(19) United States
(12) Patent Application Publication
(10) Pub. No.: US 2019/0090485 A1
(43) Pub. Date: Mar. 28, 2019

(54) Herbicidal compositions comprising 2-chloro-3-(methylsulphanyl)-N-(1-methyl-1H-tetrazol-5-yl)-4-(trifluoromethyl)benzamide

(71) Applicant: Bayer CropScience Aktiengesellschaft, Monheim am Rhein (DE)

(72) Inventors: Lothar LORENTZ, Waldbröl (DE); Klaus TRABOLD, Heidelberg (DE); Hartmut AHRENS, Egelsbach (DE); Christopher Hugh ROSINGER, Hofheim (DE); Christian WALDRAFF, Bad Vilbel (DE); Arnim KÖHN, Klein-Winternheim (DE)

(21) Appl. No.: 16/082,650

(22) PCT Filed: Feb. 20, 2017
(86) PCT No.: PCT/EP2017/053772

§ 371 Date: Sep. 6, 2018

(30) Foreign Application Priority Data
Mar. 7, 2016 (EP) 16158861.1

(51) Int. Cl. A01N 43/713; A01N 43/707; A01N 39/02; A01N 33/22; A01N 43/80; A01N 43/40

(52) U.S. Cl. CPC A01N 43/713; A01N 43/707; A01N 39/02; A01N 25/32; A01N 43/80; A01N 43/40; A01N 33/22

(57) ABSTRACT

Herbicidal compositions comprising 2-chloro-3-(methylsulphanyl)-N-(1-methyl-1H-tetrazol-5-yl)-4-(trifluoromethyl)benzamide are described. These herbicidal compositions are particularly suitable for use against harmful plants.

The present invention relates to agrochemically active herbicidal compositions and to the use thereof for control of harmful plants.

More specifically, it relates to herbicidal compositions comprising 2-chloro-3-(methylsulphanyl)-N-(1-methyl-1H-tetrazol-5-yl)-4-(trifluoromethyl)benzamide and at least two further herbicidally active compounds. These herbicidal compositions are particularly suitable for controlling unwanted harmful plants.

2-Chloro-3-(methylsulphanyl)-N-(1-methyl-1H-tetrazol-5-yl)-4-(trifluoromethyl)benzamide is known as a herbicide, for example from WO 2012/028579 A1 (Example No. 4-638 of Table 4). WO 2015/078828 A1 discloses herbicidal compositions of this compound with further herbicides. However, the herbicidal compositions disclosed therein do not always meet the requirements with respect to sufficient herbicidal activity against a broad spectrum of harmful plants.

The object of the present invention is the provision of herbicidal compositions which overcome this disadvantage.

It has now been found that herbicidal compositions comprising 2-chloro-3-(methylsulphanyl)-N-(1-methyl-1H-tetrazol-5-yl)-4-(trifluoromethyl)benzamide and at least two further herbicidally active compounds have sufficient herbicidal activity against a broad spectrum of harmful plants.

Accordingly, the present invention provides herbicidal compositions comprising
A) 2-chloro-3-(methylsulphanyl)-N-(1-methyl-1H-tetrazol-5-yl)-4-(trifluoromethyl)benzamide or salts thereof
(component A),
and
B) two herbicidally active compounds selected from the group consisting of

2,4-D (B1), 2,4-DB (B2), 2,4-DB-butyl (B3), 2,4-DB-dimethylammonium (B4), 2,4-DB-isoctyl (B5), 2,4-DB-potassium (B6), 2,4-D-butotyl (B7), 2,4-D-butyl (B8), 2,4-D-dimethylammonium (B9), 2,4-D-diolamine (B10), 2,4-D-ethyl (B11), 2,4-D-ethylhexyl (B12), 2,4-D-isobutyl (B13), 2,4-D-isoctyl (B14), 2,4-D-isopropyl (B15), 2,4-D-isopropylammonium (B16), 2,4-DP (B17), 2,4-D-sodium (B18), 2,4-D-triisopropanol-ammonium (B19), 2,4-D-trolamine (B20), acetachlor (B21), aclonifen (B22), alloxydim (B23), alloxydim-sodium (B24), ametryne (B25), amicarbazone (B26), amidosulfuron (B27), aminocyclopyrachlor (B28), aminocyclopyrachlor methyl ester (B29), aminocyclopyrachlor potassium salt (B30), aminopyralid (B31), aminopyralid-triisopropanolammonium (B32), amiprofos-methyl (B33), amitrole (B34), atrazine (B35), azimsulfuron (B36), benazolin-ethyl (B37), benazolin potassium salt (B38), benfluralin (B39), bensulfuron (B40), bensulfuron-methyl (B41), bentazone (B42), bentazone-sodium (B43), benzobicyclon (B44), benzofenap (B45), bialaphos-monosodium (B46), bialaphos-sodium (B47), bicyclopyrone (B48), bispyrac-sodium (B49), bromacil (B50), bromacil-lithium (B51), bromofenoxim (B52), bromoxynil (B53), bromoxynil butyrate (B54), bromoxynil heptanoate (B55), bromoxynil octanoate (B56), bromoxynil-potassium (B57), butamifos (B58), butralin (B59), butroxydim (B60), carbetamide (B61), chloramben (B62), chloridazon (B63), chlorimuron-ethyl (B64), chlorobromuron (B65), chlorotoluron (B66), chloroxuron (B67), chlorpropham (B68), chlorsulfuron (B69), chlorthal-dimethyl (B70), cinosulfuron (B71), clethodim (B72), clodinafop (B73), clodinafop-propargyl (B74), clomazone (B75), clomeprop (B76), clopyralid (B77), clopyralid-olamine (B78), clopyralid-potassium (B79), clopyralid-triethylammonium (B80), clopyralid-triisopropanolammonium (B81), cloransulam-methyl (B82), cyclosulfamuron (B83), cycloxydim (B84), cyhalofop-buthyl (B85), cynazine (B86), desmedipham (B87), desmetryne (B88), dicamba (B89), dicamba-butotyl (B90), dicamba diglycolamine salt (B91), dicamba-diolamine (B92), dicamba-isopropylammonium (B93), dicamba-potassium (B94), dicamba-sodium (B95), dicamba-trolamine (B96), dichlorprop (B97), dichlorprop-butotyl (B98), dichlorprop-dimethylammonium (B99), dichlorprop-isoctyl (B100), dichlorprop-P (B101), dichlorprop-P-dimethylammonium (B102), dichlorprop-P-ethylhexyl (B103), dichlorprop-potassium (B104), dichlorprop-P-potassium (B105), dichlorprop-P-sodium (B106), diclofop (B107), diclofop-methyl (B108), diclofop-P-methyl (B109), diclosulam (B110), diflufenican (B111), dimefuron (B112), dimethametryn (B113), dimethenamid (B114), dinitramine (B115), dithiopyr (B116), diuron (B117), ethalfluralin (B118), ethametsulfuron-methyl (B119), ethidimuron (B120), ethoxysulfuron (B121), fenoxaprop-p (B122), fenoxaprop-p-ethyl (B123), fenuron (B124), flamprop-m (B125), flamprop-m-isopropyl (B126), flamprop-m-methyl (B127), flazasulfuron (B128), florasulam (B129), fluazifop-butyl (B130), fluazifop-p-butyl (B131), flucarbazone-sodium (B132), flucetosulfuron (B133), flufenacet (B134), flumetsulam (B135), fluometuron (B136), flupyrsulfuron-methyl-acid (B137), flupyrsulfuron-methyl-sodium (B138), fluridone (B139), flurochloridone (B140), fluroxypyr (B141), fluroxypyr-2-butoxy-1-methylethyl (B142), fluroxypyr-meptyl (B143), flurtamone (B144), foramsulfuron (B145), glufosinate (B146), glufosinate-ammonium (B147), glufosinate-P (B148), glufosinate-sodium (B149), glyphosate (B150), glyphosate-ammonium (B151), glyphosate-diammonium (B152), glyphosate-dimethylammonium (B153), glyphosate-isopropylammonium (B154), glyphosate-potassium (B155), glyphosate-sesquisodium (B156), halosulfuron (B157), halosulfuron-methyl (B158), haloxyfop-etotyl (B159), haloxyfop-methyl (B160), haloxyfop-p (B161), haloxyfop-p-methyl (B162), hexazinone (B163), imazamethabenz-methyl (B164), imazamox (B165), imazamox-ammonium (B166), imazapic (B167), imazapic-ammonium (B168), imazapyr (B169), imazapyr-isopropylammonium (B170), imazaquin (B171), imazaquin-ammonium (B172), imazethapyr (B173), imazethapyr-ammonium (B174), imazosulfuron (B175), indaziflam (B176), iodosulfuron-methyl-sodium (B177), ioxynil (B178), ioxynil-octanoate (B179), ioxynil-potassium (B180), ioxynil-sodium (B181), isoproturon (B182), isouron (B183), isoxachlortole (B184), isoxaflutole (B185), lenacil (B186), linuron (B187), MCPA (B188), MCPA-2-ethylexyl (B189), MCPA-butotyl (B190), MCPA-dimethylammonium (B191), MCPA-isopropylammonium (B192), MCPA-potassium (B193), MCPA-sodium (B194), MCPA-thioethyl (B195), MCPB (B196), MCPB-(B197), MCPB-ethyl (B198), MCPB-potassium (B199), MCPB-sodium (B200), mecoprop (B201), mecoprop-butotyl (B202), mecoprop-P (B203), mecoprop-P-2-ethylhexyl (B204), mecoprop-P-butotyl (B205), mecoprop-P-dimethylammonium (B206), mecoprop-potassium (B207), mecoprop-P-potassium (B208), mecoprop-sodium (B209), mesosulfuron-methyl (B210), mesotrione (B211), metamifop (B212), metamitron (B213), metazachlor (B214), metazosulfuron (B215), methabenzthiazuron (B216), metobromuron (B217), metolachlor (B218), metosulam (B219), metoxuron (B220), metribuzine (B221), metsulfuron (B222), metsulfuron-methyl (B223), monolinuron (B224), neburon (B225), nicosulfuron (B226), norflurazon (B227), orthosulfamuron (B228), oryzalin (B229), oxasulfuron (B230), pendimethalin (B231), penoxsulam (B232), pentanochlor (B233), pethoxamide (B234), phenmedipham (B235), picloram (B236), picloram-dimethylammonium (B237), picloram-isoctyl (B238), picloram-potassium (B239), picloram-triethylammonium (B240), picloram-triisopropanolammonium (B241), picloram-triisopropylammonium (B242), picloram-trolamin (B243), picolinafen (B244), pinoxaden (B245), popaquizafop (B246), primisulfuron (B247), primisulfuron-methyl (B248), profoxydim (B249), prometon (B250), prometryne (B251), propanil (B252), propazine (B253), propham (B254), propoxycarbazone-sodium (B255), propyrisulfuron (B256), propyzamide (B257), prosulfuron (B258), pyrasulfotole (B259), pyrazolynate (B260), pyrazosulfuron (B261), pyrazosulfuron-ethyl (B262), pyrazoxyfen (B263), pyribenzoxim (B264), pyridafol (B265), pyridate (B266), pyriftalid (B267), pyriminobac-methyl (B268), pyrimisulfan (B269), pyrithiobac-sodium (B270), pyroxasulfone (B271), pyroxsulam (B272), quinclorac (B273), quinmerac (B274), quizalofop-ethyl (B275), quizalofop-p-ethyl (B276), quizalofop-p-methyl (B277), quizalofop-p-terfuryl (B278), rimsulfuron (B279), sethoxydim (B280), siduron (B281), simazine (B282), simetryne (B283), s-metolachlor (B284), sulcotrione (B285), sulfometuron-methyl (B286), sulfosate (B287), sulfosulfuron (B288), TBA (B289), tebutam (B290), tebuthiuron (B291), tefuryltrione (B292), tembotrione (B293), tepraloxydim (B294), terbacil (B295), terbumeton (B296), terbuthylazine (B297), terbutryne (B298), thiazopyr (B299), thiencarbazone-methyl (B300), thifensulfuron (B301), thifensulfuron-methyl (B302), topramezone (B303), tralkoxydim (B304), triasulfuron (B305), tribenuron (B306), tribenuron-methyl (B307), trichlopyr (B308), trichlopyr-butotyl (B309), trichlopyr-triethylammonium (B310), trietazine (B311), trifloxysulfuron-sodium (B312), trifluralin (B313), triflusulfuron-methyl (B314) and tritosulfuron (B315), (component B).

The nomenclature selected above is used below and is to be understood such that the code in brackets is in each case equivalent to the herbicidally active compound mentioned directly beforehand.

The active compounds referred to above by their “common names” are known from “The Pesticide Manual”, 16th edition, The British Crop Protection Council and the Royal Soc. of Chemistry, 2012.

Of particular interest are herbicidal compositions comprising the components

(A)+(B1)+(B2), (A)+(B1)+(B3), (A)+(B1)+(B4), (A)+(B1)+(B5), (A)+(B1)+(B6), (A)+(B1)+(B7), (A)+(B1)+(B8), (A)+(B1)+(B9), (A)+(B1)+(B10), (A)+(B1)+(B11), (A)+(B1)+(B12), (A)+(B1)+(B13), (A)+(B1)+(B14), (A)+(B1)+(B15), (A)+(B1)+(B16), (A)+(B1)+(B17), (A)+(B1)+(B18), (A)+(B1)+(B19), (A)+(B1)+(B20), (A)+(B1)+(B21), (A)+(B1)+(B22), (A)+(B1)+(B23), (A)+(B1)+(B24), (A)+(B1)+(B25), (A)+(B1)+(B26), (A)+(B1)+(B27), (A)+(B1)+(B28), (A)+(B1)+(B29), (A)+(B1)+(B30), (A)+(B1)+(B31), (A)+(B1)+(B32), (A)+(B1)+(B33), (A)+(B1)+(B34), (A)+(B1)+(B35), (A)+(B1)+(B36), (A)+(B1)+(B37), (A)+(B1)+(B38), (A)+(B1)+(B39), (A)+(B1)+(B40), (A)+(B1)+(B41), (A)+(B1)+(B42), (A)+(B1)+(B43), (A)+(B1)+(B44), (A)+(B1)+(B45), (A)+(B1)+(B46), (A)+(B1)+(B47), (A)+(B1)+(B48), (A)+(B1)+(B49), (A)+(B1)+(B50), (A)+(B1)+(B51), (A)+(B1)+(B52), (A)+(B1)+(B53), (A)+(B1)+(B54), (A)+(B1)+(B55), (A)+(B1)+(B56), (A)+(B1)+(B57), (A)+(B1)+(B58), (A)+(B1)+(B59), (A)+(B1)+(B60), (A)+(B1)+(B61), (A)+(B1)+(B62), (A)+(B1)+(B63), (A)+(B1)+(B64), (A)+(B1)+(B65), (A)+(B1)+(B66), (A)+(B1)+(B67), (A)+(B1)+(B68), (A)+(B1)+(B69), (A)+(B1)+(B70), (A)+(B1)+(B71), (A)+(B1)+(B72), (A)+(B1)+(B73), (A)+(B1)+(B74), (A)+(B1)+(B75), (A)+(B1)+(B76), (A)+(B1)+(B77), (A)+(B1)+(B78), (A)+(B1)+(B79), (A)+(B1)+(B80), (A)+(B1)+(B81), (A)+(B1)+(B82), (A)+(B1)+(B83), (A)+(B1)+(B84), (A)+(B1)+(B85), (A)+(B1)+(B86), (A)+(B1)+(B87), (A)+(B1)+(B88), (A)+(B1)+(B89), (A)+(B1)+(B90), (A)+(B1)+(B91), (A)+(B1)+(B92), (A)+(B1)+(B93), (A)+(B1)+(B94), (A)+(B1)+(B95), (A)+(B1)+(B96), (A)+(B1)+(B97), (A)+(B1)+(B98), (A)+(B1)+(B99), (A)+(B1)+(B100), (A)+(B1)+(B101), (A)+(B1)+(B102), (A)+(B1)+(B103), (A)+(B1)+(B104), (A)+(B1)+(B105), (A)+(B1)+(B106), (A)+(B1)+(B107), (A)+(B1)+(B108), (A)+(B1)+(B109), (A)+(B1)+(B110), (A)+(B1)+(B111), (A)+(B1)+(B112), (A)+(B1)+(B113), (A)+(B1)+(B114), (A)+(B1)+(B115), (A)+(B1)+(B116), (A)+(B1)+(B117), (A)+(B1)+(B118), (A)+(B1)+(B119), (A)+(B1)+(B120), (A)+(B1)+(B121), (A)+(B1)+(B122), (A)+(B1)+(B123), (A)+(B1)+(B124), (A)+(B1)+(B125), (A)+(B1)+(B126), (A)+(B1)+(B127), (A)+(B1)+(B128), (A)+(B1)+(B129), (A)+(B1)+(B130), (A)+(B1)+(B131), (A)+(B1)+(B132), (A)+(B1)+(B133), (A)+(B1)+(B134), (A)+(B1)+(B135), (A)+(B1)+(B136), (A)+(B1)+(B137), (A)+(B1)+(B138), (A)+(B1)+(B139), (A)+(B1)+(B140), (A)+(B1)+(B141), (A)+(B1)+(B142), (A)+(B1)+(B143), (A)+(B1)+(B144), (A)+(B1)+(B145), (A)+(B1)+(B146), (A)+(B1)+(B147), (A)+(B1)+(B148), (A)+(B1)+(B149), (A)+(B1)+(B150), (A)+(B1)+(B151), (A)+(B1)+(B152), (A)+(B1)+(B153), (A)+(B1)+(B154), (A)+(B1)+(B155), (A)+(B1)+(B156), (A)+(B1)+(B157), (A)+(B1)+(B158), (A)+(B1)+(B159), (A)+(B1)+(B160), (A)+(B1)+(B161), (A)+(B1)+(B162), (A)+(B1)+(B164), (A)+(B1)+(B164), (A)+(B1)+(B165), (A)+(B1)+(B166), (A)+(B1)+(B167), (A)+(B1)+(B168), (A)+(B1)+(B169), (A)+(B1)+(B170), (A)+(B1)+(B171), (A)+(B1)+(B172), (A)+(B1)+(B173), (A)+(B1)+(B174), (A)+(B1)+(B175), (A)+(B1)+(B176), (A)+(B1)+(B177), (A)+(B1)+(B178), (A)+(B1)+(B179), (A)+(B1)+(B180), (A)+(B1)+(B181), (A)+(B1)+(B182), (A)+(B1)+(B183), (A)+(B1)+(B184), (A)+(B1)+(B185), (A)+(B1)+(B186), (A)+(B1)+(B187), (A)+(B1)+(B188), (A)+(B1)+(B189), (A)+(B1)+(B190), (A)+(B1)+(B191), (A)+(B1)+(B192), (A)+(B1)+(B193), (A)+(B1)+(B194), (A)+(B1)+(B195), (A)+(B1)+(B196), (A)+(B1)+(B197), (A)+(B1)+(B198), (A)+(B1)+(B199), (A)+(B1)+(B200), (A)+(B1)+(B201), (A)+(B1)+(B202), (A)+(B1)+(B203), (A)+(B1)+(B204), (A)+(B1)+(B205), (A)+(B1)+(B206), (A)+(B1)+(B207), (A)+(B1)+(B208), (A)+(B1)+(B209), (A)+(B1)+(B210), (A)+(B1)+(B211), (A)+(B1)+(B212), (A)+(B1)+(B213), (A)+(B1)+(B214), (A)+(B1)+(B215), (A)+(B1)+(B216), (A)+(B1)+(B217), (A)+(B1)+(B218), (A)+(B1)+(B219), (A)+(B1)+(B220), (A)+(B1)+(B221), (A)+(B1)+(B222), (A)+(B1)+(B223), (A)+(B1)+(B224), (A)+(B1)+(B225), (A)+(B1)+(B226), (A)+(B1)+(B227), (A)+(B1)+(B228), (A)+(B1)+(B229), (A)+(B1)+(B230), (A)+(B1)+(B231), (A)+(B1)+(B232), (A)+(B1)+(B233), (A)+(B1)+(B234), (A)+(B1)+(B235), (A)+(B1)+(B236), (A)+(B1)+(B237), (A)+(B1)+(B238), (A)+(B1)+(B239), (A)+(B1)+(B240), (A)+(B1)+(B241), (A)+(B1)+(B242), (A)+(B1)+(B243), (A)+(B1)+(B244), (A)+(B1)+(B245), (A)+(B1)+(B246), (A)+(B1)+(B247), (A)+(B1)+(B248), (A)+(B1)+(B249), (A)+(B1)+(B250), (A)+(B1)+(B251), (A)+(B1)+(B252), (A)+(B1)+(B253), (A)+(B1)+(B254), (A)+(B1)+(B255), (A)+(B1)+(B256), (A)+(B1)+(B257), (A)+(B1)+(B258), (A)+(B1)+(B259), (A)+(B1)+(B260), (A)+(B1)+(B261), (A)+(B1)+(B262), (A)+(B1)+(B263), (A)+(B1)+(B264), (A)+(B1)+(B265), (A)+(B1)+(B266), (A)+(B1)+(B267), (A)+(B1)+(B268), (A)+(B1)+(B269), (A)+(B1)+(B270), (A)+(B1)+(B271), (A)+(B1)+(B272), (A)+(B1)+(B273), (A)+(B1)+(B274), (A)+(B1)+(B275), (A)+(B1)+(B276), (A)+(B1)+(B277), (A)+(B1)+(B278), (A)+(B1)+(B279), (A)+(B1)+(B280), (A)+(B1)+(B281), (A)+(B1)+(B282), (A)+(B1)+(B283), (A)+(B1)+(B284), (A)+(B1)+(B285), (A)+(B1)+(B286), (A)+(B1)+(B287), (A)+(B1)+(B288), (A)+(B1)+(B289), (A)+(B1)+(B290), (A)+(B1)+(B291), (A)+(B1)+(B292), (A)+(B1)+(B293), (A)+(B1)+(B294), (A)+(B1)+(B295), (A)+(B1)+(B296), (A)+(B1)+(B297), (A)+(B1)+(B298), (A)+(B1)+(B299), (A)+(B1)+(B300), (A)+(B1)+(B301), (A)+(B1)+(B302), (A)+(B1)+(B303), (A)+(B1)+(B304), (A)+(B1)+(B305), (A)+(B1)+(B306), (A)+(B1)+(B307), (A)+(B1)+(B308), (A)+(B1)+(B309), (A)+(B1)+(B310), (A)+(B1)+(B311), (A)+(B1)+(B312), (A)+(B1)+(B313), (A)+(B1)+(B314), (A)+(B1)+(B315),

(A)+(B2)+(B3), (A)+(B2)+(B4), (A)+(B2)+(B5), (A)+(B2)+(B6), (A)+(B2)+(B7), (A)+(B2)+(B8), (A)+(B2)+(B9), (A)+(B2)+(B10), (A)+(B2)+(B11), (A)+(B2)+(B12), (A)+(B2)+(B13), (A)+(B2)+(B14), (A)+(B2)+(B15), (A)+(B2)+(B16), (A)+(B2)+(B17), (A)+(B2)+(B18), (A)+(B2)+(B19), (A)+(B2)+(B20), (A)+(B2)+(B21), (A)+(B2)+(B22), (A)+(B2)+(B23), (A)+(B2)+(B24), (A)+(B2)+(B25), (A)+(B2)+(B26), (A)+(B2)+(B27), (A)+(B2)+(B28), (A)+(B2)+(B29), (A)+(B2)+(B30), (A)+(B2)+(B31), (A)+(B2)+(B32), (A)+(B2)+(B33), (A)+(B2)+(B34), (A)+(B2)+(B35), (A)+(B2)+(B36), (A)+(B2)+(B37), (A)+(B2)+(B38), (A)+(B2)+(B39), (A)+(B2)+(B40), (A)+(B2)+(B41), (A)+(B2)+(B42), (A)+(B2)+(B43), (A)+(B2)+(B44), (A)+(B2)+(B45), (A)+(B2)+(B46), (A)+(B2)+(B47), (A)+(B2)+(B48), (A)+(B2)+(B49), (A)+(B2)+(B50), (A)+(B2)+(B51), (A)+(B2)+(B52), (A)+(B2)+(B53), (A)+(B2)+(B54), (A)+(B2)+(B55), (A)+(B2)+(B56), (A)+(B2)+(B57), (A)+(B2)+(B58), (A)+(B2)+(B59), (A)+(B2)+(B60), (A)+(B2)+(B61), (A)+(B2)+(B62), (A)+(B2)+(B63), (A)+(B2)+(B64), (A)+(B2)+(B65), (A)+(B2)+(B66), (A)+(B2)+(B67), (A)+(B2)+(B68), (A)+(B2)+(B69), (A)+(B2)+(B70), (A)+(B2)+(B71), (A)+(B2)+(B72), (A)+(B2)+(B73), (A)+(B2)+(B74), (A)+(B2)+(B75), (A)+(B2)+(B76), (A)+(B2)+(B77), (A)+(B2)+(B78), (A)+(B2)+(B79), (A)+(B2)+(B80), (A)+(B2)+(B81), (A)+(B2)+(B82), (A)+(B2)+(B83), (A)+(B2)+(B84), (A)+(B2)+(B85), (A)+(B2)+(B86), (A)+(B2)+(B87), (A)+(B2)+(B88), (A)+(B2)+(B89), (A)+(B2)+(B90), (A)+(B2)+(B91), (A)+(B2)+(B92), (A)+(B2)+(B93), (A)+(B2)+(B94), (A)+(B2)+(B95), (A)+(B2)+(B96), (A)+(B2)+(B97), (A)+(B2)+(B98), (A)+(B2)+(B99), (A)+(B2)+(B100), (A)+(B2)+(B101), (A)+(B2)+(B102), (A)+(B2)+(B103), (A)+(B2)+(B104), (A)+(B2)+(B105), (A)+(B2)+(B106), (A)+(B2)+(B107), (A)+(B2)+(B108), (A)+(B2)+(B109), (A)+(B2)+(B110), (A)+(B2)+(B111), (A)+(B2)+(B112), (A)+(B2)+(B113), (A)+(B2)+(B114), (A)+(B2)+(B115), (A)+(B2)+(B116), (A)+(B2)+(B117), (A)+(B2)+(B118), (A)+(B2)+(B119), (A)+(B2)+(B120), (A)+(B2)+(B121), (A)+(B2)+(B122), (A)+(B2)+(B123), (A)+(B2)+(B124), (A)+(B2)+(B125), (A)+(B2)+(B126), (A)+(B2)+(B127), (A)+(B2)+(B128), (A)+(B2)+(B129), (A)+(B2)+(B130), (A)+(B2)+(B131), (A)+(B2)+(B132), (A)+(B2)+(B133), (A)+(B2)+(B134), (A)+(B2)+(B135), (A)+(B2)+(B136), (A)+(B2)+(B137), (A)+(B2)+(B138), (A)+(B2)+(B139), (A)+(B2)+(B140), (A)+(B2)+(B141), (A)+(B2)+(B142), (A)+(B2)+(B143), (A)+(B2)+(B144), (A)+(B2)+(B145), (A)+(B2)+(B146), (A)+(B2)+(B147), (A)+(B2)+(B148), (A)+(B2)+(B149), (A)+(B2)+(B150), (A)+(B2)+(B151), (A)+(B2)+(B152), (A)+(B2)+(B153), (A)+(B2)+(B154), (A)+(B2)+(B155), (A)+(B2)+(B156), (A)+(B2)+(B157), (A)+(B2)+(B158), (A)+(B2)+(B159), (A)+(B2)+(B160), (A)+(B2)+(B161), (A)+(B2)+(B162), (A)+(B2)+(B164), (A)+(B2)+(B164), (A)+(B2)+(B165), (A)+(B2)+(B166), (A)+(B2)+(B167), (A)+(B2)+(B168), (A)+(B2)+(B169), (A)+(B2)+(B170), (A)+(B2)+(B171), (A)+(B2)+(B172), (A)+(B2)+(B173), (A)+(B2)+(B174), (A)+(B2)+(B175), (A)+(B2)+(B176), (A)+(B2)+(B177), (A)+(B2)+(B178), (A)+(B2)+(B179), (A)+(B2)+(B180), (A)+(B2)+(B181), (A)+(B2)+(B182), (A)+(B2)+(B183), (A)+(B2)+(B184), (A)+(B2)+(B185), (A)+(B2)+(B186), (A)+(B2)+(B187), (A)+(B2)+(B188), (A)+(B2)+(B189), (A)+(B2)+(B190), (A)+(B2)+(B191), (A)+(B2)+(B192), (A)+(B2)+(B193), (A)+(B2)+(B194), (A)+(B2)+(B195), (A)+(B2)+(B196), (A)+(B2)+(B197), (A)+(B2)+(B198), (A)+(B2)+(B199), (A)+(B2)+(B200), (A)+(B2)+(B201), (A)+(B2)+(B202), (A)+(B2)+(B203), (A)+(B2)+(B204), (A)+(B2)+(B205), (A)+(B2)+(B206), (A)+(B2)+(B207), (A)+(B2)+(B208), (A)+(B2)+(B209), (A)+(B2)+(B210), (A)+(B2)+(B211), (A)+(B2)+(B212), (A)+(B2)+(B213), (A)+(B2)+(B214), (A)+(B2)+(B215), (A)+(B2)+(B216), (A)+(B2)+(B217), (A)+(B2)+(B218), (A)+(B2)+(B219), (A)+(B2)+(B220), (A)+(B2)+(B221), (A)+(B2)+(B222), (A)+(B2)+(B223), (A)+(B2)+(B224), (A)+(B2)+(B225), (A)+(B2)+(B226), (A)+(B2)+(B227), (A)+(B2)+(B228), (A)+(B2)+(B229), (A)+(B2)+(B230), (A)+(B2)+(B231), (A)+(B2)+(B232), (A)+(B2)+(B233), (A)+(B2)+(B234), (A)+(B2)+(B235), (A)+(B2)+(B236), (A)+(B2)+(B237), (A)+(B2)+(B238), (A)+(B2)+(B239), (A)+(B2)+(B240), (A)+(B2)+(B241), (A)+(B2)+(B242), (A)+(B2)+(B243), (A)+(B2)+(B244), (A)+(B2)+(B245), (A)+(B2)+(B246), (A)+(B2)+(B247), (A)+(B2)+(B248), (A)+(B2)+(B249), (A)+(B2)+(B250), (A)+(B2)+(B251), (A)+(B2)+(B252), (A)+(B2)+(B253), (A)+(B2)+(B254), (A)+(B2)+(B255), (A)+(B2)+(B256), (A)+(B2)+(B257), (A)+(B2)+(B258), (A)+(B2)+(B259), (A)+(B2)+(B260), (A)+(B2)+(B261), (A)+(B2)+(B262), (A)+(B2)+(B263), (A)+(B2)+(B264), (A)+(B2)+(B265), (A)+(B2)+(B266), (A)+(B2)+(B267), (A)+(B2)+(B268), (A)+(B2)+(B269), (A)+(B2)+(B270), (A)+(B2)+(B271), (A)+(B2)+(B272), (A)+(B2)+(B273), (A)+(B2)+(B274), (A)+(B2)+(B275), (A)+(B2)+(B276), (A)+(B2)+(B277), (A)+(B2)+(B278), (A)+(B2)+(B279), (A)+(B2)+(B280), (A)+(B2)+(B281), (A)+(B2)+(B282), (A)+(B2)+(B283), (A)+(B2)+(B284), (A)+(B2)+(B285), (A)+(B2)+(B286), (A)+(B2)+(B287), (A)+(B2)+(B288), (A)+(B2)+(B289), (A)+(B2)+(B290), (A)+(B2)+(B291), (A)+(B2)+(B292), (A)+(B2)+(B293), (A)+(B2)+(B294), (A)+(B2)+(B295), (A)+(B2)+(B296), (A)+(B2)+(B297), (A)+(B2)+(B298), (A)+(B2)+(B299), (A)+(B2)+(B300), (A)+(B2)+(B301), (A)+(B2)+(B302), (A)+(B2)+(B303), (A)+(B2)+(B304), (A)+(B2)+(B305), (A)+(B2)+(B306), (A)+(B2)+(B307), (A)+(B2)+(B308), (A)+(B2)+(B309), (A)+(B2)+(B310), (A)+(B2)+(B311), (A)+(B2)+(B312), (A)+(B2)+(B313), (A)+(B2)+(B314), (A)+(B2)+(B315),

(A)+(B3)+(B4), (A)+(B3)+(B5), (A)+(B3)+(B6), (A)+(B3)+(B7), (A)+(B3)+(B8), (A)+(B3)+(B9), (A)+(B3)+(B10), (A)+(B3)+(B11), (A)+(B3)+(B12), (A)+(B3)+(B13), (A)+(B3)+(B14), (A)+(B3)+(B15), (A)+(B3)+(B16), (A)+(B3)+(B17), (A)+(B3)+(B18), (A)+(B3)+(B19), (A)+(B3)+(B20), (A)+(B3)+(B21), (A)+(B3)+(B22), (A)+(B3)+(B23), (A)+(B3)+(B24), (A)+(B3)+(B25), (A)+(B3)+(B26), (A)+(B3)+(B27), (A)+(B3)+(B28), (A)+(B3)+(B29), (A)+(B3)+(B30), (A)+(B3)+(B31), (A)+(B3)+(B32), (A)+(B3)+(B33), (A)+(B3)+(B34), (A)+(B3)+(B35), (A)+(B3)+(B36), (A)+(B3)+(B37), (A)+(B3)+(B38), (A)+(B3)+(B39), (A)+(B3)+(B40), (A)+(B3)+(B41), (A)+(B3)+(B42), (A)+(B3)+(B43), (A)+(B3)+(B44), (A)+(B3)+(B45), (A)+(B3)+(B46), (A)+(B3)+(B47), (A)+(B3)+(B48), (A)+(B3)+(B49), (A)+(B3)+(B50), (A)+(B3)+(B51), (A)+(B3)+(B52), (A)+(B3)+(B53), (A)+(B3)+(B54), (A)+(B3)+(B55), (A)+(B3)+(B56), (A)+(B3)+(B57), (A)+(B3)+(B58), (A)+(B3)+(B59), (A)+(B3)+(B60), (A)+(B3)+(B61), (A)+(B3)+(B62), (A)+(B3)+(B63), (A)+(B3)+(B64), (A)+(B3)+(B65), (A)+(B3)+(B66), (A)+(B3)+(B67), (A)+(B3)+(B68), (A)+(B3)+(B69), (A)+(B3)+(B70), (A)+(B3)+(B71), (A)+(B3)+(B72), (A)+(B3)+(B73), (A)+(B3)+(B74), (A)+(B3)+(B75), (A)+(B3)+(B76), (A)+(B3)+(B77), (A)+(B3)+(B78), (A)+(B3)+(B79), (A)+(B3)+(B80), (A)+(B3)+(B81), (A)+(B3)+(B82), (A)+(B3)+(B83), (A)+(B3)+(B84), (A)+(B3)+(B85), (A)+(B3)+(B86), (A)+(B3)+(B87), (A)+(B3)+(B88), (A)+(B3)+(B89), (A)+(B3)+(B90), (A)+(B3)+(B91), (A)+(B3)+(B92), (A)+(B3)+(B93), (A)+(B3)+(B94), (A)+(B3)+(B95), (A)+(B3)+(B96), (A)+(B3)+(B97), (A)+(B3)+(B98), (A)+(B3)+(B99), (A)+(B3)+(B100), (A)+(B3)+(B101), (A)+(B3)+(B102), (A)+(B3)+(B103), (A)+(B3)+(B104), (A)+(B3)+(B105), (A)+(B3)+(B106), (A)+(B3)+(B107), (A)+(B3)+(B108), (A)+(B3)+(B109), (A)+(B3)+(B110), (A)+(B3)+(B111), (A)+(B3)+(B112), (A)+(B3)+(B113), (A)+(B3)+(B114), (A)+(B3)+(B115), (A)+(B3)+(B116), (A)+(B3)+(B117), (A)+(B3)+(B118), (A)+(B3)+(B119), (A)+(B3)+(B120), (A)+(B3)+(B121), (A)+(B3)+(B122), (A)+(B3)+(B123), (A)+(B3)+(B124), (A)+(B3)+(B125), (A)+(B3)+(B126), (A)+(B3)+(B127), (A)+(B3)+(B128), (A)+(B3)+(B129), (A)+(B3)+(B130), (A)+(B3)+(B131), (A)+(B3)+(B132), (A)+(B3)+(B133), (A)+(B3)+(B134), (A)+(B3)+(B135), (A)+(B3)+(B136), (A)+(B3)+(B137), (A)+(B3)+(B138), (A)+(B3)+(B139), (A)+(B3)+(B140), (A)+(B3)+(B141), (A)+(B3)+(B142), (A)+(B3)+(B143), (A)+(B3)+(B144), (A)+(B3)+(B145), (A)+(B3)+(B146), (A)+(B3)+(B147), (A)+(B3)+(B148), (A)+(B3)+(B149), (A)+(B3)+(B150), (A)+(B3)+(B151), (A)+(B3)+(B152), (A)+(B3)+(B153), (A)+(B3)+(B154), (A)+(B3)+(B155), (A)+(B3)+(B156), (A)+(B3)+(B157), (A)+(B3)+(B158), (A)+(B3)+(B159), (A)+(B3)+(B160), (A)+(B3)+(B161), (A)+(B3)+(B162), (A)+(B3)+(B164), (A)+(B3)+(B164), (A)+(B3)+(B165), (A)+(B3)+(B166), (A)+(B3)+(B167), (A)+(B3)+(B168), (A)+(B3)+(B169), (A)+(B3)+(B170), (A)+(B3)+(B171), (A)+(B3)+(B172), (A)+(B3)+(B173), (A)+(B3)+(B174), (A)+(B3)+(B175), (A)+(B3)+(B176), (A)+(B3)+(B177), (A)+(B3)+(B178), (A)+(B3)+(B179), (A)+(B3)+(B180), (A)+(B3)+(B181), (A)+(B3)+(B182), (A)+(B3)+(B183), (A)+(B3)+(B184), (A)+(B3)+(B185), (A)+(B3)+(B186), (A)+(B3)+(B187), (A)+(B3)+(B188), (A)+(B3)+(B189), (A)+(B3)+(B190), (A)+(B3)+(B191), (A)+(B3)+(B192), (A)+(B3)+(B193), (A)+(B3)+(B194), (A)+(B3)+(B195), (A)+(B3)+(B196), (A)+(B3)+(B197), (A)+(B3)+(B198), (A)+(B3)+(B199), (A)+(B3)+(B200), (A)+(B3)+(B201), (A)+(B3)+(B202), (A)+(B3)+(B203), (A)+(B3)+(B204), (A)+(B3)+(B205), (A)+(B3)+(B206), (A)+(B3)+(B207), (A)+(B3)+(B208), (A)+(B3)+(B209), (A)+(B3)+(B210), (A)+(B3)+(B211), (A)+(B3)+(B212), (A)+(B3)+(B213), (A)+(B3)+(B214), (A)+(B3)+(B215), (A)+(B3)+(B216), (A)+(B3)+(B217), (A)+(B3)+(B218), (A)+(B3)+(B219), (A)+(B3)+(B220), (A)+(B3)+(B221), (A)+(B3)+(B222), (A)+(B3)+(B223), (A)+(B3)+(B224), (A)+(B3)+(B225), (A)+(B3)+(B226), (A)+(B3)+(B227), (A)+(B3)+(B228), (A)+(B3)+(B229), (A)+(B3)+(B230), (A)+(B3)+(B231), (A)+(B3)+(B232), (A)+(B3)+(B233), (A)+(B3)+(B234), (A)+(B3)+(B235), (A)+(B3)+(B236), (A)+(B3)+(B237), (A)+(B3)+(B238), (A)+(B3)+(B239), (A)+(B3)+(B240), (A)+(B3)+(B241), (A)+(B3)+(B242), (A)+(B3)+(B243), (A)+(B3)+(B244), (A)+(B3)+(B245), (A)+(B3)+(B246), (A)+(B3)+(B247), (A)+(B3)+(B248), (A)+(B3)+(B249), (A)+(B3)+(B250), (A)+(B3)+(B251), (A)+(B3)+(B252), (A)+(B3)+(B253), (A)+(B3)+(B254), (A)+(B3)+(B255), (A)+(B3)+(B256), (A)+(B3)+(B257), (A)+(B3)+(B258), (A)+(B3)+(B259), (A)+(B3)+(B260), (A)+(B3)+(B261), (A)+(B3)+(B262), (A)+(B3)+(B263), (A)+(B3)+(B264), (A)+(B3)+(B265), (A)+(B3)+(B266), (A)+(B3)+(B267), (A)+(B3)+(B268), (A)+(B3)+(B269), (A)+(B3)+(B270), (A)+(B3)+(B271), (A)+(B3)+(B272), (A)+(B3)+(B273), (A)+(B3)+(B274), (A)+(B3)+(B275), (A)+(B3)+(B276), (A)+(B3)+(B277), (A)+(B3)+(B278), (A)+(B3)+(B279), (A)+(B3)+(B280), (A)+(B3)+(B281), (A)+(B3)+(B282), (A)+(B3)+(B283), (A)+(B3)+(B284), (A)+(B3)+(B285), (A)+(B3)+(B286), (A)+(B3)+(B287), (A)+(B3)+(B288), (A)+(B3)+(B289), (A)+(B3)+(B290), (A)+(B3)+(B291), (A)+(B3)+(B292), (A)+(B3)+(B293), (A)+(B3)+(B294), (A)+(B3)+(B295), (A)+(B3)+(B296), (A)+(B3)+(B297), (A)+(B3)+(B298), (A)+(B3)+(B299), (A)+(B3)+(B300), (A)+(B3)+(B301), (A)+(B3)+(B302), (A)+(B3)+(B303), (A)+(B3)+(B304), (A)+(B3)+(B305), (A)+(B3)+(B306), (A)+(B3)+(B307), (A)+(B3)+(B308), (A)+(B3)+(B309), (A)+(B3)+(B310), (A)+(B3)+(B311), (A)+(B3)+(B312), (A)+(B3)+(B313), (A)+(B3)+(B314), (A)+(B3)+(B315),

(A)+(B4)+(B5), (A)+(B4)+(B6), (A)+(B4)+(B7), (A)+(B4)+(B8), (A)+(B4)+(B9), (A)+(B4)+(B10), (A)+(B4)+(B11), (A)+(B4)+(B12), (A)+(B4)+(B13), (A)+(B4)+(B14), (A)+(B4)+(B15), (A)+(B4)+(B16), (A)+(B4)+(B17), (A)+(B4)+(B18), (A)+(B4)+(B19), (A)+(B4)+(B20), (A)+(B4)+(B21), (A)+(B4)+(B22), (A)+(B4)+(B23), (A)+(B4)+(B24), (A)+(B4)+(B25), (A)+(B4)+(B26), (A)+(B4)+(B27), (A)+(B4)+(B28), (A)+(B4)+(B29), (A)+(B4)+(B30), (A)+(B4)+(B31), (A)+(B4)+(B32), (A)+(B4)+(B33), (A)+(B4)+(B34), (A)+(B4)+(B35), (A)+(B4)+(B36), (A)+(B4)+(B37), (A)+(B4)+(B38), (A)+(B4)+(B39), (A)+(B4)+(B40), (A)+(B4)+(B41), (A)+(B4)+(B42), (A)+(B4)+(B43), (A)+(B4)+(B44), (A)+(B4)+(B45), (A)+(B4)+(B46), (A)+(B4)+(B47), (A)+(B4)+(B48), (A)+(B4)+(B49), (A)+(B4)+(B50), (A)+(B4)+(B51), (A)+(B4)+(B52), (A)+(B4)+(B53), (A)+(B4)+(B54), (A)+(B4)+(B55), (A)+(B4)+(B56), (A)+(B4)+(B57), (A)+(B4)+(B58), (A)+(B4)+(B59), (A)+(B4)+(B60), (A)+(B4)+(B61), (A)+(B4)+(B62), (A)+(B4)+(B63), (A)+(B4)+(B64), (A)+(B4)+(B65), (A)+(B4)+(B66), (A)+(B4)+(B67), (A)+(B4)+(B68), (A)+(B4)+(B69), (A)+(B4)+(B70), (A)+(B4)+(B71), (A)+(B4)+(B72), (A)+(B4)+(B73), (A)+(B4)+(B74), (A)+(B4)+(B75), (A)+(B4)+(B76), (A)+(B4)+(B77), (A)+(B4)+(B78), (A)+(B4)+(B79), (A)+(B4)+(B80), (A)+(B4)+(B81), (A)+(B4)+(B82), (A)+(B4)+(B83), (A)+(B4)+(B84), (A)+(B4)+(B85), (A)+(B4)+(B86), (A)+(B4)+(B87), (A)+(B4)+(B88), (A)+(B4)+(B89), (A)+(B4)+(B90), (A)+(B4)+(B91), (A)+(B4)+(B92), (A)+(B4)+(B93), (A)+(B4)+(B94), (A)+(B4)+(B95), (A)+(B4)+(B96), (A)+(B4)+(B97), (A)+(B4)+(B98), (A)+(B4)+(B99), (A)+(B4)+(B100), (A)+(B4)+(B101), (A)+(B4)+(B102), (A)+(B4)+(B103), (A)+(B4)+(B104), (A)+(B4)+(B105), (A)+(B4)+(B106), (A)+(B4)+(B107), (A)+(B4)+(B108), (A)+(B4)+(B109), (A)+(B4)+(B110), (A)+(B4)+(B111), (A)+(B4)+(B112), (A)+(B4)+(B113), (A)+(B4)+(B114), (A)+(B4)+(B115), (A)+(B4)+(B116), (A)+(B4)+(B117), (A)+(B4)+(B118), (A)+(B4)+(B119), (A)+(B4)+(B120), (A)+(B4)+(B121), (A)+(B4)+(B122), (A)+(B4)+(B123), (A)+(B4)+(B124), (A)+(B4)+(B125), (A)+(B4)+(B126), (A)+(B4)+(B127), (A)+(B4)+(B128), (A)+(B4)+(B129), (A)+(B4)+(B130), (A)+(B4)+(B131), (A)+(B4)+(B132), (A)+(B4)+(B133), (A)+(B4)+(B134), (A)+(B4)+(B135), (A)+(B4)+(B136), (A)+(B4)+(B137), (A)+(B4)+(B138), (A)+(B4)+(B139), (A)+(B4)+(B140), (A)+(B4)+(B141), (A)+(B4)+(B142), (A)+(B4)+(B143), (A)+(B4)+(B144), (A)+(B4)+(B145), (A)+(B4)+(B146), (A)+(B4)+(B147), (A)+(B4)+(B148), (A)+(B4)+(B149), (A)+(B4)+(B150), (A)+(B4)+(B151), (A)+(B4)+(B152), (A)+(B4)+(B153), (A)+(B4)+(B154), (A)+(B4)+(B155), (A)+(B4)+(B156), (A)+(B4)+(B157), (A)+(B4)+(B158), (A)+(B4)+(B159), (A)+(B4)+(B160), (A)+(B4)+(B161), (A)+(B4)+(B162), (A)+(B4)+(B164), (A)+(B4)+(B164), (A)+(B4)+(B165), (A)+(B4)+(B166), (A)+(B4)+(B167), (A)+(B4)+(B168), (A)+(B4)+(B169), (A)+(B4)+(B170), (A)+(B4)+(B171), (A)+(B4)+(B172), (A)+(B4)+(B173), (A)+(B4)+(B174), (A)+(B4)+(B175), (A)+(B4)+(B176), (A)+(B4)+(B177), (A)+(B4)+(B178), (A)+(B4)+(B179), (A)+(B4)+(B180), (A)+(B4)+(B181), (A)+(B4)+(B182), (A)+(B4)+(B183), (A)+(B4)+(B184), (A)+(B4)+(B185), (A)+(B4)+(B186), (A)+(B4)+(B187), (A)+(B4)+(B188), (A)+(B4)+(B189), (A)+(B4)+(B190), (A)+(B4)+(B191), (A)+(B4)+(B192), (A)+(B4)+(B193), (A)+(B4)+(B194), (A)+(B4)+(B195), (A)+(B4)+(B196), (A)+(B4)+(B197), (A)+(B4)+(B198), (A)+(B4)+(B199), (A)+(B4)+(B200), (A)+(B4)+(B201), (A)+(B4)+(B202), (A)+(B4)+(B203), (A)+(B4)+(B204), (A)+(B4)+(B205), (A)+(B4)+(B206), (A)+(B4)+(B207), (A)+(B4)+(B208), (A)+(B4)+(B209), (A)+(B4)+(B210), (A)+(B4)+(B211), (A)+(B4)+(B212), (A)+(B4)+(B213), (A)+(B4)+(B214), (A)+(B4)+(B215), (A)+(B4)+(B216), (A)+(B4)+(B217), (A)+(B4)+(B218), (A)+(B4)+(B219), (A)+(B4)+(B220), (A)+(B4)+(B221), (A)+(B4)+(B222), (A)+(B4)+(B223), (A)+(B4)+(B224), (A)+(B4)+(B225), (A)+(B4)+(B226), (A)+(B4)+(B227), (A)+(B4)+(B228), (A)+(B4)+(B229), (A)+(B4)+(B230), (A)+(B4)+(B231), (A)+(B4)+(B232), (A)+(B4)+(B233), (A)+(B4)+(B234), (A)+(B4)+(B235), (A)+(B4)+(B236), (A)+(B4)+(B237), (A)+(B4)+(B238), (A)+(B4)+(B239), (A)+(B4)+(B240), (A)+(B4)+(B241), (A)+(B4)+(B242), (A)+(B4)+(B243), (A)+(B4)+(B244), (A)+(B4)+(B245), (A)+(B4)+(B246), (A)+(B4)+(B247), (A)+(B4)+(B248), (A)+(B4)+(B249), (A)+(B4)+(B250), (A)+(B4)+(B251), (A)+(B4)+(B252), (A)+(B4)+(B253), (A)+(B4)+(B254), (A)+(B4)+(B255), (A)+(B4)+(B256), (A)+(B4)+(B257), (A)+(B4)+(B258), (A)+(B4)+(B259), (A)+(B4)+(B260), (A)+(B4)+(B261), (A)+(B4)+(B262), (A)+(B4)+(B263), (A)+(B4)+(B264), (A)+(B4)+(B265), (A)+(B4)+(B266), (A)+(B4)+(B267), (A)+(B4)+(B268), (A)+(B4)+(B269), (A)+(B4)+(B270), (A)+(B4)+(B271), (A)+(B4)+(B272), (A)+(B4)+(B273), (A)+(B4)+(B274), (A)+(B4)+(B275), (A)+(B4)+(B276), (A)+(B4)+(B277), (A)+(B4)+(B278), (A)+(B4)+(B279), (A)+(B4)+(B280), (A)+(B4)+(B281), (A)+(B4)+(B282), (A)+(B4)+(B283), (A)+(B4)+(B284), (A)+(B4)+(B285), (A)+(B4)+(B286), (A)+(B4)+(B287), (A)+(B4)+(B288), (A)+(B4)+(B289), (A)+(B4)+(B290), (A)+(B4)+(B291), (A)+(B4)+(B292), (A)+(B4)+(B293), (A)+(B4)+(B294), (A)+(B4)+(B295), (A)+(B4)+(B296), (A)+(B4)+(B297), (A)+(B4)+(B298), (A)+(B4)+(B299), (A)+(B4)+(B300), (A)+(B4)+(B301), (A)+(B4)+(B302), (A)+(B4)+(B303), (A)+(B4)+(B304), (A)+(B4)+(B305), (A)+(B4)+(B306), (A)+(B4)+(B307), (A)+(B4)+(B308), (A)+(B4)+(B309), (A)+(B4)+(B310), (A)+(B4)+(B311), (A)+(B4)+(B312), (A)+(B4)+(B313), (A)+(B4)+(B314), (A)+(B4)+(B315),

(A)+(B5)+(B6), (A)+(B5)+(B7), (A)+(B5)+(B8), (A)+(B5)+(B9), (A)+(B5)+(B10), (A)+(B5)+(B11), (A)+(B5)+(B12), (A)+(B5)+(B13), (A)+(B5)+(B14), (A)+(B5)+(B15), (A)+(B5)+(B16), (A)+(B5)+(B17), (A)+(B5)+(B18), (A)+(B5)+(B19), (A)+(B5)+(B20), (A)+(B5)+(B21), (A)+(B5)+(B22), (A)+(B5)+(B23), (A)+(B5)+(B24), (A)+(B5)+(B25), (A)+(B5)+(B26), (A)+(B5)+(B27), (A)+(B5)+(B28), (A)+(B5)+(B29), (A)+(B5)+(B30), (A)+(B5)+(B31), (A)+(B5)+(B32), (A)+(B5)+(B33), (A)+(B5)+(B34), (A)+(B5)+(B35), (A)+(B5)+(B36), (A)+(B5)+(B37), (A)+(B5)+(B38), (A)+(B5)+(B39), (A)+(B5)+(B40), (A)+(B5)+(B41), (A)+(B5)+(B42), (A)+(B5)+(B43), (A)+(B5)+(B44), (A)+(B5)+(B45), (A)+(B5)+(B46), (A)+(B5)+(B47), (A)+(B5)+(B48), (A)+(B5)+(B49), (A)+(B5)+(B50), (A)+(B5)+(B51), (A)+(B5)+(B52), (A)+(B5)+(B53), (A)+(B5)+(B54), (A)+(B5)+(B55), (A)+(B5)+(B56), (A)+(B5)+(B57), (A)+(B5)+(B58), (A)+(B5)+(B59), (A)+(B5)+(B60), (A)+(B5)+(B61), (A)+(B5)+(B62), (A)+(B5)+(B63), (A)+(B5)+(B64), (A)+(B5)+(B65), (A)+(B5)+(B66), (A)+(B5)+(B67), (A)+(B5)+(B68), (A)+(B5)+(B69), (A)+(B5)+(B70), (A)+(B5)+(B71), (A)+(B5)+(B72), (A)+(B5)+(B73), (A)+(B5)+(B74), (A)+(B5)+(B75), (A)+(B5)+(B76), (A)+(B5)+(B77), (A)+(B5)+(B78), (A)+(B5)+(B79), (A)+(B5)+(B80), (A)+(B5)+(B81), (A)+(B5)+(B82), (A)+(B5)+(B83), (A)+(B5)+(B84), (A)+(B5)+(B85), (A)+(B5)+(B86), (A)+(B5)+(B87), (A)+(B5)+(B88), (A)+(B5)+(B89), (A)+(B5)+(B90), (A)+(B5)+(B91), (A)+(B5)+(B92), (A)+(B5)+(B93), (A)+(B5)+(B94), (A)+(B5)+(B95), (A)+(B5)+(B96), (A)+(B5)+(B97), (A)+(B5)+(B98), (A)+(B5)+(B99), (A)+(B5)+(B100), (A)+(B5)+(B101), (A)+(B5)+(B102), (A)+(B5)+(B103), (A)+(B5)+(B104), (A)+(B5)+(B105), (A)+(B5)+(B106), (A)+(B5)+(B107), (A)+(B5)+(B108), (A)+(B5)+(B109), (A)+(B5)+(B110), (A)+(B5)+(B111), (A)+(B5)+(B112), (A)+(B5)+(B113), (A)+(B5)+(B114), (A)+(B5)+(B115), (A)+(B5)+(B116), (A)+(B5)+(B117), (A)+(B5)+(B118), (A)+(B5)+(B119), (A)+(B5)+(B120), (A)+(B5)+(B121), (A)+(B5)+(B122), (A)+(B5)+(B123), (A)+(B5)+(B124), (A)+(B5)+(B125), (A)+(B5)+(B126), (A)+(B5)+(B127), (A)+(B5)+(B128), (A)+(B5)+(B129), (A)+(B5)+(B130), (A)+(B5)+(B131), (A)+(B5)+(B132), (A)+(B5)+(B133), (A)+(B5)+(B134), (A)+(B5)+(B135), (A)+(B5)+(B136), (A)+(B5)+(B137), (A)+(B5)+(B138), (A)+(B5)+(B139), (A)+(B5)+(B140), (A)+(B5)+(B141), (A)+(B5)+(B142), (A)+(B5)+(B143), (A)+(B5)+(B144), (A)+(B5)+(B145), (A)+(B5)+(B146), (A)+(B5)+(B147), (A)+(B5)+(B148), (A)+(B5)+(B149), (A)+(B5)+(B150), (A)+(B5)+(B151), (A)+(B5)+(B152), (A)+(B5)+(B153), (A)+(B5)+(B154), (A)+(B5)+(B155), (A)+(B5)+(B156), (A)+(B5)+(B157), (A)+(B5)+(B158), (A)+(B5)+(B159), (A)+(B5)+(B160), (A)+(B5)+(B161), (A)+(B5)+(B162), (A)+(B5)+(B164), (A)+(B5)+(B164), (A)+(B5)+(B165), (A)+(B5)+(B166), (A)+(B5)+(B167), (A)+(B5)+(B168), (A)+(B5)+(B169), (A)+(B5)+(B170), (A)+(B5)+(B171), (A)+(B5)+(B172), (A)+(B5)+(B173), (A)+(B5)+(B174), (A)+(B5)+(B175), (A)+(B5)+(B176), (A)+(B5)+(B177), (A)+(B5)+(B178), (A)+(B5)+(B179), (A)+(B5)+(B180), (A)+(B5)+(B181), (A)+(B5)+(B182), (A)+(B5)+(B183), (A)+(B5)+(B184), (A)+(B5)+(B185), (A)+(B5)+(B186), (A)+(B5)+(B187), (A)+(B5)+(B188), (A)+(B5)+(B189), (A)+(B5)+(B190), (A)+(B5)+(B191), (A)+(B5)+(B192), (A)+(B5)+(B193), (A)+(B5)+(B194), (A)+(B5)+(B195), (A)+(B5)+(B196), (A)+(B5)+(B197), (A)+(B5)+(B198), (A)+(B5)+(B199), (A)+(B5)+(B200), (A)+(B5)+(B201), (A)+(B5)+(B202), (A)+(B5)+(B203), (A)+(B5)+(B204), (A)+(B5)+(B205), (A)+(B5)+(B206), (A)+(B5)+(B207), (A)+(B5)+(B208), (A)+(B5)+(B209), (A)+(B5)+(B210), (A)+(B5)+(B211), (A)+(B5)+(B212), (A)+(B5)+(B213), (A)+(B5)+(B214), (A)+(B5)+(B215), (A)+(B5)+(B216), (A)+(B5)+(B217), (A)+(B5)+(B218), (A)+(B5)+(B219), (A)+(B5)+(B220), (A)+(B5)+(B221), (A)+(B5)+(B222), (A)+(B5)+(B223), (A)+(B5)+(B224), (A)+(B5)+(B225), (A)+(B5)+(B226), (A)+(B5)+(B227), (A)+(B5)+(B228), (A)+(B5)+(B229), (A)+(B5)+(B230), (A)+(B5)+(B231), (A)+(B5)+(B232), (A)+(B5)+(B233), (A)+(B5)+(B234), (A)+(B5)+(B235), (A)+(B5)+(B236), (A)+(B5)+(B237), (A)+(B5)+(B238), (A)+(B5)+(B239), (A)+(B5)+(B240), (A)+(B5)+(B241), (A)+(B5)+(B242), (A)+(B5)+(B243), (A)+(B5)+(B244), (A)+(B5)+(B245), (A)+(B5)+(B246), (A)+(B5)+(B247), (A)+(B5)+(B248), (A)+(B5)+(B249), (A)+(B5)+(B250), (A)+(B5)+(B251), (A)+(B5)+(B252), (A)+(B5)+(B253), (A)+(B5)+(B254), (A)+(B5)+(B255), (A)+(B5)+(B256), (A)+(B5)+(B257), (A)+(B5)+(B258), (A)+(B5)+(B259), (A)+(B5)+(B260), (A)+(B5)+(B261), (A)+(B5)+(B262), (A)+(B5)+(B263), (A)+(B5)+(B264), (A)+(B5)+(B265), (A)+(B5)+(B266), (A)+(B5)+(B267), (A)+(B5)+(B268), (A)+(B5)+(B269), (A)+(B5)+(B270), (A)+(B5)+(B271), (A)+(B5)+(B272), (A)+(B5)+(B273), (A)+(B5)+(B274), (A)+(B5)+(B275), (A)+(B5)+(B276), (A)+(B5)+(B277), (A)+(B5)+(B278), (A)+(B5)+(B279), (A)+(B5)+(B280), (A)+(B5)+(B281), (A)+(B5)+(B282), (A)+(B5)+(B283), (A)+(B5)+(B284), (A)+(B5)+(B285), (A)+(B5)+(B286), (A)+(B5)+(B287), (A)+(B5)+(B288), (A)+(B5)+(B289), (A)+(B5)+(B290), (A)+(B5)+(B291), (A)+(B5)+(B292), (A)+(B5)+(B293), (A)+(B5)+(B294), (A)+(B5)+(B295), (A)+(B5)+(B296), (A)+(B5)+(B297), (A)+(B5)+(B298), (A)+(B5)+(B299), (A)+(B5)+(B300), (A)+(B5)+(B301), (A)+(B5)+(B302), (A)+(B5)+(B303), (A)+(B5)+(B304), (A)+(B5)+(B305), (A)+(B5)+(B306), (A)+(B5)+(B307), (A)+(B5)+(B308), (A)+(B5)+(B309), (A)+(B5)+(B310), (A)+(B5)+(B311), (A)+(B5)+(B312), (A)+(B5)+(B313), (A)+(B5)+(B314), (A)+(B5)+(B315),

(A)+(B6)+(B7), (A)+(B6)+(B8), (A)+(B6)+(B9), (A)+(B6)+(B10), (A)+(B6)+(B11), (A)+(B6)+(B12), (A)+(B6)+(B13), (A)+(B6)+(B14), (A)+(B6)+(B15), (A)+(B6)+(B16), (A)+(B6)+(B17), (A)+(B6)+(B18), (A)+(B6)+(B19), (A)+(B6)+(B20), (A)+(B6)+(B21), (A)+(B6)+(B22), (A)+(B6)+(B23), (A)+(B6)+(B24), (A)+(B6)+(B25), (A)+(B6)+(B26), (A)+(B6)+(B27), (A)+(B6)+(B28), (A)+(B6)+(B29), (A)+(B6)+(B30), (A)+(B6)+(B31), (A)+(B6)+(B32), (A)+(B6)+(B33), (A)+(B6)+(B34), (A)+(B6)+(B35), (A)+(B6)+(B36), (A)+(B6)+(B37), (A)+(B6)+(B38), (A)+(B6)+(B39), (A)+(B6)+(B40), (A)+(B6)+(B41), (A)+(B6)+(B42), (A)+(B6)+(B43), (A)+(B6)+(B44), (A)+(B6)+(B45), (A)+(B6)+(B46), (A)+(B6)+(B47), (A)+(B6)+(B48), (A)+(B6)+(B49), (A)+(B6)+(B50), (A)+(B6)+(B51), (A)+(B6)+(B52), (A)+(B6)+(B53), (A)+(B6)+(B54), (A)+(B6)+(B55), (A)+(B6)+(B56), (A)+(B6)+(B57), (A)+(B6)+(B58), (A)+(B6)+(B59), (A)+(B6)+(B60), (A)+(B6)+(B61), (A)+(B6)+(B62), (A)+(B6)+(B63), (A)+(B6)+(B64), (A)+(B6)+(B65), (A)+(B6)+(B66), (A)+(B6)+(B67), (A)+(B6)+(B68), (A)+(B6)+(B69), (A)+(B6)+(B70), (A)+(B6)+(B71), (A)+(B6)+(B72), (A)+(B6)+(B73), (A)+(B6)+(B74), (A)+(B6)+(B75), (A)+(B6)+(B76), (A)+(B6)+(B77), (A)+(B6)+(B78), (A)+(B6)+(B79), (A)+(B6)+(B80), (A)+(B6)+(B81), (A)+(B6)+(B82), (A)+(B6)+(B83), (A)+(B6)+(B84), (A)+(B6)+(B85), (A)+(B6)+(B86), (A)+(B6)+(B87), (A)+(B6)+(B88), (A)+(B6)+(B89), (A)+(B6)+(B90), (A)+(B6)+(B91), (A)+(B6)+(B92), (A)+(B6)+(B93), (A)+(B6)+(B94), (A)+(B6)+(B95), (A)+(B6)+(B96), (A)+(B6)+(B97), (A)+(B6)+(B98), (A)+(B6)+(B99), (A)+(B6)+(B100), (A)+(B6)+(B101), (A)+(B6)+(B102), (A)+(B6)+(B103), (A)+(B6)+(B104), (A)+(B6)+(B105), (A)+(B6)+(B106), (A)+(B6)+(B107), (A)+(B6)+(B108), (A)+(B6)+(B109), (A)+(B6)+(B110), (A)+(B6)+(B111), (A)+(B6)+(B112), (A)+(B6)+(B113), (A)+(B6)+(B114), (A)+(B6)+(B115), (A)+(B6)+(B116), (A)+(B6)+(B117), (A)+(B6)+(B118), (A)+(B6)+(B119), (A)+(B6)+(B120), (A)+(B6)+(B121), (A)+(B6)+(B122), (A)+(B6)+(B123), (A)+(B6)+(B124), (A)+(B6)+(B125), (A)+(B6)+(B126), (A)+(B6)+(B127), (A)+(B6)+(B128), (A)+(B6)+(B129), (A)+(B6)+(B130), (A)+(B6)+(B131), (A)+(B6)+(B132), (A)+(B6)+(B133), (A)+(B6)+(B134), (A)+(B6)+(B135), (A)+(B6)+(B136), (A)+(B6)+(B137), (A)+(B6)+(B138), (A)+(B6)+(B139), (A)+(B6)+(B140), (A)+(B6)+(B141), (A)+(B6)+(B142), (A)+(B6)+(B143), (A)+(B6)+(B144), (A)+(B6)+(B145), (A)+(B6)+(B146), (A)+(B6)+(B147), (A)+(B6)+(B148), (A)+(B6)+(B149), (A)+(B6)+(B150), (A)+(B6)+(B151), (A)+(B6)+(B152), (A)+(B6)+(B153), (A)+(B6)+(B154), (A)+(B6)+(B155), (A)+(B6)+(B156), (A)+(B6)+(B157), (A)+(B6)+(B158), (A)+(B6)+(B159), (A)+(B6)+(B160), (A)+(B6)+(B161), (A)+(B6)+(B162), (A)+(B6)+(B164), (A)+(B6)+(B164), (A)+(B6)+(B165), (A)+(B6)+(B166), (A)+(B6)+(B167), (A)+(B6)+(B168), (A)+(B6)+(B169), (A)+(B6)+(B170), (A)+(B6)+(B171), (A)+(B6)+(B172), (A)+(B6)+(B173), (A)+(B6)+(B174), (A)+(B6)+(B175), (A)+(B6)+(B176), (A)+(B6)+(B177), (A)+(B6)+(B178), (A)+(B6)+(B179), (A)+(B6)+(B180), (A)+(B6)+(B181), (A)+(B6)+(B182), (A)+(B6)+(B183), (A)+(B6)+(B184), (A)+(B6)+(B185), (A)+(B6)+(B186), (A)+(B6)+(B187), (A)+(B6)+(B188), (A)+(B6)+(B189), (A)+(B6)+(B190), (A)+(B6)+(B191), (A)+(B6)+(B192), (A)+(B6)+(B193), (A)+(B6)+(B194), (A)+(B6)+(B195), (A)+(B6)+(B196), (A)+(B6)+(B197), (A)+(B6)+(B198), (A)+(B6)+(B199), (A)+(B6)+(B200), (A)+(B6)+(B201), (A)+(B6)+(B202), (A)+(B6)+(B203), (A)+(B6)+(B204), (A)+(B6)+(B205), (A)+(B6)+(B206), (A)+(B6)+(B207), (A)+(B6)+(B208), (A)+(B6)+(B209), (A)+(B6)+(B210), (A)+(B6)+(B211), (A)+(B6)+(B212), (A)+(B6)+(B213), (A)+(B6)+(B214), (A)+(B6)+(B215), (A)+(B6)+(B216), (A)+(B6)+(B217), (A)+(B6)+(B218), (A)+(B6)+(B219), (A)+(B6)+(B220), (A)+(B6)+(B221), (A)+(B6)+(B222), (A)+(B6)+(B223), (A)+(B6)+(B224), (A)+(B6)+(B225), (A)+(B6)+(B226), (A)+(B6)+(B227), (A)+(B6)+(B228), (A)+(B6)+(B229), (A)+(B6)+(B230), (A)+(B6)+(B231), (A)+(B6)+(B232), (A)+(B6)+(B233), (A)+(B6)+(B234), (A)+(B6)+(B235), (A)+(B6)+(B236), (A)+(B6)+(B237), (A)+(B6)+(B238), (A)+(B6)+(B239), (A)+(B6)+(B240), (A)+(B6)+(B241), (A)+(B6)+(B242), (A)+(B6)+(B243), (A)+(B6)+(B244), (A)+(B6)+(B245), (A)+(B6)+(B246), (A)+(B6)+(B247), (A)+(B6)+(B248), (A)+(B6)+(B249), (A)+(B6)+(B250), (A)+(B6)+(B251), (A)+(B6)+(B252), (A)+(B6)+(B253), (A)+(B6)+(B254), (A)+(B6)+(B255), (A)+(B6)+(B256), (A)+(B6)+(B257), (A)+(B6)+(B258), (A)+(B6)+(B259), (A)+(B6)+(B260), (A)+(B6)+(B261), (A)+(B6)+(B262), (A)+(B6)+(B263), (A)+(B6)+(B264), (A)+(B6)+(B265), (A)+(B6)+(B266), (A)+(B6)+(B267), (A)+(B6)+(B268), (A)+(B6)+(B269), (A)+(B6)+(B270), (A)+(B6)+(B271), (A)+(B6)+(B272), (A)+(B6)+(B273), (A)+(B6)+(B274), (A)+(B6)+(B275), (A)+(B6)+(B276), (A)+(B6)+(B277), (A)+(B6)+(B278), (A)+(B6)+(B279), (A)+(B6)+(B280), (A)+(B6)+(B281), (A)+(B6)+(B282), (A)+(B6)+(B283), (A)+(B6)+(B284), (A)+(B6)+(B285), (A)+(B6)+(B286), (A)+(B6)+(B287), (A)+(B6)+(B288), (A)+(B6)+(B289), (A)+(B6)+(B290), (A)+(B6)+(B291), (A)+(B6)+(B292), (A)+(B6)+(B293), (A)+(B6)+(B294), (A)+(B6)+(B295), (A)+(B6)+(B296), (A)+(B6)+(B297), (A)+(B6)+(B298), (A)+(B6)+(B299), (A)+(B6)+(B300), (A)+(B6)+(B301), (A)+(B6)+(B302), (A)+(B6)+(B303), (A)+(B6)+(B304), (A)+(B6)+(B305), (A)+(B6)+(B306), (A)+(B6)+(B307), (A)+(B6)+(B308), (A)+(B6)+(B309), (A)+(B6)+(B310), (A)+(B6)+(B311), (A)+(B6)+(B312), (A)+(B6)+(B313), (A)+(B6)+(B314), (A)+(B6)+(B315),

(A)+(B7)+(B8), (A)+(B7)+(B9), (A)+(B7)+(B10), (A)+(B7)+(B11), (A)+(B7)+(B12), (A)+(B7)+(B13), (A)+(B7)+(B14), (A)+(B7)+(B15), (A)+(B7)+(B16), (A)+(B7)+(B17), (A)+(B7)+(B18), (A)+(B7)+(B19), (A)+(B7)+(B20), (A)+(B7)+(B21), (A)+(B7)+(B22), (A)+(B7)+(B23), (A)+(B7)+(B24), (A)+(B7)+(B25), (A)+(B7)+(B26), (A)+(B7)+(B27), (A)+(B7)+(B28), (A)+(B7)+(B29), (A)+(B7)+(B30), (A)+(B7)+(B31), (A)+(B7)+(B32), (A)+(B7)+(B33), (A)+(B7)+(B34), (A)+(B7)+(B35), (A)+(B7)+(B36), (A)+(B7)+(B37), (A)+(B7)+(B38), (A)+(B7)+(B39), (A)+(B7)+(B40), (A)+(B7)+(B41), (A)+(B7)+(B42), (A)+(B7)+(B43), (A)+(B7)+(B44), (A)+(B7)+(B45), (A)+(B7)+(B46), (A)+(B7)+(B47), (A)+(B7)+(B48), (A)+(B7)+(B49), (A)+(B7)+(B50), (A)+(B7)+(B51), (A)+(B7)+(B52), (A)+(B7)+(B53), (A)+(B7)+(B54), (A)+(B7)+(B55), (A)+(B7)+(B56), (A)+(B7)+(B57), (A)+(B7)+(B58), (A)+(B7)+(B59), (A)+(B7)+(B60), (A)+(B7)+(B61), (A)+(B7)+(B62), (A)+(B7)+(B63), (A)+(B7)+(B64), (A)+(B7)+(B65), (A)+(B7)+(B66), (A)+(B7)+(B67), (A)+(B7)+(B68), (A)+(B7)+(B69), (A)+(B7)+(B70), (A)+(B7)+(B71), (A)+(B7)+(B72), (A)+(B7)+(B73), (A)+(B7)+(B74), (A)+(B7)+(B75), (A)+(B7)+(B76), (A)+(B7)+(B77), (A)+(B7)+(B78), (A)+(B7)+(B79), (A)+(B7)+(B80), (A)+(B7)+(B81), (A)+(B7)+(B82), (A)+(B7)+(B83), (A)+(B7)+(B84), (A)+(B7)+(B85), (A)+(B7)+(B86), (A)+(B7)+(B87), (A)+(B7)+(B88), (A)+(B7)+(B89), (A)+(B7)+(B90), (A)+(B7)+(B91), (A)+(B7)+(B92), (A)+(B7)+(B93), (A)+(B7)+(B94), (A)+(B7)+(B95), (A)+(B7)+(B96), (A)+(B7)+(B97), (A)+(B7)+(B98), (A)+(B7)+(B99), (A)+(B7)+(B100), (A)+(B7)+(B101), (A)+(B7)+(B102), (A)+(B7)+(B103), (A)+(B7)+(B104), (A)+(B7)+(B105), (A)+(B7)+(B106), (A)+(B7)+(B107), (A)+(B7)+(B108), (A)+(B7)+(B109), (A)+(B7)+(B110), (A)+(B7)+(B111), (A)+(B7)+(B112), (A)+(B7)+(B113), (A)+(B7)+(B114), (A)+(B7)+(B115), (A)+(B7)+(B116), (A)+(B7)+(B117), (A)+(B7)+(B118), (A)+(B7)+(B119), (A)+(B7)+(B120), (A)+(B7)+(B121), (A)+(B7)+(B122), (A)+(B7)+(B123), (A)+(B7)+(B124), (A)+(B7)+(B125), (A)+(B7)+(B126), (A)+(B7)+(B127), (A)+(B7)+(B128), (A)+(B7)+(B129), (A)+(B7)+(B130), (A)+(B7)+(B131), (A)+(B7)+(B132), (A)+(B7)+(B133), (A)+(B7)+(B134), (A)+(B7)+(B135), (A)+(B7)+(B136), (A)+(B7)+(B137), (A)+(B7)+(B138), (A)+(B7)+(B139), (A)+(B7)+(B140), (A)+(B7)+(B141), (A)+(B7)+(B142), (A)+(B7)+(B143), (A)+(B7)+(B144), (A)+(B7)+(B145), (A)+(B7)+(B146), (A)+(B7)+(B147), (A)+(B7)+(B148), (A)+(B7)+(B149), (A)+(B7)+(B150), (A)+(B7)+(B151), (A)+(B7)+(B152), (A)+(B7)+(B153), (A)+(B7)+(B154), (A)+(B7)+(B155), (A)+(B7)+(B156), (A)+(B7)+(B157), (A)+(B7)+(B158), (A)+(B7)+(B159), (A)+(B7)+(B160), (A)+(B7)+(B161), (A)+(B7)+(B162), (A)+(B7)+(B164), (A)+(B7)+(B164), (A)+(B7)+(B165), (A)+(B7)+(B166), (A)+(B7)+(B167), (A)+(B7)+(B168), (A)+(B7)+(B169), (A)+(B7)+(B170), (A)+(B7)+(B171), (A)+(B7)+(B172), (A)+(B7)+(B173), (A)+(B7)+(B174), (A)+(B7)+(B175), (A)+(B7)+(B176), (A)+(B7)+(B177), (A)+(B7)+(B178), (A)+(B7)+(B179), (A)+(B7)+(B180), (A)+(B7)+(B181), (A)+(B7)+(B182), (A)+(B7)+(B183), (A)+(B7)+(B184), (A)+(B7)+(B185), (A)+(B7)+(B186), (A)+(B7)+(B187), (A)+(B7)+(B188), (A)+(B7)+(B189), (A)+(B7)+(B190), (A)+(B7)+(B191), (A)+(B7)+(B192), (A)+(B7)+(B193), (A)+(B7)+(B194), (A)+(B7)+(B195), (A)+(B7)+(B196), (A)+(B7)+(B197), (A)+(B7)+(B198), (A)+(B7)+(B199), (A)+(B7)+(B200), (A)+(B7)+(B201), (A)+(B7)+(B202), (A)+(B7)+(B203), (A)+(B7)+(B204), (A)+(B7)+(B205), (A)+(B7)+(B206), (A)+(B7)+(B207), (A)+(B7)+(B208), (A)+(B7)+(B209), (A)+(B7)+(B210), (A)+(B7)+(B211), (A)+(B7)+(B212), (A)+(B7)+(B213), (A)+(B7)+(B214), (A)+(B7)+(B215), (A)+(B7)+(B216), (A)+(B7)+(B217), (A)+(B7)+(B218), (A)+(B7)+(B219), (A)+(B7)+(B220), (A)+(B7)+(B221), (A)+(B7)+(B222), (A)+(B7)+(B223), (A)+(B7)+(B224), (A)+(B7)+(B225), (A)+(B7)+(B226), (A)+(B7)+(B227), (A)+(B7)+(B228), (A)+(B7)+(B229), (A)+(B7)+(B230), (A)+(B7)+(B231), (A)+(B7)+(B232), (A)+(B7)+(B233), (A)+(B7)+(B234), (A)+(B7)+(B235), (A)+(B7)+(B236), (A)+(B7)+(B237), (A)+(B7)+(B238), (A)+(B7)+(B239), (A)+(B7)+(B240), (A)+(B7)+(B241), (A)+(B7)+(B242), (A)+(B7)+(B243), (A)+(B7)+(B244), (A)+(B7)+(B245), (A)+(B7)+(B246), (A)+(B7)+(B247), (A)+(B7)+(B248), (A)+(B7)+(B249), (A)+(B7)+(B250), (A)+(B7)+(B251), (A)+(B7)+(B252), (A)+(B7)+(B253), (A)+(B7)+(B254), (A)+(B7)+(B255), (A)+(B7)+(B256), (A)+(B7)+(B257), (A)+(B7)+(B258), (A)+(B7)+(B259), (A)+(B7)+(B260), (A)+(B7)+(B261), (A)+(B7)+(B262), (A)+(B7)+(B263), (A)+(B7)+(B264), (A)+(B7)+(B265), (A)+(B7)+(B266), (A)+(B7)+(B267), (A)+(B7)+(B268), (A)+(B7)+(B269), (A)+(B7)+(B270), (A)+(B7)+(B271), (A)+(B7)+(B272), (A)+(B7)+(B273), (A)+(B7)+(B274), (A)+(B7)+(B275), (A)+(B7)+(B276), (A)+(B7)+(B277), (A)+(B7)+(B278), (A)+(B7)+(B279), (A)+(B7)+(B280), (A)+(B7)+(B281), (A)+(B7)+(B282), (A)+(B7)+(B283), (A)+(B7)+(B284), (A)+(B7)+(B285), (A)+(B7)+(B286), (A)+(B7)+(B287), (A)+(B7)+(B288), (A)+(B7)+(B289), (A)+(B7)+(B290), (A)+(B7)+(B291), (A)+(B7)+(B292), (A)+(B7)+(B293), (A)+(B7)+(B294), (A)+(B7)+(B295), (A)+(B7)+(B296), (A)+(B7)+(B297), (A)+(B7)+(B298), (A)+(B7)+(B299), (A)+(B7)+(B300), (A)+(B7)+(B301), (A)+(B7)+(B302), (A)+(B7)+(B303), (A)+(B7)+(B304), (A)+(B7)+(B305), (A)+(B7)+(B306), (A)+(B7)+(B307), (A)+(B7)+(B308), (A)+(B7)+(B309), (A)+(B7)+(B310), (A)+(B7)+(B311), (A)+(B7)+(B312), (A)+(B7)+(B313), (A)+(B7)+(B314), (A)+(B7)+(B315),

(A)+(B8)+(B9), (A)+(B8)+(B10), (A)+(B8)+(B11), (A)+(B8)+(B12), (A)+(B8)+(B13), (A)+(B8)+(B14), (A)+(B8)+(B15), (A)+(B8)+(B16), (A)+(B8)+(B17), (A)+(B8)+(B18), (A)+(B8)+(B19), (A)+(B8)+(B20), (A)+(B8)+(B21), (A)+(B8)+(B22), (A)+(B8)+(B23), (A)+(B8)+(B24), (A)+(B8)+(B25), (A)+(B8)+(B26), (A)+(B8)+(B27), (A)+(B8)+(B28), (A)+(B8)+(B29), (A)+(B8)+(B30), (A)+(B8)+(B31), (A)+(B8)+(B32), (A)+(B8)+(B33), (A)+(B8)+(B34), (A)+(B8)+(B35), (A)+(B8)+(B36), (A)+(B8)+(B37), (A)+(B8)+(B38), (A)+(B8)+(B39), (A)+(B8)+(B40), (A)+(B8)+(B41), (A)+(B8)+(B42), (A)+(B8)+(B43), (A)+(B8)+(B44), (A)+(B8)+(B45), (A)+(B8)+(B46), (A)+(B8)+(B47), (A)+(B8)+(B48), (A)+(B8)+(B49), (A)+(B8)+(B50), (A)+(B8)+(B51), (A)+(B8)+(B52), (A)+(B8)+(B53), (A)+(B8)+(B54), (A)+(B8)+(B55), (A)+(B8)+(B56), (A)+(B8)+(B57), (A)+(B8)+(B58), (A)+(B8)+(B59), (A)+(B8)+(B60), (A)+(B8)+(B61), (A)+(B8)+(B62), (A)+(B8)+(B63), (A)+(B8)+(B64), (A)+(B8)+(B65), (A)+(B8)+(B66), (A)+(B8)+(B67), (A)+(B8)+(B68), (A)+(B8)+(B69), (A)+(B8)+(B70), (A)+(B8)+(B71), (A)+(B8)+(B72), (A)+(B8)+(B73), (A)+(B8)+(B74), (A)+(B8)+(B75), (A)+(B8)+(B76), (A)+(B8)+(B77), (A)+(B8)+(B78), (A)+(B8)+(B79), (A)+(B8)+(B80), (A)+(B8)+(B81), (A)+(B8)+(B82), (A)+(B8)+(B83), (A)+(B8)+(B84), (A)+(B8)+(B85), (A)+(B8)+(B86), (A)+(B8)+(B87), (A)+(B8)+(B88), (A)+(B8)+(B89), (A)+(B8)+(B90), (A)+(B8)+(B91), (A)+(B8)+(B92), (A)+(B8)+(B93), (A)+(B8)+(B94), (A)+(B8)+(B95), (A)+(B8)+(B96), (A)+(B8)+(B97), (A)+(B8)+(B98), (A)+(B8)+(B99), (A)+(B8)+(B100), (A)+(B8)+(B101), (A)+(B8)+(B102), (A)+(B8)+(B103), (A)+(B8)+(B104), (A)+(B8)+(B105), (A)+(B8)+(B106), (A)+(B8)+(B107), (A)+(B8)+(B108), (A)+(B8)+(B109), (A)+(B8)+(B110), (A)+(B8)+(B111), (A)+(B8)+(B112), (A)+(B8)+(B113), (A)+(B8)+(B114), (A)+(B8)+(B115), (A)+(B8)+(B116), (A)+(B8)+(B117), (A)+(B8)+(B118), (A)+(B8)+(B119), (A)+(B8)+(B120), (A)+(B8)+(B121), (A)+(B8)+(B122), (A)+(B8)+(B123), (A)+(B8)+(B124), (A)+(B8)+(B125), (A)+(B8)+(B126), (A)+(B8)+(B127), (A)+(B8)+(B128), (A)+(B8)+(B129), (A)+(B8)+(B130), (A)+(B8)+(B131), (A)+(B8)+(B132), (A)+(B8)+(B133), (A)+(B8)+(B134), (A)+(B8)+(B135), (A)+(B8)+(B136), (A)+(B8)+(B137), (A)+(B8)+(B138), (A)+(B8)+(B139), (A)+(B8)+(B140), (A)+(B8)+(B141), (A)+(B8)+(B142), (A)+(B8)+(B143), (A)+(B8)+(B144), (A)+(B8)+(B145), (A)+(B8)+(B146), (A)+(B8)+(B147), (A)+(B8)+(B148), (A)+(B8)+(B149), (A)+(B8)+(B150), (A)+(B8)+(B151), (A)+(B8)+(B152), (A)+(B8)+(B153), (A)+(B8)+(B154), (A)+(B8)+(B155), (A)+(B8)+(B156), (A)+(B8)+(B157), (A)+(B8)+(B158), (A)+(B8)+(B159), (A)+(B8)+(B160), (A)+(B8)+(B161), (A)+(B8)+(B162), (A)+(B8)+(B164), (A)+(B8)+(B164), (A)+(B8)+(B165), (A)+(B8)+(B166), (A)+(B8)+(B167), (A)+(B8)+(B168), (A)+(B8)+(B169), (A)+(B8)+(B170), (A)+(B8)+(B171), (A)+(B8)+(B172), (A)+(B8)+(B173), (A)+(B8)+(B174), (A)+(B8)+(B175), (A)+(B8)+(B176), (A)+(B8)+(B177), (A)+(B8)+(B178), (A)+(B8)+(B179), (A)+(B8)+(B180), (A)+(B8)+(B181), (A)+(B8)+(B182), (A)+(B8)+(B183), (A)+(B8)+(B184), (A)+(B8)+(B185), (A)+(B8)+(B186), (A)+(B8)+(B187), (A)+(B8)+(B188), (A)+(B8)+(B189), (A)+(B8)+(B190), (A)+(B8)+(B191), (A)+(B8)+(B192), (A)+(B8)+(B193), (A)+(B8)+(B194), (A)+(B8)+(B195), (A)+(B8)+(B196), (A)+(B8)+(B197), (A)+(B8)+(B198), (A)+(B8)+(B199), (A)+(B8)+(B200), (A)+(B8)+(B201), (A)+(B8)+(B202), (A)+(B8)+(B203), (A)+(B8)+(B204), (A)+(B8)+(B205), (A)+(B8)+(B206), (A)+(B8)+(B207), (A)+(B8)+(B208), (A)+(B8)+(B209), (A)+(B8)+(B210), (A)+(B8)+(B211), (A)+(B8)+(B212), (A)+(B8)+(B213), (A)+(B8)+(B214), (A)+(B8)+(B215), (A)+(B8)+(B216), (A)+(B8)+(B217), (A)+(B8)+(B218), (A)+(B8)+(B219), (A)+(B8)+(B220), (A)+(B8)+(B221), (A)+(B8)+(B222), (A)+(B8)+(B223), (A)+(B8)+(B224), (A)+(B8)+(B225), (A)+(B8)+(B226), (A)+(B8)+(B227), (A)+(B8)+(B228), (A)+(B8)+(B229), (A)+(B8)+(B230), (A)+(B8)+(B231), (A)+(B8)+(B232), (A)+(B8)+(B233), (A)+(B8)+(B234), (A)+(B8)+(B235), (A)+(B8)+(B236), (A)+(B8)+(B237), (A)+(B8)+(B238), (A)+(B8)+(B239), (A)+(B8)+(B240), (A)+(B8)+(B241), (A)+(B8)+(B242), (A)+(B8)+(B243), (A)+(B8)+(B244), (A)+(B8)+(B245), (A)+(B8)+(B246), (A)+(B8)+(B247), (A)+(B8)+(B248), (A)+(B8)+(B249), (A)+(B8)+(B250), (A)+(B8)+(B251), (A)+(B8)+(B252), (A)+(B8)+(B253), (A)+(B8)+(B254), (A)+(B8)+(B255), (A)+(B8)+(B256), (A)+(B8)+(B257), (A)+(B8)+(B258), (A)+(B8)+(B259), (A)+(B8)+(B260), (A)+(B8)+(B261), (A)+(B8)+(B262), (A)+(B8)+(B263), (A)+(B8)+(B264), (A)+(B8)+(B265), (A)+(B8)+(B266), (A)+(B8)+(B267), (A)+(B8)+(B268), (A)+(B8)+(B269), (A)+(B8)+(B270), (A)+(B8)+(B271), (A)+(B8)+(B272), (A)+(B8)+(B273), (A)+(B8)+(B274), (A)+(B8)+(B275), (A)+(B8)+(B276), (A)+(B8)+(B277), (A)+(B8)+(B278), (A)+(B8)+(B279), (A)+(B8)+(B280), (A)+(B8)+(B281), (A)+(B8)+(B282), (A)+(B8)+(B283), (A)+(B8)+(B284), (A)+(B8)+(B285), (A)+(B8)+(B286), (A)+(B8)+(B287), (A)+(B8)+(B288), (A)+(B8)+(B289), (A)+(B8)+(B290), (A)+(B8)+(B291), (A)+(B8)+(B292), (A)+(B8)+(B293), (A)+(B8)+(B294), (A)+(B8)+(B295), (A)+(B8)+(B296), (A)+(B8)+(B297), (A)+(B8)+(B298), (A)+(B8)+(B299), (A)+(B8)+(B300), (A)+(B8)+(B301), (A)+(B8)+(B302), (A)+(B8)+(B303), (A)+(B8)+(B304), (A)+(B8)+(B305), (A)+(B8)+(B306), (A)+(B8)+(B307), (A)+(B8)+(B308), (A)+(B8)+(B309), (A)+(B8)+(B310), (A)+(B8)+(B311), (A)+(B8)+(B312), (A)+(B8)+(B313), (A)+(B8)+(B314), (A)+(B8)+(B315),

(A)+(B9)+(B10), (A)+(B9)+(B11), (A)+(B9)+(B12), (A)+(B9)+(B13), (A)+(B9)+(B14), (A)+(B9)+(B15), (A)+(B9)+(B16), (A)+(B9)+(B17), (A)+(B9)+(B18), (A)+(B9)+(B19), (A)+(B9)+(B20), (A)+(B9)+(B21), (A)+(B9)+(B22), (A)+(B9)+(B23), (A)+(B9)+(B24), (A)+(B9)+(B25), (A)+(B9)+(B26), (A)+(B9)+(B27), (A)+(B9)+(B28), (A)+(B9)+(B29), (A)+(B9)+(B30), (A)+(B9)+(B31), (A)+(B9)+(B32), (A)+(B9)+(B33), (A)+(B9)+(B34), (A)+(B9)+(B35), (A)+(B9)+(B36), (A)+(B9)+(B37), (A)+(B9)+(B38), (A)+(B9)+(B39), (A)+(B9)+(B40), (A)+(B9)+(B41), (A)+(B9)+(B42), (A)+(B9)+(B43), (A)+(B9)+(B44), (A)+(B9)+(B45), (A)+(B9)+(B46), (A)+(B9)+(B47), (A)+(B9)+(B48), (A)+(B9)+(B49), (A)+(B9)+(B50), (A)+(B9)+(B51), (A)+(B9)+(B52), (A)+(B9)+(B53), (A)+(B9)+(B54), (A)+(B9)+(B55), (A)+(B9)+(B56), (A)+(B9)+(B57), (A)+(B9)+(B58), (A)+(B9)+(B59), (A)+(B9)+(B60), (A)+(B9)+(B61), (A)+(B9)+(B62), (A)+(B9)+(B63), (A)+(B9)+(B64), (A)+(B9)+(B65), (A)+(B9)+(B66), (A)+(B9)+(B67), (A)+(B9)+(B68), (A)+(B9)+(B69), (A)+(B9)+(B70), (A)+(B9)+(B71), (A)+(B9)+(B72), (A)+(B9)+(B73), (A)+(B9)+(B74), (A)+(B9)+(B75), (A)+(B9)+(B76), (A)+(B9)+(B77), (A)+(B9)+(B78), (A)+(B9)+(B79), (A)+(B9)+(B80), (A)+(B9)+(B81), (A)+(B9)+(B82), (A)+(B9)+(B83), (A)+(B9)+(B84), (A)+(B9)+(B85), (A)+(B9)+(B86), (A)+(B9)+(B87), (A)+(B9)+(B88), (A)+(B9)+(B89), (A)+(B9)+(B90), (A)+(B9)+(B91), (A)+(B9)+(B92), (A)+(B9)+(B93), (A)+(B9)+(B94), (A)+(B9)+(B95), (A)+(B9)+(B96), (A)+(B9)+(B97), (A)+(B9)+(B98), (A)+(B9)+(B99), (A)+(B9)+(B100), (A)+(B9)+(B101), (A)+(B9)+(B102), (A)+(B9)+(B103), (A)+(B9)+(B104), (A)+(B9)+(B105), (A)+(B9)+(B106), (A)+(B9)+(B107), (A)+(B9)+(B108), (A)+(B9)+(B109), (A)+(B9)+(B110), (A)+(B9)+(B111), (A)+(B9)+(B112), (A)+(B9)+(B113), (A)+(B9)+(B114), (A)+(B9)+(B115), (A)+(B9)+(B116), (A)+(B9)+(B117), (A)+(B9)+(B118), (A)+(B9)+(B119), (A)+(B9)+(B120), (A)+(B9)+(B121), (A)+(B9)+(B122), (A)+(B9)+(B123), (A)+(B9)+(B124), (A)+(B9)+(B125), (A)+(B9)+(B126), (A)+(B9)+(B127), (A)+(B9)+(B128), (A)+(B9)+(B129), (A)+(B9)+(B130), (A)+(B9)+(B131), (A)+(B9)+(B132), (A)+(B9)+(B133), (A)+(B9)+(B134), (A)+(B9)+(B135), (A)+(B9)+(B136), (A)+(B9)+(B137), (A)+(B9)+(B138), (A)+(B9)+(B139), (A)+(B9)+(B140), (A)+(B9)+(B141), (A)+(B9)+(B142), (A)+(B9)+(B143), (A)+(B9)+(B144), (A)+(B9)+(B145), (A)+(B9)+(B146), (A)+(B9)+(B147), (A)+(B9)+(B148), (A)+(B9)+(B149), (A)+(B9)+(B150), (A)+(B9)+(B151), (A)+(B9)+(B152), (A)+(B9)+(B153), (A)+(B9)+(B154), (A)+(B9)+(B155), (A)+(B9)+(B156), (A)+(B9)+(B157), (A)+(B9)+(B158), (A)+(B9)+(B159), (A)+(B9)+(B160), (A)+(B9)+(B161), (A)+(B9)+(B162), (A)+(B9)+(B164), (A)+(B9)+(B164), (A)+(B9)+(B165), (A)+(B9)+(B166), (A)+(B9)+(B167), (A)+(B9)+(B168), (A)+(B9)+(B169), (A)+(B9)+(B170), (A)+(B9)+(B171), (A)+(B9)+(B172), (A)+(B9)+(B173), (A)+(B9)+(B174), (A)+(B9)+(B175), (A)+(B9)+(B176), (A)+(B9)+(B177), (A)+(B9)+(B178), (A)+(B9)+(B179), (A)+(B9)+(B180), (A)+(B9)+(B181), (A)+(B9)+(B182), (A)+(B9)+(B183), (A)+(B9)+(B184), (A)+(B9)+(B185), (A)+(B9)+(B186), (A)+(B9)+(B187), (A)+(B9)+(B188), (A)+(B9)+(B189), (A)+(B9)+(B190), (A)+(B9)+(B191), (A)+(B9)+(B192), (A)+(B9)+(B193), (A)+(B9)+(B194), (A)+(B9)+(B195), (A)+(B9)+(B196), (A)+(B9)+(B197), (A)+(B9)+(B198), (A)+(B9)+(B199), (A)+(B9)+(B200), (A)+(B9)+(B201), (A)+(B9)+(B202), (A)+(B9)+(B203), (A)+(B9)+(B204), (A)+(B9)+(B205), (A)+(B9)+(B206), (A)+(B9)+(B207), (A)+(B9)+(B208), (A)+(B9)+(B209), (A)+(B9)+(B210), (A)+(B9)+(B211), (A)+(B9)+(B212), (A)+(B9)+(B213), (A)+(B9)+(B214), (A)+(B9)+(B215), (A)+(B9)+(B216), (A)+(B9)+(B217), (A)+(B9)+(B218), (A)+(B9)+(B219), (A)+(B9)+(B220), (A)+(B9)+(B221), (A)+(B9)+(B222), (A)+(B9)+(B223), (A)+(B9)+(B224), (A)+(B9)+(B225), (A)+(B9)+(B226), (A)+(B9)+(B227), (A)+(B9)+(B228), (A)+(B9)+(B229), (A)+(B9)+(B230), (A)+(B9)+(B231), (A)+(B9)+(B232), (A)+(B9)+(B233), (A)+(B9)+(B234), (A)+(B9)+(B235), (A)+(B9)+(B236), (A)+(B9)+(B237), (A)+(B9)+(B238), (A)+(B9)+(B239), (A)+(B9)+(B240), (A)+(B9)+(B241), (A)+(B9)+(B242), (A)+(B9)+(B243), (A)+(B9)+(B244), (A)+(B9)+(B245), (A)+(B9)+(B246), (A)+(B9)+(B247), (A)+(B9)+(B248), (A)+(B9)+(B249), (A)+(B9)+(B250), (A)+(B9)+(B251), (A)+(B9)+(B252), (A)+(B9)+(B253), (A)+(B9)+(B254), (A)+(B9)+(B255), (A)+(B9)+(B256), (A)+(B9)+(B257), (A)+(B9)+(B258), (A)+(B9)+(B259), (A)+(B9)+(B260), (A)+(B9)+(B261), (A)+(B9)+(B262), (A)+(B9)+(B263), (A)+(B9)+(B264), (A)+(B9)+(B265), (A)+(B9)+(B266), (A)+(B9)+(B267), (A)+(B9)+(B268), (A)+(B9)+(B269), (A)+(B9)+(B270), (A)+(B9)+(B271), (A)+(B9)+(B272), (A)+(B9)+(B273), (A)+(B9)+(B274), (A)+(B9)+(B275), (A)+(B9)+(B276), (A)+(B9)+(B277), (A)+(B9)+(B278), (A)+(B9)+(B279), (A)+(B9)+(B280), (A)+(B9)+(B281), (A)+(B9)+(B282), (A)+(B9)+(B283), (A)+(B9)+(B284), (A)+(B9)+(B285), (A)+(B9)+(B286), (A)+(B9)+(B287), (A)+(B9)+(B288), (A)+(B9)+(B289), (A)+(B9)+(B290), (A)+(B9)+(B291), (A)+(B9)+(B292), (A)+(B9)+(B293), (A)+(B9)+(B294), (A)+(B9)+(B295), (A)+(B9)+(B296), (A)+(B9)+(B297), (A)+(B9)+(B298), (A)+(B9)+(B299), (A)+(B9)+(B300), (A)+(B9)+(B301), (A)+(B9)+(B302), (A)+(B9)+(B303), (A)+(B9)+(B304), (A)+(B9)+(B305), (A)+(B9)+(B306), (A)+(B9)+(B307), (A)+(B9)+(B308), (A)+(B9)+(B309), (A)+(B9)+(B310), (A)+(B9)+(B311), (A)+(B9)+(B312), (A)+(B9)+(B313), (A)+(B9)+(B314), (A)+(B9)+(B315),

(A)+(B10)+(B11), (A)+(B10)+(B12), (A)+(B10)+(B13), (A)+(B10)+(B14), (A)+(B10)+(B15), (A)+(B10)+(B16), (A)+(B10)+(B17), (A)+(B10)+(B18), (A)+(B10)+(B19), (A)+(B10)+(B20), (A)+(B10)+(B21), (A)+(B10)+(B22), (A)+(B10)+(B23), (A)+(B10)+(B24), (A)+(B10)+(B25), (A)+(B10)+(B26), (A)+(B10)+(B27), (A)+(B10)+(B28), (A)+(B10)+(B29), (A)+(B10)+(B30), (A)+(B10)+(B31), (A)+(B10)+(B32), (A)+(B10)+(B33), (A)+(B10)+(B34), (A)+(B10)+(B35), (A)+(B10)+(B36), (A)+(B10)+(B37), (A)+(B10)+(B38), (A)+(B10)+(B39), (A)+(B10)+(B40), (A)+(B10)+(B41), (A)+(B10)+(B42), (A)+(B10)+(B43), (A)+(B10)+(B44), (A)+(B10)+(B45), (A)+(B10)+(B46), (A)+(B10)+(B47), (A)+(B10)+(B48), (A)+(B10)+(B49), (A)+(B10)+(B50), (A)+(B10)+(B51), (A)+(B10)+(B52), (A)+(B10)+(B53), (A)+(B10)+(B54), (A)+(B10)+(B55), (A)+(B10)+(B56), (A)+(B10)+(B57), (A)+(B10)+(B58), (A)+(B10)+(B59), (A)+(B10)+(B60), (A)+(B10)+(B61), (A)+(B10)+(B62), (A)+(B10)+(B63), (A)+(B10)+(B64), (A)+(B10)+(B65), (A)+(B10)+(B66), (A)+(B10)+(B67), (A)+(B10)+(B68), (A)+(B10)+(B69), (A)+(B10)+(B70), (A)+(B10)+(B71), (A)+(B10)+(B72), (A)+(B10)+(B73), (A)+(B10)+(B74), (A)+(B10)+(B75), (A)+(B10)+(B76), (A)+(B10)+(B77), (A)+(B10)+(B78), (A)+(B10)+(B79), (A)+(B10)+(B80), (A)+(B10)+(B81), (A)+(B10)+(B82), (A)+(B10)+(B83), (A)+(B10)+(B84), (A)+(B10)+(B85), (A)+(B10)+(B86), (A)+(B10)+(B87), (A)+(B10)+(B88), (A)+(B10)+(B89), (A)+(B10)+(B90), (A)+(B10)+(B91), (A)+(B10)+(B92), (A)+(B10)+(B93), (A)+(B10)+(B94), (A)+(B10)+(B95), (A)+(B10)+(B96), (A)+(B10)+(B97), (A)+(B10)+(B98), (A)+(B10)+(B99), (A)+(B10)+(B100), (A)+(B10)+(B101), (A)+(B10)+(B102), (A)+(B10)+(B103), (A)+(B10)+(B104), (A)+(B10)+(B105), (A)+(B10)+(B106), (A)+(B10)+(B107), (A)+(B10)+(B108), (A)+(B10)+(B109), (A)+(B10)+(B110), (A)+(B10)+(B111), (A)+(B10)+(B112), (A)+(B10)+(B113), (A)+(B10)+(B114), (A)+(B10)+(B115), (A)+(B10)+(B116), (A)+(B10)+(B117), (A)+(B10)+(B118), (A)+(B10)+(B119), (A)+(B10)+(B120), (A)+(B10)+(B121), (A)+(B10)+(B122), (A)+(B10)+(B123), (A)+(B10)+(B124), (A)+(B10)+(B125), (A)+(B10)+(B126), (A)+(B10)+(B127), (A)+(B10)+(B128), (A)+(B10)+(B129), (A)+(B10)+(B130), (A)+(B10)+(B131), (A)+(B10)+(B132), (A)+(B10)+(B133), (A)+(B10)+(B134), (A)+(B10)+(B135), (A)+(B10)+(B136), (A)+(B10)+(B137), (A)+(B10)+(B138), (A)+(B10)+(B139), (A)+(B10)+(B140), (A)+(B10)+(B141), (A)+(B10)+(B142), (A)+(B10)+(B143), (A)+(B10)+(B144), (A)+(B10)+(B145), (A)+(B10)+(B146), (A)+(B10)+(B147), (A)+(B10)+(B148), (A)+(B10)+(B149), (A)+(B10)+(B150), (A)+(B10)+(B151), (A)+(B10)+(B152), (A)+(B10)+(B153), (A)+(B10)+(B154), (A)+(B10)+(B155), (A)+(B10)+(B156), (A)+(B10)+(B157), (A)+(B10)+(B158), (A)+(B10)+(B159), (A)+(B10)+(B160), (A)+(B10)+(B161), (A)+(B10)+(B162), (A)+(B10)+(B164), (A)+(B10)+(B164), (A)+(B10)+(B165), (A)+(B10)+(B166), (A)+(B10)+(B167), (A)+(B10)+(B168), (A)+(B10)+(B169), (A)+(B10)+(B170), (A)+(B10)+(B171), (A)+(B10)+(B172), (A)+(B10)+(B173), (A)+(B10)+(B174), (A)+(B10)+(B175), (A)+(B10)+(B176), (A)+(B10)+(B177), (A)+(B10)+(B178), (A)+(B10)+(B179), (A)+(B10)+(B180), (A)+(B10)+(B181), (A)+(B10)+(B182), (A)+(B10)+(B183), (A)+(B10)+(B184), (A)+(B10)+(B185), (A)+(B10)+(B186), (A)+(B10)+(B187), (A)+(B10)+(B188), (A)+(B10)+(B189), (A)+(B10)+(B190), (A)+(B10)+(B191), (A)+(B10)+(B192), (A)+(B10)+(B193), (A)+(B10)+(B194), (A)+(B10)+(B195), (A)+(B10)+(B196), (A)+(B10)+(B197), (A)+(B10)+(B198), (A)+(B10)+(B199), (A)+(B10)+(B200), (A)+(B10)+(B201), (A)+(B10)+(B202), (A)+(B10)+(B203), (A)+(B10)+(B204), (A)+(B10)+(B205), (A)+(B10)+(B206), (A)+(B10)+(B207), (A)+(B10)+(B208), (A)+(B10)+(B209), (A)+(B10)+(B210), (A)+(B10)+(B211), (A)+(B10)+(B212), (A)+(B10)+(B213), (A)+(B10)+(B214), (A)+(B10)+(B215), (A)+(B10)+(B216), (A)+(B10)+(B217), (A)+(B10)+(B218), (A)+(B10)+(B219), (A)+(B10)+(B220), (A)+(B10)+(B221), (A)+(B10)+(B222), (A)+(B10)+(B223), (A)+(B10)+(B224), (A)+(B10)+(B225), (A)+(B10)+(B226), (A)+(B10)+(B227), (A)+(B10)+(B228), (A)+(B10)+(B229), (A)+(B10)+(B230), (A)+(B10)+(B231), (A)+(B10)+(B232), (A)+(B10)+(B233), (A)+(B10)+(B234), (A)+(B10)+(B235), (A)+(B10)+(B236), (A)+(B10)+(B237), (A)+(B10)+(B238), (A)+(B10)+(B239), (A)+(B10)+(B240), (A)+(B10)+(B241), (A)+(B10)+(B242), (A)+(B10)+(B243), (A)+(B10)+(B244), (A)+(B10)+(B245), (A)+(B10)+(B246), (A)+(B10)+(B247), (A)+(B10)+(B248), (A)+(B10)+(B249), (A)+(B10)+(B250), (A)+(B10)+(B251), (A)+(B10)+(B252), (A)+(B10)+(B253), (A)+(B10)+(B254), (A)+(B10)+(B255), (A)+(B10)+(B256), (A)+(B10)+(B257), (A)+(B10)+(B258), (A)+(B10)+(B259), (A)+(B10)+(B260), (A)+(B10)+(B261), (A)+(B10)+(B262), (A)+(B10)+(B263), (A)+(B10)+(B264), (A)+(B10)+(B265), (A)+(B10)+(B266), (A)+(B10)+(B267), (A)+(B10)+(B268), (A)+(B10)+(B269), (A)+(B10)+(B270), (A)+(B10)+(B271), (A)+(B10)+(B272), (A)+(B10)+(B273), (A)+(B10)+(B274), (A)+(B10)+(B275), (A)+(B10)+(B276), (A)+(B10)+(B277), (A)+(B10)+(B278), (A)+(B10)+(B279), (A)+(B10)+(B280), (A)+(B10)+(B281), (A)+(B10)+(B282), (A)+(B10)+(B283), (A)+(B10)+(B284), (A)+(B10)+(B285), (A)+(B10)+(B286), (A)+(B10)+(B287), (A)+(B10)+(B288), (A)+(B10)+(B289), (A)+(B10)+(B290), (A)+(B10)+(B291), (A)+(B10)+(B292), (A)+(B10)+(B293), (A)+(B10)+(B294), (A)+(B10)+(B295), (A)+(B10)+(B296), (A)+(B10)+(B297), (A)+(B10)+(B298), (A)+(B10)+(B299), (A)+(B10)+(B300), (A)+(B10)+(B301), (A)+(B10)+(B302), (A)+(B10)+(B303), (A)+(B10)+(B304), (A)+(B10)+(B305), (A)+(B10)+(B306), (A)+(B10)+(B307), (A)+(B10)+(B308), (A)+(B10)+(B309), (A)+(B10)+(B310), (A)+(B10)+(B311), (A)+(B10)+(B312), (A)+(B10)+(B313), (A)+(B10)+(B314), (A)+(B10)+(B315),

(A)+(B11)+(B12), (A)+(B11)+(B13), (A)+(B11)+(B14), (A)+(B11)+(B15), (A)+(B11)+(B16), (A)+(B11)+(B17), (A)+(B11)+(B18), (A)+(B11)+(B19), (A)+(B11)+(B20), (A)+(B11)+(B21), (A)+(B11)+(B22), (A)+(B11)+(B23), (A)+(B11)+(B24), (A)+(B11)+(B25), (A)+(B11)+(B26), (A)+(B11)+(B27), (A)+(B11)+(B28), (A)+(B11)+(B29), (A)+(B11)+(B30), (A)+(B11)+(B31), (A)+(B11)+(B32), (A)+(B11)+(B33), (A)+(B11)+(B34), (A)+(B11)+(B35), (A)+(B11)+(B36), (A)+(B11)+(B37), (A)+(B11)+(B38), (A)+(B11)+(B39), (A)+(B11)+(B40), (A)+(B11)+(B41), (A)+(B11)+(B42), (A)+(B11)+(B43), (A)+(B11)+(B44), (A)+(B11)+(B45), (A)+(B11)+(B46), (A)+(B11)+(B47), (A)+(B11)+(B48), (A)+(B11)+(B49), (A)+(B11)+(B50), (A)+(B11)+(B51), (A)+(B11)+(B52), (A)+(B11)+(B53), (A)+(B11)+(B54), (A)+(B11)+(B55), (A)+(B11)+(B56), (A)+(B11)+(B57), (A)+(B11)+(B58), (A)+(B11)+(B59), (A)+(B11)+(B60), (A)+(B11)+(B61), (A)+(B11)+(B62), (A)+(B11)+(B63), (A)+(B11)+(B64), (A)+(B11)+(B65), (A)+(B11)+(B66), (A)+(B11)+(B67), (A)+(B11)+(B68), (A)+(B11)+(B69), (A)+(B11)+(B70), (A)+(B11)+(B71), (A)+(B11)+(B72), (A)+(B11)+(B73), (A)+(B11)+(B74), (A)+(B11)+(B75), (A)+(B11)+(B76), (A)+(B11)+(B77), (A)+(B11)+(B78), (A)+(B11)+(B79), (A)+(B11)+(B80), (A)+(B11)+(B81), (A)+(B11)+(B82), (A)+(B11)+(B83), (A)+(B11)+(B84), (A)+(B11)+(B85), (A)+(B11)+(B86), (A)+(B11)+(B87), (A)+(B11)+(B88), (A)+(B11)+(B89), (A)+(B11)+(B90), (A)+(B11)+(B91), (A)+(B11)+(B92), (A)+(B11)+(B93), (A)+(B11)+(B94), (A)+(B11)+(B95), (A)+(B11)+(B96), (A)+(B11)+(B97), (A)+(B11)+(B98), (A)+(B11)+(B99), (A)+(B11)+(B100), (A)+(B11)+(B101), (A)+(B11)+(B102), (A)+(B11)+(B103), (A)+(B11)+(B104), (A)+(B11)+(B105), (A)+(B11)+(B106), (A)+(B11)+(B107), (A)+(B11)+(B108), (A)+(B11)+(B109), (A)+(B11)+(B110), (A)+(B11)+(B111), (A)+(B11)+(B112), (A)+(B11)+(B113), (A)+(B11)+(B114), (A)+(B11)+(B115), (A)+(B11)+(B116), (A)+(B11)+(B117), (A)+(B11)+(B118), (A)+(B11)+(B119), (A)+(B11)+(B120), (A)+(B11)+(B121), (A)+(B11)+(B122), (A)+(B11)+(B123), (A)+(B11)+(B124), (A)+(B11)+(B125), (A)+(B11)+(B126), (A)+(B11)+(B127), (A)+(B11)+(B128), (A)+(B11)+(B129), (A)+(B11)+(B130), (A)+(B11)+(B131), (A)+(B11)+(B132), (A)+(B11)+(B133), (A)+(B11)+(B134), (A)+(B11)+(B135), (A)+(B11)+(B136), (A)+(B11)+(B137), (A)+(B11)+(B138), (A)+(B11)+(B139), (A)+(B11)+(B140), (A)+(B11)+(B141), (A)+(B11)+(B142), (A)+(B11)+(B143), (A)+(B11)+(B144), (A)+(B11)+(B145), (A)+(B11)+(B146), (A)+(B11)+(B147), (A)+(B11)+(B148), (A)+(B11)+(B149), (A)+(B11)+(B150), (A)+(B11)+(B151), (A)+(B11)+(B152), (A)+(B11)+(B153), (A)+(B11)+(B154), (A)+(B11)+(B155), (A)+(B11)+(B156), (A)+(B11)+(B157), (A)+(B11)+(B158), (A)+(B11)+(B159), (A)+(B11)+(B160), (A)+(B11)+(B161), (A)+(B11)+(B162), (A)+(B11)+(B164), (A)+(B11)+(B164), (A)+(B11)+(B165), (A)+(B11)+(B166), (A)+(B11)+(B167), (A)+(B11)+(B168), (A)+(B11)+(B169), (A)+(B11)+(B170), (A)+(B11)+(B171), (A)+(B11)+(B172), (A)+(B11)+(B173), (A)+(B11)+(B174), (A)+(B11)+(B175), (A)+(B11)+(B176), (A)+(B11)+(B177), (A)+(B11)+(B178), (A)+(B11)+(B179), (A)+(B11)+(B180), (A)+(B11)+(B181), (A)+(B11)+(B182), (A)+(B11)+(B183), (A)+(B11)+(B184), (A)+(B11)+(B185), (A)+(B11)+(B186), (A)+(B11)+(B187), (A)+(B11)+(B188), (A)+(B11)+(B189), (A)+(B11)+(B190), (A)+(B11)+(B191), (A)+(B11)+(B192), (A)+(B11)+(B193), (A)+(B11)+(B194), (A)+(B11)+(B195), (A)+(B11)+(B196), (A)+(B11)+(B197), (A)+(B11)+(B198), (A)+(B11)+(B199), (A)+(B11)+(B200), (A)+(B11)+(B201), (A)+(B11)+(B202), (A)+(B11)+(B203), (A)+(B11)+(B204), (A)+(B11)+(B205), (A)+(B11)+(B206), (A)+(B11)+(B207), (A)+(B11)+(B208), (A)+(B11)+(B209), (A)+(B11)+(B210), (A)+(B11)+(B211), (A)+(B11)+(B212), (A)+(B11)+(B213), (A)+(B11)+(B214), (A)+(B11)+(B215), (A)+(B11)+(B216), (A)+(B11)+(B217), (A)+(B11)+(B218), (A)+(B11)+(B219), (A)+(B11)+(B220), (A)+(B11)+(B221), (A)+(B11)+(B222), (A)+(B11)+(B223), (A)+(B11)+(B224), (A)+(B11)+(B225), (A)+(B11)+(B226), (A)+(B11)+(B227), (A)+(B11)+(B228), (A)+(B11)+(B229), (A)+(B11)+(B230), (A)+(B11)+(B231), (A)+(B11)+(B232), (A)+(B11)+(B233), (A)+(B11)+(B234), (A)+(B11)+(B235), (A)+(B11)+(B236), (A)+(B11)+(B237), (A)+(B11)+(B238), (A)+(B11)+(B239), (A)+(B11)+(B240), (A)+(B11)+(B241), (A)+(B11)+(B242), (A)+(B11)+(B243), (A)+(B11)+(B244), (A)+(B11)+(B245), (A)+(B11)+(B246), (A)+(B11)+(B247), (A)+(B11)+(B248), (A)+(B11)+(B249), (A)+(B11)+(B250), (A)+(B11)+(B251), (A)+(B11)+(B252), (A)+(B11)+(B253), (A)+(B11)+(B254), (A)+(B11)+(B255), (A)+(B11)+(B256), (A)+(B11)+(B257), (A)+(B11)+(B258), (A)+(B11)+(B259), (A)+(B11)+(B260), (A)+(B11)+(B261), (A)+(B11)+(B262), (A)+(B11)+(B263), (A)+(B11)+(B264), (A)+(B11)+(B265), (A)+(B11)+(B266), (A)+(B11)+(B267), (A)+(B11)+(B268), (A)+(B11)+(B269), (A)+(B11)+(B270), (A)+(B11)+(B271), (A)+(B11)+(B272), (A)+(B11)+(B273), (A)+(B11)+(B274), (A)+(B11)+(B275), (A)+(B11)+(B276), (A)+(B11)+(B277), (A)+(B11)+(B278), (A)+(B11)+(B279), (A)+(B11)+(B280), (A)+(B11)+(B281), (A)+(B11)+(B282), (A)+(B11)+(B283), (A)+(B11)+(B284), (A)+(B11)+(B285), (A)+(B11)+(B286), (A)+(B11)+(B287), (A)+(B11)+(B288), (A)+(B11)+(B289), (A)+(B11)+(B290), (A)+(B11)+(B291), (A)+(B11)+(B292), (A)+(B11)+(B293), (A)+(B11)+(B294), (A)+(B11)+(B295), (A)+(B11)+(B296), (A)+(B11)+(B297), (A)+(B11)+(B298), (A)+(B11)+(B299), (A)+(B11)+(B300), (A)+(B11)+(B301), (A)+(B11)+(B302), (A)+(B11)+(B303), (A)+(B11)+(B304), (A)+(B11)+(B305), (A)+(B11)+(B306), (A)+(B11)+(B307), (A)+(B11)+(B308), (A)+(B11)+(B309), (A)+(B11)+(B310), (A)+(B11)+(B311), (A)+(B11)+(B312), (A)+(B11)+(B313), (A)+(B11)+(B314), (A)+(B11)+(B315),

(A)+(B12)+(B13), (A)+(B12)+(B14), (A)+(B12)+(B15), (A)+(B12)+(B16), (A)+(B12)+(B17), (A)+(B12)+(B18), (A)+(B12)+(B19), (A)+(B12)+(B20), (A)+(B12)+(B21), (A)+(B12)+(B22), (A)+(B12)+(B23), (A)+(B12)+(B24), (A)+(B12)+(B25), (A)+(B12)+(B26), (A)+(B12)+(B27), (A)+(B12)+(B28), (A)+(B12)+(B29), (A)+(B12)+(B30), (A)+(B12)+(B31), (A)+(B12)+(B32), (A)+(B12)+(B33), (A)+(B12)+(B34), (A)+(B12)+(B35), (A)+(B12)+(B36), (A)+(B12)+(B37), (A)+(B12)+(B38), (A)+(B12)+(B39), (A)+(B12)+(B40), (A)+(B12)+(B41), (A)+(B12)+(B42), (A)+(B12)+(B43), (A)+(B12)+(B44), (A)+(B12)+(B45), (A)+(B12)+(B46), (A)+(B12)+(B47), (A)+(B12)+(B48), (A)+(B12)+(B49), (A)+(B12)+(B50), (A)+(B12)+(B51), (A)+(B12)+(B52), (A)+(B12)+(B53), (A)+(B12)+(B54), (A)+(B12)+(B55), (A)+(B12)+(B56), (A)+(B12)+(B57), (A)+(B12)+(B58), (A)+(B12)+(B59), (A)+(B12)+(B60), (A)+(B12)+(B61), (A)+(B12)+(B62), (A)+(B12)+(B63), (A)+(B12)+(B64), (A)+(B12)+(B65), (A)+(B12)+(B66), (A)+(B12)+(B67), (A)+(B12)+(B68), (A)+(B12)+(B69), (A)+(B12)+(B70), (A)+(B12)+(B71), (A)+(B12)+(B72), (A)+(B12)+(B73), (A)+(B12)+(B74), (A)+(B12)+(B75), (A)+(B12)+(B76), (A)+(B12)+(B77), (A)+(B12)+(B78), (A)+(B12)+(B79), (A)+(B12)+(B80), (A)+(B12)+(B81), (A)+(B12)+(B82), (A)+(B12)+(B83), (A)+(B12)+(B84), (A)+(B12)+(B85), (A)+(B12)+(B86), (A)+(B12)+(B87), (A)+(B12)+(B88), (A)+(B12)+(B89), (A)+(B12)+(B90), (A)+(B12)+(B91), (A)+(B12)+(B92), (A)+(B12)+(B93), (A)+(B12)+(B94), (A)+(B12)+(B95), (A)+(B12)+(B96), (A)+(B12)+(B97), (A)+(B12)+(B98), (A)+(B12)+(B99), (A)+(B12)+(B100), (A)+(B12)+(B101), (A)+(B12)+(B102), (A)+(B12)+(B103), (A)+(B12)+(B104), (A)+(B12)+(B105), (A)+(B12)+(B106), (A)+(B12)+(B107), (A)+(B12)+(B108), (A)+(B12)+(B109), (A)+(B12)+(B110), (A)+(B12)+(B111), (A)+(B12)+(B112), (A)+(B12)+(B113), (A)+(B12)+(B114), (A)+(B12)+(B115), (A)+(B12)+(B116), (A)+(B12)+(B117), (A)+(B12)+(B118), (A)+(B12)+(B119), (A)+(B12)+(B120), (A)+(B12)+(B121), (A)+(B12)+(B122), (A)+(B12)+(B123), (A)+(B12)+(B124), (A)+(B12)+(B125), (A)+(B12)+(B126), (A)+(B12)+(B127), (A)+(B12)+(B128), (A)+(B12)+(B129), (A)+(B12)+(B130), (A)+(B12)+(B131), (A)+(B12)+(B132), (A)+(B12)+(B133), (A)+(B12)+(B134), (A)+(B12)+(B135), (A)+(B12)+(B136), (A)+(B12)+(B137), (A)+(B12)+(B138), (A)+(B12)+(B139), (A)+(B12)+(B140), (A)+(B12)+(B141), (A)+(B12)+(B142), (A)+(B12)+(B143), (A)+(B12)+(B144), (A)+(B12)+(B145), (A)+(B12)+(B146), (A)+(B12)+(B147), (A)+(B12)+(B148), (A)+(B12)+(B149), (A)+(B12)+(B150), (A)+(B12)+(B151), (A)+(B12)+(B152), (A)+(B12)+(B153), (A)+(B12)+(B154), (A)+(B12)+(B155), (A)+(B12)+(B156), (A)+(B12)+(B157), (A)+(B12)+(B158), (A)+(B12)+(B159), (A)+(B12)+(B160), (A)+(B12)+(B161), (A)+(B12)+(B162), (A)+(B12)+(B164), (A)+(B12)+(B164), (A)+(B12)+(B165), (A)+(B12)+(B166), (A)+(B12)+(B167), (A)+(B12)+(B168), (A)+(B12)+(B169), (A)+(B12)+(B170), (A)+(B12)+(B171), (A)+(B12)+(B172), (A)+(B12)+(B173), (A)+(B12)+(B174), (A)+(B12)+(B175), (A)+(B12)+(B176), (A)+(B12)+(B177), (A)+(B12)+(B178), (A)+(B12)+(B179), (A)+(B12)+(B180), (A)+(B12)+(B181), (A)+(B12)+(B182), (A)+(B12)+(B183), (A)+(B12)+(B184), (A)+(B12)+(B185), (A)+(B12)+(B186), (A)+(B12)+(B187), (A)+(B12)+(B188), (A)+(B12)+(B189), (A)+(B12)+(B190), (A)+(B12)+(B191), (A)+(B12)+(B192), (A)+(B12)+(B193), (A)+(B12)+(B194), (A)+(B12)+(B195), (A)+(B12)+(B196), (A)+(B12)+(B197), (A)+(B12)+(B198), (A)+(B12)+(B199), (A)+(B12)+(B200), (A)+(B12)+(B201), (A)+(B12)+(B202), (A)+(B12)+(B203), (A)+(B12)+(B204), (A)+(B12)+(B205), (A)+(B12)+(B206), (A)+(B12)+(B207), (A)+(B12)+(B208), (A)+(B12)+(B209), (A)+(B12)+(B210), (A)+(B12)+(B211), (A)+(B12)+(B212), (A)+(B12)+(B213), (A)+(B12)+(B214), (A)+(B12)+(B215), (A)+(B12)+(B216), (A)+(B12)+(B217), (A)+(B12)+(B218), (A)+(B12)+(B219), (A)+(B12)+(B220), (A)+(B12)+(B221), (A)+(B12)+(B222), (A)+(B12)+(B223), (A)+(B12)+(B224), (A)+(B12)+(B225), (A)+(B12)+(B226), (A)+(B12)+(B227), (A)+(B12)+(B228), (A)+(B12)+(B229), (A)+(B12)+(B230), (A)+(B12)+(B231), (A)+(B12)+(B232), (A)+(B12)+(B233), (A)+(B12)+(B234), (A)+(B12)+(B235), (A)+(B12)+(B236), (A)+(B12)+(B237), (A)+(B12)+(B238), (A)+(B12)+(B239), (A)+(B12)+(B240), (A)+(B12)+(B241), (A)+(B12)+(B242), (A)+(B12)+(B243), (A)+(B12)+(B244), (A)+(B12)+(B245), (A)+(B12)+(B246), (A)+(B12)+(B247), (A)+(B12)+(B248), (A)+(B12)+(B249), (A)+(B12)+(B250), (A)+(B12)+(B251), (A)+(B12)+(B252), (A)+(B12)+(B253), (A)+(B12)+(B254), (A)+(B12)+(B255), (A)+(B12)+(B256), (A)+(B12)+(B257), (A)+(B12)+(B258), (A)+(B12)+(B259), (A)+(B12)+(B260), (A)+(B12)+(B261), (A)+(B12)+(B262), (A)+(B12)+(B263), (A)+(B12)+(B264), (A)+(B12)+(B265), (A)+(B12)+(B266), (A)+(B12)+(B267), (A)+(B12)+(B268), (A)+(B12)+(B269), (A)+(B12)+(B270), (A)+(B12)+(B271), (A)+(B12)+(B272), (A)+(B12)+(B273), (A)+(B12)+(B274), (A)+(B12)+(B275), (A)+(B12)+(B276), (A)+(B12)+(B277), (A)+(B12)+(B278), (A)+(B12)+(B279), (A)+(B12)+(B280), (A)+(B12)+(B281), (A)+(B12)+(B282), (A)+(B12)+(B283), (A)+(B12)+(B284), (A)+(B12)+(B285), (A)+(B12)+(B286), (A)+(B12)+(B287), (A)+(B12)+(B288), (A)+(B12)+(B289), (A)+(B12)+(B290), (A)+(B12)+(B291), (A)+(B12)+(B292), (A)+(B12)+(B293), (A)+(B12)+(B294), (A)+(B12)+(B295), (A)+(B12)+(B296), (A)+(B12)+(B297), (A)+(B12)+(B298), (A)+(B12)+(B299), (A)+(B12)+(B300), (A)+(B12)+(B301), (A)+(B12)+(B302), (A)+(B12)+(B303), (A)+(B12)+(B304), (A)+(B12)+(B305), (A)+(B12)+(B306), (A)+(B12)+(B307), (A)+(B12)+(B308), (A)+(B12)+(B309), (A)+(B12)+(B310), (A)+(B12)+(B311), (A)+(B12)+(B312), (A)+(B12)+(B313), (A)+(B12)+(B314), (A)+(B12)+(B315),

(A)+(B13)+(B14), (A)+(B13)+(B15), (A)+(B13)+(B16), (A)+(B13)+(B17), (A)+(B13)+(B18), (A)+(B13)+(B19), (A)+(B13)+(B20), (A)+(B13)+(B21), (A)+(B13)+(B22), (A)+(B13)+(B23), (A)+(B13)+(B24), (A)+(B13)+(B25), (A)+(B13)+(B26), (A)+(B13)+(B27), (A)+(B13)+(B28), (A)+(B13)+(B29), (A)+(B13)+(B30), (A)+(B13)+(B31), (A)+(B13)+(B32), (A)+(B13)+(B33), (A)+(B13)+(B34), (A)+(B13)+(B35), (A)+(B13)+(B36), (A)+(B13)+(B37), (A)+(B13)+(B38), (A)+(B13)+(B39), (A)+(B13)+(B40), (A)+(B13)+(B41), (A)+(B13)+(B42), (A)+(B13)+(B43), (A)+(B13)+(B44), (A)+(B13)+(B45), (A)+(B13)+(B46), (A)+(B13)+(B47), (A)+(B13)+(B48), (A)+(B13)+(B49), (A)+(B13)+(B50), (A)+(B13)+(B51), (A)+(B13)+(B52), (A)+(B13)+(B53), (A)+(B13)+(B54), (A)+(B13)+(B55), (A)+(B13)+(B56), (A)+(B13)+(B57), (A)+(B13)+(B58), (A)+(B13)+(B59), (A)+(B13)+(B60), (A)+(B13)+(B61), (A)+(B13)+(B62), (A)+(B13)+(B63), (A)+(B13)+(B64), (A)+(B13)+(B65), (A)+(B13)+(B66), (A)+(B13)+(B67), (A)+(B13)+(B68), (A)+(B13)+(B69), (A)+(B13)+(B70), (A)+(B13)+(B71), (A)+(B13)+(B72), (A)+(B13)+(B73), (A)+(B13)+(B74), (A)+(B13)+(B75), (A)+(B13)+(B76), (A)+(B13)+(B77), (A)+(B13)+(B78), (A)+(B13)+(B79), (A)+(B13)+(B80), (A)+(B13)+(B81), (A)+(B13)+(B82), (A)+(B13)+(B83), (A)+(B13)+(B84), (A)+(B13)+(B85), (A)+(B13)+(B86), (A)+(B13)+(B87), (A)+(B13)+(B88), (A)+(B13)+(B89), (A)+(B13)+(B90), (A)+(B13)+(B91), (A)+(B13)+(B92), (A)+(B13)+(B93), (A)+(B13)+(B94), (A)+(B13)+(B95), (A)+(B13)+(B96), (A)+(B13)+(B97), (A)+(B13)+(B98), (A)+(B13)+(B99), (A)+(B13)+(B100), (A)+(B13)+(B101), (A)+(B13)+(B102), (A)+(B13)+(B103), (A)+(B13)+(B104), (A)+(B13)+(B105), (A)+(B13)+(B106), (A)+(B13)+(B107), (A)+(B13)+(B108), (A)+(B13)+(B109), (A)+(B13)+(B110), (A)+(B13)+(B111), (A)+(B13)+(B112), (A)+(B13)+(B113), (A)+(B13)+(B114), (A)+(B13)+(B115), (A)+(B13)+(B116), (A)+(B13)+(B117), (A)+(B13)+(B118), (A)+(B13)+(B119), (A)+(B13)+(B120), (A)+(B13)+(B121), (A)+(B13)+(B122), (A)+(B13)+(B123), (A)+(B13)+(B124), (A)+(B13)+(B125), (A)+(B13)+(B126), (A)+(B13)+(B127), (A)+(B13)+(B128), (A)+(B13)+(B129), (A)+(B13)+(B130), (A)+(B13)+(B131), (A)+(B13)+(B132), (A)+(B13)+(B133), (A)+(B13)+(B134), (A)+(B13)+(B135), (A)+(B13)+(B136), (A)+(B13)+(B137), (A)+(B13)+(B138), (A)+(B13)+(B139), (A)+(B13)+(B140), (A)+(B13)+(B141), (A)+(B13)+(B142), (A)+(B13)+(B143), (A)+(B13)+(B144), (A)+(B13)+(B145), (A)+(B13)+(B146), (A)+(B13)+(B147), (A)+(B13)+(B148), (A)+(B13)+(B149), (A)+(B13)+(B150), (A)+(B13)+(B151), (A)+(B13)+(B152), (A)+(B13)+(B153), (A)+(B13)+(B154), (A)+(B13)+(B155), (A)+(B13)+(B156), (A)+(B13)+(B157), (A)+(B13)+(B158), (A)+(B13)+(B159), (A)+(B13)+(B160), (A)+(B13)+(B161), (A)+(B13)+(B162), (A)+(B13)+(B164), (A)+(B13)+(B164), (A)+(B13)+(B165), (A)+(B13)+(B166), (A)+(B13)+(B167), (A)+(B13)+(B168), (A)+(B13)+(B169), (A)+(B13)+(B170), (A)+(B13)+(B171), (A)+(B13)+(B172), (A)+(B13)+(B173), (A)+(B13)+(B174), (A)+(B13)+(B175), (A)+(B13)+(B176), (A)+(B13)+(B177), (A)+(B13)+(B178), (A)+(B13)+(B179), (A)+(B13)+(B180), (A)+(B13)+(B181), (A)+(B13)+(B182), (A)+(B13)+(B183), (A)+(B13)+(B184), (A)+(B13)+(B185), (A)+(B13)+(B186), (A)+(B13)+(B187), (A)+(B13)+(B188), (A)+(B13)+(B189), (A)+(B13)+(B190), (A)+(B13)+(B191), (A)+(B13)+(B192), (A)+(B13)+(B193), (A)+(B13)+(B194), (A)+(B13)+(B195), (A)+(B13)+(B196), (A)+(B13)+(B197), (A)+(B13)+(B198), (A)+(B13)+(B199), (A)+(B13)+(B200), (A)+(B13)+(B201), (A)+(B13)+(B202), (A)+(B13)+(B203), (A)+(B13)+(B204), (A)+(B13)+(B205), (A)+(B13)+(B206), (A)+(B13)+(B207), (A)+(B13)+(B208), (A)+(B13)+(B209), (A)+(B13)+(B210), (A)+(B13)+(B211), (A)+(B13)+(B212), (A)+(B13)+(B213), (A)+(B13)+(B214), (A)+(B13)+(B215), (A)+(B13)+(B216), (A)+(B13)+(B217), (A)+(B13)+(B218), (A)+(B13)+(B219), (A)+(B13)+(B220), (A)+(B13)+(B221), (A)+(B13)+(B222), (A)+(B13)+(B223), (A)+(B13)+(B224), (A)+(B13)+(B225), (A)+(B13)+(B226), (A)+(B13)+(B227), (A)+(B13)+(B228), (A)+(B13)+(B229), (A)+(B13)+(B230), (A)+(B13)+(B231), (A)+(B13)+(B232), (A)+(B13)+(B233), (A)+(B13)+(B234), (A)+(B13)+(B235), (A)+(B13)+(B236), (A)+(B13)+(B237), (A)+(B13)+(B238), (A)+(B13)+(B239), (A)+(B13)+(B240), (A)+(B13)+(B241), (A)+(B13)+(B242), (A)+(B13)+(B243), (A)+(B13)+(B244), (A)+(B13)+(B245), (A)+(B13)+(B246), (A)+(B13)+(B247), (A)+(B13)+(B248), (A)+(B13)+(B249), (A)+(B13)+(B250), (A)+(B13)+(B251), (A)+(B13)+(B252), (A)+(B13)+(B253), (A)+(B13)+(B254), (A)+(B13)+(B255), (A)+(B13)+(B256), (A)+(B13)+(B257), (A)+(B13)+(B258), (A)+(B13)+(B259), (A)+(B13)+(B260), (A)+(B13)+(B261), (A)+(B13)+(B262), (A)+(B13)+(B263), (A)+(B13)+(B264), (A)+(B13)+(B265), (A)+(B13)+(B266), (A)+(B13)+(B267), (A)+(B13)+(B268), (A)+(B13)+(B269), (A)+(B13)+(B270), (A)+(B13)+(B271), (A)+(B13)+(B272), (A)+(B13)+(B273), (A)+(B13)+(B274), (A)+(B13)+(B275), (A)+(B13)+(B276), (A)+(B13)+(B277), (A)+(B13)+(B278), (A)+(B13)+(B279), (A)+(B13)+(B280), (A)+(B13)+(B281), (A)+(B13)+(B282), (A)+(B13)+(B283), (A)+(B13)+(B284), (A)+(B13)+(B285), (A)+(B13)+(B286), (A)+(B13)+(B287), (A)+(B13)+(B288), (A)+(B13)+(B289), (A)+(B13)+(B290), (A)+(B13)+(B291), (A)+(B13)+(B292), (A)+(B13)+(B293), (A)+(B13)+(B294), (A)+(B13)+(B295), (A)+(B13)+(B296), (A)+(B13)+(B297), (A)+(B13)+(B298), (A)+(B13)+(B299), (A)+(B13)+(B300), (A)+(B13)+(B301), (A)+(B13)+(B302), (A)+(B13)+(B303), (A)+(B13)+(B304), (A)+(B13)+(B305), (A)+(B13)+(B306), (A)+(B13)+(B307), (A)+(B13)+(B308), (A)+(B13)+(B309), (A)+(B13)+(B310), (A)+(B13)+(B311), (A)+(B13)+(B312), (A)+(B13)+(B313), (A)+(B13)+(B314), (A)+(B13)+(B315),

(A)+(B14)+(B15), (A)+(B14)+(B16), (A)+(B14)+(B17), (A)+(B14)+(B18), (A)+(B14)+(B19), (A)+(B14)+(B20), (A)+(B14)+(B21), (A)+(B14)+(B22), (A)+(B14)+(B23), (A)+(B14)+(B24), (A)+(B14)+(B25), (A)+(B14)+(B26), (A)+(B14)+(B27), (A)+(B14)+(B28), (A)+(B14)+(B29), (A)+(B14)+(B30), (A)+(B14)+(B31), (A)+(B14)+(B32), (A)+(B14)+(B33), (A)+(B14)+(B34), (A)+(B14)+(B35), (A)+(B14)+(B36), (A)+(B14)+(B37), (A)+(B14)+(B38), (A)+(B14)+(B39), (A)+(B14)+(B40), (A)+(B14)+(B41), (A)+(B14)+(B42), (A)+(B14)+(B43), (A)+(B14)+(B44), (A)+(B14)+(B45), (A)+(B14)+(B46), (A)+(B14)+(B47), (A)+(B14)+(B48), (A)+(B14)+(B49), (A)+(B14)+(B50), (A)+(B14)+(B51), (A)+(B14)+(B52), (A)+(B14)+(B53), (A)+(B14)+(B54), (A)+(B14)+(B55), (A)+(B14)+(B56), (A)+(B14)+(B57), (A)+(B14)+(B58), (A)+(B14)+(B59), (A)+(B14)+(B60), (A)+(B14)+(B61), (A)+(B14)+(B62), (A)+(B14)+(B63), (A)+(B14)+(B64), (A)+(B14)+(B65), (A)+(B14)+(B66), (A)+(B14)+(B67), (A)+(B14)+(B68), (A)+(B14)+(B69), (A)+(B14)+(B70), (A)+(B14)+(B71), (A)+(B14)+(B72), (A)+(B14)+(B73), (A)+(B14)+(B74), (A)+(B14)+(B75), (A)+(B14)+(B76), (A)+(B14)+(B77), (A)+(B14)+(B78), (A)+(B14)+(B79), (A)+(B14)+(B80), (A)+(B14)+(B81), (A)+(B14)+(B82), (A)+(B14)+(B83), (A)+(B14)+(B84), (A)+(B14)+(B85), (A)+(B14)+(B86), (A)+(B14)+(B87), (A)+(B14)+(B88), (A)+(B14)+(B89), (A)+(B14)+(B90), (A)+(B14)+(B91), (A)+(B14)+(B92), (A)+(B14)+(B93), (A)+(B14)+(B94), (A)+(B14)+(B95), (A)+(B14)+(B96), (A)+(B14)+(B97), (A)+(B14)+(B98), (A)+(B14)+(B99), (A)+(B14)+(B100), (A)+(B14)+(B101), (A)+(B14)+(B102), (A)+(B14)+(B103), (A)+(B14)+(B104), (A)+(B14)+(B105), (A)+(B14)+(B106), (A)+(B14)+(B107), (A)+(B14)+(B108), (A)+(B14)+(B109), (A)+(B14)+(B110), (A)+(B14)+(B111), (A)+(B14)+(B112), (A)+(B14)+(B113), (A)+(B14)+(B114), (A)+(B14)+(B115), (A)+(B14)+(B116), (A)+(B14)+(B117), (A)+(B14)+(B118), (A)+(B14)+(B119), (A)+(B14)+(B120), (A)+(B14)+(B121), (A)+(B14)+(B122), (A)+(B14)+(B123), (A)+(B14)+(B124), (A)+(B14)+(B125), (A)+(B14)+(B126), (A)+(B14)+(B127), (A)+(B14)+(B128), (A)+(B14)+(B129), (A)+(B14)+(B130), (A)+(B14)+(B131), (A)+(B14)+(B132), (A)+(B14)+(B133), (A)+(B14)+(B134), (A)+(B14)+(B135), (A)+(B14)+(B136), (A)+(B14)+(B137), (A)+(B14)+(B138), (A)+(B14)+(B139), (A)+(B14)+(B140), (A)+(B14)+(B141), (A)+(B14)+(B142), (A)+(B14)+(B143), (A)+(B14)+(B144), (A)+(B14)+(B145), (A)+(B14)+(B146), (A)+(B14)+(B147), (A)+(B14)+(B148), (A)+(B14)+(B149), (A)+(B14)+(B150), (A)+(B14)+(B151), (A)+(B14)+(B152), (A)+(B14)+(B153), (A)+(B14)+(B154), (A)+(B14)+(B155), (A)+(B14)+(B156), (A)+(B14)+(B157), (A)+(B14)+(B158), (A)+(B14)+(B159), (A)+(B14)+(B160), (A)+(B14)+(B161), (A)+(B14)+(B162), (A)+(B14)+(B164), (A)+(B14)+(B164), (A)+(B14)+(B165), (A)+(B14)+(B166), (A)+(B14)+(B167), (A)+(B14)+(B168), (A)+(B14)+(B169), (A)+(B14)+(B170), (A)+(B14)+(B171), (A)+(B14)+(B172), (A)+(B14)+(B173), (A)+(B14)+(B174), (A)+(B14)+(B175), (A)+(B14)+(B176), (A)+(B14)+(B177), (A)+(B14)+(B178), (A)+(B14)+(B179), (A)+(B14)+(B180), (A)+(B14)+(B181), (A)+(B14)+(B182), (A)+(B14)+(B183), (A)+(B14)+(B184), (A)+(B14)+(B185), (A)+(B14)+(B186), (A)+(B14)+(B187), (A)+(B14)+(B188), (A)+(B14)+(B189), (A)+(B14)+(B190), (A)+(B14)+(B191), (A)+(B14)+(B192), (A)+(B14)+(B193), (A)+(B14)+(B194), (A)+(B14)+(B195), (A)+(B14)+(B196), (A)+(B14)+(B197), (A)+(B14)+(B198), (A)+(B14)+(B199), (A)+(B14)+(B200), (A)+(B14)+(B201), (A)+(B14)+(B202), (A)+(B14)+(B203), (A)+(B14)+(B204), (A)+(B14)+(B205), (A)+(B14)+(B206), (A)+(B14)+(B207), (A)+(B14)+(B208), (A)+(B14)+(B209), (A)+(B14)+(B210), (A)+(B14)+(B211), (A)+(B14)+(B212), (A)+(B14)+(B213), (A)+(B14)+(B214), (A)+(B14)+(B215), (A)+(B14)+(B216), (A)+(B14)+(B217), (A)+(B14)+(B218), (A)+(B14)+(B219), (A)+(B14)+(B220), (A)+(B14)+(B221), (A)+(B14)+(B222), (A)+(B14)+(B223), (A)+(B14)+(B224), (A)+(B14)+(B225), (A)+(B14)+(B226), (A)+(B14)+(B227), (A)+(B14)+(B228), (A)+(B14)+(B229), (A)+(B14)+(B230), (A)+(B14)+(B231), (A)+(B14)+(B232), (A)+(B14)+(B233), (A)+(B14)+(B234), (A)+(B14)+(B235), (A)+(B14)+(B236), (A)+(B14)+(B237), (A)+(B14)+(B238), (A)+(B14)+(B239), (A)+(B14)+(B240), (A)+(B14)+(B241), (A)+(B14)+(B242), (A)+(B14)+(B243), (A)+(B14)+(B244), (A)+(B14)+(B245), (A)+(B14)+(B246), (A)+(B14)+(B247), (A)+(B14)+(B248), (A)+(B14)+(B249), (A)+(B14)+(B250), (A)+(B14)+(B251), (A)+(B14)+(B252), (A)+(B14)+(B253), (A)+(B14)+(B254), (A)+(B14)+(B255), (A)+(B14)+(B256), (A)+(B14)+(B257), (A)+(B14)+(B258), (A)+(B14)+(B259), (A)+(B14)+(B260), (A)+(B14)+(B261), (A)+(B14)+(B262), (A)+(B14)+(B263), (A)+(B14)+(B264), (A)+(B14)+(B265), (A)+(B14)+(B266), (A)+(B14)+(B267), (A)+(B14)+(B268), (A)+(B14)+(B269), (A)+(B14)+(B270), (A)+(B14)+(B271), (A)+(B14)+(B272), (A)+(B14)+(B273), (A)+(B14)+(B274), (A)+(B14)+(B275), (A)+(B14)+(B276), (A)+(B14)+(B277), (A)+(B14)+(B278), (A)+(B14)+(B279), (A)+(B14)+(B280), (A)+(B14)+(B281), (A)+(B14)+(B282), (A)+(B14)+(B283), (A)+(B14)+(B284), (A)+(B14)+(B285), (A)+(B14)+(B286), (A)+(B14)+(B287), (A)+(B14)+(B288), (A)+(B14)+(B289), (A)+(B14)+(B290), (A)+(B14)+(B291), (A)+(B14)+(B292), (A)+(B14)+(B293), (A)+(B14)+(B294), (A)+(B14)+(B295), (A)+(B14)+(B296), (A)+(B14)+(B297), (A)+(B14)+(B298), (A)+(B14)+(B299), (A)+(B14)+(B300), (A)+(B14)+(B301), (A)+(B14)+(B302), (A)+(B14)+(B303), (A)+(B14)+(B304), (A)+(B14)+(B305), (A)+(B14)+(B306), (A)+(B14)+(B307), (A)+(B14)+(B308), (A)+(B14)+(B309), (A)+(B14)+(B310), (A)+(B14)+(B311), (A)+(B14)+(B312), (A)+(B14)+(B313), (A)+(B14)+(B314), (A)+(B14)+(B315),

(A)+(B15)+(B16), (A)+(B15)+(B17), (A)+(B15)+(B18), (A)+(B15)+(B19), (A)+(B15)+(B20), (A)+(B15)+(B21), (A)+(B15)+(B22), (A)+(B15)+(B23), (A)+(B15)+(B24), (A)+(B15)+(B25), (A)+(B15)+(B26), (A)+(B15)+(B27), (A)+(B15)+(B28), (A)+(B15)+(B29), (A)+(B15)+(B30), (A)+(B15)+(B31), (A)+(B15)+(B32), (A)+(B15)+(B33), (A)+(B15)+(B34), (A)+(B15)+(B35), (A)+(B15)+(B36), (A)+(B15)+(B37), (A)+(B15)+(B38), (A)+(B15)+(B39), (A)+(B15)+(B40), (A)+(B15)+(B41), (A)+(B15)+(B42), (A)+(B15)+(B43), (A)+(B15)+(B44), (A)+(B15)+(B45), (A)+(B15)+(B46), (A)+(B15)+(B47), (A)+(B15)+(B48), (A)+(B15)+(B49), (A)+(B15)+(B50), (A)+(B15)+(B51), (A)+(B15)+(B52), (A)+(B15)+(B53), (A)+(B15)+(B54), (A)+(B15)+(B55), (A)+(B15)+(B56), (A)+(B15)+(B57), (A)+(B15)+(B58), (A)+(B15)+(B59), (A)+(B15)+(B60), (A)+(B15)+(B61), (A)+(B15)+(B62), (A)+(B15)+(B63), (A)+(B15)+(B64), (A)+(B15)+(B65), (A)+(B15)+(B66), (A)+(B15)+(B67), (A)+(B15)+(B68), (A)+(B15)+(B69), (A)+(B15)+(B70), (A)+(B15)+(B71), (A)+(B15)+(B72), (A)+(B15)+(B73), (A)+(B15)+(B74), (A)+(B15)+(B75), (A)+(B15)+(B76), (A)+(B15)+(B77), (A)+(B15)+(B78), (A)+(B15)+(B79), (A)+(B15)+(B80), (A)+(B15)+(B81), (A)+(B15)+(B82), (A)+(B15)+(B83), (A)+(B15)+(B84), (A)+(B15)+(B85), (A)+(B15)+(B86), (A)+(B15)+(B87), (A)+(B15)+(B88), (A)+(B15)+(B89), (A)+(B15)+(B90), (A)+(B15)+(B91), (A)+(B15)+(B92), (A)+(B15)+(B93), (A)+(B15)+(B94), (A)+(B15)+(B95), (A)+(B15)+(B96), (A)+(B15)+(B97), (A)+(B15)+(B98), (A)+(B15)+(B99), (A)+(B15)+(B100), (A)+(B15)+(B101), (A)+(B15)+(B102), (A)+(B15)+(B103), (A)+(B15)+(B104), (A)+(B15)+(B105), (A)+(B15)+(B106), (A)+(B15)+(B107), (A)+(B15)+(B108), (A)+(B15)+(B109), (A)+(B15)+(B110), (A)+(B15)+(B111), (A)+(B15)+(B112), (A)+(B15)+(B113), (A)+(B15)+(B114), (A)+(B15)+(B115), (A)+(B15)+(B116), (A)+(B15)+(B117), (A)+(B15)+(B118), (A)+(B15)+(B119), (A)+(B15)+(B120), (A)+(B15)+(B121), (A)+(B15)+(B122), (A)+(B15)+(B123), (A)+(B15)+(B124), (A)+(B15)+(B125), (A)+(B15)+(B126), (A)+(B15)+(B127), (A)+(B15)+(B128), (A)+(B15)+(B129), (A)+(B15)+(B130), (A)+(B15)+(B131), (A)+(B15)+(B132), (A)+(B15)+(B133), (A)+(B15)+(B134), (A)+(B15)+(B135), (A)+(B15)+(B136), (A)+(B15)+(B137), (A)+(B15)+(B138), (A)+(B15)+(B139), (A)+(B15)+(B140), (A)+(B15)+(B141), (A)+(B15)+(B142), (A)+(B15)+(B143), (A)+(B15)+(B144), (A)+(B15)+(B145), (A)+(B15)+(B146), (A)+(B15)+(B147), (A)+(B15)+(B148), (A)+(B15)+(B149), (A)+(B15)+(B150), (A)+(B15)+(B151), (A)+(B15)+(B152), (A)+(B15)+(B153), (A)+(B15)+(B154), (A)+(B15)+(B155), (A)+(B15)+(B156), (A)+(B15)+(B157), (A)+(B15)+(B158), (A)+(B15)+(B159), (A)+(B15)+(B160), (A)+(B15)+(B161), (A)+(B15)+(B162), (A)+(B15)+(B164), (A)+(B15)+(B164), (A)+(B15)+(B165), (A)+(B15)+(B166), (A)+(B15)+(B167), (A)+(B15)+(B168), (A)+(B15)+(B169), (A)+(B15)+(B170), (A)+(B15)+(B171), (A)+(B15)+(B172), (A)+(B15)+(B173), (A)+(B15)+(B174), (A)+(B15)+(B175), (A)+(B15)+(B176), (A)+(B15)+(B177), (A)+(B15)+(B178), (A)+(B15)+(B179), (A)+(B15)+(B180), (A)+(B15)+(B181), (A)+(B15)+(B182), (A)+(B15)+(B183), (A)+(B15)+(B184), (A)+(B15)+(B185), (A)+(B15)+(B186), (A)+(B15)+(B187), (A)+(B15)+(B188), (A)+(B15)+(B189), (A)+(B15)+(B190), (A)+(B15)+(B191), (A)+(B15)+(B192), (A)+(B15)+(B193), (A)+(B15)+(B194), (A)+(B15)+(B195), (A)+(B15)+(B196), (A)+(B15)+(B197), (A)+(B15)+(B198), (A)+(B15)+(B199), (A)+(B15)+(B200), (A)+(B15)+(B201), (A)+(B15)+(B202), (A)+(B15)+(B203), (A)+(B15)+(B204), (A)+(B15)+(B205), (A)+(B15)+(B206), (A)+(B15)+(B207), (A)+(B15)+(B208), (A)+(B15)+(B209), (A)+(B15)+(B210), (A)+(B15)+(B211), (A)+(B15)+(B212), (A)+(B15)+(B213), (A)+(B15)+(B214), (A)+(B15)+(B215), (A)+(B15)+(B216), (A)+(B15)+(B217), (A)+(B15)+(B218), (A)+(B15)+(B219), (A)+(B15)+(B220), (A)+(B15)+(B221), (A)+(B15)+(B222), (A)+(B15)+(B223), (A)+(B15)+(B224), (A)+(B15)+(B225), (A)+(B15)+(B226), (A)+(B15)+(B227), (A)+(B15)+(B228), (A)+(B15)+(B229), (A)+(B15)+(B230), (A)+(B15)+(B231), (A)+(B15)+(B232), (A)+(B15)+(B233), (A)+(B15)+(B234), (A)+(B15)+(B235), (A)+(B15)+(B236), (A)+(B15)+(B237), (A)+(B15)+(B238), (A)+(B15)+(B239), (A)+(B15)+(B240), (A)+(B15)+(B241), (A)+(B15)+(B242), (A)+(B15)+(B243), (A)+(B15)+(B244), (A)+(B15)+(B245), (A)+(B15)+(B246), (A)+(B15)+(B247), (A)+(B15)+(B248), (A)+(B15)+(B249), (A)+(B15)+(B250), (A)+(B15)+(B251), (A)+(B15)+(B252), (A)+(B15)+(B253), (A)+(B15)+(B254), (A)+(B15)+(B255), (A)+(B15)+(B256), (A)+(B15)+(B257), (A)+(B15)+(B258), (A)+(B15)+(B259), (A)+(B15)+(B260), (A)+(B15)+(B261), (A)+(B15)+(B262), (A)+(B15)+(B263), (A)+(B15)+(B264), (A)+(B15)+(B265), (A)+(B15)+(B266), (A)+(B15)+(B267), (A)+(B15)+(B268), (A)+(B15)+(B269), (A)+(B15)+(B270), (A)+(B15)+(B271), (A)+(B15)+(B272), (A)+(B15)+(B273), (A)+(B15)+(B274), (A)+(B15)+(B275), (A)+(B15)+(B276), (A)+(B15)+(B277), (A)+(B15)+(B278), (A)+(B15)+(B279), (A)+(B15)+(B280), (A)+(B15)+(B281), (A)+(B15)+(B282), (A)+(B15)+(B283), (A)+(B15)+(B284), (A)+(B15)+(B285), (A)+(B15)+(B286), (A)+(B15)+(B287), (A)+(B15)+(B288), (A)+(B15)+(B289), (A)+(B15)+(B290), (A)+(B15)+(B291), (A)+(B15)+(B292), (A)+(B15)+(B293), (A)+(B15)+(B294), (A)+(B15)+(B295), (A)+(B15)+(B296), (A)+(B15)+(B297), (A)+(B15)+(B298), (A)+(B15)+(B299), (A)+(B15)+(B300), (A)+(B15)+(B301), (A)+(B15)+(B302), (A)+(B15)+(B303), (A)+(B15)+(B304), (A)+(B15)+(B305), (A)+(B15)+(B306), (A)+(B15)+(B307), (A)+(B15)+(B308), (A)+(B15)+(B309), (A)+(B15)+(B310), (A)+(B15)+(B311), (A)+(B15)+(B312), (A)+(B15)+(B313), (A)+(B15)+(B314), (A)+(B15)+(B315),

(A)+(B16)+(B17), (A)+(B16)+(B18), (A)+(B16)+(B19), (A)+(B16)+(B20), (A)+(B16)+(B21), (A)+(B16)+(B22), (A)+(B16)+(B23), (A)+(B16)+(B24), (A)+(B16)+(B25), (A)+(B16)+(B26), (A)+(B16)+(B27), (A)+(B16)+(B28), (A)+(B16)+(B29), (A)+(B16)+(B30), (A)+(B16)+(B31), (A)+(B16)+(B32), (A)+(B16)+(B33), (A)+(B16)+(B34), (A)+(B16)+(B35), (A)+(B16)+(B36), (A)+(B16)+(B37), (A)+(B16)+(B38), (A)+(B16)+(B39), (A)+(B16)+(B40), (A)+(B16)+(B41), (A)+(B16)+(B42), (A)+(B16)+(B43), (A)+(B16)+(B44), (A)+(B16)+(B45), (A)+(B16)+(B46), (A)+(B16)+(B47), (A)+(B16)+(B48), (A)+(B16)+(B49), (A)+(B16)+(B50), (A)+(B16)+(B51), (A)+(B16)+(B52), (A)+(B16)+(B53), (A)+(B16)+(B54), (A)+(B16)+(B55), (A)+(B16)+(B56), (A)+(B16)+(B57), (A)+(B16)+(B58), (A)+(B16)+(B59), (A)+(B16)+(B60), (A)+(B16)+(B61), (A)+(B16)+(B62), (A)+(B16)+(B63), (A)+(B16)+(B64), (A)+(B16)+(B65), (A)+(B16)+(B66), (A)+(B16)+(B67), (A)+(B16)+(B68), (A)+(B16)+(B69), (A)+(B16)+(B70), (A)+(B16)+(B71), (A)+(B16)+(B72), (A)+(B16)+(B73), (A)+(B16)+(B74), (A)+(B16)+(B75), (A)+(B16)+(B76), (A)+(B16)+(B77), (A)+(B16)+(B78), (A)+(B16)+(B79), (A)+(B16)+(B80), (A)+(B16)+(B81), (A)+(B16)+(B82), (A)+(B16)+(B83), (A)+(B16)+(B84), (A)+(B16)+(B85), (A)+(B16)+(B86), (A)+(B16)+(B87), (A)+(B16)+(B88), (A)+(B16)+(B89), (A)+(B16)+(B90), (A)+(B16)+(B91), (A)+(B16)+(B92), (A)+(B16)+(B93), (A)+(B16)+(B94), (A)+(B16)+(B95), (A)+(B16)+(B96), (A)+(B16)+(B97), (A)+(B16)+(B98), (A)+(B16)+(B99), (A)+(B16)+(B100), (A)+(B16)+(B101), (A)+(B16)+(B102), (A)+(B16)+(B103), (A)+(B16)+(B104), (A)+(B16)+(B105), (A)+(B16)+(B106), (A)+(B16)+(B107), (A)+(B16)+(B108), (A)+(B16)+(B109), (A)+(B16)+(B110), (A)+(B16)+(B111), (A)+(B16)+(B112), (A)+(B16)+(B113), (A)+(B16)+(B114), (A)+(B16)+(B115), (A)+(B16)+(B116), (A)+(B16)+(B117), (A)+(B16)+(B118), (A)+(B16)+(B119), (A)+(B16)+(B120), (A)+(B16)+(B121), (A)+(B16)+(B122), (A)+(B16)+(B123), (A)+(B16)+(B124), (A)+(B16)+(B125), (A)+(B16)+(B126), (A)+(B16)+(B127), (A)+(B16)+(B128), (A)+(B16)+(B129), (A)+(B16)+(B130), (A)+(B16)+(B131), (A)+(B16)+(B132), (A)+(B16)+(B133), (A)+(B16)+(B134), (A)+(B16)+(B135), (A)+(B16)+(B136), (A)+(B16)+(B137), (A)+(B16)+(B138), (A)+(B16)+(B139), (A)+(B16)+(B140), (A)+(B16)+(B141), (A)+(B16)+(B142), (A)+(B16)+(B143), (A)+(B16)+(B144), (A)+(B16)+(B145), (A)+(B16)+(B146), (A)+(B16)+(B147), (A)+(B16)+(B148), (A)+(B16)+(B149), (A)+(B16)+(B150), (A)+(B16)+(B151), (A)+(B16)+(B152), (A)+(B16)+(B153), (A)+(B16)+(B154), (A)+(B16)+(B155), (A)+(B16)+(B156), (A)+(B16)+(B157), (A)+(B16)+(B158), (A)+(B16)+(B159), (A)+(B16)+(B160), (A)+(B16)+(B161), (A)+(B16)+(B162), (A)+(B16)+(B164), (A)+(B16)+(B164), (A)+(B16)+(B165), (A)+(B16)+(B166), (A)+(B16)+(B167), (A)+(B16)+(B168), (A)+(B16)+(B169), (A)+(B16)+(B170), (A)+(B16)+(B171), (A)+(B16)+(B172), (A)+(B16)+(B173), (A)+(B16)+(B174), (A)+(B16)+(B175), (A)+(B16)+(B176), (A)+(B16)+(B177), (A)+(B16)+(B178), (A)+(B16)+(B179), (A)+(B16)+(B180), (A)+(B16)+(B181), (A)+(B16)+(B182), (A)+(B16)+(B183), (A)+(B16)+(B184), (A)+(B16)+(B185), (A)+(B16)+(B186), (A)+(B16)+(B187), (A)+(B16)+(B188), (A)+(B16)+(B189), (A)+(B16)+(B190), (A)+(B16)+(B191), (A)+(B16)+(B192), (A)+(B16)+(B193), (A)+(B16)+(B194), (A)+(B16)+(B195), (A)+(B16)+(B196), (A)+(B16)+(B197), (A)+(B16)+(B198), (A)+(B16)+(B199), (A)+(B16)+(B200), (A)+(B16)+(B201), (A)+(B16)+(B202), (A)+(B16)+(B203), (A)+(B16)+(B204), (A)+(B16)+(B205), (A)+(B16)+(B206), (A)+(B16)+(B207), (A)+(B16)+(B208), (A)+(B16)+(B209), (A)+(B16)+(B210), (A)+(B16)+(B211), (A)+(B16)+(B212), (A)+(B16)+(B213), (A)+(B16)+(B214), (A)+(B16)+(B215), (A)+(B16)+(B216), (A)+(B16)+(B217), (A)+(B16)+(B218), (A)+(B16)+(B219), (A)+(B16)+(B220), (A)+(B16)+(B221), (A)+(B16)+(B222), (A)+(B16)+(B223), (A)+(B16)+(B224), (A)+(B16)+(B225), (A)+(B16)+(B226), (A)+(B16)+(B227), (A)+(B16)+(B228), (A)+(B16)+(B229), (A)+(B16)+(B230), (A)+(B16)+(B231), (A)+(B16)+(B232), (A)+(B16)+(B233), (A)+(B16)+(B234), (A)+(B16)+(B235), (A)+(B16)+(B236), (A)+(B16)+(B237), (A)+(B16)+(B238), (A)+(B16)+(B239), (A)+(B16)+(B240), (A)+(B16)+(B241), (A)+(B16)+(B242), (A)+(B16)+(B243), (A)+(B16)+(B244), (A)+(B16)+(B245), (A)+(B16)+(B246), (A)+(B16)+(B247), (A)+(B16)+(B248), (A)+(B16)+(B249), (A)+(B16)+(B250), (A)+(B16)+(B251), (A)+(B16)+(B252), (A)+(B16)+(B253), (A)+(B16)+(B254), (A)+(B16)+(B255), (A)+(B16)+(B256), (A)+(B16)+(B257), (A)+(B16)+(B258), (A)+(B16)+(B259), (A)+(B16)+(B260), (A)+(B16)+(B261), (A)+(B16)+(B262), (A)+(B16)+(B263), (A)+(B16)+(B264), (A)+(B16)+(B265), (A)+(B16)+(B266), (A)+(B16)+(B267), (A)+(B16)+(B268), (A)+(B16)+(B269), (A)+(B16)+(B270), (A)+(B16)+(B271), (A)+(B16)+(B272), (A)+(B16)+(B273), (A)+(B16)+(B274), (A)+(B16)+(B275), (A)+(B16)+(B276), (A)+(B16)+(B277), (A)+(B16)+(B278), (A)+(B16)+(B279), (A)+(B16)+(B280), (A)+(B16)+(B281), (A)+(B16)+(B282), (A)+(B16)+(B283), (A)+(B16)+(B284), (A)+(B16)+(B285), (A)+(B16)+(B286), (A)+(B16)+(B287), (A)+(B16)+(B288), (A)+(B16)+(B289), (A)+(B16)+(B290), (A)+(B16)+(B291), (A)+(B16)+(B292), (A)+(B16)+(B293), (A)+(B16)+(B294), (A)+(B16)+(B295), (A)+(B16)+(B296), (A)+(B16)+(B297), (A)+(B16)+(B298), (A)+(B16)+(B299), (A)+(B16)+(B300), (A)+(B16)+(B301), (A)+(B16)+(B302), (A)+(B16)+(B303), (A)+(B16)+(B304), (A)+(B16)+(B305), (A)+(B16)+(B306), (A)+(B16)+(B307), (A)+(B16)+(B308), (A)+(B16)+(B309), (A)+(B16)+(B310), (A)+(B16)+(B311), (A)+(B16)+(B312), (A)+(B16)+(B313), (A)+(B16)+(B314), (A)+(B16)+(B315),

(A)+(B17)+(B18), (A)+(B17)+(B19), (A)+(B17)+(B20), (A)+(B17)+(B21), (A)+(B17)+(B22), (A)+(B17)+(B23), (A)+(B17)+(B24), (A)+(B17)+(B25), (A)+(B17)+(B26), (A)+(B17)+(B27), (A)+(B17)+(B28), (A)+(B17)+(B29), (A)+(B17)+(B30), (A)+(B17)+(B31), (A)+(B17)+(B32), (A)+(B17)+(B33), (A)+(B17)+(B34), (A)+(B17)+(B35), (A)+(B17)+(B36), (A)+(B17)+(B37), (A)+(B17)+(B38), (A)+(B17)+(B39), (A)+(B17)+(B40), (A)+(B17)+(B41), (A)+(B17)+(B42), (A)+(B17)+(B43), (A)+(B17)+(B44), (A)+(B17)+(B45), (A)+(B17)+(B46), (A)+(B17)+(B47), (A)+(B17)+(B48), (A)+(B17)+(B49), (A)+(B17)+(B50), (A)+(B17)+(B51), (A)+(B17)+(B52), (A)+(B17)+(B53), (A)+(B17)+(B54), (A)+(B17)+(B55), (A)+(B17)+(B56), (A)+(B17)+(B57), (A)+(B17)+(B58), (A)+(B17)+(B59), (A)+(B17)+(B60), (A)+(B17)+(B61), (A)+(B17)+(B62), (A)+(B17)+(B63), (A)+(B17)+(B64), (A)+(B17)+(B65), (A)+(B17)+(B66), (A)+(B17)+(B67), (A)+(B17)+(B68), (A)+(B17)+(B69), (A)+(B17)+(B70), (A)+(B17)+(B71), (A)+(B17)+(B72), (A)+(B17)+(B73), (A)+(B17)+(B74), (A)+(B17)+(B75), (A)+(B17)+(B76), (A)+(B17)+(B77), (A)+(B17)+(B78), (A)+(B17)+(B79), (A)+(B17)+(B80), (A)+(B17)+(B81), (A)+(B17)+(B82), (A)+(B17)+(B83), (A)+(B17)+(B84), (A)+(B17)+(B85), (A)+(B17)+(B86), (A)+(B17)+(B87), (A)+(B17)+(B88), (A)+(B17)+(B89), (A)+(B17)+(B90), (A)+(B17)+(B91), (A)+(B17)+(B92), (A)+(B17)+(B93), (A)+(B17)+(B94), (A)+(B17)+(B95), (A)+(B17)+(B96), (A)+(B17)+(B97), (A)+(B17)+(B98), (A)+(B17)+(B99), (A)+(B17)+(B100), (A)+(B17)+(B101), (A)+(B17)+(B102), (A)+(B17)+(B103), (A)+(B17)+(B104), (A)+(B17)+(B105), (A)+(B17)+(B106), (A)+(B17)+(B107), (A)+(B17)+(B108), (A)+(B17)+(B109), (A)+(B17)+(B110), (A)+(B17)+(B111), (A)+(B17)+(B112), (A)+(B17)+(B113), (A)+(B17)+(B114), (A)+(B17)+(B115), (A)+(B17)+(B116), (A)+(B17)+(B117), (A)+(B17)+(B118), (A)+(B17)+(B119), (A)+(B17)+(B120), (A)+(B17)+(B121), (A)+(B17)+(B122), (A)+(B17)+(B123), (A)+(B17)+(B124), (A)+(B17)+(B125), (A)+(B17)+(B126), (A)+(B17)+(B127), (A)+(B17)+(B128), (A)+(B17)+(B129), (A)+(B17)+(B130), (A)+(B17)+(B131), (A)+(B17)+(B132), (A)+(B17)+(B133), (A)+(B17)+(B134), (A)+(B17)+(B135), (A)+(B17)+(B136), (A)+(B17)+(B137), (A)+(B17)+(B138), (A)+(B17)+(B139), (A)+(B17)+(B140), (A)+(B17)+(B141), (A)+(B17)+(B142), (A)+(B17)+(B143), (A)+(B17)+(B144), (A)+(B17)+(B145), (A)+(B17)+(B146), (A)+(B17)+(B147), (A)+(B17)+(B148), (A)+(B17)+(B149), (A)+(B17)+(B150), (A)+(B17)+(B151), (A)+(B17)+(B152), (A)+(B17)+(B153), (A)+(B17)+(B154), (A)+(B17)+(B155), (A)+(B17)+(B156), (A)+(B17)+(B157), (A)+(B17)+(B158), (A)+(B17)+(B159), (A)+(B17)+(B160), (A)+(B17)+(B161), (A)+(B17)+(B162), (A)+(B17)+(B164), (A)+(B17)+(B164), (A)+(B17)+(B165), (A)+(B17)+(B166), (A)+(B17)+(B167), (A)+(B17)+(B168), (A)+(B17)+(B169), (A)+(B17)+(B170), (A)+(B17)+(B171), (A)+(B17)+(B172), (A)+(B17)+(B173), (A)+(B17)+(B174), (A)+(B17)+(B175), (A)+(B17)+(B176), (A)+(B17)+(B177), (A)+(B17)+(B178), (A)+(B17)+(B179), (A)+(B17)+(B180), (A)+(B17)+(B181), (A)+(B17)+(B182), (A)+(B17)+(B183), (A)+(B17)+(B184), (A)+(B17)+(B185), (A)+(B17)+(B186), (A)+(B17)+(B187), (A)+(B17)+(B188), (A)+(B17)+(B189), (A)+(B17)+(B190), (A)+(B17)+(B191), (A)+(B17)+(B192), (A)+(B17)+(B193), (A)+(B17)+(B194), (A)+(B17)+(B195), (A)+(B17)+(B196), (A)+(B17)+(B197), (A)+(B17)+(B198), (A)+(B17)+(B199), (A)+(B17)+(B200), (A)+(B17)+(B201), (A)+(B17)+(B202), (A)+(B17)+(B203), (A)+(B17)+(B204), (A)+(B17)+(B205), (A)+(B17)+(B206), (A)+(B17)+(B207), (A)+(B17)+(B208), (A)+(B17)+(B209), (A)+(B17)+(B210), (A)+(B17)+(B211), (A)+(B17)+(B212), (A)+(B17)+(B213), (A)+(B17)+(B214), (A)+(B17)+(B215), (A)+(B17)+(B216), (A)+(B17)+(B217), (A)+(B17)+(B218), (A)+(B17)+(B219), (A)+(B17)+(B220), (A)+(B17)+(B221), (A)+(B17)+(B222), (A)+(B17)+(B223), (A)+(B17)+(B224), (A)+(B17)+(B225), (A)+(B17)+(B226), (A)+(B17)+(B227), (A)+(B17)+(B228), (A)+(B17)+(B229), (A)+(B17)+(B230), (A)+(B17)+(B231), (A)+(B17)+(B232), (A)+(B17)+(B233), (A)+(B17)+(B234), (A)+(B17)+(B235), (A)+(B17)+(B236), (A)+(B17)+(B237), (A)+(B17)+(B238), (A)+(B17)+(B239), (A)+(B17)+(B240), (A)+(B17)+(B241), (A)+(B17)+(B242), (A)+(B17)+(B243), (A)+(B17)+(B244), (A)+(B17)+(B245), (A)+(B17)+(B246), (A)+(B17)+(B247), (A)+(B17)+(B248), (A)+(B17)+(B249), (A)+(B17)+(B250), (A)+(B17)+(B251), (A)+(B17)+(B252), (A)+(B17)+(B253), (A)+(B17)+(B254), (A)+(B17)+(B255), (A)+(B17)+(B256), (A)+(B17)+(B257), (A)+(B17)+(B258), (A)+(B17)+(B259), (A)+(B17)+(B260), (A)+(B17)+(B261), (A)+(B17)+(B262), (A)+(B17)+(B263), (A)+(B17)+(B264), (A)+(B17)+(B265), (A)+(B17)+(B266), (A)+(B17)+(B267), (A)+(B17)+(B268), (A)+(B17)+(B269), (A)+(B17)+(B270), (A)+(B17)+(B271), (A)+(B17)+(B272), (A)+(B17)+(B273), (A)+(B17)+(B274), (A)+(B17)+(B275), (A)+(B17)+(B276), (A)+(B17)+(B277), (A)+(B17)+(B278), (A)+(B17)+(B279), (A)+(B17)+(B280), (A)+(B17)+(B281), (A)+(B17)+(B282), (A)+(B17)+(B283), (A)+(B17)+(B284), (A)+(B17)+(B285), (A)+(B17)+(B286), (A)+(B17)+(B287), (A)+(B17)+(B288), (A)+(B17)+(B289), (A)+(B17)+(B290), (A)+(B17)+(B291), (A)+(B17)+(B292), (A)+(B17)+(B293), (A)+(B17)+(B294), (A)+(B17)+(B295), (A)+(B17)+(B296), (A)+(B17)+(B297), (A)+(B17)+(B298), (A)+(B17)+(B299), (A)+(B17)+(B300), (A)+(B17)+(B301), (A)+(B17)+(B302), (A)+(B17)+(B303), (A)+(B17)+(B304), (A)+(B17)+(B305), (A)+(B17)+(B306), (A)+(B17)+(B307), (A)+(B17)+(B308), (A)+(B17)+(B309), (A)+(B17)+(B310), (A)+(B17)+(B311), (A)+(B17)+(B312), (A)+(B17)+(B313), (A)+(B17)+(B314), (A)+(B17)+(B315),

(A)+(B18)+(B19), (A)+(B18)+(B20), (A)+(B18)+(B21), (A)+(B18)+(B22), (A)+(B18)+(B23), (A)+(B18)+(B24), (A)+(B18)+(B25), (A)+(B18)+(B26), (A)+(B18)+(B27), (A)+(B18)+(B28), (A)+(B18)+(B29), (A)+(B18)+(B30), (A)+(B18)+(B31), (A)+(B18)+(B32), (A)+(B18)+(B33), (A)+(B18)+(B34), (A)+(B18)+(B35), (A)+(B18)+(B36), (A)+(B18)+(B37), (A)+(B18)+(B38), (A)+(B18)+(B39), (A)+(B18)+(B40), (A)+(B18)+(B41), (A)+(B18)+(B42), (A)+(B18)+(B43), (A)+(B18)+(B44), (A)+(B18)+(B45), (A)+(B18)+(B46), (A)+(B18)+(B47), (A)+(B18)+(B48), (A)+(B18)+(B49), (A)+(B18)+(B50), (A)+(B18)+(B51), (A)+(B18)+(B52), (A)+(B18)+(B53), (A)+(B18)+(B54), (A)+(B18)+(B55), (A)+(B18)+(B56), (A)+(B18)+(B57), (A)+(B18)+(B58), (A)+(B18)+(B59), (A)+(B18)+(B60), (A)+(B18)+(B61), (A)+(B18)+(B62), (A)+(B18)+(B63), (A)+(B18)+(B64), (A)+(B18)+(B65), (A)+(B18)+(B66), (A)+(B18)+(B67), (A)+(B18)+(B68), (A)+(B18)+(B69), (A)+(B18)+(B70), (A)+(B18)+(B71), (A)+(B18)+(B72), (A)+(B18)+(B73), (A)+(B18)+(B74), (A)+(B18)+(B75), (A)+(B18)+(B76), (A)+(B18)+(B77), (A)+(B18)+(B78), (A)+(B18)+(B79), (A)+(B18)+(B80), (A)+(B18)+(B81), (A)+(B18)+(B82), (A)+(B18)+(B83), (A)+(B18)+(B84), (A)+(B18)+(B85), (A)+(B18)+(B86), (A)+(B18)+(B87), (A)+(B18)+(B88), (A)+(B18)+(B89), (A)+(B18)+(B90), (A)+(B18)+(B91), (A)+(B18)+(B92), (A)+(B18)+(B93), (A)+(B18)+(B94), (A)+(B18)+(B95), (A)+(B18)+(B96), (A)+(B18)+(B97), (A)+(B18)+(B98), (A)+(B18)+(B99), (A)+(B18)+(B100), (A)+(B18)+(B101), (A)+(B18)+(B102), (A)+(B18)+(B103), (A)+(B18)+(B104), (A)+(B18)+(B105), (A)+(B18)+(B106), (A)+(B18)+(B107), (A)+(B18)+(B108), (A)+(B18)+(B109), (A)+(B18)+(B110), (A)+(B18)+(B111), (A)+(B18)+(B112), (A)+(B18)+(B113), (A)+(B18)+(B114), (A)+(B18)+(B115), (A)+(B18)+(B116), (A)+(B18)+(B117), (A)+(B18)+(B118), (A)+(B18)+(B119), (A)+(B18)+(B120), (A)+(B18)+(B121), (A)+(B18)+(B122), (A)+(B18)+(B123), (A)+(B18)+(B124), (A)+(B18)+(B125), (A)+(B18)+(B126), (A)+(B18)+(B127), (A)+(B18)+(B128), (A)+(B18)+(B129), (A)+(B18)+(B130), (A)+(B18)+(B131), (A)+(B18)+(B132), (A)+(B18)+(B133), (A)+(B18)+(B134), (A)+(B18)+(B135), (A)+(B18)+(B136), (A)+(B18)+(B137), (A)+(B18)+(B138), (A)+(B18)+(B139), (A)+(B18)+(B140), (A)+(B18)+(B141), (A)+(B18)+(B142), (A)+(B18)+(B143), (A)+(B18)+(B144), (A)+(B18)+(B145), (A)+(B18)+(B146), (A)+(B18)+(B147), (A)+(B18)+(B148), (A)+(B18)+(B149), (A)+(B18)+(B150), (A)+(B18)+(B151), (A)+(B18)+(B152), (A)+(B18)+(B153), (A)+(B18)+(B154), (A)+(B18)+(B155), (A)+(B18)+(B156), (A)+(B18)+(B157), (A)+(B18)+(B158), (A)+(B18)+(B159), (A)+(B18)+(B160), (A)+(B18)+(B161), (A)+(B18)+(B162), (A)+(B18)+(B164), (A)+(B18)+(B164), (A)+(B18)+(B165), (A)+(B18)+(B166), (A)+(B18)+(B167), (A)+(B18)+(B168), (A)+(B18)+(B169), (A)+(B18)+(B170), (A)+(B18)+(B171), (A)+(B18)+(B172), (A)+(B18)+(B173), (A)+(B18)+(B174), (A)+(B18)+(B175), (A)+(B18)+(B176), (A)+(B18)+(B177), (A)+(B18)+(B178), (A)+(B18)+(B179), (A)+(B18)+(B180), (A)+(B18)+(B181), (A)+(B18)+(B182), (A)+(B18)+(B183), (A)+(B18)+(B184), (A)+(B18)+(B185), (A)+(B18)+(B186), (A)+(B18)+(B187), (A)+(B18)+(B188), (A)+(B18)+(B189), (A)+(B18)+(B190), (A)+(B18)+(B191), (A)+(B18)+(B192), (A)+(B18)+(B193), (A)+(B18)+(B194), (A)+(B18)+(B195), (A)+(B18)+(B196), (A)+(B18)+(B197), (A)+(B18)+(B198), (A)+(B18)+(B199), (A)+(B18)+(B200), (A)+(B18)+(B201), (A)+(B18)+(B202), (A)+(B18)+(B203), (A)+(B18)+(B204), (A)+(B18)+(B205), (A)+(B18)+(B206), (A)+(B18)+(B207), (A)+(B18)+(B208), (A)+(B18)+(B209), (A)+(B18)+(B210), (A)+(B18)+(B211), (A)+(B18)+(B212), (A)+(B18)+(B213), (A)+(B18)+(B214), (A)+(B18)+(B215), (A)+(B18)+(B216), (A)+(B18)+(B217), (A)+(B18)+(B218), (A)+(B18)+(B219), (A)+(B18)+(B220), (A)+(B18)+(B221), (A)+(B18)+(B222), (A)+(B18)+(B223), (A)+(B18)+(B224), (A)+(B18)+(B225), (A)+(B18)+(B226), (A)+(B18)+(B227), (A)+(B18)+(B228), (A)+(B18)+(B229), (A)+(B18)+(B230), (A)+(B18)+(B231), (A)+(B18)+(B232), (A)+(B18)+(B233), (A)+(B18)+(B234), (A)+(B18)+(B235), (A)+(B18)+(B236), (A)+(B18)+(B237), (A)+(B18)+(B238), (A)+(B18)+(B239), (A)+(B18)+(B240), (A)+(B18)+(B241), (A)+(B18)+(B242), (A)+(B18)+(B243), (A)+(B18)+(B244), (A)+(B18)+(B245), (A)+(B18)+(B246), (A)+(B18)+(B247), (A)+(B18)+(B248), (A)+(B18)+(B249), (A)+(B18)+(B250), (A)+(B18)+(B251), (A)+(B18)+(B252), (A)+(B18)+(B253), (A)+(B18)+(B254), (A)+(B18)+(B255), (A)+(B18)+(B256), (A)+(B18)+(B257), (A)+(B18)+(B258), (A)+(B18)+(B259), (A)+(B18)+(B260), (A)+(B18)+(B261), (A)+(B18)+(B262), (A)+(B18)+(B263), (A)+(B18)+(B264), (A)+(B18)+(B265), (A)+(B18)+(B266), (A)+(B18)+(B267), (A)+(B18)+(B268), (A)+(B18)+(B269), (A)+(B18)+(B270), (A)+(B18)+(B271), (A)+(B18)+(B272), (A)+(B18)+(B273), (A)+(B18)+(B274), (A)+(B18)+(B275), (A)+(B18)+(B276), (A)+(B18)+(B277), (A)+(B18)+(B278), (A)+(B18)+(B279), (A)+(B18)+(B280), (A)+(B18)+(B281), (A)+(B18)+(B282), (A)+(B18)+(B283), (A)+(B18)+(B284), (A)+(B18)+(B285), (A)+(B18)+(B286), (A)+(B18)+(B287), (A)+(B18)+(B288), (A)+(B18)+(B289), (A)+(B18)+(B290), (A)+(B18)+(B291), (A)+(B18)+(B292), (A)+(B18)+(B293), (A)+(B18)+(B294), (A)+(B18)+(B295), (A)+(B18)+(B296), (A)+(B18)+(B297), (A)+(B18)+(B298), (A)+(B18)+(B299), (A)+(B18)+(B300), (A)+(B18)+(B301), (A)+(B18)+(B302), (A)+(B18)+(B303), (A)+(B18)+(B304), (A)+(B18)+(B305), (A)+(B18)+(B306), (A)+(B18)+(B307), (A)+(B18)+(B308), (A)+(B18)+(B309), (A)+(B18)+(B310), (A)+(B18)+(B311), (A)+(B18)+(B312), (A)+(B18)+(B313), (A)+(B18)+(B314), (A)+(B18)+(B315),

(A)+(B19)+(B20), (A)+(B19)+(B21), (A)+(B19)+(B22), (A)+(B19)+(B23), (A)+(B19)+(B24), (A)+(B19)+(B25), (A)+(B19)+(B26), (A)+(B19)+(B27), (A)+(B19)+(B28), (A)+(B19)+(B29), (A)+(B19)+(B30), (A)+(B19)+(B31), (A)+(B19)+(B32), (A)+(B19)+(B33), (A)+(B19)+(B34), (A)+(B19)+(B35), (A)+(B19)+(B36), (A)+(B19)+(B37), (A)+(B19)+(B38), (A)+(B19)+(B39), (A)+(B19)+(B40), (A)+(B19)+(B41), (A)+(B19)+(B42), (A)+(B19)+(B43), (A)+(B19)+(B44), (A)+(B19)+(B45), (A)+(B19)+(B46), (A)+(B19)+(B47), (A)+(B19)+(B48), (A)+(B19)+(B49), (A)+(B19)+(B50), (A)+(B19)+(B51), (A)+(B19)+(B52), (A)+(B19)+(B53), (A)+(B19)+(B54), (A)+(B19)+(B55), (A)+(B19)+(B56), (A)+(B19)+(B57), (A)+(B19)+(B58), (A)+(B19)+(B59), (A)+(B19)+(B60), (A)+(B19)+(B61), (A)+(B19)+(B62), (A)+(B19)+(B63), (A)+(B19)+(B64), (A)+(B19)+(B65), (A)+(B19)+(B66), (A)+(B19)+(B67), (A)+(B19)+(B68), (A)+(B19)+(B69), (A)+(B19)+(B70), (A)+(B19)+(B71), (A)+(B19)+(B72), (A)+(B19)+(B73), (A)+(B19)+(B74), (A)+(B19)+(B75), (A)+(B19)+(B76), (A)+(B19)+(B77), (A)+(B19)+(B78), (A)+(B19)+(B79), (A)+(B19)+(B80), (A)+(B19)+(B81), (A)+(B19)+(B82), (A)+(B19)+(B83), (A)+(B19)+(B84), (A)+(B19)+(B85), (A)+(B19)+(B86), (A)+(B19)+(B87), (A)+(B19)+(B88), (A)+(B19)+(B89), (A)+(B19)+(B90), (A)+(B19)+(B91), (A)+(B19)+(B92), (A)+(B19)+(B93), (A)+(B19)+(B94), (A)+(B19)+(B95), (A)+(B19)+(B96), (A)+(B19)+(B97), (A)+(B19)+(B98), (A)+(B19)+(B99), (A)+(B19)+(B100), (A)+(B19)+(B101), (A)+(B19)+(B102), (A)+(B19)+(B103), (A)+(B19)+(B104), (A)+(B19)+(B105), (A)+(B19)+(B106), (A)+(B19)+(B107), (A)+(B19)+(B108), (A)+(B19)+(B109), (A)+(B19)+(B110), (A)+(B19)+(B111), (A)+(B19)+(B112), (A)+(B19)+(B113), (A)+(B19)+(B114), (A)+(B19)+(B115), (A)+(B19)+(B116), (A)+(B19)+(B117), (A)+(B19)+(B118), (A)+(B19)+(B119), (A)+(B19)+(B120), (A)+(B19)+(B121), (A)+(B19)+(B122), (A)+(B19)+(B123), (A)+(B19)+(B124), (A)+(B19)+(B125), (A)+(B19)+(B126), (A)+(B19)+(B127), (A)+(B19)+(B128), (A)+(B19)+(B129), (A)+(B19)+(B130), (A)+(B19)+(B131), (A)+(B19)+(B132), (A)+(B19)+(B133), (A)+(B19)+(B134), (A)+(B19)+(B135), (A)+(B19)+(B136), (A)+(B19)+(B137), (A)+(B19)+(B138), (A)+(B19)+(B139), (A)+(B19)+(B140), (A)+(B19)+(B141), (A)+(B19)+(B142), (A)+(B19)+(B143), (A)+(B19)+(B144), (A)+(B19)+(B145), (A)+(B19)+(B146), (A)+(B19)+(B147), (A)+(B19)+(B148), (A)+(B19)+(B149), (A)+(B19)+(B150), (A)+(B19)+(B151), (A)+(B19)+(B152), (A)+(B19)+(B153), (A)+(B19)+(B154), (A)+(B19)+(B155), (A)+(B19)+(B156), (A)+(B19)+(B157), (A)+(B19)+(B158), (A)+(B19)+(B159), (A)+(B19)+(B160), (A)+(B19)+(B161), (A)+(B19)+(B162), (A)+(B19)+(B164), (A)+(B19)+(B164), (A)+(B19)+(B165), (A)+(B19)+(B166), (A)+(B19)+(B167), (A)+(B19)+(B168), (A)+(B19)+(B169), (A)+(B19)+(B170), (A)+(B19)+(B171), (A)+(B19)+(B172), (A)+(B19)+(B173), (A)+(B19)+(B174), (A)+(B19)+(B175), (A)+(B19)+(B176), (A)+(B19)+(B177), (A)+(B19)+(B178), (A)+(B19)+(B179), (A)+(B19)+(B180), (A)+(B19)+(B181), (A)+(B19)+(B182), (A)+(B19)+(B183), (A)+(B19)+(B184), (A)+(B19)+(B185), (A)+(B19)+(B186), (A)+(B19)+(B187), (A)+(B19)+(B188), (A)+(B19)+(B189), (A)+(B19)+(B190), (A)+(B19)+(B191), (A)+(B19)+(B192), (A)+(B19)+(B193), (A)+(B19)+(B194), (A)+(B19)+(B195), (A)+(B19)+(B196), (A)+(B19)+(B197), (A)+(B19)+(B198), (A)+(B19)+(B199), (A)+(B19)+(B200), (A)+(B19)+(B201), (A)+(B19)+(B202), (A)+(B19)+(B203), (A)+(B19)+(B204), (A)+(B19)+(B205), (A)+(B19)+(B206), (A)+(B19)+(B207), (A)+(B19)+(B208), (A)+(B19)+(B209), (A)+(B19)+(B210), (A)+(B19)+(B211), (A)+(B19)+(B212), (A)+(B19)+(B213), (A)+(B19)+(B214), (A)+(B19)+(B215), (A)+(B19)+(B216), (A)+(B19)+(B217), (A)+(B19)+(B218), (A)+(B19)+(B219), (A)+(B19)+(B220), (A)+(B19)+(B221), (A)+(B19)+(B222), (A)+(B19)+(B223), (A)+(B19)+(B224), (A)+(B19)+(B225), (A)+(B19)+(B226), (A)+(B19)+(B227), (A)+(B19)+(B228), (A)+(B19)+(B229), (A)+(B19)+(B230), (A)+(B19)+(B231), (A)+(B19)+(B232), (A)+(B19)+(B233), (A)+(B19)+(B234), (A)+(B19)+(B235), (A)+(B19)+(B236), (A)+(B19)+(B237), (A)+(B19)+(B238), (A)+(B19)+(B239), (A)+(B19)+(B240), (A)+(B19)+(B241), (A)+(B19)+(B242), (A)+(B19)+(B243), (A)+(B19)+(B244), (A)+(B19)+(B245), (A)+(B19)+(B246), (A)+(B19)+(B247), (A)+(B19)+(B248), (A)+(B19)+(B249), (A)+(B19)+(B250), (A)+(B19)+(B251), (A)+(B19)+(B252), (A)+(B19)+(B253), (A)+(B19)+(B254), (A)+(B19)+(B255), (A)+(B19)+(B256), (A)+(B19)+(B257), (A)+(B19)+(B258), (A)+(B19)+(B259), (A)+(B19)+(B260), (A)+(B19)+(B261), (A)+(B19)+(B262), (A)+(B19)+(B263), (A)+(B19)+(B264), (A)+(B19)+(B265), (A)+(B19)+(B266), (A)+(B19)+(B267), (A)+(B19)+(B268), (A)+(B19)+(B269), (A)+(B19)+(B270), (A)+(B19)+(B271), (A)+(B19)+(B272), (A)+(B19)+(B273), (A)+(B19)+(B274), (A)+(B19)+(B275), (A)+(B19)+(B276), (A)+(B19)+(B277), (A)+(B19)+(B278), (A)+(B19)+(B279), (A)+(B19)+(B280), (A)+(B19)+(B281), (A)+(B19)+(B282), (A)+(B19)+(B283), (A)+(B19)+(B284), (A)+(B19)+(B285), (A)+(B19)+(B286), (A)+(B19)+(B287), (A)+(B19)+(B288), (A)+(B19)+(B289), (A)+(B19)+(B290), (A)+(B19)+(B291), (A)+(B19)+(B292), (A)+(B19)+(B293), (A)+(B19)+(B294), (A)+(B19)+(B295), (A)+(B19)+(B296), (A)+(B19)+(B297), (A)+(B19)+(B298), (A)+(B19)+(B299), (A)+(B19)+(B300), (A)+(B19)+(B301), (A)+(B19)+(B302), (A)+(B19)+(B303), (A)+(B19)+(B304), (A)+(B19)+(B305), (A)+(B19)+(B306), (A)+(B19)+(B307), (A)+(B19)+(B308), (A)+(B19)+(B309), (A)+(B19)+(B310), (A)+(B19)+(B311), (A)+(B19)+(B312), (A)+(B19)+(B313), (A)+(B19)+(B314), (A)+(B19)+(B315),

(A)+(B19)+(B20), (A)+(B19)+(B21), (A)+(B19)+(B22), (A)+(B19)+(B23), (A)+(B19)+(B24), (A)+(B19)+(B25), (A)+(B19)+(B26), (A)+(B19)+(B27), (A)+(B19)+(B28), (A)+(B19)+(B29), (A)+(B19)+(B30), (A)+(B19)+(B31), (A)+(B19)+(B32), (A)+(B19)+(B33), (A)+(B19)+(B34), (A)+(B19)+(B35), (A)+(B19)+(B36), (A)+(B19)+(B37), (A)+(B19)+(B38), (A)+(B19)+(B39), (A)+(B19)+(B40), (A)+(B19)+(B41), (A)+(B19)+(B42), (A)+(B19)+(B43), (A)+(B19)+(B44), (A)+(B19)+(B45), (A)+(B19)+(B46), (A)+(B19)+(B47), (A)+(B19)+(B48), (A)+(B19)+(B49), (A)+(B19)+(B50), (A)+(B19)+(B51), (A)+(B19)+(B52), (A)+(B19)+(B53), (A)+(B19)+(B54), (A)+(B19)+(B55), (A)+(B19)+(B56), (A)+(B19)+(B57), (A)+(B19)+(B58), (A)+(B19)+(B59), (A)+(B19)+(B60), (A)+(B19)+(B61), (A)+(B19)+(B62), (A)+(B19)+(B63), (A)+(B19)+(B64), (A)+(B19)+(B65), (A)+(B19)+(B66), (A)+(B19)+(B67), (A)+(B19)+(B68), (A)+(B19)+(B69), (A)+(B19)+(B70), (A)+(B19)+(B71), (A)+(B19)+(B72), (A)+(B19)+(B73), (A)+(B19)+(B74), (A)+(B19)+(B75), (A)+(B19)+(B76), (A)+(B19)+(B77), (A)+(B19)+(B78), (A)+(B19)+(B79), (A)+(B19)+(B80), (A)+(B19)+(B81), (A)+(B19)+(B82), (A)+(B19)+(B83), (A)+(B19)+(B84), (A)+(B19)+(B85), (A)+(B19)+(B86), (A)+(B19)+(B87), (A)+(B19)+(B88), (A)+(B19)+(B89), (A)+(B19)+(B90), (A)+(B19)+(B91), (A)+(B19)+(B92), (A)+(B19)+(B93), (A)+(B19)+(B94), (A)+(B19)+(B95), (A)+(B19)+(B96), (A)+(B19)+(B97), (A)+(B19)+(B98), (A)+(B19)+(B99), (A)+(B19)+(B100), (A)+(B19)+(B101), (A)+(B19)+(B102), (A)+(B19)+(B103), (A)+(B19)+(B104), (A)+(B19)+(B105), (A)+(B19)+(B106), (A)+(B19)+(B107), (A)+(B19)+(B108), (A)+(B19)+(B109), (A)+(B19)+(B110), (A)+(B19)+(B111), (A)+(B19)+(B112), (A)+(B19)+(B113), (A)+(B19)+(B114), (A)+(B19)+(B115), (A)+(B19)+(B116), (A)+(B19)+(B117), (A)+(B19)+(B118), (A)+(B19)+(B119), (A)+(B19)+(B120), (A)+(B19)+(B121), (A)+(B19)+(B122), (A)+(B19)+(B123), (A)+(B19)+(B124), (A)+(B19)+(B125), (A)+(B19)+(B126), (A)+(B19)+(B127), (A)+(B19)+(B128), (A)+(B19)+(B129), (A)+(B19)+(B130), (A)+(B19)+(B131), (A)+(B19)+(B132), (A)+(B19)+(B133), (A)+(B19)+(B134), (A)+(B19)+(B135), (A)+(B19)+(B136), (A)+(B19)+(B137), (A)+(B19)+(B138), (A)+(B19)+(B139), (A)+(B19)+(B140), (A)+(B19)+(B141), (A)+(B19)+(B142), (A)+(B19)+(B143), (A)+(B19)+(B144), (A)+(B19)+(B145), (A)+(B19)+(B146), (A)+(B19)+(B147), (A)+(B19)+(B148), (A)+(B19)+(B149), (A)+(B19)+(B150), (A)+(B19)+(B151), (A)+(B19)+(B152), (A)+(B19)+(B153), (A)+(B19)+(B154), (A)+(B19)+(B155), (A)+(B19)+(B156), (A)+(B19)+(B157), (A)+(B19)+(B158), (A)+(B19)+(B159), (A)+(B19)+(B160), (A)+(B19)+(B161), (A)+(B19)+(B162), (A)+(B19)+(B164), (A)+(B19)+(B164), (A)+(B19)+(B165), (A)+(B19)+(B166), (A)+(B19)+(B167), (A)+(B19)+(B168), (A)+(B19)+(B169), (A)+(B19)+(B170), (A)+(B19)+(B171), (A)+(B19)+(B172), (A)+(B19)+(B173), (A)+(B19)+(B174), (A)+(B19)+(B175), (A)+(B19)+(B176), (A)+(B19)+(B177), (A)+(B19)+(B178), (A)+(B19)+(B179), (A)+(B19)+(B180), (A)+(B19)+(B181), (A)+(B19)+(B182), (A)+(B19)+(B183), (A)+(B19)+(B184), (A)+(B19)+(B185), (A)+(B19)+(B186), (A)+(B19)+(B187), (A)+(B19)+(B188), (A)+(B19)+(B189), (A)+(B19)+(B190), (A)+(B19)+(B191), (A)+(B19)+(B192), (A)+(B19)+(B193), (A)+(B19)+(B194), (A)+(B19)+(B195), (A)+(B19)+(B196), (A)+(B19)+(B197), (A)+(B19)+(B198), (A)+(B19)+(B199), (A)+(B19)+(B200), (A)+(B19)+(B201), (A)+(B19)+(B202), (A)+(B19)+(B203), (A)+(B19)+(B204), (A)+(B19)+(B205), (A)+(B19)+(B206), (A)+(B19)+(B207), (A)+(B19)+(B208), (A)+(B19)+(B209), (A)+(B19)+(B210), (A)+(B19)+(B211), (A)+(B19)+(B212), (A)+(B19)+(B213), (A)+(B19)+(B214), (A)+(B19)+(B215), (A)+(B19)+(B216), (A)+(B19)+(B217), (A)+(B19)+(B218), (A)+(B19)+(B219), (A)+(B19)+(B220), (A)+(B19)+(B221), (A)+(B19)+(B222), (A)+(B19)+(B223), (A)+(B19)+(B224), (A)+(B19)+(B225), (A)+(B19)+(B226), (A)+(B19)+(B227), (A)+(B19)+(B228), (A)+(B19)+(B229), (A)+(B19)+(B230), (A)+(B19)+(B231), (A)+(B19)+(B232), (A)+(B19)+(B233), (A)+(B19)+(B234), (A)+(B19)+(B235), (A)+(B19)+(B236), (A)+(B19)+(B237), (A)+(B19)+(B238), (A)+(B19)+(B239), (A)+(B19)+(B240), (A)+(B19)+(B241), (A)+(B19)+(B242), (A)+(B19)+(B243), (A)+(B19)+(B244), (A)+(B19)+(B245), (A)+(B19)+(B246), (A)+(B19)+(B247), (A)+(B19)+(B248), (A)+(B19)+(B249), (A)+(B19)+(B250), (A)+(B19)+(B251), (A)+(B19)+(B252), (A)+(B19)+(B253), (A)+(B19)+(B254), (A)+(B19)+(B255), (A)+(B19)+(B256), (A)+(B19)+(B257), (A)+(B19)+(B258), (A)+(B19)+(B259), (A)+(B19)+(B260), (A)+(B19)+(B261), (A)+(B19)+(B262), (A)+(B19)+(B263), (A)+(B19)+(B264), (A)+(B19)+(B265), (A)+(B19)+(B266), (A)+(B19)+(B267), (A)+(B19)+(B268), (A)+(B19)+(B269), (A)+(B19)+(B270), (A)+(B19)+(B271), (A)+(B19)+(B272), (A)+(B19)+(B273), (A)+(B19)+(B274), (A)+(B19)+(B275), (A)+(B19)+(B276), (A)+(B19)+(B277), (A)+(B19)+(B278), (A)+(B19)+(B279), (A)+(B19)+(B280), (A)+(B19)+(B281), (A)+(B19)+(B282), (A)+(B19)+(B283), (A)+(B19)+(B284), (A)+(B19)+(B285), (A)+(B19)+(B286), (A)+(B19)+(B287), (A)+(B19)+(B288), (A)+(B19)+(B289), (A)+(B19)+(B290), (A)+(B19)+(B291), (A)+(B19)+(B292), (A)+(B19)+(B293), (A)+(B19)+(B294), (A)+(B19)+(B295), (A)+(B19)+(B296), (A)+(B19)+(B297), (A)+(B19)+(B298), (A)+(B19)+(B299), (A)+(B19)+(B300), (A)+(B19)+(B301), (A)+(B19)+(B302), (A)+(B19)+(B303), (A)+(B19)+(B304), (A)+(B19)+(B305), (A)+(B19)+(B306), (A)+(B19)+(B307), (A)+(B19)+(B308), (A)+(B19)+(B309), (A)+(B19)+(B310), (A)+(B19)+(B311), (A)+(B19)+(B312), (A)+(B19)+(B313), (A)+(B19)+(B314), (A)+(B19)+(B315),

(A)+(B21)+(B22), (A)+(B21)+(B23), (A)+(B21)+(B24), (A)+(B21)+(B25), (A)+(B21)+(B26), (A)+(B21)+(B27), (A)+(B21)+(B28), (A)+(B21)+(B29), (A)+(B21)+(B30), (A)+(B21)+(B31), (A)+(B21)+(B32), (A)+(B21)+(B33), (A)+(B21)+(B34), (A)+(B21)+(B35), (A)+(B21)+(B36), (A)+(B21)+(B37), (A)+(B21)+(B38), (A)+(B21)+(B39), (A)+(B21)+(B40), (A)+(B21)+(B41), (A)+(B21)+(B42), (A)+(B21)+(B43), (A)+(B21)+(B44), (A)+(B21)+(B45), (A)+(B21)+(B46), (A)+(B21)+(B47), (A)+(B21)+(B48), (A)+(B21)+(B49), (A)+(B21)+(B50), (A)+(B21)+(B51), (A)+(B21)+(B52), (A)+(B21)+(B53), (A)+(B21)+(B54), (A)+(B21)+(B55), (A)+(B21)+(B56), (A)+(B21)+(B57), (A)+(B21)+(B58), (A)+(B21)+(B59), (A)+(B21)+(B60), (A)+(B21)+(B61), (A)+(B21)+(B62), (A)+(B21)+(B63), (A)+(B21)+(B64), (A)+(B21)+(B65), (A)+(B21)+(B66), (A)+(B21)+(B67), (A)+(B21)+(B68), (A)+(B21)+(B69), (A)+(B21)+(B70), (A)+(B21)+(B71), (A)+(B21)+(B72), (A)+(B21)+(B73), (A)+(B21)+(B74), (A)+(B21)+(B75), (A)+(B21)+(B76), (A)+(B21)+(B77), (A)+(B21)+(B78), (A)+(B21)+(B79), (A)+(B21)+(B80), (A)+(B21)+(B81), (A)+(B21)+(B82), (A)+(B21)+(B83), (A)+(B21)+(B84), (A)+(B21)+(B85), (A)+(B21)+(B86), (A)+(B21)+(B87), (A)+(B21)+(B88), (A)+(B21)+(B89), (A)+(B21)+(B90), (A)+(B21)+(B91), (A)+(B21)+(B92), (A)+(B21)+(B93), (A)+(B21)+(B94), (A)+(B21)+(B95), (A)+(B21)+(B96), (A)+(B21)+(B97), (A)+(B21)+(B98), (A)+(B21)+(B99), (A)+(B21)+(B100), (A)+(B21)+(B101), (A)+(B21)+(B102), (A)+(B21)+(B103), (A)+(B21)+(B104), (A)+(B21)+(B105), (A)+(B21)+(B106), (A)+(B21)+(B107), (A)+(B21)+(B108), (A)+(B21)+(B109), (A)+(B21)+(B110), (A)+(B21)+(B111), (A)+(B21)+(B112), (A)+(B21)+(B113), (A)+(B21)+(B114), (A)+(B21)+(B115), (A)+(B21)+(B116), (A)+(B21)+(B117), (A)+(B21)+(B118), (A)+(B21)+(B119), (A)+(B21)+(B120), (A)+(B21)+(B121), (A)+(B21)+(B122), (A)+(B21)+(B123), (A)+(B21)+(B124), (A)+(B21)+(B125), (A)+(B21)+(B126), (A)+(B21)+(B127), (A)+(B21)+(B128), (A)+(B21)+(B129), (A)+(B21)+(B130), (A)+(B21)+(B131), (A)+(B21)+(B132), (A)+(B21)+(B133), (A)+(B21)+(B134), (A)+(B21)+(B135), (A)+(B21)+(B136), (A)+(B21)+(B137), (A)+(B21)+(B138), (A)+(B21)+(B139), (A)+(B21)+(B140), (A)+(B21)+(B141), (A)+(B21)+(B142), (A)+(B21)+(B143), (A)+(B21)+(B144), (A)+(B21)+(B145), (A)+(B21)+(B146), (A)+(B21)+(B147), (A)+(B21)+(B148), (A)+(B21)+(B149), (A)+(B21)+(B150), (A)+(B21)+(B151), (A)+(B21)+(B152), (A)+(B21)+(B153), (A)+(B21)+(B154), (A)+(B21)+(B155), (A)+(B21)+(B156), (A)+(B21)+(B157), (A)+(B21)+(B158), (A)+(B21)+(B159), (A)+(B21)+(B160), (A)+(B21)+(B161), (A)+(B21)+(B162), (A)+(B21)+(B164), (A)+(B21)+(B164), (A)+(B21)+(B165), (A)+(B21)+(B166), (A)+(B21)+(B167), (A)+(B21)+(B168), (A)+(B21)+(B169), (A)+(B21)+(B170), (A)+(B21)+(B171), (A)+(B21)+(B172), (A)+(B21)+(B173), (A)+(B21)+(B174), (A)+(B21)+(B175), (A)+(B21)+(B176), (A)+(B21)+(B177), (A)+(B21)+(B178), (A)+(B21)+(B179), (A)+(B21)+(B180), (A)+(B21)+(B181), (A)+(B21)+(B182), (A)+(B21)+(B183), (A)+(B21)+(B184), (A)+(B21)+(B185), (A)+(B21)+(B186), (A)+(B21)+(B187), (A)+(B21)+(B188), (A)+(B21)+(B189), (A)+(B21)+(B190), (A)+(B21)+(B191), (A)+(B21)+(B192), (A)+(B21)+(B193), (A)+(B21)+(B194), (A)+(B21)+(B195), (A)+(B21)+(B196), (A)+(B21)+(B197), (A)+(B21)+(B198), (A)+(B21)+(B199), (A)+(B21)+(B200), (A)+(B21)+(B201), (A)+(B21)+(B202), (A)+(B21)+(B203), (A)+(B21)+(B204), (A)+(B21)+(B205), (A)+(B21)+(B206), (A)+(B21)+(B207), (A)+(B21)+(B208), (A)+(B21)+(B209), (A)+(B21)+(B210), (A)+(B21)+(B211), (A)+(B21)+(B212), (A)+(B21)+(B213), (A)+(B21)+(B214), (A)+(B21)+(B215), (A)+(B21)+(B216), (A)+(B21)+(B217), (A)+(B21)+(B218), (A)+(B21)+(B219), (A)+(B21)+(B220), (A)+(B21)+(B221), (A)+(B21)+(B222), (A)+(B21)+(B223), (A)+(B21)+(B224), (A)+(B21)+(B225), (A)+(B21)+(B226), (A)+(B21)+(B227), (A)+(B21)+(B228), (A)+(B21)+(B229), (A)+(B21)+(B230), (A)+(B21)+(B231), (A)+(B21)+(B232), (A)+(B21)+(B233), (A)+(B21)+(B234), (A)+(B21)+(B235), (A)+(B21)+(B236), (A)+(B21)+(B237), (A)+(B21)+(B238), (A)+(B21)+(B239), (A)+(B21)+(B240), (A)+(B21)+(B241), (A)+(B21)+(B242), (A)+(B21)+(B243), (A)+(B21)+(B244), (A)+(B21)+(B245), (A)+(B21)+(B246), (A)+(B21)+(B247), (A)+(B21)+(B248), (A)+(B21)+(B249), (A)+(B21)+(B250), (A)+(B21)+(B251), (A)+(B21)+(B252), (A)+(B21)+(B253), (A)+(B21)+(B254), (A)+(B21)+(B255), (A)+(B21)+(B256), (A)+(B21)+(B257), (A)+(B21)+(B258), (A)+(B21)+(B259), (A)+(B21)+(B260), (A)+(B21)+(B261), (A)+(B21)+(B262), (A)+(B21)+(B263), (A)+(B21)+(B264), (A)+(B21)+(B265), (A)+(B21)+(B266), (A)+(B21)+(B267), (A)+(B21)+(B268), (A)+(B21)+(B269), (A)+(B21)+(B270), (A)+(B21)+(B271), (A)+(B21)+(B272), (A)+(B21)+(B273), (A)+(B21)+(B274), (A)+(B21)+(B275), (A)+(B21)+(B276), (A)+(B21)+(B277), (A)+(B21)+(B278), (A)+(B21)+(B279), (A)+(B21)+(B280), (A)+(B21)+(B281), (A)+(B21)+(B282), (A)+(B21)+(B283), (A)+(B21)+(B284), (A)+(B21)+(B285), (A)+(B21)+(B286), (A)+(B21)+(B287), (A)+(B21)+(B288), (A)+(B21)+(B289), (A)+(B21)+(B290), (A)+(B21)+(B291), (A)+(B21)+(B292), (A)+(B21)+(B293), (A)+(B21)+(B294), (A)+(B21)+(B295), (A)+(B21)+(B296), (A)+(B21)+(B297), (A)+(B21)+(B298), (A)+(B21)+(B299), (A)+(B21)+(B300), (A)+(B21)+(B301), (A)+(B21)+(B302), (A)+(B21)+(B303), (A)+(B21)+(B304), (A)+(B21)+(B305), (A)+(B21)+(B306), (A)+(B21)+(B307), (A)+(B21)+(B308), (A)+(B21)+(B309), (A)+(B21)+(B310), (A)+(B21)+(B311), (A)+(B21)+(B312), (A)+(B21)+(B313), (A)+(B21)+(B314), (A)+(B21)+(B315),

(A)+(B22)+(B23), (A)+(B22)+(B24), (A)+(B22)+(B25), (A)+(B22)+(B26), (A)+(B22)+(B27), (A)+(B22)+(B28), (A)+(B22)+(B29), (A)+(B22)+(B30), (A)+(B22)+(B31), (A)+(B22)+(B32), (A)+(B22)+(B33), (A)+(B22)+(B34), (A)+(B22)+(B35), (A)+(B22)+(B36), (A)+(B22)+(B37), (A)+(B22)+(B38), (A)+(B22)+(B39), (A)+(B22)+(B40), (A)+(B22)+(B41), (A)+(B22)+(B42), (A)+(B22)+(B43), (A)+(B22)+(B44), (A)+(B22)+(B45), (A)+(B22)+(B46), (A)+(B22)+(B47), (A)+(B22)+(B48), (A)+(B22)+(B49), (A)+(B22)+(B50), (A)+(B22)+(B51), (A)+(B22)+(B52), (A)+(B22)+(B53), (A)+(B22)+(B54), (A)+(B22)+(B55), (A)+(B22)+(B56), (A)+(B22)+(B57), (A)+(B22)+(B58), (A)+(B22)+(B59), (A)+(B22)+(B60), (A)+(B22)+(B61), (A)+(B22)+(B62), (A)+(B22)+(B63), (A)+(B22)+(B64), (A)+(B22)+(B65), (A)+(B22)+(B66), (A)+(B22)+(B67), (A)+(B22)+(B68), (A)+(B22)+(B69), (A)+(B22)+(B70), (A)+(B22)+(B71), (A)+(B22)+(B72), (A)+(B22)+(B73), (A)+(B22)+(B74), (A)+(B22)+(B75), (A)+(B22)+(B76), (A)+(B22)+(B77), (A)+(B22)+(B78), (A)+(B22)+(B79), (A)+(B22)+(B80), (A)+(B22)+(B81), (A)+(B22)+(B82), (A)+(B22)+(B83), (A)+(B22)+(B84), (A)+(B22)+(B85), (A)+(B22)+(B86), (A)+(B22)+(B87), (A)+(B22)+(B88), (A)+(B22)+(B89), (A)+(B22)+(B90), (A)+(B22)+(B91), (A)+(B22)+(B92), (A)+(B22)+(B93), (A)+(B22)+(B94), (A)+(B22)+(B95), (A)+(B22)+(B96), (A)+(B22)+(B97), (A)+(B22)+(B98), (A)+(B22)+(B99), (A)+(B22)+(B100), (A)+(B22)+(B101), (A)+(B22)+(B102), (A)+(B22)+(B103), (A)+(B22)+(B104), (A)+(B22)+(B105), (A)+(B22)+(B106), (A)+(B22)+(B107), (A)+(B22)+(B108), (A)+(B22)+(B109), (A)+(B22)+(B110), (A)+(B22)+(B111), (A)+(B22)+(B112), (A)+(B22)+(B113), (A)+(B22)+(B114), (A)+(B22)+(B115), (A)+(B22)+(B116), (A)+(B22)+(B117), (A)+(B22)+(B118), (A)+(B22)+(B119), (A)+(B22)+(B120), (A)+(B22)+(B121), (A)+(B22)+(B122), (A)+(B22)+(B123), (A)+(B22)+(B124), (A)+(B22)+(B125), (A)+(B22)+(B126), (A)+(B22)+(B127), (A)+(B22)+(B128), (A)+(B22)+(B129), (A)+(B22)+(B130), (A)+(B22)+(B131), (A)+(B22)+(B132), (A)+(B22)+(B133), (A)+(B22)+(B134), (A)+(B22)+(B135), (A)+(B22)+(B136), (A)+(B22)+(B137), (A)+(B22)+(B138), (A)+(B22)+(B139), (A)+(B22)+(B140), (A)+(B22)+(B141), (A)+(B22)+(B142), (A)+(B22)+(B143), (A)+(B22)+(B144), (A)+(B22)+(B145), (A)+(B22)+(B146), (A)+(B22)+(B147), (A)+(B22)+(B148), (A)+(B22)+(B149), (A)+(B22)+(B150), (A)+(B22)+(B151), (A)+(B22)+(B152), (A)+(B22)+(B153), (A)+(B22)+(B154), (A)+(B22)+(B155), (A)+(B22)+(B156), (A)+(B22)+(B157), (A)+(B22)+(B158), (A)+(B22)+(B159), (A)+(B22)+(B160), (A)+(B22)+(B161), (A)+(B22)+(B162), (A)+(B22)+(B164), (A)+(B22)+(B164), (A)+(B22)+(B165), (A)+(B22)+(B166), (A)+(B22)+(B167), (A)+(B22)+(B168), (A)+(B22)+(B169), (A)+(B22)+(B170), (A)+(B22)+(B171), (A)+(B22)+(B172), (A)+(B22)+(B173), (A)+(B22)+(B174), (A)+(B22)+(B175), (A)+(B22)+(B176), (A)+(B22)+(B177), (A)+(B22)+(B178), (A)+(B22)+(B179), (A)+(B22)+(B180), (A)+(B22)+(B181), (A)+(B22)+(B182), (A)+(B22)+(B183), (A)+(B22)+(B184), (A)+(B22)+(B185), (A)+(B22)+(B186), (A)+(B22)+(B187), (A)+(B22)+(B188), (A)+(B22)+(B189), (A)+(B22)+(B190), (A)+(B22)+(B191), (A)+(B22)+(B192), (A)+(B22)+(B193), (A)+(B22)+(B194), (A)+(B22)+(B195), (A)+(B22)+(B196), (A)+(B22)+(B197), (A)+(B22)+(B198), (A)+(B22)+(B199), (A)+(B22)+(B200), (A)+(B22)+(B201), (A)+(B22)+(B202), (A)+(B22)+(B203), (A)+(B22)+(B204), (A)+(B22)+(B205), (A)+(B22)+(B206), (A)+(B22)+(B207), (A)+(B22)+(B208), (A)+(B22)+(B209), (A)+(B22)+(B210), (A)+(B22)+(B211), (A)+(B22)+(B212), (A)+(B22)+(B213), (A)+(B22)+(B214), (A)+(B22)+(B215), (A)+(B22)+(B216), (A)+(B22)+(B217), (A)+(B22)+(B218), (A)+(B22)+(B219), (A)+(B22)+(B220), (A)+(B22)+(B221), (A)+(B22)+(B222), (A)+(B22)+(B223), (A)+(B22)+(B224), (A)+(B22)+(B225), (A)+(B22)+(B226), (A)+(B22)+(B227), (A)+(B22)+(B228), (A)+(B22)+(B229), (A)+(B22)+(B230), (A)+(B22)+(B231), (A)+(B22)+(B232), (A)+(B22)+(B233), (A)+(B22)+(B234), (A)+(B22)+(B235), (A)+(B22)+(B236), (A)+(B22)+(B237), (A)+(B22)+(B238), (A)+(B22)+(B239), (A)+(B22)+(B240), (A)+(B22)+(B241), (A)+(B22)+(B242), (A)+(B22)+(B243), (A)+(B22)+(B244), (A)+(B22)+(B245), (A)+(B22)+(B246), (A)+(B22)+(B247), (A)+(B22)+(B248), (A)+(B22)+(B249), (A)+(B22)+(B250), (A)+(B22)+(B251), (A)+(B22)+(B252), (A)+(B22)+(B253), (A)+(B22)+(B254), (A)+(B22)+(B255), (A)+(B22)+(B256), (A)+(B22)+(B257), (A)+(B22)+(B258), (A)+(B22)+(B259), (A)+(B22)+(B260), (A)+(B22)+(B261), (A)+(B22)+(B262), (A)+(B22)+(B263), (A)+(B22)+(B264), (A)+(B22)+(B265), (A)+(B22)+(B266), (A)+(B22)+(B267), (A)+(B22)+(B268), (A)+(B22)+(B269), (A)+(B22)+(B270), (A)+(B22)+(B271), (A)+(B22)+(B272), (A)+(B22)+(B273), (A)+(B22)+(B274), (A)+(B22)+(B275), (A)+(B22)+(B276), (A)+(B22)+(B277), (A)+(B22)+(B278), (A)+(B22)+(B279), (A)+(B22)+(B280), (A)+(B22)+(B281), (A)+(B22)+(B282), (A)+(B22)+(B283), (A)+(B22)+(B284), (A)+(B22)+(B285), (A)+(B22)+(B286), (A)+(B22)+(B287), (A)+(B22)+(B288), (A)+(B22)+(B289), (A)+(B22)+(B290), (A)+(B22)+(B291), (A)+(B22)+(B292), (A)+(B22)+(B293), (A)+(B22)+(B294), (A)+(B22)+(B295), (A)+(B22)+(B296), (A)+(B22)+(B297), (A)+(B22)+(B298), (A)+(B22)+(B299), (A)+(B22)+(B300), (A)+(B22)+(B301), (A)+(B22)+(B302), (A)+(B22)+(B303), (A)+(B22)+(B304), (A)+(B22)+(B305), (A)+(B22)+(B306), (A)+(B22)+(B307), (A)+(B22)+(B308), (A)+(B22)+(B309), (A)+(B22)+(B310), (A)+(B22)+(B311), (A)+(B22)+(B312), (A)+(B22)+(B313), (A)+(B22)+(B314), (A)+(B22)+(B315),

(A)+(B23)+(B24), (A)+(B23)+(B25), (A)+(B23)+(B26), (A)+(B23)+(B27), (A)+(B23)+(B28), (A)+(B23)+(B29), (A)+(B23)+(B30), (A)+(B23)+(B31), (A)+(B23)+(B32), (A)+(B23)+(B33), (A)+(B23)+(B34), (A)+(B23)+(B35), (A)+(B23)+(B36), (A)+(B23)+(B37), (A)+(B23)+(B38), (A)+(B23)+(B39), (A)+(B23)+(B40), (A)+(B23)+(B41), (A)+(B23)+(B42), (A)+(B23)+(B43), (A)+(B23)+(B44), (A)+(B23)+(B45), (A)+(B23)+(B46), (A)+(B23)+(B47), (A)+(B23)+(B48), (A)+(B23)+(B49), (A)+(B23)+(B50), (A)+(B23)+(B51), (A)+(B23)+(B52), (A)+(B23)+(B53), (A)+(B23)+(B54), (A)+(B23)+(B55), (A)+(B23)+(B56), (A)+(B23)+(B57), (A)+(B23)+(B58), (A)+(B23)+(B59), (A)+(B23)+(B60), (A)+(B23)+(B61), (A)+(B23)+(B62), (A)+(B23)+(B63), (A)+(B23)+(B64), (A)+(B23)+(B65), (A)+(B23)+(B66), (A)+(B23)+(B67), (A)+(B23)+(B68), (A)+(B23)+(B69), (A)+(B23)+(B70), (A)+(B23)+(B71), (A)+(B23)+(B72), (A)+(B23)+(B73), (A)+(B23)+(B74), (A)+(B23)+(B75), (A)+(B23)+(B76), (A)+(B23)+(B77), (A)+(B23)+(B78), (A)+(B23)+(B79), (A)+(B23)+(B80), (A)+(B23)+(B81), (A)+(B23)+(B82), (A)+(B23)+(B83), (A)+(B23)+(B84), (A)+(B23)+(B85), (A)+(B23)+(B86), (A)+(B23)+(B87), (A)+(B23)+(B88), (A)+(B23)+(B89), (A)+(B23)+(B90), (A)+(B23)+(B91), (A)+(B23)+(B92), (A)+(B23)+(B93), (A)+(B23)+(B94), (A)+(B23)+(B95), (A)+(B23)+(B96), (A)+(B23)+(B97), (A)+(B23)+(B98), (A)+(B23)+(B99), (A)+(B23)+(B100), (A)+(B23)+(B101), (A)+(B23)+(B102), (A)+(B23)+(B103), (A)+(B23)+(B104), (A)+(B23)+(B105), (A)+(B23)+(B106), (A)+(B23)+(B107), (A)+(B23)+(B108), (A)+(B23)+(B109), (A)+(B23)+(B110), (A)+(B23)+(B111), (A)+(B23)+(B112), (A)+(B23)+(B113), (A)+(B23)+(B114), (A)+(B23)+(B115), (A)+(B23)+(B116), (A)+(B23)+(B117), (A)+(B23)+(B118), (A)+(B23)+(B119), (A)+(B23)+(B120), (A)+(B23)+(B121), (A)+(B23)+(B122), (A)+(B23)+(B123), (A)+(B23)+(B124), (A)+(B23)+(B125), (A)+(B23)+(B126), (A)+(B23)+(B127), (A)+(B23)+(B128), (A)+(B23)+(B129), (A)+(B23)+(B130), (A)+(B23)+(B131), (A)+(B23)+(B132), (A)+(B23)+(B133), (A)+(B23)+(B134), (A)+(B23)+(B135), (A)+(B23)+(B136), (A)+(B23)+(B137), (A)+(B23)+(B138), (A)+(B23)+(B139), (A)+(B23)+(B140), (A)+(B23)+(B141), (A)+(B23)+(B142), (A)+(B23)+(B143), (A)+(B23)+(B144), (A)+(B23)+(B145), (A)+(B23)+(B146), (A)+(B23)+(B147), (A)+(B23)+(B148), (A)+(B23)+(B149), (A)+(B23)+(B150), (A)+(B23)+(B151), (A)+(B23)+(B152), (A)+(B23)+(B153), (A)+(B23)+(B154), (A)+(B23)+(B155), (A)+(B23)+(B156), (A)+(B23)+(B157), (A)+(B23)+(B158), (A)+(B23)+(B159), (A)+(B23)+(B160), (A)+(B23)+(B161), (A)+(B23)+(B162), (A)+(B23)+(B164), (A)+(B23)+(B164), (A)+(B23)+(B165), (A)+(B23)+(B166), (A)+(B23)+(B167), (A)+(B23)+(B168), (A)+(B23)+(B169), (A)+(B23)+(B170), (A)+(B23)+(B171), (A)+(B23)+(B172), (A)+(B23)+(B173), (A)+(B23)+(B174), (A)+(B23)+(B175), (A)+(B23)+(B176), (A)+(B23)+(B177), (A)+(B23)+(B178), (A)+(B23)+(B179), (A)+(B23)+(B180), (A)+(B23)+(B181), (A)+(B23)+(B182), (A)+(B23)+(B183), (A)+(B23)+(B184), (A)+(B23)+(B185), (A)+(B23)+(B186), (A)+(B23)+(B187), (A)+(B23)+(B188), (A)+(B23)+(B189), (A)+(B23)+(B190), (A)+(B23)+(B191), (A)+(B23)+(B192), (A)+(B23)+(B193), (A)+(B23)+(B194), (A)+(B23)+(B195), (A)+(B23)+(B196), (A)+(B23)+(B197), (A)+(B23)+(B198), (A)+(B23)+(B199), (A)+(B23)+(B200), (A)+(B23)+(B201), (A)+(B23)+(B202), (A)+(B23)+(B203), (A)+(B23)+(B204), (A)+(B23)+(B205), (A)+(B23)+(B206), (A)+(B23)+(B207), (A)+(B23)+(B208), (A)+(B23)+(B209), (A)+(B23)+(B210), (A)+(B23)+(B211), (A)+(B23)+(B212), (A)+(B23)+(B213), (A)+(B23)+(B214), (A)+(B23)+(B215), (A)+(B23)+(B216), (A)+(B23)+(B217), (A)+(B23)+(B218), (A)+(B23)+(B219), (A)+(B23)+(B220), (A)+(B23)+(B221), (A)+(B23)+(B222), (A)+(B23)+(B223), (A)+(B23)+(B224), (A)+(B23)+(B225), (A)+(B23)+(B226), (A)+(B23)+(B227), (A)+(B23)+(B228), (A)+(B23)+(B229), (A)+(B23)+(B230), (A)+(B23)+(B231), (A)+(B23)+(B232), (A)+(B23)+(B233), (A)+(B23)+(B234), (A)+(B23)+(B235), (A)+(B23)+(B236), (A)+(B23)+(B237), (A)+(B23)+(B238), (A)+(B23)+(B239), (A)+(B23)+(B240), (A)+(B23)+(B241), (A)+(B23)+(B242), (A)+(B23)+(B243), (A)+(B23)+(B244), (A)+(B23)+(B245), (A)+(B23)+(B246), (A)+(B23)+(B247), (A)+(B23)+(B248), (A)+(B23)+(B249), (A)+(B23)+(B250), (A)+(B23)+(B251), (A)+(B23)+(B252), (A)+(B23)+(B253), (A)+(B23)+(B254), (A)+(B23)+(B255), (A)+(B23)+(B256), (A)+(B23)+(B257), (A)+(B23)+(B258), (A)+(B23)+(B259), (A)+(B23)+(B260), (A)+(B23)+(B261), (A)+(B23)+(B262), (A)+(B23)+(B263), (A)+(B23)+(B264), (A)+(B23)+(B265), (A)+(B23)+(B266), (A)+(B23)+(B267), (A)+(B23)+(B268), (A)+(B23)+(B269), (A)+(B23)+(B270), (A)+(B23)+(B271), (A)+(B23)+(B272), (A)+(B23)+(B273), (A)+(B23)+(B274), (A)+(B23)+(B275), (A)+(B23)+(B276), (A)+(B23)+(B277), (A)+(B23)+(B278), (A)+(B23)+(B279), (A)+(B23)+(B280), (A)+(B23)+(B281), (A)+(B23)+(B282), (A)+(B23)+(B283), (A)+(B23)+(B284), (A)+(B23)+(B285), (A)+(B23)+(B286), (A)+(B23)+(B287), (A)+(B23)+(B288), (A)+(B23)+(B289), (A)+(B23)+(B290), (A)+(B23)+(B291), (A)+(B23)+(B292), (A)+(B23)+(B293), (A)+(B23)+(B294), (A)+(B23)+(B295), (A)+(B23)+(B296), (A)+(B23)+(B297), (A)+(B23)+(B298), (A)+(B23)+(B299), (A)+(B23)+(B300), (A)+(B23)+(B301), (A)+(B23)+(B302), (A)+(B23)+(B303), (A)+(B23)+(B304), (A)+(B23)+(B305), (A)+(B23)+(B306), (A)+(B23)+(B307), (A)+(B23)+(B308), (A)+(B23)+(B309), (A)+(B23)+(B310), (A)+(B23)+(B311), (A)+(B23)+(B312), (A)+(B23)+(B313), (A)+(B23)+(B314), (A)+(B23)+(B315),

(A)+(B24)+(B25), (A)+(B24)+(B26), (A)+(B24)+(B27), (A)+(B24)+(B28), (A)+(B24)+(B29), (A)+(B24)+(B30), (A)+(B24)+(B31), (A)+(B24)+(B32), (A)+(B24)+(B33), (A)+(B24)+(B34), (A)+(B24)+(B35), (A)+(B24)+(B36), (A)+(B24)+(B37), (A)+(B24)+(B38), (A)+(B24)+(B39), (A)+(B24)+(B40), (A)+(B24)+(B41), (A)+(B24)+(B42), (A)+(B24)+(B43), (A)+(B24)+(B44), (A)+(B24)+(B45), (A)+(B24)+(B46), (A)+(B24)+(B47), (A)+(B24)+(B48), (A)+(B24)+(B49), (A)+(B24)+(B50), (A)+(B24)+(B51), (A)+(B24)+(B52), (A)+(B24)+(B53), (A)+(B24)+(B54), (A)+(B24)+(B55), (A)+(B24)+(B56), (A)+(B24)+(B57), (A)+(B24)+(B58), (A)+(B24)+(B59), (A)+(B24)+(B60), (A)+(B24)+(B61), (A)+(B24)+(B62), (A)+(B24)+(B63), (A)+(B24)+(B64), (A)+(B24)+(B65), (A)+(B24)+(B66), (A)+(B24)+(B67), (A)+(B24)+(B68), (A)+(B24)+(B69), (A)+(B24)+(B70), (A)+(B24)+(B71), (A)+(B24)+(B72), (A)+(B24)+(B73), (A)+(B24)+(B74), (A)+(B24)+(B75), (A)+(B24)+(B76), (A)+(B24)+(B77), (A)+(B24)+(B78), (A)+(B24)+(B79), (A)+(B24)+(B80), (A)+(B24)+(B81), (A)+(B24)+(B82), (A)+(B24)+(B83), (A)+(B24)+(B84), (A)+(B24)+(B85), (A)+(B24)+(B86), (A)+(B24)+(B87), (A)+(B24)+(B88), (A)+(B24)+(B89), (A)+(B24)+(B90), (A)+(B24)+(B91), (A)+(B24)+(B92), (A)+(B24)+(B93), (A)+(B24)+(B94), (A)+(B24)+(B95), (A)+(B24)+(B96), (A)+(B24)+(B97), (A)+(B24)+(B98), (A)+(B24)+(B99), (A)+(B24)+(B100), (A)+(B24)+(B101), (A)+(B24)+(B102), (A)+(B24)+(B103), (A)+(B24)+(B104), (A)+(B24)+(B105), (A)+(B24)+(B106), (A)+(B24)+(B107), (A)+(B24)+(B108), (A)+(B24)+(B109), (A)+(B24)+(B110), (A)+(B24)+(B111), (A)+(B24)+(B112), (A)+(B24)+(B113), (A)+(B24)+(B114), (A)+(B24)+(B115), (A)+(B24)+(B116), (A)+(B24)+(B117), (A)+(B24)+(B118), (A)+(B24)+(B119), (A)+(B24)+(B120), (A)+(B24)+(B121), (A)+(B24)+(B122), (A)+(B24)+(B123), (A)+(B24)+(B124), (A)+(B24)+(B125), (A)+(B24)+(B126), (A)+(B24)+(B127), (A)+(B24)+(B128), (A)+(B24)+(B129), (A)+(B24)+(B130), (A)+(B24)+(B131), (A)+(B24)+(B132), (A)+(B24)+(B133), (A)+(B24)+(B134), (A)+(B24)+(B135), (A)+(B24)+(B136), (A)+(B24)+(B137), (A)+(B24)+(B138), (A)+(B24)+(B139), (A)+(B24)+(B140), (A)+(B24)+(B141), (A)+(B24)+(B142), (A)+(B24)+(B143), (A)+(B24)+(B144), (A)+(B24)+(B145), (A)+(B24)+(B146), (A)+(B24)+(B147), (A)+(B24)+(B148), (A)+(B24)+(B149), (A)+(B24)+(B150), (A)+(B24)+(B151), (A)+(B24)+(B152), (A)+(B24)+(B153), (A)+(B24)+(B154), (A)+(B24)+(B155), (A)+(B24)+(B156), (A)+(B24)+(B157), (A)+(B24)+(B158), (A)+(B24)+(B159), (A)+(B24)+(B160), (A)+(B24)+(B161), (A)+(B24)+(B162), (A)+(B24)+(B164), (A)+(B24)+(B164), (A)+(B24)+(B165), (A)+(B24)+(B166), (A)+(B24)+(B167), (A)+(B24)+(B168), (A)+(B24)+(B169), (A)+(B24)+(B170), (A)+(B24)+(B171), (A)+(B24)+(B172), (A)+(B24)+(B173), (A)+(B24)+(B174), (A)+(B24)+(B175), (A)+(B24)+(B176), (A)+(B24)+(B177), (A)+(B24)+(B178), (A)+(B24)+(B179), (A)+(B24)+(B180), (A)+(B24)+(B181), (A)+(B24)+(B182), (A)+(B24)+(B183), (A)+(B24)+(B184), (A)+(B24)+(B185), (A)+(B24)+(B186), (A)+(B24)+(B187), (A)+(B24)+(B188), (A)+(B24)+(B189), (A)+(B24)+(B190), (A)+(B24)+(B191), (A)+(B24)+(B192), (A)+(B24)+(B193), (A)+(B24)+(B194), (A)+(B24)+(B195), (A)+(B24)+(B196), (A)+(B24)+(B197), (A)+(B24)+(B198), (A)+(B24)+(B199), (A)+(B24)+(B200), (A)+(B24)+(B201), (A)+(B24)+(B202), (A)+(B24)+(B203), (A)+(B24)+(B204), (A)+(B24)+(B205), (A)+(B24)+(B206), (A)+(B24)+(B207), (A)+(B24)+(B208), (A)+(B24)+(B209), (A)+(B24)+(B210), (A)+(B24)+(B211), (A)+(B24)+(B212), (A)+(B24)+(B213), (A)+(B24)+(B214), (A)+(B24)+(B215), (A)+(B24)+(B216), (A)+(B24)+(B217), (A)+(B24)+(B218), (A)+(B24)+(B219), (A)+(B24)+(B220), (A)+(B24)+(B221), (A)+(B24)+(B222), (A)+(B24)+(B223), (A)+(B24)+(B224), (A)+(B24)+(B225), (A)+(B24)+(B226), (A)+(B24)+(B227), (A)+(B24)+(B228), (A)+(B24)+(B229), (A)+(B24)+(B230), (A)+(B24)+(B231), (A)+(B24)+(B232), (A)+(B24)+(B233), (A)+(B24)+(B234), (A)+(B24)+(B235), (A)+(B24)+(B236), (A)+(B24)+(B237), (A)+(B24)+(B238), (A)+(B24)+(B239), (A)+(B24)+(B240), (A)+(B24)+(B241), (A)+(B24)+(B242), (A)+(B24)+(B243), (A)+(B24)+(B244), (A)+(B24)+(B245), (A)+(B24)+(B246), (A)+(B24)+(B247), (A)+(B24)+(B248), (A)+(B24)+(B249), (A)+(B24)+(B250), (A)+(B24)+(B251), (A)+(B24)+(B252), (A)+(B24)+(B253), (A)+(B24)+(B254), (A)+(B24)+(B255), (A)+(B24)+(B256), (A)+(B24)+(B257), (A)+(B24)+(B258), (A)+(B24)+(B259), (A)+(B24)+(B260), (A)+(B24)+(B261), (A)+(B24)+(B262), (A)+(B24)+(B263), (A)+(B24)+(B264), (A)+(B24)+(B265), (A)+(B24)+(B266), (A)+(B24)+(B267), (A)+(B24)+(B268), (A)+(B24)+(B269), (A)+(B24)+(B270), (A)+(B24)+(B271), (A)+(B24)+(B272), (A)+(B24)+(B273), (A)+(B24)+(B274), (A)+(B24)+(B275), (A)+(B24)+(B276), (A)+(B24)+(B277), (A)+(B24)+(B278), (A)+(B24)+(B279), (A)+(B24)+(B280), (A)+(B24)+(B281), (A)+(B24)+(B282), (A)+(B24)+(B283), (A)+(B24)+(B284), (A)+(B24)+(B285), (A)+(B24)+(B286), (A)+(B24)+(B287), (A)+(B24)+(B288), (A)+(B24)+(B289), (A)+(B24)+(B290), (A)+(B24)+(B291), (A)+(B24)+(B292), (A)+(B24)+(B293), (A)+(B24)+(B294), (A)+(B24)+(B295), (A)+(B24)+(B296), (A)+(B24)+(B297), (A)+(B24)+(B298), (A)+(B24)+(B299), (A)+(B24)+(B300), (A)+(B24)+(B301), (A)+(B24)+(B302), (A)+(B24)+(B303), (A)+(B24)+(B304), (A)+(B24)+(B305), (A)+(B24)+(B306), (A)+(B24)+(B307), (A)+(B24)+(B308), (A)+(B24)+(B309), (A)+(B24)+(B310), (A)+(B24)+(B311), (A)+(B24)+(B312), (A)+(B24)+(B313), (A)+(B24)+(B314), (A)+(B24)+(B315),

(A)+(B25)+(B26), (A)+(B25)+(B27), (A)+(B25)+(B28), (A)+(B25)+(B29), (A)+(B25)+(B30), (A)+(B25)+(B31), (A)+(B25)+(B32), (A)+(B25)+(B33), (A)+(B25)+(B34), (A)+(B25)+(B35), (A)+(B25)+(B36), (A)+(B25)+(B37), (A)+(B25)+(B38), (A)+(B25)+(B39), (A)+(B25)+(B40), (A)+(B25)+(B41), (A)+(B25)+(B42), (A)+(B25)+(B43), (A)+(B25)+(B44), (A)+(B25)+(B45), (A)+(B25)+(B46), (A)+(B25)+(B47), (A)+(B25)+(B48), (A)+(B25)+(B49), (A)+(B25)+(B50), (A)+(B25)+(B51), (A)+(B25)+(B52), (A)+(B25)+(B53), (A)+(B25)+(B54), (A)+(B25)+(B55), (A)+(B25)+(B56), (A)+(B25)+(B57), (A)+(B25)+(B58), (A)+(B25)+(B59), (A)+(B25)+(B60), (A)+(B25)+(B61), (A)+(B25)+(B62), (A)+(B25)+(B63), (A)+(B25)+(B64), (A)+(B25)+(B65), (A)+(B25)+(B66), (A)+(B25)+(B67), (A)+(B25)+(B68), (A)+(B25)+(B69), (A)+(B25)+(B70), (A)+(B25)+(B71), (A)+(B25)+(B72), (A)+(B25)+(B73), (A)+(B25)+(B74), (A)+(B25)+(B75), (A)+(B25)+(B76), (A)+(B25)+(B77), (A)+(B25)+(B78), (A)+(B25)+(B79), (A)+(B25)+(B80), (A)+(B25)+(B81), (A)+(B25)+(B82), (A)+(B25)+(B83), (A)+(B25)+(B84), (A)+(B25)+(B85), (A)+(B25)+(B86), (A)+(B25)+(B87), (A)+(B25)+(B88), (A)+(B25)+(B89), (A)+(B25)+(B90), (A)+(B25)+(B91), (A)+(B25)+(B92), (A)+(B25)+(B93), (A)+(B25)+(B94), (A)+(B25)+(B95), (A)+(B25)+(B96), (A)+(B25)+(B97), (A)+(B25)+(B98), (A)+(B25)+(B99), (A)+(B25)+(B100), (A)+(B25)+(B101), (A)+(B25)+(B102), (A)+(B25)+(B103), (A)+(B25)+(B104), (A)+(B25)+(B105), (A)+(B25)+(B106), (A)+(B25)+(B107), (A)+(B25)+(B108), (A)+(B25)+(B109), (A)+(B25)+(B110), (A)+(B25)+(B111), (A)+(B25)+(B112), (A)+(B25)+(B113), (A)+(B25)+(B114), (A)+(B25)+(B115), (A)+(B25)+(B116), (A)+(B25)+(B117), (A)+(B25)+(B118), (A)+(B25)+(B119), (A)+(B25)+(B120), (A)+(B25)+(B121), (A)+(B25)+(B122), (A)+(B25)+(B123), (A)+(B25)+(B124), (A)+(B25)+(B125), (A)+(B25)+(B126), (A)+(B25)+(B127), (A)+(B25)+(B128), (A)+(B25)+(B129), (A)+(B25)+(B130), (A)+(B25)+(B131), (A)+(B25)+(B132), (A)+(B25)+(B133), (A)+(B25)+(B134), (A)+(B25)+(B135), (A)+(B25)+(B136), (A)+(B25)+(B137), (A)+(B25)+(B138), (A)+(B25)+(B139), (A)+(B25)+(B140), (A)+(B25)+(B141), (A)+(B25)+(B142), (A)+(B25)+(B143), (A)+(B25)+(B144), (A)+(B25)+(B145), (A)+(B25)+(B146), (A)+(B25)+(B147), (A)+(B25)+(B148), (A)+(B25)+(B149), (A)+(B25)+(B150), (A)+(B25)+(B151), (A)+(B25)+(B152), (A)+(B25)+(B153), (A)+(B25)+(B154), (A)+(B25)+(B155), (A)+(B25)+(B156), (A)+(B25)+(B157), (A)+(B25)+(B158), (A)+(B25)+(B159), (A)+(B25)+(B160), (A)+(B25)+(B161), (A)+(B25)+(B162), (A)+(B25)+(B164), (A)+(B25)+(B164), (A)+(B25)+(B165), (A)+(B25)+(B166), (A)+(B25)+(B167), (A)+(B25)+(B168), (A)+(B25)+(B169), (A)+(B25)+(B170), (A)+(B25)+(B171), (A)+(B25)+(B172), (A)+(B25)+(B173), (A)+(B25)+(B174), (A)+(B25)+(B175), (A)+(B25)+(B176), (A)+(B25)+(B177), (A)+(B25)+(B178), (A)+(B25)+(B179), (A)+(B25)+(B180), (A)+(B25)+(B181), (A)+(B25)+(B182), (A)+(B25)+(B183), (A)+(B25)+(B184), (A)+(B25)+(B185), (A)+(B25)+(B186), (A)+(B25)+(B187), (A)+(B25)+(B188), (A)+(B25)+(B189), (A)+(B25)+(B190), (A)+(B25)+(B191), (A)+(B25)+(B192), (A)+(B25)+(B193), (A)+(B25)+(B194), (A)+(B25)+(B195), (A)+(B25)+(B196), (A)+(B25)+(B197), (A)+(B25)+(B198), (A)+(B25)+(B199), (A)+(B25)+(B200), (A)+(B25)+(B201), (A)+(B25)+(B202), (A)+(B25)+(B203), (A)+(B25)+(B204), (A)+(B25)+(B205), (A)+(B25)+(B206), (A)+(B25)+(B207), (A)+(B25)+(B208), (A)+(B25)+(B209), (A)+(B25)+(B210), (A)+(B25)+(B211), (A)+(B25)+(B212), (A)+(B25)+(B213), (A)+(B25)+(B214), (A)+(B25)+(B215), (A)+(B25)+(B216), (A)+(B25)+(B217), (A)+(B25)+(B218), (A)+(B25)+(B219), (A)+(B25)+(B220), (A)+(B25)+(B221), (A)+(B25)+(B222), (A)+(B25)+(B223), (A)+(B25)+(B224), (A)+(B25)+(B225), (A)+(B25)+(B226), (A)+(B25)+(B227), (A)+(B25)+(B228), (A)+(B25)+(B229), (A)+(B25)+(B230), (A)+(B25)+(B231), (A)+(B25)+(B232), (A)+(B25)+(B233), (A)+(B25)+(B234), (A)+(B25)+(B235), (A)+(B25)+(B236), (A)+(B25)+(B237), (A)+(B25)+(B238), (A)+(B25)+(B239), (A)+(B25)+(B240), (A)+(B25)+(B241), (A)+(B25)+(B242), (A)+(B25)+(B243), (A)+(B25)+(B244), (A)+(B25)+(B245), (A)+(B25)+(B246), (A)+(B25)+(B247), (A)+(B25)+(B248), (A)+(B25)+(B249), (A)+(B25)+(B250), (A)+(B25)+(B251), (A)+(B25)+(B252), (A)+(B25)+(B253), (A)+(B25)+(B254), (A)+(B25)+(B255), (A)+(B25)+(B256), (A)+(B25)+(B257), (A)+(B25)+(B258), (A)+(B25)+(B259), (A)+(B25)+(B260), (A)+(B25)+(B261), (A)+(B25)+(B262), (A)+(B25)+(B263), (A)+(B25)+(B264), (A)+(B25)+(B265), (A)+(B25)+(B266), (A)+(B25)+(B267), (A)+(B25)+(B268), (A)+(B25)+(B269), (A)+(B25)+(B270), (A)+(B25)+(B271), (A)+(B25)+(B272), (A)+(B25)+(B273), (A)+(B25)+(B274), (A)+(B25)+(B275), (A)+(B25)+(B276), (A)+(B25)+(B277), (A)+(B25)+(B278), (A)+(B25)+(B279), (A)+(B25)+(B280), (A)+(B25)+(B281), (A)+(B25)+(B282), (A)+(B25)+(B283), (A)+(B25)+(B284), (A)+(B25)+(B285), (A)+(B25)+(B286), (A)+(B25)+(B287), (A)+(B25)+(B288), (A)+(B25)+(B289), (A)+(B25)+(B290), (A)+(B25)+(B291), (A)+(B25)+(B292), (A)+(B25)+(B293), (A)+(B25)+(B294), (A)+(B25)+(B295), (A)+(B25)+(B296), (A)+(B25)+(B297), (A)+(B25)+(B298), (A)+(B25)+(B299), (A)+(B25)+(B300), (A)+(B25)+(B301), (A)+(B25)+(B302), (A)+(B25)+(B303), (A)+(B25)+(B304), (A)+(B25)+(B305), (A)+(B25)+(B306), (A)+(B25)+(B307), (A)+(B25)+(B308), (A)+(B25)+(B309), (A)+(B25)+(B310), (A)+(B25)+(B311), (A)+(B25)+(B312), (A)+(B25)+(B313), (A)+(B25)+(B314), (A)+(B25)+(B315),

(A)+(B26)+(B27), (A)+(B26)+(B28), (A)+(B26)+(B29), (A)+(B26)+(B30), (A)+(B26)+(B31), (A)+(B26)+(B32), (A)+(B26)+(B33), (A)+(B26)+(B34), (A)+(B26)+(B35), (A)+(B26)+(B36), (A)+(B26)+(B37), (A)+(B26)+(B38), (A)+(B26)+(B39), (A)+(B26)+(B40), (A)+(B26)+(B41), (A)+(B26)+(B42), (A)+(B26)+(B43), (A)+(B26)+(B44), (A)+(B26)+(B45), (A)+(B26)+(B46), (A)+(B26)+(B47), (A)+(B26)+(B48), (A)+(B26)+(B49), (A)+(B26)+(B50), (A)+(B26)+(B51), (A)+(B26)+(B52), (A)+(B26)+(B53), (A)+(B26)+(B54), (A)+(B26)+(B55), (A)+(B26)+(B56), (A)+(B26)+(B57), (A)+(B26)+(B58), (A)+(B26)+(B59), (A)+(B26)+(B60), (A)+(B26)+(B61), (A)+(B26)+(B62), (A)+(B26)+(B63), (A)+(B26)+(B64), (A)+(B26)+(B65), (A)+(B26)+(B66), (A)+(B26)+(B67), (A)+(B26)+(B68), (A)+(B26)+(B69), (A)+(B26)+(B70), (A)+(B26)+(B71), (A)+(B26)+(B72), (A)+(B26)+(B73), (A)+(B26)+(B74), (A)+(B26)+(B75), (A)+(B26)+(B76), (A)+(B26)+(B77), (A)+(B26)+(B78), (A)+(B26)+(B79), (A)+(B26)+(B80), (A)+(B26)+(B81), (A)+(B26)+(B82), (A)+(B26)+(B83), (A)+(B26)+(B84), (A)+(B26)+(B85), (A)+(B26)+(B86), (A)+(B26)+(B87), (A)+(B26)+(B88), (A)+(B26)+(B89), (A)+(B26)+(B90), (A)+(B26)+(B91), (A)+(B26)+(B92), (A)+(B26)+(B93), (A)+(B26)+(B94), (A)+(B26)+(B95), (A)+(B26)+(B96), (A)+(B26)+(B97), (A)+(B26)+(B98), (A)+(B26)+(B99), (A)+(B26)+(B100), (A)+(B26)+(B101), (A)+(B26)+(B102), (A)+(B26)+(B103), (A)+(B26)+(B104), (A)+(B26)+(B105), (A)+(B26)+(B106), (A)+(B26)+(B107), (A)+(B26)+(B108), (A)+(B26)+(B109), (A)+(B26)+(B110), (A)+(B26)+(B111), (A)+(B26)+(B112), (A)+(B26)+(B113), (A)+(B26)+(B114), (A)+(B26)+(B115), (A)+(B26)+(B116), (A)+(B26)+(B117), (A)+(B26)+(B118), (A)+(B26)+(B119), (A)+(B26)+(B120), (A)+(B26)+(B121), (A)+(B26)+(B122), (A)+(B26)+(B123), (A)+(B26)+(B124), (A)+(B26)+(B125), (A)+(B26)+(B126), (A)+(B26)+(B127), (A)+(B26)+(B128), (A)+(B26)+(B129), (A)+(B26)+(B130), (A)+(B26)+(B131), (A)+(B26)+(B132), (A)+(B26)+(B133), (A)+(B26)+(B134), (A)+(B26)+(B135), (A)+(B26)+(B136), (A)+(B26)+(B137), (A)+(B26)+(B138), (A)+(B26)+(B139), (A)+(B26)+(B140), (A)+(B26)+(B141), (A)+(B26)+(B142), (A)+(B26)+(B143), (A)+(B26)+(B144), (A)+(B26)+(B145), (A)+(B26)+(B146), (A)+(B26)+(B147), (A)+(B26)+(B148), (A)+(B26)+(B149), (A)+(B26)+(B150), (A)+(B26)+(B151), (A)+(B26)+(B152), (A)+(B26)+(B153), (A)+(B26)+(B154), (A)+(B26)+(B155), (A)+(B26)+(B156), (A)+(B26)+(B157), (A)+(B26)+(B158), (A)+(B26)+(B159), (A)+(B26)+(B160), (A)+(B26)+(B161), (A)+(B26)+(B162), (A)+(B26)+(B164), (A)+(B26)+(B164), (A)+(B26)+(B165), (A)+(B26)+(B166), (A)+(B26)+(B167), (A)+(B26)+(B168), (A)+(B26)+(B169), (A)+(B26)+(B170), (A)+(B26)+(B171), (A)+(B26)+(B172), (A)+(B26)+(B173), (A)+(B26)+(B174), (A)+(B26)+(B175), (A)+(B26)+(B176), (A)+(B26)+(B177), (A)+(B26)+(B178), (A)+(B26)+(B179), (A)+(B26)+(B180), (A)+(B26)+(B181), (A)+(B26)+(B182), (A)+(B26)+(B183), (A)+(B26)+(B184), (A)+(B26)+(B185), (A)+(B26)+(B186), (A)+(B26)+(B187), (A)+(B26)+(B188), (A)+(B26)+(B189), (A)+(B26)+(B190), (A)+(B26)+(B191), (A)+(B26)+(B192), (A)+(B26)+(B193), (A)+(B26)+(B194), (A)+(B26)+(B195), (A)+(B26)+(B196), (A)+(B26)+(B197), (A)+(B26)+(B198), (A)+(B26)+(B199), (A)+(B26)+(B200), (A)+(B26)+(B201), (A)+(B26)+(B202), (A)+(B26)+(B203), (A)+(B26)+(B204), (A)+(B26)+(B205), (A)+(B26)+(B206), (A)+(B26)+(B207), (A)+(B26)+(B208), (A)+(B26)+(B209), (A)+(B26)+(B210), (A)+(B26)+(B211), (A)+(B26)+(B212), (A)+(B26)+(B213), (A)+(B26)+(B214), (A)+(B26)+(B215), (A)+(B26)+(B216), (A)+(B26)+(B217), (A)+(B26)+(B218), (A)+(B26)+(B219), (A)+(B26)+(B220), (A)+(B26)+(B221), (A)+(B26)+(B222), (A)+(B26)+(B223), (A)+(B26)+(B224), (A)+(B26)+(B225), (A)+(B26)+(B226), (A)+(B26)+(B227), (A)+(B26)+(B228), (A)+(B26)+(B229), (A)+(B26)+(B230), (A)+(B26)+(B231), (A)+(B26)+(B232), (A)+(B26)+(B233), (A)+(B26)+(B234), (A)+(B26)+(B235), (A)+(B26)+(B236), (A)+(B26)+(B237), (A)+(B26)+(B238), (A)+(B26)+(B239), (A)+(B26)+(B240), (A)+(B26)+(B241), (A)+(B26)+(B242), (A)+(B26)+(B243), (A)+(B26)+(B244), (A)+(B26)+(B245), (A)+(B26)+(B246), (A)+(B26)+(B247), (A)+(B26)+(B248), (A)+(B26)+(B249), (A)+(B26)+(B250), (A)+(B26)+(B251), (A)+(B26)+(B252), (A)+(B26)+(B253), (A)+(B26)+(B254), (A)+(B26)+(B255), (A)+(B26)+(B256), (A)+(B26)+(B257), (A)+(B26)+(B258), (A)+(B26)+(B259), (A)+(B26)+(B260), (A)+(B26)+(B261), (A)+(B26)+(B262), (A)+(B26)+(B263), (A)+(B26)+(B264), (A)+(B26)+(B265), (A)+(B26)+(B266), (A)+(B26)+(B267), (A)+(B26)+(B268), (A)+(B26)+(B269), (A)+(B26)+(B270), (A)+(B26)+(B271), (A)+(B26)+(B272), (A)+(B26)+(B273), (A)+(B26)+(B274), (A)+(B26)+(B275), (A)+(B26)+(B276), (A)+(B26)+(B277), (A)+(B26)+(B278), (A)+(B26)+(B279), (A)+(B26)+(B280), (A)+(B26)+(B281), (A)+(B26)+(B282), (A)+(B26)+(B283), (A)+(B26)+(B284), (A)+(B26)+(B285), (A)+(B26)+(B286), (A)+(B26)+(B287), (A)+(B26)+(B288), (A)+(B26)+(B289), (A)+(B26)+(B290), (A)+(B26)+(B291), (A)+(B26)+(B292), (A)+(B26)+(B293), (A)+(B26)+(B294), (A)+(B26)+(B295), (A)+(B26)+(B296), (A)+(B26)+(B297), (A)+(B26)+(B298), (A)+(B26)+(B299), (A)+(B26)+(B300), (A)+(B26)+(B301), (A)+(B26)+(B302), (A)+(B26)+(B303), (A)+(B26)+(B304), (A)+(B26)+(B305), (A)+(B26)+(B306), (A)+(B26)+(B307), (A)+(B26)+(B308), (A)+(B26)+(B309), (A)+(B26)+(B310), (A)+(B26)+(B311), (A)+(B26)+(B312), (A)+(B26)+(B313), (A)+(B26)+(B314), (A)+(B26)+(B315),

(A)+(B27)+(B28), (A)+(B27)+(B29), (A)+(B27)+(B30), (A)+(B27)+(B31), (A)+(B27)+(B32), (A)+(B27)+(B33), (A)+(B27)+(B34), (A)+(B27)+(B35), (A)+(B27)+(B36), (A)+(B27)+(B37), (A)+(B27)+(B38), (A)+(B27)+(B39), (A)+(B27)+(B40), (A)+(B27)+(B41), (A)+(B27)+(B42), (A)+(B27)+(B43), (A)+(B27)+(B44), (A)+(B27)+(B45), (A)+(B27)+(B46), (A)+(B27)+(B47), (A)+(B27)+(B48), (A)+(B27)+(B49), (A)+(B27)+(B50), (A)+(B27)+(B51), (A)+(B27)+(B52), (A)+(B27)+(B53), (A)+(B27)+(B54), (A)+(B27)+(B55), (A)+(B27)+(B56), (A)+(B27)+(B57), (A)+(B27)+(B58), (A)+(B27)+(B59), (A)+(B27)+(B60), (A)+(B27)+(B61), (A)+(B27)+(B62), (A)+(B27)+(B63), (A)+(B27)+(B64), (A)+(B27)+(B65), (A)+(B27)+(B66), (A)+(B27)+(B67), (A)+(B27)+(B68), (A)+(B27)+(B69), (A)+(B27)+(B70), (A)+(B27)+(B71), (A)+(B27)+(B72), (A)+(B27)+(B73), (A)+(B27)+(B74), (A)+(B27)+(B75), (A)+(B27)+(B76), (A)+(B27)+(B77), (A)+(B27)+(B78), (A)+(B27)+(B79), (A)+(B27)+(B80), (A)+(B27)+(B81), (A)+(B27)+(B82), (A)+(B27)+(B83), (A)+(B27)+(B84), (A)+(B27)+(B85), (A)+(B27)+(B86), (A)+(B27)+(B87), (A)+(B27)+(B88), (A)+(B27)+(B89), (A)+(B27)+(B90), (A)+(B27)+(B91), (A)+(B27)+(B92), (A)+(B27)+(B93), (A)+(B27)+(B94), (A)+(B27)+(B95), (A)+(B27)+(B96), (A)+(B27)+(B97), (A)+(B27)+(B98), (A)+(B27)+(B99), (A)+(B27)+(B100), (A)+(B27)+(B101), (A)+(B27)+(B102), (A)+(B27)+(B103), (A)+(B27)+(B104), (A)+(B27)+(B105), (A)+(B27)+(B106), (A)+(B27)+(B107), (A)+(B27)+(B108), (A)+(B27)+(B109), (A)+(B27)+(B110), (A)+(B27)+(B111), (A)+(B27)+(B112), (A)+(B27)+(B113), (A)+(B27)+(B114), (A)+(B27)+(B115), (A)+(B27)+(B116), (A)+(B27)+(B117), (A)+(B27)+(B118), (A)+(B27)+(B119), (A)+(B27)+(B120), (A)+(B27)+(B121), (A)+(B27)+(B122), (A)+(B27)+(B123), (A)+(B27)+(B124), (A)+(B27)+(B125), (A)+(B27)+(B126), (A)+(B27)+(B127), (A)+(B27)+(B128), (A)+(B27)+(B129), (A)+(B27)+(B130), (A)+(B27)+(B131), (A)+(B27)+(B132), (A)+(B27)+(B133), (A)+(B27)+(B134), (A)+(B27)+(B135), (A)+(B27)+(B136), (A)+(B27)+(B137), (A)+(B27)+(B138), (A)+(B27)+(B139), (A)+(B27)+(B140), (A)+(B27)+(B141), (A)+(B27)+(B142), (A)+(B27)+(B143), (A)+(B27)+(B144), (A)+(B27)+(B145), (A)+(B27)+(B146), (A)+(B27)+(B147), (A)+(B27)+(B148), (A)+(B27)+(B149), (A)+(B27)+(B150), (A)+(B27)+(B151), (A)+(B27)+(B152), (A)+(B27)+(B153), (A)+(B27)+(B154), (A)+(B27)+(B155), (A)+(B27)+(B156), (A)+(B27)+(B157), (A)+(B27)+(B158), (A)+(B27)+(B159), (A)+(B27)+(B160), (A)+(B27)+(B161), (A)+(B27)+(B162), (A)+(B27)+(B164), (A)+(B27)+(B164), (A)+(B27)+(B165), (A)+(B27)+(B166), (A)+(B27)+(B167), (A)+(B27)+(B168), (A)+(B27)+(B169), (A)+(B27)+(B170), (A)+(B27)+(B171), (A)+(B27)+(B172), (A)+(B27)+(B173), (A)+(B27)+(B174), (A)+(B27)+(B175), (A)+(B27)+(B176), (A)+(B27)+(B177), (A)+(B27)+(B178), (A)+(B27)+(B179), (A)+(B27)+(B180), (A)+(B27)+(B181), (A)+(B27)+(B182), (A)+(B27)+(B183), (A)+(B27)+(B184), (A)+(B27)+(B185), (A)+(B27)+(B186), (A)+(B27)+(B187), (A)+(B27)+(B188), (A)+(B27)+(B189), (A)+(B27)+(B190), (A)+(B27)+(B191), (A)+(B27)+(B192), (A)+(B27)+(B193), (A)+(B27)+(B194), (A)+(B27)+(B195), (A)+(B27)+(B196), (A)+(B27)+(B197), (A)+(B27)+(B198), (A)+(B27)+(B199), (A)+(B27)+(B200), (A)+(B27)+(B201), (A)+(B27)+(B202), (A)+(B27)+(B203), (A)+(B27)+(B204), (A)+(B27)+(B205), (A)+(B27)+(B206), (A)+(B27)+(B207), (A)+(B27)+(B208), (A)+(B27)+(B209), (A)+(B27)+(B210), (A)+(B27)+(B211), (A)+(B27)+(B212), (A)+(B27)+(B213), (A)+(B27)+(B214), (A)+(B27)+(B215), (A)+(B27)+(B216), (A)+(B27)+(B217), (A)+(B27)+(B218), (A)+(B27)+(B219), (A)+(B27)+(B220), (A)+(B27)+(B221), (A)+(B27)+(B222), (A)+(B27)+(B223), (A)+(B27)+(B224), (A)+(B27)+(B225), (A)+(B27)+(B226), (A)+(B27)+(B227), (A)+(B27)+(B228), (A)+(B27)+(B229), (A)+(B27)+(B230), (A)+(B27)+(B231), (A)+(B27)+(B232), (A)+(B27)+(B233), (A)+(B27)+(B234), (A)+(B27)+(B235), (A)+(B27)+(B236), (A)+(B27)+(B237), (A)+(B27)+(B238), (A)+(B27)+(B239), (A)+(B27)+(B240), (A)+(B27)+(B241), (A)+(B27)+(B242), (A)+(B27)+(B243), (A)+(B27)+(B244), (A)+(B27)+(B245), (A)+(B27)+(B246), (A)+(B27)+(B247), (A)+(B27)+(B248), (A)+(B27)+(B249), (A)+(B27)+(B250), (A)+(B27)+(B251), (A)+(B27)+(B252), (A)+(B27)+(B253), (A)+(B27)+(B254), (A)+(B27)+(B255), (A)+(B27)+(B256), (A)+(B27)+(B257), (A)+(B27)+(B258), (A)+(B27)+(B259), (A)+(B27)+(B260), (A)+(B27)+(B261), (A)+(B27)+(B262), (A)+(B27)+(B263), (A)+(B27)+(B264), (A)+(B27)+(B265), (A)+(B27)+(B266), (A)+(B27)+(B267), (A)+(B27)+(B268), (A)+(B27)+(B269), (A)+(B27)+(B270), (A)+(B27)+(B271), (A)+(B27)+(B272), (A)+(B27)+(B273), (A)+(B27)+(B274), (A)+(B27)+(B275), (A)+(B27)+(B276), (A)+(B27)+(B277), (A)+(B27)+(B278), (A)+(B27)+(B279), (A)+(B27)+(B280), (A)+(B27)+(B281), (A)+(B27)+(B282), (A)+(B27)+(B283), (A)+(B27)+(B284), (A)+(B27)+(B285), (A)+(B27)+(B286), (A)+(B27)+(B287), (A)+(B27)+(B288), (A)+(B27)+(B289), (A)+(B27)+(B290), (A)+(B27)+(B291), (A)+(B27)+(B292), (A)+(B27)+(B293), (A)+(B27)+(B294), (A)+(B27)+(B295), (A)+(B27)+(B296), (A)+(B27)+(B297), (A)+(B27)+(B298), (A)+(B27)+(B299), (A)+(B27)+(B300), (A)+(B27)+(B301), (A)+(B27)+(B302), (A)+(B27)+(B303), (A)+(B27)+(B304), (A)+(B27)+(B305), (A)+(B27)+(B306), (A)+(B27)+(B307), (A)+(B27)+(B308), (A)+(B27)+(B309), (A)+(B27)+(B310), (A)+(B27)+(B311), (A)+(B27)+(B312), (A)+(B27)+(B313), (A)+(B27)+(B314), (A)+(B27)+(B315),

(A)+(B28)+(B29), (A)+(B28)+(B30), (A)+(B28)+(B31), (A)+(B28)+(B32), (A)+(B28)+(B33), (A)+(B28)+(B34), (A)+(B28)+(B35), (A)+(B28)+(B36), (A)+(B28)+(B37), (A)+(B28)+(B38), (A)+(B28)+(B39), (A)+(B28)+(B40), (A)+(B28)+(B41), (A)+(B28)+(B42), (A)+(B28)+(B43), (A)+(B28)+(B44), (A)+(B28)+(B45), (A)+(B28)+(B46), (A)+(B28)+(B47), (A)+(B28)+(B48), (A)+(B28)+(B49), (A)+(B28)+(B50), (A)+(B28)+(B51), (A)+(B28)+(B52), (A)+(B28)+(B53), (A)+(B28)+(B54), (A)+(B28)+(B55), (A)+(B28)+(B56), (A)+(B28)+(B57), (A)+(B28)+(B58), (A)+(B28)+(B59), (A)+(B28)+(B60), (A)+(B28)+(B61), (A)+(B28)+(B62), (A)+(B28)+(B63), (A)+(B28)+(B64), (A)+(B28)+(B65), (A)+(B28)+(B66), (A)+(B28)+(B67), (A)+(B28)+(B68), (A)+(B28)+(B69), (A)+(B28)+(B70), (A)+(B28)+(B71), (A)+(B28)+(B72), (A)+(B28)+(B73), (A)+(B28)+(B74), (A)+(B28)+(B75), (A)+(B28)+(B76), (A)+(B28)+(B77), (A)+(B28)+(B78), (A)+(B28)+(B79), (A)+(B28)+(B80), (A)+(B28)+(B81), (A)+(B28)+(B82), (A)+(B28)+(B83), (A)+(B28)+(B84), (A)+(B28)+(B85), (A)+(B28)+(B86), (A)+(B28)+(B87), (A)+(B28)+(B88), (A)+(B28)+(B89), (A)+(B28)+(B90), (A)+(B28)+(B91), (A)+(B28)+(B92), (A)+(B28)+(B93), (A)+(B28)+(B94), (A)+(B28)+(B95), (A)+(B28)+(B96), (A)+(B28)+(B97), (A)+(B28)+(B98), (A)+(B28)+(B99), (A)+(B28)+(B100), (A)+(B28)+(B101), (A)+(B28)+(B102), (A)+(B28)+(B103), (A)+(B28)+(B104), (A)+(B28)+(B105), (A)+(B28)+(B106), (A)+(B28)+(B107), (A)+(B28)+(B108), (A)+(B28)+(B109), (A)+(B28)+(B110), (A)+(B28)+(B111), (A)+(B28)+(B112), (A)+(B28)+(B113), (A)+(B28)+(B114), (A)+(B28)+(B115), (A)+(B28)+(B116), (A)+(B28)+(B117), (A)+(B28)+(B118), (A)+(B28)+(B119), (A)+(B28)+(B120), (A)+(B28)+(B121), (A)+(B28)+(B122), (A)+(B28)+(B123), (A)+(B28)+(B124), (A)+(B28)+(B125), (A)+(B28)+(B126), (A)+(B28)+(B127), (A)+(B28)+(B128), (A)+(B28)+(B129), (A)+(B28)+(B130), (A)+(B28)+(B131), (A)+(B28)+(B132), (A)+(B28)+(B133), (A)+(B28)+(B134), (A)+(B28)+(B135), (A)+(B28)+(B136), (A)+(B28)+(B137), (A)+(B28)+(B138), (A)+(B28)+(B139), (A)+(B28)+(B140), (A)+(B28)+(B141), (A)+(B28)+(B142), (A)+(B28)+(B143), (A)+(B28)+(B144), (A)+(B28)+(B145), (A)+(B28)+(B146), (A)+(B28)+(B147), (A)+(B28)+(B148), (A)+(B28)+(B149), (A)+(B28)+(B150), (A)+(B28)+(B151), (A)+(B28)+(B152), (A)+(B28)+(B153), (A)+(B28)+(B154), (A)+(B28)+(B155), (A)+(B28)+(B156), (A)+(B28)+(B157), (A)+(B28)+(B158), (A)+(B28)+(B159), (A)+(B28)+(B160), (A)+(B28)+(B161), (A)+(B28)+(B162), (A)+(B28)+(B164), (A)+(B28)+(B164), (A)+(B28)+(B165), (A)+(B28)+(B166), (A)+(B28)+(B167), (A)+(B28)+(B168), (A)+(B28)+(B169), (A)+(B28)+(B170), (A)+(B28)+(B171), (A)+(B28)+(B172), (A)+(B28)+(B173), (A)+(B28)+(B174), (A)+(B28)+(B175), (A)+(B28)+(B176), (A)+(B28)+(B177), (A)+(B28)+(B178), (A)+(B28)+(B179), (A)+(B28)+(B180), (A)+(B28)+(B181), (A)+(B28)+(B182), (A)+(B28)+(B183), (A)+(B28)+(B184), (A)+(B28)+(B185), (A)+(B28)+(B186), (A)+(B28)+(B187), (A)+(B28)+(B188), (A)+(B28)+(B189), (A)+(B28)+(B190), (A)+(B28)+(B191), (A)+(B28)+(B192), (A)+(B28)+(B193), (A)+(B28)+(B194), (A)+(B28)+(B195), (A)+(B28)+(B196), (A)+(B28)+(B197), (A)+(B28)+(B198), (A)+(B28)+(B199), (A)+(B28)+(B200), (A)+(B28)+(B201), (A)+(B28)+(B202), (A)+(B28)+(B203), (A)+(B28)+(B204), (A)+(B28)+(B205), (A)+(B28)+(B206), (A)+(B28)+(B207), (A)+(B28)+(B208), (A)+(B28)+(B209), (A)+(B28)+(B210), (A)+(B28)+(B211), (A)+(B28)+(B212), (A)+(B28)+(B213), (A)+(B28)+(B214), (A)+(B28)+(B215), (A)+(B28)+(B216), (A)+(B28)+(B217), (A)+(B28)+(B218), (A)+(B28)+(B219), (A)+(B28)+(B220), (A)+(B28)+(B221), (A)+(B28)+(B222), (A)+(B28)+(B223), (A)+(B28)+(B224), (A)+(B28)+(B225), (A)+(B28)+(B226), (A)+(B28)+(B227), (A)+(B28)+(B228), (A)+(B28)+(B229), (A)+(B28)+(B230), (A)+(B28)+(B231), (A)+(B28)+(B232), (A)+(B28)+(B233), (A)+(B28)+(B234), (A)+(B28)+(B235), (A)+(B28)+(B236), (A)+(B28)+(B237), (A)+(B28)+(B238), (A)+(B28)+(B239), (A)+(B28)+(B240), (A)+(B28)+(B241), (A)+(B28)+(B242), (A)+(B28)+(B243), (A)+(B28)+(B244), (A)+(B28)+(B245), (A)+(B28)+(B246), (A)+(B28)+(B247), (A)+(B28)+(B248), (A)+(B28)+(B249), (A)+(B28)+(B250), (A)+(B28)+(B251), (A)+(B28)+(B252), (A)+(B28)+(B253), (A)+(B28)+(B254), (A)+(B28)+(B255), (A)+(B28)+(B256), (A)+(B28)+(B257), (A)+(B28)+(B258), (A)+(B28)+(B259), (A)+(B28)+(B260), (A)+(B28)+(B261), (A)+(B28)+(B262), (A)+(B28)+(B263), (A)+(B28)+(B264), (A)+(B28)+(B265), (A)+(B28)+(B266), (A)+(B28)+(B267), (A)+(B28)+(B268), (A)+(B28)+(B269), (A)+(B28)+(B270), (A)+(B28)+(B271), (A)+(B28)+(B272), (A)+(B28)+(B273), (A)+(B28)+(B274), (A)+(B28)+(B275), (A)+(B28)+(B276), (A)+(B28)+(B277), (A)+(B28)+(B278), (A)+(B28)+(B279), (A)+(B28)+(B280), (A)+(B28)+(B281), (A)+(B28)+(B282), (A)+(B28)+(B283), (A)+(B28)+(B284), (A)+(B28)+(B285), (A)+(B28)+(B286), (A)+(B28)+(B287), (A)+(B28)+(B288), (A)+(B28)+(B289), (A)+(B28)+(B290), (A)+(B28)+(B291), (A)+(B28)+(B292), (A)+(B28)+(B293), (A)+(B28)+(B294), (A)+(B28)+(B295), (A)+(B28)+(B296), (A)+(B28)+(B297), (A)+(B28)+(B298), (A)+(B28)+(B299), (A)+(B28)+(B300), (A)+(B28)+(B301), (A)+(B28)+(B302), (A)+(B28)+(B303), (A)+(B28)+(B304), (A)+(B28)+(B305), (A)+(B28)+(B306), (A)+(B28)+(B307), (A)+(B28)+(B308), (A)+(B28)+(B309), (A)+(B28)+(B310), (A)+(B28)+(B311), (A)+(B28)+(B312), (A)+(B28)+(B313), (A)+(B28)+(B314), (A)+(B28)+(B315),

(A)+(B29)+(B30), (A)+(B29)+(B31), (A)+(B29)+(B32), (A)+(B29)+(B33), (A)+(B29)+(B34), (A)+(B29)+(B35), (A)+(B29)+(B36), (A)+(B29)+(B37), (A)+(B29)+(B38), (A)+(B29)+(B39), (A)+(B29)+(B40), (A)+(B29)+(B41), (A)+(B29)+(B42), (A)+(B29)+(B43), (A)+(B29)+(B44), (A)+(B29)+(B45), (A)+(B29)+(B46), (A)+(B29)+(B47), (A)+(B29)+(B48), (A)+(B29)+(B49), (A)+(B29)+(B50), (A)+(B29)+(B51), (A)+(B29)+(B52), (A)+(B29)+(B53), (A)+(B29)+(B54), (A)+(B29)+(B55), (A)+(B29)+(B56), (A)+(B29)+(B57), (A)+(B29)+(B58), (A)+(B29)+(B59), (A)+(B29)+(B60), (A)+(B29)+(B61), (A)+(B29)+(B62), (A)+(B29)+(B63), (A)+(B29)+(B64), (A)+(B29)+(B65), (A)+(B29)+(B66), (A)+(B29)+(B67), (A)+(B29)+(B68), (A)+(B29)+(B69), (A)+(B29)+(B70), (A)+(B29)+(B71), (A)+(B29)+(B72), (A)+(B29)+(B73), (A)+(B29)+(B74), (A)+(B29)+(B75), (A)+(B29)+(B76), (A)+(B29)+(B77), (A)+(B29)+(B78), (A)+(B29)+(B79), (A)+(B29)+(B80), (A)+(B29)+(B81), (A)+(B29)+(B82), (A)+(B29)+(B83), (A)+(B29)+(B84), (A)+(B29)+(B85), (A)+(B29)+(B86), (A)+(B29)+(B87), (A)+(B29)+(B88), (A)+(B29)+(B89), (A)+(B29)+(B90), (A)+(B29)+(B91), (A)+(B29)+(B92), (A)+(B29)+(B93), (A)+(B29)+(B94), (A)+(B29)+(B95), (A)+(B29)+(B96), (A)+(B29)+(B97), (A)+(B29)+(B98), (A)+(B29)+(B99), (A)+(B29)+(B100), (A)+(B29)+(B101), (A)+(B29)+(B102), (A)+(B29)+(B103), (A)+(B29)+(B104), (A)+(B29)+(B105), (A)+(B29)+(B106), (A)+(B29)+(B107), (A)+(B29)+(B108), (A)+(B29)+(B109), (A)+(B29)+(B110), (A)+(B29)+(B111), (A)+(B29)+(B112), (A)+(B29)+(B113), (A)+(B29)+(B114), (A)+(B29)+(B115), (A)+(B29)+(B116), (A)+(B29)+(B117), (A)+(B29)+(B118), (A)+(B29)+(B119), (A)+(B29)+(B120), (A)+(B29)+(B121), (A)+(B29)+(B122), (A)+(B29)+(B123), (A)+(B29)+(B124), (A)+(B29)+(B125), (A)+(B29)+(B126), (A)+(B29)+(B127), (A)+(B29)+(B128), (A)+(B29)+(B129), (A)+(B29)+(B130), (A)+(B29)+(B131), (A)+(B29)+(B132), (A)+(B29)+(B133), (A)+(B29)+(B134), (A)+(B29)+(B135), (A)+(B29)+(B136), (A)+(B29)+(B137), (A)+(B29)+(B138), (A)+(B29)+(B139), (A)+(B29)+(B140), (A)+(B29)+(B141), (A)+(B29)+(B142), (A)+(B29)+(B143), (A)+(B29)+(B144), (A)+(B29)+(B145), (A)+(B29)+(B146), (A)+(B29)+(B147), (A)+(B29)+(B148), (A)+(B29)+(B149), (A)+(B29)+(B150), (A)+(B29)+(B151), (A)+(B29)+(B152), (A)+(B29)+(B153), (A)+(B29)+(B154), (A)+(B29)+(B155), (A)+(B29)+(B156), (A)+(B29)+(B157), (A)+(B29)+(B158), (A)+(B29)+(B159), (A)+(B29)+(B160), (A)+(B29)+(B161), (A)+(B29)+(B162), (A)+(B29)+(B164), (A)+(B29)+(B164), (A)+(B29)+(B165), (A)+(B29)+(B166), (A)+(B29)+(B167), (A)+(B29)+(B168), (A)+(B29)+(B169), (A)+(B29)+(B170), (A)+(B29)+(B171), (A)+(B29)+(B172), (A)+(B29)+(B173), (A)+(B29)+(B174), (A)+(B29)+(B175), (A)+(B29)+(B176), (A)+(B29)+(B177), (A)+(B29)+(B178), (A)+(B29)+(B179), (A)+(B29)+(B180), (A)+(B29)+(B181), (A)+(B29)+(B182), (A)+(B29)+(B183), (A)+(B29)+(B184), (A)+(B29)+(B185), (A)+(B29)+(B186), (A)+(B29)+(B187), (A)+(B29)+(B188), (A)+(B29)+(B189), (A)+(B29)+(B190), (A)+(B29)+(B191), (A)+(B29)+(B192), (A)+(B29)+(B193), (A)+(B29)+(B194), (A)+(B29)+(B195), (A)+(B29)+(B196), (A)+(B29)+(B197), (A)+(B29)+(B198), (A)+(B29)+(B199), (A)+(B29)+(B200), (A)+(B29)+(B201), (A)+(B29)+(B202), (A)+(B29)+(B203), (A)+(B29)+(B204), (A)+(B29)+(B205), (A)+(B29)+(B206), (A)+(B29)+(B207), (A)+(B29)+(B208), (A)+(B29)+(B209), (A)+(B29)+(B210), (A)+(B29)+(B211), (A)+(B29)+(B212), (A)+(B29)+(B213), (A)+(B29)+(B214), (A)+(B29)+(B215), (A)+(B29)+(B216), (A)+(B29)+(B217), (A)+(B29)+(B218), (A)+(B29)+(B219), (A)+(B29)+(B220), (A)+(B29)+(B221), (A)+(B29)+(B222), (A)+(B29)+(B223), (A)+(B29)+(B224), (A)+(B29)+(B225), (A)+(B29)+(B226), (A)+(B29)+(B227), (A)+(B29)+(B228), (A)+(B29)+(B229), (A)+(B29)+(B230), (A)+(B29)+(B231), (A)+(B29)+(B232), (A)+(B29)+(B233), (A)+(B29)+(B234), (A)+(B29)+(B235), (A)+(B29)+(B236), (A)+(B29)+(B237), (A)+(B29)+(B238), (A)+(B29)+(B239), (A)+(B29)+(B240), (A)+(B29)+(B241), (A)+(B29)+(B242), (A)+(B29)+(B243), (A)+(B29)+(B244), (A)+(B29)+(B245), (A)+(B29)+(B246), (A)+(B29)+(B247), (A)+(B29)+(B248), (A)+(B29)+(B249), (A)+(B29)+(B250), (A)+(B29)+(B251), (A)+(B29)+(B252), (A)+(B29)+(B253), (A)+(B29)+(B254), (A)+(B29)+(B255), (A)+(B29)+(B256), (A)+(B29)+(B257), (A)+(B29)+(B258), (A)+(B29)+(B259), (A)+(B29)+(B260), (A)+(B29)+(B261), (A)+(B29)+(B262), (A)+(B29)+(B263), (A)+(B29)+(B264), (A)+(B29)+(B265), (A)+(B29)+(B266), (A)+(B29)+(B267), (A)+(B29)+(B268), (A)+(B29)+(B269), (A)+(B29)+(B270), (A)+(B29)+(B271), (A)+(B29)+(B272), (A)+(B29)+(B273), (A)+(B29)+(B274), (A)+(B29)+(B275), (A)+(B29)+(B276), (A)+(B29)+(B277), (A)+(B29)+(B278), (A)+(B29)+(B279), (A)+(B29)+(B280), (A)+(B29)+(B281), (A)+(B29)+(B282), (A)+(B29)+(B283), (A)+(B29)+(B284), (A)+(B29)+(B285), (A)+(B29)+(B286), (A)+(B29)+(B287), (A)+(B29)+(B288), (A)+(B29)+(B289), (A)+(B29)+(B290), (A)+(B29)+(B291), (A)+(B29)+(B292), (A)+(B29)+(B293), (A)+(B29)+(B294), (A)+(B29)+(B295), (A)+(B29)+(B296), (A)+(B29)+(B297), (A)+(B29)+(B298), (A)+(B29)+(B299), (A)+(B29)+(B300), (A)+(B29)+(B301), (A)+(B29)+(B302), (A)+(B29)+(B303), (A)+(B29)+(B304), (A)+(B29)+(B305), (A)+(B29)+(B306), (A)+(B29)+(B307), (A)+(B29)+(B308), (A)+(B29)+(B309), (A)+(B29)+(B310), (A)+(B29)+(B311), (A)+(B29)+(B312), (A)+(B29)+(B313), (A)+(B29)+(B314), (A)+(B29)+(B315),

(A)+(B30)+(B31), (A)+(B30)+(B32), (A)+(B30)+(B33), (A)+(B30)+(B34), (A)+(B30)+(B35), (A)+(B30)+(B36), (A)+(B30)+(B37), (A)+(B30)+(B38), (A)+(B30)+(B39), (A)+(B30)+(B40), (A)+(B30)+(B41), (A)+(B30)+(B42), (A)+(B30)+(B43), (A)+(B30)+(B44), (A)+(B30)+(B45), (A)+(B30)+(B46), (A)+(B30)+(B47), (A)+(B30)+(B48), (A)+(B30)+(B49), (A)+(B30)+(B50), (A)+(B30)+(B51), (A)+(B30)+(B52), (A)+(B30)+(B53), (A)+(B30)+(B54), (A)+(B30)+(B55), (A)+(B30)+(B56), (A)+(B30)+(B57), (A)+(B30)+(B58), (A)+(B30)+(B59), (A)+(B30)+(B60), (A)+(B30)+(B61), (A)+(B30)+(B62), (A)+(B30)+(B63), (A)+(B30)+(B64), (A)+(B30)+(B65), (A)+(B30)+(B66), (A)+(B30)+(B67), (A)+(B30)+(B68), (A)+(B30)+(B69), (A)+(B30)+(B70), (A)+(B30)+(B71), (A)+(B30)+(B72), (A)+(B30)+(B73), (A)+(B30)+(B74), (A)+(B30)+(B75), (A)+(B30)+(B76), (A)+(B30)+(B77), (A)+(B30)+(B78), (A)+(B30)+(B79), (A)+(B30)+(B80), (A)+(B30)+(B81), (A)+(B30)+(B82), (A)+(B30)+(B83), (A)+(B30)+(B84), (A)+(B30)+(B85), (A)+(B30)+(B86), (A)+(B30)+(B87), (A)+(B30)+(B88), (A)+(B30)+(B89), (A)+(B30)+(B90), (A)+(B30)+(B91), (A)+(B30)+(B92), (A)+(B30)+(B93), (A)+(B30)+(B94), (A)+(B30)+(B95), (A)+(B30)+(B96), (A)+(B30)+(B97), (A)+(B30)+(B98), (A)+(B30)+(B99), (A)+(B30)+(B100), (A)+(B30)+(B101), (A)+(B30)+(B102), (A)+(B30)+(B103), (A)+(B30)+(B104), (A)+(B30)+(B105), (A)+(B30)+(B106), (A)+(B30)+(B107), (A)+(B30)+(B108), (A)+(B30)+(B109), (A)+(B30)+(B110), (A)+(B30)+(B111), (A)+(B30)+(B112), (A)+(B30)+(B113), (A)+(B30)+(B114), (A)+(B30)+(B115), (A)+(B30)+(B116), (A)+(B30)+(B117), (A)+(B30)+(B118), (A)+(B30)+(B119), (A)+(B30)+(B120), (A)+(B30)+(B121), (A)+(B30)+(B122), (A)+(B30)+(B123), (A)+(B30)+(B124), (A)+(B30)+(B125), (A)+(B30)+(B126), (A)+(B30)+(B127), (A)+(B30)+(B128), (A)+(B30)+(B129), (A)+(B30)+(B130), (A)+(B30)+(B131), (A)+(B30)+(B132), (A)+(B30)+(B133), (A)+(B30)+(B134), (A)+(B30)+(B135), (A)+(B30)+(B136), (A)+(B30)+(B137), (A)+(B30)+(B138), (A)+(B30)+(B139), (A)+(B30)+(B140), (A)+(B30)+(B141), (A)+(B30)+(B142), (A)+(B30)+(B143), (A)+(B30)+(B144), (A)+(B30)+(B145), (A)+(B30)+(B146), (A)+(B30)+(B147), (A)+(B30)+(B148), (A)+(B30)+(B149), (A)+(B30)+(B150), (A)+(B30)+(B151), (A)+(B30)+(B152), (A)+(B30)+(B153), (A)+(B30)+(B154), (A)+(B30)+(B155), (A)+(B30)+(B156), (A)+(B30)+(B157), (A)+(B30)+(B158), (A)+(B30)+(B159), (A)+(B30)+(B160), (A)+(B30)+(B161), (A)+(B30)+(B162), (A)+(B30)+(B164), (A)+(B30)+(B164), (A)+(B30)+(B165), (A)+(B30)+(B166), (A)+(B30)+(B167), (A)+(B30)+(B168), (A)+(B30)+(B169), (A)+(B30)+(B170), (A)+(B30)+(B171), (A)+(B30)+(B172), (A)+(B30)+(B173), (A)+(B30)+(B174), (A)+(B30)+(B175), (A)+(B30)+(B176), (A)+(B30)+(B177), (A)+(B30)+(B178), (A)+(B30)+(B179), (A)+(B30)+(B180), (A)+(B30)+(B181), (A)+(B30)+(B182), (A)+(B30)+(B183), (A)+(B30)+(B184), (A)+(B30)+(B185), (A)+(B30)+(B186), (A)+(B30)+(B187), (A)+(B30)+(B188), (A)+(B30)+(B189), (A)+(B30)+(B190), (A)+(B30)+(B191), (A)+(B30)+(B192), (A)+(B30)+(B193), (A)+(B30)+(B194), (A)+(B30)+(B195), (A)+(B30)+(B196), (A)+(B30)+(B197), (A)+(B30)+(B198), (A)+(B30)+(B199), (A)+(B30)+(B200), (A)+(B30)+(B201), (A)+(B30)+(B202), (A)+(B30)+(B203), (A)+(B30)+(B204), (A)+(B30)+(B205), (A)+(B30)+(B206), (A)+(B30)+(B207), (A)+(B30)+(B208), (A)+(B30)+(B209), (A)+(B30)+(B210), (A)+(B30)+(B211), (A)+(B30)+(B212), (A)+(B30)+(B213), (A)+(B30)+(B214), (A)+(B30)+(B215), (A)+(B30)+(B216), (A)+(B30)+(B217), (A)+(B30)+(B218), (A)+(B30)+(B219), (A)+(B30)+(B220), (A)+(B30)+(B221), (A)+(B30)+(B222), (A)+(B30)+(B223), (A)+(B30)+(B224), (A)+(B30)+(B225), (A)+(B30)+(B226), (A)+(B30)+(B227), (A)+(B30)+(B228), (A)+(B30)+(B229), (A)+(B30)+(B230), (A)+(B30)+(B231), (A)+(B30)+(B232), (A)+(B30)+(B233), (A)+(B30)+(B234), (A)+(B30)+(B235), (A)+(B30)+(B236), (A)+(B30)+(B237), (A)+(B30)+(B238), (A)+(B30)+(B239), (A)+(B30)+(B240), (A)+(B30)+(B241), (A)+(B30)+(B242), (A)+(B30)+(B243), (A)+(B30)+(B244), (A)+(B30)+(B245), (A)+(B30)+(B246), (A)+(B30)+(B247), (A)+(B30)+(B248), (A)+(B30)+(B249), (A)+(B30)+(B250), (A)+(B30)+(B251), (A)+(B30)+(B252), (A)+(B30)+(B253), (A)+(B30)+(B254), (A)+(B30)+(B255), (A)+(B30)+(B256), (A)+(B30)+(B257), (A)+(B30)+(B258), (A)+(B30)+(B259), (A)+(B30)+(B260), (A)+(B30)+(B261), (A)+(B30)+(B262), (A)+(B30)+(B263), (A)+(B30)+(B264), (A)+(B30)+(B265), (A)+(B30)+(B266), (A)+(B30)+(B267), (A)+(B30)+(B268), (A)+(B30)+(B269), (A)+(B30)+(B270), (A)+(B30)+(B271), (A)+(B30)+(B272), (A)+(B30)+(B273), (A)+(B30)+(B274), (A)+(B30)+(B275), (A)+(B30)+(B276), (A)+(B30)+(B277), (A)+(B30)+(B278), (A)+(B30)+(B279), (A)+(B30)+(B280), (A)+(B30)+(B281), (A)+(B30)+(B282), (A)+(B30)+(B283), (A)+(B30)+(B284), (A)+(B30)+(B285), (A)+(B30)+(B286), (A)+(B30)+(B287), (A)+(B30)+(B288), (A)+(B30)+(B289), (A)+(B30)+(B290), (A)+(B30)+(B291), (A)+(B30)+(B292), (A)+(B30)+(B293), (A)+(B30)+(B294), (A)+(B30)+(B295), (A)+(B30)+(B296), (A)+(B30)+(B297), (A)+(B30)+(B298), (A)+(B30)+(B299), (A)+(B30)+(B300), (A)+(B30)+(B301), (A)+(B30)+(B302), (A)+(B30)+(B303), (A)+(B30)+(B304), (A)+(B30)+(B305), (A)+(B30)+(B306), (A)+(B30)+(B307), (A)+(B30)+(B308), (A)+(B30)+(B309), (A)+(B30)+(B310), (A)+(B30)+(B311), (A)+(B30)+(B312), (A)+(B30)+(B313), (A)+(B30)+(B314), (A)+(B30)+(B315),

(A)+(B31)+(B32), (A)+(B31)+(B33), (A)+(B31)+(B34), (A)+(B31)+(B35), (A)+(B31)+(B36), (A)+(B31)+(B37), (A)+(B31)+(B38), (A)+(B31)+(B39), (A)+(B31)+(B40), (A)+(B31)+(B41), (A)+(B31)+(B42), (A)+(B31)+(B43), (A)+(B31)+(B44), (A)+(B31)+(B45), (A)+(B31)+(B46), (A)+(B31)+(B47), (A)+(B31)+(B48), (A)+(B31)+(B49), (A)+(B31)+(B50), (A)+(B31)+(B51), (A)+(B31)+(B52), (A)+(B31)+(B53), (A)+(B31)+(B54), (A)+(B31)+(B55), (A)+(B31)+(B56), (A)+(B31)+(B57), (A)+(B31)+(B58), (A)+(B31)+(B59), (A)+(B31)+(B60), (A)+(B31)+(B61), (A)+(B31)+(B62), (A)+(B31)+(B63), (A)+(B31)+(B64), (A)+(B31)+(B65), (A)+(B31)+(B66), (A)+(B31)+(B67), (A)+(B31)+(B68), (A)+(B31)+(B69), (A)+(B31)+(B70), (A)+(B31)+(B71), (A)+(B31)+(B72), (A)+(B31)+(B73), (A)+(B31)+(B74), (A)+(B31)+(B75), (A)+(B31)+(B76), (A)+(B31)+(B77), (A)+(B31)+(B78), (A)+(B31)+(B79), (A)+(B31)+(B80), (A)+(B31)+(B81), (A)+(B31)+(B82), (A)+(B31)+(B83), (A)+(B31)+(B84), (A)+(B31)+(B85), (A)+(B31)+(B86), (A)+(B31)+(B87), (A)+(B31)+(B88), (A)+(B31)+(B89), (A)+(B31)+(B90), (A)+(B31)+(B91), (A)+(B31)+(B92), (A)+(B31)+(B93), (A)+(B31)+(B94), (A)+(B31)+(B95), (A)+(B31)+(B96), (A)+(B31)+(B97), (A)+(B31)+(B98), (A)+(B31)+(B99), (A)+(B31)+(B100), (A)+(B31)+(B101), (A)+(B31)+(B102), (A)+(B31)+(B103), (A)+(B31)+(B104), (A)+(B31)+(B105), (A)+(B31)+(B106), (A)+(B31)+(B107), (A)+(B31)+(B108), (A)+(B31)+(B109), (A)+(B31)+(B110), (A)+(B31)+(B111), (A)+(B31)+(B112), (A)+(B31)+(B113), (A)+(B31)+(B114), (A)+(B31)+(B115), (A)+(B31)+(B116), (A)+(B31)+(B117), (A)+(B31)+(B118), (A)+(B31)+(B119), (A)+(B31)+(B120), (A)+(B31)+(B121), (A)+(B31)+(B122), (A)+(B31)+(B123), (A)+(B31)+(B124), (A)+(B31)+(B125), (A)+(B31)+(B126), (A)+(B31)+(B127), (A)+(B31)+(B128), (A)+(B31)+(B129), (A)+(B31)+(B130), (A)+(B31)+(B131), (A)+(B31)+(B132), (A)+(B31)+(B133), (A)+(B31)+(B134), (A)+(B31)+(B135), (A)+(B31)+(B136), (A)+(B31)+(B137), (A)+(B31)+(B138), (A)+(B31)+(B139), (A)+(B31)+(B140), (A)+(B31)+(B141), (A)+(B31)+(B142), (A)+(B31)+(B143), (A)+(B31)+(B144), (A)+(B31)+(B145), (A)+(B31)+(B146), (A)+(B31)+(B147), (A)+(B31)+(B148), (A)+(B31)+(B149), (A)+(B31)+(B150), (A)+(B31)+(B151), (A)+(B31)+(B152), (A)+(B31)+(B153), (A)+(B31)+(B154), (A)+(B31)+(B155), (A)+(B31)+(B156), (A)+(B31)+(B157), (A)+(B31)+(B158), (A)+(B31)+(B159), (A)+(B31)+(B160), (A)+(B31)+(B161), (A)+(B31)+(B162), (A)+(B31)+(B164), (A)+(B31)+(B164), (A)+(B31)+(B165), (A)+(B31)+(B166), (A)+(B31)+(B167), (A)+(B31)+(B168), (A)+(B31)+(B169), (A)+(B31)+(B170), (A)+(B31)+(B171), (A)+(B31)+(B172), (A)+(B31)+(B173), (A)+(B31)+(B174), (A)+(B31)+(B175), (A)+(B31)+(B176), (A)+(B31)+(B177), (A)+(B31)+(B178), (A)+(B31)+(B179), (A)+(B31)+(B180), (A)+(B31)+(B181), (A)+(B31)+(B182), (A)+(B31)+(B183), (A)+(B31)+(B184), (A)+(B31)+(B185), (A)+(B31)+(B186), (A)+(B31)+(B187), (A)+(B31)+(B188), (A)+(B31)+(B189), (A)+(B31)+(B190), (A)+(B31)+(B191), (A)+(B31)+(B192), (A)+(B31)+(B193), (A)+(B31)+(B194), (A)+(B31)+(B195), (A)+(B31)+(B196), (A)+(B31)+(B197), (A)+(B31)+(B198), (A)+(B31)+(B199), (A)+(B31)+(B200), (A)+(B31)+(B201), (A)+(B31)+(B202), (A)+(B31)+(B203), (A)+(B31)+(B204), (A)+(B31)+(B205), (A)+(B31)+(B206), (A)+(B31)+(B207), (A)+(B31)+(B208), (A)+(B31)+(B209), (A)+(B31)+(B210), (A)+(B31)+(B211), (A)+(B31)+(B212), (A)+(B31)+(B213), (A)+(B31)+(B214), (A)+(B31)+(B215), (A)+(B31)+(B216), (A)+(B31)+(B217), (A)+(B31)+(B218), (A)+(B31)+(B219), (A)+(B31)+(B220), (A)+(B31)+(B221), (A)+(B31)+(B222), (A)+(B31)+(B223), (A)+(B31)+(B224), (A)+(B31)+(B225), (A)+(B31)+(B226), (A)+(B31)+(B227), (A)+(B31)+(B228), (A)+(B31)+(B229), (A)+(B31)+(B230), (A)+(B31)+(B231), (A)+(B31)+(B232), (A)+(B31)+(B233), (A)+(B31)+(B234), (A)+(B31)+(B235), (A)+(B31)+(B236), (A)+(B31)+(B237), (A)+(B31)+(B238), (A)+(B31)+(B239), (A)+(B31)+(B240), (A)+(B31)+(B241), (A)+(B31)+(B242), (A)+(B31)+(B243), (A)+(B31)+(B244), (A)+(B31)+(B245), (A)+(B31)+(B246), (A)+(B31)+(B247), (A)+(B31)+(B248), (A)+(B31)+(B249), (A)+(B31)+(B250), (A)+(B31)+(B251), (A)+(B31)+(B252), (A)+(B31)+(B253), (A)+(B31)+(B254), (A)+(B31)+(B255), (A)+(B31)+(B256), (A)+(B31)+(B257), (A)+(B31)+(B258), (A)+(B31)+(B259), (A)+(B31)+(B260), (A)+(B31)+(B261), (A)+(B31)+(B262), (A)+(B31)+(B263), (A)+(B31)+(B264), (A)+(B31)+(B265), (A)+(B31)+(B266), (A)+(B31)+(B267), (A)+(B31)+(B268), (A)+(B31)+(B269), (A)+(B31)+(B270), (A)+(B31)+(B271), (A)+(B31)+(B272), (A)+(B31)+(B273), (A)+(B31)+(B274), (A)+(B31)+(B275), (A)+(B31)+(B276), (A)+(B31)+(B277), (A)+(B31)+(B278), (A)+(B31)+(B279), (A)+(B31)+(B280), (A)+(B31)+(B281), (A)+(B31)+(B282), (A)+(B31)+(B283), (A)+(B31)+(B284), (A)+(B31)+(B285), (A)+(B31)+(B286), (A)+(B31)+(B287), (A)+(B31)+(B288), (A)+(B31)+(B289), (A)+(B31)+(B290), (A)+(B31)+(B291), (A)+(B31)+(B292), (A)+(B31)+(B293), (A)+(B31)+(B294), (A)+(B31)+(B295), (A)+(B31)+(B296), (A)+(B31)+(B297), (A)+(B31)+(B298), (A)+(B31)+(B299), (A)+(B31)+(B300), (A)+(B31)+(B301), (A)+(B31)+(B302), (A)+(B31)+(B303), (A)+(B31)+(B304), (A)+(B31)+(B305), (A)+(B31)+(B306), (A)+(B31)+(B307), (A)+(B31)+(B308), (A)+(B31)+(B309), (A)+(B31)+(B310), (A)+(B31)+(B311), (A)+(B31)+(B312), (A)+(B31)+(B313), (A)+(B31)+(B314), (A)+(B31)+(B315),

(A)+(B32)+(B33), (A)+(B32)+(B34), (A)+(B32)+(B35), (A)+(B32)+(B36), (A)+(B32)+(B37), (A)+(B32)+(B38), (A)+(B32)+(B39), (A)+(B32)+(B40), (A)+(B32)+(B41), (A)+(B32)+(B42), (A)+(B32)+(B43), (A)+(B32)+(B44), (A)+(B32)+(B45), (A)+(B32)+(B46), (A)+(B32)+(B47), (A)+(B32)+(B48), (A)+(B32)+(B49), (A)+(B32)+(B50), (A)+(B32)+(B51), (A)+(B32)+(B52), (A)+(B32)+(B53), (A)+(B32)+(B54), (A)+(B32)+(B55), (A)+(B32)+(B56), (A)+(B32)+(B57), (A)+(B32)+(B58), (A)+(B32)+(B59), (A)+(B32)+(B60), (A)+(B32)+(B61), (A)+(B32)+(B62), (A)+(B32)+(B63), (A)+(B32)+(B64), (A)+(B32)+(B65), (A)+(B32)+(B66), (A)+(B32)+(B67), (A)+(B32)+(B68), (A)+(B32)+(B69), (A)+(B32)+(B70), (A)+(B32)+(B71), (A)+(B32)+(B72), (A)+(B32)+(B73), (A)+(B32)+(B74), (A)+(B32)+(B75), (A)+(B32)+(B76), (A)+(B32)+(B77), (A)+(B32)+(B78), (A)+(B32)+(B79), (A)+(B32)+(B80), (A)+(B32)+(B81), (A)+(B32)+(B82), (A)+(B32)+(B83), (A)+(B32)+(B84), (A)+(B32)+(B85), (A)+(B32)+(B86), (A)+(B32)+(B87), (A)+(B32)+(B88), (A)+(B32)+(B89), (A)+(B32)+(B90), (A)+(B32)+(B91), (A)+(B32)+(B92), (A)+(B32)+(B93), (A)+(B32)+(B94), (A)+(B32)+(B95), (A)+(B32)+(B96), (A)+(B32)+(B97), (A)+(B32)+(B98), (A)+(B32)+(B99), (A)+(B32)+(B100), (A)+(B32)+(B101), (A)+(B32)+(B102), (A)+(B32)+(B103), (A)+(B32)+(B104), (A)+(B32)+(B105), (A)+(B32)+(B106), (A)+(B32)+(B107), (A)+(B32)+(B108), (A)+(B32)+(B109), (A)+(B32)+(B110), (A)+(B32)+(B111), (A)+(B32)+(B112), (A)+(B32)+(B113), (A)+(B32)+(B114), (A)+(B32)+(B115), (A)+(B32)+(B116), (A)+(B32)+(B117), (A)+(B32)+(B118), (A)+(B32)+(B119), (A)+(B32)+(B120), (A)+(B32)+(B121), (A)+(B32)+(B122), (A)+(B32)+(B123), (A)+(B32)+(B124), (A)+(B32)+(B125), (A)+(B32)+(B126), (A)+(B32)+(B127), (A)+(B32)+(B128), (A)+(B32)+(B129), (A)+(B32)+(B130), (A)+(B32)+(B131), (A)+(B32)+(B132), (A)+(B32)+(B133), (A)+(B32)+(B134), (A)+(B32)+(B135), (A)+(B32)+(B136), (A)+(B32)+(B137), (A)+(B32)+(B138), (A)+(B32)+(B139), (A)+(B32)+(B140), (A)+(B32)+(B141), (A)+(B32)+(B142), (A)+(B32)+(B143), (A)+(B32)+(B144), (A)+(B32)+(B145), (A)+(B32)+(B146), (A)+(B32)+(B147), (A)+(B32)+(B148), (A)+(B32)+(B149), (A)+(B32)+(B150), (A)+(B32)+(B151), (A)+(B32)+(B152), (A)+(B32)+(B153), (A)+(B32)+(B154), (A)+(B32)+(B155), (A)+(B32)+(B156), (A)+(B32)+(B157), (A)+(B32)+(B158), (A)+(B32)+(B159), (A)+(B32)+(B160), (A)+(B32)+(B161), (A)+(B32)+(B162), (A)+(B32)+(B164), (A)+(B32)+(B164), (A)+(B32)+(B165), (A)+(B32)+(B166), (A)+(B32)+(B167), (A)+(B32)+(B168), (A)+(B32)+(B169), (A)+(B32)+(B170), (A)+(B32)+(B171), (A)+(B32)+(B172), (A)+(B32)+(B173), (A)+(B32)+(B174), (A)+(B32)+(B175), (A)+(B32)+(B176), (A)+(B32)+(B177), (A)+(B32)+(B178), (A)+(B32)+(B179), (A)+(B32)+(B180), (A)+(B32)+(B181), (A)+(B32)+(B182), (A)+(B32)+(B183), (A)+(B32)+(B184), (A)+(B32)+(B185), (A)+(B32)+(B186), (A)+(B32)+(B187), (A)+(B32)+(B188), (A)+(B32)+(B189), (A)+(B32)+(B190), (A)+(B32)+(B191), (A)+(B32)+(B192), (A)+(B32)+(B193), (A)+(B32)+(B194), (A)+(B32)+(B195), (A)+(B32)+(B196), (A)+(B32)+(B197), (A)+(B32)+(B198), (A)+(B32)+(B199), (A)+(B32)+(B200), (A)+(B32)+(B201), (A)+(B32)+(B202), (A)+(B32)+(B203), (A)+(B32)+(B204), (A)+(B32)+(B205), (A)+(B32)+(B206), (A)+(B32)+(B207), (A)+(B32)+(B208), (A)+(B32)+(B209), (A)+(B32)+(B210), (A)+(B32)+(B211), (A)+(B32)+(B212), (A)+(B32)+(B213), (A)+(B32)+(B214), (A)+(B32)+(B215), (A)+(B32)+(B216), (A)+(B32)+(B217), (A)+(B32)+(B218), (A)+(B32)+(B219), (A)+(B32)+(B220), (A)+(B32)+(B221), (A)+(B32)+(B222), (A)+(B32)+(B223), (A)+(B32)+(B224), (A)+(B32)+(B225), (A)+(B32)+(B226), (A)+(B32)+(B227), (A)+(B32)+(B228), (A)+(B32)+(B229), (A)+(B32)+(B230), (A)+(B32)+(B231), (A)+(B32)+(B232), (A)+(B32)+(B233), (A)+(B32)+(B234), (A)+(B32)+(B235), (A)+(B32)+(B236), (A)+(B32)+(B237), (A)+(B32)+(B238), (A)+(B32)+(B239), (A)+(B32)+(B240), (A)+(B32)+(B241), (A)+(B32)+(B242), (A)+(B32)+(B243), (A)+(B32)+(B244), (A)+(B32)+(B245), (A)+(B32)+(B246), (A)+(B32)+(B247), (A)+(B32)+(B248), (A)+(B32)+(B249), (A)+(B32)+(B250), (A)+(B32)+(B251), (A)+(B32)+(B252), (A)+(B32)+(B253), (A)+(B32)+(B254), (A)+(B32)+(B255), (A)+(B32)+(B256), (A)+(B32)+(B257), (A)+(B32)+(B258), (A)+(B32)+(B259), (A)+(B32)+(B260), (A)+(B32)+(B261), (A)+(B32)+(B262), (A)+(B32)+(B263), (A)+(B32)+(B264), (A)+(B32)+(B265), (A)+(B32)+(B266), (A)+(B32)+(B267), (A)+(B32)+(B268), (A)+(B32)+(B269), (A)+(B32)+(B270), (A)+(B32)+(B271), (A)+(B32)+(B272), (A)+(B32)+(B273), (A)+(B32)+(B274), (A)+(B32)+(B275), (A)+(B32)+(B276), (A)+(B32)+(B277), (A)+(B32)+(B278), (A)+(B32)+(B279), (A)+(B32)+(B280), (A)+(B32)+(B281), (A)+(B32)+(B282), (A)+(B32)+(B283), (A)+(B32)+(B284), (A)+(B32)+(B285), (A)+(B32)+(B286), (A)+(B32)+(B287), (A)+(B32)+(B288), (A)+(B32)+(B289), (A)+(B32)+(B290), (A)+(B32)+(B291), (A)+(B32)+(B292), (A)+(B32)+(B293), (A)+(B32)+(B294), (A)+(B32)+(B295), (A)+(B32)+(B296), (A)+(B32)+(B297), (A)+(B32)+(B298), (A)+(B32)+(B299), (A)+(B32)+(B300), (A)+(B32)+(B301), (A)+(B32)+(B302), (A)+(B32)+(B303), (A)+(B32)+(B304), (A)+(B32)+(B305), (A)+(B32)+(B306), (A)+(B32)+(B307), (A)+(B32)+(B308), (A)+(B32)+(B309), (A)+(B32)+(B310), (A)+(B32)+(B311), (A)+(B32)+(B312), (A)+(B32)+(B313), (A)+(B32)+(B314), (A)+(B32)+(B315),

(A)+(B33)+(B34), (A)+(B33)+(B35), (A)+(B33)+(B36), (A)+(B33)+(B37), (A)+(B33)+(B38), (A)+(B33)+(B39), (A)+(B33)+(B40), (A)+(B33)+(B41), (A)+(B33)+(B42), (A)+(B33)+(B43), (A)+(B33)+(B44), (A)+(B33)+(B45), (A)+(B33)+(B46), (A)+(B33)+(B47), (A)+(B33)+(B48), (A)+(B33)+(B49), (A)+(B33)+(B50), (A)+(B33)+(B51), (A)+(B33)+(B52), (A)+(B33)+(B53), (A)+(B33)+(B54), (A)+(B33)+(B55), (A)+(B33)+(B56), (A)+(B33)+(B57), (A)+(B33)+(B58), (A)+(B33)+(B59), (A)+(B33)+(B60), (A)+(B33)+(B61), (A)+(B33)+(B62), (A)+(B33)+(B63), (A)+(B33)+(B64), (A)+(B33)+(B65), (A)+(B33)+(B66), (A)+(B33)+(B67), (A)+(B33)+(B68), (A)+(B33)+(B69), (A)+(B33)+(B70), (A)+(B33)+(B71), (A)+(B33)+(B72), (A)+(B33)+(B73), (A)+(B33)+(B74), (A)+(B33)+(B75), (A)+(B33)+(B76), (A)+(B33)+(B77), (A)+(B33)+(B78), (A)+(B33)+(B79), (A)+(B33)+(B80), (A)+(B33)+(B81), (A)+(B33)+(B82), (A)+(B33)+(B83), (A)+(B33)+(B84), (A)+(B33)+(B85), (A)+(B33)+(B86), (A)+(B33)+(B87), (A)+(B33)+(B88), (A)+(B33)+(B89), (A)+(B33)+(B90), (A)+(B33)+(B91), (A)+(B33)+(B92), (A)+(B33)+(B93), (A)+(B33)+(B94), (A)+(B33)+(B95), (A)+(B33)+(B96), (A)+(B33)+(B97), (A)+(B33)+(B98), (A)+(B33)+(B99), (A)+(B33)+(B100), (A)+(B33)+(B101), (A)+(B33)+(B102), (A)+(B33)+(B103), (A)+(B33)+(B104), (A)+(B33)+(B105), (A)+(B33)+(B106), (A)+(B33)+(B107), (A)+(B33)+(B108), (A)+(B33)+(B109), (A)+(B33)+(B110), (A)+(B33)+(B111), (A)+(B33)+(B112), (A)+(B33)+(B113), (A)+(B33)+(B114), (A)+(B33)+(B115), (A)+(B33)+(B116), (A)+(B33)+(B117), (A)+(B33)+(B118), (A)+(B33)+(B119), (A)+(B33)+(B120), (A)+(B33)+(B121), (A)+(B33)+(B122), (A)+(B33)+(B123), (A)+(B33)+(B124), (A)+(B33)+(B125), (A)+(B33)+(B126), (A)+(B33)+(B127), (A)+(B33)+(B128), (A)+(B33)+(B129), (A)+(B33)+(B130), (A)+(B33)+(B131), (A)+(B33)+(B132), (A)+(B33)+(B133), (A)+(B33)+(B134), (A)+(B33)+(B135), (A)+(B33)+(B136), (A)+(B33)+(B137), (A)+(B33)+(B138), (A)+(B33)+(B139), (A)+(B33)+(B140), (A)+(B33)+(B141), (A)+(B33)+(B142), (A)+(B33)+(B143), (A)+(B33)+(B144), (A)+(B33)+(B145), (A)+(B33)+(B146), (A)+(B33)+(B147), (A)+(B33)+(B148), (A)+(B33)+(B149), (A)+(B33)+(B150), (A)+(B33)+(B151), (A)+(B33)+(B152), (A)+(B33)+(B153), (A)+(B33)+(B154), (A)+(B33)+(B155), (A)+(B33)+(B156), (A)+(B33)+(B157), (A)+(B33)+(B158), (A)+(B33)+(B159), (A)+(B33)+(B160), (A)+(B33)+(B161), (A)+(B33)+(B162), (A)+(B33)+(B164), (A)+(B33)+(B164), (A)+(B33)+(B165), (A)+(B33)+(B166), (A)+(B33)+(B167), (A)+(B33)+(B168), (A)+(B33)+(B169), (A)+(B33)+(B170), (A)+(B33)+(B171), (A)+(B33)+(B172), (A)+(B33)+(B173), (A)+(B33)+(B174), (A)+(B33)+(B175), (A)+(B33)+(B176), (A)+(B33)+(B177), (A)+(B33)+(B178), (A)+(B33)+(B179), (A)+(B33)+(B180), (A)+(B33)+(B181), (A)+(B33)+(B182), (A)+(B33)+(B183), (A)+(B33)+(B184), (A)+(B33)+(B185), (A)+(B33)+(B186), (A)+(B33)+(B187), (A)+(B33)+(B188), (A)+(B33)+(B189), (A)+(B33)+(B190), (A)+(B33)+(B191), (A)+(B33)+(B192), (A)+(B33)+(B193), (A)+(B33)+(B194), (A)+(B33)+(B195), (A)+(B33)+(B196), (A)+(B33)+(B197), (A)+(B33)+(B198), (A)+(B33)+(B199), (A)+(B33)+(B200), (A)+(B33)+(B201), (A)+(B33)+(B202), (A)+(B33)+(B203), (A)+(B33)+(B204), (A)+(B33)+(B205), (A)+(B33)+(B206), (A)+(B33)+(B207), (A)+(B33)+(B208), (A)+(B33)+(B209), (A)+(B33)+(B210), (A)+(B33)+(B211), (A)+(B33)+(B212), (A)+(B33)+(B213), (A)+(B33)+(B214), (A)+(B33)+(B215), (A)+(B33)+(B216), (A)+(B33)+(B217), (A)+(B33)+(B218), (A)+(B33)+(B219), (A)+(B33)+(B220), (A)+(B33)+(B221), (A)+(B33)+(B222), (A)+(B33)+(B223), (A)+(B33)+(B224), (A)+(B33)+(B225), (A)+(B33)+(B226), (A)+(B33)+(B227), (A)+(B33)+(B228), (A)+(B33)+(B229), (A)+(B33)+(B230), (A)+(B33)+(B231), (A)+(B33)+(B232), (A)+(B33)+(B233), (A)+(B33)+(B234), (A)+(B33)+(B235), (A)+(B33)+(B236), (A)+(B33)+(B237), (A)+(B33)+(B238), (A)+(B33)+(B239), (A)+(B33)+(B240), (A)+(B33)+(B241), (A)+(B33)+(B242), (A)+(B33)+(B243), (A)+(B33)+(B244), (A)+(B33)+(B245), (A)+(B33)+(B246), (A)+(B33)+(B247), (A)+(B33)+(B248), (A)+(B33)+(B249), (A)+(B33)+(B250), (A)+(B33)+(B251), (A)+(B33)+(B252), (A)+(B33)+(B253), (A)+(B33)+(B254), (A)+(B33)+(B255), (A)+(B33)+(B256), (A)+(B33)+(B257), (A)+(B33)+(B258), (A)+(B33)+(B259), (A)+(B33)+(B260), (A)+(B33)+(B261), (A)+(B33)+(B262), (A)+(B33)+(B263), (A)+(B33)+(B264), (A)+(B33)+(B265), (A)+(B33)+(B266), (A)+(B33)+(B267), (A)+(B33)+(B268), (A)+(B33)+(B269), (A)+(B33)+(B270), (A)+(B33)+(B271), (A)+(B33)+(B272), (A)+(B33)+(B273), (A)+(B33)+(B274), (A)+(B33)+(B275), (A)+(B33)+(B276), (A)+(B33)+(B277), (A)+(B33)+(B278), (A)+(B33)+(B279), (A)+(B33)+(B280), (A)+(B33)+(B281), (A)+(B33)+(B282), (A)+(B33)+(B283), (A)+(B33)+(B284), (A)+(B33)+(B285), (A)+(B33)+(B286), (A)+(B33)+(B287), (A)+(B33)+(B288), (A)+(B33)+(B289), (A)+(B33)+(B290), (A)+(B33)+(B291), (A)+(B33)+(B292), (A)+(B33)+(B293), (A)+(B33)+(B294), (A)+(B33)+(B295), (A)+(B33)+(B296), (A)+(B33)+(B297), (A)+(B33)+(B298), (A)+(B33)+(B299), (A)+(B33)+(B300), (A)+(B33)+(B301), (A)+(B33)+(B302), (A)+(B33)+(B303), (A)+(B33)+(B304), (A)+(B33)+(B305), (A)+(B33)+(B306), (A)+(B33)+(B307), (A)+(B33)+(B308), (A)+(B33)+(B309), (A)+(B33)+(B310), (A)+(B33)+(B311), (A)+(B33)+(B312), (A)+(B33)+(B313), (A)+(B33)+(B314), (A)+(B33)+(B315),

(A)+(B34)+(B35), (A)+(B34)+(B36), (A)+(B34)+(B37), (A)+(B34)+(B38), (A)+(B34)+(B39), (A)+(B34)+(B40), (A)+(B34)+(B41), (A)+(B34)+(B42), (A)+(B34)+(B43), (A)+(B34)+(B44), (A)+(B34)+(B45), (A)+(B34)+(B46), (A)+(B34)+(B47), (A)+(B34)+(B48), (A)+(B34)+(B49), (A)+(B34)+(B50), (A)+(B34)+(B51), (A)+(B34)+(B52), (A)+(B34)+(B53), (A)+(B34)+(B54), (A)+(B34)+(B55), (A)+(B34)+(B56), (A)+(B34)+(B57), (A)+(B34)+(B58), (A)+(B34)+(B59), (A)+(B34)+(B60), (A)+(B34)+(B61), (A)+(B34)+(B62), (A)+(B34)+(B63), (A)+(B34)+(B64), (A)+(B34)+(B65), (A)+(B34)+(B66), (A)+(B34)+(B67), (A)+(B34)+(B68), (A)+(B34)+(B69), (A)+(B34)+(B70), (A)+(B34)+(B71), (A)+(B34)+(B72), (A)+(B34)+(B73), (A)+(B34)+(B74), (A)+(B34)+(B75), (A)+(B34)+(B76), (A)+(B34)+(B77), (A)+(B34)+(B78), (A)+(B34)+(B79), (A)+(B34)+(B80), (A)+(B34)+(B81), (A)+(B34)+(B82), (A)+(B34)+(B83), (A)+(B34)+(B84), (A)+(B34)+(B85), (A)+(B34)+(B86), (A)+(B34)+(B87), (A)+(B34)+(B88), (A)+(B34)+(B89), (A)+(B34)+(B90), (A)+(B34)+(B91), (A)+(B34)+(B92), (A)+(B34)+(B93), (A)+(B34)+(B94), (A)+(B34)+(B95), (A)+(B34)+(B96), (A)+(B34)+(B97), (A)+(B34)+(B98), (A)+(B34)+(B99), (A)+(B34)+(B100), (A)+(B34)+(B101), (A)+(B34)+(B102), (A)+(B34)+(B103), (A)+(B34)+(B104), (A)+(B34)+(B105), (A)+(B34)+(B106), (A)+(B34)+(B107), (A)+(B34)+(B108), (A)+(B34)+(B109), (A)+(B34)+(B110), (A)+(B34)+(B111), (A)+(B34)+(B112), (A)+(B34)+(B113), (A)+(B34)+(B114), (A)+(B34)+(B115), (A)+(B34)+(B116), (A)+(B34)+(B117), (A)+(B34)+(B118), (A)+(B34)+(B119), (A)+(B34)+(B120), (A)+(B34)+(B121), (A)+(B34)+(B122), (A)+(B34)+(B123), (A)+(B34)+(B124), (A)+(B34)+(B125), (A)+(B34)+(B126), (A)+(B34)+(B127), (A)+(B34)+(B128), (A)+(B34)+(B129), (A)+(B34)+(B130), (A)+(B34)+(B131), (A)+(B34)+(B132), (A)+(B34)+(B133), (A)+(B34)+(B134), (A)+(B34)+(B135), (A)+(B34)+(B136), (A)+(B34)+(B137), (A)+(B34)+(B138), (A)+(B34)+(B139), (A)+(B34)+(B140), (A)+(B34)+(B141), (A)+(B34)+(B142), (A)+(B34)+(B143), (A)+(B34)+(B144), (A)+(B34)+(B145), (A)+(B34)+(B146), (A)+(B34)+(B147), (A)+(B34)+(B148), (A)+(B34)+(B149), (A)+(B34)+(B150), (A)+(B34)+(B151), (A)+(B34)+(B152), (A)+(B34)+(B153), (A)+(B34)+(B154), (A)+(B34)+(B155), (A)+(B34)+(B156), (A)+(B34)+(B157), (A)+(B34)+(B158), (A)+(B34)+(B159), (A)+(B34)+(B160), (A)+(B34)+(B161), (A)+(B34)+(B162), (A)+(B34)+(B164), (A)+(B34)+(B164), (A)+(B34)+(B165), (A)+(B34)+(B166), (A)+(B34)+(B167), (A)+(B34)+(B168), (A)+(B34)+(B169), (A)+(B34)+(B170), (A)+(B34)+(B171), (A)+(B34)+(B172), (A)+(B34)+(B173), (A)+(B34)+(B174), (A)+(B34)+(B175), (A)+(B34)+(B176), (A)+(B34)+(B177), (A)+(B34)+(B178), (A)+(B34)+(B179), (A)+(B34)+(B180), (A)+(B34)+(B181), (A)+(B34)+(B182), (A)+(B34)+(B183), (A)+(B34)+(B184), (A)+(B34)+(B185), (A)+(B34)+(B186), (A)+(B34)+(B187), (A)+(B34)+(B188), (A)+(B34)+(B189), (A)+(B34)+(B190), (A)+(B34)+(B191), (A)+(B34)+(B192), (A)+(B34)+(B193), (A)+(B34)+(B194), (A)+(B34)+(B195), (A)+(B34)+(B196), (A)+(B34)+(B197), (A)+(B34)+(B198), (A)+(B34)+(B199), (A)+(B34)+(B200), (A)+(B34)+(B201), (A)+(B34)+(B202), (A)+(B34)+(B203), (A)+(B34)+(B204), (A)+(B34)+(B205), (A)+(B34)+(B206), (A)+(B34)+(B207), (A)+(B34)+(B208), (A)+(B34)+(B209), (A)+(B34)+(B210), (A)+(B34)+(B211), (A)+(B34)+(B212), (A)+(B34)+(B213), (A)+(B34)+(B214), (A)+(B34)+(B215), (A)+(B34)+(B216), (A)+(B34)+(B217), (A)+(B34)+(B218), (A)+(B34)+(B219), (A)+(B34)+(B220), (A)+(B34)+(B221), (A)+(B34)+(B222), (A)+(B34)+(B223), (A)+(B34)+(B224), (A)+(B34)+(B225), (A)+(B34)+(B226), (A)+(B34)+(B227), (A)+(B34)+(B228), (A)+(B34)+(B229), (A)+(B34)+(B230), (A)+(B34)+(B231), (A)+(B34)+(B232), (A)+(B34)+(B233), (A)+(B34)+(B234), (A)+(B34)+(B235), (A)+(B34)+(B236), (A)+(B34)+(B237), (A)+(B34)+(B238), (A)+(B34)+(B239), (A)+(B34)+(B240), (A)+(B34)+(B241), (A)+(B34)+(B242), (A)+(B34)+(B243), (A)+(B34)+(B244), (A)+(B34)+(B245), (A)+(B34)+(B246), (A)+(B34)+(B247), (A)+(B34)+(B248), (A)+(B34)+(B249), (A)+(B34)+(B250), (A)+(B34)+(B251), (A)+(B34)+(B252), (A)+(B34)+(B253), (A)+(B34)+(B254), (A)+(B34)+(B255), (A)+(B34)+(B256), (A)+(B34)+(B257), (A)+(B34)+(B258), (A)+(B34)+(B259), (A)+(B34)+(B260), (A)+(B34)+(B261), (A)+(B34)+(B262), (A)+(B34)+(B263), (A)+(B34)+(B264), (A)+(B34)+(B265), (A)+(B34)+(B266), (A)+(B34)+(B267), (A)+(B34)+(B268), (A)+(B34)+(B269), (A)+(B34)+(B270), (A)+(B34)+(B271), (A)+(B34)+(B272), (A)+(B34)+(B273), (A)+(B34)+(B274), (A)+(B34)+(B275), (A)+(B34)+(B276), (A)+(B34)+(B277), (A)+(B34)+(B278), (A)+(B34)+(B279), (A)+(B34)+(B280), (A)+(B34)+(B281), (A)+(B34)+(B282), (A)+(B34)+(B283), (A)+(B34)+(B284), (A)+(B34)+(B285), (A)+(B34)+(B286), (A)+(B34)+(B287), (A)+(B34)+(B288), (A)+(B34)+(B289), (A)+(B34)+(B290), (A)+(B34)+(B291), (A)+(B34)+(B292), (A)+(B34)+(B293), (A)+(B34)+(B294), (A)+(B34)+(B295), (A)+(B34)+(B296), (A)+(B34)+(B297), (A)+(B34)+(B298), (A)+(B34)+(B299), (A)+(B34)+(B300), (A)+(B34)+(B301), (A)+(B34)+(B302), (A)+(B34)+(B303), (A)+(B34)+(B304), (A)+(B34)+(B305), (A)+(B34)+(B306), (A)+(B34)+(B307), (A)+(B34)+(B308), (A)+(B34)+(B309), (A)+(B34)+(B310), (A)+(B34)+(B311), (A)+(B34)+(B312), (A)+(B34)+(B313), (A)+(B34)+(B314), (A)+(B34)+(B315),

(A)+(B35)+(B36), (A)+(B35)+(B37), (A)+(B35)+(B38), (A)+(B35)+(B39), (A)+(B35)+(B40), (A)+(B35)+(B41), (A)+(B35)+(B42), (A)+(B35)+(B43), (A)+(B35)+(B44), (A)+(B35)+(B45), (A)+(B35)+(B46), (A)+(B35)+(B47), (A)+(B35)+(B48), (A)+(B35)+(B49), (A)+(B35)+(B50), (A)+(B35)+(B51), (A)+(B35)+(B52), (A)+(B35)+(B53), (A)+(B35)+(B54), (A)+(B35)+(B55), (A)+(B35)+(B56), (A)+(B35)+(B57), (A)+(B35)+(B58), (A)+(B35)+(B59), (A)+(B35)+(B60), (A)+(B35)+(B61), (A)+(B35)+(B62), (A)+(B35)+(B63), (A)+(B35)+(B64), (A)+(B35)+(B65), (A)+(B35)+(B66), (A)+(B35)+(B67), (A)+(B35)+(B68), (A)+(B35)+(B69), (A)+(B35)+(B70), (A)+(B35)+(B71), (A)+(B35)+(B72), (A)+(B35)+(B73), (A)+(B35)+(B74), (A)+(B35)+(B75), (A)+(B35)+(B76), (A)+(B35)+(B77), (A)+(B35)+(B78), (A)+(B35)+(B79), (A)+(B35)+(B80), (A)+(B35)+(B81), (A)+(B35)+(B82), (A)+(B35)+(B83), (A)+(B35)+(B84), (A)+(B35)+(B85), (A)+(B35)+(B86), (A)+(B35)+(B87), (A)+(B35)+(B88), (A)+(B35)+(B89), (A)+(B35)+(B90), (A)+(B35)+(B91), (A)+(B35)+(B92), (A)+(B35)+(B93), (A)+(B35)+(B94), (A)+(B35)+(B95), (A)+(B35)+(B96), (A)+(B35)+(B97), (A)+(B35)+(B98), (A)+(B35)+(B99), (A)+(B35)+(B100), (A)+(B35)+(B101), (A)+(B35)+(B102), (A)+(B35)+(B103), (A)+(B35)+(B104), (A)+(B35)+(B105), (A)+(B35)+(B106), (A)+(B35)+(B107), (A)+(B35)+(B108), (A)+(B35)+(B109), (A)+(B35)+(B110), (A)+(B35)+(B111), (A)+(B35)+(B112), (A)+(B35)+(B113), (A)+(B35)+(B114), (A)+(B35)+(B115), (A)+(B35)+(B116), (A)+(B35)+(B117), (A)+(B35)+(B118), (A)+(B35)+(B119), (A)+(B35)+(B120), (A)+(B35)+(B121), (A)+(B35)+(B122), (A)+(B35)+(B123), (A)+(B35)+(B124), (A)+(B35)+(B125), (A)+(B35)+(B126), (A)+(B35)+(B127), (A)+(B35)+(B128), (A)+(B35)+(B129), (A)+(B35)+(B130), (A)+(B35)+(B131), (A)+(B35)+(B132), (A)+(B35)+(B133), (A)+(B35)+(B134), (A)+(B35)+(B135), (A)+(B35)+(B136), (A)+(B35)+(B137), (A)+(B35)+(B138), (A)+(B35)+(B139), (A)+(B35)+(B140), (A)+(B35)+(B141), (A)+(B35)+(B142), (A)+(B35)+(B143), (A)+(B35)+(B144), (A)+(B35)+(B145), (A)+(B35)+(B146), (A)+(B35)+(B147), (A)+(B35)+(B148), (A)+(B35)+(B149), (A)+(B35)+(B150), (A)+(B35)+(B151), (A)+(B35)+(B152), (A)+(B35)+(B153), (A)+(B35)+(B154), (A)+(B35)+(B155), (A)+(B35)+(B156), (A)+(B35)+(B157), (A)+(B35)+(B158), (A)+(B35)+(B159), (A)+(B35)+(B160), (A)+(B35)+(B161), (A)+(B35)+(B162), (A)+(B35)+(B164), (A)+(B35)+(B164), (A)+(B35)+(B165), (A)+(B35)+(B166), (A)+(B35)+(B167), (A)+(B35)+(B168), (A)+(B35)+(B169), (A)+(B35)+(B170), (A)+(B35)+(B171), (A)+(B35)+(B172), (A)+(B35)+(B173), (A)+(B35)+(B174), (A)+(B35)+(B175), (A)+(B35)+(B176), (A)+(B35)+(B177), (A)+(B35)+(B178), (A)+(B35)+(B179), (A)+(B35)+(B180), (A)+(B35)+(B181), (A)+(B35)+(B182), (A)+(B35)+(B183), (A)+(B35)+(B184), (A)+(B35)+(B185), (A)+(B35)+(B186), (A)+(B35)+(B187), (A)+(B35)+(B188), (A)+(B35)+(B189), (A)+(B35)+(B190), (A)+(B35)+(B191), (A)+(B35)+(B192), (A)+(B35)+(B193), (A)+(B35)+(B194), (A)+(B35)+(B195), (A)+(B35)+(B196), (A)+(B35)+(B197), (A)+(B35)+(B198), (A)+(B35)+(B199), (A)+(B35)+(B200), (A)+(B35)+(B201), (A)+(B35)+(B202), (A)+(B35)+(B203), (A)+(B35)+(B204), (A)+(B35)+(B205), (A)+(B35)+(B206), (A)+(B35)+(B207), (A)+(B35)+(B208), (A)+(B35)+(B209), (A)+(B35)+(B210), (A)+(B35)+(B211), (A)+(B35)+(B212), (A)+(B35)+(B213), (A)+(B35)+(B214), (A)+(B35)+(B215), (A)+(B35)+(B216), (A)+(B35)+(B217), (A)+(B35)+(B218), (A)+(B35)+(B219), (A)+(B35)+(B220), (A)+(B35)+(B221), (A)+(B35)+(B222), (A)+(B35)+(B223), (A)+(B35)+(B224), (A)+(B35)+(B225), (A)+(B35)+(B226), (A)+(B35)+(B227), (A)+(B35)+(B228), (A)+(B35)+(B229), (A)+(B35)+(B230), (A)+(B35)+(B231), (A)+(B35)+(B232), (A)+(B35)+(B233), (A)+(B35)+(B234), (A)+(B35)+(B235), (A)+(B35)+(B236), (A)+(B35)+(B237), (A)+(B35)+(B238), (A)+(B35)+(B239), (A)+(B35)+(B240), (A)+(B35)+(B241), (A)+(B35)+(B242), (A)+(B35)+(B243), (A)+(B35)+(B244), (A)+(B35)+(B245), (A)+(B35)+(B246), (A)+(B35)+(B247), (A)+(B35)+(B248), (A)+(B35)+(B249), (A)+(B35)+(B250), (A)+(B35)+(B251), (A)+(B35)+(B252), (A)+(B35)+(B253), (A)+(B35)+(B254), (A)+(B35)+(B255), (A)+(B35)+(B256), (A)+(B35)+(B257), (A)+(B35)+(B258), (A)+(B35)+(B259), (A)+(B35)+(B260), (A)+(B35)+(B261), (A)+(B35)+(B262), (A)+(B35)+(B263), (A)+(B35)+(B264), (A)+(B35)+(B265), (A)+(B35)+(B266), (A)+(B35)+(B267), (A)+(B35)+(B268), (A)+(B35)+(B269), (A)+(B35)+(B270), (A)+(B35)+(B271), (A)+(B35)+(B272), (A)+(B35)+(B273), (A)+(B35)+(B274), (A)+(B35)+(B275), (A)+(B35)+(B276), (A)+(B35)+(B277), (A)+(B35)+(B278), (A)+(B35)+(B279), (A)+(B35)+(B280), (A)+(B35)+(B281), (A)+(B35)+(B282), (A)+(B35)+(B283), (A)+(B35)+(B284), (A)+(B35)+(B285), (A)+(B35)+(B286), (A)+(B35)+(B287), (A)+(B35)+(B288), (A)+(B35)+(B289), (A)+(B35)+(B290), (A)+(B35)+(B291), (A)+(B35)+(B292), (A)+(B35)+(B293), (A)+(B35)+(B294), (A)+(B35)+(B295), (A)+(B35)+(B296), (A)+(B35)+(B297), (A)+(B35)+(B298), (A)+(B35)+(B299), (A)+(B35)+(B300), (A)+(B35)+(B301), (A)+(B35)+(B302), (A)+(B35)+(B303), (A)+(B35)+(B304), (A)+(B35)+(B305), (A)+(B35)+(B306), (A)+(B35)+(B307), (A)+(B35)+(B308), (A)+(B35)+(B309), (A)+(B35)+(B310), (A)+(B35)+(B311), (A)+(B35)+(B312), (A)+(B35)+(B313), (A)+(B35)+(B314), (A)+(B35)+(B315),

(A)+(B36)+(B37), (A)+(B36)+(B38), (A)+(B36)+(B39), (A)+(B36)+(B40), (A)+(B36)+(B41), (A)+(B36)+(B42), (A)+(B36)+(B43), (A)+(B36)+(B44), (A)+(B36)+(B45), (A)+(B36)+(B46), (A)+(B36)+(B47), (A)+(B36)+(B48), (A)+(B36)+(B49), (A)+(B36)+(B50), (A)+(B36)+(B51), (A)+(B36)+(B52), (A)+(B36)+(B53), (A)+(B36)+(B54), (A)+(B36)+(B55), (A)+(B36)+(B56), (A)+(B36)+(B57), (A)+(B36)+(B58), (A)+(B36)+(B59), (A)+(B36)+(B60), (A)+(B36)+(B61), (A)+(B36)+(B62), (A)+(B36)+(B63), (A)+(B36)+(B64), (A)+(B36)+(B65), (A)+(B36)+(B66), (A)+(B36)+(B67), (A)+(B36)+(B68), (A)+(B36)+(B69), (A)+(B36)+(B70), (A)+(B36)+(B71), (A)+(B36)+(B72), (A)+(B36)+(B73), (A)+(B36)+(B74), (A)+(B36)+(B75), (A)+(B36)+(B76), (A)+(B36)+(B77), (A)+(B36)+(B78), (A)+(B36)+(B79), (A)+(B36)+(B80), (A)+(B36)+(B81), (A)+(B36)+(B82), (A)+(B36)+(B83), (A)+(B36)+(B84), (A)+(B36)+(B85), (A)+(B36)+(B86), (A)+(B36)+(B87), (A)+(B36)+(B88), (A)+(B36)+(B89), (A)+(B36)+(B90), (A)+(B36)+(B91), (A)+(B36)+(B92), (A)+(B36)+(B93), (A)+(B36)+(B94), (A)+(B36)+(B95), (A)+(B36)+(B96), (A)+(B36)+(B97), (A)+(B36)+(B98), (A)+(B36)+(B99), (A)+(B36)+(B100), (A)+(B36)+(B101), (A)+(B36)+(B102), (A)+(B36)+(B103), (A)+(B36)+(B104), (A)+(B36)+(B105), (A)+(B36)+(B106), (A)+(B36)+(B107), (A)+(B36)+(B108), (A)+(B36)+(B109), (A)+(B36)+(B110), (A)+(B36)+(B111), (A)+(B36)+(B112), (A)+(B36)+(B113), (A)+(B36)+(B114), (A)+(B36)+(B115), (A)+(B36)+(B116), (A)+(B36)+(B117), (A)+(B36)+(B118), (A)+(B36)+(B119), (A)+(B36)+(B120), (A)+(B36)+(B121), (A)+(B36)+(B122), (A)+(B36)+(B123), (A)+(B36)+(B124), (A)+(B36)+(B125), (A)+(B36)+(B126), (A)+(B36)+(B127), (A)+(B36)+(B128), (A)+(B36)+(B129), (A)+(B36)+(B130), (A)+(B36)+(B131), (A)+(B36)+(B132), (A)+(B36)+(B133), (A)+(B36)+(B134), (A)+(B36)+(B135), (A)+(B36)+(B136), (A)+(B36)+(B137), (A)+(B36)+(B138), (A)+(B36)+(B139), (A)+(B36)+(B140), (A)+(B36)+(B141), (A)+(B36)+(B142), (A)+(B36)+(B143), (A)+(B36)+(B144), (A)+(B36)+(B145), (A)+(B36)+(B146), (A)+(B36)+(B147), (A)+(B36)+(B148), (A)+(B36)+(B149), (A)+(B36)+(B150), (A)+(B36)+(B151), (A)+(B36)+(B152), (A)+(B36)+(B153), (A)+(B36)+(B154), (A)+(B36)+(B155), (A)+(B36)+(B156), (A)+(B36)+(B157), (A)+(B36)+(B158), (A)+(B36)+(B159), (A)+(B36)+(B160), (A)+(B36)+(B161), (A)+(B36)+(B162), (A)+(B36)+(B164), (A)+(B36)+(B164), (A)+(B36)+(B165), (A)+(B36)+(B166), (A)+(B36)+(B167), (A)+(B36)+(B168), (A)+(B36)+(B169), (A)+(B36)+(B170), (A)+(B36)+(B171), (A)+(B36)+(B172), (A)+(B36)+(B173), (A)+(B36)+(B174), (A)+(B36)+(B175), (A)+(B36)+(B176), (A)+(B36)+(B177), (A)+(B36)+(B178), (A)+(B36)+(B179), (A)+(B36)+(B180), (A)+(B36)+(B181), (A)+(B36)+(B182), (A)+(B36)+(B183), (A)+(B36)+(B184), (A)+(B36)+(B185), (A)+(B36)+(B186), (A)+(B36)+(B187), (A)+(B36)+(B188), (A)+(B36)+(B189), (A)+(B36)+(B190), (A)+(B36)+(B191), (A)+(B36)+(B192), (A)+(B36)+(B193), (A)+(B36)+(B194), (A)+(B36)+(B195), (A)+(B36)+(B196), (A)+(B36)+(B197), (A)+(B36)+(B198), (A)+(B36)+(B199), (A)+(B36)+(B200), (A)+(B36)+(B201), (A)+(B36)+(B202), (A)+(B36)+(B203), (A)+(B36)+(B204), (A)+(B36)+(B205), (A)+(B36)+(B206), (A)+(B36)+(B207), (A)+(B36)+(B208), (A)+(B36)+(B209), (A)+(B36)+(B210), (A)+(B36)+(B211), (A)+(B36)+(B212), (A)+(B36)+(B213), (A)+(B36)+(B214), (A)+(B36)+(B215), (A)+(B36)+(B216), (A)+(B36)+(B217), (A)+(B36)+(B218), (A)+(B36)+(B219), (A)+(B36)+(B220), (A)+(B36)+(B221), (A)+(B36)+(B222), (A)+(B36)+(B223), (A)+(B36)+(B224), (A)+(B36)+(B225), (A)+(B36)+(B226), (A)+(B36)+(B227), (A)+(B36)+(B228), (A)+(B36)+(B229), (A)+(B36)+(B230), (A)+(B36)+(B231), (A)+(B36)+(B232), (A)+(B36)+(B233), (A)+(B36)+(B234), (A)+(B36)+(B235), (A)+(B36)+(B236), (A)+(B36)+(B237), (A)+(B36)+(B238), (A)+(B36)+(B239), (A)+(B36)+(B240), (A)+(B36)+(B241), (A)+(B36)+(B242), (A)+(B36)+(B243), (A)+(B36)+(B244), (A)+(B36)+(B245), (A)+(B36)+(B246), (A)+(B36)+(B247), (A)+(B36)+(B248), (A)+(B36)+(B249), (A)+(B36)+(B250), (A)+(B36)+(B251), (A)+(B36)+(B252), (A)+(B36)+(B253), (A)+(B36)+(B254), (A)+(B36)+(B255), (A)+(B36)+(B256), (A)+(B36)+(B257), (A)+(B36)+(B258), (A)+(B36)+(B259), (A)+(B36)+(B260), (A)+(B36)+(B261), (A)+(B36)+(B262), (A)+(B36)+(B263), (A)+(B36)+(B264), (A)+(B36)+(B265), (A)+(B36)+(B266), (A)+(B36)+(B267), (A)+(B36)+(B268), (A)+(B36)+(B269), (A)+(B36)+(B270), (A)+(B36)+(B271), (A)+(B36)+(B272), (A)+(B36)+(B273), (A)+(B36)+(B274), (A)+(B36)+(B275), (A)+(B36)+(B276), (A)+(B36)+(B277), (A)+(B36)+(B278), (A)+(B36)+(B279), (A)+(B36)+(B280), (A)+(B36)+(B281), (A)+(B36)+(B282), (A)+(B36)+(B283), (A)+(B36)+(B284), (A)+(B36)+(B285), (A)+(B36)+(B286), (A)+(B36)+(B287), (A)+(B36)+(B288), (A)+(B36)+(B289), (A)+(B36)+(B290), (A)+(B36)+(B291), (A)+(B36)+(B292), (A)+(B36)+(B293), (A)+(B36)+(B294), (A)+(B36)+(B295), (A)+(B36)+(B296), (A)+(B36)+(B297), (A)+(B36)+(B298), (A)+(B36)+(B299), (A)+(B36)+(B300), (A)+(B36)+(B301), (A)+(B36)+(B302), (A)+(B36)+(B303), (A)+(B36)+(B304), (A)+(B36)+(B305), (A)+(B36)+(B306), (A)+(B36)+(B307), (A)+(B36)+(B308), (A)+(B36)+(B309), (A)+(B36)+(B310), (A)+(B36)+(B311), (A)+(B36)+(B312), (A)+(B36)+(B313), (A)+(B36)+(B314), (A)+(B36)+(B315),

(A)+(B37)+(B38), (A)+(B37)+(B39), (A)+(B37)+(B40), (A)+(B37)+(B41), (A)+(B37)+(B42), (A)+(B37)+(B43), (A)+(B37)+(B44), (A)+(B37)+(B45), (A)+(B37)+(B46), (A)+(B37)+(B47), (A)+(B37)+(B48), (A)+(B37)+(B49), (A)+(B37)+(B50), (A)+(B37)+(B51), (A)+(B37)+(B52), (A)+(B37)+(B53), (A)+(B37)+(B54), (A)+(B37)+(B55), (A)+(B37)+(B56), (A)+(B37)+(B57), (A)+(B37)+(B58), (A)+(B37)+(B59), (A)+(B37)+(B60), (A)+(B37)+(B61), (A)+(B37)+(B62), (A)+(B37)+(B63), (A)+(B37)+(B64), (A)+(B37)+(B65), (A)+(B37)+(B66), (A)+(B37)+(B67), (A)+(B37)+(B68), (A)+(B37)+(B69), (A)+(B37)+(B70), (A)+(B37)+(B71), (A)+(B37)+(B72), (A)+(B37)+(B73), (A)+(B37)+(B74), (A)+(B37)+(B75), (A)+(B37)+(B76), (A)+(B37)+(B77), (A)+(B37)+(B78), (A)+(B37)+(B79), (A)+(B37)+(B80), (A)+(B37)+(B81), (A)+(B37)+(B82), (A)+(B37)+(B83), (A)+(B37)+(B84), (A)+(B37)+(B85), (A)+(B37)+(B86), (A)+(B37)+(B87), (A)+(B37)+(B88), (A)+(B37)+(B89), (A)+(B37)+(B90), (A)+(B37)+(B91), (A)+(B37)+(B92), (A)+(B37)+(B93), (A)+(B37)+(B94), (A)+(B37)+(B95), (A)+(B37)+(B96), (A)+(B37)+(B97), (A)+(B37)+(B98), (A)+(B37)+(B99), (A)+(B37)+(B100), (A)+(B37)+(B101), (A)+(B37)+(B102), (A)+(B37)+(B103), (A)+(B37)+(B104), (A)+(B37)+(B105), (A)+(B37)+(B106), (A)+(B37)+(B107), (A)+(B37)+(B108), (A)+(B37)+(B109), (A)+(B37)+(B110), (A)+(B37)+(B111), (A)+(B37)+(B112), (A)+(B37)+(B113), (A)+(B37)+(B114), (A)+(B37)+(B115), (A)+(B37)+(B116), (A)+(B37)+(B117), (A)+(B37)+(B118), (A)+(B37)+(B119), (A)+(B37)+(B120), (A)+(B37)+(B121), (A)+(B37)+(B122), (A)+(B37)+(B123), (A)+(B37)+(B124), (A)+(B37)+(B125), (A)+(B37)+(B126), (A)+(B37)+(B127), (A)+(B37)+(B128), (A)+(B37)+(B129), (A)+(B37)+(B130), (A)+(B37)+(B131), (A)+(B37)+(B132), (A)+(B37)+(B133), (A)+(B37)+(B134), (A)+(B37)+(B135), (A)+(B37)+(B136), (A)+(B37)+(B137), (A)+(B37)+(B138), (A)+(B37)+(B139), (A)+(B37)+(B140), (A)+(B37)+(B141), (A)+(B37)+(B142), (A)+(B37)+(B143), (A)+(B37)+(B144), (A)+(B37)+(B145), (A)+(B37)+(B146), (A)+(B37)+(B147), (A)+(B37)+(B148), (A)+(B37)+(B149), (A)+(B37)+(B150), (A)+(B37)+(B151), (A)+(B37)+(B152), (A)+(B37)+(B153), (A)+(B37)+(B154), (A)+(B37)+(B155), (A)+(B37)+(B156), (A)+(B37)+(B157), (A)+(B37)+(B158), (A)+(B37)+(B159), (A)+(B37)+(B160), (A)+(B37)+(B161), (A)+(B37)+(B162), (A)+(B37)+(B164), (A)+(B37)+(B164), (A)+(B37)+(B165), (A)+(B37)+(B166), (A)+(B37)+(B167), (A)+(B37)+(B168), (A)+(B37)+(B169), (A)+(B37)+(B170), (A)+(B37)+(B171), (A)+(B37)+(B172), (A)+(B37)+(B173), (A)+(B37)+(B174), (A)+(B37)+(B175), (A)+(B37)+(B176), (A)+(B37)+(B177), (A)+(B37)+(B178), (A)+(B37)+(B179), (A)+(B37)+(B180), (A)+(B37)+(B181), (A)+(B37)+(B182), (A)+(B37)+(B183), (A)+(B37)+(B184), (A)+(B37)+(B185), (A)+(B37)+(B186), (A)+(B37)+(B187), (A)+(B37)+(B188), (A)+(B37)+(B189), (A)+(B37)+(B190), (A)+(B37)+(B191), (A)+(B37)+(B192), (A)+(B37)+(B193), (A)+(B37)+(B194), (A)+(B37)+(B195), (A)+(B37)+(B196), (A)+(B37)+(B197), (A)+(B37)+(B198), (A)+(B37)+(B199), (A)+(B37)+(B200), (A)+(B37)+(B201), (A)+(B37)+(B202), (A)+(B37)+(B203), (A)+(B37)+(B204), (A)+(B37)+(B205), (A)+(B37)+(B206), (A)+(B37)+(B207), (A)+(B37)+(B208), (A)+(B37)+(B209), (A)+(B37)+(B210), (A)+(B37)+(B211), (A)+(B37)+(B212), (A)+(B37)+(B213), (A)+(B37)+(B214), (A)+(B37)+(B215), (A)+(B37)+(B216), (A)+(B37)+(B217), (A)+(B37)+(B218), (A)+(B37)+(B219), (A)+(B37)+(B220), (A)+(B37)+(B221), (A)+(B37)+(B222), (A)+(B37)+(B223), (A)+(B37)+(B224), (A)+(B37)+(B225), (A)+(B37)+(B226), (A)+(B37)+(B227), (A)+(B37)+(B228), (A)+(B37)+(B229), (A)+(B37)+(B230), (A)+(B37)+(B231), (A)+(B37)+(B232), (A)+(B37)+(B233), (A)+(B37)+(B234), (A)+(B37)+(B235), (A)+(B37)+(B236), (A)+(B37)+(B237), (A)+(B37)+(B238), (A)+(B37)+(B239), (A)+(B37)+(B240), (A)+(B37)+(B241), (A)+(B37)+(B242), (A)+(B37)+(B243), (A)+(B37)+(B244), (A)+(B37)+(B245), (A)+(B37)+(B246), (A)+(B37)+(B247), (A)+(B37)+(B248), (A)+(B37)+(B249), (A)+(B37)+(B250), (A)+(B37)+(B251), (A)+(B37)+(B252), (A)+(B37)+(B253), (A)+(B37)+(B254), (A)+(B37)+(B255), (A)+(B37)+(B256), (A)+(B37)+(B257), (A)+(B37)+(B258), (A)+(B37)+(B259), (A)+(B37)+(B260), (A)+(B37)+(B261), (A)+(B37)+(B262), (A)+(B37)+(B263), (A)+(B37)+(B264), (A)+(B37)+(B265), (A)+(B37)+(B266), (A)+(B37)+(B267), (A)+(B37)+(B268), (A)+(B37)+(B269), (A)+(B37)+(B270), (A)+(B37)+(B271), (A)+(B37)+(B272), (A)+(B37)+(B273), (A)+(B37)+(B274), (A)+(B37)+(B275), (A)+(B37)+(B276), (A)+(B37)+(B277), (A)+(B37)+(B278), (A)+(B37)+(B279), (A)+(B37)+(B280), (A)+(B37)+(B281), (A)+(B37)+(B282), (A)+(B37)+(B283), (A)+(B37)+(B284), (A)+(B37)+(B285), (A)+(B37)+(B286), (A)+(B37)+(B287), (A)+(B37)+(B288), (A)+(B37)+(B289), (A)+(B37)+(B290), (A)+(B37)+(B291), (A)+(B37)+(B292), (A)+(B37)+(B293), (A)+(B37)+(B294), (A)+(B37)+(B295), (A)+(B37)+(B296), (A)+(B37)+(B297), (A)+(B37)+(B298), (A)+(B37)+(B299), (A)+(B37)+(B300), (A)+(B37)+(B301), (A)+(B37)+(B302), (A)+(B37)+(B303), (A)+(B37)+(B304), (A)+(B37)+(B305), (A)+(B37)+(B306), (A)+(B37)+(B307), (A)+(B37)+(B308), (A)+(B37)+(B309), (A)+(B37)+(B310), (A)+(B37)+(B311), (A)+(B37)+(B312), (A)+(B37)+(B313), (A)+(B37)+(B314), (A)+(B37)+(B315),

(A)+(B38)+(B39), (A)+(B38)+(B40), (A)+(B38)+(B41), (A)+(B38)+(B42), (A)+(B38)+(B43), (A)+(B38)+(B44), (A)+(B38)+(B45), (A)+(B38)+(B46), (A)+(B38)+(B47), (A)+(B38)+(B48), (A)+(B38)+(B49), (A)+(B38)+(B50), (A)+(B38)+(B51), (A)+(B38)+(B52), (A)+(B38)+(B53), (A)+(B38)+(B54), (A)+(B38)+(B55), (A)+(B38)+(B56), (A)+(B38)+(B57), (A)+(B38)+(B58), (A)+(B38)+(B59), (A)+(B38)+(B60), (A)+(B38)+(B61), (A)+(B38)+(B62), (A)+(B38)+(B63), (A)+(B38)+(B64), (A)+(B38)+(B65), (A)+(B38)+(B66), (A)+(B38)+(B67), (A)+(B38)+(B68), (A)+(B38)+(B69), (A)+(B38)+(B70), (A)+(B38)+(B71), (A)+(B38)+(B72), (A)+(B38)+(B73), (A)+(B38)+(B74), (A)+(B38)+(B75), (A)+(B38)+(B76), (A)+(B38)+(B77), (A)+(B38)+(B78), (A)+(B38)+(B79), (A)+(B38)+(B80), (A)+(B38)+(B81), (A)+(B38)+(B82), (A)+(B38)+(B83), (A)+(B38)+(B84), (A)+(B38)+(B85), (A)+(B38)+(B86), (A)+(B38)+(B87), (A)+(B38)+(B88), (A)+(B38)+(B89), (A)+(B38)+(B90), (A)+(B38)+(B91), (A)+(B38)+(B92), (A)+(B38)+(B93), (A)+(B38)+(B94), (A)+(B38)+(B95), (A)+(B38)+(B96), (A)+(B38)+(B97), (A)+(B38)+(B98), (A)+(B38)+(B99), (A)+(B38)+(B100), (A)+(B38)+(B101), (A)+(B38)+(B102), (A)+(B38)+(B103), (A)+(B38)+(B104), (A)+(B38)+(B105), (A)+(B38)+(B106), (A)+(B38)+(B107), (A)+(B38)+(B108), (A)+(B38)+(B109), (A)+(B38)+(B110), (A)+(B38)+(B111), (A)+(B38)+(B112), (A)+(B38)+(B113), (A)+(B38)+(B114), (A)+(B38)+(B115), (A)+(B38)+(B116), (A)+(B38)+(B117), (A)+(B38)+(B118), (A)+(B38)+(B119), (A)+(B38)+(B120), (A)+(B38)+(B121), (A)+(B38)+(B122), (A)+(B38)+(B123), (A)+(B38)+(B124), (A)+(B38)+(B125), (A)+(B38)+(B126), (A)+(B38)+(B127), (A)+(B38)+(B128), (A)+(B38)+(B129), (A)+(B38)+(B130), (A)+(B38)+(B131), (A)+(B38)+(B132), (A)+(B38)+(B133), (A)+(B38)+(B134), (A)+(B38)+(B135), (A)+(B38)+(B136), (A)+(B38)+(B137), (A)+(B38)+(B138), (A)+(B38)+(B139), (A)+(B38)+(B140), (A)+(B38)+(B141), (A)+(B38)+(B142), (A)+(B38)+(B143), (A)+(B38)+(B144), (A)+(B38)+(B145), (A)+(B38)+(B146), (A)+(B38)+(B147), (A)+(B38)+(B148), (A)+(B38)+(B149), (A)+(B38)+(B150), (A)+(B38)+(B151), (A)+(B38)+(B152), (A)+(B38)+(B153), (A)+(B38)+(B154), (A)+(B38)+(B155), (A)+(B38)+(B156), (A)+(B38)+(B157), (A)+(B38)+(B158), (A)+(B38)+(B159), (A)+(B38)+(B160), (A)+(B38)+(B161), (A)+(B38)+(B162), (A)+(B38)+(B164), (A)+(B38)+(B164), (A)+(B38)+(B165), (A)+(B38)+(B166), (A)+(B38)+(B167), (A)+(B38)+(B168), (A)+(B38)+(B169), (A)+(B38)+(B170), (A)+(B38)+(B171), (A)+(B38)+(B172), (A)+(B38)+(B173), (A)+(B38)+(B174), (A)+(B38)+(B175), (A)+(B38)+(B176), (A)+(B38)+(B177), (A)+(B38)+(B178), (A)+(B38)+(B179), (A)+(B38)+(B180), (A)+(B38)+(B181), (A)+(B38)+(B182), (A)+(B38)+(B183), (A)+(B38)+(B184), (A)+(B38)+(B185), (A)+(B38)+(B186), (A)+(B38)+(B187), (A)+(B38)+(B188), (A)+(B38)+(B189), (A)+(B38)+(B190), (A)+(B38)+(B191), (A)+(B38)+(B192), (A)+(B38)+(B193), (A)+(B38)+(B194), (A)+(B38)+(B195), (A)+(B38)+(B196), (A)+(B38)+(B197), (A)+(B38)+(B198), (A)+(B38)+(B199), (A)+(B38)+(B200), (A)+(B38)+(B201), (A)+(B38)+(B202), (A)+(B38)+(B203), (A)+(B38)+(B204), (A)+(B38)+(B205), (A)+(B38)+(B206), (A)+(B38)+(B207), (A)+(B38)+(B208), (A)+(B38)+(B209), (A)+(B38)+(B210), (A)+(B38)+(B211), (A)+(B38)+(B212), (A)+(B38)+(B213), (A)+(B38)+(B214), (A)+(B38)+(B215), (A)+(B38)+(B216), (A)+(B38)+(B217), (A)+(B38)+(B218), (A)+(B38)+(B219), (A)+(B38)+(B220), (A)+(B38)+(B221), (A)+(B38)+(B222), (A)+(B38)+(B223), (A)+(B38)+(B224), (A)+(B38)+(B225), (A)+(B38)+(B226), (A)+(B38)+(B227), (A)+(B38)+(B228), (A)+(B38)+(B229), (A)+(B38)+(B230), (A)+(B38)+(B231), (A)+(B38)+(B232), (A)+(B38)+(B233), (A)+(B38)+(B234), (A)+(B38)+(B235), (A)+(B38)+(B236), (A)+(B38)+(B237), (A)+(B38)+(B238), (A)+(B38)+(B239), (A)+(B38)+(B240), (A)+(B38)+(B241), (A)+(B38)+(B242), (A)+(B38)+(B243), (A)+(B38)+(B244), (A)+(B38)+(B245), (A)+(B38)+(B246), (A)+(B38)+(B247), (A)+(B38)+(B248), (A)+(B38)+(B249), (A)+(B38)+(B250), (A)+(B38)+(B251), (A)+(B38)+(B252), (A)+(B38)+(B253), (A)+(B38)+(B254), (A)+(B38)+(B255), (A)+(B38)+(B256), (A)+(B38)+(B257), (A)+(B38)+(B258), (A)+(B38)+(B259), (A)+(B38)+(B260), (A)+(B38)+(B261), (A)+(B38)+(B262), (A)+(B38)+(B263), (A)+(B38)+(B264), (A)+(B38)+(B265), (A)+(B38)+(B266), (A)+(B38)+(B267), (A)+(B38)+(B268), (A)+(B38)+(B269), (A)+(B38)+(B270), (A)+(B38)+(B271), (A)+(B38)+(B272), (A)+(B38)+(B273), (A)+(B38)+(B274), (A)+(B38)+(B275), (A)+(B38)+(B276), (A)+(B38)+(B277), (A)+(B38)+(B278), (A)+(B38)+(B279), (A)+(B38)+(B280), (A)+(B38)+(B281), (A)+(B38)+(B282), (A)+(B38)+(B283), (A)+(B38)+(B284), (A)+(B38)+(B285), (A)+(B38)+(B286), (A)+(B38)+(B287), (A)+(B38)+(B288), (A)+(B38)+(B289), (A)+(B38)+(B290), (A)+(B38)+(B291), (A)+(B38)+(B292), (A)+(B38)+(B293), (A)+(B38)+(B294), (A)+(B38)+(B295), (A)+(B38)+(B296), (A)+(B38)+(B297), (A)+(B38)+(B298), (A)+(B38)+(B299), (A)+(B38)+(B300), (A)+(B38)+(B301), (A)+(B38)+(B302), (A)+(B38)+(B303), (A)+(B38)+(B304), (A)+(B38)+(B305), (A)+(B38)+(B306), (A)+(B38)+(B307), (A)+(B38)+(B308), (A)+(B38)+(B309), (A)+(B38)+(B310), (A)+(B38)+(B311), (A)+(B38)+(B312), (A)+(B38)+(B313), (A)+(B38)+(B314), (A)+(B38)+(B315),

(A)+(B39)+(B40), (A)+(B39)+(B41), (A)+(B39)+(B42), (A)+(B39)+(B43), (A)+(B39)+(B44), (A)+(B39)+(B45), (A)+(B39)+(B46), (A)+(B39)+(B47), (A)+(B39)+(B48), (A)+(B39)+(B49), (A)+(B39)+(B50), (A)+(B39)+(B51), (A)+(B39)+(B52), (A)+(B39)+(B53), (A)+(B39)+(B54), (A)+(B39)+(B55), (A)+(B39)+(B56), (A)+(B39)+(B57), (A)+(B39)+(B58), (A)+(B39)+(B59), (A)+(B39)+(B60), (A)+(B39)+(B61), (A)+(B39)+(B62), (A)+(B39)+(B63), (A)+(B39)+(B64), (A)+(B39)+(B65), (A)+(B39)+(B66), (A)+(B39)+(B67), (A)+(B39)+(B68), (A)+(B39)+(B69), (A)+(B39)+(B70), (A)+(B39)+(B71), (A)+(B39)+(B72), (A)+(B39)+(B73), (A)+(B39)+(B74), (A)+(B39)+(B75), (A)+(B39)+(B76), (A)+(B39)+(B77), (A)+(B39)+(B78), (A)+(B39)+(B79), (A)+(B39)+(B80), (A)+(B39)+(B81), (A)+(B39)+(B82), (A)+(B39)+(B83), (A)+(B39)+(B84), (A)+(B39)+(B85), (A)+(B39)+(B86), (A)+(B39)+(B87), (A)+(B39)+(B88), (A)+(B39)+(B89), (A)+(B39)+(B90), (A)+(B39)+(B91), (A)+(B39)+(B92), (A)+(B39)+(B93), (A)+(B39)+(B94), (A)+(B39)+(B95), (A)+(B39)+(B96), (A)+(B39)+(B97), (A)+(B39)+(B98), (A)+(B39)+(B99), (A)+(B39)+(B100), (A)+(B39)+(B101), (A)+(B39)+(B102), (A)+(B39)+(B103), (A)+(B39)+(B104), (A)+(B39)+(B105), (A)+(B39)+(B106), (A)+(B39)+(B107), (A)+(B39)+(B108), (A)+(B39)+(B109), (A)+(B39)+(B110), (A)+(B39)+(B111), (A)+(B39)+(B112), (A)+(B39)+(B113), (A)+(B39)+(B114), (A)+(B39)+(B115), (A)+(B39)+(B116), (A)+(B39)+(B117), (A)+(B39)+(B118), (A)+(B39)+(B119), (A)+(B39)+(B120), (A)+(B39)+(B121), (A)+(B39)+(B122), (A)+(B39)+(B123), (A)+(B39)+(B124), (A)+(B39)+(B125), (A)+(B39)+(B126), (A)+(B39)+(B127), (A)+(B39)+(B128), (A)+(B39)+(B129), (A)+(B39)+(B130), (A)+(B39)+(B131), (A)+(B39)+(B132), (A)+(B39)+(B133), (A)+(B39)+(B134), (A)+(B39)+(B135), (A)+(B39)+(B136), (A)+(B39)+(B137), (A)+(B39)+(B138), (A)+(B39)+(B139), (A)+(B39)+(B140), (A)+(B39)+(B141), (A)+(B39)+(B142), (A)+(B39)+(B143), (A)+(B39)+(B144), (A)+(B39)+(B145), (A)+(B39)+(B146), (A)+(B39)+(B147), (A)+(B39)+(B148), (A)+(B39)+(B149), (A)+(B39)+(B150), (A)+(B39)+(B151), (A)+(B39)+(B152), (A)+(B39)+(B153), (A)+(B39)+(B154), (A)+(B39)+(B155), (A)+(B39)+(B156), (A)+(B39)+(B157), (A)+(B39)+(B158), (A)+(B39)+(B159), (A)+(B39)+(B160), (A)+(B39)+(B161), (A)+(B39)+(B162), (A)+(B39)+(B164), (A)+(B39)+(B164), (A)+(B39)+(B165), (A)+(B39)+(B166), (A)+(B39)+(B167), (A)+(B39)+(B168), (A)+(B39)+(B169), (A)+(B39)+(B170), (A)+(B39)+(B171), (A)+(B39)+(B172), (A)+(B39)+(B173), (A)+(B39)+(B174), (A)+(B39)+(B175), (A)+(B39)+(B176), (A)+(B39)+(B177), (A)+(B39)+(B178), (A)+(B39)+(B179), (A)+(B39)+(B180), (A)+(B39)+(B181), (A)+(B39)+(B182), (A)+(B39)+(B183), (A)+(B39)+(B184), (A)+(B39)+(B185), (A)+(B39)+(B186), (A)+(B39)+(B187), (A)+(B39)+(B188), (A)+(B39)+(B189), (A)+(B39)+(B190), (A)+(B39)+(B191), (A)+(B39)+(B192), (A)+(B39)+(B193), (A)+(B39)+(B194), (A)+(B39)+(B195), (A)+(B39)+(B196), (A)+(B39)+(B197), (A)+(B39)+(B198), (A)+(B39)+(B199), (A)+(B39)+(B200), (A)+(B39)+(B201), (A)+(B39)+(B202), (A)+(B39)+(B203), (A)+(B39)+(B204), (A)+(B39)+(B205), (A)+(B39)+(B206), (A)+(B39)+(B207), (A)+(B39)+(B208), (A)+(B39)+(B209), (A)+(B39)+(B210), (A)+(B39)+(B211), (A)+(B39)+(B212), (A)+(B39)+(B213), (A)+(B39)+(B214), (A)+(B39)+(B215), (A)+(B39)+(B216), (A)+(B39)+(B217), (A)+(B39)+(B218), (A)+(B39)+(B219), (A)+(B39)+(B220), (A)+(B39)+(B221), (A)+(B39)+(B222), (A)+(B39)+(B223), (A)+(B39)+(B224), (A)+(B39)+(B225), (A)+(B39)+(B226), (A)+(B39)+(B227), (A)+(B39)+(B228), (A)+(B39)+(B229), (A)+(B39)+(B230), (A)+(B39)+(B231), (A)+(B39)+(B232), (A)+(B39)+(B233), (A)+(B39)+(B234), (A)+(B39)+(B235), (A)+(B39)+(B236), (A)+(B39)+(B237), (A)+(B39)+(B238), (A)+(B39)+(B239), (A)+(B39)+(B240), (A)+(B39)+(B241), (A)+(B39)+(B242), (A)+(B39)+(B243), (A)+(B39)+(B244), (A)+(B39)+(B245), (A)+(B39)+(B246), (A)+(B39)+(B247), (A)+(B39)+(B248), (A)+(B39)+(B249), (A)+(B39)+(B250), (A)+(B39)+(B251), (A)+(B39)+(B252), (A)+(B39)+(B253), (A)+(B39)+(B254), (A)+(B39)+(B255), (A)+(B39)+(B256), (A)+(B39)+(B257), (A)+(B39)+(B258), (A)+(B39)+(B259), (A)+(B39)+(B260), (A)+(B39)+(B261), (A)+(B39)+(B262), (A)+(B39)+(B263), (A)+(B39)+(B264), (A)+(B39)+(B265), (A)+(B39)+(B266), (A)+(B39)+(B267), (A)+(B39)+(B268), (A)+(B39)+(B269), (A)+(B39)+(B270), (A)+(B39)+(B271), (A)+(B39)+(B272), (A)+(B39)+(B273), (A)+(B39)+(B274), (A)+(B39)+(B275), (A)+(B39)+(B276), (A)+(B39)+(B277), (A)+(B39)+(B278), (A)+(B39)+(B279), (A)+(B39)+(B280), (A)+(B39)+(B281), (A)+(B39)+(B282), (A)+(B39)+(B283), (A)+(B39)+(B284), (A)+(B39)+(B285), (A)+(B39)+(B286), (A)+(B39)+(B287), (A)+(B39)+(B288), (A)+(B39)+(B289), (A)+(B39)+(B290), (A)+(B39)+(B291), (A)+(B39)+(B292), (A)+(B39)+(B293), (A)+(B39)+(B294), (A)+(B39)+(B295), (A)+(B39)+(B296), (A)+(B39)+(B297), (A)+(B39)+(B298), (A)+(B39)+(B299), (A)+(B39)+(B300), (A)+(B39)+(B301), (A)+(B39)+(B302), (A)+(B39)+(B303), (A)+(B39)+(B304), (A)+(B39)+(B305), (A)+(B39)+(B306), (A)+(B39)+(B307), (A)+(B39)+(B308), (A)+(B39)+(B309), (A)+(B39)+(B310), (A)+(B39)+(B311), (A)+(B39)+(B312), (A)+(B39)+(B313), (A)+(B39)+(B314), (A)+(B39)+(B315),

(A)+(B40)+(B41), (A)+(B40)+(B42), (A)+(B40)+(B43), (A)+(B40)+(B44), (A)+(B40)+(B45), (A)+(B40)+(B46), (A)+(B40)+(B47), (A)+(B40)+(B48), (A)+(B40)+(B49), (A)+(B40)+(B50), (A)+(B40)+(B51), (A)+(B40)+(B52), (A)+(B40)+(B53), (A)+(B40)+(B54), (A)+(B40)+(B55), (A)+(B40)+(B56), (A)+(B40)+(B57), (A)+(B40)+(B58), (A)+(B40)+(B59), (A)+(B40)+(B60), (A)+(B40)+(B61), (A)+(B40)+(B62), (A)+(B40)+(B63), (A)+(B40)+(B64), (A)+(B40)+(B65), (A)+(B40)+(B66), (A)+(B40)+(B67), (A)+(B40)+(B68), (A)+(B40)+(B69), (A)+(B40)+(B70), (A)+(B40)+(B71), (A)+(B40)+(B72), (A)+(B40)+(B73), (A)+(B40)+(B74), (A)+(B40)+(B75), (A)+(B40)+(B76), (A)+(B40)+(B77), (A)+(B40)+(B78), (A)+(B40)+(B79), (A)+(B40)+(B80), (A)+(B40)+(B81), (A)+(B40)+(B82), (A)+(B40)+(B83), (A)+(B40)+(B84), (A)+(B40)+(B85), (A)+(B40)+(B86), (A)+(B40)+(B87), (A)+(B40)+(B88), (A)+(B40)+(B89), (A)+(B40)+(B90), (A)+(B40)+(B91), (A)+(B40)+(B92), (A)+(B40)+(B93), (A)+(B40)+(B94), (A)+(B40)+(B95), (A)+(B40)+(B96), (A)+(B40)+(B97), (A)+(B40)+(B98), (A)+(B40)+(B99), (A)+(B40)+(B100), (A)+(B40)+(B101), (A)+(B40)+(B102), (A)+(B40)+(B103), (A)+(B40)+(B104), (A)+(B40)+(B105), (A)+(B40)+(B106), (A)+(B40)+(B107), (A)+(B40)+(B108), (A)+(B40)+(B109), (A)+(B40)+(B110), (A)+(B40)+(B111), (A)+(B40)+(B112), (A)+(B40)+(B113), (A)+(B40)+(B114), (A)+(B40)+(B115), (A)+(B40)+(B116), (A)+(B40)+(B117), (A)+(B40)+(B118), (A)+(B40)+(B119), (A)+(B40)+(B120), (A)+(B40)+(B121), (A)+(B40)+(B122), (A)+(B40)+(B123), (A)+(B40)+(B124), (A)+(B40)+(B125), (A)+(B40)+(B126), (A)+(B40)+(B127), (A)+(B40)+(B128), (A)+(B40)+(B129), (A)+(B40)+(B130), (A)+(B40)+(B131), (A)+(B40)+(B132), (A)+(B40)+(B133), (A)+(B40)+(B134), (A)+(B40)+(B135), (A)+(B40)+(B136), (A)+(B40)+(B137), (A)+(B40)+(B138), (A)+(B40)+(B139), (A)+(B40)+(B140), (A)+(B40)+(B141), (A)+(B40)+(B142), (A)+(B40)+(B143), (A)+(B40)+(B144), (A)+(B40)+(B145), (A)+(B40)+(B146), (A)+(B40)+(B147), (A)+(B40)+(B148), (A)+(B40)+(B149), (A)+(B40)+(B150), (A)+(B40)+(B151), (A)+(B40)+(B152), (A)+(B40)+(B153), (A)+(B40)+(B154), (A)+(B40)+(B155), (A)+(B40)+(B156), (A)+(B40)+(B157), (A)+(B40)+(B158), (A)+(B40)+(B159), (A)+(B40)+(B160), (A)+(B40)+(B161), (A)+(B40)+(B162), (A)+(B40)+(B164), (A)+(B40)+(B164), (A)+(B40)+(B165), (A)+(B40)+(B166), (A)+(B40)+(B167), (A)+(B40)+(B168), (A)+(B40)+(B169), (A)+(B40)+(B170), (A)+(B40)+(B171), (A)+(B40)+(B172), (A)+(B40)+(B173), (A)+(B40)+(B174), (A)+(B40)+(B175), (A)+(B40)+(B176), (A)+(B40)+(B177), (A)+(B40)+(B178), (A)+(B40)+(B179), (A)+(B40)+(B180), (A)+(B40)+(B181), (A)+(B40)+(B182), (A)+(B40)+(B183), (A)+(B40)+(B184), (A)+(B40)+(B185), (A)+(B40)+(B186), (A)+(B40)+(B187), (A)+(B40)+(B188), (A)+(B40)+(B189), (A)+(B40)+(B190), (A)+(B40)+(B191), (A)+(B40)+(B192), (A)+(B40)+(B193), (A)+(B40)+(B194), (A)+(B40)+(B195), (A)+(B40)+(B196), (A)+(B40)+(B197), (A)+(B40)+(B198), (A)+(B40)+(B199), (A)+(B40)+(B200), (A)+(B40)+(B201), (A)+(B40)+(B202), (A)+(B40)+(B203), (A)+(B40)+(B204), (A)+(B40)+(B205), (A)+(B40)+(B206), (A)+(B40)+(B207), (A)+(B40)+(B208), (A)+(B40)+(B209), (A)+(B40)+(B210), (A)+(B40)+(B211), (A)+(B40)+(B212), (A)+(B40)+(B213), (A)+(B40)+(B214), (A)+(B40)+(B215), (A)+(B40)+(B216), (A)+(B40)+(B217), (A)+(B40)+(B218), (A)+(B40)+(B219), (A)+(B40)+(B220), (A)+(B40)+(B221), (A)+(B40)+(B222), (A)+(B40)+(B223), (A)+(B40)+(B224), (A)+(B40)+(B225), (A)+(B40)+(B226), (A)+(B40)+(B227), (A)+(B40)+(B228), (A)+(B40)+(B229), (A)+(B40)+(B230), (A)+(B40)+(B231), (A)+(B40)+(B232), (A)+(B40)+(B233), (A)+(B40)+(B234), (A)+(B40)+(B235), (A)+(B40)+(B236), (A)+(B40)+(B237), (A)+(B40)+(B238), (A)+(B40)+(B239), (A)+(B40)+(B240), (A)+(B40)+(B241), (A)+(B40)+(B242), (A)+(B40)+(B243), (A)+(B40)+(B244), (A)+(B40)+(B245), (A)+(B40)+(B246), (A)+(B40)+(B247), (A)+(B40)+(B248), (A)+(B40)+(B249), (A)+(B40)+(B250), (A)+(B40)+(B251), (A)+(B40)+(B252), (A)+(B40)+(B253), (A)+(B40)+(B254), (A)+(B40)+(B255), (A)+(B40)+(B256), (A)+(B40)+(B257), (A)+(B40)+(B258), (A)+(B40)+(B259), (A)+(B40)+(B260), (A)+(B40)+(B261), (A)+(B40)+(B262), (A)+(B40)+(B263), (A)+(B40)+(B264), (A)+(B40)+(B265), (A)+(B40)+(B266), (A)+(B40)+(B267), (A)+(B40)+(B268), (A)+(B40)+(B269), (A)+(B40)+(B270), (A)+(B40)+(B271), (A)+(B40)+(B272), (A)+(B40)+(B273), (A)+(B40)+(B274), (A)+(B40)+(B275), (A)+(B40)+(B276), (A)+(B40)+(B277), (A)+(B40)+(B278), (A)+(B40)+(B279), (A)+(B40)+(B280), (A)+(B40)+(B281), (A)+(B40)+(B282), (A)+(B40)+(B283), (A)+(B40)+(B284), (A)+(B40)+(B285), (A)+(B40)+(B286), (A)+(B40)+(B287), (A)+(B40)+(B288), (A)+(B40)+(B289), (A)+(B40)+(B290), (A)+(B40)+(B291), (A)+(B40)+(B292), (A)+(B40)+(B293), (A)+(B40)+(B294), (A)+(B40)+(B295), (A)+(B40)+(B296), (A)+(B40)+(B297), (A)+(B40)+(B298), (A)+(B40)+(B299), (A)+(B40)+(B300), (A)+(B40)+(B301), (A)+(B40)+(B302), (A)+(B40)+(B303), (A)+(B40)+(B304), (A)+(B40)+(B305), (A)+(B40)+(B306), (A)+(B40)+(B307), (A)+(B40)+(B308), (A)+(B40)+(B309), (A)+(B40)+(B310), (A)+(B40)+(B311), (A)+(B40)+(B312), (A)+(B40)+(B313), (A)+(B40)+(B314), (A)+(B40)+(B315),

(A)+(B41)+(B42), (A)+(B41)+(B43), (A)+(B41)+(B44), (A)+(B41)+(B45), (A)+(B41)+(B46), (A)+(B41)+(B47), (A)+(B41)+(B48), (A)+(B41)+(B49), (A)+(B41)+(B50), (A)+(B41)+(B51), (A)+(B41)+(B52), (A)+(B41)+(B53), (A)+(B41)+(B54), (A)+(B41)+(B55), (A)+(B41)+(B56), (A)+(B41)+(B57), (A)+(B41)+(B58), (A)+(B41)+(B59), (A)+(B41)+(B60), (A)+(B41)+(B61), (A)+(B41)+(B62), (A)+(B41)+(B63), (A)+(B41)+(B64), (A)+(B41)+(B65), (A)+(B41)+(B66), (A)+(B41)+(B67), (A)+(B41)+(B68), (A)+(B41)+(B69), (A)+(B41)+(B70), (A)+(B41)+(B71), (A)+(B41)+(B72), (A)+(B41)+(B73), (A)+(B41)+(B74), (A)+(B41)+(B75), (A)+(B41)+(B76), (A)+(B41)+(B77), (A)+(B41)+(B78), (A)+(B41)+(B79), (A)+(B41)+(B80), (A)+(B41)+(B81), (A)+(B41)+(B82), (A)+(B41)+(B83), (A)+(B41)+(B84), (A)+(B41)+(B85), (A)+(B41)+(B86), (A)+(B41)+(B87), (A)+(B41)+(B88), (A)+(B41)+(B89), (A)+(B41)+(B90), (A)+(B41)+(B91), (A)+(B41)+(B92), (A)+(B41)+(B93), (A)+(B41)+(B94), (A)+(B41)+(B95), (A)+(B41)+(B96), (A)+(B41)+(B97), (A)+(B41)+(B98), (A)+(B41)+(B99), (A)+(B41)+(B100), (A)+(B41)+(B101), (A)+(B41)+(B102), (A)+(B41)+(B103), (A)+(B41)+(B104), (A)+(B41)+(B105), (A)+(B41)+(B106), (A)+(B41)+(B107), (A)+(B41)+(B108), (A)+(B41)+(B109), (A)+(B41)+(B110), (A)+(B41)+(B111), (A)+(B41)+(B112), (A)+(B41)+(B113), (A)+(B41)+(B114), (A)+(B41)+(B115), (A)+(B41)+(B116), (A)+(B41)+(B117), (A)+(B41)+(B118), (A)+(B41)+(B119), (A)+(B41)+(B120), (A)+(B41)+(B121), (A)+(B41)+(B122), (A)+(B41)+(B123), (A)+(B41)+(B124), (A)+(B41)+(B125), (A)+(B41)+(B126), (A)+(B41)+(B127), (A)+(B41)+(B128), (A)+(B41)+(B129), (A)+(B41)+(B130), (A)+(B41)+(B131), (A)+(B41)+(B132), (A)+(B41)+(B133), (A)+(B41)+(B134), (A)+(B41)+(B135), (A)+(B41)+(B136), (A)+(B41)+(B137), (A)+(B41)+(B138), (A)+(B41)+(B139), (A)+(B41)+(B140), (A)+(B41)+(B141), (A)+(B41)+(B142), (A)+(B41)+(B143), (A)+(B41)+(B144), (A)+(B41)+(B145), (A)+(B41)+(B146), (A)+(B41)+(B147), (A)+(B41)+(B148), (A)+(B41)+(B149), (A)+(B41)+(B150), (A)+(B41)+(B151), (A)+(B41)+(B152), (A)+(B41)+(B153), (A)+(B41)+(B154), (A)+(B41)+(B155), (A)+(B41)+(B156), (A)+(B41)+(B157), (A)+(B41)+(B158), (A)+(B41)+(B159), (A)+(B41)+(B160), (A)+(B41)+(B161), (A)+(B41)+(B162), (A)+(B41)+(B164), (A)+(B41)+(B164), (A)+(B41)+(B165), (A)+(B41)+(B166), (A)+(B41)+(B167), (A)+(B41)+(B168), (A)+(B41)+(B169), (A)+(B41)+(B170), (A)+(B41)+(B171), (A)+(B41)+(B172), (A)+(B41)+(B173), (A)+(B41)+(B174), (A)+(B41)+(B175), (A)+(B41)+(B176), (A)+(B41)+(B177), (A)+(B41)+(B178), (A)+(B41)+(B179), (A)+(B41)+(B180), (A)+(B41)+(B181), (A)+(B41)+(B182), (A)+(B41)+(B183), (A)+(B41)+(B184), (A)+(B41)+(B185), (A)+(B41)+(B186), (A)+(B41)+(B187), (A)+(B41)+(B188), (A)+(B41)+(B189), (A)+(B41)+(B190), (A)+(B41)+(B191), (A)+(B41)+(B192), (A)+(B41)+(B193), (A)+(B41)+(B194), (A)+(B41)+(B195), (A)+(B41)+(B196), (A)+(B41)+(B197), (A)+(B41)+(B198), (A)+(B41)+(B199), (A)+(B41)+(B200), (A)+(B41)+(B201), (A)+(B41)+(B202), (A)+(B41)+(B203), (A)+(B41)+(B204), (A)+(B41)+(B205), (A)+(B41)+(B206), (A)+(B41)+(B207), (A)+(B41)+(B208), (A)+(B41)+(B209), (A)+(B41)+(B210), (A)+(B41)+(B211), (A)+(B41)+(B212), (A)+(B41)+(B213), (A)+(B41)+(B214), (A)+(B41)+(B215), (A)+(B41)+(B216), (A)+(B41)+(B217), (A)+(B41)+(B218), (A)+(B41)+(B219), (A)+(B41)+(B220), (A)+(B41)+(B221), (A)+(B41)+(B222), (A)+(B41)+(B223), (A)+(B41)+(B224), (A)+(B41)+(B225), (A)+(B41)+(B226), (A)+(B41)+(B227), (A)+(B41)+(B228), (A)+(B41)+(B229), (A)+(B41)+(B230), (A)+(B41)+(B231), (A)+(B41)+(B232), (A)+(B41)+(B233), (A)+(B41)+(B234), (A)+(B41)+(B235), (A)+(B41)+(B236), (A)+(B41)+(B237), (A)+(B41)+(B238), (A)+(B41)+(B239), (A)+(B41)+(B240), (A)+(B41)+(B241), (A)+(B41)+(B242), (A)+(B41)+(B243), (A)+(B41)+(B244), (A)+(B41)+(B245), (A)+(B41)+(B246), (A)+(B41)+(B247), (A)+(B41)+(B248), (A)+(B41)+(B249), (A)+(B41)+(B250), (A)+(B41)+(B251), (A)+(B41)+(B252), (A)+(B41)+(B253), (A)+(B41)+(B254), (A)+(B41)+(B255), (A)+(B41)+(B256), (A)+(B41)+(B257), (A)+(B41)+(B258), (A)+(B41)+(B259), (A)+(B41)+(B260), (A)+(B41)+(B261), (A)+(B41)+(B262), (A)+(B41)+(B263), (A)+(B41)+(B264), (A)+(B41)+(B265), (A)+(B41)+(B266), (A)+(B41)+(B267), (A)+(B41)+(B268), (A)+(B41)+(B269), (A)+(B41)+(B270), (A)+(B41)+(B271), (A)+(B41)+(B272), (A)+(B41)+(B273), (A)+(B41)+(B274), (A)+(B41)+(B275), (A)+(B41)+(B276), (A)+(B41)+(B277), (A)+(B41)+(B278), (A)+(B41)+(B279), (A)+(B41)+(B280), (A)+(B41)+(B281), (A)+(B41)+(B282), (A)+(B41)+(B283), (A)+(B41)+(B284), (A)+(B41)+(B285), (A)+(B41)+(B286), (A)+(B41)+(B287), (A)+(B41)+(B288), (A)+(B41)+(B289), (A)+(B41)+(B290), (A)+(B41)+(B291), (A)+(B41)+(B292), (A)+(B41)+(B293), (A)+(B41)+(B294), (A)+(B41)+(B295), (A)+(B41)+(B296), (A)+(B41)+(B297), (A)+(B41)+(B298), (A)+(B41)+(B299), (A)+(B41)+(B300), (A)+(B41)+(B301), (A)+(B41)+(B302), (A)+(B41)+(B303), (A)+(B41)+(B304), (A)+(B41)+(B305), (A)+(B41)+(B306), (A)+(B41)+(B307), (A)+(B41)+(B308), (A)+(B41)+(B309), (A)+(B41)+(B310), (A)+(B41)+(B311), (A)+(B41)+(B312), (A)+(B41)+(B313), (A)+(B41)+(B314), (A)+(B41)+(B315),

(A)+(B42)+(B43), (A)+(B42)+(B44), (A)+(B42)+(B45), (A)+(B42)+(B46), (A)+(B42)+(B47), (A)+(B42)+(B48), (A)+(B42)+(B49), (A)+(B42)+(B50), (A)+(B42)+(B51), (A)+(B42)+(B52), (A)+(B42)+(B53), (A)+(B42)+(B54), (A)+(B42)+(B55), (A)+(B42)+(B56), (A)+(B42)+(B57), (A)+(B42)+(B58), (A)+(B42)+(B59), (A)+(B42)+(B60), (A)+(B42)+(B61), (A)+(B42)+(B62), (A)+(B42)+(B63), (A)+(B42)+(B64), (A)+(B42)+(B65), (A)+(B42)+(B66), (A)+(B42)+(B67), (A)+(B42)+(B68), (A)+(B42)+(B69), (A)+(B42)+(B70), (A)+(B42)+(B71), (A)+(B42)+(B72), (A)+(B42)+(B73), (A)+(B42)+(B74), (A)+(B42)+(B75), (A)+(B42)+(B76), (A)+(B42)+(B77), (A)+(B42)+(B78), (A)+(B42)+(B79), (A)+(B42)+(B80), (A)+(B42)+(B81), (A)+(B42)+(B82), (A)+(B42)+(B83), (A)+(B42)+(B84), (A)+(B42)+(B85), (A)+(B42)+(B86), (A)+(B42)+(B87), (A)+(B42)+(B88), (A)+(B42)+(B89), (A)+(B42)+(B90), (A)+(B42)+(B91), (A)+(B42)+(B92), (A)+(B42)+(B93), (A)+(B42)+(B94), (A)+(B42)+(B95), (A)+(B42)+(B96), (A)+(B42)+(B97), (A)+(B42)+(B98), (A)+(B42)+(B99), (A)+(B42)+(B100), (A)+(B42)+(B101), (A)+(B42)+(B102), (A)+(B42)+(B103), (A)+(B42)+(B104), (A)+(B42)+(B105), (A)+(B42)+(B106), (A)+(B42)+(B107), (A)+(B42)+(B108), (A)+(B42)+(B109), (A)+(B42)+(B110), (A)+(B42)+(B111), (A)+(B42)+(B112), (A)+(B42)+(B113), (A)+(B42)+(B114), (A)+(B42)+(B115), (A)+(B42)+(B116), (A)+(B42)+(B117), (A)+(B42)+(B118), (A)+(B42)+(B119), (A)+(B42)+(B120), (A)+(B42)+(B121), (A)+(B42)+(B122), (A)+(B42)+(B123), (A)+(B42)+(B124), (A)+(B42)+(B125), (A)+(B42)+(B126), (A)+(B42)+(B127), (A)+(B42)+(B128), (A)+(B42)+(B129), (A)+(B42)+(B130), (A)+(B42)+(B131), (A)+(B42)+(B132), (A)+(B42)+(B133), (A)+(B42)+(B134), (A)+(B42)+(B135), (A)+(B42)+(B136), (A)+(B42)+(B137), (A)+(B42)+(B138), (A)+(B42)+(B139), (A)+(B42)+(B140), (A)+(B42)+(B141), (A)+(B42)+(B142), (A)+(B42)+(B143), (A)+(B42)+(B144), (A)+(B42)+(B145), (A)+(B42)+(B146), (A)+(B42)+(B147), (A)+(B42)+(B148), (A)+(B42)+(B149), (A)+(B42)+(B150), (A)+(B42)+(B151), (A)+(B42)+(B152), (A)+(B42)+(B153), (A)+(B42)+(B154), (A)+(B42)+(B155), (A)+(B42)+(B156), (A)+(B42)+(B157), (A)+(B42)+(B158), (A)+(B42)+(B159), (A)+(B42)+(B160), (A)+(B42)+(B161), (A)+(B42)+(B162), (A)+(B42)+(B164), (A)+(B42)+(B164), (A)+(B42)+(B165), (A)+(B42)+(B166), (A)+(B42)+(B167), (A)+(B42)+(B168), (A)+(B42)+(B169), (A)+(B42)+(B170), (A)+(B42)+(B171), (A)+(B42)+(B172), (A)+(B42)+(B173), (A)+(B42)+(B174), (A)+(B42)+(B175), (A)+(B42)+(B176), (A)+(B42)+(B177), (A)+(B42)+(B178), (A)+(B42)+(B179), (A)+(B42)+(B180), (A)+(B42)+(B181), (A)+(B42)+(B182), (A)+(B42)+(B183), (A)+(B42)+(B184), (A)+(B42)+(B185), (A)+(B42)+(B186), (A)+(B42)+(B187), (A)+(B42)+(B188), (A)+(B42)+(B189), (A)+(B42)+(B190), (A)+(B42)+(B191), (A)+(B42)+(B192), (A)+(B42)+(B193), (A)+(B42)+(B194), (A)+(B42)+(B195), (A)+(B42)+(B196), (A)+(B42)+(B197), (A)+(B42)+(B198), (A)+(B42)+(B199), (A)+(B42)+(B200), (A)+(B42)+(B201), (A)+(B42)+(B202), (A)+(B42)+(B203), (A)+(B42)+(B204), (A)+(B42)+(B205), (A)+(B42)+(B206), (A)+(B42)+(B207), (A)+(B42)+(B208), (A)+(B42)+(B209), (A)+(B42)+(B210), (A)+(B42)+(B211), (A)+(B42)+(B212), (A)+(B42)+(B213), (A)+(B42)+(B214), (A)+(B42)+(B215), (A)+(B42)+(B216), (A)+(B42)+(B217), (A)+(B42)+(B218), (A)+(B42)+(B219), (A)+(B42)+(B220), (A)+(B42)+(B221), (A)+(B42)+(B222), (A)+(B42)+(B223), (A)+(B42)+(B224), (A)+(B42)+(B225), (A)+(B42)+(B226), (A)+(B42)+(B227), (A)+(B42)+(B228), (A)+(B42)+(B229), (A)+(B42)+(B230), (A)+(B42)+(B231), (A)+(B42)+(B232), (A)+(B42)+(B233), (A)+(B42)+(B234), (A)+(B42)+(B235), (A)+(B42)+(B236), (A)+(B42)+(B237), (A)+(B42)+(B238), (A)+(B42)+(B239), (A)+(B42)+(B240), (A)+(B42)+(B241), (A)+(B42)+(B242), (A)+(B42)+(B243), (A)+(B42)+(B244), (A)+(B42)+(B245), (A)+(B42)+(B246), (A)+(B42)+(B247), (A)+(B42)+(B248), (A)+(B42)+(B249), (A)+(B42)+(B250), (A)+(B42)+(B251), (A)+(B42)+(B252), (A)+(B42)+(B253), (A)+(B42)+(B254), (A)+(B42)+(B255), (A)+(B42)+(B256), (A)+(B42)+(B257), (A)+(B42)+(B258), (A)+(B42)+(B259), (A)+(B42)+(B260), (A)+(B42)+(B261), (A)+(B42)+(B262), (A)+(B42)+(B263), (A)+(B42)+(B264), (A)+(B42)+(B265), (A)+(B42)+(B266), (A)+(B42)+(B267), (A)+(B42)+(B268), (A)+(B42)+(B269), (A)+(B42)+(B270), (A)+(B42)+(B271), (A)+(B42)+(B272), (A)+(B42)+(B273), (A)+(B42)+(B274), (A)+(B42)+(B275), (A)+(B42)+(B276), (A)+(B42)+(B277), (A)+(B42)+(B278), (A)+(B42)+(B279), (A)+(B42)+(B280), (A)+(B42)+(B281), (A)+(B42)+(B282), (A)+(B42)+(B283), (A)+(B42)+(B284), (A)+(B42)+(B285), (A)+(B42)+(B286), (A)+(B42)+(B287), (A)+(B42)+(B288), (A)+(B42)+(B289), (A)+(B42)+(B290), (A)+(B42)+(B291), (A)+(B42)+(B292), (A)+(B42)+(B293), (A)+(B42)+(B294), (A)+(B42)+(B295), (A)+(B42)+(B296), (A)+(B42)+(B297), (A)+(B42)+(B298), (A)+(B42)+(B299), (A)+(B42)+(B300), (A)+(B42)+(B301), (A)+(B42)+(B302), (A)+(B42)+(B303), (A)+(B42)+(B304), (A)+(B42)+(B305), (A)+(B42)+(B306), (A)+(B42)+(B307), (A)+(B42)+(B308), (A)+(B42)+(B309), (A)+(B42)+(B310), (A)+(B42)+(B311), (A)+(B42)+(B312), (A)+(B42)+(B313), (A)+(B42)+(B314), (A)+(B42)+(B315),

(A)+(B43)+(B44), (A)+(B43)+(B45), (A)+(B43)+(B46), (A)+(B43)+(B47), (A)+(B43)+(B48), (A)+(B43)+(B49), (A)+(B43)+(B50), (A)+(B43)+(B51), (A)+(B43)+(B52), (A)+(B43)+(B53), (A)+(B43)+(B54), (A)+(B43)+(B55), (A)+(B43)+(B56), (A)+(B43)+(B57), (A)+(B43)+(B58), (A)+(B43)+(B59), (A)+(B43)+(B60), (A)+(B43)+(B61), (A)+(B43)+(B62), (A)+(B43)+(B63), (A)+(B43)+(B64), (A)+(B43)+(B65), (A)+(B43)+(B66), (A)+(B43)+(B67), (A)+(B43)+(B68), (A)+(B43)+(B69), (A)+(B43)+(B70), (A)+(B43)+(B71), (A)+(B43)+(B72), (A)+(B43)+(B73), (A)+(B43)+(B74), (A)+(B43)+(B75), (A)+(B43)+(B76), (A)+(B43)+(B77), (A)+(B43)+(B78), (A)+(B43)+(B79), (A)+(B43)+(B80), (A)+(B43)+(B81), (A)+(B43)+(B82), (A)+(B43)+(B83), (A)+(B43)+(B84), (A)+(B43)+(B85), (A)+(B43)+(B86), (A)+(B43)+(B87), (A)+(B43)+(B88), (A)+(B43)+(B89), (A)+(B43)+(B90), (A)+(B43)+(B91), (A)+(B43)+(B92), (A)+(B43)+(B93), (A)+(B43)+(B94), (A)+(B43)+(B95), (A)+(B43)+(B96), (A)+(B43)+(B97), (A)+(B43)+(B98), (A)+(B43)+(B99), (A)+(B43)+(B100), (A)+(B43)+(B101), (A)+(B43)+(B102), (A)+(B43)+(B103), (A)+(B43)+(B104), (A)+(B43)+(B105), (A)+(B43)+(B106), (A)+(B43)+(B107), (A)+(B43)+(B108), (A)+(B43)+(B109), (A)+(B43)+(B110), (A)+(B43)+(B111), (A)+(B43)+(B112), (A)+(B43)+(B113), (A)+(B43)+(B114), (A)+(B43)+(B115), (A)+(B43)+(B116), (A)+(B43)+(B117), (A)+(B43)+(B118), (A)+(B43)+(B119), (A)+(B43)+(B120), (A)+(B43)+(B121), (A)+(B43)+(B122), (A)+(B43)+(B123), (A)+(B43)+(B124), (A)+(B43)+(B125), (A)+(B43)+(B126), (A)+(B43)+(B127), (A)+(B43)+(B128), (A)+(B43)+(B129), (A)+(B43)+(B130), (A)+(B43)+(B131), (A)+(B43)+(B132), (A)+(B43)+(B133), (A)+(B43)+(B134), (A)+(B43)+(B135), (A)+(B43)+(B136), (A)+(B43)+(B137), (A)+(B43)+(B138), (A)+(B43)+(B139), (A)+(B43)+(B140), (A)+(B43)+(B141), (A)+(B43)+(B142), (A)+(B43)+(B143), (A)+(B43)+(B144), (A)+(B43)+(B145), (A)+(B43)+(B146), (A)+(B43)+(B147), (A)+(B43)+(B148), (A)+(B43)+(B149), (A)+(B43)+(B150), (A)+(B43)+(B151), (A)+(B43)+(B152), (A)+(B43)+(B153), (A)+(B43)+(B154), (A)+(B43)+(B155), (A)+(B43)+(B156), (A)+(B43)+(B157), (A)+(B43)+(B158), (A)+(B43)+(B159), (A)+(B43)+(B160), (A)+(B43)+(B161), (A)+(B43)+(B162), (A)+(B43)+(B164), (A)+(B43)+(B164), (A)+(B43)+(B165), (A)+(B43)+(B166), (A)+(B43)+(B167), (A)+(B43)+(B168), (A)+(B43)+(B169), (A)+(B43)+(B170), (A)+(B43)+(B171), (A)+(B43)+(B172), (A)+(B43)+(B173), (A)+(B43)+(B174), (A)+(B43)+(B175), (A)+(B43)+(B176), (A)+(B43)+(B177), (A)+(B43)+(B178), (A)+(B43)+(B179), (A)+(B43)+(B180), (A)+(B43)+(B181), (A)+(B43)+(B182), (A)+(B43)+(B183), (A)+(B43)+(B184), (A)+(B43)+(B185), (A)+(B43)+(B186), (A)+(B43)+(B187), (A)+(B43)+(B188), (A)+(B43)+(B189), (A)+(B43)+(B190), (A)+(B43)+(B191), (A)+(B43)+(B192), (A)+(B43)+(B193), (A)+(B43)+(B194), (A)+(B43)+(B195), (A)+(B43)+(B196), (A)+(B43)+(B197), (A)+(B43)+(B198), (A)+(B43)+(B199), (A)+(B43)+(B200), (A)+(B43)+(B201), (A)+(B43)+(B202), (A)+(B43)+(B203), (A)+(B43)+(B204), (A)+(B43)+(B205), (A)+(B43)+(B206), (A)+(B43)+(B207), (A)+(B43)+(B208), (A)+(B43)+(B209), (A)+(B43)+(B210), (A)+(B43)+(B211), (A)+(B43)+(B212), (A)+(B43)+(B213), (A)+(B43)+(B214), (A)+(B43)+(B215), (A)+(B43)+(B216), (A)+(B43)+(B217), (A)+(B43)+(B218), (A)+(B43)+(B219), (A)+(B43)+(B220), (A)+(B43)+(B221), (A)+(B43)+(B222), (A)+(B43)+(B223), (A)+(B43)+(B224), (A)+(B43)+(B225), (A)+(B43)+(B226), (A)+(B43)+(B227), (A)+(B43)+(B228), (A)+(B43)+(B229), (A)+(B43)+(B230), (A)+(B43)+(B231), (A)+(B43)+(B232), (A)+(B43)+(B233), (A)+(B43)+(B234), (A)+(B43)+(B235), (A)+(B43)+(B236), (A)+(B43)+(B237), (A)+(B43)+(B238), (A)+(B43)+(B239), (A)+(B43)+(B240), (A)+(B43)+(B241), (A)+(B43)+(B242), (A)+(B43)+(B243), (A)+(B43)+(B244), (A)+(B43)+(B245), (A)+(B43)+(B246), (A)+(B43)+(B247), (A)+(B43)+(B248), (A)+(B43)+(B249), (A)+(B43)+(B250), (A)+(B43)+(B251), (A)+(B43)+(B252), (A)+(B43)+(B253), (A)+(B43)+(B254), (A)+(B43)+(B255), (A)+(B43)+(B256), (A)+(B43)+(B257), (A)+(B43)+(B258), (A)+(B43)+(B259), (A)+(B43)+(B260), (A)+(B43)+(B261), (A)+(B43)+(B262), (A)+(B43)+(B263), (A)+(B43)+(B264), (A)+(B43)+(B265), (A)+(B43)+(B266), (A)+(B43)+(B267), (A)+(B43)+(B268), (A)+(B43)+(B269), (A)+(B43)+(B270), (A)+(B43)+(B271), (A)+(B43)+(B272), (A)+(B43)+(B273), (A)+(B43)+(B274), (A)+(B43)+(B275), (A)+(B43)+(B276), (A)+(B43)+(B277), (A)+(B43)+(B278), (A)+(B43)+(B279), (A)+(B43)+(B280), (A)+(B43)+(B281), (A)+(B43)+(B282), (A)+(B43)+(B283), (A)+(B43)+(B284), (A)+(B43)+(B285), (A)+(B43)+(B286), (A)+(B43)+(B287), (A)+(B43)+(B288), (A)+(B43)+(B289), (A)+(B43)+(B290), (A)+(B43)+(B291), (A)+(B43)+(B292), (A)+(B43)+(B293), (A)+(B43)+(B294), (A)+(B43)+(B295), (A)+(B43)+(B296), (A)+(B43)+(B297), (A)+(B43)+(B298), (A)+(B43)+(B299), (A)+(B43)+(B300), (A)+(B43)+(B301), (A)+(B43)+(B302), (A)+(B43)+(B303), (A)+(B43)+(B304), (A)+(B43)+(B305), (A)+(B43)+(B306), (A)+(B43)+(B307), (A)+(B43)+(B308), (A)+(B43)+(B309), (A)+(B43)+(B310), (A)+(B43)+(B311), (A)+(B43)+(B312), (A)+(B43)+(B313), (A)+(B43)+(B314), (A)+(B43)+(B315),

(A)+(B44)+(B45), (A)+(B44)+(B46), (A)+(B44)+(B47), (A)+(B44)+(B48), (A)+(B44)+(B49), (A)+(B44)+(B50), (A)+(B44)+(B51), (A)+(B44)+(B52), (A)+(B44)+(B53), (A)+(B44)+(B54), (A)+(B44)+(B55), (A)+(B44)+(B56), (A)+(B44)+(B57), (A)+(B44)+(B58), (A)+(B44)+(B59), (A)+(B44)+(B60), (A)+(B44)+(B61), (A)+(B44)+(B62), (A)+(B44)+(B63), (A)+(B44)+(B64), (A)+(B44)+(B65), (A)+(B44)+(B66), (A)+(B44)+(B67), (A)+(B44)+(B68), (A)+(B44)+(B69), (A)+(B44)+(B70), (A)+(B44)+(B71), (A)+(B44)+(B72), (A)+(B44)+(B73), (A)+(B44)+(B74), (A)+(B44)+(B75), (A)+(B44)+(B76), (A)+(B44)+(B77), (A)+(B44)+(B78), (A)+(B44)+(B79), (A)+(B44)+(B80), (A)+(B44)+(B81), (A)+(B44)+(B82), (A)+(B44)+(B83), (A)+(B44)+(B84), (A)+(B44)+(B85), (A)+(B44)+(B86), (A)+(B44)+(B87), (A)+(B44)+(B88), (A)+(B44)+(B89), (A)+(B44)+(B90), (A)+(B44)+(B91), (A)+(B44)+(B92), (A)+(B44)+(B93), (A)+(B44)+(B94), (A)+(B44)+(B95), (A)+(B44)+(B96), (A)+(B44)+(B97), (A)+(B44)+(B98), (A)+(B44)+(B99), (A)+(B44)+(B100), (A)+(B44)+(B101), (A)+(B44)+(B102), (A)+(B44)+(B103), (A)+(B44)+(B104), (A)+(B44)+(B105), (A)+(B44)+(B106), (A)+(B44)+(B107), (A)+(B44)+(B108), (A)+(B44)+(B109), (A)+(B44)+(B110), (A)+(B44)+(B111), (A)+(B44)+(B112), (A)+(B44)+(B113), (A)+(B44)+(B114), (A)+(B44)+(B115), (A)+(B44)+(B116), (A)+(B44)+(B117), (A)+(B44)+(B118), (A)+(B44)+(B119), (A)+(B44)+(B120), (A)+(B44)+(B121), (A)+(B44)+(B122), (A)+(B44)+(B123), (A)+(B44)+(B124), (A)+(B44)+(B125), (A)+(B44)+(B126), (A)+(B44)+(B127), (A)+(B44)+(B128), (A)+(B44)+(B129), (A)+(B44)+(B130), (A)+(B44)+(B131), (A)+(B44)+(B132), (A)+(B44)+(B133), (A)+(B44)+(B134), (A)+(B44)+(B135), (A)+(B44)+(B136), (A)+(B44)+(B137), (A)+(B44)+(B138), (A)+(B44)+(B139), (A)+(B44)+(B140), (A)+(B44)+(B141), (A)+(B44)+(B142), (A)+(B44)+(B143), (A)+(B44)+(B144), (A)+(B44)+(B145), (A)+(B44)+(B146), (A)+(B44)+(B147), (A)+(B44)+(B148), (A)+(B44)+(B149), (A)+(B44)+(B150), (A)+(B44)+(B151), (A)+(B44)+(B152), (A)+(B44)+(B153), (A)+(B44)+(B154), (A)+(B44)+(B155), (A)+(B44)+(B156), (A)+(B44)+(B157), (A)+(B44)+(B158), (A)+(B44)+(B159), (A)+(B44)+(B160), (A)+(B44)+(B161), (A)+(B44)+(B162), (A)+(B44)+(B164), (A)+(B44)+(B164), (A)+(B44)+(B165), (A)+(B44)+(B166), (A)+(B44)+(B167), (A)+(B44)+(B168), (A)+(B44)+(B169), (A)+(B44)+(B170), (A)+(B44)+(B171), (A)+(B44)+(B172), (A)+(B44)+(B173), (A)+(B44)+(B174), (A)+(B44)+(B175), (A)+(B44)+(B176), (A)+(B44)+(B177), (A)+(B44)+(B178), (A)+(B44)+(B179), (A)+(B44)+(B180), (A)+(B44)+(B181), (A)+(B44)+(B182), (A)+(B44)+(B183), (A)+(B44)+(B184), (A)+(B44)+(B185), (A)+(B44)+(B186), (A)+(B44)+(B187), (A)+(B44)+(B188), (A)+(B44)+(B189), (A)+(B44)+(B190), (A)+(B44)+(B191), (A)+(B44)+(B192), (A)+(B44)+(B193), (A)+(B44)+(B194), (A)+(B44)+(B195), (A)+(B44)+(B196), (A)+(B44)+(B197), (A)+(B44)+(B198), (A)+(B44)+(B199), (A)+(B44)+(B200), (A)+(B44)+(B201), (A)+(B44)+(B202), (A)+(B44)+(B203), (A)+(B44)+(B204), (A)+(B44)+(B205), (A)+(B44)+(B206), (A)+(B44)+(B207), (A)+(B44)+(B208), (A)+(B44)+(B209), (A)+(B44)+(B210), (A)+(B44)+(B211), (A)+(B44)+(B212), (A)+(B44)+(B213), (A)+(B44)+(B214), (A)+(B44)+(B215), (A)+(B44)+(B216), (A)+(B44)+(B217), (A)+(B44)+(B218), (A)+(B44)+(B219), (A)+(B44)+(B220), (A)+(B44)+(B221), (A)+(B44)+(B222), (A)+(B44)+(B223), (A)+(B44)+(B224), (A)+(B44)+(B225), (A)+(B44)+(B226), (A)+(B44)+(B227), (A)+(B44)+(B228), (A)+(B44)+(B229), (A)+(B44)+(B230), (A)+(B44)+(B231), (A)+(B44)+(B232), (A)+(B44)+(B233), (A)+(B44)+(B234), (A)+(B44)+(B235), (A)+(B44)+(B236), (A)+(B44)+(B237), (A)+(B44)+(B238), (A)+(B44)+(B239), (A)+(B44)+(B240), (A)+(B44)+(B241), (A)+(B44)+(B242), (A)+(B44)+(B243), (A)+(B44)+(B244), (A)+(B44)+(B245), (A)+(B44)+(B246), (A)+(B44)+(B247), (A)+(B44)+(B248), (A)+(B44)+(B249), (A)+(B44)+(B250), (A)+(B44)+(B251), (A)+(B44)+(B252), (A)+(B44)+(B253), (A)+(B44)+(B254), (A)+(B44)+(B255), (A)+(B44)+(B256), (A)+(B44)+(B257), (A)+(B44)+(B258), (A)+(B44)+(B259), (A)+(B44)+(B260), (A)+(B44)+(B261), (A)+(B44)+(B262), (A)+(B44)+(B263), (A)+(B44)+(B264), (A)+(B44)+(B265), (A)+(B44)+(B266), (A)+(B44)+(B267), (A)+(B44)+(B268), (A)+(B44)+(B269), (A)+(B44)+(B270), (A)+(B44)+(B271), (A)+(B44)+(B272), (A)+(B44)+(B273), (A)+(B44)+(B274), (A)+(B44)+(B275), (A)+(B44)+(B276), (A)+(B44)+(B277), (A)+(B44)+(B278), (A)+(B44)+(B279), (A)+(B44)+(B280), (A)+(B44)+(B281), (A)+(B44)+(B282), (A)+(B44)+(B283), (A)+(B44)+(B284), (A)+(B44)+(B285), (A)+(B44)+(B286), (A)+(B44)+(B287), (A)+(B44)+(B288), (A)+(B44)+(B289), (A)+(B44)+(B290), (A)+(B44)+(B291), (A)+(B44)+(B292), (A)+(B44)+(B293), (A)+(B44)+(B294), (A)+(B44)+(B295), (A)+(B44)+(B296), (A)+(B44)+(B297), (A)+(B44)+(B298), (A)+(B44)+(B299), (A)+(B44)+(B300), (A)+(B44)+(B301), (A)+(B44)+(B302), (A)+(B44)+(B303), (A)+(B44)+(B304), (A)+(B44)+(B305), (A)+(B44)+(B306), (A)+(B44)+(B307), (A)+(B44)+(B308), (A)+(B44)+(B309), (A)+(B44)+(B310), (A)+(B44)+(B311), (A)+(B44)+(B312), (A)+(B44)+(B313), (A)+(B44)+(B314), (A)+(B44)+(B315),

(A)+(B45)+(B46), (A)+(B45)+(B47), (A)+(B45)+(B48), (A)+(B45)+(B49), (A)+(B45)+(B50), (A)+(B45)+(B51), (A)+(B45)+(B52), (A)+(B45)+(B53), (A)+(B45)+(B54), (A)+(B45)+(B55), (A)+(B45)+(B56), (A)+(B45)+(B57), (A)+(B45)+(B58), (A)+(B45)+(B59), (A)+(B45)+(B60), (A)+(B45)+(B61), (A)+(B45)+(B62), (A)+(B45)+(B63), (A)+(B45)+(B64), (A)+(B45)+(B65), (A)+(B45)+(B66), (A)+(B45)+(B67), (A)+(B45)+(B68), (A)+(B45)+(B69), (A)+(B45)+(B70), (A)+(B45)+(B71), (A)+(B45)+(B72), (A)+(B45)+(B73), (A)+(B45)+(B74), (A)+(B45)+(B75), (A)+(B45)+(B76), (A)+(B45)+(B77), (A)+(B45)+(B78), (A)+(B45)+(B79), (A)+(B45)+(B80), (A)+(B45)+(B81), (A)+(B45)+(B82), (A)+(B45)+(B83), (A)+(B45)+(B84), (A)+(B45)+(B85), (A)+(B45)+(B86), (A)+(B45)+(B87), (A)+(B45)+(B88), (A)+(B45)+(B89), (A)+(B45)+(B90), (A)+(B45)+(B91), (A)+(B45)+(B92), (A)+(B45)+(B93), (A)+(B45)+(B94), (A)+(B45)+(B95), (A)+(B45)+(B96), (A)+(B45)+(B97), (A)+(B45)+(B98), (A)+(B45)+(B99), (A)+(B45)+(B100), (A)+(B45)+(B101), (A)+(B45)+(B102), (A)+(B45)+(B103), (A)+(B45)+(B104), (A)+(B45)+(B105), (A)+(B45)+(B106), (A)+(B45)+(B107), (A)+(B45)+(B108), (A)+(B45)+(B109), (A)+(B45)+(B110), (A)+(B45)+(B111), (A)+(B45)+(B112), (A)+(B45)+(B113), (A)+(B45)+(B114), (A)+(B45)+(B115), (A)+(B45)+(B116), (A)+(B45)+(B117), (A)+(B45)+(B118), (A)+(B45)+(B119), (A)+(B45)+(B120), (A)+(B45)+(B121), (A)+(B45)+(B122), (A)+(B45)+(B123), (A)+(B45)+(B124), (A)+(B45)+(B125), (A)+(B45)+(B126), (A)+(B45)+(B127), (A)+(B45)+(B128), (A)+(B45)+(B129), (A)+(B45)+(B130), (A)+(B45)+(B131), (A)+(B45)+(B132), (A)+(B45)+(B133), (A)+(B45)+(B134), (A)+(B45)+(B135), (A)+(B45)+(B136), (A)+(B45)+(B137), (A)+(B45)+(B138), (A)+(B45)+(B139), (A)+(B45)+(B140), (A)+(B45)+(B141), (A)+(B45)+(B142), (A)+(B45)+(B143), (A)+(B45)+(B144), (A)+(B45)+(B145), (A)+(B45)+(B146), (A)+(B45)+(B147), (A)+(B45)+(B148), (A)+(B45)+(B149), (A)+(B45)+(B150), (A)+(B45)+(B151), (A)+(B45)+(B152), (A)+(B45)+(B153), (A)+(B45)+(B154), (A)+(B45)+(B155), (A)+(B45)+(B156), (A)+(B45)+(B157), (A)+(B45)+(B158), (A)+(B45)+(B159), (A)+(B45)+(B160), (A)+(B45)+(B161), (A)+(B45)+(B162), (A)+(B45)+(B164), (A)+(B45)+(B164), (A)+(B45)+(B165), (A)+(B45)+(B166), (A)+(B45)+(B167), (A)+(B45)+(B168), (A)+(B45)+(B169), (A)+(B45)+(B170), (A)+(B45)+(B171), (A)+(B45)+(B172), (A)+(B45)+(B173), (A)+(B45)+(B174), (A)+(B45)+(B175), (A)+(B45)+(B176), (A)+(B45)+(B177), (A)+(B45)+(B178), (A)+(B45)+(B179), (A)+(B45)+(B180), (A)+(B45)+(B181), (A)+(B45)+(B182), (A)+(B45)+(B183), (A)+(B45)+(B184), (A)+(B45)+(B185), (A)+(B45)+(B186), (A)+(B45)+(B187), (A)+(B45)+(B188), (A)+(B45)+(B189), (A)+(B45)+(B190), (A)+(B45)+(B191), (A)+(B45)+(B192), (A)+(B45)+(B193), (A)+(B45)+(B194), (A)+(B45)+(B195), (A)+(B45)+(B196), (A)+(B45)+(B197), (A)+(B45)+(B198), (A)+(B45)+(B199), (A)+(B45)+(B200), (A)+(B45)+(B201), (A)+(B45)+(B202), (A)+(B45)+(B203), (A)+(B45)+(B204), (A)+(B45)+(B205), (A)+(B45)+(B206), (A)+(B45)+(B207), (A)+(B45)+(B208), (A)+(B45)+(B209), (A)+(B45)+(B210), (A)+(B45)+(B211), (A)+(B45)+(B212), (A)+(B45)+(B213), (A)+(B45)+(B214), (A)+(B45)+(B215), (A)+(B45)+(B216), (A)+(B45)+(B217), (A)+(B45)+(B218), (A)+(B45)+(B219), (A)+(B45)+(B220), (A)+(B45)+(B221), (A)+(B45)+(B222), (A)+(B45)+(B223), (A)+(B45)+(B224), (A)+(B45)+(B225), (A)+(B45)+(B226), (A)+(B45)+(B227), (A)+(B45)+(B228), (A)+(B45)+(B229), (A)+(B45)+(B230), (A)+(B45)+(B231), (A)+(B45)+(B232), (A)+(B45)+(B233), (A)+(B45)+(B234), (A)+(B45)+(B235), (A)+(B45)+(B236), (A)+(B45)+(B237), (A)+(B45)+(B238), (A)+(B45)+(B239), (A)+(B45)+(B240), (A)+(B45)+(B241), (A)+(B45)+(B242), (A)+(B45)+(B243), (A)+(B45)+(B244), (A)+(B45)+(B245), (A)+(B45)+(B246), (A)+(B45)+(B247), (A)+(B45)+(B248), (A)+(B45)+(B249), (A)+(B45)+(B250), (A)+(B45)+(B251), (A)+(B45)+(B252), (A)+(B45)+(B253), (A)+(B45)+(B254), (A)+(B45)+(B255), (A)+(B45)+(B256), (A)+(B45)+(B257), (A)+(B45)+(B258), (A)+(B45)+(B259), (A)+(B45)+(B260), (A)+(B45)+(B261), (A)+(B45)+(B262), (A)+(B45)+(B263), (A)+(B45)+(B264), (A)+(B45)+(B265), (A)+(B45)+(B266), (A)+(B45)+(B267), (A)+(B45)+(B268), (A)+(B45)+(B269), (A)+(B45)+(B270), (A)+(B45)+(B271), (A)+(B45)+(B272), (A)+(B45)+(B273), (A)+(B45)+(B274), (A)+(B45)+(B275), (A)+(B45)+(B276), (A)+(B45)+(B277), (A)+(B45)+(B278), (A)+(B45)+(B279), (A)+(B45)+(B280), (A)+(B45)+(B281), (A)+(B45)+(B282), (A)+(B45)+(B283), (A)+(B45)+(B284), (A)+(B45)+(B285), (A)+(B45)+(B286), (A)+(B45)+(B287), (A)+(B45)+(B288), (A)+(B45)+(B289), (A)+(B45)+(B290), (A)+(B45)+(B291), (A)+(B45)+(B292), (A)+(B45)+(B293), (A)+(B45)+(B294), (A)+(B45)+(B295), (A)+(B45)+(B296), (A)+(B45)+(B297), (A)+(B45)+(B298), (A)+(B45)+(B299), (A)+(B45)+(B300), (A)+(B45)+(B301), (A)+(B45)+(B302), (A)+(B45)+(B303), (A)+(B45)+(B304), (A)+(B45)+(B305), (A)+(B45)+(B306), (A)+(B45)+(B307), (A)+(B45)+(B308), (A)+(B45)+(B309), (A)+(B45)+(B310), (A)+(B45)+(B311), (A)+(B45)+(B312), (A)+(B45)+(B313), (A)+(B45)+(B314), (A)+(B45)+(B315),

(A)+(B46)+(B47), (A)+(B46)+(B48), (A)+(B46)+(B49), (A)+(B46)+(B50), (A)+(B46)+(B51), (A)+(B46)+(B52), (A)+(B46)+(B53), (A)+(B46)+(B54), (A)+(B46)+(B55), (A)+(B46)+(B56), (A)+(B46)+(B57), (A)+(B46)+(B58), (A)+(B46)+(B59), (A)+(B46)+(B60), (A)+(B46)+(B61), (A)+(B46)+(B62), (A)+(B46)+(B63), (A)+(B46)+(B64), (A)+(B46)+(B65), (A)+(B46)+(B66), (A)+(B46)+(B67), (A)+(B46)+(B68), (A)+(B46)+(B69), (A)+(B46)+(B70), (A)+(B46)+(B71), (A)+(B46)+(B72), (A)+(B46)+(B73), (A)+(B46)+(B74), (A)+(B46)+(B75), (A)+(B46)+(B76), (A)+(B46)+(B77), (A)+(B46)+(B78), (A)+(B46)+(B79), (A)+(B46)+(B80), (A)+(B46)+(B81), (A)+(B46)+(B82), (A)+(B46)+(B83), (A)+(B46)+(B84), (A)+(B46)+(B85), (A)+(B46)+(B86), (A)+(B46)+(B87), (A)+(B46)+(B88), (A)+(B46)+(B89), (A)+(B46)+(B90), (A)+(B46)+(B91), (A)+(B46)+(B92), (A)+(B46)+(B93), (A)+(B46)+(B94), (A)+(B46)+(B95), (A)+(B46)+(B96), (A)+(B46)+(B97), (A)+(B46)+(B98), (A)+(B46)+(B99), (A)+(B46)+(B100), (A)+(B46)+(B101), (A)+(B46)+(B102), (A)+(B46)+(B103), (A)+(B46)+(B104), (A)+(B46)+(B105), (A)+(B46)+(B106), (A)+(B46)+(B107), (A)+(B46)+(B108), (A)+(B46)+(B109), (A)+(B46)+(B110), (A)+(B46)+(B111), (A)+(B46)+(B112), (A)+(B46)+(B113), (A)+(B46)+(B114), (A)+(B46)+(B115), (A)+(B46)+(B116), (A)+(B46)+(B117), (A)+(B46)+(B118), (A)+(B46)+(B119), (A)+(B46)+(B120), (A)+(B46)+(B121), (A)+(B46)+(B122), (A)+(B46)+(B123), (A)+(B46)+(B124), (A)+(B46)+(B125), (A)+(B46)+(B126), (A)+(B46)+(B127), (A)+(B46)+(B128), (A)+(B46)+(B129), (A)+(B46)+(B130), (A)+(B46)+(B131), (A)+(B46)+(B132), (A)+(B46)+(B133), (A)+(B46)+(B134), (A)+(B46)+(B135), (A)+(B46)+(B136), (A)+(B46)+(B137), (A)+(B46)+(B138), (A)+(B46)+(B139), (A)+(B46)+(B140), (A)+(B46)+(B141), (A)+(B46)+(B142), (A)+(B46)+(B143), (A)+(B46)+(B144), (A)+(B46)+(B145), (A)+(B46)+(B146), (A)+(B46)+(B147), (A)+(B46)+(B148), (A)+(B46)+(B149), (A)+(B46)+(B150), (A)+(B46)+(B151), (A)+(B46)+(B152), (A)+(B46)+(B153), (A)+(B46)+(B154), (A)+(B46)+(B155), (A)+(B46)+(B156), (A)+(B46)+(B157), (A)+(B46)+(B158), (A)+(B46)+(B159), (A)+(B46)+(B160), (A)+(B46)+(B161), (A)+(B46)+(B162), (A)+(B46)+(B164), (A)+(B46)+(B164), (A)+(B46)+(B165), (A)+(B46)+(B166), (A)+(B46)+(B167), (A)+(B46)+(B168), (A)+(B46)+(B169), (A)+(B46)+(B170), (A)+(B46)+(B171), (A)+(B46)+(B172), (A)+(B46)+(B173), (A)+(B46)+(B174), (A)+(B46)+(B175), (A)+(B46)+(B176), (A)+(B46)+(B177), (A)+(B46)+(B178), (A)+(B46)+(B179), (A)+(B46)+(B180), (A)+(B46)+(B181), (A)+(B46)+(B182), (A)+(B46)+(B183), (A)+(B46)+(B184), (A)+(B46)+(B185), (A)+(B46)+(B186), (A)+(B46)+(B187), (A)+(B46)+(B188), (A)+(B46)+(B189), (A)+(B46)+(B190), (A)+(B46)+(B191), (A)+(B46)+(B192), (A)+(B46)+(B193), (A)+(B46)+(B194), (A)+(B46)+(B195), (A)+(B46)+(B196), (A)+(B46)+(B197), (A)+(B46)+(B198), (A)+(B46)+(B199), (A)+(B46)+(B200), (A)+(B46)+(B201), (A)+(B46)+(B202), (A)+(B46)+(B203), (A)+(B46)+(B204), (A)+(B46)+(B205), (A)+(B46)+(B206), (A)+(B46)+(B207), (A)+(B46)+(B208), (A)+(B46)+(B209), (A)+(B46)+(B210), (A)+(B46)+(B211), (A)+(B46)+(B212), (A)+(B46)+(B213), (A)+(B46)+(B214), (A)+(B46)+(B215), (A)+(B46)+(B216), (A)+(B46)+(B217), (A)+(B46)+(B218), (A)+(B46)+(B219), (A)+(B46)+(B220), (A)+(B46)+(B221), (A)+(B46)+(B222), (A)+(B46)+(B223), (A)+(B46)+(B224), (A)+(B46)+(B225), (A)+(B46)+(B226), (A)+(B46)+(B227), (A)+(B46)+(B228), (A)+(B46)+(B229), (A)+(B46)+(B230), (A)+(B46)+(B231), (A)+(B46)+(B232), (A)+(B46)+(B233), (A)+(B46)+(B234), (A)+(B46)+(B235), (A)+(B46)+(B236), (A)+(B46)+(B237), (A)+(B46)+(B238), (A)+(B46)+(B239), (A)+(B46)+(B240), (A)+(B46)+(B241), (A)+(B46)+(B242), (A)+(B46)+(B243), (A)+(B46)+(B244), (A)+(B46)+(B245), (A)+(B46)+(B246), (A)+(B46)+(B247), (A)+(B46)+(B248), (A)+(B46)+(B249), (A)+(B46)+(B250), (A)+(B46)+(B251), (A)+(B46)+(B252), (A)+(B46)+(B253), (A)+(B46)+(B254), (A)+(B46)+(B255), (A)+(B46)+(B256), (A)+(B46)+(B257), (A)+(B46)+(B258), (A)+(B46)+(B259), (A)+(B46)+(B260), (A)+(B46)+(B261), (A)+(B46)+(B262), (A)+(B46)+(B263), (A)+(B46)+(B264), (A)+(B46)+(B265), (A)+(B46)+(B266), (A)+(B46)+(B267), (A)+(B46)+(B268), (A)+(B46)+(B269), (A)+(B46)+(B270), (A)+(B46)+(B271), (A)+(B46)+(B272), (A)+(B46)+(B273), (A)+(B46)+(B274), (A)+(B46)+(B275), (A)+(B46)+(B276), (A)+(B46)+(B277), (A)+(B46)+(B278), (A)+(B46)+(B279), (A)+(B46)+(B280), (A)+(B46)+(B281), (A)+(B46)+(B282), (A)+(B46)+(B283), (A)+(B46)+(B284), (A)+(B46)+(B285), (A)+(B46)+(B286), (A)+(B46)+(B287), (A)+(B46)+(B288), (A)+(B46)+(B289), (A)+(B46)+(B290), (A)+(B46)+(B291), (A)+(B46)+(B292), (A)+(B46)+(B293), (A)+(B46)+(B294), (A)+(B46)+(B295), (A)+(B46)+(B296), (A)+(B46)+(B297), (A)+(B46)+(B298), (A)+(B46)+(B299), (A)+(B46)+(B300), (A)+(B46)+(B301), (A)+(B46)+(B302), (A)+(B46)+(B303), (A)+(B46)+(B304), (A)+(B46)+(B305), (A)+(B46)+(B306), (A)+(B46)+(B307), (A)+(B46)+(B308), (A)+(B46)+(B309), (A)+(B46)+(B310), (A)+(B46)+(B311), (A)+(B46)+(B312), (A)+(B46)+(B313), (A)+(B46)+(B314), (A)+(B46)+(B315),

(A)+(B47)+(B48), (A)+(B47)+(B49), (A)+(B47)+(B50), (A)+(B47)+(B51), (A)+(B47)+(B52), (A)+(B47)+(B53), (A)+(B47)+(B54), (A)+(B47)+(B55), (A)+(B47)+(B56), (A)+(B47)+(B57), (A)+(B47)+(B58), (A)+(B47)+(B59), (A)+(B47)+(B60), (A)+(B47)+(B61), (A)+(B47)+(B62), (A)+(B47)+(B63), (A)+(B47)+(B64), (A)+(B47)+(B65), (A)+(B47)+(B66), (A)+(B47)+(B67), (A)+(B47)+(B68), (A)+(B47)+(B69), (A)+(B47)+(B70), (A)+(B47)+(B71), (A)+(B47)+(B72), (A)+(B47)+(B73), (A)+(B47)+(B74), (A)+(B47)+(B75), (A)+(B47)+(B76), (A)+(B47)+(B77), (A)+(B47)+(B78), (A)+(B47)+(B79), (A)+(B47)+(B80), (A)+(B47)+(B81), (A)+(B47)+(B82), (A)+(B47)+(B83), (A)+(B47)+(B84), (A)+(B47)+(B85), (A)+(B47)+(B86), (A)+(B47)+(B87), (A)+(B47)+(B88), (A)+(B47)+(B89), (A)+(B47)+(B90), (A)+(B47)+(B91), (A)+(B47)+(B92), (A)+(B47)+(B93), (A)+(B47)+(B94), (A)+(B47)+(B95), (A)+(B47)+(B96), (A)+(B47)+(B97), (A)+(B47)+(B98), (A)+(B47)+(B99), (A)+(B47)+(B100), (A)+(B47)+(B101), (A)+(B47)+(B102), (A)+(B47)+(B103), (A)+(B47)+(B104), (A)+(B47)+(B105), (A)+(B47)+(B106), (A)+(B47)+(B107), (A)+(B47)+(B108), (A)+(B47)+(B109), (A)+(B47)+(B110), (A)+(B47)+(B111), (A)+(B47)+(B112), (A)+(B47)+(B113), (A)+(B47)+(B114), (A)+(B47)+(B115), (A)+(B47)+(B116), (A)+(B47)+(B117), (A)+(B47)+(B118), (A)+(B47)+(B119), (A)+(B47)+(B120), (A)+(B47)+(B121), (A)+(B47)+(B122), (A)+(B47)+(B123), (A)+(B47)+(B124), (A)+(B47)+(B125), (A)+(B47)+(B126), (A)+(B47)+(B127), (A)+(B47)+(B128), (A)+(B47)+(B129), (A)+(B47)+(B130), (A)+(B47)+(B131), (A)+(B47)+(B132), (A)+(B47)+(B133), (A)+(B47)+(B134), (A)+(B47)+(B135), (A)+(B47)+(B136), (A)+(B47)+(B137), (A)+(B47)+(B138), (A)+(B47)+(B139), (A)+(B47)+(B140), (A)+(B47)+(B141), (A)+(B47)+(B142), (A)+(B47)+(B143), (A)+(B47)+(B144), (A)+(B47)+(B145), (A)+(B47)+(B146), (A)+(B47)+(B147), (A)+(B47)+(B148), (A)+(B47)+(B149), (A)+(B47)+(B150), (A)+(B47)+(B151), (A)+(B47)+(B152), (A)+(B47)+(B153), (A)+(B47)+(B154), (A)+(B47)+(B155), (A)+(B47)+(B156), (A)+(B47)+(B157), (A)+(B47)+(B158), (A)+(B47)+(B159), (A)+(B47)+(B160), (A)+(B47)+(B161), (A)+(B47)+(B162), (A)+(B47)+(B164), (A)+(B47)+(B164), (A)+(B47)+(B165), (A)+(B47)+(B166), (A)+(B47)+(B167), (A)+(B47)+(B168), (A)+(B47)+(B169), (A)+(B47)+(B170), (A)+(B47)+(B171), (A)+(B47)+(B172), (A)+(B47)+(B173), (A)+(B47)+(B174), (A)+(B47)+(B175), (A)+(B47)+(B176), (A)+(B47)+(B177), (A)+(B47)+(B178), (A)+(B47)+(B179), (A)+(B47)+(B180), (A)+(B47)+(B181), (A)+(B47)+(B182), (A)+(B47)+(B183), (A)+(B47)+(B184), (A)+(B47)+(B185), (A)+(B47)+(B186), (A)+(B47)+(B187), (A)+(B47)+(B188), (A)+(B47)+(B189), (A)+(B47)+(B190), (A)+(B47)+(B191), (A)+(B47)+(B192), (A)+(B47)+(B193), (A)+(B47)+(B194), (A)+(B47)+(B195), (A)+(B47)+(B196), (A)+(B47)+(B197), (A)+(B47)+(B198), (A)+(B47)+(B199), (A)+(B47)+(B200), (A)+(B47)+(B201), (A)+(B47)+(B202), (A)+(B47)+(B203), (A)+(B47)+(B204), (A)+(B47)+(B205), (A)+(B47)+(B206), (A)+(B47)+(B207), (A)+(B47)+(B208), (A)+(B47)+(B209), (A)+(B47)+(B210), (A)+(B47)+(B211), (A)+(B47)+(B212), (A)+(B47)+(B213), (A)+(B47)+(B214), (A)+(B47)+(B215), (A)+(B47)+(B216), (A)+(B47)+(B217), (A)+(B47)+(B218), (A)+(B47)+(B219), (A)+(B47)+(B220), (A)+(B47)+(B221), (A)+(B47)+(B222), (A)+(B47)+(B223), (A)+(B47)+(B224), (A)+(B47)+(B225), (A)+(B47)+(B226), (A)+(B47)+(B227), (A)+(B47)+(B228), (A)+(B47)+(B229), (A)+(B47)+(B230), (A)+(B47)+(B231), (A)+(B47)+(B232), (A)+(B47)+(B233), (A)+(B47)+(B234), (A)+(B47)+(B235), (A)+(B47)+(B236), (A)+(B47)+(B237), (A)+(B47)+(B238), (A)+(B47)+(B239), (A)+(B47)+(B240), (A)+(B47)+(B241), (A)+(B47)+(B242), (A)+(B47)+(B243), (A)+(B47)+(B244), (A)+(B47)+(B245), (A)+(B47)+(B246), (A)+(B47)+(B247), (A)+(B47)+(B248), (A)+(B47)+(B249), (A)+(B47)+(B250), (A)+(B47)+(B251), (A)+(B47)+(B252), (A)+(B47)+(B253), (A)+(B47)+(B254), (A)+(B47)+(B255), (A)+(B47)+(B256), (A)+(B47)+(B257), (A)+(B47)+(B258), (A)+(B47)+(B259), (A)+(B47)+(B260), (A)+(B47)+(B261), (A)+(B47)+(B262), (A)+(B47)+(B263), (A)+(B47)+(B264), (A)+(B47)+(B265), (A)+(B47)+(B266), (A)+(B47)+(B267), (A)+(B47)+(B268), (A)+(B47)+(B269), (A)+(B47)+(B270), (A)+(B47)+(B271), (A)+(B47)+(B272), (A)+(B47)+(B273), (A)+(B47)+(B274), (A)+(B47)+(B275), (A)+(B47)+(B276), (A)+(B47)+(B277), (A)+(B47)+(B278), (A)+(B47)+(B279), (A)+(B47)+(B280), (A)+(B47)+(B281), (A)+(B47)+(B282), (A)+(B47)+(B283), (A)+(B47)+(B284), (A)+(B47)+(B285), (A)+(B47)+(B286), (A)+(B47)+(B287), (A)+(B47)+(B288), (A)+(B47)+(B289), (A)+(B47)+(B290), (A)+(B47)+(B291), (A)+(B47)+(B292), (A)+(B47)+(B293), (A)+(B47)+(B294), (A)+(B47)+(B295), (A)+(B47)+(B296), (A)+(B47)+(B297), (A)+(B47)+(B298), (A)+(B47)+(B299), (A)+(B47)+(B300), (A)+(B47)+(B301), (A)+(B47)+(B302), (A)+(B47)+(B303), (A)+(B47)+(B304), (A)+(B47)+(B305), (A)+(B47)+(B306), (A)+(B47)+(B307), (A)+(B47)+(B308), (A)+(B47)+(B309), (A)+(B47)+(B310), (A)+(B47)+(B311), (A)+(B47)+(B312), (A)+(B47)+(B313), (A)+(B47)+(B314), (A)+(B47)+(B315),

(A)+(B48)+(B49), (A)+(B48)+(B50), (A)+(B48)+(B51), (A)+(B48)+(B52), (A)+(B48)+(B53), (A)+(B48)+(B54), (A)+(B48)+(B55), (A)+(B48)+(B56), (A)+(B48)+(B57), (A)+(B48)+(B58), (A)+(B48)+(B59), (A)+(B48)+(B60), (A)+(B48)+(B61), (A)+(B48)+(B62), (A)+(B48)+(B63), (A)+(B48)+(B64), (A)+(B48)+(B65), (A)+(B48)+(B66), (A)+(B48)+(B67), (A)+(B48)+(B68), (A)+(B48)+(B69), (A)+(B48)+(B70), (A)+(B48)+(B71), (A)+(B48)+(B72), (A)+(B48)+(B73), (A)+(B48)+(B74), (A)+(B48)+(B75), (A)+(B48)+(B76), (A)+(B48)+(B77), (A)+(B48)+(B78), (A)+(B48)+(B79), (A)+(B48)+(B80), (A)+(B48)+(B81), (A)+(B48)+(B82), (A)+(B48)+(B83), (A)+(B48)+(B84), (A)+(B48)+(B85), (A)+(B48)+(B86), (A)+(B48)+(B87), (A)+(B48)+(B88), (A)+(B48)+(B89), (A)+(B48)+(B90), (A)+(B48)+(B91), (A)+(B48)+(B92), (A)+(B48)+(B93), (A)+(B48)+(B94), (A)+(B48)+(B95), (A)+(B48)+(B96), (A)+(B48)+(B97), (A)+(B48)+(B98), (A)+(B48)+(B99), (A)+(B48)+(B100), (A)+(B48)+(B101), (A)+(B48)+(B102), (A)+(B48)+(B103), (A)+(B48)+(B104), (A)+(B48)+(B105), (A)+(B48)+(B106), (A)+(B48)+(B107), (A)+(B48)+(B108), (A)+(B48)+(B109), (A)+(B48)+(B110), (A)+(B48)+(B111), (A)+(B48)+(B112), (A)+(B48)+(B113), (A)+(B48)+(B114), (A)+(B48)+(B115), (A)+(B48)+(B116), (A)+(B48)+(B117), (A)+(B48)+(B118), (A)+(B48)+(B119), (A)+(B48)+(B120), (A)+(B48)+(B121), (A)+(B48)+(B122), (A)+(B48)+(B123), (A)+(B48)+(B124), (A)+(B48)+(B125), (A)+(B48)+(B126), (A)+(B48)+(B127), (A)+(B48)+(B128), (A)+(B48)+(B129), (A)+(B48)+(B130), (A)+(B48)+(B131), (A)+(B48)+(B132), (A)+(B48)+(B133), (A)+(B48)+(B134), (A)+(B48)+(B135), (A)+(B48)+(B136), (A)+(B48)+(B137), (A)+(B48)+(B138), (A)+(B48)+(B139), (A)+(B48)+(B140), (A)+(B48)+(B141), (A)+(B48)+(B142), (A)+(B48)+(B143), (A)+(B48)+(B144), (A)+(B48)+(B145), (A)+(B48)+(B146), (A)+(B48)+(B147), (A)+(B48)+(B148), (A)+(B48)+(B149), (A)+(B48)+(B150), (A)+(B48)+(B151), (A)+(B48)+(B152), (A)+(B48)+(B153), (A)+(B48)+(B154), (A)+(B48)+(B155), (A)+(B48)+(B156), (A)+(B48)+(B157), (A)+(B48)+(B158), (A)+(B48)+(B159), (A)+(B48)+(B160), (A)+(B48)+(B161), (A)+(B48)+(B162), (A)+(B48)+(B164), (A)+(B48)+(B164), (A)+(B48)+(B165), (A)+(B48)+(B166), (A)+(B48)+(B167), (A)+(B48)+(B168), (A)+(B48)+(B169), (A)+(B48)+(B170), (A)+(B48)+(B171), (A)+(B48)+(B172), (A)+(B48)+(B173), (A)+(B48)+(B174), (A)+(B48)+(B175), (A)+(B48)+(B176), (A)+(B48)+(B177), (A)+(B48)+(B178), (A)+(B48)+(B179), (A)+(B48)+(B180), (A)+(B48)+(B181), (A)+(B48)+(B182), (A)+(B48)+(B183), (A)+(B48)+(B184), (A)+(B48)+(B185), (A)+(B48)+(B186), (A)+(B48)+(B187), (A)+(B48)+(B188), (A)+(B48)+(B189), (A)+(B48)+(B190), (A)+(B48)+(B191), (A)+(B48)+(B192), (A)+(B48)+(B193), (A)+(B48)+(B194), (A)+(B48)+(B195), (A)+(B48)+(B196), (A)+(B48)+(B197), (A)+(B48)+(B198), (A)+(B48)+(B199), (A)+(B48)+(B200), (A)+(B48)+(B201), (A)+(B48)+(B202), (A)+(B48)+(B203), (A)+(B48)+(B204), (A)+(B48)+(B205), (A)+(B48)+(B206), (A)+(B48)+(B207), (A)+(B48)+(B208), (A)+(B48)+(B209), (A)+(B48)+(B210), (A)+(B48)+(B211), (A)+(B48)+(B212), (A)+(B48)+(B213), (A)+(B48)+(B214), (A)+(B48)+(B215), (A)+(B48)+(B216), (A)+(B48)+(B217), (A)+(B48)+(B218), (A)+(B48)+(B219), (A)+(B48)+(B220), (A)+(B48)+(B221), (A)+(B48)+(B222), (A)+(B48)+(B223), (A)+(B48)+(B224), (A)+(B48)+(B225), (A)+(B48)+(B226), (A)+(B48)+(B227), (A)+(B48)+(B228), (A)+(B48)+(B229), (A)+(B48)+(B230), (A)+(B48)+(B231), (A)+(B48)+(B232), (A)+(B48)+(B233), (A)+(B48)+(B234), (A)+(B48)+(B235), (A)+(B48)+(B236), (A)+(B48)+(B237), (A)+(B48)+(B238), (A)+(B48)+(B239), (A)+(B48)+(B240), (A)+(B48)+(B241), (A)+(B48)+(B242), (A)+(B48)+(B243), (A)+(B48)+(B244), (A)+(B48)+(B245), (A)+(B48)+(B246), (A)+(B48)+(B247), (A)+(B48)+(B248), (A)+(B48)+(B249), (A)+(B48)+(B250), (A)+(B48)+(B251), (A)+(B48)+(B252), (A)+(B48)+(B253), (A)+(B48)+(B254), (A)+(B48)+(B255), (A)+(B48)+(B256), (A)+(B48)+(B257), (A)+(B48)+(B258), (A)+(B48)+(B259), (A)+(B48)+(B260), (A)+(B48)+(B261), (A)+(B48)+(B262), (A)+(B48)+(B263), (A)+(B48)+(B264), (A)+(B48)+(B265), (A)+(B48)+(B266), (A)+(B48)+(B267), (A)+(B48)+(B268), (A)+(B48)+(B269), (A)+(B48)+(B270), (A)+(B48)+(B271), (A)+(B48)+(B272), (A)+(B48)+(B273), (A)+(B48)+(B274), (A)+(B48)+(B275), (A)+(B48)+(B276), (A)+(B48)+(B277), (A)+(B48)+(B278), (A)+(B48)+(B279), (A)+(B48)+(B280), (A)+(B48)+(B281), (A)+(B48)+(B282), (A)+(B48)+(B283), (A)+(B48)+(B284), (A)+(B48)+(B285), (A)+(B48)+(B286), (A)+(B48)+(B287), (A)+(B48)+(B288), (A)+(B48)+(B289), (A)+(B48)+(B290), (A)+(B48)+(B291), (A)+(B48)+(B292), (A)+(B48)+(B293), (A)+(B48)+(B294), (A)+(B48)+(B295), (A)+(B48)+(B296), (A)+(B48)+(B297), (A)+(B48)+(B298), (A)+(B48)+(B299), (A)+(B48)+(B300), (A)+(B48)+(B301), (A)+(B48)+(B302), (A)+(B48)+(B303), (A)+(B48)+(B304), (A)+(B48)+(B305), (A)+(B48)+(B306), (A)+(B48)+(B307), (A)+(B48)+(B308), (A)+(B48)+(B309), (A)+(B48)+(B310), (A)+(B48)+(B311), (A)+(B48)+(B312), (A)+(B48)+(B313), (A)+(B48)+(B314), (A)+(B48)+(B315),

(A)+(B49)+(B50), (A)+(B49)+(B51), (A)+(B49)+(B52), (A)+(B49)+(B53), (A)+(B49)+(B54), (A)+(B49)+(B55), (A)+(B49)+(B56), (A)+(B49)+(B57), (A)+(B49)+(B58), (A)+(B49)+(B59), (A)+(B49)+(B60), (A)+(B49)+(B61), (A)+(B49)+(B62), (A)+(B49)+(B63), (A)+(B49)+(B64), (A)+(B49)+(B65), (A)+(B49)+(B66), (A)+(B49)+(B67), (A)+(B49)+(B68), (A)+(B49)+(B69), (A)+(B49)+(B70), (A)+(B49)+(B71), (A)+(B49)+(B72), (A)+(B49)+(B73), (A)+(B49)+(B74), (A)+(B49)+(B75), (A)+(B49)+(B76), (A)+(B49)+(B77), (A)+(B49)+(B78), (A)+(B49)+(B79), (A)+(B49)+(B80), (A)+(B49)+(B81), (A)+(B49)+(B82), (A)+(B49)+(B83), (A)+(B49)+(B84), (A)+(B49)+(B85), (A)+(B49)+(B86), (A)+(B49)+(B87), (A)+(B49)+(B88), (A)+(B49)+(B89), (A)+(B49)+(B90), (A)+(B49)+(B91), (A)+(B49)+(B92), (A)+(B49)+(B93), (A)+(B49)+(B94), (A)+(B49)+(B95), (A)+(B49)+(B96), (A)+(B49)+(B97), (A)+(B49)+(B98), (A)+(B49)+(B99), (A)+(B49)+(B100), (A)+(B49)+(B101), (A)+(B49)+(B102), (A)+(B49)+(B103), (A)+(B49)+(B104), (A)+(B49)+(B105), (A)+(B49)+(B106), (A)+(B49)+(B107), (A)+(B49)+(B108), (A)+(B49)+(B109), (A)+(B49)+(B110), (A)+(B49)+(B111), (A)+(B49)+(B112), (A)+(B49)+(B113), (A)+(B49)+(B114), (A)+(B49)+(B115), (A)+(B49)+(B116), (A)+(B49)+(B117), (A)+(B49)+(B118), (A)+(B49)+(B119), (A)+(B49)+(B120), (A)+(B49)+(B121), (A)+(B49)+(B122), (A)+(B49)+(B123), (A)+(B49)+(B124), (A)+(B49)+(B125), (A)+(B49)+(B126), (A)+(B49)+(B127), (A)+(B49)+(B128), (A)+(B49)+(B129), (A)+(B49)+(B130), (A)+(B49)+(B131), (A)+(B49)+(B132), (A)+(B49)+(B133), (A)+(B49)+(B134), (A)+(B49)+(B135), (A)+(B49)+(B136), (A)+(B49)+(B137), (A)+(B49)+(B138), (A)+(B49)+(B139), (A)+(B49)+(B140), (A)+(B49)+(B141), (A)+(B49)+(B142), (A)+(B49)+(B143), (A)+(B49)+(B144), (A)+(B49)+(B145), (A)+(B49)+(B146), (A)+(B49)+(B147), (A)+(B49)+(B148), (A)+(B49)+(B149), (A)+(B49)+(B150), (A)+(B49)+(B151), (A)+(B49)+(B152), (A)+(B49)+(B153), (A)+(B49)+(B154), (A)+(B49)+(B155), (A)+(B49)+(B156), (A)+(B49)+(B157), (A)+(B49)+(B158), (A)+(B49)+(B159), (A)+(B49)+(B160), (A)+(B49)+(B161), (A)+(B49)+(B162), (A)+(B49)+(B164), (A)+(B49)+(B164), (A)+(B49)+(B165), (A)+(B49)+(B166), (A)+(B49)+(B167), (A)+(B49)+(B168), (A)+(B49)+(B169), (A)+(B49)+(B170), (A)+(B49)+(B171), (A)+(B49)+(B172), (A)+(B49)+(B173), (A)+(B49)+(B174), (A)+(B49)+(B175), (A)+(B49)+(B176), (A)+(B49)+(B177), (A)+(B49)+(B178), (A)+(B49)+(B179), (A)+(B49)+(B180), (A)+(B49)+(B181), (A)+(B49)+(B182), (A)+(B49)+(B183), (A)+(B49)+(B184), (A)+(B49)+(B185), (A)+(B49)+(B186), (A)+(B49)+(B187), (A)+(B49)+(B188), (A)+(B49)+(B189), (A)+(B49)+(B190), (A)+(B49)+(B191), (A)+(B49)+(B192), (A)+(B49)+(B193), (A)+(B49)+(B194), (A)+(B49)+(B195), (A)+(B49)+(B196), (A)+(B49)+(B197), (A)+(B49)+(B198), (A)+(B49)+(B199), (A)+(B49)+(B200), (A)+(B49)+(B201), (A)+(B49)+(B202), (A)+(B49)+(B203), (A)+(B49)+(B204), (A)+(B49)+(B205), (A)+(B49)+(B206), (A)+(B49)+(B207), (A)+(B49)+(B208), (A)+(B49)+(B209), (A)+(B49)+(B210), (A)+(B49)+(B211), (A)+(B49)+(B212), (A)+(B49)+(B213), (A)+(B49)+(B214), (A)+(B49)+(B215), (A)+(B49)+(B216), (A)+(B49)+(B217), (A)+(B49)+(B218), (A)+(B49)+(B219), (A)+(B49)+(B220), (A)+(B49)+(B221), (A)+(B49)+(B222), (A)+(B49)+(B223), (A)+(B49)+(B224), (A)+(B49)+(B225), (A)+(B49)+(B226), (A)+(B49)+(B227), (A)+(B49)+(B228), (A)+(B49)+(B229), (A)+(B49)+(B230), (A)+(B49)+(B231), (A)+(B49)+(B232), (A)+(B49)+(B233), (A)+(B49)+(B234), (A)+(B49)+(B235), (A)+(B49)+(B236), (A)+(B49)+(B237), (A)+(B49)+(B238), (A)+(B49)+(B239), (A)+(B49)+(B240), (A)+(B49)+(B241), (A)+(B49)+(B242), (A)+(B49)+(B243), (A)+(B49)+(B244), (A)+(B49)+(B245), (A)+(B49)+(B246), (A)+(B49)+(B247), (A)+(B49)+(B248), (A)+(B49)+(B249), (A)+(B49)+(B250), (A)+(B49)+(B251), (A)+(B49)+(B252), (A)+(B49)+(B253), (A)+(B49)+(B254), (A)+(B49)+(B255), (A)+(B49)+(B256), (A)+(B49)+(B257), (A)+(B49)+(B258), (A)+(B49)+(B259), (A)+(B49)+(B260), (A)+(B49)+(B261), (A)+(B49)+(B262), (A)+(B49)+(B263), (A)+(B49)+(B264), (A)+(B49)+(B265), (A)+(B49)+(B266), (A)+(B49)+(B267), (A)+(B49)+(B268), (A)+(B49)+(B269), (A)+(B49)+(B270), (A)+(B49)+(B271), (A)+(B49)+(B272), (A)+(B49)+(B273), (A)+(B49)+(B274), (A)+(B49)+(B275), (A)+(B49)+(B276), (A)+(B49)+(B277), (A)+(B49)+(B278), (A)+(B49)+(B279), (A)+(B49)+(B280), (A)+(B49)+(B281), (A)+(B49)+(B282), (A)+(B49)+(B283), (A)+(B49)+(B284), (A)+(B49)+(B285), (A)+(B49)+(B286), (A)+(B49)+(B287), (A)+(B49)+(B288), (A)+(B49)+(B289), (A)+(B49)+(B290), (A)+(B49)+(B291), (A)+(B49)+(B292), (A)+(B49)+(B293), (A)+(B49)+(B294), (A)+(B49)+(B295), (A)+(B49)+(B296), (A)+(B49)+(B297), (A)+(B49)+(B298), (A)+(B49)+(B299), (A)+(B49)+(B300), (A)+(B49)+(B301), (A)+(B49)+(B302), (A)+(B49)+(B303), (A)+(B49)+(B304), (A)+(B49)+(B305), (A)+(B49)+(B306), (A)+(B49)+(B307), (A)+(B49)+(B308), (A)+(B49)+(B309), (A)+(B49)+(B310), (A)+(B49)+(B311), (A)+(B49)+(B312), (A)+(B49)+(B313), (A)+(B49)+(B314), (A)+(B49)+(B315),

(A)+(B50)+(B51), (A)+(B50)+(B52), (A)+(B50)+(B53), (A)+(B50)+(B54), (A)+(B50)+(B55), (A)+(B50)+(B56), (A)+(B50)+(B57), (A)+(B50)+(B58), (A)+(B50)+(B59), (A)+(B50)+(B60), (A)+(B50)+(B61), (A)+(B50)+(B62), (A)+(B50)+(B63), (A)+(B50)+(B64), (A)+(B50)+(B65), (A)+(B50)+(B66), (A)+(B50)+(B67), (A)+(B50)+(B68), (A)+(B50)+(B69), (A)+(B50)+(B70), (A)+(B50)+(B71), (A)+(B50)+(B72), (A)+(B50)+(B73), (A)+(B50)+(B74), (A)+(B50)+(B75), (A)+(B50)+(B76), (A)+(B50)+(B77), (A)+(B50)+(B78), (A)+(B50)+(B79), (A)+(B50)+(B80), (A)+(B50)+(B81), (A)+(B50)+(B82), (A)+(B50)+(B83), (A)+(B50)+(B84), (A)+(B50)+(B85), (A)+(B50)+(B86), (A)+(B50)+(B87), (A)+(B50)+(B88), (A)+(B50)+(B89), (A)+(B50)+(B90), (A)+(B50)+(B91), (A)+(B50)+(B92), (A)+(B50)+(B93), (A)+(B50)+(B94), (A)+(B50)+(B95), (A)+(B50)+(B96), (A)+(B50)+(B97), (A)+(B50)+(B98), (A)+(B50)+(B99), (A)+(B50)+(B100), (A)+(B50)+(B101), (A)+(B50)+(B102), (A)+(B50)+(B103), (A)+(B50)+(B104), (A)+(B50)+(B105), (A)+(B50)+(B106), (A)+(B50)+(B107), (A)+(B50)+(B108), (A)+(B50)+(B109), (A)+(B50)+(B110), (A)+(B50)+(B111), (A)+(B50)+(B112), (A)+(B50)+(B113), (A)+(B50)+(B114), (A)+(B50)+(B115), (A)+(B50)+(B116), (A)+(B50)+(B117), (A)+(B50)+(B118), (A)+(B50)+(B119), (A)+(B50)+(B120), (A)+(B50)+(B121), (A)+(B50)+(B122), (A)+(B50)+(B123), (A)+(B50)+(B124), (A)+(B50)+(B125), (A)+(B50)+(B126), (A)+(B50)+(B127), (A)+(B50)+(B128), (A)+(B50)+(B129), (A)+(B50)+(B130), (A)+(B50)+(B131), (A)+(B50)+(B132), (A)+(B50)+(B133), (A)+(B50)+(B134), (A)+(B50)+(B135), (A)+(B50)+(B136), (A)+(B50)+(B137), (A)+(B50)+(B138), (A)+(B50)+(B139), (A)+(B50)+(B140), (A)+(B50)+(B141), (A)+(B50)+(B142), (A)+(B50)+(B143), (A)+(B50)+(B144), (A)+(B50)+(B145), (A)+(B50)+(B146), (A)+(B50)+(B147), (A)+(B50)+(B148), (A)+(B50)+(B149), (A)+(B50)+(B150), (A)+(B50)+(B151), (A)+(B50)+(B152), (A)+(B50)+(B153), (A)+(B50)+(B154), (A)+(B50)+(B155), (A)+(B50)+(B156), (A)+(B50)+(B157), (A)+(B50)+(B158), (A)+(B50)+(B159), (A)+(B50)+(B160), (A)+(B50)+(B161), (A)+(B50)+(B162), (A)+(B50)+(B164), (A)+(B50)+(B164), (A)+(B50)+(B165), (A)+(B50)+(B166), (A)+(B50)+(B167), (A)+(B50)+(B168), (A)+(B50)+(B169), (A)+(B50)+(B170), (A)+(B50)+(B171), (A)+(B50)+(B172), (A)+(B50)+(B173), (A)+(B50)+(B174), (A)+(B50)+(B175), (A)+(B50)+(B176), (A)+(B50)+(B177), (A)+(B50)+(B178), (A)+(B50)+(B179), (A)+(B50)+(B180), (A)+(B50)+(B181), (A)+(B50)+(B182), (A)+(B50)+(B183), (A)+(B50)+(B184), (A)+(B50)+(B185), (A)+(B50)+(B186), (A)+(B50)+(B187), (A)+(B50)+(B188), (A)+(B50)+(B189), (A)+(B50)+(B190), (A)+(B50)+(B191), (A)+(B50)+(B192), (A)+(B50)+(B193), (A)+(B50)+(B194), (A)+(B50)+(B195), (A)+(B50)+(B196), (A)+(B50)+(B197), (A)+(B50)+(B198), (A)+(B50)+(B199), (A)+(B50)+(B200), (A)+(B50)+(B201), (A)+(B50)+(B202), (A)+(B50)+(B203), (A)+(B50)+(B204), (A)+(B50)+(B205), (A)+(B50)+(B206), (A)+(B50)+(B207), (A)+(B50)+(B208), (A)+(B50)+(B209), (A)+(B50)+(B210), (A)+(B50)+(B211), (A)+(B50)+(B212), (A)+(B50)+(B213), (A)+(B50)+(B214), (A)+(B50)+(B215), (A)+(B50)+(B216), (A)+(B50)+(B217), (A)+(B50)+(B218), (A)+(B50)+(B219), (A)+(B50)+(B220), (A)+(B50)+(B221), (A)+(B50)+(B222), (A)+(B50)+(B223), (A)+(B50)+(B224), (A)+(B50)+(B225), (A)+(B50)+(B226), (A)+(B50)+(B227), (A)+(B50)+(B228), (A)+(B50)+(B229), (A)+(B50)+(B230), (A)+(B50)+(B231), (A)+(B50)+(B232), (A)+(B50)+(B233), (A)+(B50)+(B234), (A)+(B50)+(B235), (A)+(B50)+(B236), (A)+(B50)+(B237), (A)+(B50)+(B238), (A)+(B50)+(B239), (A)+(B50)+(B240), (A)+(B50)+(B241), (A)+(B50)+(B242), (A)+(B50)+(B243), (A)+(B50)+(B244), (A)+(B50)+(B245), (A)+(B50)+(B246), (A)+(B50)+(B247), (A)+(B50)+(B248), (A)+(B50)+(B249), (A)+(B50)+(B250), (A)+(B50)+(B251), (A)+(B50)+(B252), (A)+(B50)+(B253), (A)+(B50)+(B254), (A)+(B50)+(B255), (A)+(B50)+(B256), (A)+(B50)+(B257), (A)+(B50)+(B258), (A)+(B50)+(B259), (A)+(B50)+(B260), (A)+(B50)+(B261), (A)+(B50)+(B262), (A)+(B50)+(B263), (A)+(B50)+(B264), (A)+(B50)+(B265), (A)+(B50)+(B266), (A)+(B50)+(B267), (A)+(B50)+(B268), (A)+(B50)+(B269), (A)+(B50)+(B270), (A)+(B50)+(B271), (A)+(B50)+(B272), (A)+(B50)+(B273), (A)+(B50)+(B274), (A)+(B50)+(B275), (A)+(B50)+(B276), (A)+(B50)+(B277), (A)+(B50)+(B278), (A)+(B50)+(B279), (A)+(B50)+(B280), (A)+(B50)+(B281), (A)+(B50)+(B282), (A)+(B50)+(B283), (A)+(B50)+(B284), (A)+(B50)+(B285), (A)+(B50)+(B286), (A)+(B50)+(B287), (A)+(B50)+(B288), (A)+(B50)+(B289), (A)+(B50)+(B290), (A)+(B50)+(B291), (A)+(B50)+(B292), (A)+(B50)+(B293), (A)+(B50)+(B294), (A)+(B50)+(B295), (A)+(B50)+(B296), (A)+(B50)+(B297), (A)+(B50)+(B298), (A)+(B50)+(B299), (A)+(B50)+(B300), (A)+(B50)+(B301), (A)+(B50)+(B302), (A)+(B50)+(B303), (A)+(B50)+(B304), (A)+(B50)+(B305), (A)+(B50)+(B306), (A)+(B50)+(B307), (A)+(B50)+(B308), (A)+(B50)+(B309), (A)+(B50)+(B310), (A)+(B50)+(B311), (A)+(B50)+(B312), (A)+(B50)+(B313), (A)+(B50)+(B314), (A)+(B50)+(B315),

(A)+(B51)+(B52), (A)+(B51)+(B53), (A)+(B51)+(B54), (A)+(B51)+(B55), (A)+(B51)+(B56), (A)+(B51)+(B57), (A)+(B51)+(B58), (A)+(B51)+(B59), (A)+(B51)+(B60), (A)+(B51)+(B61), (A)+(B51)+(B62), (A)+(B51)+(B63), (A)+(B51)+(B64), (A)+(B51)+(B65), (A)+(B51)+(B66), (A)+(B51)+(B67), (A)+(B51)+(B68), (A)+(B51)+(B69), (A)+(B51)+(B70), (A)+(B51)+(B71), (A)+(B51)+(B72), (A)+(B51)+(B73), (A)+(B51)+(B74), (A)+(B51)+(B75), (A)+(B51)+(B76), (A)+(B51)+(B77), (A)+(B51)+(B78), (A)+(B51)+(B79), (A)+(B51)+(B80), (A)+(B51)+(B81), (A)+(B51)+(B82), (A)+(B51)+(B83), (A)+(B51)+(B84), (A)+(B51)+(B85), (A)+(B51)+(B86), (A)+(B51)+(B87), (A)+(B51)+(B88), (A)+(B51)+(B89), (A)+(B51)+(B90), (A)+(B51)+(B91), (A)+(B51)+(B92), (A)+(B51)+(B93), (A)+(B51)+(B94), (A)+(B51)+(B95), (A)+(B51)+(B96), (A)+(B51)+(B97), (A)+(B51)+(B98), (A)+(B51)+(B99), (A)+(B51)+(B100), (A)+(B51)+(B101), (A)+(B51)+(B102), (A)+(B51)+(B103), (A)+(B51)+(B104), (A)+(B51)+(B105), (A)+(B51)+(B106), (A)+(B51)+(B107), (A)+(B51)+(B108), (A)+(B51)+(B109), (A)+(B51)+(B110), (A)+(B51)+(B111), (A)+(B51)+(B112), (A)+(B51)+(B113), (A)+(B51)+(B114), (A)+(B51)+(B115), (A)+(B51)+(B116), (A)+(B51)+(B117), (A)+(B51)+(B118), (A)+(B51)+(B119), (A)+(B51)+(B120), (A)+(B51)+(B121), (A)+(B51)+(B122), (A)+(B51)+(B123), (A)+(B51)+(B124), (A)+(B51)+(B125), (A)+(B51)+(B126), (A)+(B51)+(B127), (A)+(B51)+(B128), (A)+(B51)+(B129), (A)+(B51)+(B130), (A)+(B51)+(B131), (A)+(B51)+(B132), (A)+(B51)+(B133), (A)+(B51)+(B134), (A)+(B51)+(B135), (A)+(B51)+(B136), (A)+(B51)+(B137), (A)+(B51)+(B138), (A)+(B51)+(B139), (A)+(B51)+(B140), (A)+(B51)+(B141), (A)+(B51)+(B142), (A)+(B51)+(B143), (A)+(B51)+(B144), (A)+(B51)+(B145), (A)+(B51)+(B146), (A)+(B51)+(B147), (A)+(B51)+(B148), (A)+(B51)+(B149), (A)+(B51)+(B150), (A)+(B51)+(B151), (A)+(B51)+(B152), (A)+(B51)+(B153), (A)+(B51)+(B154), (A)+(B51)+(B155), (A)+(B51)+(B156), (A)+(B51)+(B157), (A)+(B51)+(B158), (A)+(B51)+(B159), (A)+(B51)+(B160), (A)+(B51)+(B161), (A)+(B51)+(B162), (A)+(B51)+(B164), (A)+(B51)+(B164), (A)+(B51)+(B165), (A)+(B51)+(B166), (A)+(B51)+(B167), (A)+(B51)+(B168), (A)+(B51)+(B169), (A)+(B51)+(B170), (A)+(B51)+(B171), (A)+(B51)+(B172), (A)+(B51)+(B173), (A)+(B51)+(B174), (A)+(B51)+(B175), (A)+(B51)+(B176), (A)+(B51)+(B177), (A)+(B51)+(B178), (A)+(B51)+(B179), (A)+(B51)+(B180), (A)+(B51)+(B181), (A)+(B51)+(B182), (A)+(B51)+(B183), (A)+(B51)+(B184), (A)+(B51)+(B185), (A)+(B51)+(B186), (A)+(B51)+(B187), (A)+(B51)+(B188), (A)+(B51)+(B189), (A)+(B51)+(B190), (A)+(B51)+(B191), (A)+(B51)+(B192), (A)+(B51)+(B193), (A)+(B51)+(B194), (A)+(B51)+(B195), (A)+(B51)+(B196), (A)+(B51)+(B197), (A)+(B51)+(B198), (A)+(B51)+(B199), (A)+(B51)+(B200), (A)+(B51)+(B201), (A)+(B51)+(B202), (A)+(B51)+(B203), (A)+(B51)+(B204), (A)+(B51)+(B205), (A)+(B51)+(B206), (A)+(B51)+(B207), (A)+(B51)+(B208), (A)+(B51)+(B209), (A)+(B51)+(B210), (A)+(B51)+(B211), (A)+(B51)+(B212), (A)+(B51)+(B213), (A)+(B51)+(B214), (A)+(B51)+(B215), (A)+(B51)+(B216), (A)+(B51)+(B217), (A)+(B51)+(B218), (A)+(B51)+(B219), (A)+(B51)+(B220), (A)+(B51)+(B221), (A)+(B51)+(B222), (A)+(B51)+(B223), (A)+(B51)+(B224), (A)+(B51)+(B225), (A)+(B51)+(B226), (A)+(B51)+(B227), (A)+(B51)+(B228), (A)+(B51)+(B229), (A)+(B51)+(B230), (A)+(B51)+(B231), (A)+(B51)+(B232), (A)+(B51)+(B233), (A)+(B51)+(B234), (A)+(B51)+(B235), (A)+(B51)+(B236), (A)+(B51)+(B237), (A)+(B51)+(B238), (A)+(B51)+(B239), (A)+(B51)+(B240), (A)+(B51)+(B241), (A)+(B51)+(B242), (A)+(B51)+(B243), (A)+(B51)+(B244), (A)+(B51)+(B245), (A)+(B51)+(B246), (A)+(B51)+(B247), (A)+(B51)+(B248), (A)+(B51)+(B249), (A)+(B51)+(B250), (A)+(B51)+(B251), (A)+(B51)+(B252), (A)+(B51)+(B253), (A)+(B51)+(B254), (A)+(B51)+(B255), (A)+(B51)+(B256), (A)+(B51)+(B257), (A)+(B51)+(B258), (A)+(B51)+(B259), (A)+(B51)+(B260), (A)+(B51)+(B261), (A)+(B51)+(B262), (A)+(B51)+(B263), (A)+(B51)+(B264), (A)+(B51)+(B265), (A)+(B51)+(B266), (A)+(B51)+(B267), (A)+(B51)+(B268), (A)+(B51)+(B269), (A)+(B51)+(B270), (A)+(B51)+(B271), (A)+(B51)+(B272), (A)+(B51)+(B273), (A)+(B51)+(B274), (A)+(B51)+(B275), (A)+(B51)+(B276), (A)+(B51)+(B277), (A)+(B51)+(B278), (A)+(B51)+(B279), (A)+(B51)+(B280), (A)+(B51)+(B281), (A)+(B51)+(B282), (A)+(B51)+(B283), (A)+(B51)+(B284), (A)+(B51)+(B285), (A)+(B51)+(B286), (A)+(B51)+(B287), (A)+(B51)+(B288), (A)+(B51)+(B289), (A)+(B51)+(B290), (A)+(B51)+(B291), (A)+(B51)+(B292), (A)+(B51)+(B293), (A)+(B51)+(B294), (A)+(B51)+(B295), (A)+(B51)+(B296), (A)+(B51)+(B297), (A)+(B51)+(B298), (A)+(B51)+(B299), (A)+(B51)+(B300), (A)+(B51)+(B301), (A)+(B51)+(B302), (A)+(B51)+(B303), (A)+(B51)+(B304), (A)+(B51)+(B305), (A)+(B51)+(B306), (A)+(B51)+(B307), (A)+(B51)+(B308), (A)+(B51)+(B309), (A)+(B51)+(B310), (A)+(B51)+(B311), (A)+(B51)+(B312), (A)+(B51)+(B313), (A)+(B51)+(B314), (A)+(B51)+(B315),

(A)+(B52)+(B53), (A)+(B52)+(B54), (A)+(B52)+(B55), (A)+(B52)+(B56), (A)+(B52)+(B57), (A)+(B52)+(B58), (A)+(B52)+(B59), (A)+(B52)+(B60), (A)+(B52)+(B61), (A)+(B52)+(B62), (A)+(B52)+(B63), (A)+(B52)+(B64), (A)+(B52)+(B65), (A)+(B52)+(B66), (A)+(B52)+(B67), (A)+(B52)+(B68), (A)+(B52)+(B69), (A)+(B52)+(B70), (A)+(B52)+(B71), (A)+(B52)+(B72), (A)+(B52)+(B73), (A)+(B52)+(B74), (A)+(B52)+(B75), (A)+(B52)+(B76), (A)+(B52)+(B77), (A)+(B52)+(B78), (A)+(B52)+(B79), (A)+(B52)+(B80), (A)+(B52)+(B81), (A)+(B52)+(B82), (A)+(B52)+(B83), (A)+(B52)+(B84), (A)+(B52)+(B85), (A)+(B52)+(B86), (A)+(B52)+(B87), (A)+(B52)+(B88), (A)+(B52)+(B89), (A)+(B52)+(B90), (A)+(B52)+(B91), (A)+(B52)+(B92), (A)+(B52)+(B93), (A)+(B52)+(B94), (A)+(B52)+(B95), (A)+(B52)+(B96), (A)+(B52)+(B97), (A)+(B52)+(B98), (A)+(B52)+(B99), (A)+(B52)+(B100), (A)+(B52)+(B101), (A)+(B52)+(B102), (A)+(B52)+(B103), (A)+(B52)+(B104), (A)+(B52)+(B105), (A)+(B52)+(B106), (A)+(B52)+(B107), (A)+(B52)+(B108), (A)+(B52)+(B109), (A)+(B52)+(B110), (A)+(B52)+(B111), (A)+(B52)+(B112), (A)+(B52)+(B113), (A)+(B52)+(B114), (A)+(B52)+(B115), (A)+(B52)+(B116), (A)+(B52)+(B117), (A)+(B52)+(B118), (A)+(B52)+(B119), (A)+(B52)+(B120), (A)+(B52)+(B121), (A)+(B52)+(B122), (A)+(B52)+(B123), (A)+(B52)+(B124), (A)+(B52)+(B125), (A)+(B52)+(B126), (A)+(B52)+(B127), (A)+(B52)+(B128), (A)+(B52)+(B129), (A)+(B52)+(B130), (A)+(B52)+(B131), (A)+(B52)+(B132), (A)+(B52)+(B133), (A)+(B52)+(B134), (A)+(B52)+(B135), (A)+(B52)+(B136), (A)+(B52)+(B137), (A)+(B52)+(B138), (A)+(B52)+(B139), (A)+(B52)+(B140), (A)+(B52)+(B141), (A)+(B52)+(B142), (A)+(B52)+(B143), (A)+(B52)+(B144), (A)+(B52)+(B145), (A)+(B52)+(B146), (A)+(B52)+(B147), (A)+(B52)+(B148), (A)+(B52)+(B149), (A)+(B52)+(B150), (A)+(B52)+(B151), (A)+(B52)+(B152), (A)+(B52)+(B153), (A)+(B52)+(B154), (A)+(B52)+(B155), (A)+(B52)+(B156), (A)+(B52)+(B157), (A)+(B52)+(B158), (A)+(B52)+(B159), (A)+(B52)+(B160), (A)+(B52)+(B161), (A)+(B52)+(B162), (A)+(B52)+(B164), (A)+(B52)+(B164), (A)+(B52)+(B165), (A)+(B52)+(B166), (A)+(B52)+(B167), (A)+(B52)+(B168), (A)+(B52)+(B169), (A)+(B52)+(B170), (A)+(B52)+(B171), (A)+(B52)+(B172), (A)+(B52)+(B173), (A)+(B52)+(B174), (A)+(B52)+(B175), (A)+(B52)+(B176), (A)+(B52)+(B177), (A)+(B52)+(B178), (A)+(B52)+(B179), (A)+(B52)+(B180), (A)+(B52)+(B181), (A)+(B52)+(B182), (A)+(B52)+(B183), (A)+(B52)+(B184), (A)+(B52)+(B185), (A)+(B52)+(B186), (A)+(B52)+(B187), (A)+(B52)+(B188), (A)+(B52)+(B189), (A)+(B52)+(B190), (A)+(B52)+(B191), (A)+(B52)+(B192), (A)+(B52)+(B193), (A)+(B52)+(B194), (A)+(B52)+(B195), (A)+(B52)+(B196), (A)+(B52)+(B197), (A)+(B52)+(B198), (A)+(B52)+(B199), (A)+(B52)+(B200), (A)+(B52)+(B201), (A)+(B52)+(B202), (A)+(B52)+(B203), (A)+(B52)+(B204), (A)+(B52)+(B205), (A)+(B52)+(B206), (A)+(B52)+(B207), (A)+(B52)+(B208), (A)+(B52)+(B209), (A)+(B52)+(B210), (A)+(B52)+(B211), (A)+(B52)+(B212), (A)+(B52)+(B213), (A)+(B52)+(B214), (A)+(B52)+(B215), (A)+(B52)+(B216), (A)+(B52)+(B217), (A)+(B52)+(B218), (A)+(B52)+(B219), (A)+(B52)+(B220), (A)+(B52)+(B221), (A)+(B52)+(B222), (A)+(B52)+(B223), (A)+(B52)+(B224), (A)+(B52)+(B225), (A)+(B52)+(B226), (A)+(B52)+(B227), (A)+(B52)+(B228), (A)+(B52)+(B229), (A)+(B52)+(B230), (A)+(B52)+(B231), (A)+(B52)+(B232), (A)+(B52)+(B233), (A)+(B52)+(B234), (A)+(B52)+(B235), (A)+(B52)+(B236), (A)+(B52)+(B237), (A)+(B52)+(B238), (A)+(B52)+(B239), (A)+(B52)+(B240), (A)+(B52)+(B241), (A)+(B52)+(B242), (A)+(B52)+(B243), (A)+(B52)+(B244), (A)+(B52)+(B245), (A)+(B52)+(B246), (A)+(B52)+(B247), (A)+(B52)+(B248), (A)+(B52)+(B249), (A)+(B52)+(B250), (A)+(B52)+(B251), (A)+(B52)+(B252), (A)+(B52)+(B253), (A)+(B52)+(B254), (A)+(B52)+(B255), (A)+(B52)+(B256), (A)+(B52)+(B257), (A)+(B52)+(B258), (A)+(B52)+(B259), (A)+(B52)+(B260), (A)+(B52)+(B261), (A)+(B52)+(B262), (A)+(B52)+(B263), (A)+(B52)+(B264), (A)+(B52)+(B265), (A)+(B52)+(B266), (A)+(B52)+(B267), (A)+(B52)+(B268), (A)+(B52)+(B269), (A)+(B52)+(B270), (A)+(B52)+(B271), (A)+(B52)+(B272), (A)+(B52)+(B273), (A)+(B52)+(B274), (A)+(B52)+(B275), (A)+(B52)+(B276), (A)+(B52)+(B277), (A)+(B52)+(B278), (A)+(B52)+(B279), (A)+(B52)+(B280), (A)+(B52)+(B281), (A)+(B52)+(B282), (A)+(B52)+(B283), (A)+(B52)+(B284), (A)+(B52)+(B285), (A)+(B52)+(B286), (A)+(B52)+(B287), (A)+(B52)+(B288), (A)+(B52)+(B289), (A)+(B52)+(B290), (A)+(B52)+(B291), (A)+(B52)+(B292), (A)+(B52)+(B293), (A)+(B52)+(B294), (A)+(B52)+(B295), (A)+(B52)+(B296), (A)+(B52)+(B297), (A)+(B52)+(B298), (A)+(B52)+(B299), (A)+(B52)+(B300), (A)+(B52)+(B301), (A)+(B52)+(B302), (A)+(B52)+(B303), (A)+(B52)+(B304), (A)+(B52)+(B305), (A)+(B52)+(B306), (A)+(B52)+(B307), (A)+(B52)+(B308), (A)+(B52)+(B309), (A)+(B52)+(B310), (A)+(B52)+(B311), (A)+(B52)+(B312), (A)+(B52)+(B313), (A)+(B52)+(B314), (A)+(B52)+(B315),

(A)+(B53)+(B54), (A)+(B53)+(B55), (A)+(B53)+(B56), (A)+(B53)+(B57), (A)+(B53)+(B58), (A)+(B53)+(B59), (A)+(B53)+(B60), (A)+(B53)+(B61), (A)+(B53)+(B62), (A)+(B53)+(B63), (A)+(B53)+(B64), (A)+(B53)+(B65), (A)+(B53)+(B66), (A)+(B53)+(B67), (A)+(B53)+(B68), (A)+(B53)+(B69), (A)+(B53)+(B70), (A)+(B53)+(B71), (A)+(B53)+(B72), (A)+(B53)+(B73), (A)+(B53)+(B74), (A)+(B53)+(B75), (A)+(B53)+(B76), (A)+(B53)+(B77), (A)+(B53)+(B78), (A)+(B53)+(B79), (A)+(B53)+(B80), (A)+(B53)+(B81), (A)+(B53)+(B82), (A)+(B53)+(B83), (A)+(B53)+(B84), (A)+(B53)+(B85), (A)+(B53)+(B86), (A)+(B53)+(B87), (A)+(B53)+(B88), (A)+(B53)+(B89), (A)+(B53)+(B90), (A)+(B53)+(B91), (A)+(B53)+(B92), (A)+(B53)+(B93), (A)+(B53)+(B94), (A)+(B53)+(B95), (A)+(B53)+(B96), (A)+(B53)+(B97), (A)+(B53)+(B98), (A)+(B53)+(B99), (A)+(B53)+(B100), (A)+(B53)+(B101), (A)+(B53)+(B102), (A)+(B53)+(B103), (A)+(B53)+(B104), (A)+(B53)+(B105), (A)+(B53)+(B106), (A)+(B53)+(B107), (A)+(B53)+(B108), (A)+(B53)+(B109), (A)+(B53)+(B110), (A)+(B53)+(B111), (A)+(B53)+(B112), (A)+(B53)+(B113), (A)+(B53)+(B114), (A)+(B53)+(B115), (A)+(B53)+(B116), (A)+(B53)+(B117), (A)+(B53)+(B118), (A)+(B53)+(B119), (A)+(B53)+(B120), (A)+(B53)+(B121), (A)+(B53)+(B122), (A)+(B53)+(B123), (A)+(B53)+(B124), (A)+(B53)+(B125), (A)+(B53)+(B126), (A)+(B53)+(B127), (A)+(B53)+(B128), (A)+(B53)+(B129), (A)+(B53)+(B130), (A)+(B53)+(B131), (A)+(B53)+(B132), (A)+(B53)+(B133), (A)+(B53)+(B134), (A)+(B53)+(B135), (A)+(B53)+(B136), (A)+(B53)+(B137), (A)+(B53)+(B138), (A)+(B53)+(B139), (A)+(B53)+(B140), (A)+(B53)+(B141), (A)+(B53)+(B142), (A)+(B53)+(B143), (A)+(B53)+(B144), (A)+(B53)+(B145), (A)+(B53)+(B146), (A)+(B53)+(B147), (A)+(B53)+(B148), (A)+(B53)+(B149), (A)+(B53)+(B150), (A)+(B53)+(B151), (A)+(B53)+(B152), (A)+(B53)+(B153), (A)+(B53)+(B154), (A)+(B53)+(B155), (A)+(B53)+(B156), (A)+(B53)+(B157), (A)+(B53)+(B158), (A)+(B53)+(B159), (A)+(B53)+(B160), (A)+(B53)+(B161), (A)+(B53)+(B162), (A)+(B53)+(B164), (A)+(B53)+(B164), (A)+(B53)+(B165), (A)+(B53)+(B166), (A)+(B53)+(B167), (A)+(B53)+(B168), (A)+(B53)+(B169), (A)+(B53)+(B170), (A)+(B53)+(B171), (A)+(B53)+(B172), (A)+(B53)+(B173), (A)+(B53)+(B174), (A)+(B53)+(B175), (A)+(B53)+(B176), (A)+(B53)+(B177), (A)+(B53)+(B178), (A)+(B53)+(B179), (A)+(B53)+(B180), (A)+(B53)+(B181), (A)+(B53)+(B182), (A)+(B53)+(B183), (A)+(B53)+(B184), (A)+(B53)+(B185), (A)+(B53)+(B186), (A)+(B53)+(B187), (A)+(B53)+(B188), (A)+(B53)+(B189), (A)+(B53)+(B190), (A)+(B53)+(B191), (A)+(B53)+(B192), (A)+(B53)+(B193), (A)+(B53)+(B194), (A)+(B53)+(B195), (A)+(B53)+(B196), (A)+(B53)+(B197), (A)+(B53)+(B198), (A)+(B53)+(B199), (A)+(B53)+(B200), (A)+(B53)+(B201), (A)+(B53)+(B202), (A)+(B53)+(B203), (A)+(B53)+(B204), (A)+(B53)+(B205), (A)+(B53)+(B206), (A)+(B53)+(B207), (A)+(B53)+(B208), (A)+(B53)+(B209), (A)+(B53)+(B210), (A)+(B53)+(B211), (A)+(B53)+(B212), (A)+(B53)+(B213), (A)+(B53)+(B214), (A)+(B53)+(B215), (A)+(B53)+(B216), (A)+(B53)+(B217), (A)+(B53)+(B218), (A)+(B53)+(B219), (A)+(B53)+(B220), (A)+(B53)+(B221), (A)+(B53)+(B222), (A)+(B53)+(B223), (A)+(B53)+(B224), (A)+(B53)+(B225), (A)+(B53)+(B226), (A)+(B53)+(B227), (A)+(B53)+(B228), (A)+(B53)+(B229), (A)+(B53)+(B230), (A)+(B53)+(B231), (A)+(B53)+(B232), (A)+(B53)+(B233), (A)+(B53)+(B234), (A)+(B53)+(B235), (A)+(B53)+(B236), (A)+(B53)+(B237), (A)+(B53)+(B238), (A)+(B53)+(B239), (A)+(B53)+(B240), (A)+(B53)+(B241), (A)+(B53)+(B242), (A)+(B53)+(B243), (A)+(B53)+(B244), (A)+(B53)+(B245), (A)+(B53)+(B246), (A)+(B53)+(B247), (A)+(B53)+(B248), (A)+(B53)+(B249), (A)+(B53)+(B250), (A)+(B53)+(B251), (A)+(B53)+(B252), (A)+(B53)+(B253), (A)+(B53)+(B254), (A)+(B53)+(B255), (A)+(B53)+(B256), (A)+(B53)+(B257), (A)+(B53)+(B258), (A)+(B53)+(B259), (A)+(B53)+(B260), (A)+(B53)+(B261), (A)+(B53)+(B262), (A)+(B53)+(B263), (A)+(B53)+(B264), (A)+(B53)+(B265), (A)+(B53)+(B266), (A)+(B53)+(B267), (A)+(B53)+(B268), (A)+(B53)+(B269), (A)+(B53)+(B270), (A)+(B53)+(B271), (A)+(B53)+(B272), (A)+(B53)+(B273), (A)+(B53)+(B274), (A)+(B53)+(B275), (A)+(B53)+(B276), (A)+(B53)+(B277), (A)+(B53)+(B278), (A)+(B53)+(B279), (A)+(B53)+(B280), (A)+(B53)+(B281), (A)+(B53)+(B282), (A)+(B53)+(B283), (A)+(B53)+(B284), (A)+(B53)+(B285), (A)+(B53)+(B286), (A)+(B53)+(B287), (A)+(B53)+(B288), (A)+(B53)+(B289), (A)+(B53)+(B290), (A)+(B53)+(B291), (A)+(B53)+(B292), (A)+(B53)+(B293), (A)+(B53)+(B294), (A)+(B53)+(B295), (A)+(B53)+(B296), (A)+(B53)+(B297), (A)+(B53)+(B298), (A)+(B53)+(B299), (A)+(B53)+(B300), (A)+(B53)+(B301), (A)+(B53)+(B302), (A)+(B53)+(B303), (A)+(B53)+(B304), (A)+(B53)+(B305), (A)+(B53)+(B306), (A)+(B53)+(B307), (A)+(B53)+(B308), (A)+(B53)+(B309), (A)+(B53)+(B310), (A)+(B53)+(B311), (A)+(B53)+(B312), (A)+(B53)+(B313), (A)+(B53)+(B314), (A)+(B53)+(B315),

(A)+(B54)+(B55), (A)+(B54)+(B56), (A)+(B54)+(B57), (A)+(B54)+(B58), (A)+(B54)+(B59), (A)+(B54)+(B60), (A)+(B54)+(B61), (A)+(B54)+(B62), (A)+(B54)+(B63), (A)+(B54)+(B64), (A)+(B54)+(B65), (A)+(B54)+(B66), (A)+(B54)+(B67), (A)+(B54)+(B68), (A)+(B54)+(B69), (A)+(B54)+(B70), (A)+(B54)+(B71), (A)+(B54)+(B72), (A)+(B54)+(B73), (A)+(B54)+(B74), (A)+(B54)+(B75), (A)+(B54)+(B76), (A)+(B54)+(B77), (A)+(B54)+(B78), (A)+(B54)+(B79), (A)+(B54)+(B80), (A)+(B54)+(B81), (A)+(B54)+(B82), (A)+(B54)+(B83), (A)+(B54)+(B84), (A)+(B54)+(B85), (A)+(B54)+(B86), (A)+(B54)+(B87), (A)+(B54)+(B88), (A)+(B54)+(B89), (A)+(B54)+(B90), (A)+(B54)+(B91), (A)+(B54)+(B92), (A)+(B54)+(B93), (A)+(B54)+(B94), (A)+(B54)+(B95), (A)+(B54)+(B96), (A)+(B54)+(B97), (A)+(B54)+(B98), (A)+(B54)+(B99), (A)+(B54)+(B100), (A)+(B54)+(B101), (A)+(B54)+(B102), (A)+(B54)+(B103), (A)+(B54)+(B104), (A)+(B54)+(B105), (A)+(B54)+(B106), (A)+(B54)+(B107), (A)+(B54)+(B108), (A)+(B54)+(B109), (A)+(B54)+(B110), (A)+(B54)+(B111), (A)+(B54)+(B112), (A)+(B54)+(B113), (A)+(B54)+(B114), (A)+(B54)+(B115), (A)+(B54)+(B116), (A)+(B54)+(B117), (A)+(B54)+(B118), (A)+(B54)+(B119), (A)+(B54)+(B120), (A)+(B54)+(B121), (A)+(B54)+(B122), (A)+(B54)+(B123), (A)+(B54)+(B124), (A)+(B54)+(B125), (A)+(B54)+(B126), (A)+(B54)+(B127), (A)+(B54)+(B128), (A)+(B54)+(B129), (A)+(B54)+(B130), (A)+(B54)+(B131), (A)+(B54)+(B132), (A)+(B54)+(B133), (A)+(B54)+(B134), (A)+(B54)+(B135), (A)+(B54)+(B136), (A)+(B54)+(B137), (A)+(B54)+(B138), (A)+(B54)+(B139), (A)+(B54)+(B140), (A)+(B54)+(B141), (A)+(B54)+(B142), (A)+(B54)+(B143), (A)+(B54)+(B144), (A)+(B54)+(B145), (A)+(B54)+(B146), (A)+(B54)+(B147), (A)+(B54)+(B148), (A)+(B54)+(B149), (A)+(B54)+(B150), (A)+(B54)+(B151), (A)+(B54)+(B152), (A)+(B54)+(B153), (A)+(B54)+(B154), (A)+(B54)+(B155), (A)+(B54)+(B156), (A)+(B54)+(B157), (A)+(B54)+(B158), (A)+(B54)+(B159), (A)+(B54)+(B160), (A)+(B54)+(B161), (A)+(B54)+(B162), (A)+(B54)+(B164), (A)+(B54)+(B164), (A)+(B54)+(B165), (A)+(B54)+(B166), (A)+(B54)+(B167), (A)+(B54)+(B168), (A)+(B54)+(B169), (A)+(B54)+(B170), (A)+(B54)+(B171), (A)+(B54)+(B172), (A)+(B54)+(B173), (A)+(B54)+(B174), (A)+(B54)+(B175), (A)+(B54)+(B176), (A)+(B54)+(B177), (A)+(B54)+(B178), (A)+(B54)+(B179), (A)+(B54)+(B180), (A)+(B54)+(B181), (A)+(B54)+(B182), (A)+(B54)+(B183), (A)+(B54)+(B184), (A)+(B54)+(B185), (A)+(B54)+(B186), (A)+(B54)+(B187), (A)+(B54)+(B188), (A)+(B54)+(B189), (A)+(B54)+(B190), (A)+(B54)+(B191), (A)+(B54)+(B192), (A)+(B54)+(B193), (A)+(B54)+(B194), (A)+(B54)+(B195), (A)+(B54)+(B196), (A)+(B54)+(B197), (A)+(B54)+(B198), (A)+(B54)+(B199), (A)+(B54)+(B200), (A)+(B54)+(B201), (A)+(B54)+(B202), (A)+(B54)+(B203), (A)+(B54)+(B204), (A)+(B54)+(B205), (A)+(B54)+(B206), (A)+(B54)+(B207), (A)+(B54)+(B208), (A)+(B54)+(B209), (A)+(B54)+(B210), (A)+(B54)+(B211), (A)+(B54)+(B212), (A)+(B54)+(B213), (A)+(B54)+(B214), (A)+(B54)+(B215), (A)+(B54)+(B216), (A)+(B54)+(B217), (A)+(B54)+(B218), (A)+(B54)+(B219), (A)+(B54)+(B220), (A)+(B54)+(B221), (A)+(B54)+(B222), (A)+(B54)+(B223), (A)+(B54)+(B224), (A)+(B54)+(B225), (A)+(B54)+(B226), (A)+(B54)+(B227), (A)+(B54)+(B228), (A)+(B54)+(B229), (A)+(B54)+(B230), (A)+(B54)+(B231), (A)+(B54)+(B232), (A)+(B54)+(B233), (A)+(B54)+(B234), (A)+(B54)+(B235), (A)+(B54)+(B236), (A)+(B54)+(B237), (A)+(B54)+(B238), (A)+(B54)+(B239), (A)+(B54)+(B240), (A)+(B54)+(B241), (A)+(B54)+(B242), (A)+(B54)+(B243), (A)+(B54)+(B244), (A)+(B54)+(B245), (A)+(B54)+(B246), (A)+(B54)+(B247), (A)+(B54)+(B248), (A)+(B54)+(B249), (A)+(B54)+(B250), (A)+(B54)+(B251), (A)+(B54)+(B252), (A)+(B54)+(B253), (A)+(B54)+(B254), (A)+(B54)+(B255), (A)+(B54)+(B256), (A)+(B54)+(B257), (A)+(B54)+(B258), (A)+(B54)+(B259), (A)+(B54)+(B260), (A)+(B54)+(B261), (A)+(B54)+(B262), (A)+(B54)+(B263), (A)+(B54)+(B264), (A)+(B54)+(B265), (A)+(B54)+(B266), (A)+(B54)+(B267), (A)+(B54)+(B268), (A)+(B54)+(B269), (A)+(B54)+(B270), (A)+(B54)+(B271), (A)+(B54)+(B272), (A)+(B54)+(B273), (A)+(B54)+(B274), (A)+(B54)+(B275), (A)+(B54)+(B276), (A)+(B54)+(B277), (A)+(B54)+(B278), (A)+(B54)+(B279), (A)+(B54)+(B280), (A)+(B54)+(B281), (A)+(B54)+(B282), (A)+(B54)+(B283), (A)+(B54)+(B284), (A)+(B54)+(B285), (A)+(B54)+(B286), (A)+(B54)+(B287), (A)+(B54)+(B288), (A)+(B54)+(B289), (A)+(B54)+(B290), (A)+(B54)+(B291), (A)+(B54)+(B292), (A)+(B54)+(B293), (A)+(B54)+(B294), (A)+(B54)+(B295), (A)+(B54)+(B296), (A)+(B54)+(B297), (A)+(B54)+(B298), (A)+(B54)+(B299), (A)+(B54)+(B300), (A)+(B54)+(B301), (A)+(B54)+(B302), (A)+(B54)+(B303), (A)+(B54)+(B304), (A)+(B54)+(B305), (A)+(B54)+(B306), (A)+(B54)+(B307), (A)+(B54)+(B308), (A)+(B54)+(B309), (A)+(B54)+(B310), (A)+(B54)+(B311), (A)+(B54)+(B312), (A)+(B54)+(B313), (A)+(B54)+(B314), (A)+(B54)+(B315),

(A)+(B55)+(B56), (A)+(B55)+(B57), (A)+(B55)+(B58), (A)+(B55)+(B59), (A)+(B55)+(B60), (A)+(B55)+(B61), (A)+(B55)+(B62), (A)+(B55)+(B63), (A)+(B55)+(B64), (A)+(B55)+(B65), (A)+(B55)+(B66), (A)+(B55)+(B67), (A)+(B55)+(B68), (A)+(B55)+(B69), (A)+(B55)+(B70), (A)+(B55)+(B71), (A)+(B55)+(B72), (A)+(B55)+(B73), (A)+(B55)+(B74), (A)+(B55)+(B75), (A)+(B55)+(B76), (A)+(B55)+(B77), (A)+(B55)+(B78), (A)+(B55)+(B79), (A)+(B55)+(B80), (A)+(B55)+(B81), (A)+(B55)+(B82), (A)+(B55)+(B83), (A)+(B55)+(B84), (A)+(B55)+(B85), (A)+(B55)+(B86), (A)+(B55)+(B87), (A)+(B55)+(B88), (A)+(B55)+(B89), (A)+(B55)+(B90), (A)+(B55)+(B91), (A)+(B55)+(B92), (A)+(B55)+(B93), (A)+(B55)+(B94), (A)+(B55)+(B95), (A)+(B55)+(B96), (A)+(B55)+(B97), (A)+(B55)+(B98), (A)+(B55)+(B99), (A)+(B55)+(B100), (A)+(B55)+(B101), (A)+(B55)+(B102), (A)+(B55)+(B103), (A)+(B55)+(B104), (A)+(B55)+(B105), (A)+(B55)+(B106), (A)+(B55)+(B107), (A)+(B55)+(B108), (A)+(B55)+(B109), (A)+(B55)+(B110), (A)+(B55)+(B111), (A)+(B55)+(B112), (A)+(B55)+(B113), (A)+(B55)+(B114), (A)+(B55)+(B115), (A)+(B55)+(B116), (A)+(B55)+(B117), (A)+(B55)+(B118), (A)+(B55)+(B119), (A)+(B55)+(B120), (A)+(B55)+(B121), (A)+(B55)+(B122), (A)+(B55)+(B123), (A)+(B55)+(B124), (A)+(B55)+(B125), (A)+(B55)+(B126), (A)+(B55)+(B127), (A)+(B55)+(B128), (A)+(B55)+(B129), (A)+(B55)+(B130), (A)+(B55)+(B131), (A)+(B55)+(B132), (A)+(B55)+(B133), (A)+(B55)+(B134), (A)+(B55)+(B135), (A)+(B55)+(B136), (A)+(B55)+(B137), (A)+(B55)+(B138), (A)+(B55)+(B139), (A)+(B55)+(B140), (A)+(B55)+(B141), (A)+(B55)+(B142), (A)+(B55)+(B143), (A)+(B55)+(B144), (A)+(B55)+(B145), (A)+(B55)+(B146), (A)+(B55)+(B147), (A)+(B55)+(B148), (A)+(B55)+(B149), (A)+(B55)+(B150), (A)+(B55)+(B151), (A)+(B55)+(B152), (A)+(B55)+(B153), (A)+(B55)+(B154), (A)+(B55)+(B155), (A)+(B55)+(B156), (A)+(B55)+(B157), (A)+(B55)+(B158), (A)+(B55)+(B159), (A)+(B55)+(B160), (A)+(B55)+(B161), (A)+(B55)+(B162), (A)+(B55)+(B164), (A)+(B55)+(B164), (A)+(B55)+(B165), (A)+(B55)+(B166), (A)+(B55)+(B167), (A)+(B55)+(B168), (A)+(B55)+(B169), (A)+(B55)+(B170), (A)+(B55)+(B171), (A)+(B55)+(B172), (A)+(B55)+(B173), (A)+(B55)+(B174), (A)+(B55)+(B175), (A)+(B55)+(B176), (A)+(B55)+(B177), (A)+(B55)+(B178), (A)+(B55)+(B179), (A)+(B55)+(B180), (A)+(B55)+(B181), (A)+(B55)+(B182), (A)+(B55)+(B183), (A)+(B55)+(B184), (A)+(B55)+(B185), (A)+(B55)+(B186), (A)+(B55)+(B187), (A)+(B55)+(B188), (A)+(B55)+(B189), (A)+(B55)+(B190), (A)+(B55)+(B191), (A)+(B55)+(B192), (A)+(B55)+(B193), (A)+(B55)+(B194), (A)+(B55)+(B195), (A)+(B55)+(B196), (A)+(B55)+(B197), (A)+(B55)+(B198), (A)+(B55)+(B199), (A)+(B55)+(B200), (A)+(B55)+(B201), (A)+(B55)+(B202), (A)+(B55)+(B203), (A)+(B55)+(B204), (A)+(B55)+(B205), (A)+(B55)+(B206), (A)+(B55)+(B207), (A)+(B55)+(B208), (A)+(B55)+(B209), (A)+(B55)+(B210), (A)+(B55)+(B211), (A)+(B55)+(B212), (A)+(B55)+(B213), (A)+(B55)+(B214), (A)+(B55)+(B215), (A)+(B55)+(B216), (A)+(B55)+(B217), (A)+(B55)+(B218), (A)+(B55)+(B219), (A)+(B55)+(B220), (A)+(B55)+(B221), (A)+(B55)+(B222), (A)+(B55)+(B223), (A)+(B55)+(B224), (A)+(B55)+(B225), (A)+(B55)+(B226), (A)+(B55)+(B227), (A)+(B55)+(B228), (A)+(B55)+(B229), (A)+(B55)+(B230), (A)+(B55)+(B231), (A)+(B55)+(B232), (A)+(B55)+(B233), (A)+(B55)+(B234), (A)+(B55)+(B235), (A)+(B55)+(B236), (A)+(B55)+(B237), (A)+(B55)+(B238), (A)+(B55)+(B239), (A)+(B55)+(B240), (A)+(B55)+(B241), (A)+(B55)+(B242), (A)+(B55)+(B243), (A)+(B55)+(B244), (A)+(B55)+(B245), (A)+(B55)+(B246), (A)+(B55)+(B247), (A)+(B55)+(B248), (A)+(B55)+(B249), (A)+(B55)+(B250), (A)+(B55)+(B251), (A)+(B55)+(B252), (A)+(B55)+(B253), (A)+(B55)+(B254), (A)+(B55)+(B255), (A)+(B55)+(B256), (A)+(B55)+(B257), (A)+(B55)+(B258), (A)+(B55)+(B259), (A)+(B55)+(B260), (A)+(B55)+(B261), (A)+(B55)+(B262), (A)+(B55)+(B263), (A)+(B55)+(B264), (A)+(B55)+(B265), (A)+(B55)+(B266), (A)+(B55)+(B267), (A)+(B55)+(B268), (A)+(B55)+(B269), (A)+(B55)+(B270), (A)+(B55)+(B271), (A)+(B55)+(B272), (A)+(B55)+(B273), (A)+(B55)+(B274), (A)+(B55)+(B275), (A)+(B55)+(B276), (A)+(B55)+(B277), (A)+(B55)+(B278), (A)+(B55)+(B279), (A)+(B55)+(B280), (A)+(B55)+(B281), (A)+(B55)+(B282), (A)+(B55)+(B283), (A)+(B55)+(B284), (A)+(B55)+(B285), (A)+(B55)+(B286), (A)+(B55)+(B287), (A)+(B55)+(B288), (A)+(B55)+(B289), (A)+(B55)+(B290), (A)+(B55)+(B291), (A)+(B55)+(B292), (A)+(B55)+(B293), (A)+(B55)+(B294), (A)+(B55)+(B295), (A)+(B55)+(B296), (A)+(B55)+(B297), (A)+(B55)+(B298), (A)+(B55)+(B299), (A)+(B55)+(B300), (A)+(B55)+(B301), (A)+(B55)+(B302), (A)+(B55)+(B303), (A)+(B55)+(B304), (A)+(B55)+(B305), (A)+(B55)+(B306), (A)+(B55)+(B307), (A)+(B55)+(B308), (A)+(B55)+(B309), (A)+(B55)+(B310), (A)+(B55)+(B311), (A)+(B55)+(B312), (A)+(B55)+(B313), (A)+(B55)+(B314), (A)+(B55)+(B315),

(A)+(B56)+(B57), (A)+(B56)+(B58), (A)+(B56)+(B59), (A)+(B56)+(B60), (A)+(B56)+(B61), (A)+(B56)+(B62), (A)+(B56)+(B63), (A)+(B56)+(B64), (A)+(B56)+(B65), (A)+(B56)+(B66), (A)+(B56)+(B67), (A)+(B56)+(B68), (A)+(B56)+(B69), (A)+(B56)+(B70), (A)+(B56)+(B71), (A)+(B56)+(B72), (A)+(B56)+(B73), (A)+(B56)+(B74), (A)+(B56)+(B75), (A)+(B56)+(B76), (A)+(B56)+(B77), (A)+(B56)+(B78), (A)+(B56)+(B79), (A)+(B56)+(B80), (A)+(B56)+(B81), (A)+(B56)+(B82), (A)+(B56)+(B83), (A)+(B56)+(B84), (A)+(B56)+(B85), (A)+(B56)+(B86), (A)+(B56)+(B87), (A)+(B56)+(B88), (A)+(B56)+(B89), (A)+(B56)+(B90), (A)+(B56)+(B91), (A)+(B56)+(B92), (A)+(B56)+(B93), (A)+(B56)+(B94), (A)+(B56)+(B95), (A)+(B56)+(B96), (A)+(B56)+(B97), (A)+(B56)+(B98), (A)+(B56)+(B99), (A)+(B56)+(B100), (A)+(B56)+(B101), (A)+(B56)+(B102), (A)+(B56)+(B103), (A)+(B56)+(B104), (A)+(B56)+(B105), (A)+(B56)+(B106), (A)+(B56)+(B107), (A)+(B56)+(B108), (A)+(B56)+(B109), (A)+(B56)+(B110), (A)+(B56)+(B111), (A)+(B56)+(B112), (A)+(B56)+(B113), (A)+(B56)+(B114), (A)+(B56)+(B115), (A)+(B56)+(B116), (A)+(B56)+(B117), (A)+(B56)+(B118), (A)+(B56)+(B119), (A)+(B56)+(B120), (A)+(B56)+(B121), (A)+(B56)+(B122), (A)+(B56)+(B123), (A)+(B56)+(B124), (A)+(B56)+(B125), (A)+(B56)+(B126), (A)+(B56)+(B127), (A)+(B56)+(B128), (A)+(B56)+(B129), (A)+(B56)+(B130), (A)+(B56)+(B131), (A)+(B56)+(B132), (A)+(B56)+(B133), (A)+(B56)+(B134), (A)+(B56)+(B135), (A)+(B56)+(B136), (A)+(B56)+(B137), (A)+(B56)+(B138), (A)+(B56)+(B139), (A)+(B56)+(B140), (A)+(B56)+(B141), (A)+(B56)+(B142), (A)+(B56)+(B143), (A)+(B56)+(B144), (A)+(B56)+(B145), (A)+(B56)+(B146), (A)+(B56)+(B147), (A)+(B56)+(B148), (A)+(B56)+(B149), (A)+(B56)+(B150), (A)+(B56)+(B151), (A)+(B56)+(B152), (A)+(B56)+(B153), (A)+(B56)+(B154), (A)+(B56)+(B155), (A)+(B56)+(B156), (A)+(B56)+(B157), (A)+(B56)+(B158), (A)+(B56)+(B159), (A)+(B56)+(B160), (A)+(B56)+(B161), (A)+(B56)+(B162), (A)+(B56)+(B164), (A)+(B56)+(B164), (A)+(B56)+(B165), (A)+(B56)+(B166), (A)+(B56)+(B167), (A)+(B56)+(B168), (A)+(B56)+(B169), (A)+(B56)+(B170), (A)+(B56)+(B171), (A)+(B56)+(B172), (A)+(B56)+(B173), (A)+(B56)+(B174), (A)+(B56)+(B175), (A)+(B56)+(B176), (A)+(B56)+(B177), (A)+(B56)+(B178), (A)+(B56)+(B179), (A)+(B56)+(B180), (A)+(B56)+(B181), (A)+(B56)+(B182), (A)+(B56)+(B183), (A)+(B56)+(B184), (A)+(B56)+(B185), (A)+(B56)+(B186), (A)+(B56)+(B187), (A)+(B56)+(B188), (A)+(B56)+(B189), (A)+(B56)+(B190), (A)+(B56)+(B191), (A)+(B56)+(B192), (A)+(B56)+(B193), (A)+(B56)+(B194), (A)+(B56)+(B195), (A)+(B56)+(B196), (A)+(B56)+(B197), (A)+(B56)+(B198), (A)+(B56)+(B199), (A)+(B56)+(B200), (A)+(B56)+(B201), (A)+(B56)+(B202), (A)+(B56)+(B203), (A)+(B56)+(B204), (A)+(B56)+(B205), (A)+(B56)+(B206), (A)+(B56)+(B207), (A)+(B56)+(B208), (A)+(B56)+(B209), (A)+(B56)+(B210), (A)+(B56)+(B211), (A)+(B56)+(B212), (A)+(B56)+(B213), (A)+(B56)+(B214), (A)+(B56)+(B215), (A)+(B56)+(B216), (A)+(B56)+(B217), (A)+(B56)+(B218), (A)+(B56)+(B219), (A)+(B56)+(B220), (A)+(B56)+(B221), (A)+(B56)+(B222), (A)+(B56)+(B223), (A)+(B56)+(B224), (A)+(B56)+(B225), (A)+(B56)+(B226), (A)+(B56)+(B227), (A)+(B56)+(B228), (A)+(B56)+(B229), (A)+(B56)+(B230), (A)+(B56)+(B231), (A)+(B56)+(B232), (A)+(B56)+(B233), (A)+(B56)+(B234), (A)+(B56)+(B235), (A)+(B56)+(B236), (A)+(B56)+(B237), (A)+(B56)+(B238), (A)+(B56)+(B239), (A)+(B56)+(B240), (A)+(B56)+(B241), (A)+(B56)+(B242), (A)+(B56)+(B243), (A)+(B56)+(B244), (A)+(B56)+(B245), (A)+(B56)+(B246), (A)+(B56)+(B247), (A)+(B56)+(B248), (A)+(B56)+(B249), (A)+(B56)+(B250), (A)+(B56)+(B251), (A)+(B56)+(B252), (A)+(B56)+(B253), (A)+(B56)+(B254), (A)+(B56)+(B255), (A)+(B56)+(B256), (A)+(B56)+(B257), (A)+(B56)+(B258), (A)+(B56)+(B259), (A)+(B56)+(B260), (A)+(B56)+(B261), (A)+(B56)+(B262), (A)+(B56)+(B263), (A)+(B56)+(B264), (A)+(B56)+(B265), (A)+(B56)+(B266), (A)+(B56)+(B267), (A)+(B56)+(B268), (A)+(B56)+(B269), (A)+(B56)+(B270), (A)+(B56)+(B271), (A)+(B56)+(B272), (A)+(B56)+(B273), (A)+(B56)+(B274), (A)+(B56)+(B275), (A)+(B56)+(B276), (A)+(B56)+(B277), (A)+(B56)+(B278), (A)+(B56)+(B279), (A)+(B56)+(B280), (A)+(B56)+(B281), (A)+(B56)+(B282), (A)+(B56)+(B283), (A)+(B56)+(B284), (A)+(B56)+(B285), (A)+(B56)+(B286), (A)+(B56)+(B287), (A)+(B56)+(B288), (A)+(B56)+(B289), (A)+(B56)+(B290), (A)+(B56)+(B291), (A)+(B56)+(B292), (A)+(B56)+(B293), (A)+(B56)+(B294), (A)+(B56)+(B295), (A)+(B56)+(B296), (A)+(B56)+(B297), (A)+(B56)+(B298), (A)+(B56)+(B299), (A)+(B56)+(B300), (A)+(B56)+(B301), (A)+(B56)+(B302), (A)+(B56)+(B303), (A)+(B56)+(B304), (A)+(B56)+(B305), (A)+(B56)+(B306), (A)+(B56)+(B307), (A)+(B56)+(B308), (A)+(B56)+(B309), (A)+(B56)+(B310), (A)+(B56)+(B311), (A)+(B56)+(B312), (A)+(B56)+(B313), (A)+(B56)+(B314), (A)+(B56)+(B315),

(A)+(B57)+(B58), (A)+(B57)+(B59), (A)+(B57)+(B60), (A)+(B57)+(B61), (A)+(B57)+(B62), (A)+(B57)+(B63), (A)+(B57)+(B64), (A)+(B57)+(B65), (A)+(B57)+(B66), (A)+(B57)+(B67), (A)+(B57)+(B68), (A)+(B57)+(B69), (A)+(B57)+(B70), (A)+(B57)+(B71), (A)+(B57)+(B72), (A)+(B57)+(B73), (A)+(B57)+(B74), (A)+(B57)+(B75), (A)+(B57)+(B76), (A)+(B57)+(B77), (A)+(B57)+(B78), (A)+(B57)+(B79), (A)+(B57)+(B80), (A)+(B57)+(B81), (A)+(B57)+(B82), (A)+(B57)+(B83), (A)+(B57)+(B84), (A)+(B57)+(B85), (A)+(B57)+(B86), (A)+(B57)+(B87), (A)+(B57)+(B88), (A)+(B57)+(B89), (A)+(B57)+(B90), (A)+(B57)+(B91), (A)+(B57)+(B92), (A)+(B57)+(B93), (A)+(B57)+(B94), (A)+(B57)+(B95), (A)+(B57)+(B96), (A)+(B57)+(B97), (A)+(B57)+(B98), (A)+(B57)+(B99), (A)+(B57)+(B100), (A)+(B57)+(B101), (A)+(B57)+(B102), (A)+(B57)+(B103), (A)+(B57)+(B104), (A)+(B57)+(B105), (A)+(B57)+(B106), (A)+(B57)+(B107), (A)+(B57)+(B108), (A)+(B57)+(B109), (A)+(B57)+(B110), (A)+(B57)+(B111), (A)+(B57)+(B112), (A)+(B57)+(B113), (A)+(B57)+(B114), (A)+(B57)+(B115), (A)+(B57)+(B116), (A)+(B57)+(B117), (A)+(B57)+(B118), (A)+(B57)+(B119), (A)+(B57)+(B120), (A)+(B57)+(B121), (A)+(B57)+(B122), (A)+(B57)+(B123), (A)+(B57)+(B124), (A)+(B57)+(B125), (A)+(B57)+(B126), (A)+(B57)+(B127), (A)+(B57)+(B128), (A)+(B57)+(B129), (A)+(B57)+(B130), (A)+(B57)+(B131), (A)+(B57)+(B132), (A)+(B57)+(B133), (A)+(B57)+(B134), (A)+(B57)+(B135), (A)+(B57)+(B136), (A)+(B57)+(B137), (A)+(B57)+(B138), (A)+(B57)+(B139), (A)+(B57)+(B140), (A)+(B57)+(B141), (A)+(B57)+(B142), (A)+(B57)+(B143), (A)+(B57)+(B144), (A)+(B57)+(B145), (A)+(B57)+(B146), (A)+(B57)+(B147), (A)+(B57)+(B148), (A)+(B57)+(B149), (A)+(B57)+(B150), (A)+(B57)+(B151), (A)+(B57)+(B152), (A)+(B57)+(B153), (A)+(B57)+(B154), (A)+(B57)+(B155), (A)+(B57)+(B156), (A)+(B57)+(B157), (A)+(B57)+(B158), (A)+(B57)+(B159), (A)+(B57)+(B160), (A)+(B57)+(B161), (A)+(B57)+(B162), (A)+(B57)+(B164), (A)+(B57)+(B164), (A)+(B57)+(B165), (A)+(B57)+(B166), (A)+(B57)+(B167), (A)+(B57)+(B168), (A)+(B57)+(B169), (A)+(B57)+(B170), (A)+(B57)+(B171), (A)+(B57)+(B172), (A)+(B57)+(B173), (A)+(B57)+(B174), (A)+(B57)+(B175), (A)+(B57)+(B176), (A)+(B57)+(B177), (A)+(B57)+(B178), (A)+(B57)+(B179), (A)+(B57)+(B180), (A)+(B57)+(B181), (A)+(B57)+(B182), (A)+(B57)+(B183), (A)+(B57)+(B184), (A)+(B57)+(B185), (A)+(B57)+(B186), (A)+(B57)+(B187), (A)+(B57)+(B188), (A)+(B57)+(B189), (A)+(B57)+(B190), (A)+(B57)+(B191), (A)+(B57)+(B192), (A)+(B57)+(B193), (A)+(B57)+(B194), (A)+(B57)+(B195), (A)+(B57)+(B196), (A)+(B57)+(B197), (A)+(B57)+(B198), (A)+(B57)+(B199), (A)+(B57)+(B200), (A)+(B57)+(B201), (A)+(B57)+(B202), (A)+(B57)+(B203), (A)+(B57)+(B204), (A)+(B57)+(B205), (A)+(B57)+(B206), (A)+(B57)+(B207), (A)+(B57)+(B208), (A)+(B57)+(B209), (A)+(B57)+(B210), (A)+(B57)+(B211), (A)+(B57)+(B212), (A)+(B57)+(B213), (A)+(B57)+(B214), (A)+(B57)+(B215), (A)+(B57)+(B216), (A)+(B57)+(B217), (A)+(B57)+(B218), (A)+(B57)+(B219), (A)+(B57)+(B220), (A)+(B57)+(B221), (A)+(B57)+(B222), (A)+(B57)+(B223), (A)+(B57)+(B224), (A)+(B57)+(B225), (A)+(B57)+(B226), (A)+(B57)+(B227), (A)+(B57)+(B228), (A)+(B57)+(B229), (A)+(B57)+(B230), (A)+(B57)+(B231), (A)+(B57)+(B232), (A)+(B57)+(B233), (A)+(B57)+(B234), (A)+(B57)+(B235), (A)+(B57)+(B236), (A)+(B57)+(B237), (A)+(B57)+(B238), (A)+(B57)+(B239), (A)+(B57)+(B240), (A)+(B57)+(B241), (A)+(B57)+(B242), (A)+(B57)+(B243), (A)+(B57)+(B244), (A)+(B57)+(B245), (A)+(B57)+(B246), (A)+(B57)+(B247), (A)+(B57)+(B248), (A)+(B57)+(B249), (A)+(B57)+(B250), (A)+(B57)+(B251), (A)+(B57)+(B252), (A)+(B57)+(B253), (A)+(B57)+(B254), (A)+(B57)+(B255), (A)+(B57)+(B256), (A)+(B57)+(B257), (A)+(B57)+(B258), (A)+(B57)+(B259), (A)+(B57)+(B260), (A)+(B57)+(B261), (A)+(B57)+(B262), (A)+(B57)+(B263), (A)+(B57)+(B264), (A)+(B57)+(B265), (A)+(B57)+(B266), (A)+(B57)+(B267), (A)+(B57)+(B268), (A)+(B57)+(B269), (A)+(B57)+(B270), (A)+(B57)+(B271), (A)+(B57)+(B272), (A)+(B57)+(B273), (A)+(B57)+(B274), (A)+(B57)+(B275), (A)+(B57)+(B276), (A)+(B57)+(B277), (A)+(B57)+(B278), (A)+(B57)+(B279), (A)+(B57)+(B280), (A)+(B57)+(B281), (A)+(B57)+(B282), (A)+(B57)+(B283), (A)+(B57)+(B284), (A)+(B57)+(B285), (A)+(B57)+(B286), (A)+(B57)+(B287), (A)+(B57)+(B288), (A)+(B57)+(B289), (A)+(B57)+(B290), (A)+(B57)+(B291), (A)+(B57)+(B292), (A)+(B57)+(B293), (A)+(B57)+(B294), (A)+(B57)+(B295), (A)+(B57)+(B296), (A)+(B57)+(B297), (A)+(B57)+(B298), (A)+(B57)+(B299), (A)+(B57)+(B300), (A)+(B57)+(B301), (A)+(B57)+(B302), (A)+(B57)+(B303), (A)+(B57)+(B304), (A)+(B57)+(B305), (A)+(B57)+(B306), (A)+(B57)+(B307), (A)+(B57)+(B308), (A)+(B57)+(B309), (A)+(B57)+(B310), (A)+(B57)+(B311), (A)+(B57)+(B312), (A)+(B57)+(B313), (A)+(B57)+(B314), (A)+(B57)+(B315),

(A)+(B58)+(B59), (A)+(B58)+(B60), (A)+(B58)+(B61), (A)+(B58)+(B62), (A)+(B58)+(B63), (A)+(B58)+(B64), (A)+(B58)+(B65), (A)+(B58)+(B66), (A)+(B58)+(B67), (A)+(B58)+(B68), (A)+(B58)+(B69), (A)+(B58)+(B70), (A)+(B58)+(B71), (A)+(B58)+(B72), (A)+(B58)+(B73), (A)+(B58)+(B74), (A)+(B58)+(B75), (A)+(B58)+(B76), (A)+(B58)+(B77), (A)+(B58)+(B78), (A)+(B58)+(B79), (A)+(B58)+(B80), (A)+(B58)+(B81), (A)+(B58)+(B82), (A)+(B58)+(B83), (A)+(B58)+(B84), (A)+(B58)+(B85), (A)+(B58)+(B86), (A)+(B58)+(B87), (A)+(B58)+(B88), (A)+(B58)+(B89), (A)+(B58)+(B90), (A)+(B58)+(B91), (A)+(B58)+(B92), (A)+(B58)+(B93), (A)+(B58)+(B94), (A)+(B58)+(B95), (A)+(B58)+(B96), (A)+(B58)+(B97), (A)+(B58)+(B98), (A)+(B58)+(B99), (A)+(B58)+(B100), (A)+(B58)+(B101), (A)+(B58)+(B102), (A)+(B58)+(B103), (A)+(B58)+(B104), (A)+(B58)+(B105), (A)+(B58)+(B106), (A)+(B58)+(B107), (A)+(B58)+(B108), (A)+(B58)+(B109), (A)+(B58)+(B110), (A)+(B58)+(B111), (A)+(B58)+(B112), (A)+(B58)+(B113), (A)+(B58)+(B114), (A)+(B58)+(B115), (A)+(B58)+(B116), (A)+(B58)+(B117), (A)+(B58)+(B118), (A)+(B58)+(B119), (A)+(B58)+(B120), (A)+(B58)+(B121), (A)+(B58)+(B122), (A)+(B58)+(B123), (A)+(B58)+(B124), (A)+(B58)+(B125), (A)+(B58)+(B126), (A)+(B58)+(B127), (A)+(B58)+(B128), (A)+(B58)+(B129), (A)+(B58)+(B130), (A)+(B58)+(B131), (A)+(B58)+(B132), (A)+(B58)+(B133), (A)+(B58)+(B134), (A)+(B58)+(B135), (A)+(B58)+(B136), (A)+(B58)+(B137), (A)+(B58)+(B138), (A)+(B58)+(B139), (A)+(B58)+(B140), (A)+(B58)+(B141), (A)+(B58)+(B142), (A)+(B58)+(B143), (A)+(B58)+(B144), (A)+(B58)+(B145), (A)+(B58)+(B146), (A)+(B58)+(B147), (A)+(B58)+(B148), (A)+(B58)+(B149), (A)+(B58)+(B150), (A)+(B58)+(B151), (A)+(B58)+(B152), (A)+(B58)+(B153), (A)+(B58)+(B154), (A)+(B58)+(B155), (A)+(B58)+(B156), (A)+(B58)+(B157), (A)+(B58)+(B158), (A)+(B58)+(B159), (A)+(B58)+(B160), (A)+(B58)+(B161), (A)+(B58)+(B162), (A)+(B58)+(B164), (A)+(B58)+(B164), (A)+(B58)+(B165), (A)+(B58)+(B166), (A)+(B58)+(B167), (A)+(B58)+(B168), (A)+(B58)+(B169), (A)+(B58)+(B170), (A)+(B58)+(B171), (A)+(B58)+(B172), (A)+(B58)+(B173), (A)+(B58)+(B174), (A)+(B58)+(B175), (A)+(B58)+(B176), (A)+(B58)+(B177), (A)+(B58)+(B178), (A)+(B58)+(B179), (A)+(B58)+(B180), (A)+(B58)+(B181), (A)+(B58)+(B182), (A)+(B58)+(B183), (A)+(B58)+(B184), (A)+(B58)+(B185), (A)+(B58)+(B186), (A)+(B58)+(B187), (A)+(B58)+(B188), (A)+(B58)+(B189), (A)+(B58)+(B190), (A)+(B58)+(B191), (A)+(B58)+(B192), (A)+(B58)+(B193), (A)+(B58)+(B194), (A)+(B58)+(B195), (A)+(B58)+(B196), (A)+(B58)+(B197), (A)+(B58)+(B198), (A)+(B58)+(B199), (A)+(B58)+(B200), (A)+(B58)+(B201), (A)+(B58)+(B202), (A)+(B58)+(B203), (A)+(B58)+(B204), (A)+(B58)+(B205), (A)+(B58)+(B206), (A)+(B58)+(B207), (A)+(B58)+(B208), (A)+(B58)+(B209), (A)+(B58)+(B210), (A)+(B58)+(B211), (A)+(B58)+(B212), (A)+(B58)+(B213), (A)+(B58)+(B214), (A)+(B58)+(B215), (A)+(B58)+(B216), (A)+(B58)+(B217), (A)+(B58)+(B218), (A)+(B58)+(B219), (A)+(B58)+(B220), (A)+(B58)+(B221), (A)+(B58)+(B222), (A)+(B58)+(B223), (A)+(B58)+(B224), (A)+(B58)+(B225), (A)+(B58)+(B226), (A)+(B58)+(B227), (A)+(B58)+(B228), (A)+(B58)+(B229), (A)+(B58)+(B230), (A)+(B58)+(B231), (A)+(B58)+(B232), (A)+(B58)+(B233), (A)+(B58)+(B234), (A)+(B58)+(B235), (A)+(B58)+(B236), (A)+(B58)+(B237), (A)+(B58)+(B238), (A)+(B58)+(B239), (A)+(B58)+(B240), (A)+(B58)+(B241), (A)+(B58)+(B242), (A)+(B58)+(B243), (A)+(B58)+(B244), (A)+(B58)+(B245), (A)+(B58)+(B246), (A)+(B58)+(B247), (A)+(B58)+(B248), (A)+(B58)+(B249), (A)+(B58)+(B250), (A)+(B58)+(B251), (A)+(B58)+(B252), (A)+(B58)+(B253), (A)+(B58)+(B254), (A)+(B58)+(B255), (A)+(B58)+(B256), (A)+(B58)+(B257), (A)+(B58)+(B258), (A)+(B58)+(B259), (A)+(B58)+(B260), (A)+(B58)+(B261), (A)+(B58)+(B262), (A)+(B58)+(B263), (A)+(B58)+(B264), (A)+(B58)+(B265), (A)+(B58)+(B266), (A)+(B58)+(B267), (A)+(B58)+(B268), (A)+(B58)+(B269), (A)+(B58)+(B270), (A)+(B58)+(B271), (A)+(B58)+(B272), (A)+(B58)+(B273), (A)+(B58)+(B274), (A)+(B58)+(B275), (A)+(B58)+(B276), (A)+(B58)+(B277), (A)+(B58)+(B278), (A)+(B58)+(B279), (A)+(B58)+(B280), (A)+(B58)+(B281), (A)+(B58)+(B282), (A)+(B58)+(B283), (A)+(B58)+(B284), (A)+(B58)+(B285), (A)+(B58)+(B286), (A)+(B58)+(B287), (A)+(B58)+(B288), (A)+(B58)+(B289), (A)+(B58)+(B290), (A)+(B58)+(B291), (A)+(B58)+(B292), (A)+(B58)+(B293), (A)+(B58)+(B294), (A)+(B58)+(B295), (A)+(B58)+(B296), (A)+(B58)+(B297), (A)+(B58)+(B298), (A)+(B58)+(B299), (A)+(B58)+(B300), (A)+(B58)+(B301), (A)+(B58)+(B302), (A)+(B58)+(B303), (A)+(B58)+(B304), (A)+(B58)+(B305), (A)+(B58)+(B306), (A)+(B58)+(B307), (A)+(B58)+(B308), (A)+(B58)+(B309), (A)+(B58)+(B310), (A)+(B58)+(B311), (A)+(B58)+(B312), (A)+(B58)+(B313), (A)+(B58)+(B314), (A)+(B58)+(B315),

(A)+(B59)+(B60), (A)+(B59)+(B61), (A)+(B59)+(B62), (A)+(B59)+(B63), (A)+(B59)+(B64), (A)+(B59)+(B65), (A)+(B59)+(B66), (A)+(B59)+(B67), (A)+(B59)+(B68), (A)+(B59)+(B69), (A)+(B59)+(B70), (A)+(B59)+(B71), (A)+(B59)+(B72), (A)+(B59)+(B73), (A)+(B59)+(B74), (A)+(B59)+(B75), (A)+(B59)+(B76), (A)+(B59)+(B77), (A)+(B59)+(B78), (A)+(B59)+(B79), (A)+(B59)+(B80), (A)+(B59)+(B81), (A)+(B59)+(B82), (A)+(B59)+(B83), (A)+(B59)+(B84), (A)+(B59)+(B85), (A)+(B59)+(B86), (A)+(B59)+(B87), (A)+(B59)+(B88), (A)+(B59)+(B89), (A)+(B59)+(B90), (A)+(B59)+(B91), (A)+(B59)+(B92), (A)+(B59)+(B93), (A)+(B59)+(B94), (A)+(B59)+(B95), (A)+(B59)+(B96), (A)+(B59)+(B97), (A)+(B59)+(B98), (A)+(B59)+(B99), (A)+(B59)+(B100), (A)+(B59)+(B101), (A)+(B59)+(B102), (A)+(B59)+(B103), (A)+(B59)+(B104), (A)+(B59)+(B105), (A)+(B59)+(B106), (A)+(B59)+(B107), (A)+(B59)+(B108), (A)+(B59)+(B109), (A)+(B59)+(B110), (A)+(B59)+(B111), (A)+(B59)+(B112), (A)+(B59)+(B113), (A)+(B59)+(B114), (A)+(B59)+(B115), (A)+(B59)+(B116), (A)+(B59)+(B117), (A)+(B59)+(B118), (A)+(B59)+(B119), (A)+(B59)+(B120), (A)+(B59)+(B121), (A)+(B59)+(B122), (A)+(B59)+(B123), (A)+(B59)+(B124), (A)+(B59)+(B125), (A)+(B59)+(B126), (A)+(B59)+(B127), (A)+(B59)+(B128), (A)+(B59)+(B129), (A)+(B59)+(B130), (A)+(B59)+(B131), (A)+(B59)+(B132), (A)+(B59)+(B133), (A)+(B59)+(B134), (A)+(B59)+(B135), (A)+(B59)+(B136), (A)+(B59)+(B137), (A)+(B59)+(B138), (A)+(B59)+(B139), (A)+(B59)+(B140), (A)+(B59)+(B141), (A)+(B59)+(B142), (A)+(B59)+(B143), (A)+(B59)+(B144), (A)+(B59)+(B145), (A)+(B59)+(B146), (A)+(B59)+(B147), (A)+(B59)+(B148), (A)+(B59)+(B149), (A)+(B59)+(B150), (A)+(B59)+(B151), (A)+(B59)+(B152), (A)+(B59)+(B153), (A)+(B59)+(B154), (A)+(B59)+(B155), (A)+(B59)+(B156), (A)+(B59)+(B157), (A)+(B59)+(B158), (A)+(B59)+(B159), (A)+(B59)+(B160), (A)+(B59)+(B161), (A)+(B59)+(B162), (A)+(B59)+(B164), (A)+(B59)+(B164), (A)+(B59)+(B165), (A)+(B59)+(B166), (A)+(B59)+(B167), (A)+(B59)+(B168), (A)+(B59)+(B169), (A)+(B59)+(B170), (A)+(B59)+(B171), (A)+(B59)+(B172), (A)+(B59)+(B173), (A)+(B59)+(B174), (A)+(B59)+(B175), (A)+(B59)+(B176), (A)+(B59)+(B177), (A)+(B59)+(B178), (A)+(B59)+(B179), (A)+(B59)+(B180), (A)+(B59)+(B181), (A)+(B59)+(B182), (A)+(B59)+(B183), (A)+(B59)+(B184), (A)+(B59)+(B185), (A)+(B59)+(B186), (A)+(B59)+(B187), (A)+(B59)+(B188), (A)+(B59)+(B189), (A)+(B59)+(B190), (A)+(B59)+(B191), (A)+(B59)+(B192), (A)+(B59)+(B193), (A)+(B59)+(B194), (A)+(B59)+(B195), (A)+(B59)+(B196), (A)+(B59)+(B197), (A)+(B59)+(B198), (A)+(B59)+(B199), (A)+(B59)+(B200), (A)+(B59)+(B201), (A)+(B59)+(B202), (A)+(B59)+(B203), (A)+(B59)+(B204), (A)+(B59)+(B205), (A)+(B59)+(B206), (A)+(B59)+(B207), (A)+(B59)+(B208), (A)+(B59)+(B209), (A)+(B59)+(B210), (A)+(B59)+(B211), (A)+(B59)+(B212), (A)+(B59)+(B213), (A)+(B59)+(B214), (A)+(B59)+(B215), (A)+(B59)+(B216), (A)+(B59)+(B217), (A)+(B59)+(B218), (A)+(B59)+(B219), (A)+(B59)+(B220), (A)+(B59)+(B221), (A)+(B59)+(B222), (A)+(B59)+(B223), (A)+(B59)+(B224), (A)+(B59)+(B225), (A)+(B59)+(B226), (A)+(B59)+(B227), (A)+(B59)+(B228), (A)+(B59)+(B229), (A)+(B59)+(B230), (A)+(B59)+(B231), (A)+(B59)+(B232), (A)+(B59)+(B233), (A)+(B59)+(B234), (A)+(B59)+(B235), (A)+(B59)+(B236), (A)+(B59)+(B237), (A)+(B59)+(B238), (A)+(B59)+(B239), (A)+(B59)+(B240), (A)+(B59)+(B241), (A)+(B59)+(B242), (A)+(B59)+(B243), (A)+(B59)+(B244), (A)+(B59)+(B245), (A)+(B59)+(B246), (A)+(B59)+(B247), (A)+(B59)+(B248), (A)+(B59)+(B249), (A)+(B59)+(B250), (A)+(B59)+(B251), (A)+(B59)+(B252), (A)+(B59)+(B253), (A)+(B59)+(B254), (A)+(B59)+(B255), (A)+(B59)+(B256), (A)+(B59)+(B257), (A)+(B59)+(B258), (A)+(B59)+(B259), (A)+(B59)+(B260), (A)+(B59)+(B261), (A)+(B59)+(B262), (A)+(B59)+(B263), (A)+(B59)+(B264), (A)+(B59)+(B265), (A)+(B59)+(B266), (A)+(B59)+(B267), (A)+(B59)+(B268), (A)+(B59)+(B269), (A)+(B59)+(B270), (A)+(B59)+(B271), (A)+(B59)+(B272), (A)+(B59)+(B273), (A)+(B59)+(B274), (A)+(B59)+(B275), (A)+(B59)+(B276), (A)+(B59)+(B277), (A)+(B59)+(B278), (A)+(B59)+(B279), (A)+(B59)+(B280), (A)+(B59)+(B281), (A)+(B59)+(B282), (A)+(B59)+(B283), (A)+(B59)+(B284), (A)+(B59)+(B285), (A)+(B59)+(B286), (A)+(B59)+(B287), (A)+(B59)+(B288), (A)+(B59)+(B289), (A)+(B59)+(B290), (A)+(B59)+(B291), (A)+(B59)+(B292), (A)+(B59)+(B293), (A)+(B59)+(B294), (A)+(B59)+(B295), (A)+(B59)+(B296), (A)+(B59)+(B297), (A)+(B59)+(B298), (A)+(B59)+(B299), (A)+(B59)+(B300), (A)+(B59)+(B301), (A)+(B59)+(B302), (A)+(B59)+(B303), (A)+(B59)+(B304), (A)+(B59)+(B305), (A)+(B59)+(B306), (A)+(B59)+(B307), (A)+(B59)+(B308), (A)+(B59)+(B309), (A)+(B59)+(B310), (A)+(B59)+(B311), (A)+(B59)+(B312), (A)+(B59)+(B313), (A)+(B59)+(B314), (A)+(B59)+(B315),

(A)+(B59)+(B60), (A)+(B59)+(B61), (A)+(B59)+(B62), (A)+(B59)+(B63), (A)+(B59)+(B64), (A)+(B59)+(B65), (A)+(B59)+(B66), (A)+(B59)+(B67), (A)+(B59)+(B68), (A)+(B59)+(B69), (A)+(B59)+(B70), (A)+(B59)+(B71), (A)+(B59)+(B72), (A)+(B59)+(B73), (A)+(B59)+(B74), (A)+(B59)+(B75), (A)+(B59)+(B76), (A)+(B59)+(B77), (A)+(B59)+(B78), (A)+(B59)+(B79), (A)+(B59)+(B80), (A)+(B59)+(B81), (A)+(B59)+(B82), (A)+(B59)+(B83), (A)+(B59)+(B84), (A)+(B59)+(B85), (A)+(B59)+(B86), (A)+(B59)+(B87), (A)+(B59)+(B88), (A)+(B59)+(B89), (A)+(B59)+(B90), (A)+(B59)+(B91), (A)+(B59)+(B92), (A)+(B59)+(B93), (A)+(B59)+(B94), (A)+(B59)+(B95), (A)+(B59)+(B96), (A)+(B59)+(B97), (A)+(B59)+(B98), (A)+(B59)+(B99), (A)+(B59)+(B100), (A)+(B59)+(B101), (A)+(B59)+(B102), (A)+(B59)+(B103), (A)+(B59)+(B104), (A)+(B59)+(B105), (A)+(B59)+(B106), (A)+(B59)+(B107), (A)+(B59)+(B108), (A)+(B59)+(B109), (A)+(B59)+(B110), (A)+(B59)+(B111), (A)+(B59)+(B112), (A)+(B59)+(B113), (A)+(B59)+(B114), (A)+(B59)+(B115), (A)+(B59)+(B116), (A)+(B59)+(B117), (A)+(B59)+(B118), (A)+(B59)+(B119), (A)+(B59)+(B120), (A)+(B59)+(B121), (A)+(B59)+(B122), (A)+(B59)+(B123), (A)+(B59)+(B124), (A)+(B59)+(B125), (A)+(B59)+(B126), (A)+(B59)+(B127), (A)+(B59)+(B128), (A)+(B59)+(B129), (A)+(B59)+(B130), (A)+(B59)+(B131), (A)+(B59)+(B132), (A)+(B59)+(B133), (A)+(B59)+(B134), (A)+(B59)+(B135), (A)+(B59)+(B136), (A)+(B59)+(B137), (A)+(B59)+(B138), (A)+(B59)+(B139), (A)+(B59)+(B140), (A)+(B59)+(B141), (A)+(B59)+(B142), (A)+(B59)+(B143), (A)+(B59)+(B144), (A)+(B59)+(B145), (A)+(B59)+(B146), (A)+(B59)+(B147), (A)+(B59)+(B148), (A)+(B59)+(B149), (A)+(B59)+(B150), (A)+(B59)+(B151), (A)+(B59)+(B152), (A)+(B59)+(B153), (A)+(B59)+(B154), (A)+(B59)+(B155), (A)+(B59)+(B156), (A)+(B59)+(B157), (A)+(B59)+(B158), (A)+(B59)+(B159), (A)+(B59)+(B160), (A)+(B59)+(B161), (A)+(B59)+(B162), (A)+(B59)+(B164), (A)+(B59)+(B164), (A)+(B59)+(B165), (A)+(B59)+(B166), (A)+(B59)+(B167), (A)+(B59)+(B168), (A)+(B59)+(B169), (A)+(B59)+(B170), (A)+(B59)+(B171), (A)+(B59)+(B172), (A)+(B59)+(B173), (A)+(B59)+(B174), (A)+(B59)+(B175), (A)+(B59)+(B176), (A)+(B59)+(B177), (A)+(B59)+(B178), (A)+(B59)+(B179), (A)+(B59)+(B180), (A)+(B59)+(B181), (A)+(B59)+(B182), (A)+(B59)+(B183), (A)+(B59)+(B184), (A)+(B59)+(B185), (A)+(B59)+(B186), (A)+(B59)+(B187), (A)+(B59)+(B188), (A)+(B59)+(B189), (A)+(B59)+(B190), (A)+(B59)+(B191), (A)+(B59)+(B192), (A)+(B59)+(B193), (A)+(B59)+(B194), (A)+(B59)+(B195), (A)+(B59)+(B196), (A)+(B59)+(B197), (A)+(B59)+(B198), (A)+(B59)+(B199), (A)+(B59)+(B200), (A)+(B59)+(B201), (A)+(B59)+(B202), (A)+(B59)+(B203), (A)+(B59)+(B204), (A)+(B59)+(B205), (A)+(B59)+(B206), (A)+(B59)+(B207), (A)+(B59)+(B208), (A)+(B59)+(B209), (A)+(B59)+(B210), (A)+(B59)+(B211), (A)+(B59)+(B212), (A)+(B59)+(B213), (A)+(B59)+(B214), (A)+(B59)+(B215), (A)+(B59)+(B216), (A)+(B59)+(B217), (A)+(B59)+(B218), (A)+(B59)+(B219), (A)+(B59)+(B220), (A)+(B59)+(B221), (A)+(B59)+(B222), (A)+(B59)+(B223), (A)+(B59)+(B224), (A)+(B59)+(B225), (A)+(B59)+(B226), (A)+(B59)+(B227), (A)+(B59)+(B228), (A)+(B59)+(B229), (A)+(B59)+(B230), (A)+(B59)+(B231), (A)+(B59)+(B232), (A)+(B59)+(B233), (A)+(B59)+(B234), (A)+(B59)+(B235), (A)+(B59)+(B236), (A)+(B59)+(B237), (A)+(B59)+(B238), (A)+(B59)+(B239), (A)+(B59)+(B240), (A)+(B59)+(B241), (A)+(B59)+(B242), (A)+(B59)+(B243), (A)+(B59)+(B244), (A)+(B59)+(B245), (A)+(B59)+(B246), (A)+(B59)+(B247), (A)+(B59)+(B248), (A)+(B59)+(B249), (A)+(B59)+(B250), (A)+(B59)+(B251), (A)+(B59)+(B252), (A)+(B59)+(B253), (A)+(B59)+(B254), (A)+(B59)+(B255), (A)+(B59)+(B256), (A)+(B59)+(B257), (A)+(B59)+(B258), (A)+(B59)+(B259), (A)+(B59)+(B260), (A)+(B59)+(B261), (A)+(B59)+(B262), (A)+(B59)+(B263), (A)+(B59)+(B264), (A)+(B59)+(B265), (A)+(B59)+(B266), (A)+(B59)+(B267), (A)+(B59)+(B268), (A)+(B59)+(B269), (A)+(B59)+(B270), (A)+(B59)+(B271), (A)+(B59)+(B272), (A)+(B59)+(B273), (A)+(B59)+(B274), (A)+(B59)+(B275), (A)+(B59)+(B276), (A)+(B59)+(B277), (A)+(B59)+(B278), (A)+(B59)+(B279), (A)+(B59)+(B280), (A)+(B59)+(B281), (A)+(B59)+(B282), (A)+(B59)+(B283), (A)+(B59)+(B284), (A)+(B59)+(B285), (A)+(B59)+(B286), (A)+(B59)+(B287), (A)+(B59)+(B288), (A)+(B59)+(B289), (A)+(B59)+(B290), (A)+(B59)+(B291), (A)+(B59)+(B292), (A)+(B59)+(B293), (A)+(B59)+(B294), (A)+(B59)+(B295), (A)+(B59)+(B296), (A)+(B59)+(B297), (A)+(B59)+(B298), (A)+(B59)+(B299), (A)+(B59)+(B300), (A)+(B59)+(B301), (A)+(B59)+(B302), (A)+(B59)+(B303), (A)+(B59)+(B304), (A)+(B59)+(B305), (A)+(B59)+(B306), (A)+(B59)+(B307), (A)+(B59)+(B308), (A)+(B59)+(B309), (A)+(B59)+(B310), (A)+(B59)+(B311), (A)+(B59)+(B312), (A)+(B59)+(B313), (A)+(B59)+(B314), (A)+(B59)+(B315),

(A)+(B59)+(B61), (A)+(B59)+(B62), (A)+(B59)+(B63), (A)+(B59)+(B64), (A)+(B59)+(B65), (A)+(B59)+(B66), (A)+(B59)+(B67), (A)+(B59)+(B68), (A)+(B59)+(B69), (A)+(B59)+(B70), (A)+(B59)+(B71), (A)+(B59)+(B72), (A)+(B59)+(B73), (A)+(B59)+(B74), (A)+(B59)+(B75), (A)+(B59)+(B76), (A)+(B59)+(B77), (A)+(B59)+(B78), (A)+(B59)+(B79), (A)+(B59)+(B80), (A)+(B59)+(B81), (A)+(B59)+(B82), (A)+(B59)+(B83), (A)+(B59)+(B84), (A)+(B59)+(B85), (A)+(B59)+(B86), (A)+(B59)+(B87), (A)+(B59)+(B88), (A)+(B59)+(B89), (A)+(B59)+(B90), (A)+(B59)+(B91), (A)+(B59)+(B92), (A)+(B59)+(B93), (A)+(B59)+(B94), (A)+(B59)+(B95), (A)+(B59)+(B96), (A)+(B59)+(B97), (A)+(B59)+(B98), (A)+(B59)+(B99), (A)+(B59)+(B100), (A)+(B59)+(B101), (A)+(B59)+(B102), (A)+(B59)+(B103), (A)+(B59)+(B104), (A)+(B59)+(B105), (A)+(B59)+(B106), (A)+(B59)+(B107), (A)+(B59)+(B108), (A)+(B59)+(B109), (A)+(B59)+(B110), (A)+(B59)+(B111), (A)+(B59)+(B112), (A)+(B59)+(B113), (A)+(B59)+(B114), (A)+(B59)+(B115), (A)+(B59)+(B116), (A)+(B59)+(B117), (A)+(B59)+(B118), (A)+(B59)+(B119), (A)+(B59)+(B120), (A)+(B59)+(B121), (A)+(B59)+(B122), (A)+(B59)+(B123), (A)+(B59)+(B124), (A)+(B59)+(B125), (A)+(B59)+(B126), (A)+(B59)+(B127), (A)+(B59)+(B128), (A)+(B59)+(B129), (A)+(B59)+(B130), (A)+(B59)+(B131), (A)+(B59)+(B132), (A)+(B59)+(B133), (A)+(B59)+(B134), (A)+(B59)+(B135), (A)+(B59)+(B136), (A)+(B59)+(B137), (A)+(B59)+(B138), (A)+(B59)+(B139), (A)+(B59)+(B140), (A)+(B59)+(B141), (A)+(B59)+(B142), (A)+(B59)+(B143), (A)+(B59)+(B144), (A)+(B59)+(B145), (A)+(B59)+(B146), (A)+(B59)+(B147), (A)+(B59)+(B148), (A)+(B59)+(B149), (A)+(B59)+(B150), (A)+(B59)+(B151), (A)+(B59)+(B152), (A)+(B59)+(B153), (A)+(B59)+(B154), (A)+(B59)+(B155), (A)+(B59)+(B156), (A)+(B59)+(B157), (A)+(B59)+(B158), (A)+(B59)+(B159), (A)+(B59)+(B160), (A)+(B59)+(B161), (A)+(B59)+(B162), (A)+(B59)+(B164), (A)+(B59)+(B164), (A)+(B59)+(B165), (A)+(B59)+(B166), (A)+(B59)+(B167), (A)+(B59)+(B168), (A)+(B59)+(B169), (A)+(B59)+(B170), (A)+(B59)+(B171), (A)+(B59)+(B172), (A)+(B59)+(B173), (A)+(B59)+(B174), (A)+(B59)+(B175), (A)+(B59)+(B176), (A)+(B59)+(B177), (A)+(B59)+(B178), (A)+(B59)+(B179), (A)+(B59)+(B180), (A)+(B59)+(B181), (A)+(B59)+(B182), (A)+(B59)+(B183), (A)+(B59)+(B184), (A)+(B59)+(B185), (A)+(B59)+(B186), (A)+(B59)+(B187), (A)+(B59)+(B188), (A)+(B59)+(B189), (A)+(B59)+(B190), (A)+(B59)+(B191), (A)+(B59)+(B192), (A)+(B59)+(B193), (A)+(B59)+(B194), (A)+(B59)+(B195), (A)+(B59)+(B196), (A)+(B59)+(B197), (A)+(B59)+(B198), (A)+(B59)+(B199), (A)+(B59)+(B200), (A)+(B59)+(B201), (A)+(B59)+(B202), (A)+(B59)+(B203), (A)+(B59)+(B204), (A)+(B59)+(B205), (A)+(B59)+(B206), (A)+(B59)+(B207), (A)+(B59)+(B208), (A)+(B59)+(B209), (A)+(B59)+(B210), (A)+(B59)+(B211), (A)+(B59)+(B212), (A)+(B59)+(B213), (A)+(B59)+(B214), (A)+(B59)+(B215), (A)+(B59)+(B216), (A)+(B59)+(B217), (A)+(B59)+(B218), (A)+(B59)+(B219), (A)+(B59)+(B220), (A)+(B59)+(B221), (A)+(B59)+(B222), (A)+(B59)+(B223), (A)+(B59)+(B224), (A)+(B59)+(B225), (A)+(B59)+(B226), (A)+(B59)+(B227), (A)+(B59)+(B228), (A)+(B59)+(B229), (A)+(B59)+(B230), (A)+(B59)+(B231), (A)+(B59)+(B232), (A)+(B59)+(B233), (A)+(B59)+(B234), (A)+(B59)+(B235), (A)+(B59)+(B236), (A)+(B59)+(B237), (A)+(B59)+(B238), (A)+(B59)+(B239), (A)+(B59)+(B240), (A)+(B59)+(B241), (A)+(B59)+(B242), (A)+(B59)+(B243), (A)+(B59)+(B244), (A)+(B59)+(B245), (A)+(B59)+(B246), (A)+(B59)+(B247), (A)+(B59)+(B248), (A)+(B59)+(B249), (A)+(B59)+(B250), (A)+(B59)+(B251), (A)+(B59)+(B252), (A)+(B59)+(B253), (A)+(B59)+(B254), (A)+(B59)+(B255), (A)+(B59)+(B256), (A)+(B59)+(B257), (A)+(B59)+(B258), (A)+(B59)+(B259), (A)+(B59)+(B260), (A)+(B59)+(B261), (A)+(B59)+(B262), (A)+(B59)+(B263), (A)+(B59)+(B264), (A)+(B59)+(B265), (A)+(B59)+(B266), (A)+(B59)+(B267), (A)+(B59)+(B268), (A)+(B59)+(B269), (A)+(B59)+(B270), (A)+(B59)+(B271), (A)+(B59)+(B272), (A)+(B59)+(B273), (A)+(B59)+(B274), (A)+(B59)+(B275), (A)+(B59)+(B276), (A)+(B59)+(B277), (A)+(B59)+(B278), (A)+(B59)+(B279), (A)+(B59)+(B280), (A)+(B59)+(B281), (A)+(B59)+(B282), (A)+(B59)+(B283), (A)+(B59)+(B284), (A)+(B59)+(B285), (A)+(B59)+(B286), (A)+(B59)+(B287), (A)+(B59)+(B288), (A)+(B59)+(B289), (A)+(B59)+(B290), (A)+(B59)+(B291), (A)+(B59)+(B292), (A)+(B59)+(B293), (A)+(B59)+(B294), (A)+(B59)+(B295), (A)+(B59)+(B296), (A)+(B59)+(B297), (A)+(B59)+(B298), (A)+(B59)+(B299), (A)+(B59)+(B300), (A)+(B59)+(B301), (A)+(B59)+(B302), (A)+(B59)+(B303), (A)+(B59)+(B304), (A)+(B59)+(B305), (A)+(B59)+(B306), (A)+(B59)+(B307), (A)+(B59)+(B308), (A)+(B59)+(B309), (A)+(B59)+(B310), (A)+(B59)+(B311), (A)+(B59)+(B312), (A)+(B59)+(B313), (A)+(B59)+(B314), (A)+(B59)+(B315),

(A)+(B60)+(B61), (A)+(B60)+(B62), (A)+(B60)+(B63), (A)+(B60)+(B64), (A)+(B60)+(B65), (A)+(B60)+(B66), (A)+(B60)+(B67), (A)+(B60)+(B68), (A)+(B60)+(B69), (A)+(B60)+(B70), (A)+(B60)+(B71), (A)+(B60)+(B72), (A)+(B60)+(B73), (A)+(B60)+(B74), (A)+(B60)+(B75), (A)+(B60)+(B76), (A)+(B60)+(B77), (A)+(B60)+(B78), (A)+(B60)+(B79), (A)+(B60)+(B80), (A)+(B60)+(B81), (A)+(B60)+(B82), (A)+(B60)+(B83), (A)+(B60)+(B84), (A)+(B60)+(B85), (A)+(B60)+(B86), (A)+(B60)+(B87), (A)+(B60)+(B88), (A)+(B60)+(B89), (A)+(B60)+(B90), (A)+(B60)+(B91), (A)+(B60)+(B92), (A)+(B60)+(B93), (A)+(B60)+(B94), (A)+(B60)+(B95), (A)+(B60)+(B96), (A)+(B60)+(B97), (A)+(B60)+(B98), (A)+(B60)+(B99), (A)+(B60)+(B100), (A)+(B60)+(B101), (A)+(B60)+(B102), (A)+(B60)+(B103), (A)+(B60)+(B104), (A)+(B60)+(B105), (A)+(B60)+(B106), (A)+(B60)+(B107), (A)+(B60)+(B108), (A)+(B60)+(B109), (A)+(B60)+(B110), (A)+(B60)+(B111), (A)+(B60)+(B112), (A)+(B60)+(B113), (A)+(B60)+(B114), (A)+(B60)+(B115), (A)+(B60)+(B116), (A)+(B60)+(B117), (A)+(B60)+(B118), (A)+(B60)+(B119), (A)+(B60)+(B120), (A)+(B60)+(B121), (A)+(B60)+(B122), (A)+(B60)+(B123), (A)+(B60)+(B124), (A)+(B60)+(B125), (A)+(B60)+(B126), (A)+(B60)+(B127), (A)+(B60)+(B128), (A)+(B60)+(B129), (A)+(B60)+(B130), (A)+(B60)+(B131), (A)+(B60)+(B132), (A)+(B60)+(B133), (A)+(B60)+(B134), (A)+(B60)+(B135), (A)+(B60)+(B136), (A)+(B60)+(B137), (A)+(B60)+(B138), (A)+(B60)+(B139), (A)+(B60)+(B140), (A)+(B60)+(B141), (A)+(B60)+(B142), (A)+(B60)+(B143), (A)+(B60)+(B144), (A)+(B60)+(B145), (A)+(B60)+(B146), (A)+(B60)+(B147), (A)+(B60)+(B148), (A)+(B60)+(B149), (A)+(B60)+(B150), (A)+(B60)+(B151), (A)+(B60)+(B152), (A)+(B60)+(B153), (A)+(B60)+(B154), (A)+(B60)+(B155), (A)+(B60)+(B156), (A)+(B60)+(B157), (A)+(B60)+(B158), (A)+(B60)+(B159), (A)+(B60)+(B160), (A)+(B60)+(B161), (A)+(B60)+(B162), (A)+(B60)+(B164), (A)+(B60)+(B164), (A)+(B60)+(B165), (A)+(B60)+(B166), (A)+(B60)+(B167), (A)+(B60)+(B168), (A)+(B60)+(B169), (A)+(B60)+(B170), (A)+(B60)+(B171), (A)+(B60)+(B172), (A)+(B60)+(B173), (A)+(B60)+(B174), (A)+(B60)+(B175), (A)+(B60)+(B176), (A)+(B60)+(B177), (A)+(B60)+(B178), (A)+(B60)+(B179), (A)+(B60)+(B180), (A)+(B60)+(B181), (A)+(B60)+(B182), (A)+(B60)+(B183), (A)+(B60)+(B184), (A)+(B60)+(B185), (A)+(B60)+(B186), (A)+(B60)+(B187), (A)+(B60)+(B188), (A)+(B60)+(B189), (A)+(B60)+(B190), (A)+(B60)+(B191), (A)+(B60)+(B192), (A)+(B60)+(B193), (A)+(B60)+(B194), (A)+(B60)+(B195), (A)+(B60)+(B196), (A)+(B60)+(B197), (A)+(B60)+(B198), (A)+(B60)+(B199), (A)+(B60)+(B200), (A)+(B60)+(B201), (A)+(B60)+(B202), (A)+(B60)+(B203), (A)+(B60)+(B204), (A)+(B60)+(B205), (A)+(B60)+(B206), (A)+(B60)+(B207), (A)+(B60)+(B208), (A)+(B60)+(B209), (A)+(B60)+(B210), (A)+(B60)+(B211), (A)+(B60)+(B212), (A)+(B60)+(B213), (A)+(B60)+(B214), (A)+(B60)+(B215), (A)+(B60)+(B216), (A)+(B60)+(B217), (A)+(B60)+(B218), (A)+(B60)+(B219), (A)+(B60)+(B220), (A)+(B60)+(B221), (A)+(B60)+(B222), (A)+(B60)+(B223), (A)+(B60)+(B224), (A)+(B60)+(B225), (A)+(B60)+(B226), (A)+(B60)+(B227), (A)+(B60)+(B228), (A)+(B60)+(B229), (A)+(B60)+(B230), (A)+(B60)+(B231), (A)+(B60)+(B232), (A)+(B60)+(B233), (A)+(B60)+(B234), (A)+(B60)+(B235), (A)+(B60)+(B236), (A)+(B60)+(B237), (A)+(B60)+(B238), (A)+(B60)+(B239), (A)+(B60)+(B240), (A)+(B60)+(B241), (A)+(B60)+(B242), (A)+(B60)+(B243), (A)+(B60)+(B244), (A)+(B60)+(B245), (A)+(B60)+(B246), (A)+(B60)+(B247), (A)+(B60)+(B248), (A)+(B60)+(B249), (A)+(B60)+(B250), (A)+(B60)+(B251), (A)+(B60)+(B252), (A)+(B60)+(B253), (A)+(B60)+(B254), (A)+(B60)+(B255), (A)+(B60)+(B256), (A)+(B60)+(B257), (A)+(B60)+(B258), (A)+(B60)+(B259), (A)+(B60)+(B260), (A)+(B60)+(B261), (A)+(B60)+(B262), (A)+(B60)+(B263), (A)+(B60)+(B264), (A)+(B60)+(B265), (A)+(B60)+(B266), (A)+(B60)+(B267), (A)+(B60)+(B268), (A)+(B60)+(B269), (A)+(B60)+(B270), (A)+(B60)+(B271), (A)+(B60)+(B272), (A)+(B60)+(B273), (A)+(B60)+(B274), (A)+(B60)+(B275), (A)+(B60)+(B276), (A)+(B60)+(B277), (A)+(B60)+(B278), (A)+(B60)+(B279), (A)+(B60)+(B280), (A)+(B60)+(B281), (A)+(B60)+(B282), (A)+(B60)+(B283), (A)+(B60)+(B284), (A)+(B60)+(B285), (A)+(B60)+(B286), (A)+(B60)+(B287), (A)+(B60)+(B288), (A)+(B60)+(B289), (A)+(B60)+(B290), (A)+(B60)+(B291), (A)+(B60)+(B292), (A)+(B60)+(B293), (A)+(B60)+(B294), (A)+(B60)+(B295), (A)+(B60)+(B296), (A)+(B60)+(B297), (A)+(B60)+(B298), (A)+(B60)+(B299), (A)+(B60)+(B300), (A)+(B60)+(B301), (A)+(B60)+(B302), (A)+(B60)+(B303), (A)+(B60)+(B304), (A)+(B60)+(B305), (A)+(B60)+(B306), (A)+(B60)+(B307), (A)+(B60)+(B308), (A)+(B60)+(B309), (A)+(B60)+(B310), (A)+(B60)+(B311), (A)+(B60)+(B312), (A)+(B60)+(B313), (A)+(B60)+(B314), (A)+(B60)+(B315),

(A)+(B61)+(B62), (A)+(B61)+(B63), (A)+(B61)+(B64), (A)+(B61)+(B65), (A)+(B61)+(B66), (A)+(B61)+(B67), (A)+(B61)+(B68), (A)+(B61)+(B69), (A)+(B61)+(B70), (A)+(B61)+(B71), (A)+(B61)+(B72), (A)+(B61)+(B73), (A)+(B61)+(B74), (A)+(B61)+(B75), (A)+(B61)+(B76), (A)+(B61)+(B77), (A)+(B61)+(B78), (A)+(B61)+(B79), (A)+(B61)+(B80), (A)+(B61)+(B81), (A)+(B61)+(B82), (A)+(B61)+(B83), (A)+(B61)+(B84), (A)+(B61)+(B85), (A)+(B61)+(B86), (A)+(B61)+(B87), (A)+(B61)+(B88), (A)+(B61)+(B89), (A)+(B61)+(B90), (A)+(B61)+(B91), (A)+(B61)+(B92), (A)+(B61)+(B93), (A)+(B61)+(B94), (A)+(B61)+(B95), (A)+(B61)+(B96), (A)+(B61)+(B97), (A)+(B61)+(B98), (A)+(B61)+(B99), (A)+(B61)+(B100), (A)+(B61)+(B101), (A)+(B61)+(B102), (A)+(B61)+(B103), (A)+(B61)+(B104), (A)+(B61)+(B105), (A)+(B61)+(B106), (A)+(B61)+(B107), (A)+(B61)+(B108), (A)+(B61)+(B109), (A)+(B61)+(B110), (A)+(B61)+(B111), (A)+(B61)+(B112), (A)+(B61)+(B113), (A)+(B61)+(B114), (A)+(B61)+(B115), (A)+(B61)+(B116), (A)+(B61)+(B117), (A)+(B61)+(B118), (A)+(B61)+(B119), (A)+(B61)+(B120), (A)+(B61)+(B121), (A)+(B61)+(B122), (A)+(B61)+(B123), (A)+(B61)+(B124), (A)+(B61)+(B125), (A)+(B61)+(B126), (A)+(B61)+(B127), (A)+(B61)+(B128), (A)+(B61)+(B129), (A)+(B61)+(B130), (A)+(B61)+(B131), (A)+(B61)+(B132), (A)+(B61)+(B133), (A)+(B61)+(B134), (A)+(B61)+(B135), (A)+(B61)+(B136), (A)+(B61)+(B137), (A)+(B61)+(B138), (A)+(B61)+(B139), (A)+(B61)+(B140), (A)+(B61)+(B141), (A)+(B61)+(B142), (A)+(B61)+(B143), (A)+(B61)+(B144), (A)+(B61)+(B145), (A)+(B61)+(B146), (A)+(B61)+(B147), (A)+(B61)+(B148), (A)+(B61)+(B149), (A)+(B61)+(B150), (A)+(B61)+(B151), (A)+(B61)+(B152), (A)+(B61)+(B153), (A)+(B61)+(B154), (A)+(B61)+(B155), (A)+(B61)+(B156), (A)+(B61)+(B157), (A)+(B61)+(B158), (A)+(B61)+(B159), (A)+(B61)+(B160), (A)+(B61)+(B161), (A)+(B61)+(B162), (A)+(B61)+(B164), (A)+(B61)+(B164), (A)+(B61)+(B165), (A)+(B61)+(B166), (A)+(B61)+(B167), (A)+(B61)+(B168), (A)+(B61)+(B169), (A)+(B61)+(B170), (A)+(B61)+(B171), (A)+(B61)+(B172), (A)+(B61)+(B173), (A)+(B61)+(B174), (A)+(B61)+(B175), (A)+(B61)+(B176), (A)+(B61)+(B177), (A)+(B61)+(B178), (A)+(B61)+(B179), (A)+(B61)+(B180), (A)+(B61)+(B181), (A)+(B61)+(B182), (A)+(B61)+(B183), (A)+(B61)+(B184), (A)+(B61)+(B185), (A)+(B61)+(B186), (A)+(B61)+(B187), (A)+(B61)+(B188), (A)+(B61)+(B189), (A)+(B61)+(B190), (A)+(B61)+(B191), (A)+(B61)+(B192), (A)+(B61)+(B193), (A)+(B61)+(B194), (A)+(B61)+(B195), (A)+(B61)+(B196), (A)+(B61)+(B197), (A)+(B61)+(B198), (A)+(B61)+(B199), (A)+(B61)+(B200), (A)+(B61)+(B201), (A)+(B61)+(B202), (A)+(B61)+(B203), (A)+(B61)+(B204), (A)+(B61)+(B205), (A)+(B61)+(B206), (A)+(B61)+(B207), (A)+(B61)+(B208), (A)+(B61)+(B209), (A)+(B61)+(B210), (A)+(B61)+(B211), (A)+(B61)+(B212), (A)+(B61)+(B213), (A)+(B61)+(B214), (A)+(B61)+(B215), (A)+(B61)+(B216), (A)+(B61)+(B217), (A)+(B61)+(B218), (A)+(B61)+(B219), (A)+(B61)+(B220), (A)+(B61)+(B221), (A)+(B61)+(B222), (A)+(B61)+(B223), (A)+(B61)+(B224), (A)+(B61)+(B225), (A)+(B61)+(B226), (A)+(B61)+(B227), (A)+(B61)+(B228), (A)+(B61)+(B229), (A)+(B61)+(B230), (A)+(B61)+(B231), (A)+(B61)+(B232), (A)+(B61)+(B233), (A)+(B61)+(B234), (A)+(B61)+(B235), (A)+(B61)+(B236), (A)+(B61)+(B237), (A)+(B61)+(B238), (A)+(B61)+(B239), (A)+(B61)+(B240), (A)+(B61)+(B241), (A)+(B61)+(B242), (A)+(B61)+(B243), (A)+(B61)+(B244), (A)+(B61)+(B245), (A)+(B61)+(B246), (A)+(B61)+(B247), (A)+(B61)+(B248), (A)+(B61)+(B249), (A)+(B61)+(B250), (A)+(B61)+(B251), (A)+(B61)+(B252), (A)+(B61)+(B253), (A)+(B61)+(B254), (A)+(B61)+(B255), (A)+(B61)+(B256), (A)+(B61)+(B257), (A)+(B61)+(B258), (A)+(B61)+(B259), (A)+(B61)+(B260), (A)+(B61)+(B261), (A)+(B61)+(B262), (A)+(B61)+(B263), (A)+(B61)+(B264), (A)+(B61)+(B265), (A)+(B61)+(B266), (A)+(B61)+(B267), (A)+(B61)+(B268), (A)+(B61)+(B269), (A)+(B61)+(B270), (A)+(B61)+(B271), (A)+(B61)+(B272), (A)+(B61)+(B273), (A)+(B61)+(B274), (A)+(B61)+(B275), (A)+(B61)+(B276), (A)+(B61)+(B277), (A)+(B61)+(B278), (A)+(B61)+(B279), (A)+(B61)+(B280), (A)+(B61)+(B281), (A)+(B61)+(B282), (A)+(B61)+(B283), (A)+(B61)+(B284), (A)+(B61)+(B285), (A)+(B61)+(B286), (A)+(B61)+(B287), (A)+(B61)+(B288), (A)+(B61)+(B289), (A)+(B61)+(B290), (A)+(B61)+(B291), (A)+(B61)+(B292), (A)+(B61)+(B293), (A)+(B61)+(B294), (A)+(B61)+(B295), (A)+(B61)+(B296), (A)+(B61)+(B297), (A)+(B61)+(B298), (A)+(B61)+(B299), (A)+(B61)+(B300), (A)+(B61)+(B301), (A)+(B61)+(B302), (A)+(B61)+(B303), (A)+(B61)+(B304), (A)+(B61)+(B305), (A)+(B61)+(B306), (A)+(B61)+(B307), (A)+(B61)+(B308), (A)+(B61)+(B309), (A)+(B61)+(B310), (A)+(B61)+(B311), (A)+(B61)+(B312), (A)+(B61)+(B313), (A)+(B61)+(B314), (A)+(B61)+(B315),

(A)+(B62)+(B63), (A)+(B62)+(B64), (A)+(B62)+(B65), (A)+(B62)+(B66), (A)+(B62)+(B67), (A)+(B62)+(B68), (A)+(B62)+(B69), (A)+(B62)+(B70), (A)+(B62)+(B71), (A)+(B62)+(B72), (A)+(B62)+(B73), (A)+(B62)+(B74), (A)+(B62)+(B75), (A)+(B62)+(B76), (A)+(B62)+(B77), (A)+(B62)+(B78), (A)+(B62)+(B79), (A)+(B62)+(B80), (A)+(B62)+(B81), (A)+(B62)+(B82), (A)+(B62)+(B83), (A)+(B62)+(B84), (A)+(B62)+(B85), (A)+(B62)+(B86), (A)+(B62)+(B87), (A)+(B62)+(B88), (A)+(B62)+(B89), (A)+(B62)+(B90), (A)+(B62)+(B91), (A)+(B62)+(B92), (A)+(B62)+(B93), (A)+(B62)+(B94), (A)+(B62)+(B95), (A)+(B62)+(B96), (A)+(B62)+(B97), (A)+(B62)+(B98), (A)+(B62)+(B99), (A)+(B62)+(B100), (A)+(B62)+(B101), (A)+(B62)+(B102), (A)+(B62)+(B103), (A)+(B62)+(B104), (A)+(B62)+(B105), (A)+(B62)+(B106), (A)+(B62)+(B107), (A)+(B62)+(B108), (A)+(B62)+(B109), (A)+(B62)+(B110), (A)+(B62)+(B111), (A)+(B62)+(B112), (A)+(B62)+(B113), (A)+(B62)+(B114), (A)+(B62)+(B115), (A)+(B62)+(B116), (A)+(B62)+(B117), (A)+(B62)+(B118), (A)+(B62)+(B119), (A)+(B62)+(B120), (A)+(B62)+(B121), (A)+(B62)+(B122), (A)+(B62)+(B123), (A)+(B62)+(B124), (A)+(B62)+(B125), (A)+(B62)+(B126), (A)+(B62)+(B127), (A)+(B62)+(B128), (A)+(B62)+(B129), (A)+(B62)+(B130), (A)+(B62)+(B131), (A)+(B62)+(B132), (A)+(B62)+(B133), (A)+(B62)+(B134), (A)+(B62)+(B135), (A)+(B62)+(B136), (A)+(B62)+(B137), (A)+(B62)+(B138), (A)+(B62)+(B139), (A)+(B62)+(B140), (A)+(B62)+(B141), (A)+(B62)+(B142), (A)+(B62)+(B143), (A)+(B62)+(B144), (A)+(B62)+(B145), (A)+(B62)+(B146), (A)+(B62)+(B147), (A)+(B62)+(B148), (A)+(B62)+(B149), (A)+(B62)+(B150), (A)+(B62)+(B151), (A)+(B62)+(B152), (A)+(B62)+(B153), (A)+(B62)+(B154), (A)+(B62)+(B155), (A)+(B62)+(B156), (A)+(B62)+(B157), (A)+(B62)+(B158), (A)+(B62)+(B159), (A)+(B62)+(B160), (A)+(B62)+(B161), (A)+(B62)+(B162), (A)+(B62)+(B164), (A)+(B62)+(B164), (A)+(B62)+(B165), (A)+(B62)+(B166), (A)+(B62)+(B167), (A)+(B62)+(B168), (A)+(B62)+(B169), (A)+(B62)+(B170), (A)+(B62)+(B171), (A)+(B62)+(B172), (A)+(B62)+(B173), (A)+(B62)+(B174), (A)+(B62)+(B175), (A)+(B62)+(B176), (A)+(B62)+(B177), (A)+(B62)+(B178), (A)+(B62)+(B179), (A)+(B62)+(B180), (A)+(B62)+(B181), (A)+(B62)+(B182), (A)+(B62)+(B183), (A)+(B62)+(B184), (A)+(B62)+(B185), (A)+(B62)+(B186), (A)+(B62)+(B187), (A)+(B62)+(B188), (A)+(B62)+(B189), (A)+(B62)+(B190), (A)+(B62)+(B191), (A)+(B62)+(B192), (A)+(B62)+(B193), (A)+(B62)+(B194), (A)+(B62)+(B195), (A)+(B62)+(B196), (A)+(B62)+(B197), (A)+(B62)+(B198), (A)+(B62)+(B199), (A)+(B62)+(B200), (A)+(B62)+(B201), (A)+(B62)+(B202), (A)+(B62)+(B203), (A)+(B62)+(B204), (A)+(B62)+(B205), (A)+(B62)+(B206), (A)+(B62)+(B207), (A)+(B62)+(B208), (A)+(B62)+(B209), (A)+(B62)+(B210), (A)+(B62)+(B211), (A)+(B62)+(B212), (A)+(B62)+(B213), (A)+(B62)+(B214), (A)+(B62)+(B215), (A)+(B62)+(B216), (A)+(B62)+(B217), (A)+(B62)+(B218), (A)+(B62)+(B219), (A)+(B62)+(B220), (A)+(B62)+(B221), (A)+(B62)+(B222), (A)+(B62)+(B223), (A)+(B62)+(B224), (A)+(B62)+(B225), (A)+(B62)+(B226), (A)+(B62)+(B227), (A)+(B62)+(B228), (A)+(B62)+(B229), (A)+(B62)+(B230), (A)+(B62)+(B231), (A)+(B62)+(B232), (A)+(B62)+(B233), (A)+(B62)+(B234), (A)+(B62)+(B235), (A)+(B62)+(B236), (A)+(B62)+(B237), (A)+(B62)+(B238), (A)+(B62)+(B239), (A)+(B62)+(B240), (A)+(B62)+(B241), (A)+(B62)+(B242), (A)+(B62)+(B243), (A)+(B62)+(B244), (A)+(B62)+(B245), (A)+(B62)+(B246), (A)+(B62)+(B247), (A)+(B62)+(B248), (A)+(B62)+(B249), (A)+(B62)+(B250), (A)+(B62)+(B251), (A)+(B62)+(B252), (A)+(B62)+(B253), (A)+(B62)+(B254), (A)+(B62)+(B255), (A)+(B62)+(B256), (A)+(B62)+(B257), (A)+(B62)+(B258), (A)+(B62)+(B259), (A)+(B62)+(B260), (A)+(B62)+(B261), (A)+(B62)+(B262), (A)+(B62)+(B263), (A)+(B62)+(B264), (A)+(B62)+(B265), (A)+(B62)+(B266), (A)+(B62)+(B267), (A)+(B62)+(B268), (A)+(B62)+(B269), (A)+(B62)+(B270), (A)+(B62)+(B271), (A)+(B62)+(B272), (A)+(B62)+(B273), (A)+(B62)+(B274), (A)+(B62)+(B275), (A)+(B62)+(B276), (A)+(B62)+(B277), (A)+(B62)+(B278), (A)+(B62)+(B279), (A)+(B62)+(B280), (A)+(B62)+(B281), (A)+(B62)+(B282), (A)+(B62)+(B283), (A)+(B62)+(B284), (A)+(B62)+(B285), (A)+(B62)+(B286), (A)+(B62)+(B287), (A)+(B62)+(B288), (A)+(B62)+(B289), (A)+(B62)+(B290), (A)+(B62)+(B291), (A)+(B62)+(B292), (A)+(B62)+(B293), (A)+(B62)+(B294), (A)+(B62)+(B295), (A)+(B62)+(B296), (A)+(B62)+(B297), (A)+(B62)+(B298), (A)+(B62)+(B299), (A)+(B62)+(B300), (A)+(B62)+(B301), (A)+(B62)+(B302), (A)+(B62)+(B303), (A)+(B62)+(B304), (A)+(B62)+(B305), (A)+(B62)+(B306), (A)+(B62)+(B307), (A)+(B62)+(B308), (A)+(B62)+(B309), (A)+(B62)+(B310), (A)+(B62)+(B311), (A)+(B62)+(B312), (A)+(B62)+(B313), (A)+(B62)+(B314), (A)+(B62)+(B315),

(A)+(B63)+(B64), (A)+(B63)+(B65), (A)+(B63)+(B66), (A)+(B63)+(B67), (A)+(B63)+(B68), (A)+(B63)+(B69), (A)+(B63)+(B70), (A)+(B63)+(B71), (A)+(B63)+(B72), (A)+(B63)+(B73), (A)+(B63)+(B74), (A)+(B63)+(B75), (A)+(B63)+(B76), (A)+(B63)+(B77), (A)+(B63)+(B78), (A)+(B63)+(B79), (A)+(B63)+(B80), (A)+(B63)+(B81), (A)+(B63)+(B82), (A)+(B63)+(B83), (A)+(B63)+(B84), (A)+(B63)+(B85), (A)+(B63)+(B86), (A)+(B63)+(B87), (A)+(B63)+(B88), (A)+(B63)+(B89), (A)+(B63)+(B90), (A)+(B63)+(B91), (A)+(B63)+(B92), (A)+(B63)+(B93), (A)+(B63)+(B94), (A)+(B63)+(B95), (A)+(B63)+(B96), (A)+(B63)+(B97), (A)+(B63)+(B98), (A)+(B63)+(B99), (A)+(B63)+(B100), (A)+(B63)+(B101), (A)+(B63)+(B102), (A)+(B63)+(B103), (A)+(B63)+(B104), (A)+(B63)+(B105), (A)+(B63)+(B106), (A)+(B63)+(B107), (A)+(B63)+(B108), (A)+(B63)+(B109), (A)+(B63)+(B110), (A)+(B63)+(B111), (A)+(B63)+(B112), (A)+(B63)+(B113), (A)+(B63)+(B114), (A)+(B63)+(B115), (A)+(B63)+(B116), (A)+(B63)+(B117), (A)+(B63)+(B118), (A)+(B63)+(B119), (A)+(B63)+(B120), (A)+(B63)+(B121), (A)+(B63)+(B122), (A)+(B63)+(B123), (A)+(B63)+(B124), (A)+(B63)+(B125), (A)+(B63)+(B126), (A)+(B63)+(B127), (A)+(B63)+(B128), (A)+(B63)+(B129), (A)+(B63)+(B130), (A)+(B63)+(B131), (A)+(B63)+(B132), (A)+(B63)+(B133), (A)+(B63)+(B134), (A)+(B63)+(B135), (A)+(B63)+(B136), (A)+(B63)+(B137), (A)+(B63)+(B138), (A)+(B63)+(B139), (A)+(B63)+(B140), (A)+(B63)+(B141), (A)+(B63)+(B142), (A)+(B63)+(B143), (A)+(B63)+(B144), (A)+(B63)+(B145), (A)+(B63)+(B146), (A)+(B63)+(B147), (A)+(B63)+(B148), (A)+(B63)+(B149), (A)+(B63)+(B150), (A)+(B63)+(B151), (A)+(B63)+(B152), (A)+(B63)+(B153), (A)+(B63)+(B154), (A)+(B63)+(B155), (A)+(B63)+(B156), (A)+(B63)+(B157), (A)+(B63)+(B158), (A)+(B63)+(B159), (A)+(B63)+(B160), (A)+(B63)+(B161), (A)+(B63)+(B162), (A)+(B63)+(B164), (A)+(B63)+(B164), (A)+(B63)+(B165), (A)+(B63)+(B166), (A)+(B63)+(B167), (A)+(B63)+(B168), (A)+(B63)+(B169), (A)+(B63)+(B170), (A)+(B63)+(B171), (A)+(B63)+(B172), (A)+(B63)+(B173), (A)+(B63)+(B174), (A)+(B63)+(B175), (A)+(B63)+(B176), (A)+(B63)+(B177), (A)+(B63)+(B178), (A)+(B63)+(B179), (A)+(B63)+(B180), (A)+(B63)+(B181), (A)+(B63)+(B182), (A)+(B63)+(B183), (A)+(B63)+(B184), (A)+(B63)+(B185), (A)+(B63)+(B186), (A)+(B63)+(B187), (A)+(B63)+(B188), (A)+(B63)+(B189), (A)+(B63)+(B190), (A)+(B63)+(B191), (A)+(B63)+(B192), (A)+(B63)+(B193), (A)+(B63)+(B194), (A)+(B63)+(B195), (A)+(B63)+(B196), (A)+(B63)+(B197), (A)+(B63)+(B198), (A)+(B63)+(B199), (A)+(B63)+(B200), (A)+(B63)+(B201), (A)+(B63)+(B202), (A)+(B63)+(B203), (A)+(B63)+(B204), (A)+(B63)+(B205), (A)+(B63)+(B206), (A)+(B63)+(B207), (A)+(B63)+(B208), (A)+(B63)+(B209), (A)+(B63)+(B210), (A)+(B63)+(B211), (A)+(B63)+(B212), (A)+(B63)+(B213), (A)+(B63)+(B214), (A)+(B63)+(B215), (A)+(B63)+(B216), (A)+(B63)+(B217), (A)+(B63)+(B218), (A)+(B63)+(B219), (A)+(B63)+(B220), (A)+(B63)+(B221), (A)+(B63)+(B222), (A)+(B63)+(B223), (A)+(B63)+(B224), (A)+(B63)+(B225), (A)+(B63)+(B226), (A)+(B63)+(B227), (A)+(B63)+(B228), (A)+(B63)+(B229), (A)+(B63)+(B230), (A)+(B63)+(B231), (A)+(B63)+(B232), (A)+(B63)+(B233), (A)+(B63)+(B234), (A)+(B63)+(B235), (A)+(B63)+(B236), (A)+(B63)+(B237), (A)+(B63)+(B238), (A)+(B63)+(B239), (A)+(B63)+(B240), (A)+(B63)+(B241), (A)+(B63)+(B242), (A)+(B63)+(B243), (A)+(B63)+(B244), (A)+(B63)+(B245), (A)+(B63)+(B246), (A)+(B63)+(B247), (A)+(B63)+(B248), (A)+(B63)+(B249), (A)+(B63)+(B250), (A)+(B63)+(B251), (A)+(B63)+(B252), (A)+(B63)+(B253), (A)+(B63)+(B254), (A)+(B63)+(B255), (A)+(B63)+(B256), (A)+(B63)+(B257), (A)+(B63)+(B258), (A)+(B63)+(B259), (A)+(B63)+(B260), (A)+(B63)+(B261), (A)+(B63)+(B262), (A)+(B63)+(B263), (A)+(B63)+(B264), (A)+(B63)+(B265), (A)+(B63)+(B266), (A)+(B63)+(B267), (A)+(B63)+(B268), (A)+(B63)+(B269), (A)+(B63)+(B270), (A)+(B63)+(B271), (A)+(B63)+(B272), (A)+(B63)+(B273), (A)+(B63)+(B274), (A)+(B63)+(B275), (A)+(B63)+(B276), (A)+(B63)+(B277), (A)+(B63)+(B278), (A)+(B63)+(B279), (A)+(B63)+(B280), (A)+(B63)+(B281), (A)+(B63)+(B282), (A)+(B63)+(B283), (A)+(B63)+(B284), (A)+(B63)+(B285), (A)+(B63)+(B286), (A)+(B63)+(B287), (A)+(B63)+(B288), (A)+(B63)+(B289), (A)+(B63)+(B290), (A)+(B63)+(B291), (A)+(B63)+(B292), (A)+(B63)+(B293), (A)+(B63)+(B294), (A)+(B63)+(B295), (A)+(B63)+(B296), (A)+(B63)+(B297), (A)+(B63)+(B298), (A)+(B63)+(B299), (A)+(B63)+(B300), (A)+(B63)+(B301), (A)+(B63)+(B302), (A)+(B63)+(B303), (A)+(B63)+(B304), (A)+(B63)+(B305), (A)+(B63)+(B306), (A)+(B63)+(B307), (A)+(B63)+(B308), (A)+(B63)+(B309), (A)+(B63)+(B310), (A)+(B63)+(B311), (A)+(B63)+(B312), (A)+(B63)+(B313), (A)+(B63)+(B314), (A)+(B63)+(B315),

(A)+(B64)+(B65), (A)+(B64)+(B66), (A)+(B64)+(B67), (A)+(B64)+(B68), (A)+(B64)+(B69), (A)+(B64)+(B70), (A)+(B64)+(B71), (A)+(B64)+(B72), (A)+(B64)+(B73), (A)+(B64)+(B74), (A)+(B64)+(B75), (A)+(B64)+(B76), (A)+(B64)+(B77), (A)+(B64)+(B78), (A)+(B64)+(B79), (A)+(B64)+(B80), (A)+(B64)+(B81), (A)+(B64)+(B82), (A)+(B64)+(B83), (A)+(B64)+(B84), (A)+(B64)+(B85), (A)+(B64)+(B86), (A)+(B64)+(B87), (A)+(B64)+(B88), (A)+(B64)+(B89), (A)+(B64)+(B90), (A)+(B64)+(B91), (A)+(B64)+(B92), (A)+(B64)+(B93), (A)+(B64)+(B94), (A)+(B64)+(B95), (A)+(B64)+(B96), (A)+(B64)+(B97), (A)+(B64)+(B98), (A)+(B64)+(B99), (A)+(B64)+(B100), (A)+(B64)+(B101), (A)+(B64)+(B102), (A)+(B64)+(B103), (A)+(B64)+(B104), (A)+(B64)+(B105), (A)+(B64)+(B106), (A)+(B64)+(B107), (A)+(B64)+(B108), (A)+(B64)+(B109), (A)+(B64)+(B110), (A)+(B64)+(B111), (A)+(B64)+(B112), (A)+(B64)+(B113), (A)+(B64)+(B114), (A)+(B64)+(B115), (A)+(B64)+(B116), (A)+(B64)+(B117), (A)+(B64)+(B118), (A)+(B64)+(B119), (A)+(B64)+(B120), (A)+(B64)+(B121), (A)+(B64)+(B122), (A)+(B64)+(B123), (A)+(B64)+(B124), (A)+(B64)+(B125), (A)+(B64)+(B126), (A)+(B64)+(B127), (A)+(B64)+(B128), (A)+(B64)+(B129), (A)+(B64)+(B130), (A)+(B64)+(B131), (A)+(B64)+(B132), (A)+(B64)+(B133), (A)+(B64)+(B134), (A)+(B64)+(B135), (A)+(B64)+(B136), (A)+(B64)+(B137), (A)+(B64)+(B138), (A)+(B64)+(B139), (A)+(B64)+(B140), (A)+(B64)+(B141), (A)+(B64)+(B142), (A)+(B64)+(B143), (A)+(B64)+(B144), (A)+(B64)+(B145), (A)+(B64)+(B146), (A)+(B64)+(B147), (A)+(B64)+(B148), (A)+(B64)+(B149), (A)+(B64)+(B150), (A)+(B64)+(B151), (A)+(B64)+(B152), (A)+(B64)+(B153), (A)+(B64)+(B154), (A)+(B64)+(B155), (A)+(B64)+(B156), (A)+(B64)+(B157), (A)+(B64)+(B158), (A)+(B64)+(B159), (A)+(B64)+(B160), (A)+(B64)+(B161), (A)+(B64)+(B162), (A)+(B64)+(B164), (A)+(B64)+(B164), (A)+(B64)+(B165), (A)+(B64)+(B166), (A)+(B64)+(B167), (A)+(B64)+(B168), (A)+(B64)+(B169), (A)+(B64)+(B170), (A)+(B64)+(B171), (A)+(B64)+(B172), (A)+(B64)+(B173), (A)+(B64)+(B174), (A)+(B64)+(B175), (A)+(B64)+(B176), (A)+(B64)+(B177), (A)+(B64)+(B178), (A)+(B64)+(B179), (A)+(B64)+(B180), (A)+(B64)+(B181), (A)+(B64)+(B182), (A)+(B64)+(B183), (A)+(B64)+(B184), (A)+(B64)+(B185), (A)+(B64)+(B186), (A)+(B64)+(B187), (A)+(B64)+(B188), (A)+(B64)+(B189), (A)+(B64)+(B190), (A)+(B64)+(B191), (A)+(B64)+(B192), (A)+(B64)+(B193), (A)+(B64)+(B194), (A)+(B64)+(B195), (A)+(B64)+(B196), (A)+(B64)+(B197), (A)+(B64)+(B198), (A)+(B64)+(B199), (A)+(B64)+(B200), (A)+(B64)+(B201), (A)+(B64)+(B202), (A)+(B64)+(B203), (A)+(B64)+(B204), (A)+(B64)+(B205), (A)+(B64)+(B206), (A)+(B64)+(B207), (A)+(B64)+(B208), (A)+(B64)+(B209), (A)+(B64)+(B210), (A)+(B64)+(B211), (A)+(B64)+(B212), (A)+(B64)+(B213), (A)+(B64)+(B214), (A)+(B64)+(B215), (A)+(B64)+(B216), (A)+(B64)+(B217), (A)+(B64)+(B218), (A)+(B64)+(B219), (A)+(B64)+(B220), (A)+(B64)+(B221), (A)+(B64)+(B222), (A)+(B64)+(B223), (A)+(B64)+(B224), (A)+(B64)+(B225), (A)+(B64)+(B226), (A)+(B64)+(B227), (A)+(B64)+(B228), (A)+(B64)+(B229), (A)+(B64)+(B230), (A)+(B64)+(B231), (A)+(B64)+(B232), (A)+(B64)+(B233), (A)+(B64)+(B234), (A)+(B64)+(B235), (A)+(B64)+(B236), (A)+(B64)+(B237), (A)+(B64)+(B238), (A)+(B64)+(B239), (A)+(B64)+(B240), (A)+(B64)+(B241), (A)+(B64)+(B242), (A)+(B64)+(B243), (A)+(B64)+(B244), (A)+(B64)+(B245), (A)+(B64)+(B246), (A)+(B64)+(B247), (A)+(B64)+(B248), (A)+(B64)+(B249), (A)+(B64)+(B250), (A)+(B64)+(B251), (A)+(B64)+(B252), (A)+(B64)+(B253), (A)+(B64)+(B254), (A)+(B64)+(B255), (A)+(B64)+(B256), (A)+(B64)+(B257), (A)+(B64)+(B258), (A)+(B64)+(B259), (A)+(B64)+(B260), (A)+(B64)+(B261), (A)+(B64)+(B262), (A)+(B64)+(B263), (A)+(B64)+(B264), (A)+(B64)+(B265), (A)+(B64)+(B266), (A)+(B64)+(B267), (A)+(B64)+(B268), (A)+(B64)+(B269), (A)+(B64)+(B270), (A)+(B64)+(B271), (A)+(B64)+(B272), (A)+(B64)+(B273), (A)+(B64)+(B274), (A)+(B64)+(B275), (A)+(B64)+(B276), (A)+(B64)+(B277), (A)+(B64)+(B278), (A)+(B64)+(B279), (A)+(B64)+(B280), (A)+(B64)+(B281), (A)+(B64)+(B282), (A)+(B64)+(B283), (A)+(B64)+(B284), (A)+(B64)+(B285), (A)+(B64)+(B286), (A)+(B64)+(B287), (A)+(B64)+(B288), (A)+(B64)+(B289), (A)+(B64)+(B290), (A)+(B64)+(B291), (A)+(B64)+(B292), (A)+(B64)+(B293), (A)+(B64)+(B294), (A)+(B64)+(B295), (A)+(B64)+(B296), (A)+(B64)+(B297), (A)+(B64)+(B298), (A)+(B64)+(B299), (A)+(B64)+(B300), (A)+(B64)+(B301), (A)+(B64)+(B302), (A)+(B64)+(B303), (A)+(B64)+(B304), (A)+(B64)+(B305), (A)+(B64)+(B306), (A)+(B64)+(B307), (A)+(B64)+(B308), (A)+(B64)+(B309), (A)+(B64)+(B310), (A)+(B64)+(B311), (A)+(B64)+(B312), (A)+(B64)+(B313), (A)+(B64)+(B314), (A)+(B64)+(B315),

(A)+(B65)+(B66), (A)+(B65)+(B67), (A)+(B65)+(B68), (A)+(B65)+(B69), (A)+(B65)+(B70), (A)+(B65)+(B71), (A)+(B65)+(B72), (A)+(B65)+(B73), (A)+(B65)+(B74), (A)+(B65)+(B75), (A)+(B65)+(B76), (A)+(B65)+(B77), (A)+(B65)+(B78), (A)+(B65)+(B79), (A)+(B65)+(B80), (A)+(B65)+(B81), (A)+(B65)+(B82), (A)+(B65)+(B83), (A)+(B65)+(B84), (A)+(B65)+(B85), (A)+(B65)+(B86), (A)+(B65)+(B87), (A)+(B65)+(B88), (A)+(B65)+(B89), (A)+(B65)+(B90), (A)+(B65)+(B91), (A)+(B65)+(B92), (A)+(B65)+(B93), (A)+(B65)+(B94), (A)+(B65)+(B95), (A)+(B65)+(B96), (A)+(B65)+(B97), (A)+(B65)+(B98), (A)+(B65)+(B99), (A)+(B65)+(B100), (A)+(B65)+(B101), (A)+(B65)+(B102), (A)+(B65)+(B103), (A)+(B65)+(B104), (A)+(B65)+(B105), (A)+(B65)+(B106), (A)+(B65)+(B107), (A)+(B65)+(B108), (A)+(B65)+(B109), (A)+(B65)+(B110), (A)+(B65)+(B111), (A)+(B65)+(B112), (A)+(B65)+(B113), (A)+(B65)+(B114), (A)+(B65)+(B115), (A)+(B65)+(B116), (A)+(B65)+(B117), (A)+(B65)+(B118), (A)+(B65)+(B119), (A)+(B65)+(B120), (A)+(B65)+(B121), (A)+(B65)+(B122), (A)+(B65)+(B123), (A)+(B65)+(B124), (A)+(B65)+(B125), (A)+(B65)+(B126), (A)+(B65)+(B127), (A)+(B65)+(B128), (A)+(B65)+(B129), (A)+(B65)+(B130), (A)+(B65)+(B131), (A)+(B65)+(B132), (A)+(B65)+(B133), (A)+(B65)+(B134), (A)+(B65)+(B135), (A)+(B65)+(B136), (A)+(B65)+(B137), (A)+(B65)+(B138), (A)+(B65)+(B139), (A)+(B65)+(B140), (A)+(B65)+(B141), (A)+(B65)+(B142), (A)+(B65)+(B143), (A)+(B65)+(B144), (A)+(B65)+(B145), (A)+(B65)+(B146), (A)+(B65)+(B147), (A)+(B65)+(B148), (A)+(B65)+(B149), (A)+(B65)+(B150), (A)+(B65)+(B151), (A)+(B65)+(B152), (A)+(B65)+(B153), (A)+(B65)+(B154), (A)+(B65)+(B155), (A)+(B65)+(B156), (A)+(B65)+(B157), (A)+(B65)+(B158), (A)+(B65)+(B159), (A)+(B65)+(B160), (A)+(B65)+(B161), (A)+(B65)+(B162), (A)+(B65)+(B164), (A)+(B65)+(B164), (A)+(B65)+(B165), (A)+(B65)+(B166), (A)+(B65)+(B167), (A)+(B65)+(B168), (A)+(B65)+(B169), (A)+(B65)+(B170), (A)+(B65)+(B171), (A)+(B65)+(B172), (A)+(B65)+(B173), (A)+(B65)+(B174), (A)+(B65)+(B175), (A)+(B65)+(B176), (A)+(B65)+(B177), (A)+(B65)+(B178), (A)+(B65)+(B179), (A)+(B65)+(B180), (A)+(B65)+(B181), (A)+(B65)+(B182), (A)+(B65)+(B183), (A)+(B65)+(B184), (A)+(B65)+(B185), (A)+(B65)+(B186), (A)+(B65)+(B187), (A)+(B65)+(B188), (A)+(B65)+(B189), (A)+(B65)+(B190), (A)+(B65)+(B191), (A)+(B65)+(B192), (A)+(B65)+(B193), (A)+(B65)+(B194), (A)+(B65)+(B195), (A)+(B65)+(B196), (A)+(B65)+(B197), (A)+(B65)+(B198), (A)+(B65)+(B199), (A)+(B65)+(B200), (A)+(B65)+(B201), (A)+(B65)+(B202), (A)+(B65)+(B203), (A)+(B65)+(B204), (A)+(B65)+(B205), (A)+(B65)+(B206), (A)+(B65)+(B207), (A)+(B65)+(B208), (A)+(B65)+(B209), (A)+(B65)+(B210), (A)+(B65)+(B211), (A)+(B65)+(B212), (A)+(B65)+(B213), (A)+(B65)+(B214), (A)+(B65)+(B215), (A)+(B65)+(B216), (A)+(B65)+(B217), (A)+(B65)+(B218), (A)+(B65)+(B219), (A)+(B65)+(B220), (A)+(B65)+(B221), (A)+(B65)+(B222), (A)+(B65)+(B223), (A)+(B65)+(B224), (A)+(B65)+(B225), (A)+(B65)+(B226), (A)+(B65)+(B227), (A)+(B65)+(B228), (A)+(B65)+(B229), (A)+(B65)+(B230), (A)+(B65)+(B231), (A)+(B65)+(B232), (A)+(B65)+(B233), (A)+(B65)+(B234), (A)+(B65)+(B235), (A)+(B65)+(B236), (A)+(B65)+(B237), (A)+(B65)+(B238), (A)+(B65)+(B239), (A)+(B65)+(B240), (A)+(B65)+(B241), (A)+(B65)+(B242), (A)+(B65)+(B243), (A)+(B65)+(B244), (A)+(B65)+(B245), (A)+(B65)+(B246), (A)+(B65)+(B247), (A)+(B65)+(B248), (A)+(B65)+(B249), (A)+(B65)+(B250), (A)+(B65)+(B251), (A)+(B65)+(B252), (A)+(B65)+(B253), (A)+(B65)+(B254), (A)+(B65)+(B255), (A)+(B65)+(B256), (A)+(B65)+(B257), (A)+(B65)+(B258), (A)+(B65)+(B259), (A)+(B65)+(B260), (A)+(B65)+(B261), (A)+(B65)+(B262), (A)+(B65)+(B263), (A)+(B65)+(B264), (A)+(B65)+(B265), (A)+(B65)+(B266), (A)+(B65)+(B267), (A)+(B65)+(B268), (A)+(B65)+(B269), (A)+(B65)+(B270), (A)+(B65)+(B271), (A)+(B65)+(B272), (A)+(B65)+(B273), (A)+(B65)+(B274), (A)+(B65)+(B275), (A)+(B65)+(B276), (A)+(B65)+(B277), (A)+(B65)+(B278), (A)+(B65)+(B279), (A)+(B65)+(B280), (A)+(B65)+(B281), (A)+(B65)+(B282), (A)+(B65)+(B283), (A)+(B65)+(B284), (A)+(B65)+(B285), (A)+(B65)+(B286), (A)+(B65)+(B287), (A)+(B65)+(B288), (A)+(B65)+(B289), (A)+(B65)+(B290), (A)+(B65)+(B291), (A)+(B65)+(B292), (A)+(B65)+(B293), (A)+(B65)+(B294), (A)+(B65)+(B295), (A)+(B65)+(B296), (A)+(B65)+(B297), (A)+(B65)+(B298), (A)+(B65)+(B299), (A)+(B65)+(B300), (A)+(B65)+(B301), (A)+(B65)+(B302), (A)+(B65)+(B303), (A)+(B65)+(B304), (A)+(B65)+(B305), (A)+(B65)+(B306), (A)+(B65)+(B307), (A)+(B65)+(B308), (A)+(B65)+(B309), (A)+(B65)+(B310), (A)+(B65)+(B311), (A)+(B65)+(B312), (A)+(B65)+(B313), (A)+(B65)+(B314), (A)+(B65)+(B315),

(A)+(B66)+(B67), (A)+(B66)+(B68), (A)+(B66)+(B69), (A)+(B66)+(B70), (A)+(B66)+(B71), (A)+(B66)+(B72), (A)+(B66)+(B73), (A)+(B66)+(B74), (A)+(B66)+(B75), (A)+(B66)+(B76), (A)+(B66)+(B77), (A)+(B66)+(B78), (A)+(B66)+(B79), (A)+(B66)+(B80), (A)+(B66)+(B81), (A)+(B66)+(B82), (A)+(B66)+(B83), (A)+(B66)+(B84), (A)+(B66)+(B85), (A)+(B66)+(B86), (A)+(B66)+(B87), (A)+(B66)+(B88), (A)+(B66)+(B89), (A)+(B66)+(B90), (A)+(B66)+(B91), (A)+(B66)+(B92), (A)+(B66)+(B93), (A)+(B66)+(B94), (A)+(B66)+(B95), (A)+(B66)+(B96), (A)+(B66)+(B97), (A)+(B66)+(B98), (A)+(B66)+(B99), (A)+(B66)+(B100), (A)+(B66)+(B101), (A)+(B66)+(B102), (A)+(B66)+(B103), (A)+(B66)+(B104), (A)+(B66)+(B105), (A)+(B66)+(B106), (A)+(B66)+(B107), (A)+(B66)+(B108), (A)+(B66)+(B109), (A)+(B66)+(B110), (A)+(B66)+(B111), (A)+(B66)+(B112), (A)+(B66)+(B113), (A)+(B66)+(B114), (A)+(B66)+(B115), (A)+(B66)+(B116), (A)+(B66)+(B117), (A)+(B66)+(B118), (A)+(B66)+(B119), (A)+(B66)+(B120), (A)+(B66)+(B121), (A)+(B66)+(B122), (A)+(B66)+(B123), (A)+(B66)+(B124), (A)+(B66)+(B125), (A)+(B66)+(B126), (A)+(B66)+(B127), (A)+(B66)+(B128), (A)+(B66)+(B129), (A)+(B66)+(B130), (A)+(B66)+(B131), (A)+(B66)+(B132), (A)+(B66)+(B133), (A)+(B66)+(B134), (A)+(B66)+(B135), (A)+(B66)+(B136), (A)+(B66)+(B137), (A)+(B66)+(B138), (A)+(B66)+(B139), (A)+(B66)+(B140), (A)+(B66)+(B141), (A)+(B66)+(B142), (A)+(B66)+(B143), (A)+(B66)+(B144), (A)+(B66)+(B145), (A)+(B66)+(B146), (A)+(B66)+(B147), (A)+(B66)+(B148), (A)+(B66)+(B149), (A)+(B66)+(B150), (A)+(B66)+(B151), (A)+(B66)+(B152), (A)+(B66)+(B153), (A)+(B66)+(B154), (A)+(B66)+(B155), (A)+(B66)+(B156), (A)+(B66)+(B157), (A)+(B66)+(B158), (A)+(B66)+(B159), (A)+(B66)+(B160), (A)+(B66)+(B161), (A)+(B66)+(B162), (A)+(B66)+(B164), (A)+(B66)+(B164), (A)+(B66)+(B165), (A)+(B66)+(B166), (A)+(B66)+(B167), (A)+(B66)+(B168), (A)+(B66)+(B169), (A)+(B66)+(B170), (A)+(B66)+(B171), (A)+(B66)+(B172), (A)+(B66)+(B173), (A)+(B66)+(B174), (A)+(B66)+(B175), (A)+(B66)+(B176), (A)+(B66)+(B177), (A)+(B66)+(B178), (A)+(B66)+(B179), (A)+(B66)+(B180), (A)+(B66)+(B181), (A)+(B66)+(B182), (A)+(B66)+(B183), (A)+(B66)+(B184), (A)+(B66)+(B185), (A)+(B66)+(B186), (A)+(B66)+(B187), (A)+(B66)+(B188), (A)+(B66)+(B189), (A)+(B66)+(B190), (A)+(B66)+(B191), (A)+(B66)+(B192), (A)+(B66)+(B193), (A)+(B66)+(B194), (A)+(B66)+(B195), (A)+(B66)+(B196), (A)+(B66)+(B197), (A)+(B66)+(B198), (A)+(B66)+(B199), (A)+(B66)+(B200), (A)+(B66)+(B201), (A)+(B66)+(B202), (A)+(B66)+(B203), (A)+(B66)+(B204), (A)+(B66)+(B205), (A)+(B66)+(B206), (A)+(B66)+(B207), (A)+(B66)+(B208), (A)+(B66)+(B209), (A)+(B66)+(B210), (A)+(B66)+(B211), (A)+(B66)+(B212), (A)+(B66)+(B213), (A)+(B66)+(B214), (A)+(B66)+(B215), (A)+(B66)+(B216), (A)+(B66)+(B217), (A)+(B66)+(B218), (A)+(B66)+(B219), (A)+(B66)+(B220), (A)+(B66)+(B221), (A)+(B66)+(B222), (A)+(B66)+(B223), (A)+(B66)+(B224), (A)+(B66)+(B225), (A)+(B66)+(B226), (A)+(B66)+(B227), (A)+(B66)+(B228), (A)+(B66)+(B229), (A)+(B66)+(B230), (A)+(B66)+(B231), (A)+(B66)+(B232), (A)+(B66)+(B233), (A)+(B66)+(B234), (A)+(B66)+(B235), (A)+(B66)+(B236), (A)+(B66)+(B237), (A)+(B66)+(B238), (A)+(B66)+(B239), (A)+(B66)+(B240), (A)+(B66)+(B241), (A)+(B66)+(B242), (A)+(B66)+(B243), (A)+(B66)+(B244), (A)+(B66)+(B245), (A)+(B66)+(B246), (A)+(B66)+(B247), (A)+(B66)+(B248), (A)+(B66)+(B249), (A)+(B66)+(B250), (A)+(B66)+(B251), (A)+(B66)+(B252), (A)+(B66)+(B253), (A)+(B66)+(B254), (A)+(B66)+(B255), (A)+(B66)+(B256), (A)+(B66)+(B257), (A)+(B66)+(B258), (A)+(B66)+(B259), (A)+(B66)+(B260), (A)+(B66)+(B261), (A)+(B66)+(B262), (A)+(B66)+(B263), (A)+(B66)+(B264), (A)+(B66)+(B265), (A)+(B66)+(B266), (A)+(B66)+(B267), (A)+(B66)+(B268), (A)+(B66)+(B269), (A)+(B66)+(B270), (A)+(B66)+(B271), (A)+(B66)+(B272), (A)+(B66)+(B273), (A)+(B66)+(B274), (A)+(B66)+(B275), (A)+(B66)+(B276), (A)+(B66)+(B277), (A)+(B66)+(B278), (A)+(B66)+(B279), (A)+(B66)+(B280), (A)+(B66)+(B281), (A)+(B66)+(B282), (A)+(B66)+(B283), (A)+(B66)+(B284), (A)+(B66)+(B285), (A)+(B66)+(B286), (A)+(B66)+(B287), (A)+(B66)+(B288), (A)+(B66)+(B289), (A)+(B66)+(B290), (A)+(B66)+(B291), (A)+(B66)+(B292), (A)+(B66)+(B293), (A)+(B66)+(B294), (A)+(B66)+(B295), (A)+(B66)+(B296), (A)+(B66)+(B297), (A)+(B66)+(B298), (A)+(B66)+(B299), (A)+(B66)+(B300), (A)+(B66)+(B301), (A)+(B66)+(B302), (A)+(B66)+(B303), (A)+(B66)+(B304), (A)+(B66)+(B305), (A)+(B66)+(B306), (A)+(B66)+(B307), (A)+(B66)+(B308), (A)+(B66)+(B309), (A)+(B66)+(B310), (A)+(B66)+(B311), (A)+(B66)+(B312), (A)+(B66)+(B313), (A)+(B66)+(B314), (A)+(B66)+(B315),

(A)+(B67)+(B68), (A)+(B67)+(B69), (A)+(B67)+(B70), (A)+(B67)+(B71), (A)+(B67)+(B72), (A)+(B67)+(B73), (A)+(B67)+(B74), (A)+(B67)+(B75), (A)+(B67)+(B76), (A)+(B67)+(B77), (A)+(B67)+(B78), (A)+(B67)+(B79), (A)+(B67)+(B80), (A)+(B67)+(B81), (A)+(B67)+(B82), (A)+(B67)+(B83), (A)+(B67)+(B84), (A)+(B67)+(B85), (A)+(B67)+(B86), (A)+(B67)+(B87), (A)+(B67)+(B88), (A)+(B67)+(B89), (A)+(B67)+(B90), (A)+(B67)+(B91), (A)+(B67)+(B92), (A)+(B67)+(B93), (A)+(B67)+(B94), (A)+(B67)+(B95), (A)+(B67)+(B96), (A)+(B67)+(B97), (A)+(B67)+(B98), (A)+(B67)+(B99), (A)+(B67)+(B100), (A)+(B67)+(B101), (A)+(B67)+(B102), (A)+(B67)+(B103), (A)+(B67)+(B104), (A)+(B67)+(B105), (A)+(B67)+(B106), (A)+(B67)+(B107), (A)+(B67)+(B108), (A)+(B67)+(B109), (A)+(B67)+(B110), (A)+(B67)+(B111), (A)+(B67)+(B112), (A)+(B67)+(B113), (A)+(B67)+(B114), (A)+(B67)+(B115), (A)+(B67)+(B116), (A)+(B67)+(B117), (A)+(B67)+(B118), (A)+(B67)+(B119), (A)+(B67)+(B120), (A)+(B67)+(B121), (A)+(B67)+(B122), (A)+(B67)+(B123), (A)+(B67)+(B124), (A)+(B67)+(B125), (A)+(B67)+(B126), (A)+(B67)+(B127), (A)+(B67)+(B128), (A)+(B67)+(B129), (A)+(B67)+(B130), (A)+(B67)+(B131), (A)+(B67)+(B132), (A)+(B67)+(B133), (A)+(B67)+(B134), (A)+(B67)+(B135), (A)+(B67)+(B136), (A)+(B67)+(B137), (A)+(B67)+(B138), (A)+(B67)+(B139), (A)+(B67)+(B140), (A)+(B67)+(B141), (A)+(B67)+(B142), (A)+(B67)+(B143), (A)+(B67)+(B144), (A)+(B67)+(B145), (A)+(B67)+(B146), (A)+(B67)+(B147), (A)+(B67)+(B148), (A)+(B67)+(B149), (A)+(B67)+(B150), (A)+(B67)+(B151), (A)+(B67)+(B152), (A)+(B67)+(B153), (A)+(B67)+(B154), (A)+(B67)+(B155), (A)+(B67)+(B156), (A)+(B67)+(B157), (A)+(B67)+(B158), (A)+(B67)+(B159), (A)+(B67)+(B160), (A)+(B67)+(B161), (A)+(B67)+(B162), (A)+(B67)+(B164), (A)+(B67)+(B164), (A)+(B67)+(B165), (A)+(B67)+(B166), (A)+(B67)+(B167), (A)+(B67)+(B168), (A)+(B67)+(B169), (A)+(B67)+(B170), (A)+(B67)+(B171), (A)+(B67)+(B172), (A)+(B67)+(B173), (A)+(B67)+(B174), (A)+(B67)+(B175), (A)+(B67)+(B176), (A)+(B67)+(B177), (A)+(B67)+(B178), (A)+(B67)+(B179), (A)+(B67)+(B180), (A)+(B67)+(B181), (A)+(B67)+(B182), (A)+(B67)+(B183), (A)+(B67)+(B184), (A)+(B67)+(B185), (A)+(B67)+(B186), (A)+(B67)+(B187), (A)+(B67)+(B188), (A)+(B67)+(B189), (A)+(B67)+(B190), (A)+(B67)+(B191), (A)+(B67)+(B192), (A)+(B67)+(B193), (A)+(B67)+(B194), (A)+(B67)+(B195), (A)+(B67)+(B196), (A)+(B67)+(B197), (A)+(B67)+(B198), (A)+(B67)+(B199), (A)+(B67)+(B200), (A)+(B67)+(B201), (A)+(B67)+(B202), (A)+(B67)+(B203), (A)+(B67)+(B204), (A)+(B67)+(B205), (A)+(B67)+(B206), (A)+(B67)+(B207), (A)+(B67)+(B208), (A)+(B67)+(B209), (A)+(B67)+(B210), (A)+(B67)+(B211), (A)+(B67)+(B212), (A)+(B67)+(B213), (A)+(B67)+(B214), (A)+(B67)+(B215), (A)+(B67)+(B216), (A)+(B67)+(B217), (A)+(B67)+(B218), (A)+(B67)+(B219), (A)+(B67)+(B220), (A)+(B67)+(B221), (A)+(B67)+(B222), (A)+(B67)+(B223), (A)+(B67)+(B224), (A)+(B67)+(B225), (A)+(B67)+(B226), (A)+(B67)+(B227), (A)+(B67)+(B228), (A)+(B67)+(B229), (A)+(B67)+(B230), (A)+(B67)+(B231), (A)+(B67)+(B232), (A)+(B67)+(B233), (A)+(B67)+(B234), (A)+(B67)+(B235), (A)+(B67)+(B236), (A)+(B67)+(B237), (A)+(B67)+(B238), (A)+(B67)+(B239), (A)+(B67)+(B240), (A)+(B67)+(B241), (A)+(B67)+(B242), (A)+(B67)+(B243), (A)+(B67)+(B244), (A)+(B67)+(B245), (A)+(B67)+(B246), (A)+(B67)+(B247), (A)+(B67)+(B248), (A)+(B67)+(B249), (A)+(B67)+(B250), (A)+(B67)+(B251), (A)+(B67)+(B252), (A)+(B67)+(B253), (A)+(B67)+(B254), (A)+(B67)+(B255), (A)+(B67)+(B256), (A)+(B67)+(B257), (A)+(B67)+(B258), (A)+(B67)+(B259), (A)+(B67)+(B260), (A)+(B67)+(B261), (A)+(B67)+(B262), (A)+(B67)+(B263), (A)+(B67)+(B264), (A)+(B67)+(B265), (A)+(B67)+(B266), (A)+(B67)+(B267), (A)+(B67)+(B268), (A)+(B67)+(B269), (A)+(B67)+(B270), (A)+(B67)+(B271), (A)+(B67)+(B272), (A)+(B67)+(B273), (A)+(B67)+(B274), (A)+(B67)+(B275), (A)+(B67)+(B276), (A)+(B67)+(B277), (A)+(B67)+(B278), (A)+(B67)+(B279), (A)+(B67)+(B280), (A)+(B67)+(B281), (A)+(B67)+(B282), (A)+(B67)+(B283), (A)+(B67)+(B284), (A)+(B67)+(B285), (A)+(B67)+(B286), (A)+(B67)+(B287), (A)+(B67)+(B288), (A)+(B67)+(B289), (A)+(B67)+(B290), (A)+(B67)+(B291), (A)+(B67)+(B292), (A)+(B67)+(B293), (A)+(B67)+(B294), (A)+(B67)+(B295), (A)+(B67)+(B296), (A)+(B67)+(B297), (A)+(B67)+(B298), (A)+(B67)+(B299), (A)+(B67)+(B300), (A)+(B67)+(B301), (A)+(B67)+(B302), (A)+(B67)+(B303), (A)+(B67)+(B304), (A)+(B67)+(B305), (A)+(B67)+(B306), (A)+(B67)+(B307), (A)+(B67)+(B308), (A)+(B67)+(B309), (A)+(B67)+(B310), (A)+(B67)+(B311), (A)+(B67)+(B312), (A)+(B67)+(B313), (A)+(B67)+(B314), (A)+(B67)+(B315),

(A)+(B68)+(B69), (A)+(B68)+(B70), (A)+(B68)+(B71), (A)+(B68)+(B72), (A)+(B68)+(B73), (A)+(B68)+(B74), (A)+(B68)+(B75), (A)+(B68)+(B76), (A)+(B68)+(B77), (A)+(B68)+(B78), (A)+(B68)+(B79), (A)+(B68)+(B80), (A)+(B68)+(B81), (A)+(B68)+(B82), (A)+(B68)+(B83), (A)+(B68)+(B84), (A)+(B68)+(B85), (A)+(B68)+(B86), (A)+(B68)+(B87), (A)+(B68)+(B88), (A)+(B68)+(B89), (A)+(B68)+(B90), (A)+(B68)+(B91), (A)+(B68)+(B92), (A)+(B68)+(B93), (A)+(B68)+(B94), (A)+(B68)+(B95), (A)+(B68)+(B96), (A)+(B68)+(B97), (A)+(B68)+(B98), (A)+(B68)+(B99), (A)+(B68)+(B100), (A)+(B68)+(B101), (A)+(B68)+(B102), (A)+(B68)+(B103), (A)+(B68)+(B104), (A)+(B68)+(B105), (A)+(B68)+(B106), (A)+(B68)+(B107), (A)+(B68)+(B108), (A)+(B68)+(B109), (A)+(B68)+(B110), (A)+(B68)+(B111), (A)+(B68)+(B112), (A)+(B68)+(B113), (A)+(B68)+(B114), (A)+(B68)+(B115), (A)+(B68)+(B116), (A)+(B68)+(B117), (A)+(B68)+(B118), (A)+(B68)+(B119), (A)+(B68)+(B120), (A)+(B68)+(B121), (A)+(B68)+(B122), (A)+(B68)+(B123), (A)+(B68)+(B124), (A)+(B68)+(B125), (A)+(B68)+(B126), (A)+(B68)+(B127), (A)+(B68)+(B128), (A)+(B68)+(B129), (A)+(B68)+(B130), (A)+(B68)+(B131), (A)+(B68)+(B132), (A)+(B68)+(B133), (A)+(B68)+(B134), (A)+(B68)+(B135), (A)+(B68)+(B136), (A)+(B68)+(B137), (A)+(B68)+(B138), (A)+(B68)+(B139), (A)+(B68)+(B140), (A)+(B68)+(B141), (A)+(B68)+(B142), (A)+(B68)+(B143), (A)+(B68)+(B144), (A)+(B68)+(B145), (A)+(B68)+(B146), (A)+(B68)+(B147), (A)+(B68)+(B148), (A)+(B68)+(B149), (A)+(B68)+(B150), (A)+(B68)+(B151), (A)+(B68)+(B152), (A)+(B68)+(B153), (A)+(B68)+(B154), (A)+(B68)+(B155), (A)+(B68)+(B156), (A)+(B68)+(B157), (A)+(B68)+(B158), (A)+(B68)+(B159), (A)+(B68)+(B160), (A)+(B68)+(B161), (A)+(B68)+(B162), (A)+(B68)+(B164), (A)+(B68)+(B164), (A)+(B68)+(B165), (A)+(B68)+(B166), (A)+(B68)+(B167), (A)+(B68)+(B168), (A)+(B68)+(B169), (A)+(B68)+(B170), (A)+(B68)+(B171), (A)+(B68)+(B172), (A)+(B68)+(B173), (A)+(B68)+(B174), (A)+(B68)+(B175), (A)+(B68)+(B176), (A)+(B68)+(B177), (A)+(B68)+(B178), (A)+(B68)+(B179), (A)+(B68)+(B180), (A)+(B68)+(B181), (A)+(B68)+(B182), (A)+(B68)+(B183), (A)+(B68)+(B184), (A)+(B68)+(B185), (A)+(B68)+(B186), (A)+(B68)+(B187), (A)+(B68)+(B188), (A)+(B68)+(B189), (A)+(B68)+(B190), (A)+(B68)+(B191), (A)+(B68)+(B192), (A)+(B68)+(B193), (A)+(B68)+(B194), (A)+(B68)+(B195), (A)+(B68)+(B196), (A)+(B68)+(B197), (A)+(B68)+(B198), (A)+(B68)+(B199), (A)+(B68)+(B200), (A)+(B68)+(B201), (A)+(B68)+(B202), (A)+(B68)+(B203), (A)+(B68)+(B204), (A)+(B68)+(B205), (A)+(B68)+(B206), (A)+(B68)+(B207), (A)+(B68)+(B208), (A)+(B68)+(B209), (A)+(B68)+(B210), (A)+(B68)+(B211), (A)+(B68)+(B212), (A)+(B68)+(B213), (A)+(B68)+(B214), (A)+(B68)+(B215), (A)+(B68)+(B216), (A)+(B68)+(B217), (A)+(B68)+(B218), (A)+(B68)+(B219), (A)+(B68)+(B220), (A)+(B68)+(B221), (A)+(B68)+(B222), (A)+(B68)+(B223), (A)+(B68)+(B224), (A)+(B68)+(B225), (A)+(B68)+(B226), (A)+(B68)+(B227), (A)+(B68)+(B228), (A)+(B68)+(B229), (A)+(B68)+(B230), (A)+(B68)+(B231), (A)+(B68)+(B232), (A)+(B68)+(B233), (A)+(B68)+(B234), (A)+(B68)+(B235), (A)+(B68)+(B236), (A)+(B68)+(B237), (A)+(B68)+(B238), (A)+(B68)+(B239), (A)+(B68)+(B240), (A)+(B68)+(B241), (A)+(B68)+(B242), (A)+(B68)+(B243), (A)+(B68)+(B244), (A)+(B68)+(B245), (A)+(B68)+(B246), (A)+(B68)+(B247), (A)+(B68)+(B248), (A)+(B68)+(B249), (A)+(B68)+(B250), (A)+(B68)+(B251), (A)+(B68)+(B252), (A)+(B68)+(B253), (A)+(B68)+(B254), (A)+(B68)+(B255), (A)+(B68)+(B256), (A)+(B68)+(B257), (A)+(B68)+(B258), (A)+(B68)+(B259), (A)+(B68)+(B260), (A)+(B68)+(B261), (A)+(B68)+(B262), (A)+(B68)+(B263), (A)+(B68)+(B264), (A)+(B68)+(B265), (A)+(B68)+(B266), (A)+(B68)+(B267), (A)+(B68)+(B268), (A)+(B68)+(B269), (A)+(B68)+(B270), (A)+(B68)+(B271), (A)+(B68)+(B272), (A)+(B68)+(B273), (A)+(B68)+(B274), (A)+(B68)+(B275), (A)+(B68)+(B276), (A)+(B68)+(B277), (A)+(B68)+(B278), (A)+(B68)+(B279), (A)+(B68)+(B280), (A)+(B68)+(B281), (A)+(B68)+(B282), (A)+(B68)+(B283), (A)+(B68)+(B284), (A)+(B68)+(B285), (A)+(B68)+(B286), (A)+(B68)+(B287), (A)+(B68)+(B288), (A)+(B68)+(B289), (A)+(B68)+(B290), (A)+(B68)+(B291), (A)+(B68)+(B292), (A)+(B68)+(B293), (A)+(B68)+(B294), (A)+(B68)+(B295), (A)+(B68)+(B296), (A)+(B68)+(B297), (A)+(B68)+(B298), (A)+(B68)+(B299), (A)+(B68)+(B300), (A)+(B68)+(B301), (A)+(B68)+(B302), (A)+(B68)+(B303), (A)+(B68)+(B304), (A)+(B68)+(B305), (A)+(B68)+(B306), (A)+(B68)+(B307), (A)+(B68)+(B308), (A)+(B68)+(B309), (A)+(B68)+(B310), (A)+(B68)+(B311), (A)+(B68)+(B312), (A)+(B68)+(B313), (A)+(B68)+(B314), (A)+(B68)+(B315),

(A)+(B69)+(B70), (A)+(B69)+(B71), (A)+(B69)+(B72), (A)+(B69)+(B73), (A)+(B69)+(B74), (A)+(B69)+(B75), (A)+(B69)+(B76), (A)+(B69)+(B77), (A)+(B69)+(B78), (A)+(B69)+(B79), (A)+(B69)+(B80), (A)+(B69)+(B81), (A)+(B69)+(B82), (A)+(B69)+(B83), (A)+(B69)+(B84), (A)+(B69)+(B85), (A)+(B69)+(B86), (A)+(B69)+(B87), (A)+(B69)+(B88), (A)+(B69)+(B89), (A)+(B69)+(B90), (A)+(B69)+(B91), (A)+(B69)+(B92), (A)+(B69)+(B93), (A)+(B69)+(B94), (A)+(B69)+(B95), (A)+(B69)+(B96), (A)+(B69)+(B97), (A)+(B69)+(B98), (A)+(B69)+(B99), (A)+(B69)+(B100), (A)+(B69)+(B101), (A)+(B69)+(B102), (A)+(B69)+(B103), (A)+(B69)+(B104), (A)+(B69)+(B105), (A)+(B69)+(B106), (A)+(B69)+(B107), (A)+(B69)+(B108), (A)+(B69)+(B109), (A)+(B69)+(B110), (A)+(B69)+(B111), (A)+(B69)+(B112), (A)+(B69)+(B113), (A)+(B69)+(B114), (A)+(B69)+(B115), (A)+(B69)+(B116), (A)+(B69)+(B117), (A)+(B69)+(B118), (A)+(B69)+(B119), (A)+(B69)+(B120), (A)+(B69)+(B121), (A)+(B69)+(B122), (A)+(B69)+(B123), (A)+(B69)+(B124), (A)+(B69)+(B125), (A)+(B69)+(B126), (A)+(B69)+(B127), (A)+(B69)+(B128), (A)+(B69)+(B129), (A)+(B69)+(B130), (A)+(B69)+(B131), (A)+(B69)+(B132), (A)+(B69)+(B133), (A)+(B69)+(B134), (A)+(B69)+(B135), (A)+(B69)+(B136), (A)+(B69)+(B137), (A)+(B69)+(B138), (A)+(B69)+(B139), (A)+(B69)+(B140), (A)+(B69)+(B141), (A)+(B69)+(B142), (A)+(B69)+(B143), (A)+(B69)+(B144), (A)+(B69)+(B145), (A)+(B69)+(B146), (A)+(B69)+(B147), (A)+(B69)+(B148), (A)+(B69)+(B149), (A)+(B69)+(B150), (A)+(B69)+(B151), (A)+(B69)+(B152), (A)+(B69)+(B153), (A)+(B69)+(B154), (A)+(B69)+(B155), (A)+(B69)+(B156), (A)+(B69)+(B157), (A)+(B69)+(B158), (A)+(B69)+(B159), (A)+(B69)+(B160), (A)+(B69)+(B161), (A)+(B69)+(B162), (A)+(B69)+(B164), (A)+(B69)+(B164), (A)+(B69)+(B165), (A)+(B69)+(B166), (A)+(B69)+(B167), (A)+(B69)+(B168), (A)+(B69)+(B169), (A)+(B69)+(B170), (A)+(B69)+(B171), (A)+(B69)+(B172), (A)+(B69)+(B173), (A)+(B69)+(B174), (A)+(B69)+(B175), (A)+(B69)+(B176), (A)+(B69)+(B177), (A)+(B69)+(B178), (A)+(B69)+(B179), (A)+(B69)+(B180), (A)+(B69)+(B181), (A)+(B69)+(B182), (A)+(B69)+(B183), (A)+(B69)+(B184), (A)+(B69)+(B185), (A)+(B69)+(B186), (A)+(B69)+(B187), (A)+(B69)+(B188), (A)+(B69)+(B189), (A)+(B69)+(B190), (A)+(B69)+(B191), (A)+(B69)+(B192), (A)+(B69)+(B193), (A)+(B69)+(B194), (A)+(B69)+(B195), (A)+(B69)+(B196), (A)+(B69)+(B197), (A)+(B69)+(B198), (A)+(B69)+(B199), (A)+(B69)+(B200), (A)+(B69)+(B201), (A)+(B69)+(B202), (A)+(B69)+(B203), (A)+(B69)+(B204), (A)+(B69)+(B205), (A)+(B69)+(B206), (A)+(B69)+(B207), (A)+(B69)+(B208), (A)+(B69)+(B209), (A)+(B69)+(B210), (A)+(B69)+(B211), (A)+(B69)+(B212), (A)+(B69)+(B213), (A)+(B69)+(B214), (A)+(B69)+(B215), (A)+(B69)+(B216), (A)+(B69)+(B217), (A)+(B69)+(B218), (A)+(B69)+(B219), (A)+(B69)+(B220), (A)+(B69)+(B221), (A)+(B69)+(B222), (A)+(B69)+(B223), (A)+(B69)+(B224), (A)+(B69)+(B225), (A)+(B69)+(B226), (A)+(B69)+(B227), (A)+(B69)+(B228), (A)+(B69)+(B229), (A)+(B69)+(B230), (A)+(B69)+(B231), (A)+(B69)+(B232), (A)+(B69)+(B233), (A)+(B69)+(B234), (A)+(B69)+(B235), (A)+(B69)+(B236), (A)+(B69)+(B237), (A)+(B69)+(B238), (A)+(B69)+(B239), (A)+(B69)+(B240), (A)+(B69)+(B241), (A)+(B69)+(B242), (A)+(B69)+(B243), (A)+(B69)+(B244), (A)+(B69)+(B245), (A)+(B69)+(B246), (A)+(B69)+(B247), (A)+(B69)+(B248), (A)+(B69)+(B249), (A)+(B69)+(B250), (A)+(B69)+(B251), (A)+(B69)+(B252), (A)+(B69)+(B253), (A)+(B69)+(B254), (A)+(B69)+(B255), (A)+(B69)+(B256), (A)+(B69)+(B257), (A)+(B69)+(B258), (A)+(B69)+(B259), (A)+(B69)+(B260), (A)+(B69)+(B261), (A)+(B69)+(B262), (A)+(B69)+(B263), (A)+(B69)+(B264), (A)+(B69)+(B265), (A)+(B69)+(B266), (A)+(B69)+(B267), (A)+(B69)+(B268), (A)+(B69)+(B269), (A)+(B69)+(B270), (A)+(B69)+(B271), (A)+(B69)+(B272), (A)+(B69)+(B273), (A)+(B69)+(B274), (A)+(B69)+(B275), (A)+(B69)+(B276), (A)+(B69)+(B277), (A)+(B69)+(B278), (A)+(B69)+(B279), (A)+(B69)+(B280), (A)+(B69)+(B281), (A)+(B69)+(B282), (A)+(B69)+(B283), (A)+(B69)+(B284), (A)+(B69)+(B285), (A)+(B69)+(B286), (A)+(B69)+(B287), (A)+(B69)+(B288), (A)+(B69)+(B289), (A)+(B69)+(B290), (A)+(B69)+(B291), (A)+(B69)+(B292), (A)+(B69)+(B293), (A)+(B69)+(B294), (A)+(B69)+(B295), (A)+(B69)+(B296), (A)+(B69)+(B297), (A)+(B69)+(B298), (A)+(B69)+(B299), (A)+(B69)+(B300), (A)+(B69)+(B301), (A)+(B69)+(B302), (A)+(B69)+(B303), (A)+(B69)+(B304), (A)+(B69)+(B305), (A)+(B69)+(B306), (A)+(B69)+(B307), (A)+(B69)+(B308), (A)+(B69)+(B309), (A)+(B69)+(B310), (A)+(B69)+(B311), (A)+(B69)+(B312), (A)+(B69)+(B313), (A)+(B69)+(B314), (A)+(B69)+(B315),

(A)+(B70)+(B71), (A)+(B70)+(B72), (A)+(B70)+(B73), (A)+(B70)+(B74), (A)+(B70)+(B75), (A)+(B70)+(B76), (A)+(B70)+(B77), (A)+(B70)+(B78), (A)+(B70)+(B79), (A)+(B70)+(B80), (A)+(B70)+(B81), (A)+(B70)+(B82), (A)+(B70)+(B83), (A)+(B70)+(B84), (A)+(B70)+(B85), (A)+(B70)+(B86), (A)+(B70)+(B87), (A)+(B70)+(B88), (A)+(B70)+(B89), (A)+(B70)+(B90), (A)+(B70)+(B91), (A)+(B70)+(B92), (A)+(B70)+(B93), (A)+(B70)+(B94), (A)+(B70)+(B95), (A)+(B70)+(B96), (A)+(B70)+(B97), (A)+(B70)+(B98), (A)+(B70)+(B99), (A)+(B70)+(B100), (A)+(B70)+(B101), (A)+(B70)+(B102), (A)+(B70)+(B103), (A)+(B70)+(B104), (A)+(B70)+(B105), (A)+(B70)+(B106), (A)+(B70)+(B107), (A)+(B70)+(B108), (A)+(B70)+(B109), (A)+(B70)+(B110), (A)+(B70)+(B111), (A)+(B70)+(B112), (A)+(B70)+(B113), (A)+(B70)+(B114), (A)+(B70)+(B115), (A)+(B70)+(B116), (A)+(B70)+(B117), (A)+(B70)+(B118), (A)+(B70)+(B119), (A)+(B70)+(B120), (A)+(B70)+(B121), (A)+(B70)+(B122), (A)+(B70)+(B123), (A)+(B70)+(B124), (A)+(B70)+(B125), (A)+(B70)+(B126), (A)+(B70)+(B127), (A)+(B70)+(B128), (A)+(B70)+(B129), (A)+(B70)+(B130), (A)+(B70)+(B131), (A)+(B70)+(B132), (A)+(B70)+(B133), (A)+(B70)+(B134), (A)+(B70)+(B135), (A)+(B70)+(B136), (A)+(B70)+(B137), (A)+(B70)+(B138), (A)+(B70)+(B139), (A)+(B70)+(B140), (A)+(B70)+(B141), (A)+(B70)+(B142), (A)+(B70)+(B143), (A)+(B70)+(B144), (A)+(B70)+(B145), (A)+(B70)+(B146), (A)+(B70)+(B147), (A)+(B70)+(B148), (A)+(B70)+(B149), (A)+(B70)+(B150), (A)+(B70)+(B151), (A)+(B70)+(B152), (A)+(B70)+(B153), (A)+(B70)+(B154), (A)+(B70)+(B155), (A)+(B70)+(B156), (A)+(B70)+(B157), (A)+(B70)+(B158), (A)+(B70)+(B159), (A)+(B70)+(B160), (A)+(B70)+(B161), (A)+(B70)+(B162), (A)+(B70)+(B164), (A)+(B70)+(B164), (A)+(B70)+(B165), (A)+(B70)+(B166), (A)+(B70)+(B167), (A)+(B70)+(B168), (A)+(B70)+(B169), (A)+(B70)+(B170), (A)+(B70)+(B171), (A)+(B70)+(B172), (A)+(B70)+(B173), (A)+(B70)+(B174), (A)+(B70)+(B175), (A)+(B70)+(B176), (A)+(B70)+(B177), (A)+(B70)+(B178), (A)+(B70)+(B179), (A)+(B70)+(B180), (A)+(B70)+(B181), (A)+(B70)+(B182), (A)+(B70)+(B183), (A)+(B70)+(B184), (A)+(B70)+(B185), (A)+(B70)+(B186), (A)+(B70)+(B187), (A)+(B70)+(B188), (A)+(B70)+(B189), (A)+(B70)+(B190), (A)+(B70)+(B191), (A)+(B70)+(B192), (A)+(B70)+(B193), (A)+(B70)+(B194), (A)+(B70)+(B195), (A)+(B70)+(B196), (A)+(B70)+(B197), (A)+(B70)+(B198), (A)+(B70)+(B199), (A)+(B70)+(B200), (A)+(B70)+(B201), (A)+(B70)+(B202), (A)+(B70)+(B203), (A)+(B70)+(B204), (A)+(B70)+(B205), (A)+(B70)+(B206), (A)+(B70)+(B207), (A)+(B70)+(B208), (A)+(B70)+(B209), (A)+(B70)+(B210), (A)+(B70)+(B211), (A)+(B70)+(B212), (A)+(B70)+(B213), (A)+(B70)+(B214), (A)+(B70)+(B215), (A)+(B70)+(B216), (A)+(B70)+(B217), (A)+(B70)+(B218), (A)+(B70)+(B219), (A)+(B70)+(B220), (A)+(B70)+(B221), (A)+(B70)+(B222), (A)+(B70)+(B223), (A)+(B70)+(B224), (A)+(B70)+(B225), (A)+(B70)+(B226), (A)+(B70)+(B227), (A)+(B70)+(B228), (A)+(B70)+(B229), (A)+(B70)+(B230), (A)+(B70)+(B231), (A)+(B70)+(B232), (A)+(B70)+(B233), (A)+(B70)+(B234), (A)+(B70)+(B235), (A)+(B70)+(B236), (A)+(B70)+(B237), (A)+(B70)+(B238), (A)+(B70)+(B239), (A)+(B70)+(B240), (A)+(B70)+(B241), (A)+(B70)+(B242), (A)+(B70)+(B243), (A)+(B70)+(B244), (A)+(B70)+(B245), (A)+(B70)+(B246), (A)+(B70)+(B247), (A)+(B70)+(B248), (A)+(B70)+(B249), (A)+(B70)+(B250), (A)+(B70)+(B251), (A)+(B70)+(B252), (A)+(B70)+(B253), (A)+(B70)+(B254), (A)+(B70)+(B255), (A)+(B70)+(B256), (A)+(B70)+(B257), (A)+(B70)+(B258), (A)+(B70)+(B259), (A)+(B70)+(B260), (A)+(B70)+(B261), (A)+(B70)+(B262), (A)+(B70)+(B263), (A)+(B70)+(B264), (A)+(B70)+(B265), (A)+(B70)+(B266), (A)+(B70)+(B267), (A)+(B70)+(B268), (A)+(B70)+(B269), (A)+(B70)+(B270), (A)+(B70)+(B271), (A)+(B70)+(B272), (A)+(B70)+(B273), (A)+(B70)+(B274), (A)+(B70)+(B275), (A)+(B70)+(B276), (A)+(B70)+(B277), (A)+(B70)+(B278), (A)+(B70)+(B279), (A)+(B70)+(B280), (A)+(B70)+(B281), (A)+(B70)+(B282), (A)+(B70)+(B283), (A)+(B70)+(B284), (A)+(B70)+(B285), (A)+(B70)+(B286), (A)+(B70)+(B287), (A)+(B70)+(B288), (A)+(B70)+(B289), (A)+(B70)+(B290), (A)+(B70)+(B291), (A)+(B70)+(B292), (A)+(B70)+(B293), (A)+(B70)+(B294), (A)+(B70)+(B295), (A)+(B70)+(B296), (A)+(B70)+(B297), (A)+(B70)+(B298), (A)+(B70)+(B299), (A)+(B70)+(B300), (A)+(B70)+(B301), (A)+(B70)+(B302), (A)+(B70)+(B303), (A)+(B70)+(B304), (A)+(B70)+(B305), (A)+(B70)+(B306), (A)+(B70)+(B307), (A)+(B70)+(B308), (A)+(B70)+(B309), (A)+(B70)+(B310), (A)+(B70)+(B311), (A)+(B70)+(B312), (A)+(B70)+(B313), (A)+(B70)+(B314), (A)+(B70)+(B315),

(A)+(B71)+(B72), (A)+(B71)+(B73), (A)+(B71)+(B74), (A)+(B71)+(B75), (A)+(B71)+(B76), (A)+(B71)+(B77), (A)+(B71)+(B78), (A)+(B71)+(B79), (A)+(B71)+(B80), (A)+(B71)+(B81), (A)+(B71)+(B82), (A)+(B71)+(B83), (A)+(B71)+(B84), (A)+(B71)+(B85), (A)+(B71)+(B86), (A)+(B71)+(B87), (A)+(B71)+(B88), (A)+(B71)+(B89), (A)+(B71)+(B90), (A)+(B71)+(B91), (A)+(B71)+(B92), (A)+(B71)+(B93), (A)+(B71)+(B94), (A)+(B71)+(B95), (A)+(B71)+(B96), (A)+(B71)+(B97), (A)+(B71)+(B98), (A)+(B71)+(B99), (A)+(B71)+(B100), (A)+(B71)+(B101), (A)+(B71)+(B102), (A)+(B71)+(B103), (A)+(B71)+(B104), (A)+(B71)+(B105), (A)+(B71)+(B106), (A)+(B71)+(B107), (A)+(B71)+(B108), (A)+(B71)+(B109), (A)+(B71)+(B110), (A)+(B71)+(B111), (A)+(B71)+(B112), (A)+(B71)+(B113), (A)+(B71)+(B114), (A)+(B71)+(B115), (A)+(B71)+(B116), (A)+(B71)+(B117), (A)+(B71)+(B118), (A)+(B71)+(B119), (A)+(B71)+(B120), (A)+(B71)+(B121), (A)+(B71)+(B122), (A)+(B71)+(B123), (A)+(B71)+(B124), (A)+(B71)+(B125), (A)+(B71)+(B126), (A)+(B71)+(B127), (A)+(B71)+(B128), (A)+(B71)+(B129), (A)+(B71)+(B130), (A)+(B71)+(B131), (A)+(B71)+(B132), (A)+(B71)+(B133), (A)+(B71)+(B134), (A)+(B71)+(B135), (A)+(B71)+(B136), (A)+(B71)+(B137), (A)+(B71)+(B138), (A)+(B71)+(B139), (A)+(B71)+(B140), (A)+(B71)+(B141), (A)+(B71)+(B142), (A)+(B71)+(B143), (A)+(B71)+(B144), (A)+(B71)+(B145), (A)+(B71)+(B146), (A)+(B71)+(B147), (A)+(B71)+(B148), (A)+(B71)+(B149), (A)+(B71)+(B150), (A)+(B71)+(B151), (A)+(B71)+(B152), (A)+(B71)+(B153), (A)+(B71)+(B154), (A)+(B71)+(B155), (A)+(B71)+(B156), (A)+(B71)+(B157), (A)+(B71)+(B158), (A)+(B71)+(B159), (A)+(B71)+(B160), (A)+(B71)+(B161), (A)+(B71)+(B162), (A)+(B71)+(B164), (A)+(B71)+(B164), (A)+(B71)+(B165), (A)+(B71)+(B166), (A)+(B71)+(B167), (A)+(B71)+(B168), (A)+(B71)+(B169), (A)+(B71)+(B170), (A)+(B71)+(B171), (A)+(B71)+(B172), (A)+(B71)+(B173), (A)+(B71)+(B174), (A)+(B71)+(B175), (A)+(B71)+(B176), (A)+(B71)+(B177), (A)+(B71)+(B178), (A)+(B71)+(B179), (A)+(B71)+(B180), (A)+(B71)+(B181), (A)+(B71)+(B182), (A)+(B71)+(B183), (A)+(B71)+(B184), (A)+(B71)+(B185), (A)+(B71)+(B186), (A)+(B71)+(B187), (A)+(B71)+(B188), (A)+(B71)+(B189), (A)+(B71)+(B190), (A)+(B71)+(B191), (A)+(B71)+(B192), (A)+(B71)+(B193), (A)+(B71)+(B194), (A)+(B71)+(B195), (A)+(B71)+(B196), (A)+(B71)+(B197), (A)+(B71)+(B198), (A)+(B71)+(B199), (A)+(B71)+(B200), (A)+(B71)+(B201), (A)+(B71)+(B202), (A)+(B71)+(B203), (A)+(B71)+(B204), (A)+(B71)+(B205), (A)+(B71)+(B206), (A)+(B71)+(B207), (A)+(B71)+(B208), (A)+(B71)+(B209), (A)+(B71)+(B210), (A)+(B71)+(B211), (A)+(B71)+(B212), (A)+(B71)+(B213), (A)+(B71)+(B214), (A)+(B71)+(B215), (A)+(B71)+(B216), (A)+(B71)+(B217), (A)+(B71)+(B218), (A)+(B71)+(B219), (A)+(B71)+(B220), (A)+(B71)+(B221), (A)+(B71)+(B222), (A)+(B71)+(B223), (A)+(B71)+(B224), (A)+(B71)+(B225), (A)+(B71)+(B226), (A)+(B71)+(B227), (A)+(B71)+(B228), (A)+(B71)+(B229), (A)+(B71)+(B230), (A)+(B71)+(B231), (A)+(B71)+(B232), (A)+(B71)+(B233), (A)+(B71)+(B234), (A)+(B71)+(B235), (A)+(B71)+(B236), (A)+(B71)+(B237), (A)+(B71)+(B238), (A)+(B71)+(B239), (A)+(B71)+(B240), (A)+(B71)+(B241), (A)+(B71)+(B242), (A)+(B71)+(B243), (A)+(B71)+(B244), (A)+(B71)+(B245), (A)+(B71)+(B246), (A)+(B71)+(B247), (A)+(B71)+(B248), (A)+(B71)+(B249), (A)+(B71)+(B250), (A)+(B71)+(B251), (A)+(B71)+(B252), (A)+(B71)+(B253), (A)+(B71)+(B254), (A)+(B71)+(B255), (A)+(B71)+(B256), (A)+(B71)+(B257), (A)+(B71)+(B258), (A)+(B71)+(B259), (A)+(B71)+(B260), (A)+(B71)+(B261), (A)+(B71)+(B262), (A)+(B71)+(B263), (A)+(B71)+(B264), (A)+(B71)+(B265), (A)+(B71)+(B266), (A)+(B71)+(B267), (A)+(B71)+(B268), (A)+(B71)+(B269), (A)+(B71)+(B270), (A)+(B71)+(B271), (A)+(B71)+(B272), (A)+(B71)+(B273), (A)+(B71)+(B274), (A)+(B71)+(B275), (A)+(B71)+(B276), (A)+(B71)+(B277), (A)+(B71)+(B278), (A)+(B71)+(B279), (A)+(B71)+(B280), (A)+(B71)+(B281), (A)+(B71)+(B282), (A)+(B71)+(B283), (A)+(B71)+(B284), (A)+(B71)+(B285), (A)+(B71)+(B286), (A)+(B71)+(B287), (A)+(B71)+(B288), (A)+(B71)+(B289), (A)+(B71)+(B290), (A)+(B71)+(B291), (A)+(B71)+(B292), (A)+(B71)+(B293), (A)+(B71)+(B294), (A)+(B71)+(B295), (A)+(B71)+(B296), (A)+(B71)+(B297), (A)+(B71)+(B298), (A)+(B71)+(B299), (A)+(B71)+(B300), (A)+(B71)+(B301), (A)+(B71)+(B302), (A)+(B71)+(B303), (A)+(B71)+(B304), (A)+(B71)+(B305), (A)+(B71)+(B306), (A)+(B71)+(B307), (A)+(B71)+(B308), (A)+(B71)+(B309), (A)+(B71)+(B310), (A)+(B71)+(B311), (A)+(B71)+(B312), (A)+(B71)+(B313), (A)+(B71)+(B314), (A)+(B71)+(B315),

(A)+(B72)+(B73), (A)+(B72)+(B74), (A)+(B72)+(B75), (A)+(B72)+(B76), (A)+(B72)+(B77), (A)+(B72)+(B78), (A)+(B72)+(B79), (A)+(B72)+(B80), (A)+(B72)+(B81), (A)+(B72)+(B82), (A)+(B72)+(B83), (A)+(B72)+(B84), (A)+(B72)+(B85), (A)+(B72)+(B86), (A)+(B72)+(B87), (A)+(B72)+(B88), (A)+(B72)+(B89), (A)+(B72)+(B90), (A)+(B72)+(B91), (A)+(B72)+(B92), (A)+(B72)+(B93), (A)+(B72)+(B94), (A)+(B72)+(B95), (A)+(B72)+(B96), (A)+(B72)+(B97), (A)+(B72)+(B98), (A)+(B72)+(B99), (A)+(B72)+(B100), (A)+(B72)+(B101), (A)+(B72)+(B102), (A)+(B72)+(B103), (A)+(B72)+(B104), (A)+(B72)+(B105), (A)+(B72)+(B106), (A)+(B72)+(B107), (A)+(B72)+(B108), (A)+(B72)+(B109), (A)+(B72)+(B110), (A)+(B72)+(B111), (A)+(B72)+(B112), (A)+(B72)+(B113), (A)+(B72)+(B114), (A)+(B72)+(B115), (A)+(B72)+(B116), (A)+(B72)+(B117), (A)+(B72)+(B118), (A)+(B72)+(B119), (A)+(B72)+(B120), (A)+(B72)+(B121), (A)+(B72)+(B122), (A)+(B72)+(B123), (A)+(B72)+(B124), (A)+(B72)+(B125), (A)+(B72)+(B126), (A)+(B72)+(B127), (A)+(B72)+(B128), (A)+(B72)+(B129), (A)+(B72)+(B130), (A)+(B72)+(B131), (A)+(B72)+(B132), (A)+(B72)+(B133), (A)+(B72)+(B134), (A)+(B72)+(B135), (A)+(B72)+(B136), (A)+(B72)+(B137), (A)+(B72)+(B138), (A)+(B72)+(B139), (A)+(B72)+(B140), (A)+(B72)+(B141), (A)+(B72)+(B142), (A)+(B72)+(B143), (A)+(B72)+(B144), (A)+(B72)+(B145), (A)+(B72)+(B146), (A)+(B72)+(B147), (A)+(B72)+(B148), (A)+(B72)+(B149), (A)+(B72)+(B150), (A)+(B72)+(B151), (A)+(B72)+(B152), (A)+(B72)+(B153), (A)+(B72)+(B154), (A)+(B72)+(B155), (A)+(B72)+(B156), (A)+(B72)+(B157), (A)+(B72)+(B158), (A)+(B72)+(B159), (A)+(B72)+(B160), (A)+(B72)+(B161), (A)+(B72)+(B162), (A)+(B72)+(B164), (A)+(B72)+(B164), (A)+(B72)+(B165), (A)+(B72)+(B166), (A)+(B72)+(B167), (A)+(B72)+(B168), (A)+(B72)+(B169), (A)+(B72)+(B170), (A)+(B72)+(B171), (A)+(B72)+(B172), (A)+(B72)+(B173), (A)+(B72)+(B174), (A)+(B72)+(B175), (A)+(B72)+(B176), (A)+(B72)+(B177), (A)+(B72)+(B178), (A)+(B72)+(B179), (A)+(B72)+(B180), (A)+(B72)+(B181), (A)+(B72)+(B182), (A)+(B72)+(B183), (A)+(B72)+(B184), (A)+(B72)+(B185), (A)+(B72)+(B186), (A)+(B72)+(B187), (A)+(B72)+(B188), (A)+(B72)+(B189), (A)+(B72)+(B190), (A)+(B72)+(B191), (A)+(B72)+(B192), (A)+(B72)+(B193), (A)+(B72)+(B194), (A)+(B72)+(B195), (A)+(B72)+(B196), (A)+(B72)+(B197), (A)+(B72)+(B198), (A)+(B72)+(B199), (A)+(B72)+(B200), (A)+(B72)+(B201), (A)+(B72)+(B202), (A)+(B72)+(B203), (A)+(B72)+(B204), (A)+(B72)+(B205), (A)+(B72)+(B206), (A)+(B72)+(B207), (A)+(B72)+(B208), (A)+(B72)+(B209), (A)+(B72)+(B210), (A)+(B72)+(B211), (A)+(B72)+(B212), (A)+(B72)+(B213), (A)+(B72)+(B214), (A)+(B72)+(B215), (A)+(B72)+(B216), (A)+(B72)+(B217), (A)+(B72)+(B218), (A)+(B72)+(B219), (A)+(B72)+(B220), (A)+(B72)+(B221), (A)+(B72)+(B222), (A)+(B72)+(B223), (A)+(B72)+(B224), (A)+(B72)+(B225), (A)+(B72)+(B226), (A)+(B72)+(B227), (A)+(B72)+(B228), (A)+(B72)+(B229), (A)+(B72)+(B230), (A)+(B72)+(B231), (A)+(B72)+(B232), (A)+(B72)+(B233), (A)+(B72)+(B234), (A)+(B72)+(B235), (A)+(B72)+(B236), (A)+(B72)+(B237), (A)+(B72)+(B238), (A)+(B72)+(B239), (A)+(B72)+(B240), (A)+(B72)+(B241), (A)+(B72)+(B242), (A)+(B72)+(B243), (A)+(B72)+(B244), (A)+(B72)+(B245), (A)+(B72)+(B246), (A)+(B72)+(B247), (A)+(B72)+(B248), (A)+(B72)+(B249), (A)+(B72)+(B250), (A)+(B72)+(B251), (A)+(B72)+(B252), (A)+(B72)+(B253), (A)+(B72)+(B254), (A)+(B72)+(B255), (A)+(B72)+(B256), (A)+(B72)+(B257), (A)+(B72)+(B258), (A)+(B72)+(B259), (A)+(B72)+(B260), (A)+(B72)+(B261), (A)+(B72)+(B262), (A)+(B72)+(B263), (A)+(B72)+(B264), (A)+(B72)+(B265), (A)+(B72)+(B266), (A)+(B72)+(B267), (A)+(B72)+(B268), (A)+(B72)+(B269), (A)+(B72)+(B270), (A)+(B72)+(B271), (A)+(B72)+(B272), (A)+(B72)+(B273), (A)+(B72)+(B274), (A)+(B72)+(B275), (A)+(B72)+(B276), (A)+(B72)+(B277), (A)+(B72)+(B278), (A)+(B72)+(B279), (A)+(B72)+(B280), (A)+(B72)+(B281), (A)+(B72)+(B282), (A)+(B72)+(B283), (A)+(B72)+(B284), (A)+(B72)+(B285), (A)+(B72)+(B286), (A)+(B72)+(B287), (A)+(B72)+(B288), (A)+(B72)+(B289), (A)+(B72)+(B290), (A)+(B72)+(B291), (A)+(B72)+(B292), (A)+(B72)+(B293), (A)+(B72)+(B294), (A)+(B72)+(B295), (A)+(B72)+(B296), (A)+(B72)+(B297), (A)+(B72)+(B298), (A)+(B72)+(B299), (A)+(B72)+(B300), (A)+(B72)+(B301), (A)+(B72)+(B302), (A)+(B72)+(B303), (A)+(B72)+(B304), (A)+(B72)+(B305), (A)+(B72)+(B306), (A)+(B72)+(B307), (A)+(B72)+(B308), (A)+(B72)+(B309), (A)+(B72)+(B310), (A)+(B72)+(B311), (A)+(B72)+(B312), (A)+(B72)+(B313), (A)+(B72)+(B314), (A)+(B72)+(B315),

(A)+(B73)+(B74), (A)+(B73)+(B75), (A)+(B73)+(B76), (A)+(B73)+(B77), (A)+(B73)+(B78), (A)+(B73)+(B79), (A)+(B73)+(B80), (A)+(B73)+(B81), (A)+(B73)+(B82), (A)+(B73)+(B83), (A)+(B73)+(B84), (A)+(B73)+(B85), (A)+(B73)+(B86), (A)+(B73)+(B87), (A)+(B73)+(B88), (A)+(B73)+(B89), (A)+(B73)+(B90), (A)+(B73)+(B91), (A)+(B73)+(B92), (A)+(B73)+(B93), (A)+(B73)+(B94), (A)+(B73)+(B95), (A)+(B73)+(B96), (A)+(B73)+(B97), (A)+(B73)+(B98), (A)+(B73)+(B99), (A)+(B73)+(B100), (A)+(B73)+(B101), (A)+(B73)+(B102), (A)+(B73)+(B103), (A)+(B73)+(B104), (A)+(B73)+(B105), (A)+(B73)+(B106), (A)+(B73)+(B107), (A)+(B73)+(B108), (A)+(B73)+(B109), (A)+(B73)+(B110), (A)+(B73)+(B111), (A)+(B73)+(B112), (A)+(B73)+(B113), (A)+(B73)+(B114), (A)+(B73)+(B115), (A)+(B73)+(B116), (A)+(B73)+(B117), (A)+(B73)+(B118), (A)+(B73)+(B119), (A)+(B73)+(B120), (A)+(B73)+(B121), (A)+(B73)+(B122), (A)+(B73)+(B123), (A)+(B73)+(B124), (A)+(B73)+(B125), (A)+(B73)+(B126), (A)+(B73)+(B127), (A)+(B73)+(B128), (A)+(B73)+(B129), (A)+(B73)+(B130), (A)+(B73)+(B131), (A)+(B73)+(B132), (A)+(B73)+(B133), (A)+(B73)+(B134), (A)+(B73)+(B135), (A)+(B73)+(B136), (A)+(B73)+(B137), (A)+(B73)+(B138), (A)+(B73)+(B139), (A)+(B73)+(B140), (A)+(B73)+(B141), (A)+(B73)+(B142), (A)+(B73)+(B143), (A)+(B73)+(B144), (A)+(B73)+(B145), (A)+(B73)+(B146), (A)+(B73)+(B147), (A)+(B73)+(B148), (A)+(B73)+(B149), (A)+(B73)+(B150), (A)+(B73)+(B151), (A)+(B73)+(B152), (A)+(B73)+(B153), (A)+(B73)+(B154), (A)+(B73)+(B155), (A)+(B73)+(B156), (A)+(B73)+(B157), (A)+(B73)+(B158), (A)+(B73)+(B159), (A)+(B73)+(B160), (A)+(B73)+(B161), (A)+(B73)+(B162), (A)+(B73)+(B164), (A)+(B73)+(B164), (A)+(B73)+(B165), (A)+(B73)+(B166), (A)+(B73)+(B167), (A)+(B73)+(B168), (A)+(B73)+(B169), (A)+(B73)+(B170), (A)+(B73)+(B171), (A)+(B73)+(B172), (A)+(B73)+(B173), (A)+(B73)+(B174), (A)+(B73)+(B175), (A)+(B73)+(B176), (A)+(B73)+(B177), (A)+(B73)+(B178), (A)+(B73)+(B179), (A)+(B73)+(B180), (A)+(B73)+(B181), (A)+(B73)+(B182), (A)+(B73)+(B183), (A)+(B73)+(B184), (A)+(B73)+(B185), (A)+(B73)+(B186), (A)+(B73)+(B187), (A)+(B73)+(B188), (A)+(B73)+(B189), (A)+(B73)+(B190), (A)+(B73)+(B191), (A)+(B73)+(B192), (A)+(B73)+(B193), (A)+(B73)+(B194), (A)+(B73)+(B195), (A)+(B73)+(B196), (A)+(B73)+(B197), (A)+(B73)+(B198), (A)+(B73)+(B199), (A)+(B73)+(B200), (A)+(B73)+(B201), (A)+(B73)+(B202), (A)+(B73)+(B203), (A)+(B73)+(B204), (A)+(B73)+(B205), (A)+(B73)+(B206), (A)+(B73)+(B207), (A)+(B73)+(B208), (A)+(B73)+(B209), (A)+(B73)+(B210), (A)+(B73)+(B211), (A)+(B73)+(B212), (A)+(B73)+(B213), (A)+(B73)+(B214), (A)+(B73)+(B215), (A)+(B73)+(B216), (A)+(B73)+(B217), (A)+(B73)+(B218), (A)+(B73)+(B219), (A)+(B73)+(B220), (A)+(B73)+(B221), (A)+(B73)+(B222), (A)+(B73)+(B223), (A)+(B73)+(B224), (A)+(B73)+(B225), (A)+(B73)+(B226), (A)+(B73)+(B227), (A)+(B73)+(B228), (A)+(B73)+(B229), (A)+(B73)+(B230), (A)+(B73)+(B231), (A)+(B73)+(B232), (A)+(B73)+(B233), (A)+(B73)+(B234), (A)+(B73)+(B235), (A)+(B73)+(B236), (A)+(B73)+(B237), (A)+(B73)+(B238), (A)+(B73)+(B239), (A)+(B73)+(B240), (A)+(B73)+(B241), (A)+(B73)+(B242), (A)+(B73)+(B243), (A)+(B73)+(B244), (A)+(B73)+(B245), (A)+(B73)+(B246), (A)+(B73)+(B247), (A)+(B73)+(B248), (A)+(B73)+(B249), (A)+(B73)+(B250), (A)+(B73)+(B251), (A)+(B73)+(B252), (A)+(B73)+(B253), (A)+(B73)+(B254), (A)+(B73)+(B255), (A)+(B73)+(B256), (A)+(B73)+(B257), (A)+(B73)+(B258), (A)+(B73)+(B259), (A)+(B73)+(B260), (A)+(B73)+(B261), (A)+(B73)+(B262), (A)+(B73)+(B263), (A)+(B73)+(B264), (A)+(B73)+(B265), (A)+(B73)+(B266), (A)+(B73)+(B267), (A)+(B73)+(B268), (A)+(B73)+(B269), (A)+(B73)+(B270), (A)+(B73)+(B271), (A)+(B73)+(B272), (A)+(B73)+(B273), (A)+(B73)+(B274), (A)+(B73)+(B275), (A)+(B73)+(B276), (A)+(B73)+(B277), (A)+(B73)+(B278), (A)+(B73)+(B279), (A)+(B73)+(B280), (A)+(B73)+(B281), (A)+(B73)+(B282), (A)+(B73)+(B283), (A)+(B73)+(B284), (A)+(B73)+(B285), (A)+(B73)+(B286), (A)+(B73)+(B287), (A)+(B73)+(B288), (A)+(B73)+(B289), (A)+(B73)+(B290), (A)+(B73)+(B291), (A)+(B73)+(B292), (A)+(B73)+(B293), (A)+(B73)+(B294), (A)+(B73)+(B295), (A)+(B73)+(B296), (A)+(B73)+(B297), (A)+(B73)+(B298), (A)+(B73)+(B299), (A)+(B73)+(B300), (A)+(B73)+(B301), (A)+(B73)+(B302), (A)+(B73)+(B303), (A)+(B73)+(B304), (A)+(B73)+(B305), (A)+(B73)+(B306), (A)+(B73)+(B307), (A)+(B73)+(B308), (A)+(B73)+(B309), (A)+(B73)+(B310), (A)+(B73)+(B311), (A)+(B73)+(B312), (A)+(B73)+(B313), (A)+(B73)+(B314), (A)+(B73)+(B315),

(A)+(B74)+(B75), (A)+(B74)+(B76), (A)+(B74)+(B77), (A)+(B74)+(B78), (A)+(B74)+(B79), (A)+(B74)+(B80), (A)+(B74)+(B81), (A)+(B74)+(B82), (A)+(B74)+(B83), (A)+(B74)+(B84), (A)+(B74)+(B85), (A)+(B74)+(B86), (A)+(B74)+(B87), (A)+(B74)+(B88), (A)+(B74)+(B89), (A)+(B74)+(B90), (A)+(B74)+(B91), (A)+(B74)+(B92), (A)+(B74)+(B93), (A)+(B74)+(B94), (A)+(B74)+(B95), (A)+(B74)+(B96), (A)+(B74)+(B97), (A)+(B74)+(B98), (A)+(B74)+(B99), (A)+(B74)+(B100), (A)+(B74)+(B101), (A)+(B74)+(B102), (A)+(B74)+(B103), (A)+(B74)+(B104), (A)+(B74)+(B105), (A)+(B74)+(B106), (A)+(B74)+(B107), (A)+(B74)+(B108), (A)+(B74)+(B109), (A)+(B74)+(B110), (A)+(B74)+(B111), (A)+(B74)+(B112), (A)+(B74)+(B113), (A)+(B74)+(B114), (A)+(B74)+(B115), (A)+(B74)+(B116), (A)+(B74)+(B117), (A)+(B74)+(B118), (A)+(B74)+(B119), (A)+(B74)+(B120), (A)+(B74)+(B121), (A)+(B74)+(B122), (A)+(B74)+(B123), (A)+(B74)+(B124), (A)+(B74)+(B125), (A)+(B74)+(B126), (A)+(B74)+(B127), (A)+(B74)+(B128), (A)+(B74)+(B129), (A)+(B74)+(B130), (A)+(B74)+(B131), (A)+(B74)+(B132), (A)+(B74)+(B133), (A)+(B74)+(B134), (A)+(B74)+(B135), (A)+(B74)+(B136), (A)+(B74)+(B137), (A)+(B74)+(B138), (A)+(B74)+(B139), (A)+(B74)+(B140), (A)+(B74)+(B141), (A)+(B74)+(B142), (A)+(B74)+(B143), (A)+(B74)+(B144), (A)+(B74)+(B145), (A)+(B74)+(B146), (A)+(B74)+(B147), (A)+(B74)+(B148), (A)+(B74)+(B149), (A)+(B74)+(B150), (A)+(B74)+(B151), (A)+(B74)+(B152), (A)+(B74)+(B153), (A)+(B74)+(B154), (A)+(B74)+(B155), (A)+(B74)+(B156), (A)+(B74)+(B157), (A)+(B74)+(B158), (A)+(B74)+(B159), (A)+(B74)+(B160), (A)+(B74)+(B161), (A)+(B74)+(B162), (A)+(B74)+(B164), (A)+(B74)+(B164), (A)+(B74)+(B165), (A)+(B74)+(B166), (A)+(B74)+(B167), (A)+(B74)+(B168), (A)+(B74)+(B169), (A)+(B74)+(B170), (A)+(B74)+(B171), (A)+(B74)+(B172), (A)+(B74)+(B173), (A)+(B74)+(B174), (A)+(B74)+(B175), (A)+(B74)+(B176), (A)+(B74)+(B177), (A)+(B74)+(B178), (A)+(B74)+(B179), (A)+(B74)+(B180), (A)+(B74)+(B181), (A)+(B74)+(B182), (A)+(B74)+(B183), (A)+(B74)+(B184), (A)+(B74)+(B185), (A)+(B74)+(B186), (A)+(B74)+(B187), (A)+(B74)+(B188), (A)+(B74)+(B189), (A)+(B74)+(B190), (A)+(B74)+(B191), (A)+(B74)+(B192), (A)+(B74)+(B193), (A)+(B74)+(B194), (A)+(B74)+(B195), (A)+(B74)+(B196), (A)+(B74)+(B197), (A)+(B74)+(B198), (A)+(B74)+(B199), (A)+(B74)+(B200), (A)+(B74)+(B201), (A)+(B74)+(B202), (A)+(B74)+(B203), (A)+(B74)+(B204), (A)+(B74)+(B205), (A)+(B74)+(B206), (A)+(B74)+(B207), (A)+(B74)+(B208), (A)+(B74)+(B209), (A)+(B74)+(B210), (A)+(B74)+(B211), (A)+(B74)+(B212), (A)+(B74)+(B213), (A)+(B74)+(B214), (A)+(B74)+(B215), (A)+(B74)+(B216), (A)+(B74)+(B217), (A)+(B74)+(B218), (A)+(B74)+(B219), (A)+(B74)+(B220), (A)+(B74)+(B221), (A)+(B74)+(B222), (A)+(B74)+(B223), (A)+(B74)+(B224), (A)+(B74)+(B225), (A)+(B74)+(B226), (A)+(B74)+(B227), (A)+(B74)+(B228), (A)+(B74)+(B229), (A)+(B74)+(B230), (A)+(B74)+(B231), (A)+(B74)+(B232), (A)+(B74)+(B233), (A)+(B74)+(B234), (A)+(B74)+(B235), (A)+(B74)+(B236), (A)+(B74)+(B237), (A)+(B74)+(B238), (A)+(B74)+(B239), (A)+(B74)+(B240), (A)+(B74)+(B241), (A)+(B74)+(B242), (A)+(B74)+(B243), (A)+(B74)+(B244), (A)+(B74)+(B245), (A)+(B74)+(B246), (A)+(B74)+(B247), (A)+(B74)+(B248), (A)+(B74)+(B249), (A)+(B74)+(B250), (A)+(B74)+(B251), (A)+(B74)+(B252), (A)+(B74)+(B253), (A)+(B74)+(B254), (A)+(B74)+(B255), (A)+(B74)+(B256), (A)+(B74)+(B257), (A)+(B74)+(B258), (A)+(B74)+(B259), (A)+(B74)+(B260), (A)+(B74)+(B261), (A)+(B74)+(B262), (A)+(B74)+(B263), (A)+(B74)+(B264), (A)+(B74)+(B265), (A)+(B74)+(B266), (A)+(B74)+(B267), (A)+(B74)+(B268), (A)+(B74)+(B269), (A)+(B74)+(B270), (A)+(B74)+(B271), (A)+(B74)+(B272), (A)+(B74)+(B273), (A)+(B74)+(B274), (A)+(B74)+(B275), (A)+(B74)+(B276), (A)+(B74)+(B277), (A)+(B74)+(B278), (A)+(B74)+(B279), (A)+(B74)+(B280), (A)+(B74)+(B281), (A)+(B74)+(B282), (A)+(B74)+(B283), (A)+(B74)+(B284), (A)+(B74)+(B285), (A)+(B74)+(B286), (A)+(B74)+(B287), (A)+(B74)+(B288), (A)+(B74)+(B289), (A)+(B74)+(B290), (A)+(B74)+(B291), (A)+(B74)+(B292), (A)+(B74)+(B293), (A)+(B74)+(B294), (A)+(B74)+(B295), (A)+(B74)+(B296), (A)+(B74)+(B297), (A)+(B74)+(B298), (A)+(B74)+(B299), (A)+(B74)+(B300), (A)+(B74)+(B301), (A)+(B74)+(B302), (A)+(B74)+(B303), (A)+(B74)+(B304), (A)+(B74)+(B305), (A)+(B74)+(B306), (A)+(B74)+(B307), (A)+(B74)+(B308), (A)+(B74)+(B309), (A)+(B74)+(B310), (A)+(B74)+(B311), (A)+(B74)+(B312), (A)+(B74)+(B313), (A)+(B74)+(B314), (A)+(B74)+(B315),

(A)+(B75)+(B76), (A)+(B75)+(B77), (A)+(B75)+(B78), (A)+(B75)+(B79), (A)+(B75)+(B80), (A)+(B75)+(B81), (A)+(B75)+(B82), (A)+(B75)+(B83), (A)+(B75)+(B84), (A)+(B75)+(B85), (A)+(B75)+(B86), (A)+(B75)+(B87), (A)+(B75)+(B88), (A)+(B75)+(B89), (A)+(B75)+(B90), (A)+(B75)+(B91), (A)+(B75)+(B92), (A)+(B75)+(B93), (A)+(B75)+(B94), (A)+(B75)+(B95), (A)+(B75)+(B96), (A)+(B75)+(B97), (A)+(B75)+(B98), (A)+(B75)+(B99), (A)+(B75)+(B100), (A)+(B75)+(B101), (A)+(B75)+(B102), (A)+(B75)+(B103), (A)+(B75)+(B104), (A)+(B75)+(B105), (A)+(B75)+(B106), (A)+(B75)+(B107), (A)+(B75)+(B108), (A)+(B75)+(B109), (A)+(B75)+(B110), (A)+(B75)+(B111), (A)+(B75)+(B112), (A)+(B75)+(B113), (A)+(B75)+(B114), (A)+(B75)+(B115), (A)+(B75)+(B116), (A)+(B75)+(B117), (A)+(B75)+(B118), (A)+(B75)+(B119), (A)+(B75)+(B120), (A)+(B75)+(B121), (A)+(B75)+(B122), (A)+(B75)+(B123), (A)+(B75)+(B124), (A)+(B75)+(B125), (A)+(B75)+(B126), (A)+(B75)+(B127), (A)+(B75)+(B128), (A)+(B75)+(B129), (A)+(B75)+(B130), (A)+(B75)+(B131), (A)+(B75)+(B132), (A)+(B75)+(B133), (A)+(B75)+(B134), (A)+(B75)+(B135), (A)+(B75)+(B136), (A)+(B75)+(B137), (A)+(B75)+(B138), (A)+(B75)+(B139), (A)+(B75)+(B140), (A)+(B75)+(B141), (A)+(B75)+(B142), (A)+(B75)+(B143), (A)+(B75)+(B144), (A)+(B75)+(B145), (A)+(B75)+(B146), (A)+(B75)+(B147), (A)+(B75)+(B148), (A)+(B75)+(B149), (A)+(B75)+(B150), (A)+(B75)+(B151), (A)+(B75)+(B152), (A)+(B75)+(B153), (A)+(B75)+(B154), (A)+(B75)+(B155), (A)+(B75)+(B156), (A)+(B75)+(B157), (A)+(B75)+(B158), (A)+(B75)+(B159), (A)+(B75)+(B160), (A)+(B75)+(B161), (A)+(B75)+(B162), (A)+(B75)+(B164), (A)+(B75)+(B164), (A)+(B75)+(B165), (A)+(B75)+(B166), (A)+(B75)+(B167), (A)+(B75)+(B168), (A)+(B75)+(B169), (A)+(B75)+(B170), (A)+(B75)+(B171), (A)+(B75)+(B172), (A)+(B75)+(B173), (A)+(B75)+(B174), (A)+(B75)+(B175), (A)+(B75)+(B176), (A)+(B75)+(B177), (A)+(B75)+(B178), (A)+(B75)+(B179), (A)+(B75)+(B180), (A)+(B75)+(B181), (A)+(B75)+(B182), (A)+(B75)+(B183), (A)+(B75)+(B184), (A)+(B75)+(B185), (A)+(B75)+(B186), (A)+(B75)+(B187), (A)+(B75)+(B188), (A)+(B75)+(B189), (A)+(B75)+(B190), (A)+(B75)+(B191), (A)+(B75)+(B192), (A)+(B75)+(B193), (A)+(B75)+(B194), (A)+(B75)+(B195), (A)+(B75)+(B196), (A)+(B75)+(B197), (A)+(B75)+(B198), (A)+(B75)+(B199), (A)+(B75)+(B200), (A)+(B75)+(B201), (A)+(B75)+(B202), (A)+(B75)+(B203), (A)+(B75)+(B204), (A)+(B75)+(B205), (A)+(B75)+(B206), (A)+(B75)+(B207), (A)+(B75)+(B208), (A)+(B75)+(B209), (A)+(B75)+(B210), (A)+(B75)+(B211), (A)+(B75)+(B212), (A)+(B75)+(B213), (A)+(B75)+(B214), (A)+(B75)+(B215), (A)+(B75)+(B216), (A)+(B75)+(B217), (A)+(B75)+(B218), (A)+(B75)+(B219), (A)+(B75)+(B220), (A)+(B75)+(B221), (A)+(B75)+(B222), (A)+(B75)+(B223), (A)+(B75)+(B224), (A)+(B75)+(B225), (A)+(B75)+(B226), (A)+(B75)+(B227), (A)+(B75)+(B228), (A)+(B75)+(B229), (A)+(B75)+(B230), (A)+(B75)+(B231), (A)+(B75)+(B232), (A)+(B75)+(B233), (A)+(B75)+(B234), (A)+(B75)+(B235), (A)+(B75)+(B236), (A)+(B75)+(B237), (A)+(B75)+(B238), (A)+(B75)+(B239), (A)+(B75)+(B240), (A)+(B75)+(B241), (A)+(B75)+(B242), (A)+(B75)+(B243), (A)+(B75)+(B244), (A)+(B75)+(B245), (A)+(B75)+(B246), (A)+(B75)+(B247), (A)+(B75)+(B248), (A)+(B75)+(B249), (A)+(B75)+(B250), (A)+(B75)+(B251), (A)+(B75)+(B252), (A)+(B75)+(B253), (A)+(B75)+(B254), (A)+(B75)+(B255), (A)+(B75)+(B256), (A)+(B75)+(B257), (A)+(B75)+(B258), (A)+(B75)+(B259), (A)+(B75)+(B260), (A)+(B75)+(B261), (A)+(B75)+(B262), (A)+(B75)+(B263), (A)+(B75)+(B264), (A)+(B75)+(B265), (A)+(B75)+(B266), (A)+(B75)+(B267), (A)+(B75)+(B268), (A)+(B75)+(B269), (A)+(B75)+(B270), (A)+(B75)+(B271), (A)+(B75)+(B272), (A)+(B75)+(B273), (A)+(B75)+(B274), (A)+(B75)+(B275), (A)+(B75)+(B276), (A)+(B75)+(B277), (A)+(B75)+(B278), (A)+(B75)+(B279), (A)+(B75)+(B280), (A)+(B75)+(B281), (A)+(B75)+(B282), (A)+(B75)+(B283), (A)+(B75)+(B284), (A)+(B75)+(B285), (A)+(B75)+(B286), (A)+(B75)+(B287), (A)+(B75)+(B288), (A)+(B75)+(B289), (A)+(B75)+(B290), (A)+(B75)+(B291), (A)+(B75)+(B292), (A)+(B75)+(B293), (A)+(B75)+(B294), (A)+(B75)+(B295), (A)+(B75)+(B296), (A)+(B75)+(B297), (A)+(B75)+(B298), (A)+(B75)+(B299), (A)+(B75)+(B300), (A)+(B75)+(B301), (A)+(B75)+(B302), (A)+(B75)+(B303), (A)+(B75)+(B304), (A)+(B75)+(B305), (A)+(B75)+(B306), (A)+(B75)+(B307), (A)+(B75)+(B308), (A)+(B75)+(B309), (A)+(B75)+(B310), (A)+(B75)+(B311), (A)+(B75)+(B312), (A)+(B75)+(B313), (A)+(B75)+(B314), (A)+(B75)+(B315),

(A)+(B76)+(B77), (A)+(B76)+(B78), (A)+(B76)+(B79), (A)+(B76)+(B80), (A)+(B76)+(B81), (A)+(B76)+(B82), (A)+(B76)+(B83), (A)+(B76)+(B84), (A)+(B76)+(B85), (A)+(B76)+(B86), (A)+(B76)+(B87), (A)+(B76)+(B88), (A)+(B76)+(B89), (A)+(B76)+(B90), (A)+(B76)+(B91), (A)+(B76)+(B92), (A)+(B76)+(B93), (A)+(B76)+(B94), (A)+(B76)+(B95), (A)+(B76)+(B96), (A)+(B76)+(B97), (A)+(B76)+(B98), (A)+(B76)+(B99), (A)+(B76)+(B100), (A)+(B76)+(B101), (A)+(B76)+(B102), (A)+(B76)+(B103), (A)+(B76)+(B104), (A)+(B76)+(B105), (A)+(B76)+(B106), (A)+(B76)+(B107), (A)+(B76)+(B108), (A)+(B76)+(B109), (A)+(B76)+(B110), (A)+(B76)+(B111), (A)+(B76)+(B112), (A)+(B76)+(B113), (A)+(B76)+(B114), (A)+(B76)+(B115), (A)+(B76)+(B116), (A)+(B76)+(B117), (A)+(B76)+(B118), (A)+(B76)+(B119), (A)+(B76)+(B120), (A)+(B76)+(B121), (A)+(B76)+(B122), (A)+(B76)+(B123), (A)+(B76)+(B124), (A)+(B76)+(B125), (A)+(B76)+(B126), (A)+(B76)+(B127), (A)+(B76)+(B128), (A)+(B76)+(B129), (A)+(B76)+(B130), (A)+(B76)+(B131), (A)+(B76)+(B132), (A)+(B76)+(B133), (A)+(B76)+(B134), (A)+(B76)+(B135), (A)+(B76)+(B136), (A)+(B76)+(B137), (A)+(B76)+(B138), (A)+(B76)+(B139), (A)+(B76)+(B140), (A)+(B76)+(B141), (A)+(B76)+(B142), (A)+(B76)+(B143), (A)+(B76)+(B144), (A)+(B76)+(B145), (A)+(B76)+(B146), (A)+(B76)+(B147), (A)+(B76)+(B148), (A)+(B76)+(B149), (A)+(B76)+(B150), (A)+(B76)+(B151), (A)+(B76)+(B152), (A)+(B76)+(B153), (A)+(B76)+(B154), (A)+(B76)+(B155), (A)+(B76)+(B156), (A)+(B76)+(B157), (A)+(B76)+(B158), (A)+(B76)+(B159), (A)+(B76)+(B160), (A)+(B76)+(B161), (A)+(B76)+(B162), (A)+(B76)+(B164), (A)+(B76)+(B164), (A)+(B76)+(B165), (A)+(B76)+(B166), (A)+(B76)+(B167), (A)+(B76)+(B168), (A)+(B76)+(B169), (A)+(B76)+(B170), (A)+(B76)+(B171), (A)+(B76)+(B172), (A)+(B76)+(B173), (A)+(B76)+(B174), (A)+(B76)+(B175), (A)+(B76)+(B176), (A)+(B76)+(B177), (A)+(B76)+(B178), (A)+(B76)+(B179), (A)+(B76)+(B180), (A)+(B76)+(B181), (A)+(B76)+(B182), (A)+(B76)+(B183), (A)+(B76)+(B184), (A)+(B76)+(B185), (A)+(B76)+(B186), (A)+(B76)+(B187), (A)+(B76)+(B188), (A)+(B76)+(B189), (A)+(B76)+(B190), (A)+(B76)+(B191), (A)+(B76)+(B192), (A)+(B76)+(B193), (A)+(B76)+(B194), (A)+(B76)+(B195), (A)+(B76)+(B196), (A)+(B76)+(B197), (A)+(B76)+(B198), (A)+(B76)+(B199), (A)+(B76)+(B200), (A)+(B76)+(B201), (A)+(B76)+(B202), (A)+(B76)+(B203), (A)+(B76)+(B204), (A)+(B76)+(B205), (A)+(B76)+(B206), (A)+(B76)+(B207), (A)+(B76)+(B208), (A)+(B76)+(B209), (A)+(B76)+(B210), (A)+(B76)+(B211), (A)+(B76)+(B212), (A)+(B76)+(B213), (A)+(B76)+(B214), (A)+(B76)+(B215), (A)+(B76)+(B216), (A)+(B76)+(B217), (A)+(B76)+(B218), (A)+(B76)+(B219), (A)+(B76)+(B220), (A)+(B76)+(B221), (A)+(B76)+(B222), (A)+(B76)+(B223), (A)+(B76)+(B224), (A)+(B76)+(B225), (A)+(B76)+(B226), (A)+(B76)+(B227), (A)+(B76)+(B228), (A)+(B76)+(B229), (A)+(B76)+(B230), (A)+(B76)+(B231), (A)+(B76)+(B232), (A)+(B76)+(B233), (A)+(B76)+(B234), (A)+(B76)+(B235), (A)+(B76)+(B236), (A)+(B76)+(B237), (A)+(B76)+(B238), (A)+(B76)+(B239), (A)+(B76)+(B240), (A)+(B76)+(B241), (A)+(B76)+(B242), (A)+(B76)+(B243), (A)+(B76)+(B244), (A)+(B76)+(B245), (A)+(B76)+(B246), (A)+(B76)+(B247), (A)+(B76)+(B248), (A)+(B76)+(B249), (A)+(B76)+(B250), (A)+(B76)+(B251), (A)+(B76)+(B252), (A)+(B76)+(B253), (A)+(B76)+(B254), (A)+(B76)+(B255), (A)+(B76)+(B256), (A)+(B76)+(B257), (A)+(B76)+(B258), (A)+(B76)+(B259), (A)+(B76)+(B260), (A)+(B76)+(B261), (A)+(B76)+(B262), (A)+(B76)+(B263), (A)+(B76)+(B264), (A)+(B76)+(B265), (A)+(B76)+(B266), (A)+(B76)+(B267), (A)+(B76)+(B268), (A)+(B76)+(B269), (A)+(B76)+(B270), (A)+(B76)+(B271), (A)+(B76)+(B272), (A)+(B76)+(B273), (A)+(B76)+(B274), (A)+(B76)+(B275), (A)+(B76)+(B276), (A)+(B76)+(B277), (A)+(B76)+(B278), (A)+(B76)+(B279), (A)+(B76)+(B280), (A)+(B76)+(B281), (A)+(B76)+(B282), (A)+(B76)+(B283), (A)+(B76)+(B284), (A)+(B76)+(B285), (A)+(B76)+(B286), (A)+(B76)+(B287), (A)+(B76)+(B288), (A)+(B76)+(B289), (A)+(B76)+(B290), (A)+(B76)+(B291), (A)+(B76)+(B292), (A)+(B76)+(B293), (A)+(B76)+(B294), (A)+(B76)+(B295), (A)+(B76)+(B296), (A)+(B76)+(B297), (A)+(B76)+(B298), (A)+(B76)+(B299), (A)+(B76)+(B300), (A)+(B76)+(B301), (A)+(B76)+(B302), (A)+(B76)+(B303), (A)+(B76)+(B304), (A)+(B76)+(B305), (A)+(B76)+(B306), (A)+(B76)+(B307), (A)+(B76)+(B308), (A)+(B76)+(B309), (A)+(B76)+(B310), (A)+(B76)+(B311), (A)+(B76)+(B312), (A)+(B76)+(B313), (A)+(B76)+(B314), (A)+(B76)+(B315),

(A)+(B77)+(B78), (A)+(B77)+(B79), (A)+(B77)+(B80), (A)+(B77)+(B81), (A)+(B77)+(B82), (A)+(B77)+(B83), (A)+(B77)+(B84), (A)+(B77)+(B85), (A)+(B77)+(B86), (A)+(B77)+(B87), (A)+(B77)+(B88), (A)+(B77)+(B89), (A)+(B77)+(B90), (A)+(B77)+(B91), (A)+(B77)+(B92), (A)+(B77)+(B93), (A)+(B77)+(B94), (A)+(B77)+(B95), (A)+(B77)+(B96), (A)+(B77)+(B97), (A)+(B77)+(B98), (A)+(B77)+(B99), (A)+(B77)+(B100), (A)+(B77)+(B101), (A)+(B77)+(B102), (A)+(B77)+(B103), (A)+(B77)+(B104), (A)+(B77)+(B105), (A)+(B77)+(B106), (A)+(B77)+(B107), (A)+(B77)+(B108), (A)+(B77)+(B109), (A)+(B77)+(B110), (A)+(B77)+(B111), (A)+(B77)+(B112), (A)+(B77)+(B113), (A)+(B77)+(B114), (A)+(B77)+(B115), (A)+(B77)+(B116), (A)+(B77)+(B117), (A)+(B77)+(B118), (A)+(B77)+(B119), (A)+(B77)+(B120), (A)+(B77)+(B121), (A)+(B77)+(B122), (A)+(B77)+(B123), (A)+(B77)+(B124), (A)+(B77)+(B125), (A)+(B77)+(B126), (A)+(B77)+(B127), (A)+(B77)+(B128), (A)+(B77)+(B129), (A)+(B77)+(B130), (A)+(B77)+(B131), (A)+(B77)+(B132), (A)+(B77)+(B133), (A)+(B77)+(B134), (A)+(B77)+(B135), (A)+(B77)+(B136), (A)+(B77)+(B137), (A)+(B77)+(B138), (A)+(B77)+(B139), (A)+(B77)+(B140), (A)+(B77)+(B141), (A)+(B77)+(B142), (A)+(B77)+(B143), (A)+(B77)+(B144), (A)+(B77)+(B145), (A)+(B77)+(B146), (A)+(B77)+(B147), (A)+(B77)+(B148), (A)+(B77)+(B149), (A)+(B77)+(B150), (A)+(B77)+(B151), (A)+(B77)+(B152), (A)+(B77)+(B153), (A)+(B77)+(B154), (A)+(B77)+(B155), (A)+(B77)+(B156), (A)+(B77)+(B157), (A)+(B77)+(B158), (A)+(B77)+(B159), (A)+(B77)+(B160), (A)+(B77)+(B161), (A)+(B77)+(B162), (A)+(B77)+(B164), (A)+(B77)+(B164), (A)+(B77)+(B165), (A)+(B77)+(B166), (A)+(B77)+(B167), (A)+(B77)+(B168), (A)+(B77)+(B169), (A)+(B77)+(B170), (A)+(B77)+(B171), (A)+(B77)+(B172), (A)+(B77)+(B173), (A)+(B77)+(B174), (A)+(B77)+(B175), (A)+(B77)+(B176), (A)+(B77)+(B177), (A)+(B77)+(B178), (A)+(B77)+(B179), (A)+(B77)+(B180), (A)+(B77)+(B181), (A)+(B77)+(B182), (A)+(B77)+(B183), (A)+(B77)+(B184), (A)+(B77)+(B185), (A)+(B77)+(B186), (A)+(B77)+(B187), (A)+(B77)+(B188), (A)+(B77)+(B189), (A)+(B77)+(B190), (A)+(B77)+(B191), (A)+(B77)+(B192), (A)+(B77)+(B193), (A)+(B77)+(B194), (A)+(B77)+(B195), (A)+(B77)+(B196), (A)+(B77)+(B197), (A)+(B77)+(B198), (A)+(B77)+(B199), (A)+(B77)+(B200), (A)+(B77)+(B201), (A)+(B77)+(B202), (A)+(B77)+(B203), (A)+(B77)+(B204), (A)+(B77)+(B205), (A)+(B77)+(B206), (A)+(B77)+(B207), (A)+(B77)+(B208), (A)+(B77)+(B209), (A)+(B77)+(B210), (A)+(B77)+(B211), (A)+(B77)+(B212), (A)+(B77)+(B213), (A)+(B77)+(B214), (A)+(B77)+(B215), (A)+(B77)+(B216), (A)+(B77)+(B217), (A)+(B77)+(B218), (A)+(B77)+(B219), (A)+(B77)+(B220), (A)+(B77)+(B221), (A)+(B77)+(B222), (A)+(B77)+(B223), (A)+(B77)+(B224), (A)+(B77)+(B225), (A)+(B77)+(B226), (A)+(B77)+(B227), (A)+(B77)+(B228), (A)+(B77)+(B229), (A)+(B77)+(B230), (A)+(B77)+(B231), (A)+(B77)+(B232), (A)+(B77)+(B233), (A)+(B77)+(B234), (A)+(B77)+(B235), (A)+(B77)+(B236), (A)+(B77)+(B237), (A)+(B77)+(B238), (A)+(B77)+(B239), (A)+(B77)+(B240), (A)+(B77)+(B241), (A)+(B77)+(B242), (A)+(B77)+(B243), (A)+(B77)+(B244), (A)+(B77)+(B245), (A)+(B77)+(B246), (A)+(B77)+(B247), (A)+(B77)+(B248), (A)+(B77)+(B249), (A)+(B77)+(B250), (A)+(B77)+(B251), (A)+(B77)+(B252), (A)+(B77)+(B253), (A)+(B77)+(B254), (A)+(B77)+(B255), (A)+(B77)+(B256), (A)+(B77)+(B257), (A)+(B77)+(B258), (A)+(B77)+(B259), (A)+(B77)+(B260), (A)+(B77)+(B261), (A)+(B77)+(B262), (A)+(B77)+(B263), (A)+(B77)+(B264), (A)+(B77)+(B265), (A)+(B77)+(B266), (A)+(B77)+(B267), (A)+(B77)+(B268), (A)+(B77)+(B269), (A)+(B77)+(B270), (A)+(B77)+(B271), (A)+(B77)+(B272), (A)+(B77)+(B273), (A)+(B77)+(B274), (A)+(B77)+(B275), (A)+(B77)+(B276), (A)+(B77)+(B277), (A)+(B77)+(B278), (A)+(B77)+(B279), (A)+(B77)+(B280), (A)+(B77)+(B281), (A)+(B77)+(B282), (A)+(B77)+(B283), (A)+(B77)+(B284), (A)+(B77)+(B285), (A)+(B77)+(B286), (A)+(B77)+(B287), (A)+(B77)+(B288), (A)+(B77)+(B289), (A)+(B77)+(B290), (A)+(B77)+(B291), (A)+(B77)+(B292), (A)+(B77)+(B293), (A)+(B77)+(B294), (A)+(B77)+(B295), (A)+(B77)+(B296), (A)+(B77)+(B297), (A)+(B77)+(B298), (A)+(B77)+(B299), (A)+(B77)+(B300), (A)+(B77)+(B301), (A)+(B77)+(B302), (A)+(B77)+(B303), (A)+(B77)+(B304), (A)+(B77)+(B305), (A)+(B77)+(B306), (A)+(B77)+(B307), (A)+(B77)+(B308), (A)+(B77)+(B309), (A)+(B77)+(B310), (A)+(B77)+(B311), (A)+(B77)+(B312), (A)+(B77)+(B313), (A)+(B77)+(B314), (A)+(B77)+(B315),

(A)+(B78)+(B79), (A)+(B78)+(B80), (A)+(B78)+(B81), (A)+(B78)+(B82), (A)+(B78)+(B83), (A)+(B78)+(B84), (A)+(B78)+(B85), (A)+(B78)+(B86), (A)+(B78)+(B87), (A)+(B78)+(B88), (A)+(B78)+(B89), (A)+(B78)+(B90), (A)+(B78)+(B91), (A)+(B78)+(B92), (A)+(B78)+(B93), (A)+(B78)+(B94), (A)+(B78)+(B95), (A)+(B78)+(B96), (A)+(B78)+(B97), (A)+(B78)+(B98), (A)+(B78)+(B99), (A)+(B78)+(B100), (A)+(B78)+(B101), (A)+(B78)+(B102), (A)+(B78)+(B103), (A)+(B78)+(B104), (A)+(B78)+(B105), (A)+(B78)+(B106), (A)+(B78)+(B107), (A)+(B78)+(B108), (A)+(B78)+(B109), (A)+(B78)+(B110), (A)+(B78)+(B111), (A)+(B78)+(B112), (A)+(B78)+(B113), (A)+(B78)+(B114), (A)+(B78)+(B115), (A)+(B78)+(B116), (A)+(B78)+(B117), (A)+(B78)+(B118), (A)+(B78)+(B119), (A)+(B78)+(B120), (A)+(B78)+(B121), (A)+(B78)+(B122), (A)+(B78)+(B123), (A)+(B78)+(B124), (A)+(B78)+(B125), (A)+(B78)+(B126), (A)+(B78)+(B127), (A)+(B78)+(B128), (A)+(B78)+(B129), (A)+(B78)+(B130), (A)+(B78)+(B131), (A)+(B78)+(B132), (A)+(B78)+(B133), (A)+(B78)+(B134), (A)+(B78)+(B135), (A)+(B78)+(B136), (A)+(B78)+(B137), (A)+(B78)+(B138), (A)+(B78)+(B139), (A)+(B78)+(B140), (A)+(B78)+(B141), (A)+(B78)+(B142), (A)+(B78)+(B143), (A)+(B78)+(B144), (A)+(B78)+(B145), (A)+(B78)+(B146), (A)+(B78)+(B147), (A)+(B78)+(B148), (A)+(B78)+(B149), (A)+(B78)+(B150), (A)+(B78)+(B151), (A)+(B78)+(B152), (A)+(B78)+(B153), (A)+(B78)+(B154), (A)+(B78)+(B155), (A)+(B78)+(B156), (A)+(B78)+(B157), (A)+(B78)+(B158), (A)+(B78)+(B159), (A)+(B78)+(B160), (A)+(B78)+(B161), (A)+(B78)+(B162), (A)+(B78)+(B164), (A)+(B78)+(B164), (A)+(B78)+(B165), (A)+(B78)+(B166), (A)+(B78)+(B167), (A)+(B78)+(B168), (A)+(B78)+(B169), (A)+(B78)+(B170), (A)+(B78)+(B171), (A)+(B78)+(B172), (A)+(B78)+(B173), (A)+(B78)+(B174), (A)+(B78)+(B175), (A)+(B78)+(B176), (A)+(B78)+(B177), (A)+(B78)+(B178), (A)+(B78)+(B179), (A)+(B78)+(B180), (A)+(B78)+(B181), (A)+(B78)+(B182), (A)+(B78)+(B183), (A)+(B78)+(B184), (A)+(B78)+(B185), (A)+(B78)+(B186), (A)+(B78)+(B187), (A)+(B78)+(B188), (A)+(B78)+(B189), (A)+(B78)+(B190), (A)+(B78)+(B191), (A)+(B78)+(B192), (A)+(B78)+(B193), (A)+(B78)+(B194), (A)+(B78)+(B195), (A)+(B78)+(B196), (A)+(B78)+(B197), (A)+(B78)+(B198), (A)+(B78)+(B199), (A)+(B78)+(B200), (A)+(B78)+(B201), (A)+(B78)+(B202), (A)+(B78)+(B203), (A)+(B78)+(B204), (A)+(B78)+(B205), (A)+(B78)+(B206), (A)+(B78)+(B207), (A)+(B78)+(B208), (A)+(B78)+(B209), (A)+(B78)+(B210), (A)+(B78)+(B211), (A)+(B78)+(B212), (A)+(B78)+(B213), (A)+(B78)+(B214), (A)+(B78)+(B215), (A)+(B78)+(B216), (A)+(B78)+(B217), (A)+(B78)+(B218), (A)+(B78)+(B219), (A)+(B78)+(B220), (A)+(B78)+(B221), (A)+(B78)+(B222), (A)+(B78)+(B223), (A)+(B78)+(B224), (A)+(B78)+(B225), (A)+(B78)+(B226), (A)+(B78)+(B227), (A)+(B78)+(B228), (A)+(B78)+(B229), (A)+(B78)+(B230), (A)+(B78)+(B231), (A)+(B78)+(B232), (A)+(B78)+(B233), (A)+(B78)+(B234), (A)+(B78)+(B235), (A)+(B78)+(B236), (A)+(B78)+(B237), (A)+(B78)+(B238), (A)+(B78)+(B239), (A)+(B78)+(B240), (A)+(B78)+(B241), (A)+(B78)+(B242), (A)+(B78)+(B243), (A)+(B78)+(B244), (A)+(B78)+(B245), (A)+(B78)+(B246), (A)+(B78)+(B247), (A)+(B78)+(B248), (A)+(B78)+(B249), (A)+(B78)+(B250), (A)+(B78)+(B251), (A)+(B78)+(B252), (A)+(B78)+(B253), (A)+(B78)+(B254), (A)+(B78)+(B255), (A)+(B78)+(B256), (A)+(B78)+(B257), (A)+(B78)+(B258), (A)+(B78)+(B259), (A)+(B78)+(B260), (A)+(B78)+(B261), (A)+(B78)+(B262), (A)+(B78)+(B263), (A)+(B78)+(B264), (A)+(B78)+(B265), (A)+(B78)+(B266), (A)+(B78)+(B267), (A)+(B78)+(B268), (A)+(B78)+(B269), (A)+(B78)+(B270), (A)+(B78)+(B271), (A)+(B78)+(B272), (A)+(B78)+(B273), (A)+(B78)+(B274), (A)+(B78)+(B275), (A)+(B78)+(B276), (A)+(B78)+(B277), (A)+(B78)+(B278), (A)+(B78)+(B279), (A)+(B78)+(B280), (A)+(B78)+(B281), (A)+(B78)+(B282), (A)+(B78)+(B283), (A)+(B78)+(B284), (A)+(B78)+(B285), (A)+(B78)+(B286), (A)+(B78)+(B287), (A)+(B78)+(B288), (A)+(B78)+(B289), (A)+(B78)+(B290), (A)+(B78)+(B291), (A)+(B78)+(B292), (A)+(B78)+(B293), (A)+(B78)+(B294), (A)+(B78)+(B295), (A)+(B78)+(B296), (A)+(B78)+(B297), (A)+(B78)+(B298), (A)+(B78)+(B299), (A)+(B78)+(B300), (A)+(B78)+(B301), (A)+(B78)+(B302), (A)+(B78)+(B303), (A)+(B78)+(B304), (A)+(B78)+(B305), (A)+(B78)+(B306), (A)+(B78)+(B307), (A)+(B78)+(B308), (A)+(B78)+(B309), (A)+(B78)+(B310), (A)+(B78)+(B311), (A)+(B78)+(B312), (A)+(B78)+(B313), (A)+(B78)+(B314), (A)+(B78)+(B315),

(A)+(B79)+(B80), (A)+(B79)+(B81), (A)+(B79)+(B82), (A)+(B79)+(B83), (A)+(B79)+(B84), (A)+(B79)+(B85), (A)+(B79)+(B86), (A)+(B79)+(B87), (A)+(B79)+(B88), (A)+(B79)+(B89), (A)+(B79)+(B90), (A)+(B79)+(B91), (A)+(B79)+(B92), (A)+(B79)+(B93), (A)+(B79)+(B94), (A)+(B79)+(B95), (A)+(B79)+(B96), (A)+(B79)+(B97), (A)+(B79)+(B98), (A)+(B79)+(B99), (A)+(B79)+(B100), (A)+(B79)+(B101), (A)+(B79)+(B102), (A)+(B79)+(B103), (A)+(B79)+(B104), (A)+(B79)+(B105), (A)+(B79)+(B106), (A)+(B79)+(B107), (A)+(B79)+(B108), (A)+(B79)+(B109), (A)+(B79)+(B110), (A)+(B79)+(B111), (A)+(B79)+(B112), (A)+(B79)+(B113), (A)+(B79)+(B114), (A)+(B79)+(B115), (A)+(B79)+(B116), (A)+(B79)+(B117), (A)+(B79)+(B118), (A)+(B79)+(B119), (A)+(B79)+(B120), (A)+(B79)+(B121), (A)+(B79)+(B122), (A)+(B79)+(B123), (A)+(B79)+(B124), (A)+(B79)+(B125), (A)+(B79)+(B126), (A)+(B79)+(B127), (A)+(B79)+(B128), (A)+(B79)+(B129), (A)+(B79)+(B130), (A)+(B79)+(B131), (A)+(B79)+(B132), (A)+(B79)+(B133), (A)+(B79)+(B134), (A)+(B79)+(B135), (A)+(B79)+(B136), (A)+(B79)+(B137), (A)+(B79)+(B138), (A)+(B79)+(B139), (A)+(B79)+(B140), (A)+(B79)+(B141), (A)+(B79)+(B142), (A)+(B79)+(B143), (A)+(B79)+(B144), (A)+(B79)+(B145), (A)+(B79)+(B146), (A)+(B79)+(B147), (A)+(B79)+(B148), (A)+(B79)+(B149), (A)+(B79)+(B150), (A)+(B79)+(B151), (A)+(B79)+(B152), (A)+(B79)+(B153), (A)+(B79)+(B154), (A)+(B79)+(B155), (A)+(B79)+(B156), (A)+(B79)+(B157), (A)+(B79)+(B158), (A)+(B79)+(B159), (A)+(B79)+(B160), (A)+(B79)+(B161), (A)+(B79)+(B162), (A)+(B79)+(B164), (A)+(B79)+(B164), (A)+(B79)+(B165), (A)+(B79)+(B166), (A)+(B79)+(B167), (A)+(B79)+(B168), (A)+(B79)+(B169), (A)+(B79)+(B170), (A)+(B79)+(B171), (A)+(B79)+(B172), (A)+(B79)+(B173), (A)+(B79)+(B174), (A)+(B79)+(B175), (A)+(B79)+(B176), (A)+(B79)+(B177), (A)+(B79)+(B178), (A)+(B79)+(B179), (A)+(B79)+(B180), (A)+(B79)+(B181), (A)+(B79)+(B182), (A)+(B79)+(B183), (A)+(B79)+(B184), (A)+(B79)+(B185), (A)+(B79)+(B186), (A)+(B79)+(B187), (A)+(B79)+(B188), (A)+(B79)+(B189), (A)+(B79)+(B190), (A)+(B79)+(B191), (A)+(B79)+(B192), (A)+(B79)+(B193), (A)+(B79)+(B194), (A)+(B79)+(B195), (A)+(B79)+(B196), (A)+(B79)+(B197), (A)+(B79)+(B198), (A)+(B79)+(B199), (A)+(B79)+(B200), (A)+(B79)+(B201), (A)+(B79)+(B202), (A)+(B79)+(B203), (A)+(B79)+(B204), (A)+(B79)+(B205), (A)+(B79)+(B206), (A)+(B79)+(B207), (A)+(B79)+(B208), (A)+(B79)+(B209), (A)+(B79)+(B210), (A)+(B79)+(B211), (A)+(B79)+(B212), (A)+(B79)+(B213), (A)+(B79)+(B214), (A)+(B79)+(B215), (A)+(B79)+(B216), (A)+(B79)+(B217), (A)+(B79)+(B218), (A)+(B79)+(B219), (A)+(B79)+(B220), (A)+(B79)+(B221), (A)+(B79)+(B222), (A)+(B79)+(B223), (A)+(B79)+(B224), (A)+(B79)+(B225), (A)+(B79)+(B226), (A)+(B79)+(B227), (A)+(B79)+(B228), (A)+(B79)+(B229), (A)+(B79)+(B230), (A)+(B79)+(B231), (A)+(B79)+(B232), (A)+(B79)+(B233), (A)+(B79)+(B234), (A)+(B79)+(B235), (A)+(B79)+(B236), (A)+(B79)+(B237), (A)+(B79)+(B238), (A)+(B79)+(B239), (A)+(B79)+(B240), (A)+(B79)+(B241), (A)+(B79)+(B242), (A)+(B79)+(B243), (A)+(B79)+(B244), (A)+(B79)+(B245), (A)+(B79)+(B246), (A)+(B79)+(B247), (A)+(B79)+(B248), (A)+(B79)+(B249), (A)+(B79)+(B250), (A)+(B79)+(B251), (A)+(B79)+(B252), (A)+(B79)+(B253), (A)+(B79)+(B254), (A)+(B79)+(B255), (A)+(B79)+(B256), (A)+(B79)+(B257), (A)+(B79)+(B258), (A)+(B79)+(B259), (A)+(B79)+(B260), (A)+(B79)+(B261), (A)+(B79)+(B262), (A)+(B79)+(B263), (A)+(B79)+(B264), (A)+(B79)+(B265), (A)+(B79)+(B266), (A)+(B79)+(B267), (A)+(B79)+(B268), (A)+(B79)+(B269), (A)+(B79)+(B270), (A)+(B79)+(B271), (A)+(B79)+(B272), (A)+(B79)+(B273), (A)+(B79)+(B274), (A)+(B79)+(B275), (A)+(B79)+(B276), (A)+(B79)+(B277), (A)+(B79)+(B278), (A)+(B79)+(B279), (A)+(B79)+(B280), (A)+(B79)+(B281), (A)+(B79)+(B282), (A)+(B79)+(B283), (A)+(B79)+(B284), (A)+(B79)+(B285), (A)+(B79)+(B286), (A)+(B79)+(B287), (A)+(B79)+(B288), (A)+(B79)+(B289), (A)+(B79)+(B290), (A)+(B79)+(B291), (A)+(B79)+(B292), (A)+(B79)+(B293), (A)+(B79)+(B294), (A)+(B79)+(B295), (A)+(B79)+(B296), (A)+(B79)+(B297), (A)+(B79)+(B298), (A)+(B79)+(B299), (A)+(B79)+(B300), (A)+(B79)+(B301), (A)+(B79)+(B302), (A)+(B79)+(B303), (A)+(B79)+(B304), (A)+(B79)+(B305), (A)+(B79)+(B306), (A)+(B79)+(B307), (A)+(B79)+(B308), (A)+(B79)+(B309), (A)+(B79)+(B310), (A)+(B79)+(B311), (A)+(B79)+(B312), (A)+(B79)+(B313), (A)+(B79)+(B314), (A)+(B79)+(B315),

(A)+(B80)+(B81), (A)+(B80)+(B82), (A)+(B80)+(B83), (A)+(B80)+(B84), (A)+(B80)+(B85), (A)+(B80)+(B86), (A)+(B80)+(B87), (A)+(B80)+(B88), (A)+(B80)+(B89), (A)+(B80)+(B90), (A)+(B80)+(B91), (A)+(B80)+(B92), (A)+(B80)+(B93), (A)+(B80)+(B94), (A)+(B80)+(B95), (A)+(B80)+(B96), (A)+(B80)+(B97), (A)+(B80)+(B98), (A)+(B80)+(B99), (A)+(B80)+(B100), (A)+(B80)+(B101), (A)+(B80)+(B102), (A)+(B80)+(B103), (A)+(B80)+(B104), (A)+(B80)+(B105), (A)+(B80)+(B106), (A)+(B80)+(B107), (A)+(B80)+(B108), (A)+(B80)+(B109), (A)+(B80)+(B110), (A)+(B80)+(B111), (A)+(B80)+(B112), (A)+(B80)+(B113), (A)+(B80)+(B114), (A)+(B80)+(B115), (A)+(B80)+(B116), (A)+(B80)+(B117), (A)+(B80)+(B118), (A)+(B80)+(B119), (A)+(B80)+(B120), (A)+(B80)+(B121), (A)+(B80)+(B122), (A)+(B80)+(B123), (A)+(B80)+(B124), (A)+(B80)+(B125), (A)+(B80)+(B126), (A)+(B80)+(B127), (A)+(B80)+(B128), (A)+(B80)+(B129), (A)+(B80)+(B130), (A)+(B80)+(B131), (A)+(B80)+(B132), (A)+(B80)+(B133), (A)+(B80)+(B134), (A)+(B80)+(B135), (A)+(B80)+(B136), (A)+(B80)+(B137), (A)+(B80)+(B138), (A)+(B80)+(B139), (A)+(B80)+(B140), (A)+(B80)+(B141), (A)+(B80)+(B142), (A)+(B80)+(B143), (A)+(B80)+(B144), (A)+(B80)+(B145), (A)+(B80)+(B146), (A)+(B80)+(B147), (A)+(B80)+(B148), (A)+(B80)+(B149), (A)+(B80)+(B150), (A)+(B80)+(B151), (A)+(B80)+(B152), (A)+(B80)+(B153), (A)+(B80)+(B154), (A)+(B80)+(B155), (A)+(B80)+(B156), (A)+(B80)+(B157), (A)+(B80)+(B158), (A)+(B80)+(B159), (A)+(B80)+(B160), (A)+(B80)+(B161), (A)+(B80)+(B162), (A)+(B80)+(B164), (A)+(B80)+(B164), (A)+(B80)+(B165), (A)+(B80)+(B166), (A)+(B80)+(B167), (A)+(B80)+(B168), (A)+(B80)+(B169), (A)+(B80)+(B170), (A)+(B80)+(B171), (A)+(B80)+(B172), (A)+(B80)+(B173), (A)+(B80)+(B174), (A)+(B80)+(B175), (A)+(B80)+(B176), (A)+(B80)+(B177), (A)+(B80)+(B178), (A)+(B80)+(B179), (A)+(B80)+(B180), (A)+(B80)+(B181), (A)+(B80)+(B182), (A)+(B80)+(B183), (A)+(B80)+(B184), (A)+(B80)+(B185), (A)+(B80)+(B186), (A)+(B80)+(B187), (A)+(B80)+(B188), (A)+(B80)+(B189), (A)+(B80)+(B190), (A)+(B80)+(B191), (A)+(B80)+(B192), (A)+(B80)+(B193), (A)+(B80)+(B194), (A)+(B80)+(B195), (A)+(B80)+(B196), (A)+(B80)+(B197), (A)+(B80)+(B198), (A)+(B80)+(B199), (A)+(B80)+(B200), (A)+(B80)+(B201), (A)+(B80)+(B202), (A)+(B80)+(B203), (A)+(B80)+(B204), (A)+(B80)+(B205), (A)+(B80)+(B206), (A)+(B80)+(B207), (A)+(B80)+(B208), (A)+(B80)+(B209), (A)+(B80)+(B210), (A)+(B80)+(B211), (A)+(B80)+(B212), (A)+(B80)+(B213), (A)+(B80)+(B214), (A)+(B80)+(B215), (A)+(B80)+(B216), (A)+(B80)+(B217), (A)+(B80)+(B218), (A)+(B80)+(B219), (A)+(B80)+(B220), (A)+(B80)+(B221), (A)+(B80)+(B222), (A)+(B80)+(B223), (A)+(B80)+(B224), (A)+(B80)+(B225), (A)+(B80)+(B226), (A)+(B80)+(B227), (A)+(B80)+(B228), (A)+(B80)+(B229), (A)+(B80)+(B230), (A)+(B80)+(B231), (A)+(B80)+(B232), (A)+(B80)+(B233), (A)+(B80)+(B234), (A)+(B80)+(B235), (A)+(B80)+(B236), (A)+(B80)+(B237), (A)+(B80)+(B238), (A)+(B80)+(B239), (A)+(B80)+(B240), (A)+(B80)+(B241), (A)+(B80)+(B242), (A)+(B80)+(B243), (A)+(B80)+(B244), (A)+(B80)+(B245), (A)+(B80)+(B246), (A)+(B80)+(B247), (A)+(B80)+(B248), (A)+(B80)+(B249), (A)+(B80)+(B250), (A)+(B80)+(B251), (A)+(B80)+(B252), (A)+(B80)+(B253), (A)+(B80)+(B254), (A)+(B80)+(B255), (A)+(B80)+(B256), (A)+(B80)+(B257), (A)+(B80)+(B258), (A)+(B80)+(B259), (A)+(B80)+(B260), (A)+(B80)+(B261), (A)+(B80)+(B262), (A)+(B80)+(B263), (A)+(B80)+(B264), (A)+(B80)+(B265), (A)+(B80)+(B266), (A)+(B80)+(B267), (A)+(B80)+(B268), (A)+(B80)+(B269), (A)+(B80)+(B270), (A)+(B80)+(B271), (A)+(B80)+(B272), (A)+(B80)+(B273), (A)+(B80)+(B274), (A)+(B80)+(B275), (A)+(B80)+(B276), (A)+(B80)+(B277), (A)+(B80)+(B278), (A)+(B80)+(B279), (A)+(B80)+(B280), (A)+(B80)+(B281), (A)+(B80)+(B282), (A)+(B80)+(B283), (A)+(B80)+(B284), (A)+(B80)+(B285), (A)+(B80)+(B286), (A)+(B80)+(B287), (A)+(B80)+(B288), (A)+(B80)+(B289), (A)+(B80)+(B290), (A)+(B80)+(B291), (A)+(B80)+(B292), (A)+(B80)+(B293), (A)+(B80)+(B294), (A)+(B80)+(B295), (A)+(B80)+(B296), (A)+(B80)+(B297), (A)+(B80)+(B298), (A)+(B80)+(B299), (A)+(B80)+(B300), (A)+(B80)+(B301), (A)+(B80)+(B302), (A)+(B80)+(B303), (A)+(B80)+(B304), (A)+(B80)+(B305), (A)+(B80)+(B306), (A)+(B80)+(B307), (A)+(B80)+(B308), (A)+(B80)+(B309), (A)+(B80)+(B310), (A)+(B80)+(B311), (A)+(B80)+(B312), (A)+(B80)+(B313), (A)+(B80)+(B314), (A)+(B80)+(B315),

(A)+(B81)+(B82), (A)+(B81)+(B83), (A)+(B81)+(B84), (A)+(B81)+(B85), (A)+(B81)+(B86), (A)+(B81)+(B87), (A)+(B81)+(B88), (A)+(B81)+(B89), (A)+(B81)+(B90), (A)+(B81)+(B91), (A)+(B81)+(B92), (A)+(B81)+(B93), (A)+(B81)+(B94), (A)+(B81)+(B95), (A)+(B81)+(B96), (A)+(B81)+(B97), (A)+(B81)+(B98), (A)+(B81)+(B99), (A)+(B81)+(B100), (A)+(B81)+(B101), (A)+(B81)+(B102), (A)+(B81)+(B103), (A)+(B81)+(B104), (A)+(B81)+(B105), (A)+(B81)+(B106), (A)+(B81)+(B107), (A)+(B81)+(B108), (A)+(B81)+(B109), (A)+(B81)+(B110), (A)+(B81)+(B111), (A)+(B81)+(B112), (A)+(B81)+(B113), (A)+(B81)+(B114), (A)+(B81)+(B115), (A)+(B81)+(B116), (A)+(B81)+(B117), (A)+(B81)+(B118), (A)+(B81)+(B119), (A)+(B81)+(B120), (A)+(B81)+(B121), (A)+(B81)+(B122), (A)+(B81)+(B123), (A)+(B81)+(B124), (A)+(B81)+(B125), (A)+(B81)+(B126), (A)+(B81)+(B127), (A)+(B81)+(B128), (A)+(B81)+(B129), (A)+(B81)+(B130), (A)+(B81)+(B131), (A)+(B81)+(B132), (A)+(B81)+(B133), (A)+(B81)+(B134), (A)+(B81)+(B135), (A)+(B81)+(B136), (A)+(B81)+(B137), (A)+(B81)+(B138), (A)+(B81)+(B139), (A)+(B81)+(B140), (A)+(B81)+(B141), (A)+(B81)+(B142), (A)+(B81)+(B143), (A)+(B81)+(B144), (A)+(B81)+(B145), (A)+(B81)+(B146), (A)+(B81)+(B147), (A)+(B81)+(B148), (A)+(B81)+(B149), (A)+(B81)+(B150), (A)+(B81)+(B151), (A)+(B81)+(B152), (A)+(B81)+(B153), (A)+(B81)+(B154), (A)+(B81)+(B155), (A)+(B81)+(B156), (A)+(B81)+(B157), (A)+(B81)+(B158), (A)+(B81)+(B159), (A)+(B81)+(B160), (A)+(B81)+(B161), (A)+(B81)+(B162), (A)+(B81)+(B164), (A)+(B81)+(B164), (A)+(B81)+(B165), (A)+(B81)+(B166), (A)+(B81)+(B167), (A)+(B81)+(B168), (A)+(B81)+(B169), (A)+(B81)+(B170), (A)+(B81)+(B171), (A)+(B81)+(B172), (A)+(B81)+(B173), (A)+(B81)+(B174), (A)+(B81)+(B175), (A)+(B81)+(B176), (A)+(B81)+(B177), (A)+(B81)+(B178), (A)+(B81)+(B179), (A)+(B81)+(B180), (A)+(B81)+(B181), (A)+(B81)+(B182), (A)+(B81)+(B183), (A)+(B81)+(B184), (A)+(B81)+(B185), (A)+(B81)+(B186), (A)+(B81)+(B187), (A)+(B81)+(B188), (A)+(B81)+(B189), (A)+(B81)+(B190), (A)+(B81)+(B191), (A)+(B81)+(B192), (A)+(B81)+(B193), (A)+(B81)+(B194), (A)+(B81)+(B195), (A)+(B81)+(B196), (A)+(B81)+(B197), (A)+(B81)+(B198), (A)+(B81)+(B199), (A)+(B81)+(B200), (A)+(B81)+(B201), (A)+(B81)+(B202), (A)+(B81)+(B203), (A)+(B81)+(B204), (A)+(B81)+(B205), (A)+(B81)+(B206), (A)+(B81)+(B207), (A)+(B81)+(B208), (A)+(B81)+(B209), (A)+(B81)+(B210), (A)+(B81)+(B211), (A)+(B81)+(B212), (A)+(B81)+(B213), (A)+(B81)+(B214), (A)+(B81)+(B215), (A)+(B81)+(B216), (A)+(B81)+(B217), (A)+(B81)+(B218), (A)+(B81)+(B219), (A)+(B81)+(B220), (A)+(B81)+(B221), (A)+(B81)+(B222), (A)+(B81)+(B223), (A)+(B81)+(B224), (A)+(B81)+(B225), (A)+(B81)+(B226), (A)+(B81)+(B227), (A)+(B81)+(B228), (A)+(B81)+(B229), (A)+(B81)+(B230), (A)+(B81)+(B231), (A)+(B81)+(B232), (A)+(B81)+(B233), (A)+(B81)+(B234), (A)+(B81)+(B235), (A)+(B81)+(B236), (A)+(B81)+(B237), (A)+(B81)+(B238), (A)+(B81)+(B239), (A)+(B81)+(B240), (A)+(B81)+(B241), (A)+(B81)+(B242), (A)+(B81)+(B243), (A)+(B81)+(B244), (A)+(B81)+(B245), (A)+(B81)+(B246), (A)+(B81)+(B247), (A)+(B81)+(B248), (A)+(B81)+(B249), (A)+(B81)+(B250), (A)+(B81)+(B251), (A)+(B81)+(B252), (A)+(B81)+(B253), (A)+(B81)+(B254), (A)+(B81)+(B255), (A)+(B81)+(B256), (A)+(B81)+(B257), (A)+(B81)+(B258), (A)+(B81)+(B259), (A)+(B81)+(B260), (A)+(B81)+(B261), (A)+(B81)+(B262), (A)+(B81)+(B263), (A)+(B81)+(B264), (A)+(B81)+(B265), (A)+(B81)+(B266), (A)+(B81)+(B267), (A)+(B81)+(B268), (A)+(B81)+(B269), (A)+(B81)+(B270), (A)+(B81)+(B271), (A)+(B81)+(B272), (A)+(B81)+(B273), (A)+(B81)+(B274), (A)+(B81)+(B275), (A)+(B81)+(B276), (A)+(B81)+(B277), (A)+(B81)+(B278), (A)+(B81)+(B279), (A)+(B81)+(B280), (A)+(B81)+(B281), (A)+(B81)+(B282), (A)+(B81)+(B283), (A)+(B81)+(B284), (A)+(B81)+(B285), (A)+(B81)+(B286), (A)+(B81)+(B287), (A)+(B81)+(B288), (A)+(B81)+(B289), (A)+(B81)+(B290), (A)+(B81)+(B291), (A)+(B81)+(B292), (A)+(B81)+(B293), (A)+(B81)+(B294), (A)+(B81)+(B295), (A)+(B81)+(B296), (A)+(B81)+(B297), (A)+(B81)+(B298), (A)+(B81)+(B299), (A)+(B81)+(B300), (A)+(B81)+(B301), (A)+(B81)+(B302), (A)+(B81)+(B303), (A)+(B81)+(B304), (A)+(B81)+(B305), (A)+(B81)+(B306), (A)+(B81)+(B307), (A)+(B81)+(B308), (A)+(B81)+(B309), (A)+(B81)+(B310), (A)+(B81)+(B311), (A)+(B81)+(B312), (A)+(B81)+(B313), (A)+(B81)+(B314), (A)+(B81)+(B315),

(A)+(B82)+(B83), (A)+(B82)+(B84), (A)+(B82)+(B85), (A)+(B82)+(B86), (A)+(B82)+(B87), (A)+(B82)+(B88), (A)+(B82)+(B89), (A)+(B82)+(B90), (A)+(B82)+(B91), (A)+(B82)+(B92), (A)+(B82)+(B93), (A)+(B82)+(B94), (A)+(B82)+(B95), (A)+(B82)+(B96), (A)+(B82)+(B97), (A)+(B82)+(B98), (A)+(B82)+(B99), (A)+(B82)+(B100), (A)+(B82)+(B101), (A)+(B82)+(B102), (A)+(B82)+(B103), (A)+(B82)+(B104), (A)+(B82)+(B105), (A)+(B82)+(B106), (A)+(B82)+(B107), (A)+(B82)+(B108), (A)+(B82)+(B109), (A)+(B82)+(B110), (A)+(B82)+(B111), (A)+(B82)+(B112), (A)+(B82)+(B113), (A)+(B82)+(B114), (A)+(B82)+(B115), (A)+(B82)+(B116), (A)+(B82)+(B117), (A)+(B82)+(B118), (A)+(B82)+(B119), (A)+(B82)+(B120), (A)+(B82)+(B121), (A)+(B82)+(B122), (A)+(B82)+(B123), (A)+(B82)+(B124), (A)+(B82)+(B125), (A)+(B82)+(B126), (A)+(B82)+(B127), (A)+(B82)+(B128), (A)+(B82)+(B129), (A)+(B82)+(B130), (A)+(B82)+(B131), (A)+(B82)+(B132), (A)+(B82)+(B133), (A)+(B82)+(B134), (A)+(B82)+(B135), (A)+(B82)+(B136), (A)+(B82)+(B137), (A)+(B82)+(B138), (A)+(B82)+(B139), (A)+(B82)+(B140), (A)+(B82)+(B141), (A)+(B82)+(B142), (A)+(B82)+(B143), (A)+(B82)+(B144), (A)+(B82)+(B145), (A)+(B82)+(B146), (A)+(B82)+(B147), (A)+(B82)+(B148), (A)+(B82)+(B149), (A)+(B82)+(B150), (A)+(B82)+(B151), (A)+(B82)+(B152), (A)+(B82)+(B153), (A)+(B82)+(B154), (A)+(B82)+(B155), (A)+(B82)+(B156), (A)+(B82)+(B157), (A)+(B82)+(B158), (A)+(B82)+(B159), (A)+(B82)+(B160), (A)+(B82)+(B161), (A)+(B82)+(B162), (A)+(B82)+(B164), (A)+(B82)+(B164), (A)+(B82)+(B165), (A)+(B82)+(B166), (A)+(B82)+(B167), (A)+(B82)+(B168), (A)+(B82)+(B169), (A)+(B82)+(B170), (A)+(B82)+(B171), (A)+(B82)+(B172), (A)+(B82)+(B173), (A)+(B82)+(B174), (A)+(B82)+(B175), (A)+(B82)+(B176), (A)+(B82)+(B177), (A)+(B82)+(B178), (A)+(B82)+(B179), (A)+(B82)+(B180), (A)+(B82)+(B181), (A)+(B82)+(B182), (A)+(B82)+(B183), (A)+(B82)+(B184), (A)+(B82)+(B185), (A)+(B82)+(B186), (A)+(B82)+(B187), (A)+(B82)+(B188), (A)+(B82)+(B189), (A)+(B82)+(B190), (A)+(B82)+(B191), (A)+(B82)+(B192), (A)+(B82)+(B193), (A)+(B82)+(B194), (A)+(B82)+(B195), (A)+(B82)+(B196), (A)+(B82)+(B197), (A)+(B82)+(B198), (A)+(B82)+(B199), (A)+(B82)+(B200), (A)+(B82)+(B201), (A)+(B82)+(B202), (A)+(B82)+(B203), (A)+(B82)+(B204), (A)+(B82)+(B205), (A)+(B82)+(B206), (A)+(B82)+(B207), (A)+(B82)+(B208), (A)+(B82)+(B209), (A)+(B82)+(B210), (A)+(B82)+(B211), (A)+(B82)+(B212), (A)+(B82)+(B213), (A)+(B82)+(B214), (A)+(B82)+(B215), (A)+(B82)+(B216), (A)+(B82)+(B217), (A)+(B82)+(B218), (A)+(B82)+(B219), (A)+(B82)+(B220), (A)+(B82)+(B221), (A)+(B82)+(B222), (A)+(B82)+(B223), (A)+(B82)+(B224), (A)+(B82)+(B225), (A)+(B82)+(B226), (A)+(B82)+(B227), (A)+(B82)+(B228), (A)+(B82)+(B229), (A)+(B82)+(B230), (A)+(B82)+(B231), (A)+(B82)+(B232), (A)+(B82)+(B233), (A)+(B82)+(B234), (A)+(B82)+(B235), (A)+(B82)+(B236), (A)+(B82)+(B237), (A)+(B82)+(B238), (A)+(B82)+(B239), (A)+(B82)+(B240), (A)+(B82)+(B241), (A)+(B82)+(B242), (A)+(B82)+(B243), (A)+(B82)+(B244), (A)+(B82)+(B245), (A)+(B82)+(B246), (A)+(B82)+(B247), (A)+(B82)+(B248), (A)+(B82)+(B249), (A)+(B82)+(B250), (A)+(B82)+(B251), (A)+(B82)+(B252), (A)+(B82)+(B253), (A)+(B82)+(B254), (A)+(B82)+(B255), (A)+(B82)+(B256), (A)+(B82)+(B257), (A)+(B82)+(B258), (A)+(B82)+(B259), (A)+(B82)+(B260), (A)+(B82)+(B261), (A)+(B82)+(B262), (A)+(B82)+(B263), (A)+(B82)+(B264), (A)+(B82)+(B265), (A)+(B82)+(B266), (A)+(B82)+(B267), (A)+(B82)+(B268), (A)+(B82)+(B269), (A)+(B82)+(B270), (A)+(B82)+(B271), (A)+(B82)+(B272), (A)+(B82)+(B273), (A)+(B82)+(B274), (A)+(B82)+(B275), (A)+(B82)+(B276), (A)+(B82)+(B277), (A)+(B82)+(B278), (A)+(B82)+(B279), (A)+(B82)+(B280), (A)+(B82)+(B281), (A)+(B82)+(B282), (A)+(B82)+(B283), (A)+(B82)+(B284), (A)+(B82)+(B285), (A)+(B82)+(B286), (A)+(B82)+(B287), (A)+(B82)+(B288), (A)+(B82)+(B289), (A)+(B82)+(B290), (A)+(B82)+(B291), (A)+(B82)+(B292), (A)+(B82)+(B293), (A)+(B82)+(B294), (A)+(B82)+(B295), (A)+(B82)+(B296), (A)+(B82)+(B297), (A)+(B82)+(B298), (A)+(B82)+(B299), (A)+(B82)+(B300), (A)+(B82)+(B301), (A)+(B82)+(B302), (A)+(B82)+(B303), (A)+(B82)+(B304), (A)+(B82)+(B305), (A)+(B82)+(B306), (A)+(B82)+(B307), (A)+(B82)+(B308), (A)+(B82)+(B309), (A)+(B82)+(B310), (A)+(B82)+(B311), (A)+(B82)+(B312), (A)+(B82)+(B313), (A)+(B82)+(B314), (A)+(B82)+(B315),

(A)+(B83)+(B84), (A)+(B83)+(B85), (A)+(B83)+(B86), (A)+(B83)+(B87), (A)+(B83)+(B88), (A)+(B83)+(B89), (A)+(B83)+(B90), (A)+(B83)+(B91), (A)+(B83)+(B92), (A)+(B83)+(B93), (A)+(B83)+(B94), (A)+(B83)+(B95), (A)+(B83)+(B96), (A)+(B83)+(B97), (A)+(B83)+(B98), (A)+(B83)+(B99), (A)+(B83)+(B100), (A)+(B83)+(B101), (A)+(B83)+(B102), (A)+(B83)+(B103), (A)+(B83)+(B104), (A)+(B83)+(B105), (A)+(B83)+(B106), (A)+(B83)+(B107), (A)+(B83)+(B108), (A)+(B83)+(B109), (A)+(B83)+(B110), (A)+(B83)+(B111), (A)+(B83)+(B112), (A)+(B83)+(B113), (A)+(B83)+(B114), (A)+(B83)+(B115), (A)+(B83)+(B116), (A)+(B83)+(B117), (A)+(B83)+(B118), (A)+(B83)+(B119), (A)+(B83)+(B120), (A)+(B83)+(B121), (A)+(B83)+(B122), (A)+(B83)+(B123), (A)+(B83)+(B124), (A)+(B83)+(B125), (A)+(B83)+(B126), (A)+(B83)+(B127), (A)+(B83)+(B128), (A)+(B83)+(B129), (A)+(B83)+(B130), (A)+(B83)+(B131), (A)+(B83)+(B132), (A)+(B83)+(B133), (A)+(B83)+(B134), (A)+(B83)+(B135), (A)+(B83)+(B136), (A)+(B83)+(B137), (A)+(B83)+(B138), (A)+(B83)+(B139), (A)+(B83)+(B140), (A)+(B83)+(B141), (A)+(B83)+(B142), (A)+(B83)+(B143), (A)+(B83)+(B144), (A)+(B83)+(B145), (A)+(B83)+(B146), (A)+(B83)+(B147), (A)+(B83)+(B148), (A)+(B83)+(B149), (A)+(B83)+(B150), (A)+(B83)+(B151), (A)+(B83)+(B152), (A)+(B83)+(B153), (A)+(B83)+(B154), (A)+(B83)+(B155), (A)+(B83)+(B156), (A)+(B83)+(B157), (A)+(B83)+(B158), (A)+(B83)+(B159), (A)+(B83)+(B160), (A)+(B83)+(B161), (A)+(B83)+(B162), (A)+(B83)+(B164), (A)+(B83)+(B164), (A)+(B83)+(B165), (A)+(B83)+(B166), (A)+(B83)+(B167), (A)+(B83)+(B168), (A)+(B83)+(B169), (A)+(B83)+(B170), (A)+(B83)+(B171), (A)+(B83)+(B172), (A)+(B83)+(B173), (A)+(B83)+(B174), (A)+(B83)+(B175), (A)+(B83)+(B176), (A)+(B83)+(B177), (A)+(B83)+(B178), (A)+(B83)+(B179), (A)+(B83)+(B180), (A)+(B83)+(B181), (A)+(B83)+(B182), (A)+(B83)+(B183), (A)+(B83)+(B184), (A)+(B83)+(B185), (A)+(B83)+(B186), (A)+(B83)+(B187), (A)+(B83)+(B188), (A)+(B83)+(B189), (A)+(B83)+(B190), (A)+(B83)+(B191), (A)+(B83)+(B192), (A)+(B83)+(B193), (A)+(B83)+(B194), (A)+(B83)+(B195), (A)+(B83)+(B196), (A)+(B83)+(B197), (A)+(B83)+(B198), (A)+(B83)+(B199), (A)+(B83)+(B200), (A)+(B83)+(B201), (A)+(B83)+(B202), (A)+(B83)+(B203), (A)+(B83)+(B204), (A)+(B83)+(B205), (A)+(B83)+(B206), (A)+(B83)+(B207), (A)+(B83)+(B208), (A)+(B83)+(B209), (A)+(B83)+(B210), (A)+(B83)+(B211), (A)+(B83)+(B212), (A)+(B83)+(B213), (A)+(B83)+(B214), (A)+(B83)+(B215), (A)+(B83)+(B216), (A)+(B83)+(B217), (A)+(B83)+(B218), (A)+(B83)+(B219), (A)+(B83)+(B220), (A)+(B83)+(B221), (A)+(B83)+(B222), (A)+(B83)+(B223), (A)+(B83)+(B224), (A)+(B83)+(B225), (A)+(B83)+(B226), (A)+(B83)+(B227), (A)+(B83)+(B228), (A)+(B83)+(B229), (A)+(B83)+(B230), (A)+(B83)+(B231), (A)+(B83)+(B232), (A)+(B83)+(B233), (A)+(B83)+(B234), (A)+(B83)+(B235), (A)+(B83)+(B236), (A)+(B83)+(B237), (A)+(B83)+(B238), (A)+(B83)+(B239), (A)+(B83)+(B240), (A)+(B83)+(B241), (A)+(B83)+(B242), (A)+(B83)+(B243), (A)+(B83)+(B244), (A)+(B83)+(B245), (A)+(B83)+(B246), (A)+(B83)+(B247), (A)+(B83)+(B248), (A)+(B83)+(B249), (A)+(B83)+(B250), (A)+(B83)+(B251), (A)+(B83)+(B252), (A)+(B83)+(B253), (A)+(B83)+(B254), (A)+(B83)+(B255), (A)+(B83)+(B256), (A)+(B83)+(B257), (A)+(B83)+(B258), (A)+(B83)+(B259), (A)+(B83)+(B260), (A)+(B83)+(B261), (A)+(B83)+(B262), (A)+(B83)+(B263), (A)+(B83)+(B264), (A)+(B83)+(B265), (A)+(B83)+(B266), (A)+(B83)+(B267), (A)+(B83)+(B268), (A)+(B83)+(B269), (A)+(B83)+(B270), (A)+(B83)+(B271), (A)+(B83)+(B272), (A)+(B83)+(B273), (A)+(B83)+(B274), (A)+(B83)+(B275), (A)+(B83)+(B276), (A)+(B83)+(B277), (A)+(B83)+(B278), (A)+(B83)+(B279), (A)+(B83)+(B280), (A)+(B83)+(B281), (A)+(B83)+(B282), (A)+(B83)+(B283), (A)+(B83)+(B284), (A)+(B83)+(B285), (A)+(B83)+(B286), (A)+(B83)+(B287), (A)+(B83)+(B288), (A)+(B83)+(B289), (A)+(B83)+(B290), (A)+(B83)+(B291), (A)+(B83)+(B292), (A)+(B83)+(B293), (A)+(B83)+(B294), (A)+(B83)+(B295), (A)+(B83)+(B296), (A)+(B83)+(B297), (A)+(B83)+(B298), (A)+(B83)+(B299), (A)+(B83)+(B300), (A)+(B83)+(B301), (A)+(B83)+(B302), (A)+(B83)+(B303), (A)+(B83)+(B304), (A)+(B83)+(B305), (A)+(B83)+(B306), (A)+(B83)+(B307), (A)+(B83)+(B308), (A)+(B83)+(B309), (A)+(B83)+(B310), (A)+(B83)+(B311), (A)+(B83)+(B312), (A)+(B83)+(B313), (A)+(B83)+(B314), (A)+(B83)+(B315),

(A)+(B84)+(B85), (A)+(B84)+(B86), (A)+(B84)+(B87), (A)+(B84)+(B88), (A)+(B84)+(B89), (A)+(B84)+(B90), (A)+(B84)+(B91), (A)+(B84)+(B92), (A)+(B84)+(B93), (A)+(B84)+(B94), (A)+(B84)+(B95), (A)+(B84)+(B96), (A)+(B84)+(B97), (A)+(B84)+(B98), (A)+(B84)+(B99), (A)+(B84)+(B100), (A)+(B84)+(B101), (A)+(B84)+(B102), (A)+(B84)+(B103), (A)+(B84)+(B104), (A)+(B84)+(B105), (A)+(B84)+(B106), (A)+(B84)+(B107), (A)+(B84)+(B108), (A)+(B84)+(B109), (A)+(B84)+(B110), (A)+(B84)+(B111), (A)+(B84)+(B112), (A)+(B84)+(B113), (A)+(B84)+(B114), (A)+(B84)+(B115), (A)+(B84)+(B116), (A)+(B84)+(B117), (A)+(B84)+(B118), (A)+(B84)+(B119), (A)+(B84)+(B120), (A)+(B84)+(B121), (A)+(B84)+(B122), (A)+(B84)+(B123), (A)+(B84)+(B124), (A)+(B84)+(B125), (A)+(B84)+(B126), (A)+(B84)+(B127), (A)+(B84)+(B128), (A)+(B84)+(B129), (A)+(B84)+(B130), (A)+(B84)+(B131), (A)+(B84)+(B132), (A)+(B84)+(B133), (A)+(B84)+(B134), (A)+(B84)+(B135), (A)+(B84)+(B136), (A)+(B84)+(B137), (A)+(B84)+(B138), (A)+(B84)+(B139), (A)+(B84)+(B140), (A)+(B84)+(B141), (A)+(B84)+(B142), (A)+(B84)+(B143), (A)+(B84)+(B144), (A)+(B84)+(B145), (A)+(B84)+(B146), (A)+(B84)+(B147), (A)+(B84)+(B148), (A)+(B84)+(B149), (A)+(B84)+(B150), (A)+(B84)+(B151), (A)+(B84)+(B152), (A)+(B84)+(B153), (A)+(B84)+(B154), (A)+(B84)+(B155), (A)+(B84)+(B156), (A)+(B84)+(B157), (A)+(B84)+(B158), (A)+(B84)+(B159), (A)+(B84)+(B160), (A)+(B84)+(B161), (A)+(B84)+(B162), (A)+(B84)+(B164), (A)+(B84)+(B164), (A)+(B84)+(B165), (A)+(B84)+(B166), (A)+(B84)+(B167), (A)+(B84)+(B168), (A)+(B84)+(B169), (A)+(B84)+(B170), (A)+(B84)+(B171), (A)+(B84)+(B172), (A)+(B84)+(B173), (A)+(B84)+(B174), (A)+(B84)+(B175), (A)+(B84)+(B176), (A)+(B84)+(B177), (A)+(B84)+(B178), (A)+(B84)+(B179), (A)+(B84)+(B180), (A)+(B84)+(B181), (A)+(B84)+(B182), (A)+(B84)+(B183), (A)+(B84)+(B184), (A)+(B84)+(B185), (A)+(B84)+(B186), (A)+(B84)+(B187), (A)+(B84)+(B188), (A)+(B84)+(B189), (A)+(B84)+(B190), (A)+(B84)+(B191), (A)+(B84)+(B192), (A)+(B84)+(B193), (A)+(B84)+(B194), (A)+(B84)+(B195), (A)+(B84)+(B196), (A)+(B84)+(B197), (A)+(B84)+(B198), (A)+(B84)+(B199), (A)+(B84)+(B200), (A)+(B84)+(B201), (A)+(B84)+(B202), (A)+(B84)+(B203), (A)+(B84)+(B204), (A)+(B84)+(B205), (A)+(B84)+(B206), (A)+(B84)+(B207), (A)+(B84)+(B208), (A)+(B84)+(B209), (A)+(B84)+(B210), (A)+(B84)+(B211), (A)+(B84)+(B212), (A)+(B84)+(B213), (A)+(B84)+(B214), (A)+(B84)+(B215), (A)+(B84)+(B216), (A)+(B84)+(B217), (A)+(B84)+(B218), (A)+(B84)+(B219), (A)+(B84)+(B220), (A)+(B84)+(B221), (A)+(B84)+(B222), (A)+(B84)+(B223), (A)+(B84)+(B224), (A)+(B84)+(B225), (A)+(B84)+(B226), (A)+(B84)+(B227), (A)+(B84)+(B228), (A)+(B84)+(B229), (A)+(B84)+(B230), (A)+(B84)+(B231), (A)+(B84)+(B232), (A)+(B84)+(B233), (A)+(B84)+(B234), (A)+(B84)+(B235), (A)+(B84)+(B236), (A)+(B84)+(B237), (A)+(B84)+(B238), (A)+(B84)+(B239), (A)+(B84)+(B240), (A)+(B84)+(B241), (A)+(B84)+(B242), (A)+(B84)+(B243), (A)+(B84)+(B244), (A)+(B84)+(B245), (A)+(B84)+(B246), (A)+(B84)+(B247), (A)+(B84)+(B248), (A)+(B84)+(B249), (A)+(B84)+(B250), (A)+(B84)+(B251), (A)+(B84)+(B252), (A)+(B84)+(B253), (A)+(B84)+(B254), (A)+(B84)+(B255), (A)+(B84)+(B256), (A)+(B84)+(B257), (A)+(B84)+(B258), (A)+(B84)+(B259), (A)+(B84)+(B260), (A)+(B84)+(B261), (A)+(B84)+(B262), (A)+(B84)+(B263), (A)+(B84)+(B264), (A)+(B84)+(B265), (A)+(B84)+(B266), (A)+(B84)+(B267), (A)+(B84)+(B268), (A)+(B84)+(B269), (A)+(B84)+(B270), (A)+(B84)+(B271), (A)+(B84)+(B272), (A)+(B84)+(B273), (A)+(B84)+(B274), (A)+(B84)+(B275), (A)+(B84)+(B276), (A)+(B84)+(B277), (A)+(B84)+(B278), (A)+(B84)+(B279), (A)+(B84)+(B280), (A)+(B84)+(B281), (A)+(B84)+(B282), (A)+(B84)+(B283), (A)+(B84)+(B284), (A)+(B84)+(B285), (A)+(B84)+(B286), (A)+(B84)+(B287), (A)+(B84)+(B288), (A)+(B84)+(B289), (A)+(B84)+(B290), (A)+(B84)+(B291), (A)+(B84)+(B292), (A)+(B84)+(B293), (A)+(B84)+(B294), (A)+(B84)+(B295), (A)+(B84)+(B296), (A)+(B84)+(B297), (A)+(B84)+(B298), (A)+(B84)+(B299), (A)+(B84)+(B300), (A)+(B84)+(B301), (A)+(B84)+(B302), (A)+(B84)+(B303), (A)+(B84)+(B304), (A)+(B84)+(B305), (A)+(B84)+(B306), (A)+(B84)+(B307), (A)+(B84)+(B308), (A)+(B84)+(B309), (A)+(B84)+(B310), (A)+(B84)+(B311), (A)+(B84)+(B312), (A)+(B84)+(B313), (A)+(B84)+(B314), (A)+(B84)+(B315),

(A)+(B85)+(B86), (A)+(B85)+(B87), (A)+(B85)+(B88), (A)+(B85)+(B89), (A)+(B85)+(B90), (A)+(B85)+(B91), (A)+(B85)+(B92), (A)+(B85)+(B93), (A)+(B85)+(B94), (A)+(B85)+(B95), (A)+(B85)+(B96), (A)+(B85)+(B97), (A)+(B85)+(B98), (A)+(B85)+(B99), (A)+(B85)+(B100), (A)+(B85)+(B101), (A)+(B85)+(B102), (A)+(B85)+(B103), (A)+(B85)+(B104), (A)+(B85)+(B105), (A)+(B85)+(B106), (A)+(B85)+(B107), (A)+(B85)+(B108), (A)+(B85)+(B109), (A)+(B85)+(B110), (A)+(B85)+(B111), (A)+(B85)+(B112), (A)+(B85)+(B113), (A)+(B85)+(B114), (A)+(B85)+(B115), (A)+(B85)+(B116), (A)+(B85)+(B117), (A)+(B85)+(B118), (A)+(B85)+(B119), (A)+(B85)+(B120), (A)+(B85)+(B121), (A)+(B85)+(B122), (A)+(B85)+(B123), (A)+(B85)+(B124), (A)+(B85)+(B125), (A)+(B85)+(B126), (A)+(B85)+(B127), (A)+(B85)+(B128), (A)+(B85)+(B129), (A)+(B85)+(B130), (A)+(B85)+(B131), (A)+(B85)+(B132), (A)+(B85)+(B133), (A)+(B85)+(B134), (A)+(B85)+(B135), (A)+(B85)+(B136), (A)+(B85)+(B137), (A)+(B85)+(B138), (A)+(B85)+(B139), (A)+(B85)+(B140), (A)+(B85)+(B141), (A)+(B85)+(B142), (A)+(B85)+(B143), (A)+(B85)+(B144), (A)+(B85)+(B145), (A)+(B85)+(B146), (A)+(B85)+(B147), (A)+(B85)+(B148), (A)+(B85)+(B149), (A)+(B85)+(B150), (A)+(B85)+(B151), (A)+(B85)+(B152), (A)+(B85)+(B153), (A)+(B85)+(B154), (A)+(B85)+(B155), (A)+(B85)+(B156), (A)+(B85)+(B157), (A)+(B85)+(B158), (A)+(B85)+(B159), (A)+(B85)+(B160), (A)+(B85)+(B161), (A)+(B85)+(B162), (A)+(B85)+(B164), (A)+(B85)+(B164), (A)+(B85)+(B165), (A)+(B85)+(B166), (A)+(B85)+(B167), (A)+(B85)+(B168), (A)+(B85)+(B169), (A)+(B85)+(B170), (A)+(B85)+(B171), (A)+(B85)+(B172), (A)+(B85)+(B173), (A)+(B85)+(B174), (A)+(B85)+(B175), (A)+(B85)+(B176), (A)+(B85)+(B177), (A)+(B85)+(B178), (A)+(B85)+(B179), (A)+(B85)+(B180), (A)+(B85)+(B181), (A)+(B85)+(B182), (A)+(B85)+(B183), (A)+(B85)+(B184), (A)+(B85)+(B185), (A)+(B85)+(B186), (A)+(B85)+(B187), (A)+(B85)+(B188), (A)+(B85)+(B189), (A)+(B85)+(B190), (A)+(B85)+(B191), (A)+(B85)+(B192), (A)+(B85)+(B193), (A)+(B85)+(B194), (A)+(B85)+(B195), (A)+(B85)+(B196), (A)+(B85)+(B197), (A)+(B85)+(B198), (A)+(B85)+(B199), (A)+(B85)+(B200), (A)+(B85)+(B201), (A)+(B85)+(B202), (A)+(B85)+(B203), (A)+(B85)+(B204), (A)+(B85)+(B205), (A)+(B85)+(B206), (A)+(B85)+(B207), (A)+(B85)+(B208), (A)+(B85)+(B209), (A)+(B85)+(B210), (A)+(B85)+(B211), (A)+(B85)+(B212), (A)+(B85)+(B213), (A)+(B85)+(B214), (A)+(B85)+(B215), (A)+(B85)+(B216), (A)+(B85)+(B217), (A)+(B85)+(B218), (A)+(B85)+(B219), (A)+(B85)+(B220), (A)+(B85)+(B221), (A)+(B85)+(B222), (A)+(B85)+(B223), (A)+(B85)+(B224), (A)+(B85)+(B225), (A)+(B85)+(B226), (A)+(B85)+(B227), (A)+(B85)+(B228), (A)+(B85)+(B229), (A)+(B85)+(B230), (A)+(B85)+(B231), (A)+(B85)+(B232), (A)+(B85)+(B233), (A)+(B85)+(B234), (A)+(B85)+(B235), (A)+(B85)+(B236), (A)+(B85)+(B237), (A)+(B85)+(B238), (A)+(B85)+(B239), (A)+(B85)+(B240), (A)+(B85)+(B241), (A)+(B85)+(B242), (A)+(B85)+(B243), (A)+(B85)+(B244), (A)+(B85)+(B245), (A)+(B85)+(B246), (A)+(B85)+(B247), (A)+(B85)+(B248), (A)+(B85)+(B249), (A)+(B85)+(B250), (A)+(B85)+(B251), (A)+(B85)+(B252), (A)+(B85)+(B253), (A)+(B85)+(B254), (A)+(B85)+(B255), (A)+(B85)+(B256), (A)+(B85)+(B257), (A)+(B85)+(B258), (A)+(B85)+(B259), (A)+(B85)+(B260), (A)+(B85)+(B261), (A)+(B85)+(B262), (A)+(B85)+(B263), (A)+(B85)+(B264), (A)+(B85)+(B265), (A)+(B85)+(B266), (A)+(B85)+(B267), (A)+(B85)+(B268), (A)+(B85)+(B269), (A)+(B85)+(B270), (A)+(B85)+(B271), (A)+(B85)+(B272), (A)+(B85)+(B273), (A)+(B85)+(B274), (A)+(B85)+(B275), (A)+(B85)+(B276), (A)+(B85)+(B277), (A)+(B85)+(B278), (A)+(B85)+(B279), (A)+(B85)+(B280), (A)+(B85)+(B281), (A)+(B85)+(B282), (A)+(B85)+(B283), (A)+(B85)+(B284), (A)+(B85)+(B285), (A)+(B85)+(B286), (A)+(B85)+(B287), (A)+(B85)+(B288), (A)+(B85)+(B289), (A)+(B85)+(B290), (A)+(B85)+(B291), (A)+(B85)+(B292), (A)+(B85)+(B293), (A)+(B85)+(B294), (A)+(B85)+(B295), (A)+(B85)+(B296), (A)+(B85)+(B297), (A)+(B85)+(B298), (A)+(B85)+(B299), (A)+(B85)+(B300), (A)+(B85)+(B301), (A)+(B85)+(B302), (A)+(B85)+(B303), (A)+(B85)+(B304), (A)+(B85)+(B305), (A)+(B85)+(B306), (A)+(B85)+(B307), (A)+(B85)+(B308), (A)+(B85)+(B309), (A)+(B85)+(B310), (A)+(B85)+(B311), (A)+(B85)+(B312), (A)+(B85)+(B313), (A)+(B85)+(B314), (A)+(B85)+(B315),

(A)+(B86)+(B87), (A)+(B86)+(B88), (A)+(B86)+(B89), (A)+(B86)+(B90), (A)+(B86)+(B91), (A)+(B86)+(B92), (A)+(B86)+(B93), (A)+(B86)+(B94), (A)+(B86)+(B95), (A)+(B86)+(B96), (A)+(B86)+(B97), (A)+(B86)+(B98), (A)+(B86)+(B99), (A)+(B86)+(B100), (A)+(B86)+(B101), (A)+(B86)+(B102), (A)+(B86)+(B103), (A)+(B86)+(B104), (A)+(B86)+(B105), (A)+(B86)+(B106), (A)+(B86)+(B107), (A)+(B86)+(B108), (A)+(B86)+(B109), (A)+(B86)+(B110), (A)+(B86)+(B111), (A)+(B86)+(B112), (A)+(B86)+(B113), (A)+(B86)+(B114), (A)+(B86)+(B115), (A)+(B86)+(B116), (A)+(B86)+(B117), (A)+(B86)+(B118), (A)+(B86)+(B119), (A)+(B86)+(B120), (A)+(B86)+(B121), (A)+(B86)+(B122), (A)+(B86)+(B123), (A)+(B86)+(B124), (A)+(B86)+(B125), (A)+(B86)+(B126), (A)+(B86)+(B127), (A)+(B86)+(B128), (A)+(B86)+(B129), (A)+(B86)+(B130), (A)+(B86)+(B131), (A)+(B86)+(B132), (A)+(B86)+(B133), (A)+(B86)+(B134), (A)+(B86)+(B135), (A)+(B86)+(B136), (A)+(B86)+(B137), (A)+(B86)+(B138), (A)+(B86)+(B139), (A)+(B86)+(B140), (A)+(B86)+(B141), (A)+(B86)+(B142), (A)+(B86)+(B143), (A)+(B86)+(B144), (A)+(B86)+(B145), (A)+(B86)+(B146), (A)+(B86)+(B147), (A)+(B86)+(B148), (A)+(B86)+(B149), (A)+(B86)+(B150), (A)+(B86)+(B151), (A)+(B86)+(B152), (A)+(B86)+(B153), (A)+(B86)+(B154), (A)+(B86)+(B155), (A)+(B86)+(B156), (A)+(B86)+(B157), (A)+(B86)+(B158), (A)+(B86)+(B159), (A)+(B86)+(B160), (A)+(B86)+(B161), (A)+(B86)+(B162), (A)+(B86)+(B164), (A)+(B86)+(B164), (A)+(B86)+(B165), (A)+(B86)+(B166), (A)+(B86)+(B167), (A)+(B86)+(B168), (A)+(B86)+(B169), (A)+(B86)+(B170), (A)+(B86)+(B171), (A)+(B86)+(B172), (A)+(B86)+(B173), (A)+(B86)+(B174), (A)+(B86)+(B175), (A)+(B86)+(B176), (A)+(B86)+(B177), (A)+(B86)+(B178), (A)+(B86)+(B179), (A)+(B86)+(B180), (A)+(B86)+(B181), (A)+(B86)+(B182), (A)+(B86)+(B183), (A)+(B86)+(B184), (A)+(B86)+(B185), (A)+(B86)+(B186), (A)+(B86)+(B187), (A)+(B86)+(B188), (A)+(B86)+(B189), (A)+(B86)+(B190), (A)+(B86)+(B191), (A)+(B86)+(B192), (A)+(B86)+(B193), (A)+(B86)+(B194), (A)+(B86)+(B195), (A)+(B86)+(B196), (A)+(B86)+(B197), (A)+(B86)+(B198), (A)+(B86)+(B199), (A)+(B86)+(B200), (A)+(B86)+(B201), (A)+(B86)+(B202), (A)+(B86)+(B203), (A)+(B86)+(B204), (A)+(B86)+(B205), (A)+(B86)+(B206), (A)+(B86)+(B207), (A)+(B86)+(B208), (A)+(B86)+(B209), (A)+(B86)+(B210), (A)+(B86)+(B211), (A)+(B86)+(B212), (A)+(B86)+(B213), (A)+(B86)+(B214), (A)+(B86)+(B215), (A)+(B86)+(B216), (A)+(B86)+(B217), (A)+(B86)+(B218), (A)+(B86)+(B219), (A)+(B86)+(B220), (A)+(B86)+(B221), (A)+(B86)+(B222), (A)+(B86)+(B223), (A)+(B86)+(B224), (A)+(B86)+(B225), (A)+(B86)+(B226), (A)+(B86)+(B227), (A)+(B86)+(B228), (A)+(B86)+(B229), (A)+(B86)+(B230), (A)+(B86)+(B231), (A)+(B86)+(B232), (A)+(B86)+(B233), (A)+(B86)+(B234), (A)+(B86)+(B235), (A)+(B86)+(B236), (A)+(B86)+(B237), (A)+(B86)+(B238), (A)+(B86)+(B239), (A)+(B86)+(B240), (A)+(B86)+(B241), (A)+(B86)+(B242), (A)+(B86)+(B243), (A)+(B86)+(B244), (A)+(B86)+(B245), (A)+(B86)+(B246), (A)+(B86)+(B247), (A)+(B86)+(B248), (A)+(B86)+(B249), (A)+(B86)+(B250), (A)+(B86)+(B251), (A)+(B86)+(B252), (A)+(B86)+(B253), (A)+(B86)+(B254), (A)+(B86)+(B255), (A)+(B86)+(B256), (A)+(B86)+(B257), (A)+(B86)+(B258), (A)+(B86)+(B259), (A)+(B86)+(B260), (A)+(B86)+(B261), (A)+(B86)+(B262), (A)+(B86)+(B263), (A)+(B86)+(B264), (A)+(B86)+(B265), (A)+(B86)+(B266), (A)+(B86)+(B267), (A)+(B86)+(B268), (A)+(B86)+(B269), (A)+(B86)+(B270), (A)+(B86)+(B271), (A)+(B86)+(B272), (A)+(B86)+(B273), (A)+(B86)+(B274), (A)+(B86)+(B275), (A)+(B86)+(B276), (A)+(B86)+(B277), (A)+(B86)+(B278), (A)+(B86)+(B279), (A)+(B86)+(B280), (A)+(B86)+(B281), (A)+(B86)+(B282), (A)+(B86)+(B283), (A)+(B86)+(B284), (A)+(B86)+(B285), (A)+(B86)+(B286), (A)+(B86)+(B287), (A)+(B86)+(B288), (A)+(B86)+(B289), (A)+(B86)+(B290), (A)+(B86)+(B291), (A)+(B86)+(B292), (A)+(B86)+(B293), (A)+(B86)+(B294), (A)+(B86)+(B295), (A)+(B86)+(B296), (A)+(B86)+(B297), (A)+(B86)+(B298), (A)+(B86)+(B299), (A)+(B86)+(B300), (A)+(B86)+(B301), (A)+(B86)+(B302), (A)+(B86)+(B303), (A)+(B86)+(B304), (A)+(B86)+(B305), (A)+(B86)+(B306), (A)+(B86)+(B307), (A)+(B86)+(B308), (A)+(B86)+(B309), (A)+(B86)+(B310), (A)+(B86)+(B311), (A)+(B86)+(B312), (A)+(B86)+(B313), (A)+(B86)+(B314), (A)+(B86)+(B315),

(A)+(B87)+(B88), (A)+(B87)+(B89), (A)+(B87)+(B90), (A)+(B87)+(B91), (A)+(B87)+(B92), (A)+(B87)+(B93), (A)+(B87)+(B94), (A)+(B87)+(B95), (A)+(B87)+(B96), (A)+(B87)+(B97), (A)+(B87)+(B98), (A)+(B87)+(B99), (A)+(B87)+(B100), (A)+(B87)+(B101), (A)+(B87)+(B102), (A)+(B87)+(B103), (A)+(B87)+(B104), (A)+(B87)+(B105), (A)+(B87)+(B106), (A)+(B87)+(B107), (A)+(B87)+(B108), (A)+(B87)+(B109), (A)+(B87)+(B110), (A)+(B87)+(B111), (A)+(B87)+(B112), (A)+(B87)+(B113), (A)+(B87)+(B114), (A)+(B87)+(B115), (A)+(B87)+(B116), (A)+(B87)+(B117), (A)+(B87)+(B118), (A)+(B87)+(B119), (A)+(B87)+(B120), (A)+(B87)+(B121), (A)+(B87)+(B122), (A)+(B87)+(B123), (A)+(B87)+(B124), (A)+(B87)+(B125), (A)+(B87)+(B126), (A)+(B87)+(B127), (A)+(B87)+(B128), (A)+(B87)+(B129), (A)+(B87)+(B130), (A)+(B87)+(B131), (A)+(B87)+(B132), (A)+(B87)+(B133), (A)+(B87)+(B134), (A)+(B87)+(B135), (A)+(B87)+(B136), (A)+(B87)+(B137), (A)+(B87)+(B138), (A)+(B87)+(B139), (A)+(B87)+(B140), (A)+(B87)+(B141), (A)+(B87)+(B142), (A)+(B87)+(B143), (A)+(B87)+(B144), (A)+(B87)+(B145), (A)+(B87)+(B146), (A)+(B87)+(B147), (A)+(B87)+(B148), (A)+(B87)+(B149), (A)+(B87)+(B150), (A)+(B87)+(B151), (A)+(B87)+(B152), (A)+(B87)+(B153), (A)+(B87)+(B154), (A)+(B87)+(B155), (A)+(B87)+(B156), (A)+(B87)+(B157), (A)+(B87)+(B158), (A)+(B87)+(B159), (A)+(B87)+(B160), (A)+(B87)+(B161), (A)+(B87)+(B162), (A)+(B87)+(B164), (A)+(B87)+(B164), (A)+(B87)+(B165), (A)+(B87)+(B166), (A)+(B87)+(B167), (A)+(B87)+(B168), (A)+(B87)+(B169), (A)+(B87)+(B170), (A)+(B87)+(B171), (A)+(B87)+(B172), (A)+(B87)+(B173), (A)+(B87)+(B174), (A)+(B87)+(B175), (A)+(B87)+(B176), (A)+(B87)+(B177), (A)+(B87)+(B178), (A)+(B87)+(B179), (A)+(B87)+(B180), (A)+(B87)+(B181), (A)+(B87)+(B182), (A)+(B87)+(B183), (A)+(B87)+(B184), (A)+(B87)+(B185), (A)+(B87)+(B186), (A)+(B87)+(B187), (A)+(B87)+(B188), (A)+(B87)+(B189), (A)+(B87)+(B190), (A)+(B87)+(B191), (A)+(B87)+(B192), (A)+(B87)+(B193), (A)+(B87)+(B194), (A)+(B87)+(B195), (A)+(B87)+(B196), (A)+(B87)+(B197), (A)+(B87)+(B198), (A)+(B87)+(B199), (A)+(B87)+(B200), (A)+(B87)+(B201), (A)+(B87)+(B202), (A)+(B87)+(B203), (A)+(B87)+(B204), (A)+(B87)+(B205), (A)+(B87)+(B206), (A)+(B87)+(B207), (A)+(B87)+(B208), (A)+(B87)+(B209), (A)+(B87)+(B210), (A)+(B87)+(B211), (A)+(B87)+(B212), (A)+(B87)+(B213), (A)+(B87)+(B214), (A)+(B87)+(B215), (A)+(B87)+(B216), (A)+(B87)+(B217), (A)+(B87)+(B218), (A)+(B87)+(B219), (A)+(B87)+(B220), (A)+(B87)+(B221), (A)+(B87)+(B222), (A)+(B87)+(B223), (A)+(B87)+(B224), (A)+(B87)+(B225), (A)+(B87)+(B226), (A)+(B87)+(B227), (A)+(B87)+(B228), (A)+(B87)+(B229), (A)+(B87)+(B230), (A)+(B87)+(B231), (A)+(B87)+(B232), (A)+(B87)+(B233), (A)+(B87)+(B234), (A)+(B87)+(B235), (A)+(B87)+(B236), (A)+(B87)+(B237), (A)+(B87)+(B238), (A)+(B87)+(B239), (A)+(B87)+(B240), (A)+(B87)+(B241), (A)+(B87)+(B242), (A)+(B87)+(B243), (A)+(B87)+(B244), (A)+(B87)+(B245), (A)+(B87)+(B246), (A)+(B87)+(B247), (A)+(B87)+(B248), (A)+(B87)+(B249), (A)+(B87)+(B250), (A)+(B87)+(B251), (A)+(B87)+(B252), (A)+(B87)+(B253), (A)+(B87)+(B254), (A)+(B87)+(B255), (A)+(B87)+(B256), (A)+(B87)+(B257), (A)+(B87)+(B258), (A)+(B87)+(B259), (A)+(B87)+(B260), (A)+(B87)+(B261), (A)+(B87)+(B262), (A)+(B87)+(B263), (A)+(B87)+(B264), (A)+(B87)+(B265), (A)+(B87)+(B266), (A)+(B87)+(B267), (A)+(B87)+(B268), (A)+(B87)+(B269), (A)+(B87)+(B270), (A)+(B87)+(B271), (A)+(B87)+(B272), (A)+(B87)+(B273), (A)+(B87)+(B274), (A)+(B87)+(B275), (A)+(B87)+(B276), (A)+(B87)+(B277), (A)+(B87)+(B278), (A)+(B87)+(B279), (A)+(B87)+(B280), (A)+(B87)+(B281), (A)+(B87)+(B282), (A)+(B87)+(B283), (A)+(B87)+(B284), (A)+(B87)+(B285), (A)+(B87)+(B286), (A)+(B87)+(B287), (A)+(B87)+(B288), (A)+(B87)+(B289), (A)+(B87)+(B290), (A)+(B87)+(B291), (A)+(B87)+(B292), (A)+(B87)+(B293), (A)+(B87)+(B294), (A)+(B87)+(B295), (A)+(B87)+(B296), (A)+(B87)+(B297), (A)+(B87)+(B298), (A)+(B87)+(B299), (A)+(B87)+(B300), (A)+(B87)+(B301), (A)+(B87)+(B302), (A)+(B87)+(B303), (A)+(B87)+(B304), (A)+(B87)+(B305), (A)+(B87)+(B306), (A)+(B87)+(B307), (A)+(B87)+(B308), (A)+(B87)+(B309), (A)+(B87)+(B310), (A)+(B87)+(B311), (A)+(B87)+(B312), (A)+(B87)+(B313), (A)+(B87)+(B314), (A)+(B87)+(B315),

(A)+(B88)+(B89), (A)+(B88)+(B90), (A)+(B88)+(B91), (A)+(B88)+(B92), (A)+(B88)+(B93), (A)+(B88)+(B94), (A)+(B88)+(B95), (A)+(B88)+(B96), (A)+(B88)+(B97), (A)+(B88)+(B98), (A)+(B88)+(B99), (A)+(B88)+(B100), (A)+(B88)+(B101), (A)+(B88)+(B102), (A)+(B88)+(B103), (A)+(B88)+(B104), (A)+(B88)+(B105), (A)+(B88)+(B106), (A)+(B88)+(B107), (A)+(B88)+(B108), (A)+(B88)+(B109), (A)+(B88)+(B110), (A)+(B88)+(B111), (A)+(B88)+(B112), (A)+(B88)+(B113), (A)+(B88)+(B114), (A)+(B88)+(B115), (A)+(B88)+(B116), (A)+(B88)+(B117), (A)+(B88)+(B118), (A)+(B88)+(B119), (A)+(B88)+(B120), (A)+(B88)+(B121), (A)+(B88)+(B122), (A)+(B88)+(B123), (A)+(B88)+(B124), (A)+(B88)+(B125), (A)+(B88)+(B126), (A)+(B88)+(B127), (A)+(B88)+(B128), (A)+(B88)+(B129), (A)+(B88)+(B130), (A)+(B88)+(B131), (A)+(B88)+(B132), (A)+(B88)+(B133), (A)+(B88)+(B134), (A)+(B88)+(B135), (A)+(B88)+(B136), (A)+(B88)+(B137), (A)+(B88)+(B138), (A)+(B88)+(B139), (A)+(B88)+(B140), (A)+(B88)+(B141), (A)+(B88)+(B142), (A)+(B88)+(B143), (A)+(B88)+(B144), (A)+(B88)+(B145), (A)+(B88)+(B146), (A)+(B88)+(B147), (A)+(B88)+(B148), (A)+(B88)+(B149), (A)+(B88)+(B150), (A)+(B88)+(B151), (A)+(B88)+(B152), (A)+(B88)+(B153), (A)+(B88)+(B154), (A)+(B88)+(B155), (A)+(B88)+(B156), (A)+(B88)+(B157), (A)+(B88)+(B158), (A)+(B88)+(B159), (A)+(B88)+(B160), (A)+(B88)+(B161), (A)+(B88)+(B162), (A)+(B88)+(B164), (A)+(B88)+(B164), (A)+(B88)+(B165), (A)+(B88)+(B166), (A)+(B88)+(B167), (A)+(B88)+(B168), (A)+(B88)+(B169), (A)+(B88)+(B170), (A)+(B88)+(B171), (A)+(B88)+(B172), (A)+(B88)+(B173), (A)+(B88)+(B174), (A)+(B88)+(B175), (A)+(B88)+(B176), (A)+(B88)+(B177), (A)+(B88)+(B178), (A)+(B88)+(B179), (A)+(B88)+(B180), (A)+(B88)+(B181), (A)+(B88)+(B182), (A)+(B88)+(B183), (A)+(B88)+(B184), (A)+(B88)+(B185), (A)+(B88)+(B186), (A)+(B88)+(B187), (A)+(B88)+(B188), (A)+(B88)+(B189), (A)+(B88)+(B190), (A)+(B88)+(B191), (A)+(B88)+(B192), (A)+(B88)+(B193), (A)+(B88)+(B194), (A)+(B88)+(B195), (A)+(B88)+(B196), (A)+(B88)+(B197), (A)+(B88)+(B198), (A)+(B88)+(B199), (A)+(B88)+(B200), (A)+(B88)+(B201), (A)+(B88)+(B202), (A)+(B88)+(B203), (A)+(B88)+(B204), (A)+(B88)+(B205), (A)+(B88)+(B206), (A)+(B88)+(B207), (A)+(B88)+(B208), (A)+(B88)+(B209), (A)+(B88)+(B210), (A)+(B88)+(B211), (A)+(B88)+(B212), (A)+(B88)+(B213), (A)+(B88)+(B214), (A)+(B88)+(B215), (A)+(B88)+(B216), (A)+(B88)+(B217), (A)+(B88)+(B218), (A)+(B88)+(B219), (A)+(B88)+(B220), (A)+(B88)+(B221), (A)+(B88)+(B222), (A)+(B88)+(B223), (A)+(B88)+(B224), (A)+(B88)+(B225), (A)+(B88)+(B226), (A)+(B88)+(B227), (A)+(B88)+(B228), (A)+(B88)+(B229), (A)+(B88)+(B230), (A)+(B88)+(B231), (A)+(B88)+(B232), (A)+(B88)+(B233), (A)+(B88)+(B234), (A)+(B88)+(B235), (A)+(B88)+(B236), (A)+(B88)+(B237), (A)+(B88)+(B238), (A)+(B88)+(B239), (A)+(B88)+(B240), (A)+(B88)+(B241), (A)+(B88)+(B242), (A)+(B88)+(B243), (A)+(B88)+(B244), (A)+(B88)+(B245), (A)+(B88)+(B246), (A)+(B88)+(B247), (A)+(B88)+(B248), (A)+(B88)+(B249), (A)+(B88)+(B250), (A)+(B88)+(B251), (A)+(B88)+(B252), (A)+(B88)+(B253), (A)+(B88)+(B254), (A)+(B88)+(B255), (A)+(B88)+(B256), (A)+(B88)+(B257), (A)+(B88)+(B258), (A)+(B88)+(B259), (A)+(B88)+(B260), (A)+(B88)+(B261), (A)+(B88)+(B262), (A)+(B88)+(B263), (A)+(B88)+(B264), (A)+(B88)+(B265), (A)+(B88)+(B266), (A)+(B88)+(B267), (A)+(B88)+(B268), (A)+(B88)+(B269), (A)+(B88)+(B270), (A)+(B88)+(B271), (A)+(B88)+(B272), (A)+(B88)+(B273), (A)+(B88)+(B274), (A)+(B88)+(B275), (A)+(B88)+(B276), (A)+(B88)+(B277), (A)+(B88)+(B278), (A)+(B88)+(B279), (A)+(B88)+(B280), (A)+(B88)+(B281), (A)+(B88)+(B282), (A)+(B88)+(B283), (A)+(B88)+(B284), (A)+(B88)+(B285), (A)+(B88)+(B286), (A)+(B88)+(B287), (A)+(B88)+(B288), (A)+(B88)+(B289), (A)+(B88)+(B290), (A)+(B88)+(B291), (A)+(B88)+(B292), (A)+(B88)+(B293), (A)+(B88)+(B294), (A)+(B88)+(B295), (A)+(B88)+(B296), (A)+(B88)+(B297), (A)+(B88)+(B298), (A)+(B88)+(B299), (A)+(B88)+(B300), (A)+(B88)+(B301), (A)+(B88)+(B302), (A)+(B88)+(B303), (A)+(B88)+(B304), (A)+(B88)+(B305), (A)+(B88)+(B306), (A)+(B88)+(B307), (A)+(B88)+(B308), (A)+(B88)+(B309), (A)+(B88)+(B310), (A)+(B88)+(B311), (A)+(B88)+(B312), (A)+(B88)+(B313), (A)+(B88)+(B314), (A)+(B88)+(B315),

(A)+(B89)+(B90), (A)+(B89)+(B91), (A)+(B89)+(B92), (A)+(B89)+(B93), (A)+(B89)+(B94), (A)+(B89)+(B95), (A)+(B89)+(B96), (A)+(B89)+(B97), (A)+(B89)+(B98), (A)+(B89)+(B99), (A)+(B89)+(B100), (A)+(B89)+(B101), (A)+(B89)+(B102), (A)+(B89)+(B103), (A)+(B89)+(B104), (A)+(B89)+(B105), (A)+(B89)+(B106), (A)+(B89)+(B107), (A)+(B89)+(B108), (A)+(B89)+(B109), (A)+(B89)+(B110), (A)+(B89)+(B111), (A)+(B89)+(B112), (A)+(B89)+(B113), (A)+(B89)+(B114), (A)+(B89)+(B115), (A)+(B89)+(B116), (A)+(B89)+(B117), (A)+(B89)+(B118), (A)+(B89)+(B119), (A)+(B89)+(B120), (A)+(B89)+(B121), (A)+(B89)+(B122), (A)+(B89)+(B123), (A)+(B89)+(B124), (A)+(B89)+(B125), (A)+(B89)+(B126), (A)+(B89)+(B127), (A)+(B89)+(B128), (A)+(B89)+(B129), (A)+(B89)+(B130), (A)+(B89)+(B131), (A)+(B89)+(B132), (A)+(B89)+(B133), (A)+(B89)+(B134), (A)+(B89)+(B135), (A)+(B89)+(B136), (A)+(B89)+(B137), (A)+(B89)+(B138), (A)+(B89)+(B139), (A)+(B89)+(B140), (A)+(B89)+(B141), (A)+(B89)+(B142), (A)+(B89)+(B143), (A)+(B89)+(B144), (A)+(B89)+(B145), (A)+(B89)+(B146), (A)+(B89)+(B147), (A)+(B89)+(B148), (A)+(B89)+(B149), (A)+(B89)+(B150), (A)+(B89)+(B151), (A)+(B89)+(B152), (A)+(B89)+(B153), (A)+(B89)+(B154), (A)+(B89)+(B155), (A)+(B89)+(B156), (A)+(B89)+(B157), (A)+(B89)+(B158), (A)+(B89)+(B159), (A)+(B89)+(B160), (A)+(B89)+(B161), (A)+(B89)+(B162), (A)+(B89)+(B164), (A)+(B89)+(B164), (A)+(B89)+(B165), (A)+(B89)+(B166), (A)+(B89)+(B167), (A)+(B89)+(B168), (A)+(B89)+(B169), (A)+(B89)+(B170), (A)+(B89)+(B171), (A)+(B89)+(B172), (A)+(B89)+(B173), (A)+(B89)+(B174), (A)+(B89)+(B175), (A)+(B89)+(B176), (A)+(B89)+(B177), (A)+(B89)+(B178), (A)+(B89)+(B179), (A)+(B89)+(B180), (A)+(B89)+(B181), (A)+(B89)+(B182), (A)+(B89)+(B183), (A)+(B89)+(B184), (A)+(B89)+(B185), (A)+(B89)+(B186), (A)+(B89)+(B187), (A)+(B89)+(B188), (A)+(B89)+(B189), (A)+(B89)+(B190), (A)+(B89)+(B191), (A)+(B89)+(B192), (A)+(B89)+(B193), (A)+(B89)+(B194), (A)+(B89)+(B195), (A)+(B89)+(B196), (A)+(B89)+(B197), (A)+(B89)+(B198), (A)+(B89)+(B199), (A)+(B89)+(B200), (A)+(B89)+(B201), (A)+(B89)+(B202), (A)+(B89)+(B203), (A)+(B89)+(B204), (A)+(B89)+(B205), (A)+(B89)+(B206), (A)+(B89)+(B207), (A)+(B89)+(B208), (A)+(B89)+(B209), (A)+(B89)+(B210), (A)+(B89)+(B211), (A)+(B89)+(B212), (A)+(B89)+(B213), (A)+(B89)+(B214), (A)+(B89)+(B215), (A)+(B89)+(B216), (A)+(B89)+(B217), (A)+(B89)+(B218), (A)+(B89)+(B219), (A)+(B89)+(B220), (A)+(B89)+(B221), (A)+(B89)+(B222), (A)+(B89)+(B223), (A)+(B89)+(B224), (A)+(B89)+(B225), (A)+(B89)+(B226), (A)+(B89)+(B227), (A)+(B89)+(B228), (A)+(B89)+(B229), (A)+(B89)+(B230), (A)+(B89)+(B231), (A)+(B89)+(B232), (A)+(B89)+(B233), (A)+(B89)+(B234), (A)+(B89)+(B235), (A)+(B89)+(B236), (A)+(B89)+(B237), (A)+(B89)+(B238), (A)+(B89)+(B239), (A)+(B89)+(B240), (A)+(B89)+(B241), (A)+(B89)+(B242), (A)+(B89)+(B243), (A)+(B89)+(B244), (A)+(B89)+(B245), (A)+(B89)+(B246), (A)+(B89)+(B247), (A)+(B89)+(B248), (A)+(B89)+(B249), (A)+(B89)+(B250), (A)+(B89)+(B251), (A)+(B89)+(B252), (A)+(B89)+(B253), (A)+(B89)+(B254), (A)+(B89)+(B255), (A)+(B89)+(B256), (A)+(B89)+(B257), (A)+(B89)+(B258), (A)+(B89)+(B259), (A)+(B89)+(B260), (A)+(B89)+(B261), (A)+(B89)+(B262), (A)+(B89)+(B263), (A)+(B89)+(B264), (A)+(B89)+(B265), (A)+(B89)+(B266), (A)+(B89)+(B267), (A)+(B89)+(B268), (A)+(B89)+(B269), (A)+(B89)+(B270), (A)+(B89)+(B271), (A)+(B89)+(B272), (A)+(B89)+(B273), (A)+(B89)+(B274), (A)+(B89)+(B275), (A)+(B89)+(B276), (A)+(B89)+(B277), (A)+(B89)+(B278), (A)+(B89)+(B279), (A)+(B89)+(B280), (A)+(B89)+(B281), (A)+(B89)+(B282), (A)+(B89)+(B283), (A)+(B89)+(B284), (A)+(B89)+(B285), (A)+(B89)+(B286), (A)+(B89)+(B287), (A)+(B89)+(B288), (A)+(B89)+(B289), (A)+(B89)+(B290), (A)+(B89)+(B291), (A)+(B89)+(B292), (A)+(B89)+(B293), (A)+(B89)+(B294), (A)+(B89)+(B295), (A)+(B89)+(B296), (A)+(B89)+(B297), (A)+(B89)+(B298), (A)+(B89)+(B299), (A)+(B89)+(B300), (A)+(B89)+(B301), (A)+(B89)+(B302), (A)+(B89)+(B303), (A)+(B89)+(B304), (A)+(B89)+(B305), (A)+(B89)+(B306), (A)+(B89)+(B307), (A)+(B89)+(B308), (A)+(B89)+(B309), (A)+(B89)+(B310), (A)+(B89)+(B311), (A)+(B89)+(B312), (A)+(B89)+(B313), (A)+(B89)+(B314), (A)+(B89)+(B315),

(A)+(B90)+(B91), (A)+(B90)+(B92), (A)+(B90)+(B93), (A)+(B90)+(B94), (A)+(B90)+(B95), (A)+(B90)+(B96), (A)+(B90)+(B97), (A)+(B90)+(B98), (A)+(B90)+(B99), (A)+(B90)+(B100), (A)+(B90)+(B101), (A)+(B90)+(B102), (A)+(B90)+(B103), (A)+(B90)+(B104), (A)+(B90)+(B105), (A)+(B90)+(B106), (A)+(B90)+(B107), (A)+(B90)+(B108), (A)+(B90)+(B109), (A)+(B90)+(B110), (A)+(B90)+(B111), (A)+(B90)+(B112), (A)+(B90)+(B113), (A)+(B90)+(B114), (A)+(B90)+(B115), (A)+(B90)+(B116), (A)+(B90)+(B117), (A)+(B90)+(B118), (A)+(B90)+(B119), (A)+(B90)+(B120), (A)+(B90)+(B121), (A)+(B90)+(B122), (A)+(B90)+(B123), (A)+(B90)+(B124), (A)+(B90)+(B125), (A)+(B90)+(B126), (A)+(B90)+(B127), (A)+(B90)+(B128), (A)+(B90)+(B129), (A)+(B90)+(B130), (A)+(B90)+(B131), (A)+(B90)+(B132), (A)+(B90)+(B133), (A)+(B90)+(B134), (A)+(B90)+(B135), (A)+(B90)+(B136), (A)+(B90)+(B137), (A)+(B90)+(B138), (A)+(B90)+(B139), (A)+(B90)+(B140), (A)+(B90)+(B141), (A)+(B90)+(B142), (A)+(B90)+(B143), (A)+(B90)+(B144), (A)+(B90)+(B145), (A)+(B90)+(B146), (A)+(B90)+(B147), (A)+(B90)+(B148), (A)+(B90)+(B149), (A)+(B90)+(B150), (A)+(B90)+(B151), (A)+(B90)+(B152), (A)+(B90)+(B153), (A)+(B90)+(B154), (A)+(B90)+(B155), (A)+(B90)+(B156), (A)+(B90)+(B157), (A)+(B90)+(B158), (A)+(B90)+(B159), (A)+(B90)+(B160), (A)+(B90)+(B161), (A)+(B90)+(B162), (A)+(B90)+(B164), (A)+(B90)+(B164), (A)+(B90)+(B165), (A)+(B90)+(B166), (A)+(B90)+(B167), (A)+(B90)+(B168), (A)+(B90)+(B169), (A)+(B90)+(B170), (A)+(B90)+(B171), (A)+(B90)+(B172), (A)+(B90)+(B173), (A)+(B90)+(B174), (A)+(B90)+(B175), (A)+(B90)+(B176), (A)+(B90)+(B177), (A)+(B90)+(B178), (A)+(B90)+(B179), (A)+(B90)+(B180), (A)+(B90)+(B181), (A)+(B90)+(B182), (A)+(B90)+(B183), (A)+(B90)+(B184), (A)+(B90)+(B185), (A)+(B90)+(B186), (A)+(B90)+(B187), (A)+(B90)+(B188), (A)+(B90)+(B189), (A)+(B90)+(B190), (A)+(B90)+(B191), (A)+(B90)+(B192), (A)+(B90)+(B193), (A)+(B90)+(B194), (A)+(B90)+(B195), (A)+(B90)+(B196), (A)+(B90)+(B197), (A)+(B90)+(B198), (A)+(B90)+(B199), (A)+(B90)+(B200), (A)+(B90)+(B201), (A)+(B90)+(B202), (A)+(B90)+(B203), (A)+(B90)+(B204), (A)+(B90)+(B205), (A)+(B90)+(B206), (A)+(B90)+(B207), (A)+(B90)+(B208), (A)+(B90)+(B209), (A)+(B90)+(B210), (A)+(B90)+(B211), (A)+(B90)+(B212), (A)+(B90)+(B213), (A)+(B90)+(B214), (A)+(B90)+(B215), (A)+(B90)+(B216), (A)+(B90)+(B217), (A)+(B90)+(B218), (A)+(B90)+(B219), (A)+(B90)+(B220), (A)+(B90)+(B221), (A)+(B90)+(B222), (A)+(B90)+(B223), (A)+(B90)+(B224), (A)+(B90)+(B225), (A)+(B90)+(B226), (A)+(B90)+(B227), (A)+(B90)+(B228), (A)+(B90)+(B229), (A)+(B90)+(B230), (A)+(B90)+(B231), (A)+(B90)+(B232), (A)+(B90)+(B233), (A)+(B90)+(B234), (A)+(B90)+(B235), (A)+(B90)+(B236), (A)+(B90)+(B237), (A)+(B90)+(B238), (A)+(B90)+(B239), (A)+(B90)+(B240), (A)+(B90)+(B241), (A)+(B90)+(B242), (A)+(B90)+(B243), (A)+(B90)+(B244), (A)+(B90)+(B245), (A)+(B90)+(B246), (A)+(B90)+(B247), (A)+(B90)+(B248), (A)+(B90)+(B249), (A)+(B90)+(B250), (A)+(B90)+(B251), (A)+(B90)+(B252), (A)+(B90)+(B253), (A)+(B90)+(B254), (A)+(B90)+(B255), (A)+(B90)+(B256), (A)+(B90)+(B257), (A)+(B90)+(B258), (A)+(B90)+(B259), (A)+(B90)+(B260), (A)+(B90)+(B261), (A)+(B90)+(B262), (A)+(B90)+(B263), (A)+(B90)+(B264), (A)+(B90)+(B265), (A)+(B90)+(B266), (A)+(B90)+(B267), (A)+(B90)+(B268), (A)+(B90)+(B269), (A)+(B90)+(B270), (A)+(B90)+(B271), (A)+(B90)+(B272), (A)+(B90)+(B273), (A)+(B90)+(B274), (A)+(B90)+(B275), (A)+(B90)+(B276), (A)+(B90)+(B277), (A)+(B90)+(B278), (A)+(B90)+(B279), (A)+(B90)+(B280), (A)+(B90)+(B281), (A)+(B90)+(B282), (A)+(B90)+(B283), (A)+(B90)+(B284), (A)+(B90)+(B285), (A)+(B90)+(B286), (A)+(B90)+(B287), (A)+(B90)+(B288), (A)+(B90)+(B289), (A)+(B90)+(B290), (A)+(B90)+(B291), (A)+(B90)+(B292), (A)+(B90)+(B293), (A)+(B90)+(B294), (A)+(B90)+(B295), (A)+(B90)+(B296), (A)+(B90)+(B297), (A)+(B90)+(B298), (A)+(B90)+(B299), (A)+(B90)+(B300), (A)+(B90)+(B301), (A)+(B90)+(B302), (A)+(B90)+(B303), (A)+(B90)+(B304), (A)+(B90)+(B305), (A)+(B90)+(B306), (A)+(B90)+(B307), (A)+(B90)+(B308), (A)+(B90)+(B309), (A)+(B90)+(B310), (A)+(B90)+(B311), (A)+(B90)+(B312), (A)+(B90)+(B313), (A)+(B90)+(B314), (A)+(B90)+(B315),

(A)+(B91)+(B92), (A)+(B91)+(B93), (A)+(B91)+(B94), (A)+(B91)+(B95), (A)+(B91)+(B96), (A)+(B91)+(B97), (A)+(B91)+(B98), (A)+(B91)+(B99), (A)+(B91)+(B100), (A)+(B91)+(B101), (A)+(B91)+(B102), (A)+(B91)+(B103), (A)+(B91)+(B104), (A)+(B91)+(B105), (A)+(B91)+(B106), (A)+(B91)+(B107), (A)+(B91)+(B108), (A)+(B91)+(B109), (A)+(B91)+(B110), (A)+(B91)+(B111), (A)+(B91)+(B112), (A)+(B91)+(B113), (A)+(B91)+(B114), (A)+(B91)+(B115), (A)+(B91)+(B116), (A)+(B91)+(B117), (A)+(B91)+(B118), (A)+(B91)+(B119), (A)+(B91)+(B120), (A)+(B91)+(B121), (A)+(B91)+(B122), (A)+(B91)+(B123), (A)+(B91)+(B124), (A)+(B91)+(B125), (A)+(B91)+(B126), (A)+(B91)+(B127), (A)+(B91)+(B128), (A)+(B91)+(B129), (A)+(B91)+(B130), (A)+(B91)+(B131), (A)+(B91)+(B132), (A)+(B91)+(B133), (A)+(B91)+(B134), (A)+(B91)+(B135), (A)+(B91)+(B136), (A)+(B91)+(B137), (A)+(B91)+(B138), (A)+(B91)+(B139), (A)+(B91)+(B140), (A)+(B91)+(B141), (A)+(B91)+(B142), (A)+(B91)+(B143), (A)+(B91)+(B144), (A)+(B91)+(B145), (A)+(B91)+(B146), (A)+(B91)+(B147), (A)+(B91)+(B148), (A)+(B91)+(B149), (A)+(B91)+(B150), (A)+(B91)+(B151), (A)+(B91)+(B152), (A)+(B91)+(B153), (A)+(B91)+(B154), (A)+(B91)+(B155), (A)+(B91)+(B156), (A)+(B91)+(B157), (A)+(B91)+(B158), (A)+(B91)+(B159), (A)+(B91)+(B160), (A)+(B91)+(B161), (A)+(B91)+(B162), (A)+(B91)+(B164), (A)+(B91)+(B164), (A)+(B91)+(B165), (A)+(B91)+(B166), (A)+(B91)+(B167), (A)+(B91)+(B168), (A)+(B91)+(B169), (A)+(B91)+(B170), (A)+(B91)+(B171), (A)+(B91)+(B172), (A)+(B91)+(B173), (A)+(B91)+(B174), (A)+(B91)+(B175), (A)+(B91)+(B176), (A)+(B91)+(B177), (A)+(B91)+(B178), (A)+(B91)+(B179), (A)+(B91)+(B180), (A)+(B91)+(B181), (A)+(B91)+(B182), (A)+(B91)+(B183), (A)+(B91)+(B184), (A)+(B91)+(B185), (A)+(B91)+(B186), (A)+(B91)+(B187), (A)+(B91)+(B188), (A)+(B91)+(B189), (A)+(B91)+(B190), (A)+(B91)+(B191), (A)+(B91)+(B192), (A)+(B91)+(B193), (A)+(B91)+(B194), (A)+(B91)+(B195), (A)+(B91)+(B196), (A)+(B91)+(B197), (A)+(B91)+(B198), (A)+(B91)+(B199), (A)+(B91)+(B200), (A)+(B91)+(B201), (A)+(B91)+(B202), (A)+(B91)+(B203), (A)+(B91)+(B204), (A)+(B91)+(B205), (A)+(B91)+(B206), (A)+(B91)+(B207), (A)+(B91)+(B208), (A)+(B91)+(B209), (A)+(B91)+(B210), (A)+(B91)+(B211), (A)+(B91)+(B212), (A)+(B91)+(B213), (A)+(B91)+(B214), (A)+(B91)+(B215), (A)+(B91)+(B216), (A)+(B91)+(B217), (A)+(B91)+(B218), (A)+(B91)+(B219), (A)+(B91)+(B220), (A)+(B91)+(B221), (A)+(B91)+(B222), (A)+(B91)+(B223), (A)+(B91)+(B224), (A)+(B91)+(B225), (A)+(B91)+(B226), (A)+(B91)+(B227), (A)+(B91)+(B228), (A)+(B91)+(B229), (A)+(B91)+(B230), (A)+(B91)+(B231), (A)+(B91)+(B232), (A)+(B91)+(B233), (A)+(B91)+(B234), (A)+(B91)+(B235), (A)+(B91)+(B236), (A)+(B91)+(B237), (A)+(B91)+(B238), (A)+(B91)+(B239), (A)+(B91)+(B240), (A)+(B91)+(B241), (A)+(B91)+(B242), (A)+(B91)+(B243), (A)+(B91)+(B244), (A)+(B91)+(B245), (A)+(B91)+(B246), (A)+(B91)+(B247), (A)+(B91)+(B248), (A)+(B91)+(B249), (A)+(B91)+(B250), (A)+(B91)+(B251), (A)+(B91)+(B252), (A)+(B91)+(B253), (A)+(B91)+(B254), (A)+(B91)+(B255), (A)+(B91)+(B256), (A)+(B91)+(B257), (A)+(B91)+(B258), (A)+(B91)+(B259), (A)+(B91)+(B260), (A)+(B91)+(B261), (A)+(B91)+(B262), (A)+(B91)+(B263), (A)+(B91)+(B264), (A)+(B91)+(B265), (A)+(B91)+(B266), (A)+(B91)+(B267), (A)+(B91)+(B268), (A)+(B91)+(B269), (A)+(B91)+(B270), (A)+(B91)+(B271), (A)+(B91)+(B272), (A)+(B91)+(B273), (A)+(B91)+(B274), (A)+(B91)+(B275), (A)+(B91)+(B276), (A)+(B91)+(B277), (A)+(B91)+(B278), (A)+(B91)+(B279), (A)+(B91)+(B280), (A)+(B91)+(B281), (A)+(B91)+(B282), (A)+(B91)+(B283), (A)+(B91)+(B284), (A)+(B91)+(B285), (A)+(B91)+(B286), (A)+(B91)+(B287), (A)+(B91)+(B288), (A)+(B91)+(B289), (A)+(B91)+(B290), (A)+(B91)+(B291), (A)+(B91)+(B292), (A)+(B91)+(B293), (A)+(B91)+(B294), (A)+(B91)+(B295), (A)+(B91)+(B296), (A)+(B91)+(B297), (A)+(B91)+(B298), (A)+(B91)+(B299), (A)+(B91)+(B300), (A)+(B91)+(B301), (A)+(B91)+(B302), (A)+(B91)+(B303), (A)+(B91)+(B304), (A)+(B91)+(B305), (A)+(B91)+(B306), (A)+(B91)+(B307), (A)+(B91)+(B308), (A)+(B91)+(B309), (A)+(B91)+(B310), (A)+(B91)+(B311), (A)+(B91)+(B312), (A)+(B91)+(B313), (A)+(B91)+(B314), (A)+(B91)+(B315),

(A)+(B92)+(B93), (A)+(B92)+(B94), (A)+(B92)+(B95), (A)+(B92)+(B96), (A)+(B92)+(B97), (A)+(B92)+(B98), (A)+(B92)+(B99), (A)+(B92)+(B100), (A)+(B92)+(B101), (A)+(B92)+(B102), (A)+(B92)+(B103), (A)+(B92)+(B104), (A)+(B92)+(B105), (A)+(B92)+(B106), (A)+(B92)+(B107), (A)+(B92)+(B108), (A)+(B92)+(B109), (A)+(B92)+(B110), (A)+(B92)+(B111), (A)+(B92)+(B112), (A)+(B92)+(B113), (A)+(B92)+(B114), (A)+(B92)+(B115), (A)+(B92)+(B116), (A)+(B92)+(B117), (A)+(B92)+(B118), (A)+(B92)+(B119), (A)+(B92)+(B120), (A)+(B92)+(B121), (A)+(B92)+(B122), (A)+(B92)+(B123), (A)+(B92)+(B124), (A)+(B92)+(B125), (A)+(B92)+(B126), (A)+(B92)+(B127), (A)+(B92)+(B128), (A)+(B92)+(B129), (A)+(B92)+(B130), (A)+(B92)+(B131), (A)+(B92)+(B132), (A)+(B92)+(B133), (A)+(B92)+(B134), (A)+(B92)+(B135), (A)+(B92)+(B136), (A)+(B92)+(B137), (A)+(B92)+(B138), (A)+(B92)+(B139), (A)+(B92)+(B140), (A)+(B92)+(B141), (A)+(B92)+(B142), (A)+(B92)+(B143), (A)+(B92)+(B144), (A)+(B92)+(B145), (A)+(B92)+(B146), (A)+(B92)+(B147), (A)+(B92)+(B148), (A)+(B92)+(B149), (A)+(B92)+(B150), (A)+(B92)+(B151), (A)+(B92)+(B152), (A)+(B92)+(B153), (A)+(B92)+(B154), (A)+(B92)+(B155), (A)+(B92)+(B156), (A)+(B92)+(B157), (A)+(B92)+(B158), (A)+(B92)+(B159), (A)+(B92)+(B160), (A)+(B92)+(B161), (A)+(B92)+(B162), (A)+(B92)+(B164), (A)+(B92)+(B164), (A)+(B92)+(B165), (A)+(B92)+(B166), (A)+(B92)+(B167), (A)+(B92)+(B168), (A)+(B92)+(B169), (A)+(B92)+(B170), (A)+(B92)+(B171), (A)+(B92)+(B172), (A)+(B92)+(B173), (A)+(B92)+(B174), (A)+(B92)+(B175), (A)+(B92)+(B176), (A)+(B92)+(B177), (A)+(B92)+(B178), (A)+(B92)+(B179), (A)+(B92)+(B180), (A)+(B92)+(B181), (A)+(B92)+(B182), (A)+(B92)+(B183), (A)+(B92)+(B184), (A)+(B92)+(B185), (A)+(B92)+(B186), (A)+(B92)+(B187), (A)+(B92)+(B188), (A)+(B92)+(B189), (A)+(B92)+(B190), (A)+(B92)+(B191), (A)+(B92)+(B192), (A)+(B92)+(B193), (A)+(B92)+(B194), (A)+(B92)+(B195), (A)+(B92)+(B196), (A)+(B92)+(B197), (A)+(B92)+(B198), (A)+(B92)+(B199), (A)+(B92)+(B200), (A)+(B92)+(B201), (A)+(B92)+(B202), (A)+(B92)+(B203), (A)+(B92)+(B204), (A)+(B92)+(B205), (A)+(B92)+(B206), (A)+(B92)+(B207), (A)+(B92)+(B208), (A)+(B92)+(B209), (A)+(B92)+(B210), (A)+(B92)+(B211), (A)+(B92)+(B212), (A)+(B92)+(B213), (A)+(B92)+(B214), (A)+(B92)+(B215), (A)+(B92)+(B216), (A)+(B92)+(B217), (A)+(B92)+(B218), (A)+(B92)+(B219), (A)+(B92)+(B220), (A)+(B92)+(B221), (A)+(B92)+(B222), (A)+(B92)+(B223), (A)+(B92)+(B224), (A)+(B92)+(B225), (A)+(B92)+(B226), (A)+(B92)+(B227), (A)+(B92)+(B228), (A)+(B92)+(B229), (A)+(B92)+(B230), (A)+(B92)+(B231), (A)+(B92)+(B232), (A)+(B92)+(B233), (A)+(B92)+(B234), (A)+(B92)+(B235), (A)+(B92)+(B236), (A)+(B92)+(B237), (A)+(B92)+(B238), (A)+(B92)+(B239), (A)+(B92)+(B240), (A)+(B92)+(B241), (A)+(B92)+(B242), (A)+(B92)+(B243), (A)+(B92)+(B244), (A)+(B92)+(B245), (A)+(B92)+(B246), (A)+(B92)+(B247), (A)+(B92)+(B248), (A)+(B92)+(B249), (A)+(B92)+(B250), (A)+(B92)+(B251), (A)+(B92)+(B252), (A)+(B92)+(B253), (A)+(B92)+(B254), (A)+(B92)+(B255), (A)+(B92)+(B256), (A)+(B92)+(B257), (A)+(B92)+(B258), (A)+(B92)+(B259), (A)+(B92)+(B260), (A)+(B92)+(B261), (A)+(B92)+(B262), (A)+(B92)+(B263), (A)+(B92)+(B264), (A)+(B92)+(B265), (A)+(B92)+(B266), (A)+(B92)+(B267), (A)+(B92)+(B268), (A)+(B92)+(B269), (A)+(B92)+(B270), (A)+(B92)+(B271), (A)+(B92)+(B272), (A)+(B92)+(B273), (A)+(B92)+(B274), (A)+(B92)+(B275), (A)+(B92)+(B276), (A)+(B92)+(B277), (A)+(B92)+(B278), (A)+(B92)+(B279), (A)+(B92)+(B280), (A)+(B92)+(B281), (A)+(B92)+(B282), (A)+(B92)+(B283), (A)+(B92)+(B284), (A)+(B92)+(B285), (A)+(B92)+(B286), (A)+(B92)+(B287), (A)+(B92)+(B288), (A)+(B92)+(B289), (A)+(B92)+(B290), (A)+(B92)+(B291), (A)+(B92)+(B292), (A)+(B92)+(B293), (A)+(B92)+(B294), (A)+(B92)+(B295), (A)+(B92)+(B296), (A)+(B92)+(B297), (A)+(B92)+(B298), (A)+(B92)+(B299), (A)+(B92)+(B300), (A)+(B92)+(B301), (A)+(B92)+(B302), (A)+(B92)+(B303), (A)+(B92)+(B304), (A)+(B92)+(B305), (A)+(B92)+(B306), (A)+(B92)+(B307), (A)+(B92)+(B308), (A)+(B92)+(B309), (A)+(B92)+(B310), (A)+(B92)+(B311), (A)+(B92)+(B312), (A)+(B92)+(B313), (A)+(B92)+(B314), (A)+(B92)+(B315),

(A)+(B93)+(B94), (A)+(B93)+(B95), (A)+(B93)+(B96), (A)+(B93)+(B97), (A)+(B93)+(B98), (A)+(B93)+(B99), (A)+(B93)+(B100), (A)+(B93)+(B101), (A)+(B93)+(B102), (A)+(B93)+(B103), (A)+(B93)+(B104), (A)+(B93)+(B105), (A)+(B93)+(B106), (A)+(B93)+(B107), (A)+(B93)+(B108), (A)+(B93)+(B109), (A)+(B93)+(B110), (A)+(B93)+(B111), (A)+(B93)+(B112), (A)+(B93)+(B113), (A)+(B93)+(B114), (A)+(B93)+(B115), (A)+(B93)+(B116), (A)+(B93)+(B117), (A)+(B93)+(B118), (A)+(B93)+(B119), (A)+(B93)+(B120), (A)+(B93)+(B121), (A)+(B93)+(B122), (A)+(B93)+(B123), (A)+(B93)+(B124), (A)+(B93)+(B125), (A)+(B93)+(B126), (A)+(B93)+(B127), (A)+(B93)+(B128), (A)+(B93)+(B129), (A)+(B93)+(B130), (A)+(B93)+(B131), (A)+(B93)+(B132), (A)+(B93)+(B133), (A)+(B93)+(B134), (A)+(B93)+(B135), (A)+(B93)+(B136), (A)+(B93)+(B137), (A)+(B93)+(B138), (A)+(B93)+(B139), (A)+(B93)+(B140), (A)+(B93)+(B141), (A)+(B93)+(B142), (A)+(B93)+(B143), (A)+(B93)+(B144), (A)+(B93)+(B145), (A)+(B93)+(B146), (A)+(B93)+(B147), (A)+(B93)+(B148), (A)+(B93)+(B149), (A)+(B93)+(B150), (A)+(B93)+(B151), (A)+(B93)+(B152), (A)+(B93)+(B153), (A)+(B93)+(B154), (A)+(B93)+(B155), (A)+(B93)+(B156), (A)+(B93)+(B157), (A)+(B93)+(B158), (A)+(B93)+(B159), (A)+(B93)+(B160), (A)+(B93)+(B161), (A)+(B93)+(B162), (A)+(B93)+(B164), (A)+(B93)+(B164), (A)+(B93)+(B165), (A)+(B93)+(B166), (A)+(B93)+(B167), (A)+(B93)+(B168), (A)+(B93)+(B169), (A)+(B93)+(B170), (A)+(B93)+(B171), (A)+(B93)+(B172), (A)+(B93)+(B173), (A)+(B93)+(B174), (A)+(B93)+(B175), (A)+(B93)+(B176), (A)+(B93)+(B177), (A)+(B93)+(B178), (A)+(B93)+(B179), (A)+(B93)+(B180), (A)+(B93)+(B181), (A)+(B93)+(B182), (A)+(B93)+(B183), (A)+(B93)+(B184), (A)+(B93)+(B185), (A)+(B93)+(B186), (A)+(B93)+(B187), (A)+(B93)+(B188), (A)+(B93)+(B189), (A)+(B93)+(B190), (A)+(B93)+(B191), (A)+(B93)+(B192), (A)+(B93)+(B193), (A)+(B93)+(B194), (A)+(B93)+(B195), (A)+(B93)+(B196), (A)+(B93)+(B197), (A)+(B93)+(B198), (A)+(B93)+(B199), (A)+(B93)+(B200), (A)+(B93)+(B201), (A)+(B93)+(B202), (A)+(B93)+(B203), (A)+(B93)+(B204), (A)+(B93)+(B205), (A)+(B93)+(B206), (A)+(B93)+(B207), (A)+(B93)+(B208), (A)+(B93)+(B209), (A)+(B93)+(B210), (A)+(B93)+(B211), (A)+(B93)+(B212), (A)+(B93)+(B213), (A)+(B93)+(B214), (A)+(B93)+(B215), (A)+(B93)+(B216), (A)+(B93)+(B217), (A)+(B93)+(B218), (A)+(B93)+(B219), (A)+(B93)+(B220), (A)+(B93)+(B221), (A)+(B93)+(B222), (A)+(B93)+(B223), (A)+(B93)+(B224), (A)+(B93)+(B225), (A)+(B93)+(B226), (A)+(B93)+(B227), (A)+(B93)+(B228), (A)+(B93)+(B229), (A)+(B93)+(B230), (A)+(B93)+(B231), (A)+(B93)+(B232), (A)+(B93)+(B233), (A)+(B93)+(B234), (A)+(B93)+(B235), (A)+(B93)+(B236), (A)+(B93)+(B237), (A)+(B93)+(B238), (A)+(B93)+(B239), (A)+(B93)+(B240), (A)+(B93)+(B241), (A)+(B93)+(B242), (A)+(B93)+(B243), (A)+(B93)+(B244), (A)+(B93)+(B245), (A)+(B93)+(B246), (A)+(B93)+(B247), (A)+(B93)+(B248), (A)+(B93)+(B249), (A)+(B93)+(B250), (A)+(B93)+(B251), (A)+(B93)+(B252), (A)+(B93)+(B253), (A)+(B93)+(B254), (A)+(B93)+(B255), (A)+(B93)+(B256), (A)+(B93)+(B257), (A)+(B93)+(B258), (A)+(B93)+(B259), (A)+(B93)+(B260), (A)+(B93)+(B261), (A)+(B93)+(B262), (A)+(B93)+(B263), (A)+(B93)+(B264), (A)+(B93)+(B265), (A)+(B93)+(B266), (A)+(B93)+(B267), (A)+(B93)+(B268), (A)+(B93)+(B269), (A)+(B93)+(B270), (A)+(B93)+(B271), (A)+(B93)+(B272), (A)+(B93)+(B273), (A)+(B93)+(B274), (A)+(B93)+(B275), (A)+(B93)+(B276), (A)+(B93)+(B277), (A)+(B93)+(B278), (A)+(B93)+(B279), (A)+(B93)+(B280), (A)+(B93)+(B281), (A)+(B93)+(B282), (A)+(B93)+(B283), (A)+(B93)+(B284), (A)+(B93)+(B285), (A)+(B93)+(B286), (A)+(B93)+(B287), (A)+(B93)+(B288), (A)+(B93)+(B289), (A)+(B93)+(B290), (A)+(B93)+(B291), (A)+(B93)+(B292), (A)+(B93)+(B293), (A)+(B93)+(B294), (A)+(B93)+(B295), (A)+(B93)+(B296), (A)+(B93)+(B297), (A)+(B93)+(B298), (A)+(B93)+(B299), (A)+(B93)+(B300), (A)+(B93)+(B301), (A)+(B93)+(B302), (A)+(B93)+(B303), (A)+(B93)+(B304), (A)+(B93)+(B305), (A)+(B93)+(B306), (A)+(B93)+(B307), (A)+(B93)+(B308), (A)+(B93)+(B309), (A)+(B93)+(B310), (A)+(B93)+(B311), (A)+(B93)+(B312), (A)+(B93)+(B313), (A)+(B93)+(B314), (A)+(B93)+(B315),

(A)+(B94)+(B95), (A)+(B94)+(B96), (A)+(B94)+(B97), (A)+(B94)+(B98), (A)+(B94)+(B99), (A)+(B94)+(B100), (A)+(B94)+(B101), (A)+(B94)+(B102), (A)+(B94)+(B103), (A)+(B94)+(B104), (A)+(B94)+(B105), (A)+(B94)+(B106), (A)+(B94)+(B107), (A)+(B94)+(B108), (A)+(B94)+(B109), (A)+(B94)+(B110), (A)+(B94)+(B111), (A)+(B94)+(B112), (A)+(B94)+(B113), (A)+(B94)+(B114), (A)+(B94)+(B115), (A)+(B94)+(B116), (A)+(B94)+(B117), (A)+(B94)+(B118), (A)+(B94)+(B119), (A)+(B94)+(B120), (A)+(B94)+(B121), (A)+(B94)+(B122), (A)+(B94)+(B123), (A)+(B94)+(B124), (A)+(B94)+(B125), (A)+(B94)+(B126), (A)+(B94)+(B127), (A)+(B94)+(B128), (A)+(B94)+(B129), (A)+(B94)+(B130), (A)+(B94)+(B131), (A)+(B94)+(B132), (A)+(B94)+(B133), (A)+(B94)+(B134), (A)+(B94)+(B135), (A)+(B94)+(B136), (A)+(B94)+(B137), (A)+(B94)+(B138), (A)+(B94)+(B139), (A)+(B94)+(B140), (A)+(B94)+(B141), (A)+(B94)+(B142), (A)+(B94)+(B143), (A)+(B94)+(B144), (A)+(B94)+(B145), (A)+(B94)+(B146), (A)+(B94)+(B147), (A)+(B94)+(B148), (A)+(B94)+(B149), (A)+(B94)+(B150), (A)+(B94)+(B151), (A)+(B94)+(B152), (A)+(B94)+(B153), (A)+(B94)+(B154), (A)+(B94)+(B155), (A)+(B94)+(B156), (A)+(B94)+(B157), (A)+(B94)+(B158), (A)+(B94)+(B159), (A)+(B94)+(B160), (A)+(B94)+(B161), (A)+(B94)+(B162), (A)+(B94)+(B164), (A)+(B94)+(B164), (A)+(B94)+(B165), (A)+(B94)+(B166), (A)+(B94)+(B167), (A)+(B94)+(B168), (A)+(B94)+(B169), (A)+(B94)+(B170), (A)+(B94)+(B171), (A)+(B94)+(B172), (A)+(B94)+(B173), (A)+(B94)+(B174), (A)+(B94)+(B175), (A)+(B94)+(B176), (A)+(B94)+(B177), (A)+(B94)+(B178), (A)+(B94)+(B179), (A)+(B94)+(B180), (A)+(B94)+(B181), (A)+(B94)+(B182), (A)+(B94)+(B183), (A)+(B94)+(B184), (A)+(B94)+(B185), (A)+(B94)+(B186), (A)+(B94)+(B187), (A)+(B94)+(B188), (A)+(B94)+(B189), (A)+(B94)+(B190), (A)+(B94)+(B191), (A)+(B94)+(B192), (A)+(B94)+(B193), (A)+(B94)+(B194), (A)+(B94)+(B195), (A)+(B94)+(B196), (A)+(B94)+(B197), (A)+(B94)+(B198), (A)+(B94)+(B199), (A)+(B94)+(B200), (A)+(B94)+(B201), (A)+(B94)+(B202), (A)+(B94)+(B203), (A)+(B94)+(B204), (A)+(B94)+(B205), (A)+(B94)+(B206), (A)+(B94)+(B207), (A)+(B94)+(B208), (A)+(B94)+(B209), (A)+(B94)+(B210), (A)+(B94)+(B211), (A)+(B94)+(B212), (A)+(B94)+(B213), (A)+(B94)+(B214), (A)+(B94)+(B215), (A)+(B94)+(B216), (A)+(B94)+(B217), (A)+(B94)+(B218), (A)+(B94)+(B219), (A)+(B94)+(B220), (A)+(B94)+(B221), (A)+(B94)+(B222), (A)+(B94)+(B223), (A)+(B94)+(B224), (A)+(B94)+(B225), (A)+(B94)+(B226), (A)+(B94)+(B227), (A)+(B94)+(B228), (A)+(B94)+(B229), (A)+(B94)+(B230), (A)+(B94)+(B231), (A)+(B94)+(B232), (A)+(B94)+(B233), (A)+(B94)+(B234), (A)+(B94)+(B235), (A)+(B94)+(B236), (A)+(B94)+(B237), (A)+(B94)+(B238), (A)+(B94)+(B239), (A)+(B94)+(B240), (A)+(B94)+(B241), (A)+(B94)+(B242), (A)+(B94)+(B243), (A)+(B94)+(B244), (A)+(B94)+(B245), (A)+(B94)+(B246), (A)+(B94)+(B247), (A)+(B94)+(B248), (A)+(B94)+(B249), (A)+(B94)+(B250), (A)+(B94)+(B251), (A)+(B94)+(B252), (A)+(B94)+(B253), (A)+(B94)+(B254), (A)+(B94)+(B255), (A)+(B94)+(B256), (A)+(B94)+(B257), (A)+(B94)+(B258), (A)+(B94)+(B259), (A)+(B94)+(B260), (A)+(B94)+(B261), (A)+(B94)+(B262), (A)+(B94)+(B263), (A)+(B94)+(B264), (A)+(B94)+(B265), (A)+(B94)+(B266), (A)+(B94)+(B267), (A)+(B94)+(B268), (A)+(B94)+(B269), (A)+(B94)+(B270), (A)+(B94)+(B271), (A)+(B94)+(B272), (A)+(B94)+(B273), (A)+(B94)+(B274), (A)+(B94)+(B275), (A)+(B94)+(B276), (A)+(B94)+(B277), (A)+(B94)+(B278), (A)+(B94)+(B279), (A)+(B94)+(B280), (A)+(B94)+(B281), (A)+(B94)+(B282), (A)+(B94)+(B283), (A)+(B94)+(B284), (A)+(B94)+(B285), (A)+(B94)+(B286), (A)+(B94)+(B287), (A)+(B94)+(B288), (A)+(B94)+(B289), (A)+(B94)+(B290), (A)+(B94)+(B291), (A)+(B94)+(B292), (A)+(B94)+(B293), (A)+(B94)+(B294), (A)+(B94)+(B295), (A)+(B94)+(B296), (A)+(B94)+(B297), (A)+(B94)+(B298), (A)+(B94)+(B299), (A)+(B94)+(B300), (A)+(B94)+(B301), (A)+(B94)+(B302), (A)+(B94)+(B303), (A)+(B94)+(B304), (A)+(B94)+(B305), (A)+(B94)+(B306), (A)+(B94)+(B307), (A)+(B94)+(B308), (A)+(B94)+(B309), (A)+(B94)+(B310), (A)+(B94)+(B311), (A)+(B94)+(B312), (A)+(B94)+(B313), (A)+(B94)+(B314), (A)+(B94)+(B315),

(A)+(B95)+(B96), (A)+(B95)+(B97), (A)+(B95)+(B98), (A)+(B95)+(B99), (A)+(B95)+(B100), (A)+(B95)+(B101), (A)+(B95)+(B102), (A)+(B95)+(B103), (A)+(B95)+(B104), (A)+(B95)+(B105), (A)+(B95)+(B106), (A)+(B95)+(B107), (A)+(B95)+(B108), (A)+(B95)+(B109), (A)+(B95)+(B110), (A)+(B95)+(B111), (A)+(B95)+(B112), (A)+(B95)+(B113), (A)+(B95)+(B114), (A)+(B95)+(B115), (A)+(B95)+(B116), (A)+(B95)+(B117), (A)+(B95)+(B118), (A)+(B95)+(B119), (A)+(B95)+(B120), (A)+(B95)+(B121), (A)+(B95)+(B122), (A)+(B95)+(B123), (A)+(B95)+(B124), (A)+(B95)+(B125), (A)+(B95)+(B126), (A)+(B95)+(B127), (A)+(B95)+(B128), (A)+(B95)+(B129), (A)+(B95)+(B130), (A)+(B95)+(B131), (A)+(B95)+(B132), (A)+(B95)+(B133), (A)+(B95)+(B134), (A)+(B95)+(B135), (A)+(B95)+(B136), (A)+(B95)+(B137), (A)+(B95)+(B138), (A)+(B95)+(B139), (A)+(B95)+(B140), (A)+(B95)+(B141), (A)+(B95)+(B142), (A)+(B95)+(B143), (A)+(B95)+(B144), (A)+(B95)+(B145), (A)+(B95)+(B146), (A)+(B95)+(B147), (A)+(B95)+(B148), (A)+(B95)+(B149), (A)+(B95)+(B150), (A)+(B95)+(B151), (A)+(B95)+(B152), (A)+(B95)+(B153), (A)+(B95)+(B154), (A)+(B95)+(B155), (A)+(B95)+(B156), (A)+(B95)+(B157), (A)+(B95)+(B158), (A)+(B95)+(B159), (A)+(B95)+(B160), (A)+(B95)+(B161), (A)+(B95)+(B162), (A)+(B95)+(B164), (A)+(B95)+(B164), (A)+(B95)+(B165), (A)+(B95)+(B166), (A)+(B95)+(B167), (A)+(B95)+(B168), (A)+(B95)+(B169), (A)+(B95)+(B170), (A)+(B95)+(B171), (A)+(B95)+(B172), (A)+(B95)+(B173), (A)+(B95)+(B174), (A)+(B95)+(B175), (A)+(B95)+(B176), (A)+(B95)+(B177), (A)+(B95)+(B178), (A)+(B95)+(B179), (A)+(B95)+(B180), (A)+(B95)+(B181), (A)+(B95)+(B182), (A)+(B95)+(B183), (A)+(B95)+(B184), (A)+(B95)+(B185), (A)+(B95)+(B186), (A)+(B95)+(B187), (A)+(B95)+(B188), (A)+(B95)+(B189), (A)+(B95)+(B190), (A)+(B95)+(B191), (A)+(B95)+(B192), (A)+(B95)+(B193), (A)+(B95)+(B194), (A)+(B95)+(B195), (A)+(B95)+(B196), (A)+(B95)+(B197), (A)+(B95)+(B198), (A)+(B95)+(B199), (A)+(B95)+(B200), (A)+(B95)+(B201), (A)+(B95)+(B202), (A)+(B95)+(B203), (A)+(B95)+(B204), (A)+(B95)+(B205), (A)+(B95)+(B206), (A)+(B95)+(B207), (A)+(B95)+(B208), (A)+(B95)+(B209), (A)+(B95)+(B210), (A)+(B95)+(B211), (A)+(B95)+(B212), (A)+(B95)+(B213), (A)+(B95)+(B214), (A)+(B95)+(B215), (A)+(B95)+(B216), (A)+(B95)+(B217), (A)+(B95)+(B218), (A)+(B95)+(B219), (A)+(B95)+(B220), (A)+(B95)+(B221), (A)+(B95)+(B222), (A)+(B95)+(B223), (A)+(B95)+(B224), (A)+(B95)+(B225), (A)+(B95)+(B226), (A)+(B95)+(B227), (A)+(B95)+(B228), (A)+(B95)+(B229), (A)+(B95)+(B230), (A)+(B95)+(B231), (A)+(B95)+(B232), (A)+(B95)+(B233), (A)+(B95)+(B234), (A)+(B95)+(B235), (A)+(B95)+(B236), (A)+(B95)+(B237), (A)+(B95)+(B238), (A)+(B95)+(B239), (A)+(B95)+(B240), (A)+(B95)+(B241), (A)+(B95)+(B242), (A)+(B95)+(B243), (A)+(B95)+(B244), (A)+(B95)+(B245), (A)+(B95)+(B246), (A)+(B95)+(B247), (A)+(B95)+(B248), (A)+(B95)+(B249), (A)+(B95)+(B250), (A)+(B95)+(B251), (A)+(B95)+(B252), (A)+(B95)+(B253), (A)+(B95)+(B254), (A)+(B95)+(B255), (A)+(B95)+(B256), (A)+(B95)+(B257), (A)+(B95)+(B258), (A)+(B95)+(B259), (A)+(B95)+(B260), (A)+(B95)+(B261), (A)+(B95)+(B262), (A)+(B95)+(B263), (A)+(B95)+(B264), (A)+(B95)+(B265), (A)+(B95)+(B266), (A)+(B95)+(B267), (A)+(B95)+(B268), (A)+(B95)+(B269), (A)+(B95)+(B270), (A)+(B95)+(B271), (A)+(B95)+(B272), (A)+(B95)+(B273), (A)+(B95)+(B274), (A)+(B95)+(B275), (A)+(B95)+(B276), (A)+(B95)+(B277), (A)+(B95)+(B278), (A)+(B95)+(B279), (A)+(B95)+(B280), (A)+(B95)+(B281), (A)+(B95)+(B282), (A)+(B95)+(B283), (A)+(B95)+(B284), (A)+(B95)+(B285), (A)+(B95)+(B286), (A)+(B95)+(B287), (A)+(B95)+(B288), (A)+(B95)+(B289), (A)+(B95)+(B290), (A)+(B95)+(B291), (A)+(B95)+(B292), (A)+(B95)+(B293), (A)+(B95)+(B294), (A)+(B95)+(B295), (A)+(B95)+(B296), (A)+(B95)+(B297), (A)+(B95)+(B298), (A)+(B95)+(B299), (A)+(B95)+(B300), (A)+(B95)+(B301), (A)+(B95)+(B302), (A)+(B95)+(B303), (A)+(B95)+(B304), (A)+(B95)+(B305), (A)+(B95)+(B306), (A)+(B95)+(B307), (A)+(B95)+(B308), (A)+(B95)+(B309), (A)+(B95)+(B310), (A)+(B95)+(B311), (A)+(B95)+(B312), (A)+(B95)+(B313), (A)+(B95)+(B314), (A)+(B95)+(B315),

(A)+(B96)+(B97), (A)+(B96)+(B98), (A)+(B96)+(B99), (A)+(B96)+(B100), (A)+(B96)+(B101), (A)+(B96)+(B102), (A)+(B96)+(B103), (A)+(B96)+(B104), (A)+(B96)+(B105), (A)+(B96)+(B106), (A)+(B96)+(B107), (A)+(B96)+(B108), (A)+(B96)+(B109), (A)+(B96)+(B110), (A)+(B96)+(B111), (A)+(B96)+(B112), (A)+(B96)+(B113), (A)+(B96)+(B114), (A)+(B96)+(B115), (A)+(B96)+(B116), (A)+(B96)+(B117), (A)+(B96)+(B118), (A)+(B96)+(B119), (A)+(B96)+(B120), (A)+(B96)+(B121), (A)+(B96)+(B122), (A)+(B96)+(B123), (A)+(B96)+(B124), (A)+(B96)+(B125), (A)+(B96)+(B126), (A)+(B96)+(B127), (A)+(B96)+(B128), (A)+(B96)+(B129), (A)+(B96)+(B130), (A)+(B96)+(B131), (A)+(B96)+(B132), (A)+(B96)+(B133), (A)+(B96)+(B134), (A)+(B96)+(B135), (A)+(B96)+(B136), (A)+(B96)+(B137), (A)+(B96)+(B138), (A)+(B96)+(B139), (A)+(B96)+(B140), (A)+(B96)+(B141), (A)+(B96)+(B142), (A)+(B96)+(B143), (A)+(B96)+(B144), (A)+(B96)+(B145), (A)+(B96)+(B146), (A)+(B96)+(B147), (A)+(B96)+(B148), (A)+(B96)+(B149), (A)+(B96)+(B150), (A)+(B96)+(B151), (A)+(B96)+(B152), (A)+(B96)+(B153), (A)+(B96)+(B154), (A)+(B96)+(B155), (A)+(B96)+(B156), (A)+(B96)+(B157), (A)+(B96)+(B158), (A)+(B96)+(B159), (A)+(B96)+(B160), (A)+(B96)+(B161), (A)+(B96)+(B162), (A)+(B96)+(B164), (A)+(B96)+(B164), (A)+(B96)+(B165), (A)+(B96)+(B166), (A)+(B96)+(B167), (A)+(B96)+(B168), (A)+(B96)+(B169), (A)+(B96)+(B170), (A)+(B96)+(B171), (A)+(B96)+(B172), (A)+(B96)+(B173), (A)+(B96)+(B174), (A)+(B96)+(B175), (A)+(B96)+(B176), (A)+(B96)+(B177), (A)+(B96)+(B178), (A)+(B96)+(B179), (A)+(B96)+(B180), (A)+(B96)+(B181), (A)+(B96)+(B182), (A)+(B96)+(B183), (A)+(B96)+(B184), (A)+(B96)+(B185), (A)+(B96)+(B186), (A)+(B96)+(B187), (A)+(B96)+(B188), (A)+(B96)+(B189), (A)+(B96)+(B190), (A)+(B96)+(B191), (A)+(B96)+(B192), (A)+(B96)+(B193), (A)+(B96)+(B194), (A)+(B96)+(B195), (A)+(B96)+(B196), (A)+(B96)+(B197), (A)+(B96)+(B198), (A)+(B96)+(B199), (A)+(B96)+(B200), (A)+(B96)+(B201), (A)+(B96)+(B202), (A)+(B96)+(B203), (A)+(B96)+(B204), (A)+(B96)+(B205), (A)+(B96)+(B206), (A)+(B96)+(B207), (A)+(B96)+(B208), (A)+(B96)+(B209), (A)+(B96)+(B210), (A)+(B96)+(B211), (A)+(B96)+(B212), (A)+(B96)+(B213), (A)+(B96)+(B214), (A)+(B96)+(B215), (A)+(B96)+(B216), (A)+(B96)+(B217), (A)+(B96)+(B218), (A)+(B96)+(B219), (A)+(B96)+(B220), (A)+(B96)+(B221), (A)+(B96)+(B222), (A)+(B96)+(B223), (A)+(B96)+(B224), (A)+(B96)+(B225), (A)+(B96)+(B226), (A)+(B96)+(B227), (A)+(B96)+(B228), (A)+(B96)+(B229), (A)+(B96)+(B230), (A)+(B96)+(B231), (A)+(B96)+(B232), (A)+(B96)+(B233), (A)+(B96)+(B234), (A)+(B96)+(B235), (A)+(B96)+(B236), (A)+(B96)+(B237), (A)+(B96)+(B238), (A)+(B96)+(B239), (A)+(B96)+(B240), (A)+(B96)+(B241), (A)+(B96)+(B242), (A)+(B96)+(B243), (A)+(B96)+(B244), (A)+(B96)+(B245), (A)+(B96)+(B246), (A)+(B96)+(B247), (A)+(B96)+(B248), (A)+(B96)+(B249), (A)+(B96)+(B250), (A)+(B96)+(B251), (A)+(B96)+(B252), (A)+(B96)+(B253), (A)+(B96)+(B254), (A)+(B96)+(B255), (A)+(B96)+(B256), (A)+(B96)+(B257), (A)+(B96)+(B258), (A)+(B96)+(B259), (A)+(B96)+(B260), (A)+(B96)+(B261), (A)+(B96)+(B262), (A)+(B96)+(B263), (A)+(B96)+(B264), (A)+(B96)+(B265), (A)+(B96)+(B266), (A)+(B96)+(B267), (A)+(B96)+(B268), (A)+(B96)+(B269), (A)+(B96)+(B270), (A)+(B96)+(B271), (A)+(B96)+(B272), (A)+(B96)+(B273), (A)+(B96)+(B274), (A)+(B96)+(B275), (A)+(B96)+(B276), (A)+(B96)+(B277), (A)+(B96)+(B278), (A)+(B96)+(B279), (A)+(B96)+(B280), (A)+(B96)+(B281), (A)+(B96)+(B282), (A)+(B96)+(B283), (A)+(B96)+(B284), (A)+(B96)+(B285), (A)+(B96)+(B286), (A)+(B96)+(B287), (A)+(B96)+(B288), (A)+(B96)+(B289), (A)+(B96)+(B290), (A)+(B96)+(B291), (A)+(B96)+(B292), (A)+(B96)+(B293), (A)+(B96)+(B294), (A)+(B96)+(B295), (A)+(B96)+(B296), (A)+(B96)+(B297), (A)+(B96)+(B298), (A)+(B96)+(B299), (A)+(B96)+(B300), (A)+(B96)+(B301), (A)+(B96)+(B302), (A)+(B96)+(B303), (A)+(B96)+(B304), (A)+(B96)+(B305), (A)+(B96)+(B306), (A)+(B96)+(B307), (A)+(B96)+(B308), (A)+(B96)+(B309), (A)+(B96)+(B310), (A)+(B96)+(B311), (A)+(B96)+(B312), (A)+(B96)+(B313), (A)+(B96)+(B314), (A)+(B96)+(B315),

(A)+(B97)+(B98), (A)+(B97)+(B99), (A)+(B97)+(B100), (A)+(B97)+(B101), (A)+(B97)+(B102), (A)+(B97)+(B103), (A)+(B97)+(B104), (A)+(B97)+(B105), (A)+(B97)+(B106), (A)+(B97)+(B107), (A)+(B97)+(B108), (A)+(B97)+(B109), (A)+(B97)+(B110), (A)+(B97)+(B111), (A)+(B97)+(B112), (A)+(B97)+(B113), (A)+(B97)+(B114), (A)+(B97)+(B115), (A)+(B97)+(B116), (A)+(B97)+(B117), (A)+(B97)+(B118), (A)+(B97)+(B119), (A)+(B97)+(B120), (A)+(B97)+(B121), (A)+(B97)+(B122), (A)+(B97)+(B123), (A)+(B97)+(B124), (A)+(B97)+(B125), (A)+(B97)+(B126), (A)+(B97)+(B127), (A)+(B97)+(B128), (A)+(B97)+(B129), (A)+(B97)+(B130), (A)+(B97)+(B131), (A)+(B97)+(B132), (A)+(B97)+(B133), (A)+(B97)+(B134), (A)+(B97)+(B135), (A)+(B97)+(B136), (A)+(B97)+(B137), (A)+(B97)+(B138), (A)+(B97)+(B139), (A)+(B97)+(B140), (A)+(B97)+(B141), (A)+(B97)+(B142), (A)+(B97)+(B143), (A)+(B97)+(B144), (A)+(B97)+(B145), (A)+(B97)+(B146), (A)+(B97)+(B147), (A)+(B97)+(B148), (A)+(B97)+(B149), (A)+(B97)+(B150), (A)+(B97)+(B151), (A)+(B97)+(B152), (A)+(B97)+(B153), (A)+(B97)+(B154), (A)+(B97)+(B155), (A)+(B97)+(B156), (A)+(B97)+(B157), (A)+(B97)+(B158), (A)+(B97)+(B159), (A)+(B97)+(B160), (A)+(B97)+(B161), (A)+(B97)+(B162), (A)+(B97)+(B164), (A)+(B97)+(B164), (A)+(B97)+(B165), (A)+(B97)+(B166), (A)+(B97)+(B167), (A)+(B97)+(B168), (A)+(B97)+(B169), (A)+(B97)+(B170), (A)+(B97)+(B171), (A)+(B97)+(B172), (A)+(B97)+(B173), (A)+(B97)+(B174), (A)+(B97)+(B175), (A)+(B97)+(B176), (A)+(B97)+(B177), (A)+(B97)+(B178), (A)+(B97)+(B179), (A)+(B97)+(B180), (A)+(B97)+(B181), (A)+(B97)+(B182), (A)+(B97)+(B183), (A)+(B97)+(B184), (A)+(B97)+(B185), (A)+(B97)+(B186), (A)+(B97)+(B187), (A)+(B97)+(B188), (A)+(B97)+(B189), (A)+(B97)+(B190), (A)+(B97)+(B191), (A)+(B97)+(B192), (A)+(B97)+(B193), (A)+(B97)+(B194), (A)+(B97)+(B195), (A)+(B97)+(B196), (A)+(B97)+(B197), (A)+(B97)+(B198), (A)+(B97)+(B199), (A)+(B97)+(B200), (A)+(B97)+(B201), (A)+(B97)+(B202), (A)+(B97)+(B203), (A)+(B97)+(B204), (A)+(B97)+(B205), (A)+(B97)+(B206), (A)+(B97)+(B207), (A)+(B97)+(B208), (A)+(B97)+(B209), (A)+(B97)+(B210), (A)+(B97)+(B211), (A)+(B97)+(B212), (A)+(B97)+(B213), (A)+(B97)+(B214), (A)+(B97)+(B215), (A)+(B97)+(B216), (A)+(B97)+(B217), (A)+(B97)+(B218), (A)+(B97)+(B219), (A)+(B97)+(B220), (A)+(B97)+(B221), (A)+(B97)+(B222), (A)+(B97)+(B223), (A)+(B97)+(B224), (A)+(B97)+(B225), (A)+(B97)+(B226), (A)+(B97)+(B227), (A)+(B97)+(B228), (A)+(B97)+(B229), (A)+(B97)+(B230), (A)+(B97)+(B231), (A)+(B97)+(B232), (A)+(B97)+(B233), (A)+(B97)+(B234), (A)+(B97)+(B235), (A)+(B97)+(B236), (A)+(B97)+(B237), (A)+(B97)+(B238), (A)+(B97)+(B239), (A)+(B97)+(B240), (A)+(B97)+(B241), (A)+(B97)+(B242), (A)+(B97)+(B243), (A)+(B97)+(B244), (A)+(B97)+(B245), (A)+(B97)+(B246), (A)+(B97)+(B247), (A)+(B97)+(B248), (A)+(B97)+(B249), (A)+(B97)+(B250), (A)+(B97)+(B251), (A)+(B97)+(B252), (A)+(B97)+(B253), (A)+(B97)+(B254), (A)+(B97)+(B255), (A)+(B97)+(B256), (A)+(B97)+(B257), (A)+(B97)+(B258), (A)+(B97)+(B259), (A)+(B97)+(B260), (A)+(B97)+(B261), (A)+(B97)+(B262), (A)+(B97)+(B263), (A)+(B97)+(B264), (A)+(B97)+(B265), (A)+(B97)+(B266), (A)+(B97)+(B267), (A)+(B97)+(B268), (A)+(B97)+(B269), (A)+(B97)+(B270), (A)+(B97)+(B271), (A)+(B97)+(B272), (A)+(B97)+(B273), (A)+(B97)+(B274), (A)+(B97)+(B275), (A)+(B97)+(B276), (A)+(B97)+(B277), (A)+(B97)+(B278), (A)+(B97)+(B279), (A)+(B97)+(B280), (A)+(B97)+(B281), (A)+(B97)+(B282), (A)+(B97)+(B283), (A)+(B97)+(B284), (A)+(B97)+(B285), (A)+(B97)+(B286), (A)+(B97)+(B287), (A)+(B97)+(B288), (A)+(B97)+(B289), (A)+(B97)+(B290), (A)+(B97)+(B291), (A)+(B97)+(B292), (A)+(B97)+(B293), (A)+(B97)+(B294), (A)+(B97)+(B295), (A)+(B97)+(B296), (A)+(B97)+(B297), (A)+(B97)+(B298), (A)+(B97)+(B299), (A)+(B97)+(B300), (A)+(B97)+(B301), (A)+(B97)+(B302), (A)+(B97)+(B303), (A)+(B97)+(B304), (A)+(B97)+(B305), (A)+(B97)+(B306), (A)+(B97)+(B307), (A)+(B97)+(B308), (A)+(B97)+(B309), (A)+(B97)+(B310), (A)+(B97)+(B311), (A)+(B97)+(B312), (A)+(B97)+(B313), (A)+(B97)+(B314), (A)+(B97)+(B315),

(A)+(B98)+(B99), (A)+(B98)+(B100), (A)+(B98)+(B101), (A)+(B98)+(B102), (A)+(B98)+(B103), (A)+(B98)+(B104), (A)+(B98)+(B105), (A)+(B98)+(B106), (A)+(B98)+(B107), (A)+(B98)+(B108), (A)+(B98)+(B109), (A)+(B98)+(B110), (A)+(B98)+(B111), (A)+(B98)+(B112), (A)+(B98)+(B113), (A)+(B98)+(B114), (A)+(B98)+(B115), (A)+(B98)+(B116), (A)+(B98)+(B117), (A)+(B98)+(B118), (A)+(B98)+(B119), (A)+(B98)+(B120), (A)+(B98)+(B121), (A)+(B98)+(B122), (A)+(B98)+(B123), (A)+(B98)+(B124), (A)+(B98)+(B125), (A)+(B98)+(B126), (A)+(B98)+(B127), (A)+(B98)+(B128), (A)+(B98)+(B129), (A)+(B98)+(B130), (A)+(B98)+(B131), (A)+(B98)+(B132), (A)+(B98)+(B133), (A)+(B98)+(B134), (A)+(B98)+(B135), (A)+(B98)+(B136), (A)+(B98)+(B137), (A)+(B98)+(B138), (A)+(B98)+(B139), (A)+(B98)+(B140), (A)+(B98)+(B141), (A)+(B98)+(B142), (A)+(B98)+(B143), (A)+(B98)+(B144), (A)+(B98)+(B145), (A)+(B98)+(B146), (A)+(B98)+(B147), (A)+(B98)+(B148), (A)+(B98)+(B149), (A)+(B98)+(B150), (A)+(B98)+(B151), (A)+(B98)+(B152), (A)+(B98)+(B153), (A)+(B98)+(B154), (A)+(B98)+(B155), (A)+(B98)+(B156), (A)+(B98)+(B157), (A)+(B98)+(B158), (A)+(B98)+(B159), (A)+(B98)+(B160), (A)+(B98)+(B161), (A)+(B98)+(B162), (A)+(B98)+(B164), (A)+(B98)+(B164), (A)+(B98)+(B165), (A)+(B98)+(B166), (A)+(B98)+(B167), (A)+(B98)+(B168), (A)+(B98)+(B169), (A)+(B98)+(B170), (A)+(B98)+(B171), (A)+(B98)+(B172), (A)+(B98)+(B173), (A)+(B98)+(B174), (A)+(B98)+(B175), (A)+(B98)+(B176), (A)+(B98)+(B177), (A)+(B98)+(B178), (A)+(B98)+(B179), (A)+(B98)+(B180), (A)+(B98)+(B181), (A)+(B98)+(B182), (A)+(B98)+(B183), (A)+(B98)+(B184), (A)+(B98)+(B185), (A)+(B98)+(B186), (A)+(B98)+(B187), (A)+(B98)+(B188), (A)+(B98)+(B189), (A)+(B98)+(B190), (A)+(B98)+(B191), (A)+(B98)+(B192), (A)+(B98)+(B193), (A)+(B98)+(B194), (A)+(B98)+(B195), (A)+(B98)+(B196), (A)+(B98)+(B197), (A)+(B98)+(B198), (A)+(B98)+(B199), (A)+(B98)+(B200), (A)+(B98)+(B201), (A)+(B98)+(B202), (A)+(B98)+(B203), (A)+(B98)+(B204), (A)+(B98)+(B205), (A)+(B98)+(B206), (A)+(B98)+(B207), (A)+(B98)+(B208), (A)+(B98)+(B209), (A)+(B98)+(B210), (A)+(B98)+(B211), (A)+(B98)+(B212), (A)+(B98)+(B213), (A)+(B98)+(B214), (A)+(B98)+(B215), (A)+(B98)+(B216), (A)+(B98)+(B217), (A)+(B98)+(B218), (A)+(B98)+(B219), (A)+(B98)+(B220), (A)+(B98)+(B221), (A)+(B98)+(B222), (A)+(B98)+(B223), (A)+(B98)+(B224), (A)+(B98)+(B225), (A)+(B98)+(B226), (A)+(B98)+(B227), (A)+(B98)+(B228), (A)+(B98)+(B229), (A)+(B98)+(B230), (A)+(B98)+(B231), (A)+(B98)+(B232), (A)+(B98)+(B233), (A)+(B98)+(B234), (A)+(B98)+(B235), (A)+(B98)+(B236), (A)+(B98)+(B237), (A)+(B98)+(B238), (A)+(B98)+(B239), (A)+(B98)+(B240), (A)+(B98)+(B241), (A)+(B98)+(B242), (A)+(B98)+(B243), (A)+(B98)+(B244), (A)+(B98)+(B245), (A)+(B98)+(B246), (A)+(B98)+(B247), (A)+(B98)+(B248), (A)+(B98)+(B249), (A)+(B98)+(B250), (A)+(B98)+(B251), (A)+(B98)+(B252), (A)+(B98)+(B253), (A)+(B98)+(B254), (A)+(B98)+(B255), (A)+(B98)+(B256), (A)+(B98)+(B257), (A)+(B98)+(B258), (A)+(B98)+(B259), (A)+(B98)+(B260), (A)+(B98)+(B261), (A)+(B98)+(B262), (A)+(B98)+(B263), (A)+(B98)+(B264), (A)+(B98)+(B265), (A)+(B98)+(B266), (A)+(B98)+(B267), (A)+(B98)+(B268), (A)+(B98)+(B269), (A)+(B98)+(B270), (A)+(B98)+(B271), (A)+(B98)+(B272), (A)+(B98)+(B273), (A)+(B98)+(B274), (A)+(B98)+(B275), (A)+(B98)+(B276), (A)+(B98)+(B277), (A)+(B98)+(B278), (A)+(B98)+(B279), (A)+(B98)+(B280), (A)+(B98)+(B281), (A)+(B98)+(B282), (A)+(B98)+(B283), (A)+(B98)+(B284), (A)+(B98)+(B285), (A)+(B98)+(B286), (A)+(B98)+(B287), (A)+(B98)+(B288), (A)+(B98)+(B289), (A)+(B98)+(B290), (A)+(B98)+(B291), (A)+(B98)+(B292), (A)+(B98)+(B293), (A)+(B98)+(B294), (A)+(B98)+(B295), (A)+(B98)+(B296), (A)+(B98)+(B297), (A)+(B98)+(B298), (A)+(B98)+(B299), (A)+(B98)+(B300), (A)+(B98)+(B301), (A)+(B98)+(B302), (A)+(B98)+(B303), (A)+(B98)+(B304), (A)+(B98)+(B305), (A)+(B98)+(B306), (A)+(B98)+(B307), (A)+(B98)+(B308), (A)+(B98)+(B309), (A)+(B98)+(B310), (A)+(B98)+(B311), (A)+(B98)+(B312), (A)+(B98)+(B313), (A)+(B98)+(B314), (A)+(B98)+(B315),

(A)+(B99)+(B100), (A)+(B99)+(B101), (A)+(B99)+(B102), (A)+(B99)+(B103), (A)+(B99)+(B104), (A)+(B99)+(B105), (A)+(B99)+(B106), (A)+(B99)+(B107), (A)+(B99)+(B108), (A)+(B99)+(B109), (A)+(B99)+(B110), (A)+(B99)+(B111), (A)+(B99)+(B112), (A)+(B99)+(B113), (A)+(B99)+(B114), (A)+(B99)+(B115), (A)+(B99)+(B116), (A)+(B99)+(B117), (A)+(B99)+(B118), (A)+(B99)+(B119), (A)+(B99)+(B120), (A)+(B99)+(B121), (A)+(B99)+(B122), (A)+(B99)+(B123), (A)+(B99)+(B124), (A)+(B99)+(B125), (A)+(B99)+(B126), (A)+(B99)+(B127), (A)+(B99)+(B128), (A)+(B99)+(B129), (A)+(B99)+(B130), (A)+(B99)+(B131), (A)+(B99)+(B132), (A)+(B99)+(B133), (A)+(B99)+(B134), (A)+(B99)+(B135), (A)+(B99)+(B136), (A)+(B99)+(B137), (A)+(B99)+(B138), (A)+(B99)+(B139), (A)+(B99)+(B140), (A)+(B99)+(B141), (A)+(B99)+(B142), (A)+(B99)+(B143), (A)+(B99)+(B144), (A)+(B99)+(B145), (A)+(B99)+(B146), (A)+(B99)+(B147), (A)+(B99)+(B148), (A)+(B99)+(B149), (A)+(B99)+(B150), (A)+(B99)+(B151), (A)+(B99)+(B152), (A)+(B99)+(B153), (A)+(B99)+(B154), (A)+(B99)+(B155), (A)+(B99)+(B156), (A)+(B99)+(B157), (A)+(B99)+(B158), (A)+(B99)+(B159), (A)+(B99)+(B160), (A)+(B99)+(B161), (A)+(B99)+(B162), (A)+(B99)+(B164), (A)+(B99)+(B164), (A)+(B99)+(B165), (A)+(B99)+(B166), (A)+(B99)+(B167), (A)+(B99)+(B168), (A)+(B99)+(B169), (A)+(B99)+(B170), (A)+(B99)+(B171), (A)+(B99)+(B172), (A)+(B99)+(B173), (A)+(B99)+(B174), (A)+(B99)+(B175), (A)+(B99)+(B176), (A)+(B99)+(B177), (A)+(B99)+(B178), (A)+(B99)+(B179), (A)+(B99)+(B180), (A)+(B99)+(B181), (A)+(B99)+(B182), (A)+(B99)+(B183), (A)+(B99)+(B184), (A)+(B99)+(B185), (A)+(B99)+(B186), (A)+(B99)+(B187), (A)+(B99)+(B188), (A)+(B99)+(B189), (A)+(B99)+(B190), (A)+(B99)+(B191), (A)+(B99)+(B192), (A)+(B99)+(B193), (A)+(B99)+(B194), (A)+(B99)+(B195), (A)+(B99)+(B196), (A)+(B99)+(B197), (A)+(B99)+(B198), (A)+(B99)+(B199), (A)+(B99)+(B200), (A)+(B99)+(B201), (A)+(B99)+(B202), (A)+(B99)+(B203), (A)+(B99)+(B204), (A)+(B99)+(B205), (A)+(B99)+(B206), (A)+(B99)+(B207), (A)+(B99)+(B208), (A)+(B99)+(B209), (A)+(B99)+(B210), (A)+(B99)+(B211), (A)+(B99)+(B212), (A)+(B99)+(B213), (A)+(B99)+(B214), (A)+(B99)+(B215), (A)+(B99)+(B216), (A)+(B99)+(B217), (A)+(B99)+(B218), (A)+(B99)+(B219), (A)+(B99)+(B220), (A)+(B99)+(B221), (A)+(B99)+(B222), (A)+(B99)+(B223), (A)+(B99)+(B224), (A)+(B99)+(B225), (A)+(B99)+(B226), (A)+(B99)+(B227), (A)+(B99)+(B228), (A)+(B99)+(B229), (A)+(B99)+(B230), (A)+(B99)+(B231), (A)+(B99)+(B232), (A)+(B99)+(B233), (A)+(B99)+(B234), (A)+(B99)+(B235), (A)+(B99)+(B236), (A)+(B99)+(B237), (A)+(B99)+(B238), (A)+(B99)+(B239), (A)+(B99)+(B240), (A)+(B99)+(B241), (A)+(B99)+(B242), (A)+(B99)+(B243), (A)+(B99)+(B244), (A)+(B99)+(B245), (A)+(B99)+(B246), (A)+(B99)+(B247), (A)+(B99)+(B248), (A)+(B99)+(B249), (A)+(B99)+(B250), (A)+(B99)+(B251), (A)+(B99)+(B252), (A)+(B99)+(B253), (A)+(B99)+(B254), (A)+(B99)+(B255), (A)+(B99)+(B256), (A)+(B99)+(B257), (A)+(B99)+(B258), (A)+(B99)+(B259), (A)+(B99)+(B260), (A)+(B99)+(B261), (A)+(B99)+(B262), (A)+(B99)+(B263), (A)+(B99)+(B264), (A)+(B99)+(B265), (A)+(B99)+(B266), (A)+(B99)+(B267), (A)+(B99)+(B268), (A)+(B99)+(B269), (A)+(B99)+(B270), (A)+(B99)+(B271), (A)+(B99)+(B272), (A)+(B99)+(B273), (A)+(B99)+(B274), (A)+(B99)+(B275), (A)+(B99)+(B276), (A)+(B99)+(B277), (A)+(B99)+(B278), (A)+(B99)+(B279), (A)+(B99)+(B280), (A)+(B99)+(B281), (A)+(B99)+(B282), (A)+(B99)+(B283), (A)+(B99)+(B284), (A)+(B99)+(B285), (A)+(B99)+(B286), (A)+(B99)+(B287), (A)+(B99)+(B288), (A)+(B99)+(B289), (A)+(B99)+(B290), (A)+(B99)+(B291), (A)+(B99)+(B292), (A)+(B99)+(B293), (A)+(B99)+(B294), (A)+(B99)+(B295), (A)+(B99)+(B296), (A)+(B99)+(B297), (A)+(B99)+(B298), (A)+(B99)+(B299), (A)+(B99)+(B300), (A)+(B99)+(B301), (A)+(B99)+(B302), (A)+(B99)+(B303), (A)+(B99)+(B304), (A)+(B99)+(B305), (A)+(B99)+(B306), (A)+(B99)+(B307), (A)+(B99)+(B308), (A)+(B99)+(B309), (A)+(B99)+(B310), (A)+(B99)+(B311), (A)+(B99)+(B312), (A)+(B99)+(B313), (A)+(B99)+(B314), (A)+(B99)+(B315),

(A)+(B100)+(B101), (A)+(B100)+(B102), (A)+(B100)+(B103), (A)+(B100)+(B104), (A)+(B100)+(B105), (A)+(B100)+(B106), (A)+(B100)+(B107), (A)+(B100)+(B108), (A)+(B100)+(B109), (A)+(B100)+(B110), (A)+(B100)+(B111), (A)+(B100)+(B112), (A)+(B100)+(B113), (A)+(B100)+(B114), (A)+(B100)+(B115), (A)+(B100)+(B116), (A)+(B100)+(B117), (A)+(B100)+(B118), (A)+(B100)+(B119), (A)+(B100)+(B120), (A)+(B100)+(B121), (A)+(B100)+(B122), (A)+(B100)+(B123), (A)+(B100)+(B124), (A)+(B100)+(B125), (A)+(B100)+(B126), (A)+(B100)+(B127), (A)+(B100)+(B128), (A)+(B100)+(B129), (A)+(B100)+(B130), (A)+(B100)+(B131), (A)+(B100)+(B132), (A)+(B100)+(B133), (A)+(B100)+(B134), (A)+(B100)+(B135), (A)+(B100)+(B136), (A)+(B100)+(B137), (A)+(B100)+(B138), (A)+(B100)+(B139), (A)+(B100)+(B140), (A)+(B100)+(B141), (A)+(B100)+(B142), (A)+(B100)+(B143), (A)+(B100)+(B144), (A)+(B100)+(B145), (A)+(B100)+(B146), (A)+(B100)+(B147), (A)+(B100)+(B148), (A)+(B100)+(B149), (A)+(B100)+(B150), (A)+(B100)+(B151), (A)+(B100)+(B152), (A)+(B100)+(B153), (A)+(B100)+(B154), (A)+(B100)+(B155), (A)+(B100)+(B156), (A)+(B100)+(B157), (A)+(B100)+(B158), (A)+(B100)+(B159), (A)+(B100)+(B160), (A)+(B100)+(B161), (A)+(B100)+(B162), (A)+(B100)+(B164), (A)+(B100)+(B164), (A)+(B100)+(B165), (A)+(B100)+(B166), (A)+(B100)+(B167), (A)+(B100)+(B168), (A)+(B100)+(B169), (A)+(B100)+(B170), (A)+(B100)+(B171), (A)+(B100)+(B172), (A)+(B100)+(B173), (A)+(B100)+(B174), (A)+(B100)+(B175), (A)+(B100)+(B176), (A)+(B100)+(B177), (A)+(B100)+(B178), (A)+(B100)+(B179), (A)+(B100)+(B180), (A)+(B100)+(B181), (A)+(B100)+(B182), (A)+(B100)+(B183), (A)+(B100)+(B184), (A)+(B100)+(B185), (A)+(B100)+(B186), (A)+(B100)+(B187), (A)+(B100)+(B188), (A)+(B100)+(B189), (A)+(B100)+(B190), (A)+(B100)+(B191), (A)+(B100)+(B192), (A)+(B100)+(B193), (A)+(B100)+(B194), (A)+(B100)+(B195), (A)+(B100)+(B196), (A)+(B100)+(B197), (A)+(B100)+(B198), (A)+(B100)+(B199), (A)+(B100)+(B200), (A)+(B100)+(B201), (A)+(B100)+(B202), (A)+(B100)+(B203), (A)+(B100)+(B204), (A)+(B100)+(B205), (A)+(B100)+(B206), (A)+(B100)+(B207), (A)+(B100)+(B208), (A)+(B100)+(B209), (A)+(B100)+(B210), (A)+(B100)+(B211), (A)+(B100)+(B212), (A)+(B100)+(B213), (A)+(B100)+(B214), (A)+(B100)+(B215), (A)+(B100)+(B216), (A)+(B100)+(B217), (A)+(B100)+(B218), (A)+(B100)+(B219), (A)+(B100)+(B220), (A)+(B100)+(B221), (A)+(B100)+(B222), (A)+(B100)+(B223), (A)+(B100)+(B224), (A)+(B100)+(B225), (A)+(B100)+(B226), (A)+(B100)+(B227), (A)+(B100)+(B228), (A)+(B100)+(B229), (A)+(B100)+(B230), (A)+(B100)+(B231), (A)+(B100)+(B232), (A)+(B100)+(B233), (A)+(B100)+(B234), (A)+(B100)+(B235), (A)+(B100)+(B236), (A)+(B100)+(B237), (A)+(B100)+(B238), (A)+(B100)+(B239), (A)+(B100)+(B240), (A)+(B100)+(B241), (A)+(B100)+(B242), (A)+(B100)+(B243), (A)+(B100)+(B244), (A)+(B100)+(B245), (A)+(B100)+(B246), (A)+(B100)+(B247), (A)+(B100)+(B248), (A)+(B100)+(B249), (A)+(B100)+(B250), (A)+(B100)+(B251), (A)+(B100)+(B252), (A)+(B100)+(B253), (A)+(B100)+(B254), (A)+(B100)+(B255), (A)+(B100)+(B256), (A)+(B100)+(B257), (A)+(B100)+(B258), (A)+(B100)+(B259), (A)+(B100)+(B260), (A)+(B100)+(B261), (A)+(B100)+(B262), (A)+(B100)+(B263), (A)+(B100)+(B264), (A)+(B100)+(B265), (A)+(B100)+(B266), (A)+(B100)+(B267), (A)+(B100)+(B268), (A)+(B100)+(B269), (A)+(B100)+(B270), (A)+(B100)+(B271), (A)+(B100)+(B272), (A)+(B100)+(B273), (A)+(B100)+(B274), (A)+(B100)+(B275), (A)+(B100)+(B276), (A)+(B100)+(B277), (A)+(B100)+(B278), (A)+(B100)+(B279), (A)+(B100)+(B280), (A)+(B100)+(B281), (A)+(B100)+(B282), (A)+(B100)+(B283), (A)+(B100)+(B284), (A)+(B100)+(B285), (A)+(B100)+(B286), (A)+(B100)+(B287), (A)+(B100)+(B288), (A)+(B100)+(B289), (A)+(B100)+(B290), (A)+(B100)+(B291), (A)+(B100)+(B292), (A)+(B100)+(B293), (A)+(B100)+(B294), (A)+(B100)+(B295), (A)+(B100)+(B296), (A)+(B100)+(B297), (A)+(B100)+(B298), (A)+(B100)+(B299), (A)+(B100)+(B300), (A)+(B100)+(B301), (A)+(B100)+(B302), (A)+(B100)+(B303), (A)+(B100)+(B304), (A)+(B100)+(B305), (A)+(B100)+(B306), (A)+(B100)+(B307), (A)+(B100)+(B308), (A)+(B100)+(B309), (A)+(B100)+(B310), (A)+(B100)+(B311), (A)+(B100)+(B312), (A)+(B100)+(B313), (A)+(B100)+(B314), (A)+(B100)+(B315),

(A)+(B101)+(B102), (A)+(B101)+(B103), (A)+(B101)+(B104), (A)+(B101)+(B105), (A)+(B101)+(B106), (A)+(B101)+(B107), (A)+(B101)+(B108), (A)+(B101)+(B109), (A)+(B101)+(B110), (A)+(B101)+(B111), (A)+(B101)+(B112), (A)+(B101)+(B113), (A)+(B101)+(B114), (A)+(B101)+(B115), (A)+(B101)+(B116), (A)+(B101)+(B117), (A)+(B101)+(B118), (A)+(B101)+(B119), (A)+(B101)+(B120), (A)+(B101)+(B121), (A)+(B101)+(B122), (A)+(B101)+(B123), (A)+(B101)+(B124), (A)+(B101)+(B125), (A)+(B101)+(B126), (A)+(B101)+(B127), (A)+(B101)+(B128), (A)+(B101)+(B129), (A)+(B101)+(B130), (A)+(B101)+(B131), (A)+(B101)+(B132), (A)+(B101)+(B133), (A)+(B101)+(B134), (A)+(B101)+(B135), (A)+(B101)+(B136), (A)+(B101)+(B137), (A)+(B101)+(B138), (A)+(B101)+(B139), (A)+(B101)+(B140), (A)+(B101)+(B141), (A)+(B101)+(B142), (A)+(B101)+(B143), (A)+(B101)+(B144), (A)+(B101)+(B145), (A)+(B101)+(B146), (A)+(B101)+(B147), (A)+(B101)+(B148), (A)+(B101)+(B149), (A)+(B101)+(B150), (A)+(B101)+(B151), (A)+(B101)+(B152), (A)+(B101)+(B153), (A)+(B101)+(B154), (A)+(B101)+(B155), (A)+(B101)+(B156), (A)+(B101)+(B157), (A)+(B101)+(B158), (A)+(B101)+(B159), (A)+(B101)+(B160), (A)+(B101)+(B161), (A)+(B101)+(B162), (A)+(B101)+(B164), (A)+(B101)+(B164), (A)+(B101)+(B165), (A)+(B101)+(B166), (A)+(B101)+(B167), (A)+(B101)+(B168), (A)+(B101)+(B169), (A)+(B101)+(B170), (A)+(B101)+(B171), (A)+(B101)+(B172), (A)+(B101)+(B173), (A)+(B101)+(B174), (A)+(B101)+(B175), (A)+(B101)+(B176), (A)+(B101)+(B177), (A)+(B101)+(B178), (A)+(B101)+(B179), (A)+(B101)+(B180), (A)+(B101)+(B181), (A)+(B101)+(B182), (A)+(B101)+(B183), (A)+(B101)+(B184), (A)+(B101)+(B185), (A)+(B101)+(B186), (A)+(B101)+(B187), (A)+(B101)+(B188), (A)+(B101)+(B189), (A)+(B101)+(B190), (A)+(B101)+(B191), (A)+(B101)+(B192), (A)+(B101)+(B193), (A)+(B101)+(B194), (A)+(B101)+(B195), (A)+(B101)+(B196), (A)+(B101)+(B197), (A)+(B101)+(B198), (A)+(B101)+(B199), (A)+(B101)+(B200), (A)+(B101)+(B201), (A)+(B101)+(B202), (A)+(B101)+(B203), (A)+(B101)+(B204), (A)+(B101)+(B205), (A)+(B101)+(B206), (A)+(B101)+(B207), (A)+(B101)+(B208), (A)+(B101)+(B209), (A)+(B101)+(B210), (A)+(B101)+(B211), (A)+(B101)+(B212), (A)+(B101)+(B213), (A)+(B101)+(B214), (A)+(B101)+(B215), (A)+(B101)+(B216), (A)+(B101)+(B217), (A)+(B101)+(B218), (A)+(B101)+(B219), (A)+(B101)+(B220), (A)+(B101)+(B221), (A)+(B101)+(B222), (A)+(B101)+(B223), (A)+(B101)+(B224), (A)+(B101)+(B225), (A)+(B101)+(B226), (A)+(B101)+(B227), (A)+(B101)+(B228), (A)+(B101)+(B229), (A)+(B101)+(B230), (A)+(B101)+(B231), (A)+(B101)+(B232), (A)+(B101)+(B233), (A)+(B101)+(B234), (A)+(B101)+(B235), (A)+(B101)+(B236), (A)+(B101)+(B237), (A)+(B101)+(B238), (A)+(B101)+(B239), (A)+(B101)+(B240), (A)+(B101)+(B241), (A)+(B101)+(B242), (A)+(B101)+(B243), (A)+(B101)+(B244), (A)+(B101)+(B245), (A)+(B101)+(B246), (A)+(B101)+(B247), (A)+(B101)+(B248), (A)+(B101)+(B249), (A)+(B101)+(B250), (A)+(B101)+(B251), (A)+(B101)+(B252), (A)+(B101)+(B253), (A)+(B101)+(B254), (A)+(B101)+(B255), (A)+(B101)+(B256), (A)+(B101)+(B257), (A)+(B101)+(B258), (A)+(B101)+(B259), (A)+(B101)+(B260), (A)+(B101)+(B261), (A)+(B101)+(B262), (A)+(B101)+(B263), (A)+(B101)+(B264), (A)+(B101)+(B265), (A)+(B101)+(B266), (A)+(B101)+(B267), (A)+(B101)+(B268), (A)+(B101)+(B269), (A)+(B101)+(B270), (A)+(B101)+(B271), (A)+(B101)+(B272), (A)+(B101)+(B273), (A)+(B101)+(B274), (A)+(B101)+(B275), (A)+(B101)+(B276), (A)+(B101)+(B277), (A)+(B101)+(B278), (A)+(B101)+(B279), (A)+(B101)+(B280), (A)+(B101)+(B281), (A)+(B101)+(B282), (A)+(B101)+(B283), (A)+(B101)+(B284), (A)+(B101)+(B285), (A)+(B101)+(B286), (A)+(B101)+(B287), (A)+(B101)+(B288), (A)+(B101)+(B289), (A)+(B101)+(B290), (A)+(B101)+(B291), (A)+(B101)+(B292), (A)+(B101)+(B293), (A)+(B101)+(B294), (A)+(B101)+(B295), (A)+(B101)+(B296), (A)+(B101)+(B297), (A)+(B101)+(B298), (A)+(B101)+(B299), (A)+(B101)+(B300), (A)+(B101)+(B301), (A)+(B101)+(B302), (A)+(B101)+(B303), (A)+(B101)+(B304), (A)+(B101)+(B305), (A)+(B101)+(B306), (A)+(B101)+(B307), (A)+(B101)+(B308), (A)+(B101)+(B309), (A)+(B101)+(B310), (A)+(B101)+(B311), (A)+(B101)+(B312), (A)+(B101)+(B313), (A)+(B101)+(B314), (A)+(B101)+(B315),

(A)+(B102)+(B103), (A)+(B102)+(B104), (A)+(B102)+(B105), (A)+(B102)+(B106), (A)+(B102)+(B107), (A)+(B102)+(B108), (A)+(B102)+(B109), (A)+(B102)+(B110), (A)+(B102)+(B111), (A)+(B102)+(B112), (A)+(B102)+(B113), (A)+(B102)+(B114), (A)+(B102)+(B115), (A)+(B102)+(B116), (A)+(B102)+(B117), (A)+(B102)+(B118), (A)+(B102)+(B119), (A)+(B102)+(B120), (A)+(B102)+(B121), (A)+(B102)+(B122), (A)+(B102)+(B123), (A)+(B102)+(B124), (A)+(B102)+(B125), (A)+(B102)+(B126), (A)+(B102)+(B127), (A)+(B102)+(B128), (A)+(B102)+(B129), (A)+(B102)+(B130), (A)+(B102)+(B131), (A)+(B102)+(B132), (A)+(B102)+(B133), (A)+(B102)+(B134), (A)+(B102)+(B135), (A)+(B102)+(B136), (A)+(B102)+(B137), (A)+(B102)+(B138), (A)+(B102)+(B139), (A)+(B102)+(B140), (A)+(B102)+(B141), (A)+(B102)+(B142), (A)+(B102)+(B143), (A)+(B102)+(B144), (A)+(B102)+(B145), (A)+(B102)+(B146), (A)+(B102)+(B147), (A)+(B102)+(B148), (A)+(B102)+(B149), (A)+(B102)+(B150), (A)+(B102)+(B151), (A)+(B102)+(B152), (A)+(B102)+(B153), (A)+(B102)+(B154), (A)+(B102)+(B155), (A)+(B102)+(B156), (A)+(B102)+(B157), (A)+(B102)+(B158), (A)+(B102)+(B159), (A)+(B102)+(B160), (A)+(B102)+(B161), (A)+(B102)+(B162), (A)+(B102)+(B164), (A)+(B102)+(B164), (A)+(B102)+(B165), (A)+(B102)+(B166), (A)+(B102)+(B167), (A)+(B102)+(B168), (A)+(B102)+(B169), (A)+(B102)+(B170), (A)+(B102)+(B171), (A)+(B102)+(B172), (A)+(B102)+(B173), (A)+(B102)+(B174), (A)+(B102)+(B175), (A)+(B102)+(B176), (A)+(B102)+(B177), (A)+(B102)+(B178), (A)+(B102)+(B179), (A)+(B102)+(B180), (A)+(B102)+(B181), (A)+(B102)+(B182), (A)+(B102)+(B183), (A)+(B102)+(B184), (A)+(B102)+(B185), (A)+(B102)+(B186), (A)+(B102)+(B187), (A)+(B102)+(B188), (A)+(B102)+(B189), (A)+(B102)+(B190), (A)+(B102)+(B191), (A)+(B102)+(B192), (A)+(B102)+(B193), (A)+(B102)+(B194), (A)+(B102)+(B195), (A)+(B102)+(B196), (A)+(B102)+(B197), (A)+(B102)+(B198), (A)+(B102)+(B199), (A)+(B102)+(B200), (A)+(B102)+(B201), (A)+(B102)+(B202), (A)+(B102)+(B203), (A)+(B102)+(B204), (A)+(B102)+(B205), (A)+(B102)+(B206), (A)+(B102)+(B207), (A)+(B102)+(B208), (A)+(B102)+(B209), (A)+(B102)+(B210), (A)+(B102)+(B211), (A)+(B102)+(B212), (A)+(B102)+(B213), (A)+(B102)+(B214), (A)+(B102)+(B215), (A)+(B102)+(B216), (A)+(B102)+(B217), (A)+(B102)+(B218), (A)+(B102)+(B219), (A)+(B102)+(B220), (A)+(B102)+(B221), (A)+(B102)+(B222), (A)+(B102)+(B223), (A)+(B102)+(B224), (A)+(B102)+(B225), (A)+(B102)+(B226), (A)+(B102)+(B227), (A)+(B102)+(B228), (A)+(B102)+(B229), (A)+(B102)+(B230), (A)+(B102)+(B231), (A)+(B102)+(B232), (A)+(B102)+(B233), (A)+(B102)+(B234), (A)+(B102)+(B235), (A)+(B102)+(B236), (A)+(B102)+(B237), (A)+(B102)+(B238), (A)+(B102)+(B239), (A)+(B102)+(B240), (A)+(B102)+(B241), (A)+(B102)+(B242), (A)+(B102)+(B243), (A)+(B102)+(B244), (A)+(B102)+(B245), (A)+(B102)+(B246), (A)+(B102)+(B247), (A)+(B102)+(B248), (A)+(B102)+(B249), (A)+(B102)+(B250), (A)+(B102)+(B251), (A)+(B102)+(B252), (A)+(B102)+(B253), (A)+(B102)+(B254), (A)+(B102)+(B255), (A)+(B102)+(B256), (A)+(B102)+(B257), (A)+(B102)+(B258), (A)+(B102)+(B259), (A)+(B102)+(B260), (A)+(B102)+(B261), (A)+(B102)+(B262), (A)+(B102)+(B263), (A)+(B102)+(B264), (A)+(B102)+(B265), (A)+(B102)+(B266), (A)+(B102)+(B267), (A)+(B102)+(B268), (A)+(B102)+(B269), (A)+(B102)+(B270), (A)+(B102)+(B271), (A)+(B102)+(B272), (A)+(B102)+(B273), (A)+(B102)+(B274), (A)+(B102)+(B275), (A)+(B102)+(B276), (A)+(B102)+(B277), (A)+(B102)+(B278), (A)+(B102)+(B279), (A)+(B102)+(B280), (A)+(B102)+(B281), (A)+(B102)+(B282), (A)+(B102)+(B283), (A)+(B102)+(B284), (A)+(B102)+(B285), (A)+(B102)+(B286), (A)+(B102)+(B287), (A)+(B102)+(B288), (A)+(B102)+(B289), (A)+(B102)+(B290), (A)+(B102)+(B291), (A)+(B102)+(B292), (A)+(B102)+(B293), (A)+(B102)+(B294), (A)+(B102)+(B295), (A)+(B102)+(B296), (A)+(B102)+(B297), (A)+(B102)+(B298), (A)+(B102)+(B299), (A)+(B102)+(B300), (A)+(B102)+(B301), (A)+(B102)+(B302), (A)+(B102)+(B303), (A)+(B102)+(B304), (A)+(B102)+(B305), (A)+(B102)+(B306), (A)+(B102)+(B307), (A)+(B102)+(B308), (A)+(B102)+(B309), (A)+(B102)+(B310), (A)+(B102)+(B311), (A)+(B102)+(B312), (A)+(B102)+(B313), (A)+(B102)+(B314), (A)+(B102)+(B315),

(A)+(B103)+(B104), (A)+(B103)+(B105), (A)+(B103)+(B106), (A)+(B103)+(B107), (A)+(B103)+(B108), (A)+(B103)+(B109), (A)+(B103)+(B110), (A)+(B103)+(B111), (A)+(B103)+(B112), (A)+(B103)+(B113), (A)+(B103)+(B114), (A)+(B103)+(B115), (A)+(B103)+(B116), (A)+(B103)+(B117), (A)+(B103)+(B118), (A)+(B103)+(B119), (A)+(B103)+(B120), (A)+(B103)+(B121), (A)+(B103)+(B122), (A)+(B103)+(B123), (A)+(B103)+(B124), (A)+(B103)+(B125), (A)+(B103)+(B126), (A)+(B103)+(B127), (A)+(B103)+(B128), (A)+(B103)+(B129), (A)+(B103)+(B130), (A)+(B103)+(B131), (A)+(B103)+(B132), (A)+(B103)+(B133), (A)+(B103)+(B134), (A)+(B103)+(B135), (A)+(B103)+(B136), (A)+(B103)+(B137), (A)+(B103)+(B138), (A)+(B103)+(B139), (A)+(B103)+(B140), (A)+(B103)+(B141), (A)+(B103)+(B142), (A)+(B103)+(B143), (A)+(B103)+(B144), (A)+(B103)+(B145), (A)+(B103)+(B146), (A)+(B103)+(B147), (A)+(B103)+(B148), (A)+(B103)+(B149), (A)+(B103)+(B150), (A)+(B103)+(B151), (A)+(B103)+(B152), (A)+(B103)+(B153), (A)+(B103)+(B154), (A)+(B103)+(B155), (A)+(B103)+(B156), (A)+(B103)+(B157), (A)+(B103)+(B158), (A)+(B103)+(B159), (A)+(B103)+(B160), (A)+(B103)+(B161), (A)+(B103)+(B162), (A)+(B103)+(B164), (A)+(B103)+(B164), (A)+(B103)+(B165), (A)+(B103)+(B166), (A)+(B103)+(B167), (A)+(B103)+(B168), (A)+(B103)+(B169), (A)+(B103)+(B170), (A)+(B103)+(B171), (A)+(B103)+(B172), (A)+(B103)+(B173), (A)+(B103)+(B174), (A)+(B103)+(B175), (A)+(B103)+(B176), (A)+(B103)+(B177), (A)+(B103)+(B178), (A)+(B103)+(B179), (A)+(B103)+(B180), (A)+(B103)+(B181), (A)+(B103)+(B182), (A)+(B103)+(B183), (A)+(B103)+(B184), (A)+(B103)+(B185), (A)+(B103)+(B186), (A)+(B103)+(B187), (A)+(B103)+(B188), (A)+(B103)+(B189), (A)+(B103)+(B190), (A)+(B103)+(B191), (A)+(B103)+(B192), (A)+(B103)+(B193), (A)+(B103)+(B194), (A)+(B103)+(B195), (A)+(B103)+(B196), (A)+(B103)+(B197), (A)+(B103)+(B198), (A)+(B103)+(B199), (A)+(B103)+(B200), (A)+(B103)+(B201), (A)+(B103)+(B202), (A)+(B103)+(B203), (A)+(B103)+(B204), (A)+(B103)+(B205), (A)+(B103)+(B206), (A)+(B103)+(B207), (A)+(B103)+(B208), (A)+(B103)+(B209), (A)+(B103)+(B210), (A)+(B103)+(B211), (A)+(B103)+(B212), (A)+(B103)+(B213), (A)+(B103)+(B214), (A)+(B103)+(B215), (A)+(B103)+(B216), (A)+(B103)+(B217), (A)+(B103)+(B218), (A)+(B103)+(B219), (A)+(B103)+(B220), (A)+(B103)+(B221), (A)+(B103)+(B222), (A)+(B103)+(B223), (A)+(B103)+(B224), (A)+(B103)+(B225), (A)+(B103)+(B226), (A)+(B103)+(B227), (A)+(B103)+(B228), (A)+(B103)+(B229), (A)+(B103)+(B230), (A)+(B103)+(B231), (A)+(B103)+(B232), (A)+(B103)+(B233), (A)+(B103)+(B234), (A)+(B103)+(B235), (A)+(B103)+(B236), (A)+(B103)+(B237), (A)+(B103)+(B238), (A)+(B103)+(B239), (A)+(B103)+(B240), (A)+(B103)+(B241), (A)+(B103)+(B242), (A)+(B103)+(B243), (A)+(B103)+(B244), (A)+(B103)+(B245), (A)+(B103)+(B246), (A)+(B103)+(B247), (A)+(B103)+(B248), (A)+(B103)+(B249), (A)+(B103)+(B250), (A)+(B103)+(B251), (A)+(B103)+(B252), (A)+(B103)+(B253), (A)+(B103)+(B254), (A)+(B103)+(B255), (A)+(B103)+(B256), (A)+(B103)+(B257), (A)+(B103)+(B258), (A)+(B103)+(B259), (A)+(B103)+(B260), (A)+(B103)+(B261), (A)+(B103)+(B262), (A)+(B103)+(B263), (A)+(B103)+(B264), (A)+(B103)+(B265), (A)+(B103)+(B266), (A)+(B103)+(B267), (A)+(B103)+(B268), (A)+(B103)+(B269), (A)+(B103)+(B270), (A)+(B103)+(B271), (A)+(B103)+(B272), (A)+(B103)+(B273), (A)+(B103)+(B274), (A)+(B103)+(B275), (A)+(B103)+(B276), (A)+(B103)+(B277), (A)+(B103)+(B278), (A)+(B103)+(B279), (A)+(B103)+(B280), (A)+(B103)+(B281), (A)+(B103)+(B282), (A)+(B103)+(B283), (A)+(B103)+(B284), (A)+(B103)+(B285), (A)+(B103)+(B286), (A)+(B103)+(B287), (A)+(B103)+(B288), (A)+(B103)+(B289), (A)+(B103)+(B290), (A)+(B103)+(B291), (A)+(B103)+(B292), (A)+(B103)+(B293), (A)+(B103)+(B294), (A)+(B103)+(B295), (A)+(B103)+(B296), (A)+(B103)+(B297), (A)+(B103)+(B298), (A)+(B103)+(B299), (A)+(B103)+(B300), (A)+(B103)+(B301), (A)+(B103)+(B302), (A)+(B103)+(B303), (A)+(B103)+(B304), (A)+(B103)+(B305), (A)+(B103)+(B306), (A)+(B103)+(B307), (A)+(B103)+(B308), (A)+(B103)+(B309), (A)+(B103)+(B310), (A)+(B103)+(B311), (A)+(B103)+(B312), (A)+(B103)+(B313), (A)+(B103)+(B314), (A)+(B103)+(B315),

(A)+(B104)+(B105), (A)+(B104)+(B106), (A)+(B104)+(B107), (A)+(B104)+(B108), (A)+(B104)+(B109), (A)+(B104)+(B110), (A)+(B104)+(B111), (A)+(B104)+(B112), (A)+(B104)+(B113), (A)+(B104)+(B114), (A)+(B104)+(B115), (A)+(B104)+(B116), (A)+(B104)+(B117), (A)+(B104)+(B118), (A)+(B104)+(B119), (A)+(B104)+(B120), (A)+(B104)+(B121), (A)+(B104)+(B122), (A)+(B104)+(B123), (A)+(B104)+(B124), (A)+(B104)+(B125), (A)+(B104)+(B126), (A)+(B104)+(B127), (A)+(B104)+(B128), (A)+(B104)+(B129), (A)+(B104)+(B130), (A)+(B104)+(B131), (A)+(B104)+(B132), (A)+(B104)+(B133), (A)+(B104)+(B134), (A)+(B104)+(B135), (A)+(B104)+(B136), (A)+(B104)+(B137), (A)+(B104)+(B138), (A)+(B104)+(B139), (A)+(B104)+(B140), (A)+(B104)+(B141), (A)+(B104)+(B142), (A)+(B104)+(B143), (A)+(B104)+(B144), (A)+(B104)+(B145), (A)+(B104)+(B146), (A)+(B104)+(B147), (A)+(B104)+(B148), (A)+(B104)+(B149), (A)+(B104)+(B150), (A)+(B104)+(B151), (A)+(B104)+(B152), (A)+(B104)+(B153), (A)+(B104)+(B154), (A)+(B104)+(B155), (A)+(B104)+(B156), (A)+(B104)+(B157), (A)+(B104)+(B158), (A)+(B104)+(B159), (A)+(B104)+(B160), (A)+(B104)+(B161), (A)+(B104)+(B162), (A)+(B104)+(B164), (A)+(B104)+(B164), (A)+(B104)+(B165), (A)+(B104)+(B166), (A)+(B104)+(B167), (A)+(B104)+(B168), (A)+(B104)+(B169), (A)+(B104)+(B170), (A)+(B104)+(B171), (A)+(B104)+(B172), (A)+(B104)+(B173), (A)+(B104)+(B174), (A)+(B104)+(B175), (A)+(B104)+(B176), (A)+(B104)+(B177), (A)+(B104)+(B178), (A)+(B104)+(B179), (A)+(B104)+(B180), (A)+(B104)+(B181), (A)+(B104)+(B182), (A)+(B104)+(B183), (A)+(B104)+(B184), (A)+(B104)+(B185), (A)+(B104)+(B186), (A)+(B104)+(B187), (A)+(B104)+(B188), (A)+(B104)+(B189), (A)+(B104)+(B190), (A)+(B104)+(B191), (A)+(B104)+(B192), (A)+(B104)+(B193), (A)+(B104)+(B194), (A)+(B104)+(B195), (A)+(B104)+(B196), (A)+(B104)+(B197), (A)+(B104)+(B198), (A)+(B104)+(B199), (A)+(B104)+(B200), (A)+(B104)+(B201), (A)+(B104)+(B202), (A)+(B104)+(B203), (A)+(B104)+(B204), (A)+(B104)+(B205), (A)+(B104)+(B206), (A)+(B104)+(B207), (A)+(B104)+(B208), (A)+(B104)+(B209), (A)+(B104)+(B210), (A)+(B104)+(B211), (A)+(B104)+(B212), (A)+(B104)+(B213), (A)+(B104)+(B214), (A)+(B104)+(B215), (A)+(B104)+(B216), (A)+(B104)+(B217), (A)+(B104)+(B218), (A)+(B104)+(B219), (A)+(B104)+(B220), (A)+(B104)+(B221), (A)+(B104)+(B222), (A)+(B104)+(B223), (A)+(B104)+(B224), (A)+(B104)+(B225), (A)+(B104)+(B226), (A)+(B104)+(B227), (A)+(B104)+(B228), (A)+(B104)+(B229), (A)+(B104)+(B230), (A)+(B104)+(B231), (A)+(B104)+(B232), (A)+(B104)+(B233), (A)+(B104)+(B234), (A)+(B104)+(B235), (A)+(B104)+(B236), (A)+(B104)+(B237), (A)+(B104)+(B238), (A)+(B104)+(B239), (A)+(B104)+(B240), (A)+(B104)+(B241), (A)+(B104)+(B242), (A)+(B104)+(B243), (A)+(B104)+(B244), (A)+(B104)+(B245), (A)+(B104)+(B246), (A)+(B104)+(B247), (A)+(B104)+(B248), (A)+(B104)+(B249), (A)+(B104)+(B250), (A)+(B104)+(B251), (A)+(B104)+(B252), (A)+(B104)+(B253), (A)+(B104)+(B254), (A)+(B104)+(B255), (A)+(B104)+(B256), (A)+(B104)+(B257), (A)+(B104)+(B258), (A)+(B104)+(B259), (A)+(B104)+(B260), (A)+(B104)+(B261), (A)+(B104)+(B262), (A)+(B104)+(B263), (A)+(B104)+(B264), (A)+(B104)+(B265), (A)+(B104)+(B266), (A)+(B104)+(B267), (A)+(B104)+(B268), (A)+(B104)+(B269), (A)+(B104)+(B270), (A)+(B104)+(B271), (A)+(B104)+(B272), (A)+(B104)+(B273), (A)+(B104)+(B274), (A)+(B104)+(B275), (A)+(B104)+(B276), (A)+(B104)+(B277), (A)+(B104)+(B278), (A)+(B104)+(B279), (A)+(B104)+(B280), (A)+(B104)+(B281), (A)+(B104)+(B282), (A)+(B104)+(B283), (A)+(B104)+(B284), (A)+(B104)+(B285), (A)+(B104)+(B286), (A)+(B104)+(B287), (A)+(B104)+(B288), (A)+(B104)+(B289), (A)+(B104)+(B290), (A)+(B104)+(B291), (A)+(B104)+(B292), (A)+(B104)+(B293), (A)+(B104)+(B294), (A)+(B104)+(B295), (A)+(B104)+(B296), (A)+(B104)+(B297), (A)+(B104)+(B298), (A)+(B104)+(B299), (A)+(B104)+(B300), (A)+(B104)+(B301), (A)+(B104)+(B302), (A)+(B104)+(B303), (A)+(B104)+(B304), (A)+(B104)+(B305), (A)+(B104)+(B306), (A)+(B104)+(B307), (A)+(B104)+(B308), (A)+(B104)+(B309), (A)+(B104)+(B310), (A)+(B104)+(B311), (A)+(B104)+(B312), (A)+(B104)+(B313), (A)+(B104)+(B314), (A)+(B104)+(B315),

(A)+(B105)+(B106), (A)+(B105)+(B107), (A)+(B105)+(B108), (A)+(B105)+(B109), (A)+(B105)+(B110), (A)+(B105)+(B111), (A)+(B105)+(B112), (A)+(B105)+(B113), (A)+(B105)+(B114), (A)+(B105)+(B115), (A)+(B105)+(B116), (A)+(B105)+(B117), (A)+(B105)+(B118), (A)+(B105)+(B119), (A)+(B105)+(B120), (A)+(B105)+(B121), (A)+(B105)+(B122), (A)+(B105)+(B123), (A)+(B105)+(B124), (A)+(B105)+(B125), (A)+(B105)+(B126), (A)+(B105)+(B127), (A)+(B105)+(B128), (A)+(B105)+(B129), (A)+(B105)+(B130), (A)+(B105)+(B131), (A)+(B105)+(B132), (A)+(B105)+(B133), (A)+(B105)+(B134), (A)+(B105)+(B135), (A)+(B105)+(B136), (A)+(B105)+(B137), (A)+(B105)+(B138), (A)+(B105)+(B139), (A)+(B105)+(B140), (A)+(B105)+(B141), (A)+(B105)+(B142), (A)+(B105)+(B143), (A)+(B105)+(B144), (A)+(B105)+(B145), (A)+(B105)+(B146), (A)+(B105)+(B147), (A)+(B105)+(B148), (A)+(B105)+(B149), (A)+(B105)+(B150), (A)+(B105)+(B151), (A)+(B105)+(B152), (A)+(B105)+(B153), (A)+(B105)+(B154), (A)+(B105)+(B155), (A)+(B105)+(B156), (A)+(B105)+(B157), (A)+(B105)+(B158), (A)+(B105)+(B159), (A)+(B105)+(B160), (A)+(B105)+(B161), (A)+(B105)+(B162), (A)+(B105)+(B164), (A)+(B105)+(B164), (A)+(B105)+(B165), (A)+(B105)+(B166), (A)+(B105)+(B167), (A)+(B105)+(B168), (A)+(B105)+(B169), (A)+(B105)+(B170), (A)+(B105)+(B171), (A)+(B105)+(B172), (A)+(B105)+(B173), (A)+(B105)+(B174), (A)+(B105)+(B175), (A)+(B105)+(B176), (A)+(B105)+(B177), (A)+(B105)+(B178), (A)+(B105)+(B179), (A)+(B105)+(B180), (A)+(B105)+(B181), (A)+(B105)+(B182), (A)+(B105)+(B183), (A)+(B105)+(B184), (A)+(B105)+(B185), (A)+(B105)+(B186), (A)+(B105)+(B187), (A)+(B105)+(B188), (A)+(B105)+(B189), (A)+(B105)+(B190), (A)+(B105)+(B191), (A)+(B105)+(B192), (A)+(B105)+(B193), (A)+(B105)+(B194), (A)+(B105)+(B195), (A)+(B105)+(B196), (A)+(B105)+(B197), (A)+(B105)+(B198), (A)+(B105)+(B199), (A)+(B105)+(B200), (A)+(B105)+(B201), (A)+(B105)+(B202), (A)+(B105)+(B203), (A)+(B105)+(B204), (A)+(B105)+(B205), (A)+(B105)+(B206), (A)+(B105)+(B207), (A)+(B105)+(B208), (A)+(B105)+(B209), (A)+(B105)+(B210), (A)+(B105)+(B211), (A)+(B105)+(B212), (A)+(B105)+(B213), (A)+(B105)+(B214), (A)+(B105)+(B215), (A)+(B105)+(B216), (A)+(B105)+(B217), (A)+(B105)+(B218), (A)+(B105)+(B219), (A)+(B105)+(B220), (A)+(B105)+(B221), (A)+(B105)+(B222), (A)+(B105)+(B223), (A)+(B105)+(B224), (A)+(B105)+(B225), (A)+(B105)+(B226), (A)+(B105)+(B227), (A)+(B105)+(B228), (A)+(B105)+(B229), (A)+(B105)+(B230), (A)+(B105)+(B231), (A)+(B105)+(B232), (A)+(B105)+(B233), (A)+(B105)+(B234), (A)+(B105)+(B235), (A)+(B105)+(B236), (A)+(B105)+(B237), (A)+(B105)+(B238), (A)+(B105)+(B239), (A)+(B105)+(B240), (A)+(B105)+(B241), (A)+(B105)+(B242), (A)+(B105)+(B243), (A)+(B105)+(B244), (A)+(B105)+(B245), (A)+(B105)+(B246), (A)+(B105)+(B247), (A)+(B105)+(B248), (A)+(B105)+(B249), (A)+(B105)+(B250), (A)+(B105)+(B251), (A)+(B105)+(B252), (A)+(B105)+(B253), (A)+(B105)+(B254), (A)+(B105)+(B255), (A)+(B105)+(B256), (A)+(B105)+(B257), (A)+(B105)+(B258), (A)+(B105)+(B259), (A)+(B105)+(B260), (A)+(B105)+(B261), (A)+(B105)+(B262), (A)+(B105)+(B263), (A)+(B105)+(B264), (A)+(B105)+(B265), (A)+(B105)+(B266), (A)+(B105)+(B267), (A)+(B105)+(B268), (A)+(B105)+(B269), (A)+(B105)+(B270), (A)+(B105)+(B271), (A)+(B105)+(B272), (A)+(B105)+(B273), (A)+(B105)+(B274), (A)+(B105)+(B275), (A)+(B105)+(B276), (A)+(B105)+(B277), (A)+(B105)+(B278), (A)+(B105)+(B279), (A)+(B105)+(B280), (A)+(B105)+(B281), (A)+(B105)+(B282), (A)+(B105)+(B283), (A)+(B105)+(B284), (A)+(B105)+(B285), (A)+(B105)+(B286), (A)+(B105)+(B287), (A)+(B105)+(B288), (A)+(B105)+(B289), (A)+(B105)+(B290), (A)+(B105)+(B291), (A)+(B105)+(B292), (A)+(B105)+(B293), (A)+(B105)+(B294), (A)+(B105)+(B295), (A)+(B105)+(B296), (A)+(B105)+(B297), (A)+(B105)+(B298), (A)+(B105)+(B299), (A)+(B105)+(B300), (A)+(B105)+(B301), (A)+(B105)+(B302), (A)+(B105)+(B303), (A)+(B105)+(B304), (A)+(B105)+(B305), (A)+(B105)+(B306), (A)+(B105)+(B307), (A)+(B105)+(B308), (A)+(B105)+(B309), (A)+(B105)+(B310), (A)+(B105)+(B311), (A)+(B105)+(B312), (A)+(B105)+(B313), (A)+(B105)+(B314), (A)+(B105)+(B315),

(A)+(B106)+(B107), (A)+(B106)+(B108), (A)+(B106)+(B109), (A)+(B106)+(B110), (A)+(B106)+(B111), (A)+(B106)+(B112), (A)+(B106)+(B113), (A)+(B106)+(B114), (A)+(B106)+(B115), (A)+(B106)+(B116), (A)+(B106)+(B117), (A)+(B106)+(B118), (A)+(B106)+(B119), (A)+(B106)+(B120), (A)+(B106)+(B121), (A)+(B106)+(B122), (A)+(B106)+(B123), (A)+(B106)+(B124), (A)+(B106)+(B125), (A)+(B106)+(B126), (A)+(B106)+(B127), (A)+(B106)+(B128), (A)+(B106)+(B129), (A)+(B106)+(B130), (A)+(B106)+(B131), (A)+(B106)+(B132), (A)+(B106)+(B133), (A)+(B106)+(B134), (A)+(B106)+(B135), (A)+(B106)+(B136), (A)+(B106)+(B137), (A)+(B106)+(B138), (A)+(B106)+(B139), (A)+(B106)+(B140), (A)+(B106)+(B141), (A)+(B106)+(B142), (A)+(B106)+(B143), (A)+(B106)+(B144), (A)+(B106)+(B145), (A)+(B106)+(B146), (A)+(B106)+(B147), (A)+(B106)+(B148), (A)+(B106)+(B149), (A)+(B106)+(B150), (A)+(B106)+(B151), (A)+(B106)+(B152), (A)+(B106)+(B153), (A)+(B106)+(B154), (A)+(B106)+(B155), (A)+(B106)+(B156), (A)+(B106)+(B157), (A)+(B106)+(B158), (A)+(B106)+(B159), (A)+(B106)+(B160), (A)+(B106)+(B161), (A)+(B106)+(B162), (A)+(B106)+(B164), (A)+(B106)+(B164), (A)+(B106)+(B165), (A)+(B106)+(B166), (A)+(B106)+(B167), (A)+(B106)+(B168), (A)+(B106)+(B169), (A)+(B106)+(B170), (A)+(B106)+(B171), (A)+(B106)+(B172), (A)+(B106)+(B173), (A)+(B106)+(B174), (A)+(B106)+(B175), (A)+(B106)+(B176), (A)+(B106)+(B177), (A)+(B106)+(B178), (A)+(B106)+(B179), (A)+(B106)+(B180), (A)+(B106)+(B181), (A)+(B106)+(B182), (A)+(B106)+(B183), (A)+(B106)+(B184), (A)+(B106)+(B185), (A)+(B106)+(B186), (A)+(B106)+(B187), (A)+(B106)+(B188), (A)+(B106)+(B189), (A)+(B106)+(B190), (A)+(B106)+(B191), (A)+(B106)+(B192), (A)+(B106)+(B193), (A)+(B106)+(B194), (A)+(B106)+(B195), (A)+(B106)+(B196), (A)+(B106)+(B197), (A)+(B106)+(B198), (A)+(B106)+(B199), (A)+(B106)+(B200), (A)+(B106)+(B201), (A)+(B106)+(B202), (A)+(B106)+(B203), (A)+(B106)+(B204), (A)+(B106)+(B205), (A)+(B106)+(B206), (A)+(B106)+(B207), (A)+(B106)+(B208), (A)+(B106)+(B209), (A)+(B106)+(B210), (A)+(B106)+(B211), (A)+(B106)+(B212), (A)+(B106)+(B213), (A)+(B106)+(B214), (A)+(B106)+(B215), (A)+(B106)+(B216), (A)+(B106)+(B217), (A)+(B106)+(B218), (A)+(B106)+(B219), (A)+(B106)+(B220), (A)+(B106)+(B221), (A)+(B106)+(B222), (A)+(B106)+(B223), (A)+(B106)+(B224), (A)+(B106)+(B225), (A)+(B106)+(B226), (A)+(B106)+(B227), (A)+(B106)+(B228), (A)+(B106)+(B229), (A)+(B106)+(B230), (A)+(B106)+(B231), (A)+(B106)+(B232), (A)+(B106)+(B233), (A)+(B106)+(B234), (A)+(B106)+(B235), (A)+(B106)+(B236), (A)+(B106)+(B237), (A)+(B106)+(B238), (A)+(B106)+(B239), (A)+(B106)+(B240), (A)+(B106)+(B241), (A)+(B106)+(B242), (A)+(B106)+(B243), (A)+(B106)+(B244), (A)+(B106)+(B245), (A)+(B106)+(B246), (A)+(B106)+(B247), (A)+(B106)+(B248), (A)+(B106)+(B249), (A)+(B106)+(B250), (A)+(B106)+(B251), (A)+(B106)+(B252), (A)+(B106)+(B253), (A)+(B106)+(B254), (A)+(B106)+(B255), (A)+(B106)+(B256), (A)+(B106)+(B257), (A)+(B106)+(B258), (A)+(B106)+(B259), (A)+(B106)+(B260), (A)+(B106)+(B261), (A)+(B106)+(B262), (A)+(B106)+(B263), (A)+(B106)+(B264), (A)+(B106)+(B265), (A)+(B106)+(B266), (A)+(B106)+(B267), (A)+(B106)+(B268), (A)+(B106)+(B269), (A)+(B106)+(B270), (A)+(B106)+(B271), (A)+(B106)+(B272), (A)+(B106)+(B273), (A)+(B106)+(B274), (A)+(B106)+(B275), (A)+(B106)+(B276), (A)+(B106)+(B277), (A)+(B106)+(B278), (A)+(B106)+(B279), (A)+(B106)+(B280), (A)+(B106)+(B281), (A)+(B106)+(B282), (A)+(B106)+(B283), (A)+(B106)+(B284), (A)+(B106)+(B285), (A)+(B106)+(B286), (A)+(B106)+(B287), (A)+(B106)+(B288), (A)+(B106)+(B289), (A)+(B106)+(B290), (A)+(B106)+(B291), (A)+(B106)+(B292), (A)+(B106)+(B293), (A)+(B106)+(B294), (A)+(B106)+(B295), (A)+(B106)+(B296), (A)+(B106)+(B297), (A)+(B106)+(B298), (A)+(B106)+(B299), (A)+(B106)+(B300), (A)+(B106)+(B301), (A)+(B106)+(B302), (A)+(B106)+(B303), (A)+(B106)+(B304), (A)+(B106)+(B305), (A)+(B106)+(B306), (A)+(B106)+(B307), (A)+(B106)+(B308), (A)+(B106)+(B309), (A)+(B106)+(B310), (A)+(B106)+(B311), (A)+(B106)+(B312), (A)+(B106)+(B313), (A)+(B106)+(B314), (A)+(B106)+(B315),

(A)+(B107)+(B108), (A)+(B107)+(B109), (A)+(B107)+(B110), (A)+(B107)+(B111), (A)+(B107)+(B112), (A)+(B107)+(B113), (A)+(B107)+(B114), (A)+(B107)+(B115), (A)+(B107)+(B116), (A)+(B107)+(B117), (A)+(B107)+(B118), (A)+(B107)+(B119), (A)+(B107)+(B120), (A)+(B107)+(B121), (A)+(B107)+(B122), (A)+(B107)+(B123), (A)+(B107)+(B124), (A)+(B107)+(B125), (A)+(B107)+(B126), (A)+(B107)+(B127), (A)+(B107)+(B128), (A)+(B107)+(B129), (A)+(B107)+(B130), (A)+(B107)+(B131), (A)+(B107)+(B132), (A)+(B107)+(B133), (A)+(B107)+(B134), (A)+(B107)+(B135), (A)+(B107)+(B136), (A)+(B107)+(B137), (A)+(B107)+(B138), (A)+(B107)+(B139), (A)+(B107)+(B140), (A)+(B107)+(B141), (A)+(B107)+(B142), (A)+(B107)+(B143), (A)+(B107)+(B144), (A)+(B107)+(B145), (A)+(B107)+(B146), (A)+(B107)+(B147), (A)+(B107)+(B148), (A)+(B107)+(B149), (A)+(B107)+(B150), (A)+(B107)+(B151), (A)+(B107)+(B152), (A)+(B107)+(B153), (A)+(B107)+(B154), (A)+(B107)+(B155), (A)+(B107)+(B156), (A)+(B107)+(B157), (A)+(B107)+(B158), (A)+(B107)+(B159), (A)+(B107)+(B160), (A)+(B107)+(B161), (A)+(B107)+(B162), (A)+(B107)+(B164), (A)+(B107)+(B164), (A)+(B107)+(B165), (A)+(B107)+(B166), (A)+(B107)+(B167), (A)+(B107)+(B168), (A)+(B107)+(B169), (A)+(B107)+(B170), (A)+(B107)+(B171), (A)+(B107)+(B172), (A)+(B107)+(B173), (A)+(B107)+(B174), (A)+(B107)+(B175), (A)+(B107)+(B176), (A)+(B107)+(B177), (A)+(B107)+(B178), (A)+(B107)+(B179), (A)+(B107)+(B180), (A)+(B107)+(B181), (A)+(B107)+(B182), (A)+(B107)+(B183), (A)+(B107)+(B184), (A)+(B107)+(B185), (A)+(B107)+(B186), (A)+(B107)+(B187), (A)+(B107)+(B188), (A)+(B107)+(B189), (A)+(B107)+(B190), (A)+(B107)+(B191), (A)+(B107)+(B192), (A)+(B107)+(B193), (A)+(B107)+(B194), (A)+(B107)+(B195), (A)+(B107)+(B196), (A)+(B107)+(B197), (A)+(B107)+(B198), (A)+(B107)+(B199), (A)+(B107)+(B200), (A)+(B107)+(B201), (A)+(B107)+(B202), (A)+(B107)+(B203), (A)+(B107)+(B204), (A)+(B107)+(B205), (A)+(B107)+(B206), (A)+(B107)+(B207), (A)+(B107)+(B208), (A)+(B107)+(B209), (A)+(B107)+(B210), (A)+(B107)+(B211), (A)+(B107)+(B212), (A)+(B107)+(B213), (A)+(B107)+(B214), (A)+(B107)+(B215), (A)+(B107)+(B216), (A)+(B107)+(B217), (A)+(B107)+(B218), (A)+(B107)+(B219), (A)+(B107)+(B220), (A)+(B107)+(B221), (A)+(B107)+(B222), (A)+(B107)+(B223), (A)+(B107)+(B224), (A)+(B107)+(B225), (A)+(B107)+(B226), (A)+(B107)+(B227), (A)+(B107)+(B228), (A)+(B107)+(B229), (A)+(B107)+(B230), (A)+(B107)+(B231), (A)+(B107)+(B232), (A)+(B107)+(B233), (A)+(B107)+(B234), (A)+(B107)+(B235), (A)+(B107)+(B236), (A)+(B107)+(B237), (A)+(B107)+(B238), (A)+(B107)+(B239), (A)+(B107)+(B240), (A)+(B107)+(B241), (A)+(B107)+(B242), (A)+(B107)+(B243), (A)+(B107)+(B244), (A)+(B107)+(B245), (A)+(B107)+(B246), (A)+(B107)+(B247), (A)+(B107)+(B248), (A)+(B107)+(B249), (A)+(B107)+(B250), (A)+(B107)+(B251), (A)+(B107)+(B252), (A)+(B107)+(B253), (A)+(B107)+(B254), (A)+(B107)+(B255), (A)+(B107)+(B256), (A)+(B107)+(B257), (A)+(B107)+(B258), (A)+(B107)+(B259), (A)+(B107)+(B260), (A)+(B107)+(B261), (A)+(B107)+(B262), (A)+(B107)+(B263), (A)+(B107)+(B264), (A)+(B107)+(B265), (A)+(B107)+(B266), (A)+(B107)+(B267), (A)+(B107)+(B268), (A)+(B107)+(B269), (A)+(B107)+(B270), (A)+(B107)+(B271), (A)+(B107)+(B272), (A)+(B107)+(B273), (A)+(B107)+(B274), (A)+(B107)+(B275), (A)+(B107)+(B276), (A)+(B107)+(B277), (A)+(B107)+(B278), (A)+(B107)+(B279), (A)+(B107)+(B280), (A)+(B107)+(B281), (A)+(B107)+(B282), (A)+(B107)+(B283), (A)+(B107)+(B284), (A)+(B107)+(B285), (A)+(B107)+(B286), (A)+(B107)+(B287), (A)+(B107)+(B288), (A)+(B107)+(B289), (A)+(B107)+(B290), (A)+(B107)+(B291), (A)+(B107)+(B292), (A)+(B107)+(B293), (A)+(B107)+(B294), (A)+(B107)+(B295), (A)+(B107)+(B296), (A)+(B107)+(B297), (A)+(B107)+(B298), (A)+(B107)+(B299), (A)+(B107)+(B300), (A)+(B107)+(B301), (A)+(B107)+(B302), (A)+(B107)+(B303), (A)+(B107)+(B304), (A)+(B107)+(B305), (A)+(B107)+(B306), (A)+(B107)+(B307), (A)+(B107)+(B308), (A)+(B107)+(B309), (A)+(B107)+(B310), (A)+(B107)+(B311), (A)+(B107)+(B312), (A)+(B107)+(B313), (A)+(B107)+(B314), (A)+(B107)+(B315),

(A)+(B108)+(B109), (A)+(B108)+(B110), (A)+(B108)+(B111), (A)+(B108)+(B112), (A)+(B108)+(B113), (A)+(B108)+(B114), (A)+(B108)+(B115), (A)+(B108)+(B116), (A)+(B108)+(B117), (A)+(B108)+(B118), (A)+(B108)+(B119), (A)+(B108)+(B120), (A)+(B108)+(B121), (A)+(B108)+(B122), (A)+(B108)+(B123), (A)+(B108)+(B124), (A)+(B108)+(B125), (A)+(B108)+(B126), (A)+(B108)+(B127), (A)+(B108)+(B128), (A)+(B108)+(B129), (A)+(B108)+(B130), (A)+(B108)+(B131), (A)+(B108)+(B132), (A)+(B108)+(B133), (A)+(B108)+(B134), (A)+(B108)+(B135), (A)+(B108)+(B136), (A)+(B108)+(B137), (A)+(B108)+(B138), (A)+(B108)+(B139), (A)+(B108)+(B140), (A)+(B108)+(B141), (A)+(B108)+(B142), (A)+(B108)+(B143), (A)+(B108)+(B144), (A)+(B108)+(B145), (A)+(B108)+(B146), (A)+(B108)+(B147), (A)+(B108)+(B148), (A)+(B108)+(B149), (A)+(B108)+(B150), (A)+(B108)+(B151), (A)+(B108)+(B152), (A)+(B108)+(B153), (A)+(B108)+(B154), (A)+(B108)+(B155), (A)+(B108)+(B156), (A)+(B108)+(B157), (A)+(B108)+(B158), (A)+(B108)+(B159), (A)+(B108)+(B160), (A)+(B108)+(B161), (A)+(B108)+(B162), (A)+(B108)+(B164), (A)+(B108)+(B164), (A)+(B108)+(B165), (A)+(B108)+(B166), (A)+(B108)+(B167), (A)+(B108)+(B168), (A)+(B108)+(B169), (A)+(B108)+(B170), (A)+(B108)+(B171), (A)+(B108)+(B172), (A)+(B108)+(B173), (A)+(B108)+(B174), (A)+(B108)+(B175), (A)+(B108)+(B176), (A)+(B108)+(B177), (A)+(B108)+(B178), (A)+(B108)+(B179), (A)+(B108)+(B180), (A)+(B108)+(B181), (A)+(B108)+(B182), (A)+(B108)+(B183), (A)+(B108)+(B184), (A)+(B108)+(B185), (A)+(B108)+(B186), (A)+(B108)+(B187), (A)+(B108)+(B188), (A)+(B108)+(B189), (A)+(B108)+(B190), (A)+(B108)+(B191), (A)+(B108)+(B192), (A)+(B108)+(B193), (A)+(B108)+(B194), (A)+(B108)+(B195), (A)+(B108)+(B196), (A)+(B108)+(B197), (A)+(B108)+(B198), (A)+(B108)+(B199), (A)+(B108)+(B200), (A)+(B108)+(B201), (A)+(B108)+(B202), (A)+(B108)+(B203), (A)+(B108)+(B204), (A)+(B108)+(B205), (A)+(B108)+(B206), (A)+(B108)+(B207), (A)+(B108)+(B208), (A)+(B108)+(B209), (A)+(B108)+(B210), (A)+(B108)+(B211), (A)+(B108)+(B212), (A)+(B108)+(B213), (A)+(B108)+(B214), (A)+(B108)+(B215), (A)+(B108)+(B216), (A)+(B108)+(B217), (A)+(B108)+(B218), (A)+(B108)+(B219), (A)+(B108)+(B220), (A)+(B108)+(B221), (A)+(B108)+(B222), (A)+(B108)+(B223), (A)+(B108)+(B224), (A)+(B108)+(B225), (A)+(B108)+(B226), (A)+(B108)+(B227), (A)+(B108)+(B228), (A)+(B108)+(B229), (A)+(B108)+(B230), (A)+(B108)+(B231), (A)+(B108)+(B232), (A)+(B108)+(B233), (A)+(B108)+(B234), (A)+(B108)+(B235), (A)+(B108)+(B236), (A)+(B108)+(B237), (A)+(B108)+(B238), (A)+(B108)+(B239), (A)+(B108)+(B240), (A)+(B108)+(B241), (A)+(B108)+(B242), (A)+(B108)+(B243), (A)+(B108)+(B244), (A)+(B108)+(B245), (A)+(B108)+(B246), (A)+(B108)+(B247), (A)+(B108)+(B248), (A)+(B108)+(B249), (A)+(B108)+(B250), (A)+(B108)+(B251), (A)+(B108)+(B252), (A)+(B108)+(B253), (A)+(B108)+(B254), (A)+(B108)+(B255), (A)+(B108)+(B256), (A)+(B108)+(B257), (A)+(B108)+(B258), (A)+(B108)+(B259), (A)+(B108)+(B260), (A)+(B108)+(B261), (A)+(B108)+(B262), (A)+(B108)+(B263), (A)+(B108)+(B264), (A)+(B108)+(B265), (A)+(B108)+(B266), (A)+(B108)+(B267), (A)+(B108)+(B268), (A)+(B108)+(B269), (A)+(B108)+(B270), (A)+(B108)+(B271), (A)+(B108)+(B272), (A)+(B108)+(B273), (A)+(B108)+(B274), (A)+(B108)+(B275), (A)+(B108)+(B276), (A)+(B108)+(B277), (A)+(B108)+(B278), (A)+(B108)+(B279), (A)+(B108)+(B280), (A)+(B108)+(B281), (A)+(B108)+(B282), (A)+(B108)+(B283), (A)+(B108)+(B284), (A)+(B108)+(B285), (A)+(B108)+(B286), (A)+(B108)+(B287), (A)+(B108)+(B288), (A)+(B108)+(B289), (A)+(B108)+(B290), (A)+(B108)+(B291), (A)+(B108)+(B292), (A)+(B108)+(B293), (A)+(B108)+(B294), (A)+(B108)+(B295), (A)+(B108)+(B296), (A)+(B108)+(B297), (A)+(B108)+(B298), (A)+(B108)+(B299), (A)+(B108)+(B300), (A)+(B108)+(B301), (A)+(B108)+(B302), (A)+(B108)+(B303), (A)+(B108)+(B304), (A)+(B108)+(B305), (A)+(B108)+(B306), (A)+(B108)+(B307), (A)+(B108)+(B308), (A)+(B108)+(B309), (A)+(B108)+(B310), (A)+(B108)+(B311), (A)+(B108)+(B312), (A)+(B108)+(B313), (A)+(B108)+(B314), (A)+(B108)+(B315),

(A)+(B109)+(B110), (A)+(B109)+(B111), (A)+(B109)+(B112), (A)+(B109)+(B113), (A)+(B109)+(B114), (A)+(B109)+(B115), (A)+(B109)+(B116), (A)+(B109)+(B117), (A)+(B109)+(B118), (A)+(B109)+(B119), (A)+(B109)+(B120), (A)+(B109)+(B121), (A)+(B109)+(B122), (A)+(B109)+(B123), (A)+(B109)+(B124), (A)+(B109)+(B125), (A)+(B109)+(B126), (A)+(B109)+(B127), (A)+(B109)+(B128), (A)+(B109)+(B129), (A)+(B109)+(B130), (A)+(B109)+(B131), (A)+(B109)+(B132), (A)+(B109)+(B133), (A)+(B109)+(B134), (A)+(B109)+(B135), (A)+(B109)+(B136), (A)+(B109)+(B137), (A)+(B109)+(B138), (A)+(B109)+(B139), (A)+(B109)+(B140), (A)+(B109)+(B141), (A)+(B109)+(B142), (A)+(B109)+(B143), (A)+(B109)+(B144), (A)+(B109)+(B145), (A)+(B109)+(B146), (A)+(B109)+(B147), (A)+(B109)+(B148), (A)+(B109)+(B149), (A)+(B109)+(B150), (A)+(B109)+(B151), (A)+(B109)+(B152), (A)+(B109)+(B153), (A)+(B109)+(B154), (A)+(B109)+(B155), (A)+(B109)+(B156), (A)+(B109)+(B157), (A)+(B109)+(B158), (A)+(B109)+(B159), (A)+(B109)+(B160), (A)+(B109)+(B161), (A)+(B109)+(B162), (A)+(B109)+(B164), (A)+(B109)+(B164), (A)+(B109)+(B165), (A)+(B109)+(B166), (A)+(B109)+(B167), (A)+(B109)+(B168), (A)+(B109)+(B169), (A)+(B109)+(B170), (A)+(B109)+(B171), (A)+(B109)+(B172), (A)+(B109)+(B173), (A)+(B109)+(B174), (A)+(B109)+(B175), (A)+(B109)+(B176), (A)+(B109)+(B177), (A)+(B109)+(B178), (A)+(B109)+(B179), (A)+(B109)+(B180), (A)+(B109)+(B181), (A)+(B109)+(B182), (A)+(B109)+(B183), (A)+(B109)+(B184), (A)+(B109)+(B185), (A)+(B109)+(B186), (A)+(B109)+(B187), (A)+(B109)+(B188), (A)+(B109)+(B189), (A)+(B109)+(B190), (A)+(B109)+(B191), (A)+(B109)+(B192), (A)+(B109)+(B193), (A)+(B109)+(B194), (A)+(B109)+(B195), (A)+(B109)+(B196), (A)+(B109)+(B197), (A)+(B109)+(B198), (A)+(B109)+(B199), (A)+(B109)+(B200), (A)+(B109)+(B201), (A)+(B109)+(B202), (A)+(B109)+(B203), (A)+(B109)+(B204), (A)+(B109)+(B205), (A)+(B109)+(B206), (A)+(B109)+(B207), (A)+(B109)+(B208), (A)+(B109)+(B209), (A)+(B109)+(B210), (A)+(B109)+(B211), (A)+(B109)+(B212), (A)+(B109)+(B213), (A)+(B109)+(B214), (A)+(B109)+(B215), (A)+(B109)+(B216), (A)+(B109)+(B217), (A)+(B109)+(B218), (A)+(B109)+(B219), (A)+(B109)+(B220), (A)+(B109)+(B221), (A)+(B109)+(B222), (A)+(B109)+(B223), (A)+(B109)+(B224), (A)+(B109)+(B225), (A)+(B109)+(B226), (A)+(B109)+(B227), (A)+(B109)+(B228), (A)+(B109)+(B229), (A)+(B109)+(B230), (A)+(B109)+(B231), (A)+(B109)+(B232), (A)+(B109)+(B233), (A)+(B109)+(B234), (A)+(B109)+(B235), (A)+(B109)+(B236), (A)+(B109)+(B237), (A)+(B109)+(B238), (A)+(B109)+(B239), (A)+(B109)+(B240), (A)+(B109)+(B241), (A)+(B109)+(B242), (A)+(B109)+(B243), (A)+(B109)+(B244), (A)+(B109)+(B245), (A)+(B109)+(B246), (A)+(B109)+(B247), (A)+(B109)+(B248), (A)+(B109)+(B249), (A)+(B109)+(B250), (A)+(B109)+(B251), (A)+(B109)+(B252), (A)+(B109)+(B253), (A)+(B109)+(B254), (A)+(B109)+(B255), (A)+(B109)+(B256), (A)+(B109)+(B257), (A)+(B109)+(B258), (A)+(B109)+(B259), (A)+(B109)+(B260), (A)+(B109)+(B261), (A)+(B109)+(B262), (A)+(B109)+(B263), (A)+(B109)+(B264), (A)+(B109)+(B265), (A)+(B109)+(B266), (A)+(B109)+(B267), (A)+(B109)+(B268), (A)+(B109)+(B269), (A)+(B109)+(B270), (A)+(B109)+(B271), (A)+(B109)+(B272), (A)+(B109)+(B273), (A)+(B109)+(B274), (A)+(B109)+(B275), (A)+(B109)+(B276), (A)+(B109)+(B277), (A)+(B109)+(B278), (A)+(B109)+(B279), (A)+(B109)+(B280), (A)+(B109)+(B281), (A)+(B109)+(B282), (A)+(B109)+(B283), (A)+(B109)+(B284), (A)+(B109)+(B285), (A)+(B109)+(B286), (A)+(B109)+(B287), (A)+(B109)+(B288), (A)+(B109)+(B289), (A)+(B109)+(B290), (A)+(B109)+(B291), (A)+(B109)+(B292), (A)+(B109)+(B293), (A)+(B109)+(B294), (A)+(B109)+(B295), (A)+(B109)+(B296), (A)+(B109)+(B297), (A)+(B109)+(B298), (A)+(B109)+(B299), (A)+(B109)+(B300), (A)+(B109)+(B301), (A)+(B109)+(B302), (A)+(B109)+(B303), (A)+(B109)+(B304), (A)+(B109)+(B305), (A)+(B109)+(B306), (A)+(B109)+(B307), (A)+(B109)+(B308), (A)+(B109)+(B309), (A)+(B109)+(B310), (A)+(B109)+(B311), (A)+(B109)+(B312), (A)+(B109)+(B313), (A)+(B109)+(B314), (A)+(B109)+(B315),

(A)+(B110)+(B111), (A)+(B110)+(B112), (A)+(B110)+(B113), (A)+(B110)+(B114), (A)+(B110)+(B115), (A)+(B110)+(B116), (A)+(B110)+(B117), (A)+(B110)+(B118), (A)+(B110)+(B119), (A)+(B110)+(B120), (A)+(B110)+(B121), (A)+(B110)+(B122), (A)+(B110)+(B123), (A)+(B110)+(B124), (A)+(B110)+(B125), (A)+(B110)+(B126), (A)+(B110)+(B127), (A)+(B110)+(B128), (A)+(B110)+(B129), (A)+(B110)+(B130), (A)+(B110)+(B131), (A)+(B110)+(B132), (A)+(B110)+(B133), (A)+(B110)+(B134), (A)+(B110)+(B135), (A)+(B110)+(B136), (A)+(B110)+(B137), (A)+(B110)+(B138), (A)+(B110)+(B139), (A)+(B110)+(B140), (A)+(B110)+(B141), (A)+(B110)+(B142), (A)+(B110)+(B143), (A)+(B110)+(B144), (A)+(B110)+(B145), (A)+(B110)+(B146), (A)+(B110)+(B147), (A)+(B110)+(B148), (A)+(B110)+(B149), (A)+(B110)+(B150), (A)+(B110)+(B151), (A)+(B110)+(B152), (A)+(B110)+(B153), (A)+(B110)+(B154), (A)+(B110)+(B155), (A)+(B110)+(B156), (A)+(B110)+(B157), (A)+(B110)+(B158), (A)+(B110)+(B159), (A)+(B110)+(B160), (A)+(B110)+(B161), (A)+(B110)+(B162), (A)+(B110)+(B164), (A)+(B110)+(B164), (A)+(B110)+(B165), (A)+(B110)+(B166), (A)+(B110)+(B167), (A)+(B110)+(B168), (A)+(B110)+(B169), (A)+(B110)+(B170), (A)+(B110)+(B171), (A)+(B110)+(B172), (A)+(B110)+(B173), (A)+(B110)+(B174), (A)+(B110)+(B175), (A)+(B110)+(B176), (A)+(B110)+(B177), (A)+(B110)+(B178), (A)+(B110)+(B179), (A)+(B110)+(B180), (A)+(B110)+(B181), (A)+(B110)+(B182), (A)+(B110)+(B183), (A)+(B110)+(B184), (A)+(B110)+(B185), (A)+(B110)+(B186), (A)+(B110)+(B187), (A)+(B110)+(B188), (A)+(B110)+(B189), (A)+(B110)+(B190), (A)+(B110)+(B191), (A)+(B110)+(B192), (A)+(B110)+(B193), (A)+(B110)+(B194), (A)+(B110)+(B195), (A)+(B110)+(B196), (A)+(B110)+(B197), (A)+(B110)+(B198), (A)+(B110)+(B199), (A)+(B110)+(B200), (A)+(B110)+(B201), (A)+(B110)+(B202), (A)+(B110)+(B203), (A)+(B110)+(B204), (A)+(B110)+(B205), (A)+(B110)+(B206), (A)+(B110)+(B207), (A)+(B110)+(B208), (A)+(B110)+(B209), (A)+(B110)+(B210), (A)+(B110)+(B211), (A)+(B110)+(B212), (A)+(B110)+(B213), (A)+(B110)+(B214), (A)+(B110)+(B215), (A)+(B110)+(B216), (A)+(B110)+(B217), (A)+(B110)+(B218), (A)+(B110)+(B219), (A)+(B110)+(B220), (A)+(B110)+(B221), (A)+(B110)+(B222), (A)+(B110)+(B223), (A)+(B110)+(B224), (A)+(B110)+(B225), (A)+(B110)+(B226), (A)+(B110)+(B227), (A)+(B110)+(B228), (A)+(B110)+(B229), (A)+(B110)+(B230), (A)+(B110)+(B231), (A)+(B110)+(B232), (A)+(B110)+(B233), (A)+(B110)+(B234), (A)+(B110)+(B235), (A)+(B110)+(B236), (A)+(B110)+(B237), (A)+(B110)+(B238), (A)+(B110)+(B239), (A)+(B110)+(B240), (A)+(B110)+(B241), (A)+(B110)+(B242), (A)+(B110)+(B243), (A)+(B110)+(B244), (A)+(B110)+(B245), (A)+(B110)+(B246), (A)+(B110)+(B247), (A)+(B110)+(B248), (A)+(B110)+(B249), (A)+(B110)+(B250), (A)+(B110)+(B251), (A)+(B110)+(B252), (A)+(B110)+(B253), (A)+(B110)+(B254), (A)+(B110)+(B255), (A)+(B110)+(B256), (A)+(B110)+(B257), (A)+(B110)+(B258), (A)+(B110)+(B259), (A)+(B110)+(B260), (A)+(B110)+(B261), (A)+(B110)+(B262), (A)+(B110)+(B263), (A)+(B110)+(B264), (A)+(B110)+(B265), (A)+(B110)+(B266), (A)+(B110)+(B267), (A)+(B110)+(B268), (A)+(B110)+(B269), (A)+(B110)+(B270), (A)+(B110)+(B271), (A)+(B110)+(B272), (A)+(B110)+(B273), (A)+(B110)+(B274), (A)+(B110)+(B275), (A)+(B110)+(B276), (A)+(B110)+(B277), (A)+(B110)+(B278), (A)+(B110)+(B279), (A)+(B110)+(B280), (A)+(B110)+(B281), (A)+(B110)+(B282), (A)+(B110)+(B283), (A)+(B110)+(B284), (A)+(B110)+(B285), (A)+(B110)+(B286), (A)+(B110)+(B287), (A)+(B110)+(B288), (A)+(B110)+(B289), (A)+(B110)+(B290), (A)+(B110)+(B291), (A)+(B110)+(B292), (A)+(B110)+(B293), (A)+(B110)+(B294), (A)+(B110)+(B295), (A)+(B110)+(B296), (A)+(B110)+(B297), (A)+(B110)+(B298), (A)+(B110)+(B299), (A)+(B110)+(B300), (A)+(B110)+(B301), (A)+(B110)+(B302), (A)+(B110)+(B303), (A)+(B110)+(B304), (A)+(B110)+(B305), (A)+(B110)+(B306), (A)+(B110)+(B307), (A)+(B110)+(B308), (A)+(B110)+(B309), (A)+(B110)+(B310), (A)+(B110)+(B311), (A)+(B110)+(B312), (A)+(B110)+(B313), (A)+(B110)+(B314), (A)+(B110)+(B315),

(A)+(B111)+(B112), (A)+(B111)+(B113), (A)+(B111)+(B114), (A)+(B111)+(B115), (A)+(B111)+(B116), (A)+(B111)+(B117), (A)+(B111)+(B118), (A)+(B111)+(B119), (A)+(B111)+(B120), (A)+(B111)+(B121), (A)+(B111)+(B122), (A)+(B111)+(B123), (A)+(B111)+(B124), (A)+(B111)+(B125), (A)+(B111)+(B126), (A)+(B111)+(B127), (A)+(B111)+(B128), (A)+(B111)+(B129), (A)+(B111)+(B130), (A)+(B111)+(B131), (A)+(B111)+(B132), (A)+(B111)+(B133), (A)+(B111)+(B134), (A)+(B111)+(B135), (A)+(B111)+(B136), (A)+(B111)+(B137), (A)+(B111)+(B138), (A)+(B111)+(B139), (A)+(B111)+(B140), (A)+(B111)+(B141), (A)+(B111)+(B142), (A)+(B111)+(B143), (A)+(B111)+(B144), (A)+(B111)+(B145), (A)+(B111)+(B146), (A)+(B111)+(B147), (A)+(B111)+(B148), (A)+(B111)+(B149), (A)+(B111)+(B150), (A)+(B111)+(B151), (A)+(B111)+(B152), (A)+(B111)+(B153), (A)+(B111)+(B154), (A)+(B111)+(B155), (A)+(B111)+(B156), (A)+(B111)+(B157), (A)+(B111)+(B158), (A)+(B111)+(B159), (A)+(B111)+(B160), (A)+(B111)+(B161), (A)+(B111)+(B162), (A)+(B111)+(B164), (A)+(B111)+(B164), (A)+(B111)+(B165), (A)+(B111)+(B166), (A)+(B111)+(B167), (A)+(B111)+(B168), (A)+(B111)+(B169), (A)+(B111)+(B170), (A)+(B111)+(B171), (A)+(B111)+(B172), (A)+(B111)+(B173), (A)+(B111)+(B174), (A)+(B111)+(B175), (A)+(B111)+(B176), (A)+(B111)+(B177), (A)+(B111)+(B178), (A)+(B111)+(B179), (A)+(B111)+(B180), (A)+(B111)+(B181), (A)+(B111)+(B182), (A)+(B111)+(B183), (A)+(B111)+(B184), (A)+(B111)+(B185), (A)+(B111)+(B186), (A)+(B111)+(B187), (A)+(B111)+(B188), (A)+(B111)+(B189), (A)+(B111)+(B190), (A)+(B111)+(B191), (A)+(B111)+(B192), (A)+(B111)+(B193), (A)+(B111)+(B194), (A)+(B111)+(B195), (A)+(B111)+(B196), (A)+(B111)+(B197), (A)+(B111)+(B198), (A)+(B111)+(B199), (A)+(B111)+(B200), (A)+(B111)+(B201), (A)+(B111)+(B202), (A)+(B111)+(B203), (A)+(B111)+(B204), (A)+(B111)+(B205), (A)+(B111)+(B206), (A)+(B111)+(B207), (A)+(B111)+(B208), (A)+(B111)+(B209), (A)+(B111)+(B210), (A)+(B111)+(B211), (A)+(B111)+(B212), (A)+(B111)+(B213), (A)+(B111)+(B214), (A)+(B111)+(B215), (A)+(B111)+(B216), (A)+(B111)+(B217), (A)+(B111)+(B218), (A)+(B111)+(B219), (A)+(B111)+(B220), (A)+(B111)+(B221), (A)+(B111)+(B222), (A)+(B111)+(B223), (A)+(B111)+(B224), (A)+(B111)+(B225), (A)+(B111)+(B226), (A)+(B111)+(B227), (A)+(B111)+(B228), (A)+(B111)+(B229), (A)+(B111)+(B230), (A)+(B111)+(B231), (A)+(B111)+(B232), (A)+(B111)+(B233), (A)+(B111)+(B234), (A)+(B111)+(B235), (A)+(B111)+(B236), (A)+(B111)+(B237), (A)+(B111)+(B238), (A)+(B111)+(B239), (A)+(B111)+(B240), (A)+(B111)+(B241), (A)+(B111)+(B242), (A)+(B111)+(B243), (A)+(B111)+(B244), (A)+(B111)+(B245), (A)+(B111)+(B246), (A)+(B111)+(B247), (A)+(B111)+(B248), (A)+(B111)+(B249), (A)+(B111)+(B250), (A)+(B111)+(B251), (A)+(B111)+(B252), (A)+(B111)+(B253), (A)+(B111)+(B254), (A)+(B111)+(B255), (A)+(B111)+(B256), (A)+(B111)+(B257), (A)+(B111)+(B258), (A)+(B111)+(B259), (A)+(B111)+(B260), (A)+(B111)+(B261), (A)+(B111)+(B262), (A)+(B111)+(B263), (A)+(B111)+(B264), (A)+(B111)+(B265), (A)+(B111)+(B266), (A)+(B111)+(B267), (A)+(B111)+(B268), (A)+(B111)+(B269), (A)+(B111)+(B270), (A)+(B111)+(B271), (A)+(B111)+(B272), (A)+(B111)+(B273), (A)+(B111)+(B274), (A)+(B111)+(B275), (A)+(B111)+(B276), (A)+(B111)+(B277), (A)+(B111)+(B278), (A)+(B111)+(B279), (A)+(B111)+(B280), (A)+(B111)+(B281), (A)+(B111)+(B282), (A)+(B111)+(B283), (A)+(B111)+(B284), (A)+(B111)+(B285), (A)+(B111)+(B286), (A)+(B111)+(B287), (A)+(B111)+(B288), (A)+(B111)+(B289), (A)+(B111)+(B290), (A)+(B111)+(B291), (A)+(B111)+(B292), (A)+(B111)+(B293), (A)+(B111)+(B294), (A)+(B111)+(B295), (A)+(B111)+(B296), (A)+(B111)+(B297), (A)+(B111)+(B298), (A)+(B111)+(B299), (A)+(B111)+(B300), (A)+(B111)+(B301), (A)+(B111)+(B302), (A)+(B111)+(B303), (A)+(B111)+(B304), (A)+(B111)+(B305), (A)+(B111)+(B306), (A)+(B111)+(B307), (A)+(B111)+(B308), (A)+(B111)+(B309), (A)+(B111)+(B310), (A)+(B111)+(B311), (A)+(B111)+(B312), (A)+(B111)+(B313), (A)+(B111)+(B314), (A)+(B111)+(B315),

(A)+(B112)+(B113), (A)+(B112)+(B114), (A)+(B112)+(B115), (A)+(B112)+(B116), (A)+(B112)+(B117), (A)+(B112)+(B118), (A)+(B112)+(B119), (A)+(B112)+(B120), (A)+(B112)+(B121), (A)+(B112)+(B122), (A)+(B112)+(B123), (A)+(B112)+(B124), (A)+(B112)+(B125), (A)+(B112)+(B126), (A)+(B112)+(B127), (A)+(B112)+(B128), (A)+(B112)+(B129), (A)+(B112)+(B130), (A)+(B112)+(B131), (A)+(B112)+(B132), (A)+(B112)+(B133), (A)+(B112)+(B134), (A)+(B112)+(B135), (A)+(B112)+(B136), (A)+(B112)+(B137), (A)+(B112)+(B138), (A)+(B112)+(B139), (A)+(B112)+(B140), (A)+(B112)+(B141), (A)+(B112)+(B142), (A)+(B112)+(B143), (A)+(B112)+(B144), (A)+(B112)+(B145), (A)+(B112)+(B146), (A)+(B112)+(B147), (A)+(B112)+(B148), (A)+(B112)+(B149), (A)+(B112)+(B150), (A)+(B112)+(B151), (A)+(B112)+(B152), (A)+(B112)+(B153), (A)+(B112)+(B154), (A)+(B112)+(B155), (A)+(B112)+(B156), (A)+(B112)+(B157), (A)+(B112)+(B158), (A)+(B112)+(B159), (A)+(B112)+(B160), (A)+(B112)+(B161), (A)+(B112)+(B162), (A)+(B112)+(B164), (A)+(B112)+(B164), (A)+(B112)+(B165), (A)+(B112)+(B166), (A)+(B112)+(B167), (A)+(B112)+(B168), (A)+(B112)+(B169), (A)+(B112)+(B170), (A)+(B112)+(B171), (A)+(B112)+(B172), (A)+(B112)+(B173), (A)+(B112)+(B174), (A)+(B112)+(B175), (A)+(B112)+(B176), (A)+(B112)+(B177), (A)+(B112)+(B178), (A)+(B112)+(B179), (A)+(B112)+(B180), (A)+(B112)+(B181), (A)+(B112)+(B182), (A)+(B112)+(B183), (A)+(B112)+(B184), (A)+(B112)+(B185), (A)+(B112)+(B186), (A)+(B112)+(B187), (A)+(B112)+(B188), (A)+(B112)+(B189), (A)+(B112)+(B190), (A)+(B112)+(B191), (A)+(B112)+(B192), (A)+(B112)+(B193), (A)+(B112)+(B194), (A)+(B112)+(B195), (A)+(B112)+(B196), (A)+(B112)+(B197), (A)+(B112)+(B198), (A)+(B112)+(B199), (A)+(B112)+(B200), (A)+(B112)+(B201), (A)+(B112)+(B202), (A)+(B112)+(B203), (A)+(B112)+(B204), (A)+(B112)+(B205), (A)+(B112)+(B206), (A)+(B112)+(B207), (A)+(B112)+(B208), (A)+(B112)+(B209), (A)+(B112)+(B210), (A)+(B112)+(B211), (A)+(B112)+(B212), (A)+(B112)+(B213), (A)+(B112)+(B214), (A)+(B112)+(B215), (A)+(B112)+(B216), (A)+(B112)+(B217), (A)+(B112)+(B218), (A)+(B112)+(B219), (A)+(B112)+(B220), (A)+(B112)+(B221), (A)+(B112)+(B222), (A)+(B112)+(B223), (A)+(B112)+(B224), (A)+(B112)+(B225), (A)+(B112)+(B226), (A)+(B112)+(B227), (A)+(B112)+(B228), (A)+(B112)+(B229), (A)+(B112)+(B230), (A)+(B112)+(B231), (A)+(B112)+(B232), (A)+(B112)+(B233), (A)+(B112)+(B234), (A)+(B112)+(B235), (A)+(B112)+(B236), (A)+(B112)+(B237), (A)+(B112)+(B238), (A)+(B112)+(B239), (A)+(B112)+(B240), (A)+(B112)+(B241), (A)+(B112)+(B242), (A)+(B112)+(B243), (A)+(B112)+(B244), (A)+(B112)+(B245), (A)+(B112)+(B246), (A)+(B112)+(B247), (A)+(B112)+(B248), (A)+(B112)+(B249), (A)+(B112)+(B250), (A)+(B112)+(B251), (A)+(B112)+(B252), (A)+(B112)+(B253), (A)+(B112)+(B254), (A)+(B112)+(B255), (A)+(B112)+(B256), (A)+(B112)+(B257), (A)+(B112)+(B258), (A)+(B112)+(B259), (A)+(B112)+(B260), (A)+(B112)+(B261), (A)+(B112)+(B262), (A)+(B112)+(B263), (A)+(B112)+(B264), (A)+(B112)+(B265), (A)+(B112)+(B266), (A)+(B112)+(B267), (A)+(B112)+(B268), (A)+(B112)+(B269), (A)+(B112)+(B270), (A)+(B112)+(B271), (A)+(B112)+(B272), (A)+(B112)+(B273), (A)+(B112)+(B274), (A)+(B112)+(B275), (A)+(B112)+(B276), (A)+(B112)+(B277), (A)+(B112)+(B278), (A)+(B112)+(B279), (A)+(B112)+(B280), (A)+(B112)+(B281), (A)+(B112)+(B282), (A)+(B112)+(B283), (A)+(B112)+(B284), (A)+(B112)+(B285), (A)+(B112)+(B286), (A)+(B112)+(B287), (A)+(B112)+(B288), (A)+(B112)+(B289), (A)+(B112)+(B290), (A)+(B112)+(B291), (A)+(B112)+(B292), (A)+(B112)+(B293), (A)+(B112)+(B294), (A)+(B112)+(B295), (A)+(B112)+(B296), (A)+(B112)+(B297), (A)+(B112)+(B298), (A)+(B112)+(B299), (A)+(B112)+(B300), (A)+(B112)+(B301), (A)+(B112)+(B302), (A)+(B112)+(B303), (A)+(B112)+(B304), (A)+(B112)+(B305), (A)+(B112)+(B306), (A)+(B112)+(B307), (A)+(B112)+(B308), (A)+(B112)+(B309), (A)+(B112)+(B310), (A)+(B112)+(B311), (A)+(B112)+(B312), (A)+(B112)+(B313), (A)+(B112)+(B314), (A)+(B112)+(B315),

(A)+(B113)+(B114), (A)+(B113)+(B115), (A)+(B113)+(B116), (A)+(B113)+(B117), (A)+(B113)+(B118), (A)+(B113)+(B119), (A)+(B113)+(B120), (A)+(B113)+(B121), (A)+(B113)+(B122), (A)+(B113)+(B123), (A)+(B113)+(B124), (A)+(B113)+(B125), (A)+(B113)+(B126), (A)+(B113)+(B127), (A)+(B113)+(B128), (A)+(B113)+(B129), (A)+(B113)+(B130), (A)+(B113)+(B131), (A)+(B113)+(B132), (A)+(B113)+(B133), (A)+(B113)+(B134), (A)+(B113)+(B135), (A)+(B113)+(B136), (A)+(B113)+(B137), (A)+(B113)+(B138), (A)+(B113)+(B139), (A)+(B113)+(B140), (A)+(B113)+(B141), (A)+(B113)+(B142), (A)+(B113)+(B143), (A)+(B113)+(B144), (A)+(B113)+(B145), (A)+(B113)+(B146), (A)+(B113)+(B147), (A)+(B113)+(B148), (A)+(B113)+(B149), (A)+(B113)+(B150), (A)+(B113)+(B151), (A)+(B113)+(B152), (A)+(B113)+(B153), (A)+(B113)+(B154), (A)+(B113)+(B155), (A)+(B113)+(B156), (A)+(B113)+(B157), (A)+(B113)+(B158), (A)+(B113)+(B159), (A)+(B113)+(B160), (A)+(B113)+(B161), (A)+(B113)+(B162), (A)+(B113)+(B164), (A)+(B113)+(B164), (A)+(B113)+(B165), (A)+(B113)+(B166), (A)+(B113)+(B167), (A)+(B113)+(B168), (A)+(B113)+(B169), (A)+(B113)+(B170), (A)+(B113)+(B171), (A)+(B113)+(B172), (A)+(B113)+(B173), (A)+(B113)+(B174), (A)+(B113)+(B175), (A)+(B113)+(B176), (A)+(B113)+(B177), (A)+(B113)+(B178), (A)+(B113)+(B179), (A)+(B113)+(B180), (A)+(B113)+(B181), (A)+(B113)+(B182), (A)+(B113)+(B183), (A)+(B113)+(B184), (A)+(B113)+(B185), (A)+(B113)+(B186), (A)+(B113)+(B187), (A)+(B113)+(B188), (A)+(B113)+(B189), (A)+(B113)+(B190), (A)+(B113)+(B191), (A)+(B113)+(B192), (A)+(B113)+(B193), (A)+(B113)+(B194), (A)+(B113)+(B195), (A)+(B113)+(B196), (A)+(B113)+(B197), (A)+(B113)+(B198), (A)+(B113)+(B199), (A)+(B113)+(B200), (A)+(B113)+(B201), (A)+(B113)+(B202), (A)+(B113)+(B203), (A)+(B113)+(B204), (A)+(B113)+(B205), (A)+(B113)+(B206), (A)+(B113)+(B207), (A)+(B113)+(B208), (A)+(B113)+(B209), (A)+(B113)+(B210), (A)+(B113)+(B211), (A)+(B113)+(B212), (A)+(B113)+(B213), (A)+(B113)+(B214), (A)+(B113)+(B215), (A)+(B113)+(B216), (A)+(B113)+(B217), (A)+(B113)+(B218), (A)+(B113)+(B219), (A)+(B113)+(B220), (A)+(B113)+(B221), (A)+(B113)+(B222), (A)+(B113)+(B223), (A)+(B113)+(B224), (A)+(B113)+(B225), (A)+(B113)+(B226), (A)+(B113)+(B227), (A)+(B113)+(B228), (A)+(B113)+(B229), (A)+(B113)+(B230), (A)+(B113)+(B231), (A)+(B113)+(B232), (A)+(B113)+(B233), (A)+(B113)+(B234), (A)+(B113)+(B235), (A)+(B113)+(B236), (A)+(B113)+(B237), (A)+(B113)+(B238), (A)+(B113)+(B239), (A)+(B113)+(B240), (A)+(B113)+(B241), (A)+(B113)+(B242), (A)+(B113)+(B243), (A)+(B113)+(B244), (A)+(B113)+(B245), (A)+(B113)+(B246), (A)+(B113)+(B247), (A)+(B113)+(B248), (A)+(B113)+(B249), (A)+(B113)+(B250), (A)+(B113)+(B251), (A)+(B113)+(B252), (A)+(B113)+(B253), (A)+(B113)+(B254), (A)+(B113)+(B255), (A)+(B113)+(B256), (A)+(B113)+(B257), (A)+(B113)+(B258), (A)+(B113)+(B259), (A)+(B113)+(B260), (A)+(B113)+(B261), (A)+(B113)+(B262), (A)+(B113)+(B263), (A)+(B113)+(B264), (A)+(B113)+(B265), (A)+(B113)+(B266), (A)+(B113)+(B267), (A)+(B113)+(B268), (A)+(B113)+(B269), (A)+(B113)+(B270), (A)+(B113)+(B271), (A)+(B113)+(B272), (A)+(B113)+(B273), (A)+(B113)+(B274), (A)+(B113)+(B275), (A)+(B113)+(B276), (A)+(B113)+(B277), (A)+(B113)+(B278), (A)+(B113)+(B279), (A)+(B113)+(B280), (A)+(B113)+(B281), (A)+(B113)+(B282), (A)+(B113)+(B283), (A)+(B113)+(B284), (A)+(B113)+(B285), (A)+(B113)+(B286), (A)+(B113)+(B287), (A)+(B113)+(B288), (A)+(B113)+(B289), (A)+(B113)+(B290), (A)+(B113)+(B291), (A)+(B113)+(B292), (A)+(B113)+(B293), (A)+(B113)+(B294), (A)+(B113)+(B295), (A)+(B113)+(B296), (A)+(B113)+(B297), (A)+(B113)+(B298), (A)+(B113)+(B299), (A)+(B113)+(B300), (A)+(B113)+(B301), (A)+(B113)+(B302), (A)+(B113)+(B303), (A)+(B113)+(B304), (A)+(B113)+(B305), (A)+(B113)+(B306), (A)+(B113)+(B307), (A)+(B113)+(B308), (A)+(B113)+(B309), (A)+(B113)+(B310), (A)+(B113)+(B311), (A)+(B113)+(B312), (A)+(B113)+(B313), (A)+(B113)+(B314), (A)+(B113)+(B315),

(A)+(B114)+(B115), (A)+(B114)+(B116), (A)+(B114)+(B117), (A)+(B114)+(B118), (A)+(B114)+(B119), (A)+(B114)+(B120), (A)+(B114)+(B121), (A)+(B114)+(B122), (A)+(B114)+(B123), (A)+(B114)+(B124), (A)+(B114)+(B125), (A)+(B114)+(B126), (A)+(B114)+(B127), (A)+(B114)+(B128), (A)+(B114)+(B129), (A)+(B114)+(B130), (A)+(B114)+(B131), (A)+(B114)+(B132), (A)+(B114)+(B133), (A)+(B114)+(B134), (A)+(B114)+(B135), (A)+(B114)+(B136), (A)+(B114)+(B137), (A)+(B114)+(B138), (A)+(B114)+(B139), (A)+(B114)+(B140), (A)+(B114)+(B141), (A)+(B114)+(B142), (A)+(B114)+(B143), (A)+(B114)+(B144), (A)+(B114)+(B145), (A)+(B114)+(B146), (A)+(B114)+(B147), (A)+(B114)+(B148), (A)+(B114)+(B149), (A)+(B114)+(B150), (A)+(B114)+(B151), (A)+(B114)+(B152), (A)+(B114)+(B153), (A)+(B114)+(B154), (A)+(B114)+(B155), (A)+(B114)+(B156), (A)+(B114)+(B157), (A)+(B114)+(B158), (A)+(B114)+(B159), (A)+(B114)+(B160), (A)+(B114)+(B161), (A)+(B114)+(B162), (A)+(B114)+(B164), (A)+(B114)+(B164), (A)+(B114)+(B165), (A)+(B114)+(B166), (A)+(B114)+(B167), (A)+(B114)+(B168), (A)+(B114)+(B169), (A)+(B114)+(B170), (A)+(B114)+(B171), (A)+(B114)+(B172), (A)+(B114)+(B173), (A)+(B114)+(B174), (A)+(B114)+(B175), (A)+(B114)+(B176), (A)+(B114)+(B177), (A)+(B114)+(B178), (A)+(B114)+(B179), (A)+(B114)+(B180), (A)+(B114)+(B181), (A)+(B114)+(B182), (A)+(B114)+(B183), (A)+(B114)+(B184), (A)+(B114)+(B185), (A)+(B114)+(B186), (A)+(B114)+(B187), (A)+(B114)+(B188), (A)+(B114)+(B189), (A)+(B114)+(B190), (A)+(B114)+(B191), (A)+(B114)+(B192), (A)+(B114)+(B193), (A)+(B114)+(B194), (A)+(B114)+(B195), (A)+(B114)+(B196), (A)+(B114)+(B197), (A)+(B114)+(B198), (A)+(B114)+(B199), (A)+(B114)+(B200), (A)+(B114)+(B201), (A)+(B114)+(B202), (A)+(B114)+(B203), (A)+(B114)+(B204), (A)+(B114)+(B205), (A)+(B114)+(B206), (A)+(B114)+(B207), (A)+(B114)+(B208), (A)+(B114)+(B209), (A)+(B114)+(B210), (A)+(B114)+(B211), (A)+(B114)+(B212), (A)+(B114)+(B213), (A)+(B114)+(B214), (A)+(B114)+(B215), (A)+(B114)+(B216), (A)+(B114)+(B217), (A)+(B114)+(B218), (A)+(B114)+(B219), (A)+(B114)+(B220), (A)+(B114)+(B221), (A)+(B114)+(B222), (A)+(B114)+(B223), (A)+(B114)+(B224), (A)+(B114)+(B225), (A)+(B114)+(B226), (A)+(B114)+(B227), (A)+(B114)+(B228), (A)+(B114)+(B229), (A)+(B114)+(B230), (A)+(B114)+(B231), (A)+(B114)+(B232), (A)+(B114)+(B233), (A)+(B114)+(B234), (A)+(B114)+(B235), (A)+(B114)+(B236), (A)+(B114)+(B237), (A)+(B114)+(B238), (A)+(B114)+(B239), (A)+(B114)+(B240), (A)+(B114)+(B241), (A)+(B114)+(B242), (A)+(B114)+(B243), (A)+(B114)+(B244), (A)+(B114)+(B245), (A)+(B114)+(B246), (A)+(B114)+(B247), (A)+(B114)+(B248), (A)+(B114)+(B249), (A)+(B114)+(B250), (A)+(B114)+(B251), (A)+(B114)+(B252), (A)+(B114)+(B253), (A)+(B114)+(B254), (A)+(B114)+(B255), (A)+(B114)+(B256), (A)+(B114)+(B257), (A)+(B114)+(B258), (A)+(B114)+(B259), (A)+(B114)+(B260), (A)+(B114)+(B261), (A)+(B114)+(B262), (A)+(B114)+(B263), (A)+(B114)+(B264), (A)+(B114)+(B265), (A)+(B114)+(B266), (A)+(B114)+(B267), (A)+(B114)+(B268), (A)+(B114)+(B269), (A)+(B114)+(B270), (A)+(B114)+(B271), (A)+(B114)+(B272), (A)+(B114)+(B273), (A)+(B114)+(B274), (A)+(B114)+(B275), (A)+(B114)+(B276), (A)+(B114)+(B277), (A)+(B114)+(B278), (A)+(B114)+(B279), (A)+(B114)+(B280), (A)+(B114)+(B281), (A)+(B114)+(B282), (A)+(B114)+(B283), (A)+(B114)+(B284), (A)+(B114)+(B285), (A)+(B114)+(B286), (A)+(B114)+(B287), (A)+(B114)+(B288), (A)+(B114)+(B289), (A)+(B114)+(B290), (A)+(B114)+(B291), (A)+(B114)+(B292), (A)+(B114)+(B293), (A)+(B114)+(B294), (A)+(B114)+(B295), (A)+(B114)+(B296), (A)+(B114)+(B297), (A)+(B114)+(B298), (A)+(B114)+(B299), (A)+(B114)+(B300), (A)+(B114)+(B301), (A)+(B114)+(B302), (A)+(B114)+(B303), (A)+(B114)+(B304), (A)+(B114)+(B305), (A)+(B114)+(B306), (A)+(B114)+(B307), (A)+(B114)+(B308), (A)+(B114)+(B309), (A)+(B114)+(B310), (A)+(B114)+(B311), (A)+(B114)+(B312), (A)+(B114)+(B313), (A)+(B114)+(B314), (A)+(B114)+(B315),

(A)+(B115)+(B116), (A)+(B115)+(B117), (A)+(B115)+(B118), (A)+(B115)+(B119), (A)+(B115)+(B120), (A)+(B115)+(B121), (A)+(B115)+(B122), (A)+(B115)+(B123), (A)+(B115)+(B124), (A)+(B115)+(B125), (A)+(B115)+(B126), (A)+(B115)+(B127), (A)+(B115)+(B128), (A)+(B115)+(B129), (A)+(B115)+(B130), (A)+(B115)+(B131), (A)+(B115)+(B132), (A)+(B115)+(B133), (A)+(B115)+(B134), (A)+(B115)+(B135), (A)+(B115)+(B136), (A)+(B115)+(B137), (A)+(B115)+(B138), (A)+(B115)+(B139), (A)+(B115)+(B140), (A)+(B115)+(B141), (A)+(B115)+(B142), (A)+(B115)+(B143), (A)+(B115)+(B144), (A)+(B115)+(B145), (A)+(B115)+(B146), (A)+(B115)+(B147), (A)+(B115)+(B148), (A)+(B115)+(B149), (A)+(B115)+(B150), (A)+(B115)+(B151), (A)+(B115)+(B152), (A)+(B115)+(B153), (A)+(B115)+(B154), (A)+(B115)+(B155), (A)+(B115)+(B156), (A)+(B115)+(B157), (A)+(B115)+(B158), (A)+(B115)+(B159), (A)+(B115)+(B160), (A)+(B115)+(B161), (A)+(B115)+(B162), (A)+(B115)+(B164), (A)+(B115)+(B164), (A)+(B115)+(B165), (A)+(B115)+(B166), (A)+(B115)+(B167), (A)+(B115)+(B168), (A)+(B115)+(B169), (A)+(B115)+(B170), (A)+(B115)+(B171), (A)+(B115)+(B172), (A)+(B115)+(B173), (A)+(B115)+(B174), (A)+(B115)+(B175), (A)+(B115)+(B176), (A)+(B115)+(B177), (A)+(B115)+(B178), (A)+(B115)+(B179), (A)+(B115)+(B180), (A)+(B115)+(B181), (A)+(B115)+(B182), (A)+(B115)+(B183), (A)+(B115)+(B184), (A)+(B115)+(B185), (A)+(B115)+(B186), (A)+(B115)+(B187), (A)+(B115)+(B188), (A)+(B115)+(B189), (A)+(B115)+(B190), (A)+(B115)+(B191), (A)+(B115)+(B192), (A)+(B115)+(B193), (A)+(B115)+(B194), (A)+(B115)+(B195), (A)+(B115)+(B196), (A)+(B115)+(B197), (A)+(B115)+(B198), (A)+(B115)+(B199), (A)+(B115)+(B200), (A)+(B115)+(B201), (A)+(B115)+(B202), (A)+(B115)+(B203), (A)+(B115)+(B204), (A)+(B115)+(B205), (A)+(B115)+(B206), (A)+(B115)+(B207), (A)+(B115)+(B208), (A)+(B115)+(B209), (A)+(B115)+(B210), (A)+(B115)+(B211), (A)+(B115)+(B212), (A)+(B115)+(B213), (A)+(B115)+(B214), (A)+(B115)+(B215), (A)+(B115)+(B216), (A)+(B115)+(B217), (A)+(B115)+(B218), (A)+(B115)+(B219), (A)+(B115)+(B220), (A)+(B115)+(B221), (A)+(B115)+(B222), (A)+(B115)+(B223), (A)+(B115)+(B224), (A)+(B115)+(B225), (A)+(B115)+(B226), (A)+(B115)+(B227), (A)+(B115)+(B228), (A)+(B115)+(B229), (A)+(B115)+(B230), (A)+(B115)+(B231), (A)+(B115)+(B232), (A)+(B115)+(B233), (A)+(B115)+(B234), (A)+(B115)+(B235), (A)+(B115)+(B236), (A)+(B115)+(B237), (A)+(B115)+(B238), (A)+(B115)+(B239), (A)+(B115)+(B240), (A)+(B115)+(B241), (A)+(B115)+(B242), (A)+(B115)+(B243), (A)+(B115)+(B244), (A)+(B115)+(B245), (A)+(B115)+(B246), (A)+(B115)+(B247), (A)+(B115)+(B248), (A)+(B115)+(B249), (A)+(B115)+(B250), (A)+(B115)+(B251), (A)+(B115)+(B252), (A)+(B115)+(B253), (A)+(B115)+(B254), (A)+(B115)+(B255), (A)+(B115)+(B256), (A)+(B115)+(B257), (A)+(B115)+(B258), (A)+(B115)+(B259), (A)+(B115)+(B260), (A)+(B115)+(B261), (A)+(B115)+(B262), (A)+(B115)+(B263), (A)+(B115)+(B264), (A)+(B115)+(B265), (A)+(B115)+(B266), (A)+(B115)+(B267), (A)+(B115)+(B268), (A)+(B115)+(B269), (A)+(B115)+(B270), (A)+(B115)+(B271), (A)+(B115)+(B272), (A)+(B115)+(B273), (A)+(B115)+(B274), (A)+(B115)+(B275), (A)+(B115)+(B276), (A)+(B115)+(B277), (A)+(B115)+(B278), (A)+(B115)+(B279), (A)+(B115)+(B280), (A)+(B115)+(B281), (A)+(B115)+(B282), (A)+(B115)+(B283), (A)+(B115)+(B284), (A)+(B115)+(B285), (A)+(B115)+(B286), (A)+(B115)+(B287), (A)+(B115)+(B288), (A)+(B115)+(B289), (A)+(B115)+(B290), (A)+(B115)+(B291), (A)+(B115)+(B292), (A)+(B115)+(B293), (A)+(B115)+(B294), (A)+(B115)+(B295), (A)+(B115)+(B296), (A)+(B115)+(B297), (A)+(B115)+(B298), (A)+(B115)+(B299), (A)+(B115)+(B300), (A)+(B115)+(B301), (A)+(B115)+(B302), (A)+(B115)+(B303), (A)+(B115)+(B304), (A)+(B115)+(B305), (A)+(B115)+(B306), (A)+(B115)+(B307), (A)+(B115)+(B308), (A)+(B115)+(B309), (A)+(B115)+(B310), (A)+(B115)+(B311), (A)+(B115)+(B312), (A)+(B115)+(B313), (A)+(B115)+(B314), (A)+(B115)+(B315),

(A)+(B116)+(B117), (A)+(B116)+(B118), (A)+(B116)+(B119), (A)+(B116)+(B120), (A)+(B116)+(B121), (A)+(B116)+(B122), (A)+(B116)+(B123), (A)+(B116)+(B124), (A)+(B116)+(B125), (A)+(B116)+(B126), (A)+(B116)+(B127), (A)+(B116)+(B128), (A)+(B116)+(B129), (A)+(B116)+(B130), (A)+(B116)+(B131), (A)+(B116)+(B132), (A)+(B116)+(B133), (A)+(B116)+(B134), (A)+(B116)+(B135), (A)+(B116)+(B136), (A)+(B116)+(B137), (A)+(B116)+(B138), (A)+(B116)+(B139), (A)+(B116)+(B140), (A)+(B116)+(B141), (A)+(B116)+(B142), (A)+(B116)+(B143), (A)+(B116)+(B144), (A)+(B116)+(B145), (A)+(B116)+(B146), (A)+(B116)+(B147), (A)+(B116)+(B148), (A)+(B116)+(B149), (A)+(B116)+(B150), (A)+(B116)+(B151), (A)+(B116)+(B152), (A)+(B116)+(B153), (A)+(B116)+(B154), (A)+(B116)+(B155), (A)+(B116)+(B156), (A)+(B116)+(B157), (A)+(B116)+(B158), (A)+(B116)+(B159), (A)+(B116)+(B160), (A)+(B116)+(B161), (A)+(B116)+(B162), (A)+(B116)+(B164), (A)+(B116)+(B164), (A)+(B116)+(B165), (A)+(B116)+(B166), (A)+(B116)+(B167), (A)+(B116)+(B168), (A)+(B116)+(B169), (A)+(B116)+(B170), (A)+(B116)+(B171), (A)+(B116)+(B172), (A)+(B116)+(B173), (A)+(B116)+(B174), (A)+(B116)+(B175), (A)+(B116)+(B176), (A)+(B116)+(B177), (A)+(B116)+(B178), (A)+(B116)+(B179), (A)+(B116)+(B180), (A)+(B116)+(B181), (A)+(B116)+(B182), (A)+(B116)+(B183), (A)+(B116)+(B184), (A)+(B116)+(B185), (A)+(B116)+(B186), (A)+(B116)+(B187), (A)+(B116)+(B188), (A)+(B116)+(B189), (A)+(B116)+(B190), (A)+(B116)+(B191), (A)+(B116)+(B192), (A)+(B116)+(B193), (A)+(B116)+(B194), (A)+(B116)+(B195), (A)+(B116)+(B196), (A)+(B116)+(B197), (A)+(B116)+(B198), (A)+(B116)+(B199), (A)+(B116)+(B200), (A)+(B116)+(B201), (A)+(B116)+(B202), (A)+(B116)+(B203), (A)+(B116)+(B204), (A)+(B116)+(B205), (A)+(B116)+(B206), (A)+(B116)+(B207), (A)+(B116)+(B208), (A)+(B116)+(B209), (A)+(B116)+(B210), (A)+(B116)+(B211), (A)+(B116)+(B212), (A)+(B116)+(B213), (A)+(B116)+(B214), (A)+(B116)+(B215), (A)+(B116)+(B216), (A)+(B116)+(B217), (A)+(B116)+(B218), (A)+(B116)+(B219), (A)+(B116)+(B220), (A)+(B116)+(B221), (A)+(B116)+(B222), (A)+(B116)+(B223), (A)+(B116)+(B224), (A)+(B116)+(B225), (A)+(B116)+(B226), (A)+(B116)+(B227), (A)+(B116)+(B228), (A)+(B116)+(B229), (A)+(B116)+(B230), (A)+(B116)+(B231), (A)+(B116)+(B232), (A)+(B116)+(B233), (A)+(B116)+(B234), (A)+(B116)+(B235), (A)+(B116)+(B236), (A)+(B116)+(B237), (A)+(B116)+(B238), (A)+(B116)+(B239), (A)+(B116)+(B240), (A)+(B116)+(B241), (A)+(B116)+(B242), (A)+(B116)+(B243), (A)+(B116)+(B244), (A)+(B116)+(B245), (A)+(B116)+(B246), (A)+(B116)+(B247), (A)+(B116)+(B248), (A)+(B116)+(B249), (A)+(B116)+(B250), (A)+(B116)+(B251), (A)+(B116)+(B252), (A)+(B116)+(B253), (A)+(B116)+(B254), (A)+(B116)+(B255), (A)+(B116)+(B256), (A)+(B116)+(B257), (A)+(B116)+(B258), (A)+(B116)+(B259), (A)+(B116)+(B260), (A)+(B116)+(B261), (A)+(B116)+(B262), (A)+(B116)+(B263), (A)+(B116)+(B264), (A)+(B116)+(B265), (A)+(B116)+(B266), (A)+(B116)+(B267), (A)+(B116)+(B268), (A)+(B116)+(B269), (A)+(B116)+(B270), (A)+(B116)+(B271), (A)+(B116)+(B272), (A)+(B116)+(B273), (A)+(B116)+(B274), (A)+(B116)+(B275), (A)+(B116)+(B276), (A)+(B116)+(B277), (A)+(B116)+(B278), (A)+(B116)+(B279), (A)+(B116)+(B280), (A)+(B116)+(B281), (A)+(B116)+(B282), (A)+(B116)+(B283), (A)+(B116)+(B284), (A)+(B116)+(B285), (A)+(B116)+(B286), (A)+(B116)+(B287), (A)+(B116)+(B288), (A)+(B116)+(B289), (A)+(B116)+(B290), (A)+(B116)+(B291), (A)+(B116)+(B292), (A)+(B116)+(B293), (A)+(B116)+(B294), (A)+(B116)+(B295), (A)+(B116)+(B296), (A)+(B116)+(B297), (A)+(B116)+(B298), (A)+(B116)+(B299), (A)+(B116)+(B300), (A)+(B116)+(B301), (A)+(B116)+(B302), (A)+(B116)+(B303), (A)+(B116)+(B304), (A)+(B116)+(B305), (A)+(B116)+(B306), (A)+(B116)+(B307), (A)+(B116)+(B308), (A)+(B116)+(B309), (A)+(B116)+(B310), (A)+(B116)+(B311), (A)+(B116)+(B312), (A)+(B116)+(B313), (A)+(B116)+(B314), (A)+(B116)+(B315),

(A)+(B117)+(B118), (A)+(B117)+(B119), (A)+(B117)+(B120), (A)+(B117)+(B121), (A)+(B117)+(B122), (A)+(B117)+(B123), (A)+(B117)+(B124), (A)+(B117)+(B125), (A)+(B117)+(B126), (A)+(B117)+(B127), (A)+(B117)+(B128), (A)+(B117)+(B129), (A)+(B117)+(B130), (A)+(B117)+(B131), (A)+(B117)+(B132), (A)+(B117)+(B133), (A)+(B117)+(B134), (A)+(B117)+(B135), (A)+(B117)+(B136), (A)+(B117)+(B137), (A)+(B117)+(B138), (A)+(B117)+(B139), (A)+(B117)+(B140), (A)+(B117)+(B141), (A)+(B117)+(B142), (A)+(B117)+(B143), (A)+(B117)+(B144), (A)+(B117)+(B145), (A)+(B117)+(B146), (A)+(B117)+(B147), (A)+(B117)+(B148), (A)+(B117)+(B149), (A)+(B117)+(B150), (A)+(B117)+(B151), (A)+(B117)+(B152), (A)+(B117)+(B153), (A)+(B117)+(B154), (A)+(B117)+(B155), (A)+(B117)+(B156), (A)+(B117)+(B157), (A)+(B117)+(B158), (A)+(B117)+(B159), (A)+(B117)+(B160), (A)+(B117)+(B161), (A)+(B117)+(B162), (A)+(B117)+(B164), (A)+(B117)+(B164), (A)+(B117)+(B165), (A)+(B117)+(B166), (A)+(B117)+(B167), (A)+(B117)+(B168), (A)+(B117)+(B169), (A)+(B117)+(B170), (A)+(B117)+(B171), (A)+(B117)+(B172), (A)+(B117)+(B173), (A)+(B117)+(B174), (A)+(B117)+(B175), (A)+(B117)+(B176), (A)+(B117)+(B177), (A)+(B117)+(B178), (A)+(B117)+(B179), (A)+(B117)+(B180), (A)+(B117)+(B181), (A)+(B117)+(B182), (A)+(B117)+(B183), (A)+(B117)+(B184), (A)+(B117)+(B185), (A)+(B117)+(B186), (A)+(B117)+(B187), (A)+(B117)+(B188), (A)+(B117)+(B189), (A)+(B117)+(B190), (A)+(B117)+(B191), (A)+(B117)+(B192), (A)+(B117)+(B193), (A)+(B117)+(B194), (A)+(B117)+(B195), (A)+(B117)+(B196), (A)+(B117)+(B197), (A)+(B117)+(B198), (A)+(B117)+(B199), (A)+(B117)+(B200), (A)+(B117)+(B201), (A)+(B117)+(B202), (A)+(B117)+(B203), (A)+(B117)+(B204), (A)+(B117)+(B205), (A)+(B117)+(B206), (A)+(B117)+(B207), (A)+(B117)+(B208), (A)+(B117)+(B209), (A)+(B117)+(B210), (A)+(B117)+(B211), (A)+(B117)+(B212), (A)+(B117)+(B213), (A)+(B117)+(B214), (A)+(B117)+(B215), (A)+(B117)+(B216), (A)+(B117)+(B217), (A)+(B117)+(B218), (A)+(B117)+(B219), (A)+(B117)+(B220), (A)+(B117)+(B221), (A)+(B117)+(B222), (A)+(B117)+(B223), (A)+(B117)+(B224), (A)+(B117)+(B225), (A)+(B117)+(B226), (A)+(B117)+(B227), (A)+(B117)+(B228), (A)+(B117)+(B229), (A)+(B117)+(B230), (A)+(B117)+(B231), (A)+(B117)+(B232), (A)+(B117)+(B233), (A)+(B117)+(B234), (A)+(B117)+(B235), (A)+(B117)+(B236), (A)+(B117)+(B237), (A)+(B117)+(B238), (A)+(B117)+(B239), (A)+(B117)+(B240), (A)+(B117)+(B241), (A)+(B117)+(B242), (A)+(B117)+(B243), (A)+(B117)+(B244), (A)+(B117)+(B245), (A)+(B117)+(B246), (A)+(B117)+(B247), (A)+(B117)+(B248), (A)+(B117)+(B249), (A)+(B117)+(B250), (A)+(B117)+(B251), (A)+(B117)+(B252), (A)+(B117)+(B253), (A)+(B117)+(B254), (A)+(B117)+(B255), (A)+(B117)+(B256), (A)+(B117)+(B257), (A)+(B117)+(B258), (A)+(B117)+(B259), (A)+(B117)+(B260), (A)+(B117)+(B261), (A)+(B117)+(B262), (A)+(B117)+(B263), (A)+(B117)+(B264), (A)+(B117)+(B265), (A)+(B117)+(B266), (A)+(B117)+(B267), (A)+(B117)+(B268), (A)+(B117)+(B269), (A)+(B117)+(B270), (A)+(B117)+(B271), (A)+(B117)+(B272), (A)+(B117)+(B273), (A)+(B117)+(B274), (A)+(B117)+(B275), (A)+(B117)+(B276), (A)+(B117)+(B277), (A)+(B117)+(B278), (A)+(B117)+(B279), (A)+(B117)+(B280), (A)+(B117)+(B281), (A)+(B117)+(B282), (A)+(B117)+(B283), (A)+(B117)+(B284), (A)+(B117)+(B285), (A)+(B117)+(B286), (A)+(B117)+(B287), (A)+(B117)+(B288), (A)+(B117)+(B289), (A)+(B117)+(B290), (A)+(B117)+(B291), (A)+(B117)+(B292), (A)+(B117)+(B293), (A)+(B117)+(B294), (A)+(B117)+(B295), (A)+(B117)+(B296), (A)+(B117)+(B297), (A)+(B117)+(B298), (A)+(B117)+(B299), (A)+(B117)+(B300), (A)+(B117)+(B301), (A)+(B117)+(B302), (A)+(B117)+(B303), (A)+(B117)+(B304), (A)+(B117)+(B305), (A)+(B117)+(B306), (A)+(B117)+(B307), (A)+(B117)+(B308), (A)+(B117)+(B309), (A)+(B117)+(B310), (A)+(B117)+(B311), (A)+(B117)+(B312), (A)+(B117)+(B313), (A)+(B117)+(B314), (A)+(B117)+(B315),

(A)+(B118)+(B119), (A)+(B118)+(B120), (A)+(B118)+(B121), (A)+(B118)+(B122), (A)+(B118)+(B123), (A)+(B118)+(B124), (A)+(B118)+(B125), (A)+(B118)+(B126), (A)+(B118)+(B127), (A)+(B118)+(B128), (A)+(B118)+(B129), (A)+(B118)+(B130), (A)+(B118)+(B131), (A)+(B118)+(B132), (A)+(B118)+(B133), (A)+(B118)+(B134), (A)+(B118)+(B135), (A)+(B118)+(B136), (A)+(B118)+(B137), (A)+(B118)+(B138), (A)+(B118)+(B139), (A)+(B118)+(B140), (A)+(B118)+(B141), (A)+(B118)+(B142), (A)+(B118)+(B143), (A)+(B118)+(B144), (A)+(B118)+(B145), (A)+(B118)+(B146), (A)+(B118)+(B147), (A)+(B118)+(B148), (A)+(B118)+(B149), (A)+(B118)+(B150), (A)+(B118)+(B151), (A)+(B118)+(B152), (A)+(B118)+(B153), (A)+(B118)+(B154), (A)+(B118)+(B155), (A)+(B118)+(B156), (A)+(B118)+(B157), (A)+(B118)+(B158), (A)+(B118)+(B159), (A)+(B118)+(B160), (A)+(B118)+(B161), (A)+(B118)+(B162), (A)+(B118)+(B164), (A)+(B118)+(B164), (A)+(B118)+(B165), (A)+(B118)+(B166), (A)+(B118)+(B167), (A)+(B118)+(B168), (A)+(B118)+(B169), (A)+(B118)+(B170), (A)+(B118)+(B171), (A)+(B118)+(B172), (A)+(B118)+(B173), (A)+(B118)+(B174), (A)+(B118)+(B175), (A)+(B118)+(B176), (A)+(B118)+(B177), (A)+(B118)+(B178), (A)+(B118)+(B179), (A)+(B118)+(B180), (A)+(B118)+(B181), (A)+(B118)+(B182), (A)+(B118)+(B183), (A)+(B118)+(B184), (A)+(B118)+(B185), (A)+(B118)+(B186), (A)+(B118)+(B187), (A)+(B118)+(B188), (A)+(B118)+(B189), (A)+(B118)+(B190), (A)+(B118)+(B191), (A)+(B118)+(B192), (A)+(B118)+(B193), (A)+(B118)+(B194), (A)+(B118)+(B195), (A)+(B118)+(B196), (A)+(B118)+(B197), (A)+(B118)+(B198), (A)+(B118)+(B199), (A)+(B118)+(B200), (A)+(B118)+(B201), (A)+(B118)+(B202), (A)+(B118)+(B203), (A)+(B118)+(B204), (A)+(B118)+(B205), (A)+(B118)+(B206), (A)+(B118)+(B207), (A)+(B118)+(B208), (A)+(B118)+(B209), (A)+(B118)+(B210), (A)+(B118)+(B211), (A)+(B118)+(B212), (A)+(B118)+(B213), (A)+(B118)+(B214), (A)+(B118)+(B215), (A)+(B118)+(B216), (A)+(B118)+(B217), (A)+(B118)+(B218), (A)+(B118)+(B219), (A)+(B118)+(B220), (A)+(B118)+(B221), (A)+(B118)+(B222), (A)+(B118)+(B223), (A)+(B118)+(B224), (A)+(B118)+(B225), (A)+(B118)+(B226), (A)+(B118)+(B227), (A)+(B118)+(B228), (A)+(B118)+(B229), (A)+(B118)+(B230), (A)+(B118)+(B231), (A)+(B118)+(B232), (A)+(B118)+(B233), (A)+(B118)+(B234), (A)+(B118)+(B235), (A)+(B118)+(B236), (A)+(B118)+(B237), (A)+(B118)+(B238), (A)+(B118)+(B239), (A)+(B118)+(B240), (A)+(B118)+(B241), (A)+(B118)+(B242), (A)+(B118)+(B243), (A)+(B118)+(B244), (A)+(B118)+(B245), (A)+(B118)+(B246), (A)+(B118)+(B247), (A)+(B118)+(B248), (A)+(B118)+(B249), (A)+(B118)+(B250), (A)+(B118)+(B251), (A)+(B118)+(B252), (A)+(B118)+(B253), (A)+(B118)+(B254), (A)+(B118)+(B255), (A)+(B118)+(B256), (A)+(B118)+(B257), (A)+(B118)+(B258), (A)+(B118)+(B259), (A)+(B118)+(B260), (A)+(B118)+(B261), (A)+(B118)+(B262), (A)+(B118)+(B263), (A)+(B118)+(B264), (A)+(B118)+(B265), (A)+(B118)+(B266), (A)+(B118)+(B267), (A)+(B118)+(B268), (A)+(B118)+(B269), (A)+(B118)+(B270), (A)+(B118)+(B271), (A)+(B118)+(B272), (A)+(B118)+(B273), (A)+(B118)+(B274), (A)+(B118)+(B275), (A)+(B118)+(B276), (A)+(B118)+(B277), (A)+(B118)+(B278), (A)+(B118)+(B279), (A)+(B118)+(B280), (A)+(B118)+(B281), (A)+(B118)+(B282), (A)+(B118)+(B283), (A)+(B118)+(B284), (A)+(B118)+(B285), (A)+(B118)+(B286), (A)+(B118)+(B287), (A)+(B118)+(B288), (A)+(B118)+(B289), (A)+(B118)+(B290), (A)+(B118)+(B291), (A)+(B118)+(B292), (A)+(B118)+(B293), (A)+(B118)+(B294), (A)+(B118)+(B295), (A)+(B118)+(B296), (A)+(B118)+(B297), (A)+(B118)+(B298), (A)+(B118)+(B299), (A)+(B118)+(B300), (A)+(B118)+(B301), (A)+(B118)+(B302), (A)+(B118)+(B303), (A)+(B118)+(B304), (A)+(B118)+(B305), (A)+(B118)+(B306), (A)+(B118)+(B307), (A)+(B118)+(B308), (A)+(B118)+(B309), (A)+(B118)+(B310), (A)+(B118)+(B311), (A)+(B118)+(B312), (A)+(B118)+(B313), (A)+(B118)+(B314), (A)+(B118)+(B315),

(A)+(B119)+(B120), (A)+(B119)+(B121), (A)+(B119)+(B122), (A)+(B119)+(B123), (A)+(B119)+(B124), (A)+(B119)+(B125), (A)+(B119)+(B126), (A)+(B119)+(B127), (A)+(B119)+(B128), (A)+(B119)+(B129), (A)+(B119)+(B130), (A)+(B119)+(B131), (A)+(B119)+(B132), (A)+(B119)+(B133), (A)+(B119)+(B134), (A)+(B119)+(B135), (A)+(B119)+(B136), (A)+(B119)+(B137), (A)+(B119)+(B138), (A)+(B119)+(B139), (A)+(B119)+(B140), (A)+(B119)+(B141), (A)+(B119)+(B142), (A)+(B119)+(B143), (A)+(B119)+(B144), (A)+(B119)+(B145), (A)+(B119)+(B146), (A)+(B119)+(B147), (A)+(B119)+(B148), (A)+(B119)+(B149), (A)+(B119)+(B150), (A)+(B119)+(B151), (A)+(B119)+(B152), (A)+(B119)+(B153), (A)+(B119)+(B154), (A)+(B119)+(B155), (A)+(B119)+(B156), (A)+(B119)+(B157), (A)+(B119)+(B158), (A)+(B119)+(B159), (A)+(B119)+(B160), (A)+(B119)+(B161), (A)+(B119)+(B162), (A)+(B119)+(B164), (A)+(B119)+(B164), (A)+(B119)+(B165), (A)+(B119)+(B166), (A)+(B119)+(B167), (A)+(B119)+(B168), (A)+(B119)+(B169), (A)+(B119)+(B170), (A)+(B119)+(B171), (A)+(B119)+(B172), (A)+(B119)+(B173), (A)+(B119)+(B174), (A)+(B119)+(B175), (A)+(B119)+(B176), (A)+(B119)+(B177), (A)+(B119)+(B178), (A)+(B119)+(B179), (A)+(B119)+(B180), (A)+(B119)+(B181), (A)+(B119)+(B182), (A)+(B119)+(B183), (A)+(B119)+(B184), (A)+(B119)+(B185), (A)+(B119)+(B186), (A)+(B119)+(B187), (A)+(B119)+(B188), (A)+(B119)+(B189), (A)+(B119)+(B190), (A)+(B119)+(B191), (A)+(B119)+(B192), (A)+(B119)+(B193), (A)+(B119)+(B194), (A)+(B119)+(B195), (A)+(B119)+(B196), (A)+(B119)+(B197), (A)+(B119)+(B198), (A)+(B119)+(B199), (A)+(B119)+(B200), (A)+(B119)+(B201), (A)+(B119)+(B202), (A)+(B119)+(B203), (A)+(B119)+(B204), (A)+(B119)+(B205), (A)+(B119)+(B206), (A)+(B119)+(B207), (A)+(B119)+(B208), (A)+(B119)+(B209), (A)+(B119)+(B210), (A)+(B119)+(B211), (A)+(B119)+(B212), (A)+(B119)+(B213), (A)+(B119)+(B214), (A)+(B119)+(B215), (A)+(B119)+(B216), (A)+(B119)+(B217), (A)+(B119)+(B218), (A)+(B119)+(B219), (A)+(B119)+(B220), (A)+(B119)+(B221), (A)+(B119)+(B222), (A)+(B119)+(B223), (A)+(B119)+(B224), (A)+(B119)+(B225), (A)+(B119)+(B226), (A)+(B119)+(B227), (A)+(B119)+(B228), (A)+(B119)+(B229), (A)+(B119)+(B230), (A)+(B119)+(B231), (A)+(B119)+(B232), (A)+(B119)+(B233), (A)+(B119)+(B234), (A)+(B119)+(B235), (A)+(B119)+(B236), (A)+(B119)+(B237), (A)+(B119)+(B238), (A)+(B119)+(B239), (A)+(B119)+(B240), (A)+(B119)+(B241), (A)+(B119)+(B242), (A)+(B119)+(B243), (A)+(B119)+(B244), (A)+(B119)+(B245), (A)+(B119)+(B246), (A)+(B119)+(B247), (A)+(B119)+(B248), (A)+(B119)+(B249), (A)+(B119)+(B250), (A)+(B119)+(B251), (A)+(B119)+(B252), (A)+(B119)+(B253), (A)+(B119)+(B254), (A)+(B119)+(B255), (A)+(B119)+(B256), (A)+(B119)+(B257), (A)+(B119)+(B258), (A)+(B119)+(B259), (A)+(B119)+(B260), (A)+(B119)+(B261), (A)+(B119)+(B262), (A)+(B119)+(B263), (A)+(B119)+(B264), (A)+(B119)+(B265), (A)+(B119)+(B266), (A)+(B119)+(B267), (A)+(B119)+(B268), (A)+(B119)+(B269), (A)+(B119)+(B270), (A)+(B119)+(B271), (A)+(B119)+(B272), (A)+(B119)+(B273), (A)+(B119)+(B274), (A)+(B119)+(B275), (A)+(B119)+(B276), (A)+(B119)+(B277), (A)+(B119)+(B278), (A)+(B119)+(B279), (A)+(B119)+(B280), (A)+(B119)+(B281), (A)+(B119)+(B282), (A)+(B119)+(B283), (A)+(B119)+(B284), (A)+(B119)+(B285), (A)+(B119)+(B286), (A)+(B119)+(B287), (A)+(B119)+(B288), (A)+(B119)+(B289), (A)+(B119)+(B290), (A)+(B119)+(B291), (A)+(B119)+(B292), (A)+(B119)+(B293), (A)+(B119)+(B294), (A)+(B119)+(B295), (A)+(B119)+(B296), (A)+(B119)+(B297), (A)+(B119)+(B298), (A)+(B119)+(B299), (A)+(B119)+(B300), (A)+(B119)+(B301), (A)+(B119)+(B302), (A)+(B119)+(B303), (A)+(B119)+(B304), (A)+(B119)+(B305), (A)+(B119)+(B306), (A)+(B119)+(B307), (A)+(B119)+(B308), (A)+(B119)+(B309), (A)+(B119)+(B310), (A)+(B119)+(B311), (A)+(B119)+(B312), (A)+(B119)+(B313), (A)+(B119)+(B314), (A)+(B119)+(B315),

(A)+(B120)+(B121), (A)+(B120)+(B122), (A)+(B120)+(B123), (A)+(B120)+(B124), (A)+(B120)+(B125), (A)+(B120)+(B126), (A)+(B120)+(B127), (A)+(B120)+(B128), (A)+(B120)+(B129), (A)+(B120)+(B130), (A)+(B120)+(B131), (A)+(B120)+(B132), (A)+(B120)+(B133), (A)+(B120)+(B134), (A)+(B120)+(B135), (A)+(B120)+(B136), (A)+(B120)+(B137), (A)+(B120)+(B138), (A)+(B120)+(B139), (A)+(B120)+(B140), (A)+(B120)+(B141), (A)+(B120)+(B142), (A)+(B120)+(B143), (A)+(B120)+(B144), (A)+(B120)+(B145), (A)+(B120)+(B146), (A)+(B120)+(B147), (A)+(B120)+(B148), (A)+(B120)+(B149), (A)+(B120)+(B150), (A)+(B120)+(B151), (A)+(B120)+(B152), (A)+(B120)+(B153), (A)+(B120)+(B154), (A)+(B120)+(B155), (A)+(B120)+(B156), (A)+(B120)+(B157), (A)+(B120)+(B158), (A)+(B120)+(B159), (A)+(B120)+(B160), (A)+(B120)+(B161), (A)+(B120)+(B162), (A)+(B120)+(B164), (A)+(B120)+(B164), (A)+(B120)+(B165), (A)+(B120)+(B166), (A)+(B120)+(B167), (A)+(B120)+(B168), (A)+(B120)+(B169), (A)+(B120)+(B170), (A)+(B120)+(B171), (A)+(B120)+(B172), (A)+(B120)+(B173), (A)+(B120)+(B174), (A)+(B120)+(B175), (A)+(B120)+(B176), (A)+(B120)+(B177), (A)+(B120)+(B178), (A)+(B120)+(B179), (A)+(B120)+(B180), (A)+(B120)+(B181), (A)+(B120)+(B182), (A)+(B120)+(B183), (A)+(B120)+(B184), (A)+(B120)+(B185), (A)+(B120)+(B186), (A)+(B120)+(B187), (A)+(B120)+(B188), (A)+(B120)+(B189), (A)+(B120)+(B190), (A)+(B120)+(B191), (A)+(B120)+(B192), (A)+(B120)+(B193), (A)+(B120)+(B194), (A)+(B120)+(B195), (A)+(B120)+(B196), (A)+(B120)+(B197), (A)+(B120)+(B198), (A)+(B120)+(B199), (A)+(B120)+(B200), (A)+(B120)+(B201), (A)+(B120)+(B202), (A)+(B120)+(B203), (A)+(B120)+(B204), (A)+(B120)+(B205), (A)+(B120)+(B206), (A)+(B120)+(B207), (A)+(B120)+(B208), (A)+(B120)+(B209), (A)+(B120)+(B210), (A)+(B120)+(B211), (A)+(B120)+(B212), (A)+(B120)+(B213), (A)+(B120)+(B214), (A)+(B120)+(B215), (A)+(B120)+(B216), (A)+(B120)+(B217), (A)+(B120)+(B218), (A)+(B120)+(B219), (A)+(B120)+(B220), (A)+(B120)+(B221), (A)+(B120)+(B222), (A)+(B120)+(B223), (A)+(B120)+(B224), (A)+(B120)+(B225), (A)+(B120)+(B226), (A)+(B120)+(B227), (A)+(B120)+(B228), (A)+(B120)+(B229), (A)+(B120)+(B230), (A)+(B120)+(B231), (A)+(B120)+(B232), (A)+(B120)+(B233), (A)+(B120)+(B234), (A)+(B120)+(B235), (A)+(B120)+(B236), (A)+(B120)+(B237), (A)+(B120)+(B238), (A)+(B120)+(B239), (A)+(B120)+(B240), (A)+(B120)+(B241), (A)+(B120)+(B242), (A)+(B120)+(B243), (A)+(B120)+(B244), (A)+(B120)+(B245), (A)+(B120)+(B246), (A)+(B120)+(B247), (A)+(B120)+(B248), (A)+(B120)+(B249), (A)+(B120)+(B250), (A)+(B120)+(B251), (A)+(B120)+(B252), (A)+(B120)+(B253), (A)+(B120)+(B254), (A)+(B120)+(B255), (A)+(B120)+(B256), (A)+(B120)+(B257), (A)+(B120)+(B258), (A)+(B120)+(B259), (A)+(B120)+(B260), (A)+(B120)+(B261), (A)+(B120)+(B262), (A)+(B120)+(B263), (A)+(B120)+(B264), (A)+(B120)+(B265), (A)+(B120)+(B266), (A)+(B120)+(B267), (A)+(B120)+(B268), (A)+(B120)+(B269), (A)+(B120)+(B270), (A)+(B120)+(B271), (A)+(B120)+(B272), (A)+(B120)+(B273), (A)+(B120)+(B274), (A)+(B120)+(B275), (A)+(B120)+(B276), (A)+(B120)+(B277), (A)+(B120)+(B278), (A)+(B120)+(B279), (A)+(B120)+(B280), (A)+(B120)+(B281), (A)+(B120)+(B282), (A)+(B120)+(B283), (A)+(B120)+(B284), (A)+(B120)+(B285), (A)+(B120)+(B286), (A)+(B120)+(B287), (A)+(B120)+(B288), (A)+(B120)+(B289), (A)+(B120)+(B290), (A)+(B120)+(B291), (A)+(B120)+(B292), (A)+(B120)+(B293), (A)+(B120)+(B294), (A)+(B120)+(B295), (A)+(B120)+(B296), (A)+(B120)+(B297), (A)+(B120)+(B298), (A)+(B120)+(B299), (A)+(B120)+(B300), (A)+(B120)+(B301), (A)+(B120)+(B302), (A)+(B120)+(B303), (A)+(B120)+(B304), (A)+(B120)+(B305), (A)+(B120)+(B306), (A)+(B120)+(B307), (A)+(B120)+(B308), (A)+(B120)+(B309), (A)+(B120)+(B310), (A)+(B120)+(B311), (A)+(B120)+(B312), (A)+(B120)+(B313), (A)+(B120)+(B314), (A)+(B120)+(B315),

(A)+(B121)+(B122), (A)+(B121)+(B123), (A)+(B121)+(B124), (A)+(B121)+(B125), (A)+(B121)+(B126), (A)+(B121)+(B127), (A)+(B121)+(B128), (A)+(B121)+(B129), (A)+(B121)+(B130), (A)+(B121)+(B131), (A)+(B121)+(B132), (A)+(B121)+(B133), (A)+(B121)+(B134), (A)+(B121)+(B135), (A)+(B121)+(B136), (A)+(B121)+(B137), (A)+(B121)+(B138), (A)+(B121)+(B139), (A)+(B121)+(B140), (A)+(B121)+(B141), (A)+(B121)+(B142), (A)+(B121)+(B143), (A)+(B121)+(B144), (A)+(B121)+(B145), (A)+(B121)+(B146), (A)+(B121)+(B147), (A)+(B121)+(B148), (A)+(B121)+(B149), (A)+(B121)+(B150), (A)+(B121)+(B151), (A)+(B121)+(B152), (A)+(B121)+(B153), (A)+(B121)+(B154), (A)+(B121)+(B155), (A)+(B121)+(B156), (A)+(B121)+(B157), (A)+(B121)+(B158), (A)+(B121)+(B159), (A)+(B121)+(B160), (A)+(B121)+(B161), (A)+(B121)+(B162), (A)+(B121)+(B164), (A)+(B121)+(B164), (A)+(B121)+(B165), (A)+(B121)+(B166), (A)+(B121)+(B167), (A)+(B121)+(B168), (A)+(B121)+(B169), (A)+(B121)+(B170), (A)+(B121)+(B171), (A)+(B121)+(B172), (A)+(B121)+(B173), (A)+(B121)+(B174), (A)+(B121)+(B175), (A)+(B121)+(B176), (A)+(B121)+(B177), (A)+(B121)+(B178), (A)+(B121)+(B179), (A)+(B121)+(B180), (A)+(B121)+(B181), (A)+(B121)+(B182), (A)+(B121)+(B183), (A)+(B121)+(B184), (A)+(B121)+(B185), (A)+(B121)+(B186), (A)+(B121)+(B187), (A)+(B121)+(B188), (A)+(B121)+(B189), (A)+(B121)+(B190), (A)+(B121)+(B191), (A)+(B121)+(B192), (A)+(B121)+(B193), (A)+(B121)+(B194), (A)+(B121)+(B195), (A)+(B121)+(B196), (A)+(B121)+(B197), (A)+(B121)+(B198), (A)+(B121)+(B199), (A)+(B121)+(B200), (A)+(B121)+(B201), (A)+(B121)+(B202), (A)+(B121)+(B203), (A)+(B121)+(B204), (A)+(B121)+(B205), (A)+(B121)+(B206), (A)+(B121)+(B207), (A)+(B121)+(B208), (A)+(B121)+(B209), (A)+(B121)+(B210), (A)+(B121)+(B211), (A)+(B121)+(B212), (A)+(B121)+(B213), (A)+(B121)+(B214), (A)+(B121)+(B215), (A)+(B121)+(B216), (A)+(B121)+(B217), (A)+(B121)+(B218), (A)+(B121)+(B219), (A)+(B121)+(B220), (A)+(B121)+(B221), (A)+(B121)+(B222), (A)+(B121)+(B223), (A)+(B121)+(B224), (A)+(B121)+(B225), (A)+(B121)+(B226), (A)+(B121)+(B227), (A)+(B121)+(B228), (A)+(B121)+(B229), (A)+(B121)+(B230), (A)+(B121)+(B231), (A)+(B121)+(B232), (A)+(B121)+(B233), (A)+(B121)+(B234), (A)+(B121)+(B235), (A)+(B121)+(B236), (A)+(B121)+(B237), (A)+(B121)+(B238), (A)+(B121)+(B239), (A)+(B121)+(B240), (A)+(B121)+(B241), (A)+(B121)+(B242), (A)+(B121)+(B243), (A)+(B121)+(B244), (A)+(B121)+(B245), (A)+(B121)+(B246), (A)+(B121)+(B247), (A)+(B121)+(B248), (A)+(B121)+(B249), (A)+(B121)+(B250), (A)+(B121)+(B251), (A)+(B121)+(B252), (A)+(B121)+(B253), (A)+(B121)+(B254), (A)+(B121)+(B255), (A)+(B121)+(B256), (A)+(B121)+(B257), (A)+(B121)+(B258), (A)+(B121)+(B259), (A)+(B121)+(B260), (A)+(B121)+(B261), (A)+(B121)+(B262), (A)+(B121)+(B263), (A)+(B121)+(B264), (A)+(B121)+(B265), (A)+(B121)+(B266), (A)+(B121)+(B267), (A)+(B121)+(B268), (A)+(B121)+(B269), (A)+(B121)+(B270), (A)+(B121)+(B271), (A)+(B121)+(B272), (A)+(B121)+(B273), (A)+(B121)+(B274), (A)+(B121)+(B275), (A)+(B121)+(B276), (A)+(B121)+(B277), (A)+(B121)+(B278), (A)+(B121)+(B279), (A)+(B121)+(B280), (A)+(B121)+(B281), (A)+(B121)+(B282), (A)+(B121)+(B283), (A)+(B121)+(B284), (A)+(B121)+(B285), (A)+(B121)+(B286), (A)+(B121)+(B287), (A)+(B121)+(B288), (A)+(B121)+(B289), (A)+(B121)+(B290), (A)+(B121)+(B291), (A)+(B121)+(B292), (A)+(B121)+(B293), (A)+(B121)+(B294), (A)+(B121)+(B295), (A)+(B121)+(B296), (A)+(B121)+(B297), (A)+(B121)+(B298), (A)+(B121)+(B299), (A)+(B121)+(B300), (A)+(B121)+(B301), (A)+(B121)+(B302), (A)+(B121)+(B303), (A)+(B121)+(B304), (A)+(B121)+(B305), (A)+(B121)+(B306), (A)+(B121)+(B307), (A)+(B121)+(B308), (A)+(B121)+(B309), (A)+(B121)+(B310), (A)+(B121)+(B311), (A)+(B121)+(B312), (A)+(B121)+(B313), (A)+(B121)+(B314), (A)+(B121)+(B315),

(A)+(B122)+(B123), (A)+(B122)+(B124), (A)+(B122)+(B125), (A)+(B122)+(B126), (A)+(B122)+(B127), (A)+(B122)+(B128), (A)+(B122)+(B129), (A)+(B122)+(B130), (A)+(B122)+(B131), (A)+(B122)+(B132), (A)+(B122)+(B133), (A)+(B122)+(B134), (A)+(B122)+(B135), (A)+(B122)+(B136), (A)+(B122)+(B137), (A)+(B122)+(B138), (A)+(B122)+(B139), (A)+(B122)+(B140), (A)+(B122)+(B141), (A)+(B122)+(B142), (A)+(B122)+(B143), (A)+(B122)+(B144), (A)+(B122)+(B145), (A)+(B122)+(B146), (A)+(B122)+(B147), (A)+(B122)+(B148), (A)+(B122)+(B149), (A)+(B122)+(B150), (A)+(B122)+(B151), (A)+(B122)+(B152), (A)+(B122)+(B153), (A)+(B122)+(B154), (A)+(B122)+(B155), (A)+(B122)+(B156), (A)+(B122)+(B157), (A)+(B122)+(B158), (A)+(B122)+(B159), (A)+(B122)+(B160), (A)+(B122)+(B161), (A)+(B122)+(B162), (A)+(B122)+(B164), (A)+(B122)+(B164), (A)+(B122)+(B165), (A)+(B122)+(B166), (A)+(B122)+(B167), (A)+(B122)+(B168), (A)+(B122)+(B169), (A)+(B122)+(B170), (A)+(B122)+(B171), (A)+(B122)+(B172), (A)+(B122)+(B173), (A)+(B122)+(B174), (A)+(B122)+(B175), (A)+(B122)+(B176), (A)+(B122)+(B177), (A)+(B122)+(B178), (A)+(B122)+(B179), (A)+(B122)+(B180), (A)+(B122)+(B181), (A)+(B122)+(B182), (A)+(B122)+(B183), (A)+(B122)+(B184), (A)+(B122)+(B185), (A)+(B122)+(B186), (A)+(B122)+(B187), (A)+(B122)+(B188), (A)+(B122)+(B189), (A)+(B122)+(B190), (A)+(B122)+(B191), (A)+(B122)+(B192), (A)+(B122)+(B193), (A)+(B122)+(B194), (A)+(B122)+(B195), (A)+(B122)+(B196), (A)+(B122)+(B197), (A)+(B122)+(B198), (A)+(B122)+(B199), (A)+(B122)+(B200), (A)+(B122)+(B201), (A)+(B122)+(B202), (A)+(B122)+(B203), (A)+(B122)+(B204), (A)+(B122)+(B205), (A)+(B122)+(B206), (A)+(B122)+(B207), (A)+(B122)+(B208), (A)+(B122)+(B209), (A)+(B122)+(B210), (A)+(B122)+(B211), (A)+(B122)+(B212), (A)+(B122)+(B213), (A)+(B122)+(B214), (A)+(B122)+(B215), (A)+(B122)+(B216), (A)+(B122)+(B217), (A)+(B122)+(B218), (A)+(B122)+(B219), (A)+(B122)+(B220), (A)+(B122)+(B221), (A)+(B122)+(B222), (A)+(B122)+(B223), (A)+(B122)+(B224), (A)+(B122)+(B225), (A)+(B122)+(B226), (A)+(B122)+(B227), (A)+(B122)+(B228), (A)+(B122)+(B229), (A)+(B122)+(B230), (A)+(B122)+(B231), (A)+(B122)+(B232), (A)+(B122)+(B233), (A)+(B122)+(B234), (A)+(B122)+(B235), (A)+(B122)+(B236), (A)+(B122)+(B237), (A)+(B122)+(B238), (A)+(B122)+(B239), (A)+(B122)+(B240), (A)+(B122)+(B241), (A)+(B122)+(B242), (A)+(B122)+(B243), (A)+(B122)+(B244), (A)+(B122)+(B245), (A)+(B122)+(B246), (A)+(B122)+(B247), (A)+(B122)+(B248), (A)+(B122)+(B249), (A)+(B122)+(B250), (A)+(B122)+(B251), (A)+(B122)+(B252), (A)+(B122)+(B253), (A)+(B122)+(B254), (A)+(B122)+(B255), (A)+(B122)+(B256), (A)+(B122)+(B257), (A)+(B122)+(B258), (A)+(B122)+(B259), (A)+(B122)+(B260), (A)+(B122)+(B261), (A)+(B122)+(B262), (A)+(B122)+(B263), (A)+(B122)+(B264), (A)+(B122)+(B265), (A)+(B122)+(B266), (A)+(B122)+(B267), (A)+(B122)+(B268), (A)+(B122)+(B269), (A)+(B122)+(B270), (A)+(B122)+(B271), (A)+(B122)+(B272), (A)+(B122)+(B273), (A)+(B122)+(B274), (A)+(B122)+(B275), (A)+(B122)+(B276), (A)+(B122)+(B277), (A)+(B122)+(B278), (A)+(B122)+(B279), (A)+(B122)+(B280), (A)+(B122)+(B281), (A)+(B122)+(B282), (A)+(B122)+(B283), (A)+(B122)+(B284), (A)+(B122)+(B285), (A)+(B122)+(B286), (A)+(B122)+(B287), (A)+(B122)+(B288), (A)+(B122)+(B289), (A)+(B122)+(B290), (A)+(B122)+(B291), (A)+(B122)+(B292), (A)+(B122)+(B293), (A)+(B122)+(B294), (A)+(B122)+(B295), (A)+(B122)+(B296), (A)+(B122)+(B297), (A)+(B122)+(B298), (A)+(B122)+(B299), (A)+(B122)+(B300), (A)+(B122)+(B301), (A)+(B122)+(B302), (A)+(B122)+(B303), (A)+(B122)+(B304), (A)+(B122)+(B305), (A)+(B122)+(B306), (A)+(B122)+(B307), (A)+(B122)+(B308), (A)+(B122)+(B309), (A)+(B122)+(B310), (A)+(B122)+(B311), (A)+(B122)+(B312), (A)+(B122)+(B313), (A)+(B122)+(B314), (A)+(B122)+(B315),

(A)+(B123)+(B124), (A)+(B123)+(B125), (A)+(B123)+(B126), (A)+(B123)+(B127), (A)+(B123)+(B128), (A)+(B123)+(B129), (A)+(B123)+(B130), (A)+(B123)+(B131), (A)+(B123)+(B132), (A)+(B123)+(B133), (A)+(B123)+(B134), (A)+(B123)+(B135), (A)+(B123)+(B136), (A)+(B123)+(B137), (A)+(B123)+(B138), (A)+(B123)+(B139), (A)+(B123)+(B140), (A)+(B123)+(B141), (A)+(B123)+(B142), (A)+(B123)+(B143), (A)+(B123)+(B144), (A)+(B123)+(B145), (A)+(B123)+(B146), (A)+(B123)+(B147), (A)+(B123)+(B148), (A)+(B123)+(B149), (A)+(B123)+(B150), (A)+(B123)+(B151), (A)+(B123)+(B152), (A)+(B123)+(B153), (A)+(B123)+(B154), (A)+(B123)+(B155), (A)+(B123)+(B156), (A)+(B123)+(B157), (A)+(B123)+(B158), (A)+(B123)+(B159), (A)+(B123)+(B160), (A)+(B123)+(B161), (A)+(B123)+(B162), (A)+(B123)+(B164), (A)+(B123)+(B164), (A)+(B123)+(B165), (A)+(B123)+(B166), (A)+(B123)+(B167), (A)+(B123)+(B168), (A)+(B123)+(B169), (A)+(B123)+(B170), (A)+(B123)+(B171), (A)+(B123)+(B172), (A)+(B123)+(B173), (A)+(B123)+(B174), (A)+(B123)+(B175), (A)+(B123)+(B176), (A)+(B123)+(B177), (A)+(B123)+(B178), (A)+(B123)+(B179), (A)+(B123)+(B180), (A)+(B123)+(B181), (A)+(B123)+(B182), (A)+(B123)+(B183), (A)+(B123)+(B184), (A)+(B123)+(B185), (A)+(B123)+(B186), (A)+(B123)+(B187), (A)+(B123)+(B188), (A)+(B123)+(B189), (A)+(B123)+(B190), (A)+(B123)+(B191), (A)+(B123)+(B192), (A)+(B123)+(B193), (A)+(B123)+(B194), (A)+(B123)+(B195), (A)+(B123)+(B196), (A)+(B123)+(B197), (A)+(B123)+(B198), (A)+(B123)+(B199), (A)+(B123)+(B200), (A)+(B123)+(B201), (A)+(B123)+(B202), (A)+(B123)+(B203), (A)+(B123)+(B204), (A)+(B123)+(B205), (A)+(B123)+(B206), (A)+(B123)+(B207), (A)+(B123)+(B208), (A)+(B123)+(B209), (A)+(B123)+(B210), (A)+(B123)+(B211), (A)+(B123)+(B212), (A)+(B123)+(B213), (A)+(B123)+(B214), (A)+(B123)+(B215), (A)+(B123)+(B216), (A)+(B123)+(B217), (A)+(B123)+(B218), (A)+(B123)+(B219), (A)+(B123)+(B220), (A)+(B123)+(B221), (A)+(B123)+(B222), (A)+(B123)+(B223), (A)+(B123)+(B224), (A)+(B123)+(B225), (A)+(B123)+(B226), (A)+(B123)+(B227), (A)+(B123)+(B228), (A)+(B123)+(B229), (A)+(B123)+(B230), (A)+(B123)+(B231), (A)+(B123)+(B232), (A)+(B123)+(B233), (A)+(B123)+(B234), (A)+(B123)+(B235), (A)+(B123)+(B236), (A)+(B123)+(B237), (A)+(B123)+(B238), (A)+(B123)+(B239), (A)+(B123)+(B240), (A)+(B123)+(B241), (A)+(B123)+(B242), (A)+(B123)+(B243), (A)+(B123)+(B244), (A)+(B123)+(B245), (A)+(B123)+(B246), (A)+(B123)+(B247), (A)+(B123)+(B248), (A)+(B123)+(B249), (A)+(B123)+(B250), (A)+(B123)+(B251), (A)+(B123)+(B252), (A)+(B123)+(B253), (A)+(B123)+(B254), (A)+(B123)+(B255), (A)+(B123)+(B256), (A)+(B123)+(B257), (A)+(B123)+(B258), (A)+(B123)+(B259), (A)+(B123)+(B260), (A)+(B123)+(B261), (A)+(B123)+(B262), (A)+(B123)+(B263), (A)+(B123)+(B264), (A)+(B123)+(B265), (A)+(B123)+(B266), (A)+(B123)+(B267), (A)+(B123)+(B268), (A)+(B123)+(B269), (A)+(B123)+(B270), (A)+(B123)+(B271), (A)+(B123)+(B272), (A)+(B123)+(B273), (A)+(B123)+(B274), (A)+(B123)+(B275), (A)+(B123)+(B276), (A)+(B123)+(B277), (A)+(B123)+(B278), (A)+(B123)+(B279), (A)+(B123)+(B280), (A)+(B123)+(B281), (A)+(B123)+(B282), (A)+(B123)+(B283), (A)+(B123)+(B284), (A)+(B123)+(B285), (A)+(B123)+(B286), (A)+(B123)+(B287), (A)+(B123)+(B288), (A)+(B123)+(B289), (A)+(B123)+(B290), (A)+(B123)+(B291), (A)+(B123)+(B292), (A)+(B123)+(B293), (A)+(B123)+(B294), (A)+(B123)+(B295), (A)+(B123)+(B296), (A)+(B123)+(B297), (A)+(B123)+(B298), (A)+(B123)+(B299), (A)+(B123)+(B300), (A)+(B123)+(B301), (A)+(B123)+(B302), (A)+(B123)+(B303), (A)+(B123)+(B304), (A)+(B123)+(B305), (A)+(B123)+(B306), (A)+(B123)+(B307), (A)+(B123)+(B308), (A)+(B123)+(B309), (A)+(B123)+(B310), (A)+(B123)+(B311), (A)+(B123)+(B312), (A)+(B123)+(B313), (A)+(B123)+(B314), (A)+(B123)+(B315),

(A)+(B124)+(B125), (A)+(B124)+(B126), (A)+(B124)+(B127), (A)+(B124)+(B128), (A)+(B124)+(B129), (A)+(B124)+(B130), (A)+(B124)+(B131), (A)+(B124)+(B132), (A)+(B124)+(B133), (A)+(B124)+(B134), (A)+(B124)+(B135), (A)+(B124)+(B136), (A)+(B124)+(B137), (A)+(B124)+(B138), (A)+(B124)+(B139), (A)+(B124)+(B140), (A)+(B124)+(B141), (A)+(B124)+(B142), (A)+(B124)+(B143), (A)+(B124)+(B144), (A)+(B124)+(B145), (A)+(B124)+(B146), (A)+(B124)+(B147), (A)+(B124)+(B148), (A)+(B124)+(B149), (A)+(B124)+(B150), (A)+(B124)+(B151), (A)+(B124)+(B152), (A)+(B124)+(B153), (A)+(B124)+(B154), (A)+(B124)+(B155), (A)+(B124)+(B156), (A)+(B124)+(B157), (A)+(B124)+(B158), (A)+(B124)+(B159), (A)+(B124)+(B160), (A)+(B124)+(B161), (A)+(B124)+(B162), (A)+(B124)+(B164), (A)+(B124)+(B164), (A)+(B124)+(B165), (A)+(B124)+(B166), (A)+(B124)+(B167), (A)+(B124)+(B168), (A)+(B124)+(B169), (A)+(B124)+(B170), (A)+(B124)+(B171), (A)+(B124)+(B172), (A)+(B124)+(B173), (A)+(B124)+(B174), (A)+(B124)+(B175), (A)+(B124)+(B176), (A)+(B124)+(B177), (A)+(B124)+(B178), (A)+(B124)+(B179), (A)+(B124)+(B180), (A)+(B124)+(B181), (A)+(B124)+(B182), (A)+(B124)+(B183), (A)+(B124)+(B184), (A)+(B124)+(B185), (A)+(B124)+(B186), (A)+(B124)+(B187), (A)+(B124)+(B188), (A)+(B124)+(B189), (A)+(B124)+(B190), (A)+(B124)+(B191), (A)+(B124)+(B192), (A)+(B124)+(B193), (A)+(B124)+(B194), (A)+(B124)+(B195), (A)+(B124)+(B196), (A)+(B124)+(B197), (A)+(B124)+(B198), (A)+(B124)+(B199), (A)+(B124)+(B200), (A)+(B124)+(B201), (A)+(B124)+(B202), (A)+(B124)+(B203), (A)+(B124)+(B204), (A)+(B124)+(B205), (A)+(B124)+(B206), (A)+(B124)+(B207), (A)+(B124)+(B208), (A)+(B124)+(B209), (A)+(B124)+(B210), (A)+(B124)+(B211), (A)+(B124)+(B212), (A)+(B124)+(B213), (A)+(B124)+(B214), (A)+(B124)+(B215), (A)+(B124)+(B216), (A)+(B124)+(B217), (A)+(B124)+(B218), (A)+(B124)+(B219), (A)+(B124)+(B220), (A)+(B124)+(B221), (A)+(B124)+(B222), (A)+(B124)+(B223), (A)+(B124)+(B224), (A)+(B124)+(B225), (A)+(B124)+(B226), (A)+(B124)+(B227), (A)+(B124)+(B228), (A)+(B124)+(B229), (A)+(B124)+(B230), (A)+(B124)+(B231), (A)+(B124)+(B232), (A)+(B124)+(B233), (A)+(B124)+(B234), (A)+(B124)+(B235), (A)+(B124)+(B236), (A)+(B124)+(B237), (A)+(B124)+(B238), (A)+(B124)+(B239), (A)+(B124)+(B240), (A)+(B124)+(B241), (A)+(B124)+(B242), (A)+(B124)+(B243), (A)+(B124)+(B244), (A)+(B124)+(B245), (A)+(B124)+(B246), (A)+(B124)+(B247), (A)+(B124)+(B248), (A)+(B124)+(B249), (A)+(B124)+(B250), (A)+(B124)+(B251), (A)+(B124)+(B252), (A)+(B124)+(B253), (A)+(B124)+(B254), (A)+(B124)+(B255), (A)+(B124)+(B256), (A)+(B124)+(B257), (A)+(B124)+(B258), (A)+(B124)+(B259), (A)+(B124)+(B260), (A)+(B124)+(B261), (A)+(B124)+(B262), (A)+(B124)+(B263), (A)+(B124)+(B264), (A)+(B124)+(B265), (A)+(B124)+(B266), (A)+(B124)+(B267), (A)+(B124)+(B268), (A)+(B124)+(B269), (A)+(B124)+(B270), (A)+(B124)+(B271), (A)+(B124)+(B272), (A)+(B124)+(B273), (A)+(B124)+(B274), (A)+(B124)+(B275), (A)+(B124)+(B276), (A)+(B124)+(B277), (A)+(B124)+(B278), (A)+(B124)+(B279), (A)+(B124)+(B280), (A)+(B124)+(B281), (A)+(B124)+(B282), (A)+(B124)+(B283), (A)+(B124)+(B284), (A)+(B124)+(B285), (A)+(B124)+(B286), (A)+(B124)+(B287), (A)+(B124)+(B288), (A)+(B124)+(B289), (A)+(B124)+(B290), (A)+(B124)+(B291), (A)+(B124)+(B292), (A)+(B124)+(B293), (A)+(B124)+(B294), (A)+(B124)+(B295), (A)+(B124)+(B296), (A)+(B124)+(B297), (A)+(B124)+(B298), (A)+(B124)+(B299), (A)+(B124)+(B300), (A)+(B124)+(B301), (A)+(B124)+(B302), (A)+(B124)+(B303), (A)+(B124)+(B304), (A)+(B124)+(B305), (A)+(B124)+(B306), (A)+(B124)+(B307), (A)+(B124)+(B308), (A)+(B124)+(B309), (A)+(B124)+(B310), (A)+(B124)+(B311), (A)+(B124)+(B312), (A)+(B124)+(B313), (A)+(B124)+(B314), (A)+(B124)+(B315),

(A)+(B125)+(B126), (A)+(B125)+(B127), (A)+(B125)+(B128), (A)+(B125)+(B129), (A)+(B125)+(B130), (A)+(B125)+(B131), (A)+(B125)+(B132), (A)+(B125)+(B133), (A)+(B125)+(B134), (A)+(B125)+(B135), (A)+(B125)+(B136), (A)+(B125)+(B137), (A)+(B125)+(B138), (A)+(B125)+(B139), (A)+(B125)+(B140), (A)+(B125)+(B141), (A)+(B125)+(B142), (A)+(B125)+(B143), (A)+(B125)+(B144), (A)+(B125)+(B145), (A)+(B125)+(B146), (A)+(B125)+(B147), (A)+(B125)+(B148), (A)+(B125)+(B149), (A)+(B125)+(B150), (A)+(B125)+(B151), (A)+(B125)+(B152), (A)+(B125)+(B153), (A)+(B125)+(B154), (A)+(B125)+(B155), (A)+(B125)+(B156), (A)+(B125)+(B157), (A)+(B125)+(B158), (A)+(B125)+(B159), (A)+(B125)+(B160), (A)+(B125)+(B161), (A)+(B125)+(B162), (A)+(B125)+(B164), (A)+(B125)+(B164), (A)+(B125)+(B165), (A)+(B125)+(B166), (A)+(B125)+(B167), (A)+(B125)+(B168), (A)+(B125)+(B169), (A)+(B125)+(B170), (A)+(B125)+(B171), (A)+(B125)+(B172), (A)+(B125)+(B173), (A)+(B125)+(B174), (A)+(B125)+(B175), (A)+(B125)+(B176), (A)+(B125)+(B177), (A)+(B125)+(B178), (A)+(B125)+(B179), (A)+(B125)+(B180), (A)+(B125)+(B181), (A)+(B125)+(B182), (A)+(B125)+(B183), (A)+(B125)+(B184), (A)+(B125)+(B185), (A)+(B125)+(B186), (A)+(B125)+(B187), (A)+(B125)+(B188), (A)+(B125)+(B189), (A)+(B125)+(B190), (A)+(B125)+(B191), (A)+(B125)+(B192), (A)+(B125)+(B193), (A)+(B125)+(B194), (A)+(B125)+(B195), (A)+(B125)+(B196), (A)+(B125)+(B197), (A)+(B125)+(B198), (A)+(B125)+(B199), (A)+(B125)+(B200), (A)+(B125)+(B201), (A)+(B125)+(B202), (A)+(B125)+(B203), (A)+(B125)+(B204), (A)+(B125)+(B205), (A)+(B125)+(B206), (A)+(B125)+(B207), (A)+(B125)+(B208), (A)+(B125)+(B209), (A)+(B125)+(B210), (A)+(B125)+(B211), (A)+(B125)+(B212), (A)+(B125)+(B213), (A)+(B125)+(B214), (A)+(B125)+(B215), (A)+(B125)+(B216), (A)+(B125)+(B217), (A)+(B125)+(B218), (A)+(B125)+(B219), (A)+(B125)+(B220), (A)+(B125)+(B221), (A)+(B125)+(B222), (A)+(B125)+(B223), (A)+(B125)+(B224), (A)+(B125)+(B225), (A)+(B125)+(B226), (A)+(B125)+(B227), (A)+(B125)+(B228), (A)+(B125)+(B229), (A)+(B125)+(B230), (A)+(B125)+(B231), (A)+(B125)+(B232), (A)+(B125)+(B233), (A)+(B125)+(B234), (A)+(B125)+(B235), (A)+(B125)+(B236), (A)+(B125)+(B237), (A)+(B125)+(B238), (A)+(B125)+(B239), (A)+(B125)+(B240), (A)+(B125)+(B241), (A)+(B125)+(B242), (A)+(B125)+(B243), (A)+(B125)+(B244), (A)+(B125)+(B245), (A)+(B125)+(B246), (A)+(B125)+(B247), (A)+(B125)+(B248), (A)+(B125)+(B249), (A)+(B125)+(B250), (A)+(B125)+(B251), (A)+(B125)+(B252), (A)+(B125)+(B253), (A)+(B125)+(B254), (A)+(B125)+(B255), (A)+(B125)+(B256), (A)+(B125)+(B257), (A)+(B125)+(B258), (A)+(B125)+(B259), (A)+(B125)+(B260), (A)+(B125)+(B261), (A)+(B125)+(B262), (A)+(B125)+(B263), (A)+(B125)+(B264), (A)+(B125)+(B265), (A)+(B125)+(B266), (A)+(B125)+(B267), (A)+(B125)+(B268), (A)+(B125)+(B269), (A)+(B125)+(B270), (A)+(B125)+(B271), (A)+(B125)+(B272), (A)+(B125)+(B273), (A)+(B125)+(B274), (A)+(B125)+(B275), (A)+(B125)+(B276), (A)+(B125)+(B277), (A)+(B125)+(B278), (A)+(B125)+(B279), (A)+(B125)+(B280), (A)+(B125)+(B281), (A)+(B125)+(B282), (A)+(B125)+(B283), (A)+(B125)+(B284), (A)+(B125)+(B285), (A)+(B125)+(B286), (A)+(B125)+(B287), (A)+(B125)+(B288), (A)+(B125)+(B289), (A)+(B125)+(B290), (A)+(B125)+(B291), (A)+(B125)+(B292), (A)+(B125)+(B293), (A)+(B125)+(B294), (A)+(B125)+(B295), (A)+(B125)+(B296), (A)+(B125)+(B297), (A)+(B125)+(B298), (A)+(B125)+(B299), (A)+(B125)+(B300), (A)+(B125)+(B301), (A)+(B125)+(B302), (A)+(B125)+(B303), (A)+(B125)+(B304), (A)+(B125)+(B305), (A)+(B125)+(B306), (A)+(B125)+(B307), (A)+(B125)+(B308), (A)+(B125)+(B309), (A)+(B125)+(B310), (A)+(B125)+(B311), (A)+(B125)+(B312), (A)+(B125)+(B313), (A)+(B125)+(B314), (A)+(B125)+(B315),

(A)+(B126)+(B127), (A)+(B126)+(B128), (A)+(B126)+(B129), (A)+(B126)+(B130), (A)+(B126)+(B131), (A)+(B126)+(B132), (A)+(B126)+(B133), (A)+(B126)+(B134), (A)+(B126)+(B135), (A)+(B126)+(B136), (A)+(B126)+(B137), (A)+(B126)+(B138), (A)+(B126)+(B139), (A)+(B126)+(B140), (A)+(B126)+(B141), (A)+(B126)+(B142), (A)+(B126)+(B143), (A)+(B126)+(B144), (A)+(B126)+(B145), (A)+(B126)+(B146), (A)+(B126)+(B147), (A)+(B126)+(B148), (A)+(B126)+(B149), (A)+(B126)+(B150), (A)+(B126)+(B151), (A)+(B126)+(B152), (A)+(B126)+(B153), (A)+(B126)+(B154), (A)+(B126)+(B155), (A)+(B126)+(B156), (A)+(B126)+(B157), (A)+(B126)+(B158), (A)+(B126)+(B159), (A)+(B126)+(B160), (A)+(B126)+(B161), (A)+(B126)+(B162), (A)+(B126)+(B164), (A)+(B126)+(B164), (A)+(B126)+(B165), (A)+(B126)+(B166), (A)+(B126)+(B167), (A)+(B126)+(B168), (A)+(B126)+(B169), (A)+(B126)+(B170), (A)+(B126)+(B171), (A)+(B126)+(B172), (A)+(B126)+(B173), (A)+(B126)+(B174), (A)+(B126)+(B175), (A)+(B126)+(B176), (A)+(B126)+(B177), (A)+(B126)+(B178), (A)+(B126)+(B179), (A)+(B126)+(B180), (A)+(B126)+(B181), (A)+(B126)+(B182), (A)+(B126)+(B183), (A)+(B126)+(B184), (A)+(B126)+(B185), (A)+(B126)+(B186), (A)+(B126)+(B187), (A)+(B126)+(B188), (A)+(B126)+(B189), (A)+(B126)+(B190), (A)+(B126)+(B191), (A)+(B126)+(B192), (A)+(B126)+(B193), (A)+(B126)+(B194), (A)+(B126)+(B195), (A)+(B126)+(B196), (A)+(B126)+(B197), (A)+(B126)+(B198), (A)+(B126)+(B199), (A)+(B126)+(B200), (A)+(B126)+(B201), (A)+(B126)+(B202), (A)+(B126)+(B203), (A)+(B126)+(B204), (A)+(B126)+(B205), (A)+(B126)+(B206), (A)+(B126)+(B207), (A)+(B126)+(B208), (A)+(B126)+(B209), (A)+(B126)+(B210), (A)+(B126)+(B211), (A)+(B126)+(B212), (A)+(B126)+(B213), (A)+(B126)+(B214), (A)+(B126)+(B215), (A)+(B126)+(B216), (A)+(B126)+(B217), (A)+(B126)+(B218), (A)+(B126)+(B219), (A)+(B126)+(B220), (A)+(B126)+(B221), (A)+(B126)+(B222), (A)+(B126)+(B223), (A)+(B126)+(B224), (A)+(B126)+(B225), (A)+(B126)+(B226), (A)+(B126)+(B227), (A)+(B126)+(B228), (A)+(B126)+(B229), (A)+(B126)+(B230), (A)+(B126)+(B231), (A)+(B126)+(B232), (A)+(B126)+(B233), (A)+(B126)+(B234), (A)+(B126)+(B235), (A)+(B126)+(B236), (A)+(B126)+(B237), (A)+(B126)+(B238), (A)+(B126)+(B239), (A)+(B126)+(B240), (A)+(B126)+(B241), (A)+(B126)+(B242), (A)+(B126)+(B243), (A)+(B126)+(B244), (A)+(B126)+(B245), (A)+(B126)+(B246), (A)+(B126)+(B247), (A)+(B126)+(B248), (A)+(B126)+(B249), (A)+(B126)+(B250), (A)+(B126)+(B251), (A)+(B126)+(B252), (A)+(B126)+(B253), (A)+(B126)+(B254), (A)+(B126)+(B255), (A)+(B126)+(B256), (A)+(B126)+(B257), (A)+(B126)+(B258), (A)+(B126)+(B259), (A)+(B126)+(B260), (A)+(B126)+(B261), (A)+(B126)+(B262), (A)+(B126)+(B263), (A)+(B126)+(B264), (A)+(B126)+(B265), (A)+(B126)+(B266), (A)+(B126)+(B267), (A)+(B126)+(B268), (A)+(B126)+(B269), (A)+(B126)+(B270), (A)+(B126)+(B271), (A)+(B126)+(B272), (A)+(B126)+(B273), (A)+(B126)+(B274), (A)+(B126)+(B275), (A)+(B126)+(B276), (A)+(B126)+(B277), (A)+(B126)+(B278), (A)+(B126)+(B279), (A)+(B126)+(B280), (A)+(B126)+(B281), (A)+(B126)+(B282), (A)+(B126)+(B283), (A)+(B126)+(B284), (A)+(B126)+(B285), (A)+(B126)+(B286), (A)+(B126)+(B287), (A)+(B126)+(B288), (A)+(B126)+(B289), (A)+(B126)+(B290), (A)+(B126)+(B291), (A)+(B126)+(B292), (A)+(B126)+(B293), (A)+(B126)+(B294), (A)+(B126)+(B295), (A)+(B126)+(B296), (A)+(B126)+(B297), (A)+(B126)+(B298), (A)+(B126)+(B299), (A)+(B126)+(B300), (A)+(B126)+(B301), (A)+(B126)+(B302), (A)+(B126)+(B303), (A)+(B126)+(B304), (A)+(B126)+(B305), (A)+(B126)+(B306), (A)+(B126)+(B307), (A)+(B126)+(B308), (A)+(B126)+(B309), (A)+(B126)+(B310), (A)+(B126)+(B311), (A)+(B126)+(B312), (A)+(B126)+(B313), (A)+(B126)+(B314), (A)+(B126)+(B315),

(A)+(B127)+(B128), (A)+(B127)+(B129), (A)+(B127)+(B130), (A)+(B127)+(B131), (A)+(B127)+(B132), (A)+(B127)+(B133), (A)+(B127)+(B134), (A)+(B127)+(B135), (A)+(B127)+(B136), (A)+(B127)+(B137), (A)+(B127)+(B138), (A)+(B127)+(B139), (A)+(B127)+(B140), (A)+(B127)+(B141), (A)+(B127)+(B142), (A)+(B127)+(B143), (A)+(B127)+(B144), (A)+(B127)+(B145), (A)+(B127)+(B146), (A)+(B127)+(B147), (A)+(B127)+(B148), (A)+(B127)+(B149), (A)+(B127)+(B150), (A)+(B127)+(B151), (A)+(B127)+(B152), (A)+(B127)+(B153), (A)+(B127)+(B154), (A)+(B127)+(B155), (A)+(B127)+(B156), (A)+(B127)+(B157), (A)+(B127)+(B158), (A)+(B127)+(B159), (A)+(B127)+(B160), (A)+(B127)+(B161), (A)+(B127)+(B162), (A)+(B127)+(B164), (A)+(B127)+(B164), (A)+(B127)+(B165), (A)+(B127)+(B166), (A)+(B127)+(B167), (A)+(B127)+(B168), (A)+(B127)+(B169), (A)+(B127)+(B170), (A)+(B127)+(B171), (A)+(B127)+(B172), (A)+(B127)+(B173), (A)+(B127)+(B174), (A)+(B127)+(B175), (A)+(B127)+(B176), (A)+(B127)+(B177), (A)+(B127)+(B178), (A)+(B127)+(B179), (A)+(B127)+(B180), (A)+(B127)+(B181), (A)+(B127)+(B182), (A)+(B127)+(B183), (A)+(B127)+(B184), (A)+(B127)+(B185), (A)+(B127)+(B186), (A)+(B127)+(B187), (A)+(B127)+(B188), (A)+(B127)+(B189), (A)+(B127)+(B190), (A)+(B127)+(B191), (A)+(B127)+(B192), (A)+(B127)+(B193), (A)+(B127)+(B194), (A)+(B127)+(B195), (A)+(B127)+(B196), (A)+(B127)+(B197), (A)+(B127)+(B198), (A)+(B127)+(B199), (A)+(B127)+(B200), (A)+(B127)+(B201), (A)+(B127)+(B202), (A)+(B127)+(B203), (A)+(B127)+(B204), (A)+(B127)+(B205), (A)+(B127)+(B206), (A)+(B127)+(B207), (A)+(B127)+(B208), (A)+(B127)+(B209), (A)+(B127)+(B210), (A)+(B127)+(B211), (A)+(B127)+(B212), (A)+(B127)+(B213), (A)+(B127)+(B214), (A)+(B127)+(B215), (A)+(B127)+(B216), (A)+(B127)+(B217), (A)+(B127)+(B218), (A)+(B127)+(B219), (A)+(B127)+(B220), (A)+(B127)+(B221), (A)+(B127)+(B222), (A)+(B127)+(B223), (A)+(B127)+(B224), (A)+(B127)+(B225), (A)+(B127)+(B226), (A)+(B127)+(B227), (A)+(B127)+(B228), (A)+(B127)+(B229), (A)+(B127)+(B230), (A)+(B127)+(B231), (A)+(B127)+(B232), (A)+(B127)+(B233), (A)+(B127)+(B234), (A)+(B127)+(B235), (A)+(B127)+(B236), (A)+(B127)+(B237), (A)+(B127)+(B238), (A)+(B127)+(B239), (A)+(B127)+(B240), (A)+(B127)+(B241), (A)+(B127)+(B242), (A)+(B127)+(B243), (A)+(B127)+(B244), (A)+(B127)+(B245), (A)+(B127)+(B246), (A)+(B127)+(B247), (A)+(B127)+(B248), (A)+(B127)+(B249), (A)+(B127)+(B250), (A)+(B127)+(B251), (A)+(B127)+(B252), (A)+(B127)+(B253), (A)+(B127)+(B254), (A)+(B127)+(B255), (A)+(B127)+(B256), (A)+(B127)+(B257), (A)+(B127)+(B258), (A)+(B127)+(B259), (A)+(B127)+(B260), (A)+(B127)+(B261), (A)+(B127)+(B262), (A)+(B127)+(B263), (A)+(B127)+(B264), (A)+(B127)+(B265), (A)+(B127)+(B266), (A)+(B127)+(B267), (A)+(B127)+(B268), (A)+(B127)+(B269), (A)+(B127)+(B270), (A)+(B127)+(B271), (A)+(B127)+(B272), (A)+(B127)+(B273), (A)+(B127)+(B274), (A)+(B127)+(B275), (A)+(B127)+(B276), (A)+(B127)+(B277), (A)+(B127)+(B278), (A)+(B127)+(B279), (A)+(B127)+(B280), (A)+(B127)+(B281), (A)+(B127)+(B282), (A)+(B127)+(B283), (A)+(B127)+(B284), (A)+(B127)+(B285), (A)+(B127)+(B286), (A)+(B127)+(B287), (A)+(B127)+(B288), (A)+(B127)+(B289), (A)+(B127)+(B290), (A)+(B127)+(B291), (A)+(B127)+(B292), (A)+(B127)+(B293), (A)+(B127)+(B294), (A)+(B127)+(B295), (A)+(B127)+(B296), (A)+(B127)+(B297), (A)+(B127)+(B298), (A)+(B127)+(B299), (A)+(B127)+(B300), (A)+(B127)+(B301), (A)+(B127)+(B302), (A)+(B127)+(B303), (A)+(B127)+(B304), (A)+(B127)+(B305), (A)+(B127)+(B306), (A)+(B127)+(B307), (A)+(B127)+(B308), (A)+(B127)+(B309), (A)+(B127)+(B310), (A)+(B127)+(B311), (A)+(B127)+(B312), (A)+(B127)+(B313), (A)+(B127)+(B314), (A)+(B127)+(B315),

(A)+(B128)+(B129), (A)+(B128)+(B130), (A)+(B128)+(B131), (A)+(B128)+(B132), (A)+(B128)+(B133), (A)+(B128)+(B134), (A)+(B128)+(B135), (A)+(B128)+(B136), (A)+(B128)+(B137), (A)+(B128)+(B138), (A)+(B128)+(B139), (A)+(B128)+(B140), (A)+(B128)+(B141), (A)+(B128)+(B142), (A)+(B128)+(B143), (A)+(B128)+(B144), (A)+(B128)+(B145), (A)+(B128)+(B146), (A)+(B128)+(B147), (A)+(B128)+(B148), (A)+(B128)+(B149), (A)+(B128)+(B150), (A)+(B128)+(B151), (A)+(B128)+(B152), (A)+(B128)+(B153), (A)+(B128)+(B154), (A)+(B128)+(B155), (A)+(B128)+(B156), (A)+(B128)+(B157), (A)+(B128)+(B158), (A)+(B128)+(B159), (A)+(B128)+(B160), (A)+(B128)+(B161), (A)+(B128)+(B162), (A)+(B128)+(B164), (A)+(B128)+(B164), (A)+(B128)+(B165), (A)+(B128)+(B166), (A)+(B128)+(B167), (A)+(B128)+(B168), (A)+(B128)+(B169), (A)+(B128)+(B170), (A)+(B128)+(B171), (A)+(B128)+(B172), (A)+(B128)+(B173), (A)+(B128)+(B174), (A)+(B128)+(B175), (A)+(B128)+(B176), (A)+(B128)+(B177), (A)+(B128)+(B178), (A)+(B128)+(B179), (A)+(B128)+(B180), (A)+(B128)+(B181), (A)+(B128)+(B182), (A)+(B128)+(B183), (A)+(B128)+(B184), (A)+(B128)+(B185), (A)+(B128)+(B186), (A)+(B128)+(B187), (A)+(B128)+(B188), (A)+(B128)+(B189), (A)+(B128)+(B190), (A)+(B128)+(B191), (A)+(B128)+(B192), (A)+(B128)+(B193), (A)+(B128)+(B194), (A)+(B128)+(B195), (A)+(B128)+(B196), (A)+(B128)+(B197), (A)+(B128)+(B198), (A)+(B128)+(B199), (A)+(B128)+(B200), (A)+(B128)+(B201), (A)+(B128)+(B202), (A)+(B128)+(B203), (A)+(B128)+(B204), (A)+(B128)+(B205), (A)+(B128)+(B206), (A)+(B128)+(B207), (A)+(B128)+(B208), (A)+(B128)+(B209), (A)+(B128)+(B210), (A)+(B128)+(B211), (A)+(B128)+(B212), (A)+(B128)+(B213), (A)+(B128)+(B214), (A)+(B128)+(B215), (A)+(B128)+(B216), (A)+(B128)+(B217), (A)+(B128)+(B218), (A)+(B128)+(B219), (A)+(B128)+(B220), (A)+(B128)+(B221), (A)+(B128)+(B222), (A)+(B128)+(B223), (A)+(B128)+(B224), (A)+(B128)+(B225), (A)+(B128)+(B226), (A)+(B128)+(B227), (A)+(B128)+(B228), (A)+(B128)+(B229), (A)+(B128)+(B230), (A)+(B128)+(B231), (A)+(B128)+(B232), (A)+(B128)+(B233), (A)+(B128)+(B234), (A)+(B128)+(B235), (A)+(B128)+(B236), (A)+(B128)+(B237), (A)+(B128)+(B238), (A)+(B128)+(B239), (A)+(B128)+(B240), (A)+(B128)+(B241), (A)+(B128)+(B242), (A)+(B128)+(B243), (A)+(B128)+(B244), (A)+(B128)+(B245), (A)+(B128)+(B246), (A)+(B128)+(B247), (A)+(B128)+(B248), (A)+(B128)+(B249), (A)+(B128)+(B250), (A)+(B128)+(B251), (A)+(B128)+(B252), (A)+(B128)+(B253), (A)+(B128)+(B254), (A)+(B128)+(B255), (A)+(B128)+(B256), (A)+(B128)+(B257), (A)+(B128)+(B258), (A)+(B128)+(B259), (A)+(B128)+(B260), (A)+(B128)+(B261), (A)+(B128)+(B262), (A)+(B128)+(B263), (A)+(B128)+(B264), (A)+(B128)+(B265), (A)+(B128)+(B266), (A)+(B128)+(B267), (A)+(B128)+(B268), (A)+(B128)+(B269), (A)+(B128)+(B270), (A)+(B128)+(B271), (A)+(B128)+(B272), (A)+(B128)+(B273), (A)+(B128)+(B274), (A)+(B128)+(B275), (A)+(B128)+(B276), (A)+(B128)+(B277), (A)+(B128)+(B278), (A)+(B128)+(B279), (A)+(B128)+(B280), (A)+(B128)+(B281), (A)+(B128)+(B282), (A)+(B128)+(B283), (A)+(B128)+(B284), (A)+(B128)+(B285), (A)+(B128)+(B286), (A)+(B128)+(B287), (A)+(B128)+(B288), (A)+(B128)+(B289), (A)+(B128)+(B290), (A)+(B128)+(B291), (A)+(B128)+(B292), (A)+(B128)+(B293), (A)+(B128)+(B294), (A)+(B128)+(B295), (A)+(B128)+(B296), (A)+(B128)+(B297), (A)+(B128)+(B298), (A)+(B128)+(B299), (A)+(B128)+(B300), (A)+(B128)+(B301), (A)+(B128)+(B302), (A)+(B128)+(B303), (A)+(B128)+(B304), (A)+(B128)+(B305), (A)+(B128)+(B306), (A)+(B128)+(B307), (A)+(B128)+(B308), (A)+(B128)+(B309), (A)+(B128)+(B310), (A)+(B128)+(B311), (A)+(B128)+(B312), (A)+(B128)+(B313), (A)+(B128)+(B314), (A)+(B128)+(B315),

(A)+(B129)+(B130), (A)+(B129)+(B131), (A)+(B129)+(B132), (A)+(B129)+(B133), (A)+(B129)+(B134), (A)+(B129)+(B135), (A)+(B129)+(B136), (A)+(B129)+(B137), (A)+(B129)+(B138), (A)+(B129)+(B139), (A)+(B129)+(B140), (A)+(B129)+(B141), (A)+(B129)+(B142), (A)+(B129)+(B143), (A)+(B129)+(B144), (A)+(B129)+(B145), (A)+(B129)+(B146), (A)+(B129)+(B147), (A)+(B129)+(B148), (A)+(B129)+(B149), (A)+(B129)+(B150), (A)+(B129)+(B151), (A)+(B129)+(B152), (A)+(B129)+(B153), (A)+(B129)+(B154), (A)+(B129)+(B155), (A)+(B129)+(B156), (A)+(B129)+(B157), (A)+(B129)+(B158), (A)+(B129)+(B159), (A)+(B129)+(B160), (A)+(B129)+(B161), (A)+(B129)+(B162), (A)+(B129)+(B164), (A)+(B129)+(B164), (A)+(B129)+(B165), (A)+(B129)+(B166), (A)+(B129)+(B167), (A)+(B129)+(B168), (A)+(B129)+(B169), (A)+(B129)+(B170), (A)+(B129)+(B171), (A)+(B129)+(B172), (A)+(B129)+(B173), (A)+(B129)+(B174), (A)+(B129)+(B175), (A)+(B129)+(B176), (A)+(B129)+(B177), (A)+(B129)+(B178), (A)+(B129)+(B179), (A)+(B129)+(B180), (A)+(B129)+(B181), (A)+(B129)+(B182), (A)+(B129)+(B183), (A)+(B129)+(B184), (A)+(B129)+(B185), (A)+(B129)+(B186), (A)+(B129)+(B187), (A)+(B129)+(B188), (A)+(B129)+(B189), (A)+(B129)+(B190), (A)+(B129)+(B191), (A)+(B129)+(B192), (A)+(B129)+(B193), (A)+(B129)+(B194), (A)+(B129)+(B195), (A)+(B129)+(B196), (A)+(B129)+(B197), (A)+(B129)+(B198), (A)+(B129)+(B199), (A)+(B129)+(B200), (A)+(B129)+(B201), (A)+(B129)+(B202), (A)+(B129)+(B203), (A)+(B129)+(B204), (A)+(B129)+(B205), (A)+(B129)+(B206), (A)+(B129)+(B207), (A)+(B129)+(B208), (A)+(B129)+(B209), (A)+(B129)+(B210), (A)+(B129)+(B211), (A)+(B129)+(B212), (A)+(B129)+(B213), (A)+(B129)+(B214), (A)+(B129)+(B215), (A)+(B129)+(B216), (A)+(B129)+(B217), (A)+(B129)+(B218), (A)+(B129)+(B219), (A)+(B129)+(B220), (A)+(B129)+(B221), (A)+(B129)+(B222), (A)+(B129)+(B223), (A)+(B129)+(B224), (A)+(B129)+(B225), (A)+(B129)+(B226), (A)+(B129)+(B227), (A)+(B129)+(B228), (A)+(B129)+(B229), (A)+(B129)+(B230), (A)+(B129)+(B231), (A)+(B129)+(B232), (A)+(B129)+(B233), (A)+(B129)+(B234), (A)+(B129)+(B235), (A)+(B129)+(B236), (A)+(B129)+(B237), (A)+(B129)+(B238), (A)+(B129)+(B239), (A)+(B129)+(B240), (A)+(B129)+(B241), (A)+(B129)+(B242), (A)+(B129)+(B243), (A)+(B129)+(B244), (A)+(B129)+(B245), (A)+(B129)+(B246), (A)+(B129)+(B247), (A)+(B129)+(B248), (A)+(B129)+(B249), (A)+(B129)+(B250), (A)+(B129)+(B251), (A)+(B129)+(B252), (A)+(B129)+(B253), (A)+(B129)+(B254), (A)+(B129)+(B255), (A)+(B129)+(B256), (A)+(B129)+(B257), (A)+(B129)+(B258), (A)+(B129)+(B259), (A)+(B129)+(B260), (A)+(B129)+(B261), (A)+(B129)+(B262), (A)+(B129)+(B263), (A)+(B129)+(B264), (A)+(B129)+(B265), (A)+(B129)+(B266), (A)+(B129)+(B267), (A)+(B129)+(B268), (A)+(B129)+(B269), (A)+(B129)+(B270), (A)+(B129)+(B271), (A)+(B129)+(B272), (A)+(B129)+(B273), (A)+(B129)+(B274), (A)+(B129)+(B275), (A)+(B129)+(B276), (A)+(B129)+(B277), (A)+(B129)+(B278), (A)+(B129)+(B279), (A)+(B129)+(B280), (A)+(B129)+(B281), (A)+(B129)+(B282), (A)+(B129)+(B283), (A)+(B129)+(B284), (A)+(B129)+(B285), (A)+(B129)+(B286), (A)+(B129)+(B287), (A)+(B129)+(B288), (A)+(B129)+(B289), (A)+(B129)+(B290), (A)+(B129)+(B291), (A)+(B129)+(B292), (A)+(B129)+(B293), (A)+(B129)+(B294), (A)+(B129)+(B295), (A)+(B129)+(B296), (A)+(B129)+(B297), (A)+(B129)+(B298), (A)+(B129)+(B299), (A)+(B129)+(B300), (A)+(B129)+(B301), (A)+(B129)+(B302), (A)+(B129)+(B303), (A)+(B129)+(B304), (A)+(B129)+(B305), (A)+(B129)+(B306), (A)+(B129)+(B307), (A)+(B129)+(B308), (A)+(B129)+(B309), (A)+(B129)+(B310), (A)+(B129)+(B311), (A)+(B129)+(B312), (A)+(B129)+(B313), (A)+(B129)+(B314), (A)+(B129)+(B315),

(A)+(B130)+(B131), (A)+(B130)+(B132), (A)+(B130)+(B133), (A)+(B130)+(B134), (A)+(B130)+(B135), (A)+(B130)+(B136), (A)+(B130)+(B137), (A)+(B130)+(B138), (A)+(B130)+(B139), (A)+(B130)+(B140), (A)+(B130)+(B141), (A)+(B130)+(B142), (A)+(B130)+(B143), (A)+(B130)+(B144), (A)+(B130)+(B145), (A)+(B130)+(B146), (A)+(B130)+(B147), (A)+(B130)+(B148), (A)+(B130)+(B149), (A)+(B130)+(B150), (A)+(B130)+(B151), (A)+(B130)+(B152), (A)+(B130)+(B153), (A)+(B130)+(B154), (A)+(B130)+(B155), (A)+(B130)+(B156), (A)+(B130)+(B157), (A)+(B130)+(B158), (A)+(B130)+(B159), (A)+(B130)+(B160), (A)+(B130)+(B161), (A)+(B130)+(B162), (A)+(B130)+(B164), (A)+(B130)+(B164), (A)+(B130)+(B165), (A)+(B130)+(B166), (A)+(B130)+(B167), (A)+(B130)+(B168), (A)+(B130)+(B169), (A)+(B130)+(B170), (A)+(B130)+(B171), (A)+(B130)+(B172), (A)+(B130)+(B173), (A)+(B130)+(B174), (A)+(B130)+(B175), (A)+(B130)+(B176), (A)+(B130)+(B177), (A)+(B130)+(B178), (A)+(B130)+(B179), (A)+(B130)+(B180), (A)+(B130)+(B181), (A)+(B130)+(B182), (A)+(B130)+(B183), (A)+(B130)+(B184), (A)+(B130)+(B185), (A)+(B130)+(B186), (A)+(B130)+(B187), (A)+(B130)+(B188), (A)+(B130)+(B189), (A)+(B130)+(B190), (A)+(B130)+(B191), (A)+(B130)+(B192), (A)+(B130)+(B193), (A)+(B130)+(B194), (A)+(B130)+(B195), (A)+(B130)+(B196), (A)+(B130)+(B197), (A)+(B130)+(B198), (A)+(B130)+(B199), (A)+(B130)+(B200), (A)+(B130)+(B201), (A)+(B130)+(B202), (A)+(B130)+(B203), (A)+(B130)+(B204), (A)+(B130)+(B205), (A)+(B130)+(B206), (A)+(B130)+(B207), (A)+(B130)+(B208), (A)+(B130)+(B209), (A)+(B130)+(B210), (A)+(B130)+(B211), (A)+(B130)+(B212), (A)+(B130)+(B213), (A)+(B130)+(B214), (A)+(B130)+(B215), (A)+(B130)+(B216), (A)+(B130)+(B217), (A)+(B130)+(B218), (A)+(B130)+(B219), (A)+(B130)+(B220), (A)+(B130)+(B221), (A)+(B130)+(B222), (A)+(B130)+(B223), (A)+(B130)+(B224), (A)+(B130)+(B225), (A)+(B130)+(B226), (A)+(B130)+(B227), (A)+(B130)+(B228), (A)+(B130)+(B229), (A)+(B130)+(B230), (A)+(B130)+(B231), (A)+(B130)+(B232), (A)+(B130)+(B233), (A)+(B130)+(B234), (A)+(B130)+(B235), (A)+(B130)+(B236), (A)+(B130)+(B237), (A)+(B130)+(B238), (A)+(B130)+(B239), (A)+(B130)+(B240), (A)+(B130)+(B241), (A)+(B130)+(B242), (A)+(B130)+(B243), (A)+(B130)+(B244), (A)+(B130)+(B245), (A)+(B130)+(B246), (A)+(B130)+(B247), (A)+(B130)+(B248), (A)+(B130)+(B249), (A)+(B130)+(B250), (A)+(B130)+(B251), (A)+(B130)+(B252), (A)+(B130)+(B253), (A)+(B130)+(B254), (A)+(B130)+(B255), (A)+(B130)+(B256), (A)+(B130)+(B257), (A)+(B130)+(B258), (A)+(B130)+(B259), (A)+(B130)+(B260), (A)+(B130)+(B261), (A)+(B130)+(B262), (A)+(B130)+(B263), (A)+(B130)+(B264), (A)+(B130)+(B265), (A)+(B130)+(B266), (A)+(B130)+(B267), (A)+(B130)+(B268), (A)+(B130)+(B269), (A)+(B130)+(B270), (A)+(B130)+(B271), (A)+(B130)+(B272), (A)+(B130)+(B273), (A)+(B130)+(B274), (A)+(B130)+(B275), (A)+(B130)+(B276), (A)+(B130)+(B277), (A)+(B130)+(B278), (A)+(B130)+(B279), (A)+(B130)+(B280), (A)+(B130)+(B281), (A)+(B130)+(B282), (A)+(B130)+(B283), (A)+(B130)+(B284), (A)+(B130)+(B285), (A)+(B130)+(B286), (A)+(B130)+(B287), (A)+(B130)+(B288), (A)+(B130)+(B289), (A)+(B130)+(B290), (A)+(B130)+(B291), (A)+(B130)+(B292), (A)+(B130)+(B293), (A)+(B130)+(B294), (A)+(B130)+(B295), (A)+(B130)+(B296), (A)+(B130)+(B297), (A)+(B130)+(B298), (A)+(B130)+(B299), (A)+(B130)+(B300), (A)+(B130)+(B301), (A)+(B130)+(B302), (A)+(B130)+(B303), (A)+(B130)+(B304), (A)+(B130)+(B305), (A)+(B130)+(B306), (A)+(B130)+(B307), (A)+(B130)+(B308), (A)+(B130)+(B309), (A)+(B130)+(B310), (A)+(B130)+(B311), (A)+(B130)+(B312), (A)+(B130)+(B313), (A)+(B130)+(B314), (A)+(B130)+(B315),

(A)+(B131)+(B132), (A)+(B131)+(B133), (A)+(B131)+(B134), (A)+(B131)+(B135), (A)+(B131)+(B136), (A)+(B131)+(B137), (A)+(B131)+(B138), (A)+(B131)+(B139), (A)+(B131)+(B140), (A)+(B131)+(B141), (A)+(B131)+(B142), (A)+(B131)+(B143), (A)+(B131)+(B144), (A)+(B131)+(B145), (A)+(B131)+(B146), (A)+(B131)+(B147), (A)+(B131)+(B148), (A)+(B131)+(B149), (A)+(B131)+(B150), (A)+(B131)+(B151), (A)+(B131)+(B152), (A)+(B131)+(B153), (A)+(B131)+(B154), (A)+(B131)+(B155), (A)+(B131)+(B156), (A)+(B131)+(B157), (A)+(B131)+(B158), (A)+(B131)+(B159), (A)+(B131)+(B160), (A)+(B131)+(B161), (A)+(B131)+(B162), (A)+(B131)+(B164), (A)+(B131)+(B164), (A)+(B131)+(B165), (A)+(B131)+(B166), (A)+(B131)+(B167), (A)+(B131)+(B168), (A)+(B131)+(B169), (A)+(B131)+(B170), (A)+(B131)+(B171), (A)+(B131)+(B172), (A)+(B131)+(B173), (A)+(B131)+(B174), (A)+(B131)+(B175), (A)+(B131)+(B176), (A)+(B131)+(B177), (A)+(B131)+(B178), (A)+(B131)+(B179), (A)+(B131)+(B180), (A)+(B131)+(B181), (A)+(B131)+(B182), (A)+(B131)+(B183), (A)+(B131)+(B184), (A)+(B131)+(B185), (A)+(B131)+(B186), (A)+(B131)+(B187), (A)+(B131)+(B188), (A)+(B131)+(B189), (A)+(B131)+(B190), (A)+(B131)+(B191), (A)+(B131)+(B192), (A)+(B131)+(B193), (A)+(B131)+(B194), (A)+(B131)+(B195), (A)+(B131)+(B196), (A)+(B131)+(B197), (A)+(B131)+(B198), (A)+(B131)+(B199), (A)+(B131)+(B200), (A)+(B131)+(B201), (A)+(B131)+(B202), (A)+(B131)+(B203), (A)+(B131)+(B204), (A)+(B131)+(B205), (A)+(B131)+(B206), (A)+(B131)+(B207), (A)+(B131)+(B208), (A)+(B131)+(B209), (A)+(B131)+(B210), (A)+(B131)+(B211), (A)+(B131)+(B212), (A)+(B131)+(B213), (A)+(B131)+(B214), (A)+(B131)+(B215), (A)+(B131)+(B216), (A)+(B131)+(B217), (A)+(B131)+(B218), (A)+(B131)+(B219), (A)+(B131)+(B220), (A)+(B131)+(B221), (A)+(B131)+(B222), (A)+(B131)+(B223), (A)+(B131)+(B224), (A)+(B131)+(B225), (A)+(B131)+(B226), (A)+(B131)+(B227), (A)+(B131)+(B228), (A)+(B131)+(B229), (A)+(B131)+(B230), (A)+(B131)+(B231), (A)+(B131)+(B232), (A)+(B131)+(B233), (A)+(B131)+(B234), (A)+(B131)+(B235), (A)+(B131)+(B236), (A)+(B131)+(B237), (A)+(B131)+(B238), (A)+(B131)+(B239), (A)+(B131)+(B240), (A)+(B131)+(B241), (A)+(B131)+(B242), (A)+(B131)+(B243), (A)+(B131)+(B244), (A)+(B131)+(B245), (A)+(B131)+(B246), (A)+(B131)+(B247), (A)+(B131)+(B248), (A)+(B131)+(B249), (A)+(B131)+(B250), (A)+(B131)+(B251), (A)+(B131)+(B252), (A)+(B131)+(B253), (A)+(B131)+(B254), (A)+(B131)+(B255), (A)+(B131)+(B256), (A)+(B131)+(B257), (A)+(B131)+(B258), (A)+(B131)+(B259), (A)+(B131)+(B260), (A)+(B131)+(B261), (A)+(B131)+(B262), (A)+(B131)+(B263), (A)+(B131)+(B264), (A)+(B131)+(B265), (A)+(B131)+(B266), (A)+(B131)+(B267), (A)+(B131)+(B268), (A)+(B131)+(B269), (A)+(B131)+(B270), (A)+(B131)+(B271), (A)+(B131)+(B272), (A)+(B131)+(B273), (A)+(B131)+(B274), (A)+(B131)+(B275), (A)+(B131)+(B276), (A)+(B131)+(B277), (A)+(B131)+(B278), (A)+(B131)+(B279), (A)+(B131)+(B280), (A)+(B131)+(B281), (A)+(B131)+(B282), (A)+(B131)+(B283), (A)+(B131)+(B284), (A)+(B131)+(B285), (A)+(B131)+(B286), (A)+(B131)+(B287), (A)+(B131)+(B288), (A)+(B131)+(B289), (A)+(B131)+(B290), (A)+(B131)+(B291), (A)+(B131)+(B292), (A)+(B131)+(B293), (A)+(B131)+(B294), (A)+(B131)+(B295), (A)+(B131)+(B296), (A)+(B131)+(B297), (A)+(B131)+(B298), (A)+(B131)+(B299), (A)+(B131)+(B300), (A)+(B131)+(B301), (A)+(B131)+(B302), (A)+(B131)+(B303), (A)+(B131)+(B304), (A)+(B131)+(B305), (A)+(B131)+(B306), (A)+(B131)+(B307), (A)+(B131)+(B308), (A)+(B131)+(B309), (A)+(B131)+(B310), (A)+(B131)+(B311), (A)+(B131)+(B312), (A)+(B131)+(B313), (A)+(B131)+(B314), (A)+(B131)+(B315),

(A)+(B132)+(B133), (A)+(B132)+(B134), (A)+(B132)+(B135), (A)+(B132)+(B136), (A)+(B132)+(B137), (A)+(B132)+(B138), (A)+(B132)+(B139), (A)+(B132)+(B140), (A)+(B132)+(B141), (A)+(B132)+(B142), (A)+(B132)+(B143), (A)+(B132)+(B144), (A)+(B132)+(B145), (A)+(B132)+(B146), (A)+(B132)+(B147), (A)+(B132)+(B148), (A)+(B132)+(B149), (A)+(B132)+(B150), (A)+(B132)+(B151), (A)+(B132)+(B152), (A)+(B132)+(B153), (A)+(B132)+(B154), (A)+(B132)+(B155), (A)+(B132)+(B156), (A)+(B132)+(B157), (A)+(B132)+(B158), (A)+(B132)+(B159), (A)+(B132)+(B160), (A)+(B132)+(B161), (A)+(B132)+(B162), (A)+(B132)+(B164), (A)+(B132)+(B164), (A)+(B132)+(B165), (A)+(B132)+(B166), (A)+(B132)+(B167), (A)+(B132)+(B168), (A)+(B132)+(B169), (A)+(B132)+(B170), (A)+(B132)+(B171), (A)+(B132)+(B172), (A)+(B132)+(B173), (A)+(B132)+(B174), (A)+(B132)+(B175), (A)+(B132)+(B176), (A)+(B132)+(B177), (A)+(B132)+(B178), (A)+(B132)+(B179), (A)+(B132)+(B180), (A)+(B132)+(B181), (A)+(B132)+(B182), (A)+(B132)+(B183), (A)+(B132)+(B184), (A)+(B132)+(B185), (A)+(B132)+(B186), (A)+(B132)+(B187), (A)+(B132)+(B188), (A)+(B132)+(B189), (A)+(B132)+(B190), (A)+(B132)+(B191), (A)+(B132)+(B192), (A)+(B132)+(B193), (A)+(B132)+(B194), (A)+(B132)+(B195), (A)+(B132)+(B196), (A)+(B132)+(B197), (A)+(B132)+(B198), (A)+(B132)+(B199), (A)+(B132)+(B200), (A)+(B132)+(B201), (A)+(B132)+(B202), (A)+(B132)+(B203), (A)+(B132)+(B204), (A)+(B132)+(B205), (A)+(B132)+(B206), (A)+(B132)+(B207), (A)+(B132)+(B208), (A)+(B132)+(B209), (A)+(B132)+(B210), (A)+(B132)+(B211), (A)+(B132)+(B212), (A)+(B132)+(B213), (A)+(B132)+(B214), (A)+(B132)+(B215), (A)+(B132)+(B216), (A)+(B132)+(B217), (A)+(B132)+(B218), (A)+(B132)+(B219), (A)+(B132)+(B220), (A)+(B132)+(B221), (A)+(B132)+(B222), (A)+(B132)+(B223), (A)+(B132)+(B224), (A)+(B132)+(B225), (A)+(B132)+(B226), (A)+(B132)+(B227), (A)+(B132)+(B228), (A)+(B132)+(B229), (A)+(B132)+(B230), (A)+(B132)+(B231), (A)+(B132)+(B232), (A)+(B132)+(B233), (A)+(B132)+(B234), (A)+(B132)+(B235), (A)+(B132)+(B236), (A)+(B132)+(B237), (A)+(B132)+(B238), (A)+(B132)+(B239), (A)+(B132)+(B240), (A)+(B132)+(B241), (A)+(B132)+(B242), (A)+(B132)+(B243), (A)+(B132)+(B244), (A)+(B132)+(B245), (A)+(B132)+(B246), (A)+(B132)+(B247), (A)+(B132)+(B248), (A)+(B132)+(B249), (A)+(B132)+(B250), (A)+(B132)+(B251), (A)+(B132)+(B252), (A)+(B132)+(B253), (A)+(B132)+(B254), (A)+(B132)+(B255), (A)+(B132)+(B256), (A)+(B132)+(B257), (A)+(B132)+(B258), (A)+(B132)+(B259), (A)+(B132)+(B260), (A)+(B132)+(B261), (A)+(B132)+(B262), (A)+(B132)+(B263), (A)+(B132)+(B264), (A)+(B132)+(B265), (A)+(B132)+(B266), (A)+(B132)+(B267), (A)+(B132)+(B268), (A)+(B132)+(B269), (A)+(B132)+(B270), (A)+(B132)+(B271), (A)+(B132)+(B272), (A)+(B132)+(B273), (A)+(B132)+(B274), (A)+(B132)+(B275), (A)+(B132)+(B276), (A)+(B132)+(B277), (A)+(B132)+(B278), (A)+(B132)+(B279), (A)+(B132)+(B280), (A)+(B132)+(B281), (A)+(B132)+(B282), (A)+(B132)+(B283), (A)+(B132)+(B284), (A)+(B132)+(B285), (A)+(B132)+(B286), (A)+(B132)+(B287), (A)+(B132)+(B288), (A)+(B132)+(B289), (A)+(B132)+(B290), (A)+(B132)+(B291), (A)+(B132)+(B292), (A)+(B132)+(B293), (A)+(B132)+(B294), (A)+(B132)+(B295), (A)+(B132)+(B296), (A)+(B132)+(B297), (A)+(B132)+(B298), (A)+(B132)+(B299), (A)+(B132)+(B300), (A)+(B132)+(B301), (A)+(B132)+(B302), (A)+(B132)+(B303), (A)+(B132)+(B304), (A)+(B132)+(B305), (A)+(B132)+(B306), (A)+(B132)+(B307), (A)+(B132)+(B308), (A)+(B132)+(B309), (A)+(B132)+(B310), (A)+(B132)+(B311), (A)+(B132)+(B312), (A)+(B132)+(B313), (A)+(B132)+(B314), (A)+(B132)+(B315),

(A)+(B133)+(B134), (A)+(B133)+(B135), (A)+(B133)+(B136), (A)+(B133)+(B137), (A)+(B133)+(B138), (A)+(B133)+(B139), (A)+(B133)+(B140), (A)+(B133)+(B141), (A)+(B133)+(B142), (A)+(B133)+(B143), (A)+(B133)+(B144), (A)+(B133)+(B145), (A)+(B133)+(B146), (A)+(B133)+(B147), (A)+(B133)+(B148), (A)+(B133)+(B149), (A)+(B133)+(B150), (A)+(B133)+(B151), (A)+(B133)+(B152), (A)+(B133)+(B153), (A)+(B133)+(B154), (A)+(B133)+(B155), (A)+(B133)+(B156), (A)+(B133)+(B157), (A)+(B133)+(B158), (A)+(B133)+(B159), (A)+(B133)+(B160), (A)+(B133)+(B161), (A)+(B133)+(B162), (A)+(B133)+(B164), (A)+(B133)+(B164), (A)+(B133)+(B165), (A)+(B133)+(B166), (A)+(B133)+(B167), (A)+(B133)+(B168), (A)+(B133)+(B169), (A)+(B133)+(B170), (A)+(B133)+(B171), (A)+(B133)+(B172), (A)+(B133)+(B173), (A)+(B133)+(B174), (A)+(B133)+(B175), (A)+(B133)+(B176), (A)+(B133)+(B177), (A)+(B133)+(B178), (A)+(B133)+(B179), (A)+(B133)+(B180), (A)+(B133)+(B181), (A)+(B133)+(B182), (A)+(B133)+(B183), (A)+(B133)+(B184), (A)+(B133)+(B185), (A)+(B133)+(B186), (A)+(B133)+(B187), (A)+(B133)+(B188), (A)+(B133)+(B189), (A)+(B133)+(B190), (A)+(B133)+(B191), (A)+(B133)+(B192), (A)+(B133)+(B193), (A)+(B133)+(B194), (A)+(B133)+(B195), (A)+(B133)+(B196), (A)+(B133)+(B197), (A)+(B133)+(B198), (A)+(B133)+(B199), (A)+(B133)+(B200), (A)+(B133)+(B201), (A)+(B133)+(B202), (A)+(B133)+(B203), (A)+(B133)+(B204), (A)+(B133)+(B205), (A)+(B133)+(B206), (A)+(B133)+(B207), (A)+(B133)+(B208), (A)+(B133)+(B209), (A)+(B133)+(B210), (A)+(B133)+(B211), (A)+(B133)+(B212), (A)+(B133)+(B213), (A)+(B133)+(B214), (A)+(B133)+(B215), (A)+(B133)+(B216), (A)+(B133)+(B217), (A)+(B133)+(B218), (A)+(B133)+(B219), (A)+(B133)+(B220), (A)+(B133)+(B221), (A)+(B133)+(B222), (A)+(B133)+(B223), (A)+(B133)+(B224), (A)+(B133)+(B225), (A)+(B133)+(B226), (A)+(B133)+(B227), (A)+(B133)+(B228), (A)+(B133)+(B229), (A)+(B133)+(B230), (A)+(B133)+(B231), (A)+(B133)+(B232), (A)+(B133)+(B233), (A)+(B133)+(B234), (A)+(B133)+(B235), (A)+(B133)+(B236), (A)+(B133)+(B237), (A)+(B133)+(B238), (A)+(B133)+(B239), (A)+(B133)+(B240), (A)+(B133)+(B241), (A)+(B133)+(B242), (A)+(B133)+(B243), (A)+(B133)+(B244), (A)+(B133)+(B245), (A)+(B133)+(B246), (A)+(B133)+(B247), (A)+(B133)+(B248), (A)+(B133)+(B249), (A)+(B133)+(B250), (A)+(B133)+(B251), (A)+(B133)+(B252), (A)+(B133)+(B253), (A)+(B133)+(B254), (A)+(B133)+(B255), (A)+(B133)+(B256), (A)+(B133)+(B257), (A)+(B133)+(B258), (A)+(B133)+(B259), (A)+(B133)+(B260), (A)+(B133)+(B261), (A)+(B133)+(B262), (A)+(B133)+(B263), (A)+(B133)+(B264), (A)+(B133)+(B265), (A)+(B133)+(B266), (A)+(B133)+(B267), (A)+(B133)+(B268), (A)+(B133)+(B269), (A)+(B133)+(B270), (A)+(B133)+(B271), (A)+(B133)+(B272), (A)+(B133)+(B273), (A)+(B133)+(B274), (A)+(B133)+(B275), (A)+(B133)+(B276), (A)+(B133)+(B277), (A)+(B133)+(B278), (A)+(B133)+(B279), (A)+(B133)+(B280), (A)+(B133)+(B281), (A)+(B133)+(B282), (A)+(B133)+(B283), (A)+(B133)+(B284), (A)+(B133)+(B285), (A)+(B133)+(B286), (A)+(B133)+(B287), (A)+(B133)+(B288), (A)+(B133)+(B289), (A)+(B133)+(B290), (A)+(B133)+(B291), (A)+(B133)+(B292), (A)+(B133)+(B293), (A)+(B133)+(B294), (A)+(B133)+(B295), (A)+(B133)+(B296), (A)+(B133)+(B297), (A)+(B133)+(B298), (A)+(B133)+(B299), (A)+(B133)+(B300), (A)+(B133)+(B301), (A)+(B133)+(B302), (A)+(B133)+(B303), (A)+(B133)+(B304), (A)+(B133)+(B305), (A)+(B133)+(B306), (A)+(B133)+(B307), (A)+(B133)+(B308), (A)+(B133)+(B309), (A)+(B133)+(B310), (A)+(B133)+(B311), (A)+(B133)+(B312), (A)+(B133)+(B313), (A)+(B133)+(B314), (A)+(B133)+(B315),

(A)+(B134)+(B135), (A)+(B134)+(B136), (A)+(B134)+(B137), (A)+(B134)+(B138), (A)+(B134)+(B139), (A)+(B134)+(B140), (A)+(B134)+(B141), (A)+(B134)+(B142), (A)+(B134)+(B143), (A)+(B134)+(B144), (A)+(B134)+(B145), (A)+(B134)+(B146), (A)+(B134)+(B147), (A)+(B134)+(B148), (A)+(B134)+(B149), (A)+(B134)+(B150), (A)+(B134)+(B151), (A)+(B134)+(B152), (A)+(B134)+(B153), (A)+(B134)+(B154), (A)+(B134)+(B155), (A)+(B134)+(B156), (A)+(B134)+(B157), (A)+(B134)+(B158), (A)+(B134)+(B159), (A)+(B134)+(B160), (A)+(B134)+(B161), (A)+(B134)+(B162), (A)+(B134)+(B164), (A)+(B134)+(B164), (A)+(B134)+(B165), (A)+(B134)+(B166), (A)+(B134)+(B167), (A)+(B134)+(B168), (A)+(B134)+(B169), (A)+(B134)+(B170), (A)+(B134)+(B171), (A)+(B134)+(B172), (A)+(B134)+(B173), (A)+(B134)+(B174), (A)+(B134)+(B175), (A)+(B134)+(B176), (A)+(B134)+(B177), (A)+(B134)+(B178), (A)+(B134)+(B179), (A)+(B134)+(B180), (A)+(B134)+(B181), (A)+(B134)+(B182), (A)+(B134)+(B183), (A)+(B134)+(B184), (A)+(B134)+(B185), (A)+(B134)+(B186), (A)+(B134)+(B187), (A)+(B134)+(B188), (A)+(B134)+(B189), (A)+(B134)+(B190), (A)+(B134)+(B191), (A)+(B134)+(B192), (A)+(B134)+(B193), (A)+(B134)+(B194), (A)+(B134)+(B195), (A)+(B134)+(B196), (A)+(B134)+(B197), (A)+(B134)+(B198), (A)+(B134)+(B199), (A)+(B134)+(B200), (A)+(B134)+(B201), (A)+(B134)+(B202), (A)+(B134)+(B203), (A)+(B134)+(B204), (A)+(B134)+(B205), (A)+(B134)+(B206), (A)+(B134)+(B207), (A)+(B134)+(B208), (A)+(B134)+(B209), (A)+(B134)+(B210), (A)+(B134)+(B211), (A)+(B134)+(B212), (A)+(B134)+(B213), (A)+(B134)+(B214), (A)+(B134)+(B215), (A)+(B134)+(B216), (A)+(B134)+(B217), (A)+(B134)+(B218), (A)+(B134)+(B219), (A)+(B134)+(B220), (A)+(B134)+(B221), (A)+(B134)+(B222), (A)+(B134)+(B223), (A)+(B134)+(B224), (A)+(B134)+(B225), (A)+(B134)+(B226), (A)+(B134)+(B227), (A)+(B134)+(B228), (A)+(B134)+(B229), (A)+(B134)+(B230), (A)+(B134)+(B231), (A)+(B134)+(B232), (A)+(B134)+(B233), (A)+(B134)+(B234), (A)+(B134)+(B235), (A)+(B134)+(B236), (A)+(B134)+(B237), (A)+(B134)+(B238), (A)+(B134)+(B239), (A)+(B134)+(B240), (A)+(B134)+(B241), (A)+(B134)+(B242), (A)+(B134)+(B243), (A)+(B134)+(B244), (A)+(B134)+(B245), (A)+(B134)+(B246), (A)+(B134)+(B247), (A)+(B134)+(B248), (A)+(B134)+(B249), (A)+(B134)+(B250), (A)+(B134)+(B251), (A)+(B134)+(B252), (A)+(B134)+(B253), (A)+(B134)+(B254), (A)+(B134)+(B255), (A)+(B134)+(B256), (A)+(B134)+(B257), (A)+(B134)+(B258), (A)+(B134)+(B259), (A)+(B134)+(B260), (A)+(B134)+(B261), (A)+(B134)+(B262), (A)+(B134)+(B263), (A)+(B134)+(B264), (A)+(B134)+(B265), (A)+(B134)+(B266), (A)+(B134)+(B267), (A)+(B134)+(B268), (A)+(B134)+(B269), (A)+(B134)+(B270), (A)+(B134)+(B271), (A)+(B134)+(B272), (A)+(B134)+(B273), (A)+(B134)+(B274), (A)+(B134)+(B275), (A)+(B134)+(B276), (A)+(B134)+(B277), (A)+(B134)+(B278), (A)+(B134)+(B279), (A)+(B134)+(B280), (A)+(B134)+(B281), (A)+(B134)+(B282), (A)+(B134)+(B283), (A)+(B134)+(B284), (A)+(B134)+(B285), (A)+(B134)+(B286), (A)+(B134)+(B287), (A)+(B134)+(B288), (A)+(B134)+(B289), (A)+(B134)+(B290), (A)+(B134)+(B291), (A)+(B134)+(B292), (A)+(B134)+(B293), (A)+(B134)+(B294), (A)+(B134)+(B295), (A)+(B134)+(B296), (A)+(B134)+(B297), (A)+(B134)+(B298), (A)+(B134)+(B299), (A)+(B134)+(B300), (A)+(B134)+(B301), (A)+(B134)+(B302), (A)+(B134)+(B303), (A)+(B134)+(B304), (A)+(B134)+(B305), (A)+(B134)+(B306), (A)+(B134)+(B307), (A)+(B134)+(B308), (A)+(B134)+(B309), (A)+(B134)+(B310), (A)+(B134)+(B311), (A)+(B134)+(B312), (A)+(B134)+(B313), (A)+(B134)+(B314), (A)+(B134)+(B315),

(A)+(B135)+(B136), (A)+(B135)+(B137), (A)+(B135)+(B138), (A)+(B135)+(B139), (A)+(B135)+(B140), (A)+(B135)+(B141), (A)+(B135)+(B142), (A)+(B135)+(B143), (A)+(B135)+(B144), (A)+(B135)+(B145), (A)+(B135)+(B146), (A)+(B135)+(B147), (A)+(B135)+(B148), (A)+(B135)+(B149), (A)+(B135)+(B150), (A)+(B135)+(B151), (A)+(B135)+(B152), (A)+(B135)+(B153), (A)+(B135)+(B154), (A)+(B135)+(B155), (A)+(B135)+(B156), (A)+(B135)+(B157), (A)+(B135)+(B158), (A)+(B135)+(B159), (A)+(B135)+(B160), (A)+(B135)+(B161), (A)+(B135)+(B162), (A)+(B135)+(B164), (A)+(B135)+(B164), (A)+(B135)+(B165), (A)+(B135)+(B166), (A)+(B135)+(B167), (A)+(B135)+(B168), (A)+(B135)+(B169), (A)+(B135)+(B170), (A)+(B135)+(B171), (A)+(B135)+(B172), (A)+(B135)+(B173), (A)+(B135)+(B174), (A)+(B135)+(B175), (A)+(B135)+(B176), (A)+(B135)+(B177), (A)+(B135)+(B178), (A)+(B135)+(B179), (A)+(B135)+(B180), (A)+(B135)+(B181), (A)+(B135)+(B182), (A)+(B135)+(B183), (A)+(B135)+(B184), (A)+(B135)+(B185), (A)+(B135)+(B186), (A)+(B135)+(B187), (A)+(B135)+(B188), (A)+(B135)+(B189), (A)+(B135)+(B190), (A)+(B135)+(B191), (A)+(B135)+(B192), (A)+(B135)+(B193), (A)+(B135)+(B194), (A)+(B135)+(B195), (A)+(B135)+(B196), (A)+(B135)+(B197), (A)+(B135)+(B198), (A)+(B135)+(B199), (A)+(B135)+(B200), (A)+(B135)+(B201), (A)+(B135)+(B202), (A)+(B135)+(B203), (A)+(B135)+(B204), (A)+(B135)+(B205), (A)+(B135)+(B206), (A)+(B135)+(B207), (A)+(B135)+(B208), (A)+(B135)+(B209), (A)+(B135)+(B210), (A)+(B135)+(B211), (A)+(B135)+(B212), (A)+(B135)+(B213), (A)+(B135)+(B214), (A)+(B135)+(B215), (A)+(B135)+(B216), (A)+(B135)+(B217), (A)+(B135)+(B218), (A)+(B135)+(B219), (A)+(B135)+(B220), (A)+(B135)+(B221), (A)+(B135)+(B222), (A)+(B135)+(B223), (A)+(B135)+(B224), (A)+(B135)+(B225), (A)+(B135)+(B226), (A)+(B135)+(B227), (A)+(B135)+(B228), (A)+(B135)+(B229), (A)+(B135)+(B230), (A)+(B135)+(B231), (A)+(B135)+(B232), (A)+(B135)+(B233), (A)+(B135)+(B234), (A)+(B135)+(B235), (A)+(B135)+(B236), (A)+(B135)+(B237), (A)+(B135)+(B238), (A)+(B135)+(B239), (A)+(B135)+(B240), (A)+(B135)+(B241), (A)+(B135)+(B242), (A)+(B135)+(B243), (A)+(B135)+(B244), (A)+(B135)+(B245), (A)+(B135)+(B246), (A)+(B135)+(B247), (A)+(B135)+(B248), (A)+(B135)+(B249), (A)+(B135)+(B250), (A)+(B135)+(B251), (A)+(B135)+(B252), (A)+(B135)+(B253), (A)+(B135)+(B254), (A)+(B135)+(B255), (A)+(B135)+(B256), (A)+(B135)+(B257), (A)+(B135)+(B258), (A)+(B135)+(B259), (A)+(B135)+(B260), (A)+(B135)+(B261), (A)+(B135)+(B262), (A)+(B135)+(B263), (A)+(B135)+(B264), (A)+(B135)+(B265), (A)+(B135)+(B266), (A)+(B135)+(B267), (A)+(B135)+(B268), (A)+(B135)+(B269), (A)+(B135)+(B270), (A)+(B135)+(B271), (A)+(B135)+(B272), (A)+(B135)+(B273), (A)+(B135)+(B274), (A)+(B135)+(B275), (A)+(B135)+(B276), (A)+(B135)+(B277), (A)+(B135)+(B278), (A)+(B135)+(B279), (A)+(B135)+(B280), (A)+(B135)+(B281), (A)+(B135)+(B282), (A)+(B135)+(B283), (A)+(B135)+(B284), (A)+(B135)+(B285), (A)+(B135)+(B286), (A)+(B135)+(B287), (A)+(B135)+(B288), (A)+(B135)+(B289), (A)+(B135)+(B290), (A)+(B135)+(B291), (A)+(B135)+(B292), (A)+(B135)+(B293), (A)+(B135)+(B294), (A)+(B135)+(B295), (A)+(B135)+(B296), (A)+(B135)+(B297), (A)+(B135)+(B298), (A)+(B135)+(B299), (A)+(B135)+(B300), (A)+(B135)+(B301), (A)+(B135)+(B302), (A)+(B135)+(B303), (A)+(B135)+(B304), (A)+(B135)+(B305), (A)+(B135)+(B306), (A)+(B135)+(B307), (A)+(B135)+(B308), (A)+(B135)+(B309), (A)+(B135)+(B310), (A)+(B135)+(B311), (A)+(B135)+(B312), (A)+(B135)+(B313), (A)+(B135)+(B314), (A)+(B135)+(B315),

(A)+(B136)+(B137), (A)+(B136)+(B138), (A)+(B136)+(B139), (A)+(B136)+(B140), (A)+(B136)+(B141), (A)+(B136)+(B142), (A)+(B136)+(B143), (A)+(B136)+(B144), (A)+(B136)+(B145), (A)+(B136)+(B146), (A)+(B136)+(B147), (A)+(B136)+(B148), (A)+(B136)+(B149), (A)+(B136)+(B150), (A)+(B136)+(B151), (A)+(B136)+(B152), (A)+(B136)+(B153), (A)+(B136)+(B154), (A)+(B136)+(B155), (A)+(B136)+(B156), (A)+(B136)+(B157), (A)+(B136)+(B158), (A)+(B136)+(B159), (A)+(B136)+(B160), (A)+(B136)+(B161), (A)+(B136)+(B162), (A)+(B136)+(B164), (A)+(B136)+(B164), (A)+(B136)+(B165), (A)+(B136)+(B166), (A)+(B136)+(B167), (A)+(B136)+(B168), (A)+(B136)+(B169), (A)+(B136)+(B170), (A)+(B136)+(B171), (A)+(B136)+(B172), (A)+(B136)+(B173), (A)+(B136)+(B174), (A)+(B136)+(B175), (A)+(B136)+(B176), (A)+(B136)+(B177), (A)+(B136)+(B178), (A)+(B136)+(B179), (A)+(B136)+(B180), (A)+(B136)+(B181), (A)+(B136)+(B182), (A)+(B136)+(B183), (A)+(B136)+(B184), (A)+(B136)+(B185), (A)+(B136)+(B186), (A)+(B136)+(B187), (A)+(B136)+(B188), (A)+(B136)+(B189), (A)+(B136)+(B190), (A)+(B136)+(B191), (A)+(B136)+(B192), (A)+(B136)+(B193), (A)+(B136)+(B194), (A)+(B136)+(B195), (A)+(B136)+(B196), (A)+(B136)+(B197), (A)+(B136)+(B198), (A)+(B136)+(B199), (A)+(B136)+(B200), (A)+(B136)+(B201), (A)+(B136)+(B202), (A)+(B136)+(B203), (A)+(B136)+(B204), (A)+(B136)+(B205), (A)+(B136)+(B206), (A)+(B136)+(B207), (A)+(B136)+(B208), (A)+(B136)+(B209), (A)+(B136)+(B210), (A)+(B136)+(B211), (A)+(B136)+(B212), (A)+(B136)+(B213), (A)+(B136)+(B214), (A)+(B136)+(B215), (A)+(B136)+(B216), (A)+(B136)+(B217), (A)+(B136)+(B218), (A)+(B136)+(B219), (A)+(B136)+(B220), (A)+(B136)+(B221), (A)+(B136)+(B222), (A)+(B136)+(B223), (A)+(B136)+(B224), (A)+(B136)+(B225), (A)+(B136)+(B226), (A)+(B136)+(B227), (A)+(B136)+(B228), (A)+(B136)+(B229), (A)+(B136)+(B230), (A)+(B136)+(B231), (A)+(B136)+(B232), (A)+(B136)+(B233), (A)+(B136)+(B234), (A)+(B136)+(B235), (A)+(B136)+(B236), (A)+(B136)+(B237), (A)+(B136)+(B238), (A)+(B136)+(B239), (A)+(B136)+(B240), (A)+(B136)+(B241), (A)+(B136)+(B242), (A)+(B136)+(B243), (A)+(B136)+(B244), (A)+(B136)+(B245), (A)+(B136)+(B246), (A)+(B136)+(B247), (A)+(B136)+(B248), (A)+(B136)+(B249), (A)+(B136)+(B250), (A)+(B136)+(B251), (A)+(B136)+(B252), (A)+(B136)+(B253), (A)+(B136)+(B254), (A)+(B136)+(B255), (A)+(B136)+(B256), (A)+(B136)+(B257), (A)+(B136)+(B258), (A)+(B136)+(B259), (A)+(B136)+(B260), (A)+(B136)+(B261), (A)+(B136)+(B262), (A)+(B136)+(B263), (A)+(B136)+(B264), (A)+(B136)+(B265), (A)+(B136)+(B266), (A)+(B136)+(B267), (A)+(B136)+(B268), (A)+(B136)+(B269), (A)+(B136)+(B270), (A)+(B136)+(B271), (A)+(B136)+(B272), (A)+(B136)+(B273), (A)+(B136)+(B274), (A)+(B136)+(B275), (A)+(B136)+(B276), (A)+(B136)+(B277), (A)+(B136)+(B278), (A)+(B136)+(B279), (A)+(B136)+(B280), (A)+(B136)+(B281), (A)+(B136)+(B282), (A)+(B136)+(B283), (A)+(B136)+(B284), (A)+(B136)+(B285), (A)+(B136)+(B286), (A)+(B136)+(B287), (A)+(B136)+(B288), (A)+(B136)+(B289), (A)+(B136)+(B290), (A)+(B136)+(B291), (A)+(B136)+(B292), (A)+(B136)+(B293), (A)+(B136)+(B294), (A)+(B136)+(B295), (A)+(B136)+(B296), (A)+(B136)+(B297), (A)+(B136)+(B298), (A)+(B136)+(B299), (A)+(B136)+(B300), (A)+(B136)+(B301), (A)+(B136)+(B302), (A)+(B136)+(B303), (A)+(B136)+(B304), (A)+(B136)+(B305), (A)+(B136)+(B306), (A)+(B136)+(B307), (A)+(B136)+(B308), (A)+(B136)+(B309), (A)+(B136)+(B310), (A)+(B136)+(B311), (A)+(B136)+(B312), (A)+(B136)+(B313), (A)+(B136)+(B314), (A)+(B136)+(B315),

(A)+(B137)+(B138), (A)+(B137)+(B139), (A)+(B137)+(B140), (A)+(B137)+(B141), (A)+(B137)+(B142), (A)+(B137)+(B143), (A)+(B137)+(B144), (A)+(B137)+(B145), (A)+(B137)+(B146), (A)+(B137)+(B147), (A)+(B137)+(B148), (A)+(B137)+(B149), (A)+(B137)+(B150), (A)+(B137)+(B151), (A)+(B137)+(B152), (A)+(B137)+(B153), (A)+(B137)+(B154), (A)+(B137)+(B155), (A)+(B137)+(B156), (A)+(B137)+(B157), (A)+(B137)+(B158), (A)+(B137)+(B159), (A)+(B137)+(B160), (A)+(B137)+(B161), (A)+(B137)+(B162), (A)+(B137)+(B164), (A)+(B137)+(B164), (A)+(B137)+(B165), (A)+(B137)+(B166), (A)+(B137)+(B167), (A)+(B137)+(B168), (A)+(B137)+(B169), (A)+(B137)+(B170), (A)+(B137)+(B171), (A)+(B137)+(B172), (A)+(B137)+(B173), (A)+(B137)+(B174), (A)+(B137)+(B175), (A)+(B137)+(B176), (A)+(B137)+(B177), (A)+(B137)+(B178), (A)+(B137)+(B179), (A)+(B137)+(B180), (A)+(B137)+(B181), (A)+(B137)+(B182), (A)+(B137)+(B183), (A)+(B137)+(B184), (A)+(B137)+(B185), (A)+(B137)+(B186), (A)+(B137)+(B187), (A)+(B137)+(B188), (A)+(B137)+(B189), (A)+(B137)+(B190), (A)+(B137)+(B191), (A)+(B137)+(B192), (A)+(B137)+(B193), (A)+(B137)+(B194), (A)+(B137)+(B195), (A)+(B137)+(B196), (A)+(B137)+(B197), (A)+(B137)+(B198), (A)+(B137)+(B199), (A)+(B137)+(B200), (A)+(B137)+(B201), (A)+(B137)+(B202), (A)+(B137)+(B203), (A)+(B137)+(B204), (A)+(B137)+(B205), (A)+(B137)+(B206), (A)+(B137)+(B207), (A)+(B137)+(B208), (A)+(B137)+(B209), (A)+(B137)+(B210), (A)+(B137)+(B211), (A)+(B137)+(B212), (A)+(B137)+(B213), (A)+(B137)+(B214), (A)+(B137)+(B215), (A)+(B137)+(B216), (A)+(B137)+(B217), (A)+(B137)+(B218), (A)+(B137)+(B219), (A)+(B137)+(B220), (A)+(B137)+(B221), (A)+(B137)+(B222), (A)+(B137)+(B223), (A)+(B137)+(B224), (A)+(B137)+(B225), (A)+(B137)+(B226), (A)+(B137)+(B227), (A)+(B137)+(B228), (A)+(B137)+(B229), (A)+(B137)+(B230), (A)+(B137)+(B231), (A)+(B137)+(B232), (A)+(B137)+(B233), (A)+(B137)+(B234), (A)+(B137)+(B235), (A)+(B137)+(B236), (A)+(B137)+(B237), (A)+(B137)+(B238), (A)+(B137)+(B239), (A)+(B137)+(B240), (A)+(B137)+(B241), (A)+(B137)+(B242), (A)+(B137)+(B243), (A)+(B137)+(B244), (A)+(B137)+(B245), (A)+(B137)+(B246), (A)+(B137)+(B247), (A)+(B137)+(B248), (A)+(B137)+(B249), (A)+(B137)+(B250), (A)+(B137)+(B251), (A)+(B137)+(B252), (A)+(B137)+(B253), (A)+(B137)+(B254), (A)+(B137)+(B255), (A)+(B137)+(B256), (A)+(B137)+(B257), (A)+(B137)+(B258), (A)+(B137)+(B259), (A)+(B137)+(B260), (A)+(B137)+(B261), (A)+(B137)+(B262), (A)+(B137)+(B263), (A)+(B137)+(B264), (A)+(B137)+(B265), (A)+(B137)+(B266), (A)+(B137)+(B267), (A)+(B137)+(B268), (A)+(B137)+(B269), (A)+(B137)+(B270), (A)+(B137)+(B271), (A)+(B137)+(B272), (A)+(B137)+(B273), (A)+(B137)+(B274), (A)+(B137)+(B275), (A)+(B137)+(B276), (A)+(B137)+(B277), (A)+(B137)+(B278), (A)+(B137)+(B279), (A)+(B137)+(B280), (A)+(B137)+(B281), (A)+(B137)+(B282), (A)+(B137)+(B283), (A)+(B137)+(B284), (A)+(B137)+(B285), (A)+(B137)+(B286), (A)+(B137)+(B287), (A)+(B137)+(B288), (A)+(B137)+(B289), (A)+(B137)+(B290), (A)+(B137)+(B291), (A)+(B137)+(B292), (A)+(B137)+(B293), (A)+(B137)+(B294), (A)+(B137)+(B295), (A)+(B137)+(B296), (A)+(B137)+(B297), (A)+(B137)+(B298), (A)+(B137)+(B299), (A)+(B137)+(B300), (A)+(B137)+(B301), (A)+(B137)+(B302), (A)+(B137)+(B303), (A)+(B137)+(B304), (A)+(B137)+(B305), (A)+(B137)+(B306), (A)+(B137)+(B307), (A)+(B137)+(B308), (A)+(B137)+(B309), (A)+(B137)+(B310), (A)+(B137)+(B311), (A)+(B137)+(B312), (A)+(B137)+(B313), (A)+(B137)+(B314), (A)+(B137)+(B315),

(A)+(B138)+(B139), (A)+(B138)+(B140), (A)+(B138)+(B141), (A)+(B138)+(B142), (A)+(B138)+(B143), (A)+(B138)+(B144), (A)+(B138)+(B145), (A)+(B138)+(B146), (A)+(B138)+(B147), (A)+(B138)+(B148), (A)+(B138)+(B149), (A)+(B138)+(B150), (A)+(B138)+(B151), (A)+(B138)+(B152), (A)+(B138)+(B153), (A)+(B138)+(B154), (A)+(B138)+(B155), (A)+(B138)+(B156), (A)+(B138)+(B157), (A)+(B138)+(B158), (A)+(B138)+(B159), (A)+(B138)+(B160), (A)+(B138)+(B161), (A)+(B138)+(B162), (A)+(B138)+(B164), (A)+(B138)+(B164), (A)+(B138)+(B165), (A)+(B138)+(B166), (A)+(B138)+(B167), (A)+(B138)+(B168), (A)+(B138)+(B169), (A)+(B138)+(B170), (A)+(B138)+(B171), (A)+(B138)+(B172), (A)+(B138)+(B173), (A)+(B138)+(B174), (A)+(B138)+(B175), (A)+(B138)+(B176), (A)+(B138)+(B177), (A)+(B138)+(B178), (A)+(B138)+(B179), (A)+(B138)+(B180), (A)+(B138)+(B181), (A)+(B138)+(B182), (A)+(B138)+(B183), (A)+(B138)+(B184), (A)+(B138)+(B185), (A)+(B138)+(B186), (A)+(B138)+(B187), (A)+(B138)+(B188), (A)+(B138)+(B189), (A)+(B138)+(B190), (A)+(B138)+(B191), (A)+(B138)+(B192), (A)+(B138)+(B193), (A)+(B138)+(B194), (A)+(B138)+(B195), (A)+(B138)+(B196), (A)+(B138)+(B197), (A)+(B138)+(B198), (A)+(B138)+(B199), (A)+(B138)+(B200), (A)+(B138)+(B201), (A)+(B138)+(B202), (A)+(B138)+(B203), (A)+(B138)+(B204), (A)+(B138)+(B205), (A)+(B138)+(B206), (A)+(B138)+(B207), (A)+(B138)+(B208), (A)+(B138)+(B209), (A)+(B138)+(B210), (A)+(B138)+(B211), (A)+(B138)+(B212), (A)+(B138)+(B213), (A)+(B138)+(B214), (A)+(B138)+(B215), (A)+(B138)+(B216), (A)+(B138)+(B217), (A)+(B138)+(B218), (A)+(B138)+(B219), (A)+(B138)+(B220), (A)+(B138)+(B221), (A)+(B138)+(B222), (A)+(B138)+(B223), (A)+(B138)+(B224), (A)+(B138)+(B225), (A)+(B138)+(B226), (A)+(B138)+(B227), (A)+(B138)+(B228), (A)+(B138)+(B229), (A)+(B138)+(B230), (A)+(B138)+(B231), (A)+(B138)+(B232), (A)+(B138)+(B233), (A)+(B138)+(B234), (A)+(B138)+(B235), (A)+(B138)+(B236), (A)+(B138)+(B237), (A)+(B138)+(B238), (A)+(B138)+(B239), (A)+(B138)+(B240), (A)+(B138)+(B241), (A)+(B138)+(B242), (A)+(B138)+(B243), (A)+(B138)+(B244), (A)+(B138)+(B245), (A)+(B138)+(B246), (A)+(B138)+(B247), (A)+(B138)+(B248), (A)+(B138)+(B249), (A)+(B138)+(B250), (A)+(B138)+(B251), (A)+(B138)+(B252), (A)+(B138)+(B253), (A)+(B138)+(B254), (A)+(B138)+(B255), (A)+(B138)+(B256), (A)+(B138)+(B257), (A)+(B138)+(B258), (A)+(B138)+(B259), (A)+(B138)+(B260), (A)+(B138)+(B261), (A)+(B138)+(B262), (A)+(B138)+(B263), (A)+(B138)+(B264), (A)+(B138)+(B265), (A)+(B138)+(B266), (A)+(B138)+(B267), (A)+(B138)+(B268), (A)+(B138)+(B269), (A)+(B138)+(B270), (A)+(B138)+(B271), (A)+(B138)+(B272), (A)+(B138)+(B273), (A)+(B138)+(B274), (A)+(B138)+(B275), (A)+(B138)+(B276), (A)+(B138)+(B277), (A)+(B138)+(B278), (A)+(B138)+(B279), (A)+(B138)+(B280), (A)+(B138)+(B281), (A)+(B138)+(B282), (A)+(B138)+(B283), (A)+(B138)+(B284), (A)+(B138)+(B285), (A)+(B138)+(B286), (A)+(B138)+(B287), (A)+(B138)+(B288), (A)+(B138)+(B289), (A)+(B138)+(B290), (A)+(B138)+(B291), (A)+(B138)+(B292), (A)+(B138)+(B293), (A)+(B138)+(B294), (A)+(B138)+(B295), (A)+(B138)+(B296), (A)+(B138)+(B297), (A)+(B138)+(B298), (A)+(B138)+(B299), (A)+(B138)+(B300), (A)+(B138)+(B301), (A)+(B138)+(B302), (A)+(B138)+(B303), (A)+(B138)+(B304), (A)+(B138)+(B305), (A)+(B138)+(B306), (A)+(B138)+(B307), (A)+(B138)+(B308), (A)+(B138)+(B309), (A)+(B138)+(B310), (A)+(B138)+(B311), (A)+(B138)+(B312), (A)+(B138)+(B313), (A)+(B138)+(B314), (A)+(B138)+(B315),

(A)+(B139)+(B140), (A)+(B139)+(B141), (A)+(B139)+(B142), (A)+(B139)+(B143), (A)+(B139)+(B144), (A)+(B139)+(B145), (A)+(B139)+(B146), (A)+(B139)+(B147), (A)+(B139)+(B148), (A)+(B139)+(B149), (A)+(B139)+(B150), (A)+(B139)+(B151), (A)+(B139)+(B152), (A)+(B139)+(B153), (A)+(B139)+(B154), (A)+(B139)+(B155), (A)+(B139)+(B156), (A)+(B139)+(B157), (A)+(B139)+(B158), (A)+(B139)+(B159), (A)+(B139)+(B160), (A)+(B139)+(B161), (A)+(B139)+(B162), (A)+(B139)+(B164), (A)+(B139)+(B164), (A)+(B139)+(B165), (A)+(B139)+(B166), (A)+(B139)+(B167), (A)+(B139)+(B168), (A)+(B139)+(B169), (A)+(B139)+(B170), (A)+(B139)+(B171), (A)+(B139)+(B172), (A)+(B139)+(B173), (A)+(B139)+(B174), (A)+(B139)+(B175), (A)+(B139)+(B176), (A)+(B139)+(B177), (A)+(B139)+(B178), (A)+(B139)+(B179), (A)+(B139)+(B180), (A)+(B139)+(B181), (A)+(B139)+(B182), (A)+(B139)+(B183), (A)+(B139)+(B184), (A)+(B139)+(B185), (A)+(B139)+(B186), (A)+(B139)+(B187), (A)+(B139)+(B188), (A)+(B139)+(B189), (A)+(B139)+(B190), (A)+(B139)+(B191), (A)+(B139)+(B192), (A)+(B139)+(B193), (A)+(B139)+(B194), (A)+(B139)+(B195), (A)+(B139)+(B196), (A)+(B139)+(B197), (A)+(B139)+(B198), (A)+(B139)+(B199), (A)+(B139)+(B200), (A)+(B139)+(B201), (A)+(B139)+(B202), (A)+(B139)+(B203), (A)+(B139)+(B204), (A)+(B139)+(B205), (A)+(B139)+(B206), (A)+(B139)+(B207), (A)+(B139)+(B208), (A)+(B139)+(B209), (A)+(B139)+(B210), (A)+(B139)+(B211), (A)+(B139)+(B212), (A)+(B139)+(B213), (A)+(B139)+(B214), (A)+(B139)+(B215), (A)+(B139)+(B216), (A)+(B139)+(B217), (A)+(B139)+(B218), (A)+(B139)+(B219), (A)+(B139)+(B220), (A)+(B139)+(B221), (A)+(B139)+(B222), (A)+(B139)+(B223), (A)+(B139)+(B224), (A)+(B139)+(B225), (A)+(B139)+(B226), (A)+(B139)+(B227), (A)+(B139)+(B228), (A)+(B139)+(B229), (A)+(B139)+(B230), (A)+(B139)+(B231), (A)+(B139)+(B232), (A)+(B139)+(B233), (A)+(B139)+(B234), (A)+(B139)+(B235), (A)+(B139)+(B236), (A)+(B139)+(B237), (A)+(B139)+(B238), (A)+(B139)+(B239), (A)+(B139)+(B240), (A)+(B139)+(B241), (A)+(B139)+(B242), (A)+(B139)+(B243), (A)+(B139)+(B244), (A)+(B139)+(B245), (A)+(B139)+(B246), (A)+(B139)+(B247), (A)+(B139)+(B248), (A)+(B139)+(B249), (A)+(B139)+(B250), (A)+(B139)+(B251), (A)+(B139)+(B252), (A)+(B139)+(B253), (A)+(B139)+(B254), (A)+(B139)+(B255), (A)+(B139)+(B256), (A)+(B139)+(B257), (A)+(B139)+(B258), (A)+(B139)+(B259), (A)+(B139)+(B260), (A)+(B139)+(B261), (A)+(B139)+(B262), (A)+(B139)+(B263), (A)+(B139)+(B264), (A)+(B139)+(B265), (A)+(B139)+(B266), (A)+(B139)+(B267), (A)+(B139)+(B268), (A)+(B139)+(B269), (A)+(B139)+(B270), (A)+(B139)+(B271), (A)+(B139)+(B272), (A)+(B139)+(B273), (A)+(B139)+(B274), (A)+(B139)+(B275), (A)+(B139)+(B276), (A)+(B139)+(B277), (A)+(B139)+(B278), (A)+(B139)+(B279), (A)+(B139)+(B280), (A)+(B139)+(B281), (A)+(B139)+(B282), (A)+(B139)+(B283), (A)+(B139)+(B284), (A)+(B139)+(B285), (A)+(B139)+(B286), (A)+(B139)+(B287), (A)+(B139)+(B288), (A)+(B139)+(B289), (A)+(B139)+(B290), (A)+(B139)+(B291), (A)+(B139)+(B292), (A)+(B139)+(B293), (A)+(B139)+(B294), (A)+(B139)+(B295), (A)+(B139)+(B296), (A)+(B139)+(B297), (A)+(B139)+(B298), (A)+(B139)+(B299), (A)+(B139)+(B300), (A)+(B139)+(B301), (A)+(B139)+(B302), (A)+(B139)+(B303), (A)+(B139)+(B304), (A)+(B139)+(B305), (A)+(B139)+(B306), (A)+(B139)+(B307), (A)+(B139)+(B308), (A)+(B139)+(B309), (A)+(B139)+(B310), (A)+(B139)+(B311), (A)+(B139)+(B312), (A)+(B139)+(B313), (A)+(B139)+(B314), (A)+(B139)+(B315),

(A)+(B140)+(B141), (A)+(B140)+(B142), (A)+(B140)+(B143), (A)+(B140)+(B144), (A)+(B140)+(B145), (A)+(B140)+(B146), (A)+(B140)+(B147), (A)+(B140)+(B148), (A)+(B140)+(B149), (A)+(B140)+(B150), (A)+(B140)+(B151), (A)+(B140)+(B152), (A)+(B140)+(B153), (A)+(B140)+(B154), (A)+(B140)+(B155), (A)+(B140)+(B156), (A)+(B140)+(B157), (A)+(B140)+(B158), (A)+(B140)+(B159), (A)+(B140)+(B160), (A)+(B140)+(B161), (A)+(B140)+(B162), (A)+(B140)+(B164), (A)+(B140)+(B164), (A)+(B140)+(B165), (A)+(B140)+(B166), (A)+(B140)+(B167), (A)+(B140)+(B168), (A)+(B140)+(B169), (A)+(B140)+(B170), (A)+(B140)+(B171), (A)+(B140)+(B172), (A)+(B140)+(B173), (A)+(B140)+(B174), (A)+(B140)+(B175), (A)+(B140)+(B176), (A)+(B140)+(B177), (A)+(B140)+(B178), (A)+(B140)+(B179), (A)+(B140)+(B180), (A)+(B140)+(B181), (A)+(B140)+(B182), (A)+(B140)+(B183), (A)+(B140)+(B184), (A)+(B140)+(B185), (A)+(B140)+(B186), (A)+(B140)+(B187), (A)+(B140)+(B188), (A)+(B140)+(B189), (A)+(B140)+(B190), (A)+(B140)+(B191), (A)+(B140)+(B192), (A)+(B140)+(B193), (A)+(B140)+(B194), (A)+(B140)+(B195), (A)+(B140)+(B196), (A)+(B140)+(B197), (A)+(B140)+(B198), (A)+(B140)+(B199), (A)+(B140)+(B200), (A)+(B140)+(B201), (A)+(B140)+(B202), (A)+(B140)+(B203), (A)+(B140)+(B204), (A)+(B140)+(B205), (A)+(B140)+(B206), (A)+(B140)+(B207), (A)+(B140)+(B208), (A)+(B140)+(B209), (A)+(B140)+(B210), (A)+(B140)+(B211), (A)+(B140)+(B212), (A)+(B140)+(B213), (A)+(B140)+(B214), (A)+(B140)+(B215), (A)+(B140)+(B216), (A)+(B140)+(B217), (A)+(B140)+(B218), (A)+(B140)+(B219), (A)+(B140)+(B220), (A)+(B140)+(B221), (A)+(B140)+(B222), (A)+(B140)+(B223), (A)+(B140)+(B224), (A)+(B140)+(B225), (A)+(B140)+(B226), (A)+(B140)+(B227), (A)+(B140)+(B228), (A)+(B140)+(B229), (A)+(B140)+(B230), (A)+(B140)+(B231), (A)+(B140)+(B232), (A)+(B140)+(B233), (A)+(B140)+(B234), (A)+(B140)+(B235), (A)+(B140)+(B236), (A)+(B140)+(B237), (A)+(B140)+(B238), (A)+(B140)+(B239), (A)+(B140)+(B240), (A)+(B140)+(B241), (A)+(B140)+(B242), (A)+(B140)+(B243), (A)+(B140)+(B244), (A)+(B140)+(B245), (A)+(B140)+(B246), (A)+(B140)+(B247), (A)+(B140)+(B248), (A)+(B140)+(B249), (A)+(B140)+(B250), (A)+(B140)+(B251), (A)+(B140)+(B252), (A)+(B140)+(B253), (A)+(B140)+(B254), (A)+(B140)+(B255), (A)+(B140)+(B256), (A)+(B140)+(B257), (A)+(B140)+(B258), (A)+(B140)+(B259), (A)+(B140)+(B260), (A)+(B140)+(B261), (A)+(B140)+(B262), (A)+(B140)+(B263), (A)+(B140)+(B264), (A)+(B140)+(B265), (A)+(B140)+(B266), (A)+(B140)+(B267), (A)+(B140)+(B268), (A)+(B140)+(B269), (A)+(B140)+(B270), (A)+(B140)+(B271), (A)+(B140)+(B272), (A)+(B140)+(B273), (A)+(B140)+(B274), (A)+(B140)+(B275), (A)+(B140)+(B276), (A)+(B140)+(B277), (A)+(B140)+(B278), (A)+(B140)+(B279), (A)+(B140)+(B280), (A)+(B140)+(B281), (A)+(B140)+(B282), (A)+(B140)+(B283), (A)+(B140)+(B284), (A)+(B140)+(B285), (A)+(B140)+(B286), (A)+(B140)+(B287), (A)+(B140)+(B288), (A)+(B140)+(B289), (A)+(B140)+(B290), (A)+(B140)+(B291), (A)+(B140)+(B292), (A)+(B140)+(B293), (A)+(B140)+(B294), (A)+(B140)+(B295), (A)+(B140)+(B296), (A)+(B140)+(B297), (A)+(B140)+(B298), (A)+(B140)+(B299), (A)+(B140)+(B300), (A)+(B140)+(B301), (A)+(B140)+(B302), (A)+(B140)+(B303), (A)+(B140)+(B304), (A)+(B140)+(B305), (A)+(B140)+(B306), (A)+(B140)+(B307), (A)+(B140)+(B308), (A)+(B140)+(B309), (A)+(B140)+(B310), (A)+(B140)+(B311), (A)+(B140)+(B312), (A)+(B140)+(B313), (A)+(B140)+(B314), (A)+(B140)+(B315),

(A)+(B141)+(B142), (A)+(B141)+(B143), (A)+(B141)+(B144), (A)+(B141)+(B145), (A)+(B141)+(B146), (A)+(B141)+(B147), (A)+(B141)+(B148), (A)+(B141)+(B149), (A)+(B141)+(B150), (A)+(B141)+(B151), (A)+(B141)+(B152), (A)+(B141)+(B153), (A)+(B141)+(B154), (A)+(B141)+(B155), (A)+(B141)+(B156), (A)+(B141)+(B157), (A)+(B141)+(B158), (A)+(B141)+(B159), (A)+(B141)+(B160), (A)+(B141)+(B161), (A)+(B141)+(B162), (A)+(B141)+(B164), (A)+(B141)+(B164), (A)+(B141)+(B165), (A)+(B141)+(B166), (A)+(B141)+(B167), (A)+(B141)+(B168), (A)+(B141)+(B169), (A)+(B141)+(B170), (A)+(B141)+(B171), (A)+(B141)+(B172), (A)+(B141)+(B173), (A)+(B141)+(B174), (A)+(B141)+(B175), (A)+(B141)+(B176), (A)+(B141)+(B177), (A)+(B141)+(B178), (A)+(B141)+(B179), (A)+(B141)+(B180), (A)+(B141)+(B181), (A)+(B141)+(B182), (A)+(B141)+(B183), (A)+(B141)+(B184), (A)+(B141)+(B185), (A)+(B141)+(B186), (A)+(B141)+(B187), (A)+(B141)+(B188), (A)+(B141)+(B189), (A)+(B141)+(B190), (A)+(B141)+(B191), (A)+(B141)+(B192), (A)+(B141)+(B193), (A)+(B141)+(B194), (A)+(B141)+(B195), (A)+(B141)+(B196), (A)+(B141)+(B197), (A)+(B141)+(B198), (A)+(B141)+(B199), (A)+(B141)+(B200), (A)+(B141)+(B201), (A)+(B141)+(B202), (A)+(B141)+(B203), (A)+(B141)+(B204), (A)+(B141)+(B205), (A)+(B141)+(B206), (A)+(B141)+(B207), (A)+(B141)+(B208), (A)+(B141)+(B209), (A)+(B141)+(B210), (A)+(B141)+(B211), (A)+(B141)+(B212), (A)+(B141)+(B213), (A)+(B141)+(B214), (A)+(B141)+(B215), (A)+(B141)+(B216), (A)+(B141)+(B217), (A)+(B141)+(B218), (A)+(B141)+(B219), (A)+(B141)+(B220), (A)+(B141)+(B221), (A)+(B141)+(B222), (A)+(B141)+(B223), (A)+(B141)+(B224), (A)+(B141)+(B225), (A)+(B141)+(B226), (A)+(B141)+(B227), (A)+(B141)+(B228), (A)+(B141)+(B229), (A)+(B141)+(B230), (A)+(B141)+(B231), (A)+(B141)+(B232), (A)+(B141)+(B233), (A)+(B141)+(B234), (A)+(B141)+(B235), (A)+(B141)+(B236), (A)+(B141)+(B237), (A)+(B141)+(B238), (A)+(B141)+(B239), (A)+(B141)+(B240), (A)+(B141)+(B241), (A)+(B141)+(B242), (A)+(B141)+(B243), (A)+(B141)+(B244), (A)+(B141)+(B245), (A)+(B141)+(B246), (A)+(B141)+(B247), (A)+(B141)+(B248), (A)+(B141)+(B249), (A)+(B141)+(B250), (A)+(B141)+(B251), (A)+(B141)+(B252), (A)+(B141)+(B253), (A)+(B141)+(B254), (A)+(B141)+(B255), (A)+(B141)+(B256), (A)+(B141)+(B257), (A)+(B141)+(B258), (A)+(B141)+(B259), (A)+(B141)+(B260), (A)+(B141)+(B261), (A)+(B141)+(B262), (A)+(B141)+(B263), (A)+(B141)+(B264), (A)+(B141)+(B265), (A)+(B141)+(B266), (A)+(B141)+(B267), (A)+(B141)+(B268), (A)+(B141)+(B269), (A)+(B141)+(B270), (A)+(B141)+(B271), (A)+(B141)+(B272), (A)+(B141)+(B273), (A)+(B141)+(B274), (A)+(B141)+(B275), (A)+(B141)+(B276), (A)+(B141)+(B277), (A)+(B141)+(B278), (A)+(B141)+(B279), (A)+(B141)+(B280), (A)+(B141)+(B281), (A)+(B141)+(B282), (A)+(B141)+(B283), (A)+(B141)+(B284), (A)+(B141)+(B285), (A)+(B141)+(B286), (A)+(B141)+(B287), (A)+(B141)+(B288), (A)+(B141)+(B289), (A)+(B141)+(B290), (A)+(B141)+(B291), (A)+(B141)+(B292), (A)+(B141)+(B293), (A)+(B141)+(B294), (A)+(B141)+(B295), (A)+(B141)+(B296), (A)+(B141)+(B297), (A)+(B141)+(B298), (A)+(B141)+(B299), (A)+(B141)+(B300), (A)+(B141)+(B301), (A)+(B141)+(B302), (A)+(B141)+(B303), (A)+(B141)+(B304), (A)+(B141)+(B305), (A)+(B141)+(B306), (A)+(B141)+(B307), (A)+(B141)+(B308), (A)+(B141)+(B309), (A)+(B141)+(B310), (A)+(B141)+(B311), (A)+(B141)+(B312), (A)+(B141)+(B313), (A)+(B141)+(B314), (A)+(B141)+(B315),

(A)+(B142)+(B143), (A)+(B142)+(B144), (A)+(B142)+(B145), (A)+(B142)+(B146), (A)+(B142)+(B147), (A)+(B142)+(B148), (A)+(B142)+(B149), (A)+(B142)+(B150), (A)+(B142)+(B151), (A)+(B142)+(B152), (A)+(B142)+(B153), (A)+(B142)+(B154), (A)+(B142)+(B155), (A)+(B142)+(B156), (A)+(B142)+(B157), (A)+(B142)+(B158), (A)+(B142)+(B159), (A)+(B142)+(B160), (A)+(B142)+(B161), (A)+(B142)+(B162), (A)+(B142)+(B164), (A)+(B142)+(B164), (A)+(B142)+(B165), (A)+(B142)+(B166), (A)+(B142)+(B167), (A)+(B142)+(B168), (A)+(B142)+(B169), (A)+(B142)+(B170), (A)+(B142)+(B171), (A)+(B142)+(B172), (A)+(B142)+(B173), (A)+(B142)+(B174), (A)+(B142)+(B175), (A)+(B142)+(B176), (A)+(B142)+(B177), (A)+(B142)+(B178), (A)+(B142)+(B179), (A)+(B142)+(B180), (A)+(B142)+(B181), (A)+(B142)+(B182), (A)+(B142)+(B183), (A)+(B142)+(B184), (A)+(B142)+(B185), (A)+(B142)+(B186), (A)+(B142)+(B187), (A)+(B142)+(B188), (A)+(B142)+(B189), (A)+(B142)+(B190), (A)+(B142)+(B191), (A)+(B142)+(B192), (A)+(B142)+(B193), (A)+(B142)+(B194), (A)+(B142)+(B195), (A)+(B142)+(B196), (A)+(B142)+(B197), (A)+(B142)+(B198), (A)+(B142)+(B199), (A)+(B142)+(B200), (A)+(B142)+(B201), (A)+(B142)+(B202), (A)+(B142)+(B203), (A)+(B142)+(B204), (A)+(B142)+(B205), (A)+(B142)+(B206), (A)+(B142)+(B207), (A)+(B142)+(B208), (A)+(B142)+(B209), (A)+(B142)+(B210), (A)+(B142)+(B211), (A)+(B142)+(B212), (A)+(B142)+(B213), (A)+(B142)+(B214), (A)+(B142)+(B215), (A)+(B142)+(B216), (A)+(B142)+(B217), (A)+(B142)+(B218), (A)+(B142)+(B219), (A)+(B142)+(B220), (A)+(B142)+(B221), (A)+(B142)+(B222), (A)+(B142)+(B223), (A)+(B142)+(B224), (A)+(B142)+(B225), (A)+(B142)+(B226), (A)+(B142)+(B227), (A)+(B142)+(B228), (A)+(B142)+(B229), (A)+(B142)+(B230), (A)+(B142)+(B231), (A)+(B142)+(B232), (A)+(B142)+(B233), (A)+(B142)+(B234), (A)+(B142)+(B235), (A)+(B142)+(B236), (A)+(B142)+(B237), (A)+(B142)+(B238), (A)+(B142)+(B239), (A)+(B142)+(B240), (A)+(B142)+(B241), (A)+(B142)+(B242), (A)+(B142)+(B243), (A)+(B142)+(B244), (A)+(B142)+(B245), (A)+(B142)+(B246), (A)+(B142)+(B247), (A)+(B142)+(B248), (A)+(B142)+(B249), (A)+(B142)+(B250), (A)+(B142)+(B251), (A)+(B142)+(B252), (A)+(B142)+(B253), (A)+(B142)+(B254), (A)+(B142)+(B255), (A)+(B142)+(B256), (A)+(B142)+(B257), (A)+(B142)+(B258), (A)+(B142)+(B259), (A)+(B142)+(B260), (A)+(B142)+(B261), (A)+(B142)+(B262), (A)+(B142)+(B263), (A)+(B142)+(B264), (A)+(B142)+(B265), (A)+(B142)+(B266), (A)+(B142)+(B267), (A)+(B142)+(B268), (A)+(B142)+(B269), (A)+(B142)+(B270), (A)+(B142)+(B271), (A)+(B142)+(B272), (A)+(B142)+(B273), (A)+(B142)+(B274), (A)+(B142)+(B275), (A)+(B142)+(B276), (A)+(B142)+(B277), (A)+(B142)+(B278), (A)+(B142)+(B279), (A)+(B142)+(B280), (A)+(B142)+(B281), (A)+(B142)+(B282), (A)+(B142)+(B283), (A)+(B142)+(B284), (A)+(B142)+(B285), (A)+(B142)+(B286), (A)+(B142)+(B287), (A)+(B142)+(B288), (A)+(B142)+(B289), (A)+(B142)+(B290), (A)+(B142)+(B291), (A)+(B142)+(B292), (A)+(B142)+(B293), (A)+(B142)+(B294), (A)+(B142)+(B295), (A)+(B142)+(B296), (A)+(B142)+(B297), (A)+(B142)+(B298), (A)+(B142)+(B299), (A)+(B142)+(B300), (A)+(B142)+(B301), (A)+(B142)+(B302), (A)+(B142)+(B303), (A)+(B142)+(B304), (A)+(B142)+(B305), (A)+(B142)+(B306), (A)+(B142)+(B307), (A)+(B142)+(B308), (A)+(B142)+(B309), (A)+(B142)+(B310), (A)+(B142)+(B311), (A)+(B142)+(B312), (A)+(B142)+(B313), (A)+(B142)+(B314), (A)+(B142)+(B315),

(A)+(B143)+(B144), (A)+(B143)+(B145), (A)+(B143)+(B146), (A)+(B143)+(B147), (A)+(B143)+(B148), (A)+(B143)+(B149), (A)+(B143)+(B150), (A)+(B143)+(B151), (A)+(B143)+(B152), (A)+(B143)+(B153), (A)+(B143)+(B154), (A)+(B143)+(B155), (A)+(B143)+(B156), (A)+(B143)+(B157), (A)+(B143)+(B158), (A)+(B143)+(B159), (A)+(B143)+(B160), (A)+(B143)+(B161), (A)+(B143)+(B162), (A)+(B143)+(B164), (A)+(B143)+(B164), (A)+(B143)+(B165), (A)+(B143)+(B166), (A)+(B143)+(B167), (A)+(B143)+(B168), (A)+(B143)+(B169), (A)+(B143)+(B170), (A)+(B143)+(B171), (A)+(B143)+(B172), (A)+(B143)+(B173), (A)+(B143)+(B174), (A)+(B143)+(B175), (A)+(B143)+(B176), (A)+(B143)+(B177), (A)+(B143)+(B178), (A)+(B143)+(B179), (A)+(B143)+(B180), (A)+(B143)+(B181), (A)+(B143)+(B182), (A)+(B143)+(B183), (A)+(B143)+(B184), (A)+(B143)+(B185), (A)+(B143)+(B186), (A)+(B143)+(B187), (A)+(B143)+(B188), (A)+(B143)+(B189), (A)+(B143)+(B190), (A)+(B143)+(B191), (A)+(B143)+(B192), (A)+(B143)+(B193), (A)+(B143)+(B194), (A)+(B143)+(B195), (A)+(B143)+(B196), (A)+(B143)+(B197), (A)+(B143)+(B198), (A)+(B143)+(B199), (A)+(B143)+(B200), (A)+(B143)+(B201), (A)+(B143)+(B202), (A)+(B143)+(B203), (A)+(B143)+(B204), (A)+(B143)+(B205), (A)+(B143)+(B206), (A)+(B143)+(B207), (A)+(B143)+(B208), (A)+(B143)+(B209), (A)+(B143)+(B210), (A)+(B143)+(B211), (A)+(B143)+(B212), (A)+(B143)+(B213), (A)+(B143)+(B214), (A)+(B143)+(B215), (A)+(B143)+(B216), (A)+(B143)+(B217), (A)+(B143)+(B218), (A)+(B143)+(B219), (A)+(B143)+(B220), (A)+(B143)+(B221), (A)+(B143)+(B222), (A)+(B143)+(B223), (A)+(B143)+(B224), (A)+(B143)+(B225), (A)+(B143)+(B226), (A)+(B143)+(B227), (A)+(B143)+(B228), (A)+(B143)+(B229), (A)+(B143)+(B230), (A)+(B143)+(B231), (A)+(B143)+(B232), (A)+(B143)+(B233), (A)+(B143)+(B234), (A)+(B143)+(B235), (A)+(B143)+(B236), (A)+(B143)+(B237), (A)+(B143)+(B238), (A)+(B143)+(B239), (A)+(B143)+(B240), (A)+(B143)+(B241), (A)+(B143)+(B242), (A)+(B143)+(B243), (A)+(B143)+(B244), (A)+(B143)+(B245), (A)+(B143)+(B246), (A)+(B143)+(B247), (A)+(B143)+(B248), (A)+(B143)+(B249), (A)+(B143)+(B250), (A)+(B143)+(B251), (A)+(B143)+(B252), (A)+(B143)+(B253), (A)+(B143)+(B254), (A)+(B143)+(B255), (A)+(B143)+(B256), (A)+(B143)+(B257), (A)+(B143)+(B258), (A)+(B143)+(B259), (A)+(B143)+(B260), (A)+(B143)+(B261), (A)+(B143)+(B262), (A)+(B143)+(B263), (A)+(B143)+(B264), (A)+(B143)+(B265), (A)+(B143)+(B266), (A)+(B143)+(B267), (A)+(B143)+(B268), (A)+(B143)+(B269), (A)+(B143)+(B270), (A)+(B143)+(B271), (A)+(B143)+(B272), (A)+(B143)+(B273), (A)+(B143)+(B274), (A)+(B143)+(B275), (A)+(B143)+(B276), (A)+(B143)+(B277), (A)+(B143)+(B278), (A)+(B143)+(B279), (A)+(B143)+(B280), (A)+(B143)+(B281), (A)+(B143)+(B282), (A)+(B143)+(B283), (A)+(B143)+(B284), (A)+(B143)+(B285), (A)+(B143)+(B286), (A)+(B143)+(B287), (A)+(B143)+(B288), (A)+(B143)+(B289), (A)+(B143)+(B290), (A)+(B143)+(B291), (A)+(B143)+(B292), (A)+(B143)+(B293), (A)+(B143)+(B294), (A)+(B143)+(B295), (A)+(B143)+(B296), (A)+(B143)+(B297), (A)+(B143)+(B298), (A)+(B143)+(B299), (A)+(B143)+(B300), (A)+(B143)+(B301), (A)+(B143)+(B302), (A)+(B143)+(B303), (A)+(B143)+(B304), (A)+(B143)+(B305), (A)+(B143)+(B306), (A)+(B143)+(B307), (A)+(B143)+(B308), (A)+(B143)+(B309), (A)+(B143)+(B310), (A)+(B143)+(B311), (A)+(B143)+(B312), (A)+(B143)+(B313), (A)+(B143)+(B314), (A)+(B143)+(B315),

(A)+(B144)+(B145), (A)+(B144)+(B146), (A)+(B144)+(B147), (A)+(B144)+(B148), (A)+(B144)+(B149), (A)+(B144)+(B150), (A)+(B144)+(B151), (A)+(B144)+(B152), (A)+(B144)+(B153), (A)+(B144)+(B154), (A)+(B144)+(B155), (A)+(B144)+(B156), (A)+(B144)+(B157), (A)+(B144)+(B158), (A)+(B144)+(B159), (A)+(B144)+(B160), (A)+(B144)+(B161), (A)+(B144)+(B162), (A)+(B144)+(B164), (A)+(B144)+(B164), (A)+(B144)+(B165), (A)+(B144)+(B166), (A)+(B144)+(B167), (A)+(B144)+(B168), (A)+(B144)+(B169), (A)+(B144)+(B170), (A)+(B144)+(B171), (A)+(B144)+(B172), (A)+(B144)+(B173), (A)+(B144)+(B174), (A)+(B144)+(B175), (A)+(B144)+(B176), (A)+(B144)+(B177), (A)+(B144)+(B178), (A)+(B144)+(B179), (A)+(B144)+(B180), (A)+(B144)+(B181), (A)+(B144)+(B182), (A)+(B144)+(B183), (A)+(B144)+(B184), (A)+(B144)+(B185), (A)+(B144)+(B186), (A)+(B144)+(B187), (A)+(B144)+(B188), (A)+(B144)+(B189), (A)+(B144)+(B190), (A)+(B144)+(B191), (A)+(B144)+(B192), (A)+(B144)+(B193), (A)+(B144)+(B194), (A)+(B144)+(B195), (A)+(B144)+(B196), (A)+(B144)+(B197), (A)+(B144)+(B198), (A)+(B144)+(B199), (A)+(B144)+(B200), (A)+(B144)+(B201), (A)+(B144)+(B202), (A)+(B144)+(B203), (A)+(B144)+(B204), (A)+(B144)+(B205), (A)+(B144)+(B206), (A)+(B144)+(B207), (A)+(B144)+(B208), (A)+(B144)+(B209), (A)+(B144)+(B210), (A)+(B144)+(B211), (A)+(B144)+(B212), (A)+(B144)+(B213), (A)+(B144)+(B214), (A)+(B144)+(B215), (A)+(B144)+(B216), (A)+(B144)+(B217), (A)+(B144)+(B218), (A)+(B144)+(B219), (A)+(B144)+(B220), (A)+(B144)+(B221), (A)+(B144)+(B222), (A)+(B144)+(B223), (A)+(B144)+(B224), (A)+(B144)+(B225), (A)+(B144)+(B226), (A)+(B144)+(B227), (A)+(B144)+(B228), (A)+(B144)+(B229), (A)+(B144)+(B230), (A)+(B144)+(B231), (A)+(B144)+(B232), (A)+(B144)+(B233), (A)+(B144)+(B234), (A)+(B144)+(B235), (A)+(B144)+(B236), (A)+(B144)+(B237), (A)+(B144)+(B238), (A)+(B144)+(B239), (A)+(B144)+(B240), (A)+(B144)+(B241), (A)+(B144)+(B242), (A)+(B144)+(B243), (A)+(B144)+(B244), (A)+(B144)+(B245), (A)+(B144)+(B246), (A)+(B144)+(B247), (A)+(B144)+(B248), (A)+(B144)+(B249), (A)+(B144)+(B250), (A)+(B144)+(B251), (A)+(B144)+(B252), (A)+(B144)+(B253), (A)+(B144)+(B254), (A)+(B144)+(B255), (A)+(B144)+(B256), (A)+(B144)+(B257), (A)+(B144)+(B258), (A)+(B144)+(B259), (A)+(B144)+(B260), (A)+(B144)+(B261), (A)+(B144)+(B262), (A)+(B144)+(B263), (A)+(B144)+(B264), (A)+(B144)+(B265), (A)+(B144)+(B266), (A)+(B144)+(B267), (A)+(B144)+(B268), (A)+(B144)+(B269), (A)+(B144)+(B270), (A)+(B144)+(B271), (A)+(B144)+(B272), (A)+(B144)+(B273), (A)+(B144)+(B274), (A)+(B144)+(B275), (A)+(B144)+(B276), (A)+(B144)+(B277), (A)+(B144)+(B278), (A)+(B144)+(B279), (A)+(B144)+(B280), (A)+(B144)+(B281), (A)+(B144)+(B282), (A)+(B144)+(B283), (A)+(B144)+(B284), (A)+(B144)+(B285), (A)+(B144)+(B286), (A)+(B144)+(B287), (A)+(B144)+(B288), (A)+(B144)+(B289), (A)+(B144)+(B290), (A)+(B144)+(B291), (A)+(B144)+(B292), (A)+(B144)+(B293), (A)+(B144)+(B294), (A)+(B144)+(B295), (A)+(B144)+(B296), (A)+(B144)+(B297), (A)+(B144)+(B298), (A)+(B144)+(B299), (A)+(B144)+(B300), (A)+(B144)+(B301), (A)+(B144)+(B302), (A)+(B144)+(B303), (A)+(B144)+(B304), (A)+(B144)+(B305), (A)+(B144)+(B306), (A)+(B144)+(B307), (A)+(B144)+(B308), (A)+(B144)+(B309), (A)+(B144)+(B310), (A)+(B144)+(B311), (A)+(B144)+(B312), (A)+(B144)+(B313), (A)+(B144)+(B314), (A)+(B144)+(B315),

(A)+(B145)+(B146), (A)+(B145)+(B147), (A)+(B145)+(B148), (A)+(B145)+(B149), (A)+(B145)+(B150), (A)+(B145)+(B151), (A)+(B145)+(B152), (A)+(B145)+(B153), (A)+(B145)+(B154), (A)+(B145)+(B155), (A)+(B145)+(B156), (A)+(B145)+(B157), (A)+(B145)+(B158), (A)+(B145)+(B159), (A)+(B145)+(B160), (A)+(B145)+(B161), (A)+(B145)+(B162), (A)+(B145)+(B164), (A)+(B145)+(B164), (A)+(B145)+(B165), (A)+(B145)+(B166), (A)+(B145)+(B167), (A)+(B145)+(B168), (A)+(B145)+(B169), (A)+(B145)+(B170), (A)+(B145)+(B171), (A)+(B145)+(B172), (A)+(B145)+(B173), (A)+(B145)+(B174), (A)+(B145)+(B175), (A)+(B145)+(B176), (A)+(B145)+(B177), (A)+(B145)+(B178), (A)+(B145)+(B179), (A)+(B145)+(B180), (A)+(B145)+(B181), (A)+(B145)+(B182), (A)+(B145)+(B183), (A)+(B145)+(B184), (A)+(B145)+(B185), (A)+(B145)+(B186), (A)+(B145)+(B187), (A)+(B145)+(B188), (A)+(B145)+(B189), (A)+(B145)+(B190), (A)+(B145)+(B191), (A)+(B145)+(B192), (A)+(B145)+(B193), (A)+(B145)+(B194), (A)+(B145)+(B195), (A)+(B145)+(B196), (A)+(B145)+(B197), (A)+(B145)+(B198), (A)+(B145)+(B199), (A)+(B145)+(B200), (A)+(B145)+(B201), (A)+(B145)+(B202), (A)+(B145)+(B203), (A)+(B145)+(B204), (A)+(B145)+(B205), (A)+(B145)+(B206), (A)+(B145)+(B207), (A)+(B145)+(B208), (A)+(B145)+(B209), (A)+(B145)+(B210), (A)+(B145)+(B211), (A)+(B145)+(B212), (A)+(B145)+(B213), (A)+(B145)+(B214), (A)+(B145)+(B215), (A)+(B145)+(B216), (A)+(B145)+(B217), (A)+(B145)+(B218), (A)+(B145)+(B219), (A)+(B145)+(B220), (A)+(B145)+(B221), (A)+(B145)+(B222), (A)+(B145)+(B223), (A)+(B145)+(B224), (A)+(B145)+(B225), (A)+(B145)+(B226), (A)+(B145)+(B227), (A)+(B145)+(B228), (A)+(B145)+(B229), (A)+(B145)+(B230), (A)+(B145)+(B231), (A)+(B145)+(B232), (A)+(B145)+(B233), (A)+(B145)+(B234), (A)+(B145)+(B235), (A)+(B145)+(B236), (A)+(B145)+(B237), (A)+(B145)+(B238), (A)+(B145)+(B239), (A)+(B145)+(B240), (A)+(B145)+(B241), (A)+(B145)+(B242), (A)+(B145)+(B243), (A)+(B145)+(B244), (A)+(B145)+(B245), (A)+(B145)+(B246), (A)+(B145)+(B247), (A)+(B145)+(B248), (A)+(B145)+(B249), (A)+(B145)+(B250), (A)+(B145)+(B251), (A)+(B145)+(B252), (A)+(B145)+(B253), (A)+(B145)+(B254), (A)+(B145)+(B255), (A)+(B145)+(B256), (A)+(B145)+(B257), (A)+(B145)+(B258), (A)+(B145)+(B259), (A)+(B145)+(B260), (A)+(B145)+(B261), (A)+(B145)+(B262), (A)+(B145)+(B263), (A)+(B145)+(B264), (A)+(B145)+(B265), (A)+(B145)+(B266), (A)+(B145)+(B267), (A)+(B145)+(B268), (A)+(B145)+(B269), (A)+(B145)+(B270), (A)+(B145)+(B271), (A)+(B145)+(B272), (A)+(B145)+(B273), (A)+(B145)+(B274), (A)+(B145)+(B275), (A)+(B145)+(B276), (A)+(B145)+(B277), (A)+(B145)+(B278), (A)+(B145)+(B279), (A)+(B145)+(B280), (A)+(B145)+(B281), (A)+(B145)+(B282), (A)+(B145)+(B283), (A)+(B145)+(B284), (A)+(B145)+(B285), (A)+(B145)+(B286), (A)+(B145)+(B287), (A)+(B145)+(B288), (A)+(B145)+(B289), (A)+(B145)+(B290), (A)+(B145)+(B291), (A)+(B145)+(B292), (A)+(B145)+(B293), (A)+(B145)+(B294), (A)+(B145)+(B295), (A)+(B145)+(B296), (A)+(B145)+(B297), (A)+(B145)+(B298), (A)+(B145)+(B299), (A)+(B145)+(B300), (A)+(B145)+(B301), (A)+(B145)+(B302), (A)+(B145)+(B303), (A)+(B145)+(B304), (A)+(B145)+(B305), (A)+(B145)+(B306), (A)+(B145)+(B307), (A)+(B145)+(B308), (A)+(B145)+(B309), (A)+(B145)+(B310), (A)+(B145)+(B311), (A)+(B145)+(B312), (A)+(B145)+(B313), (A)+(B145)+(B314), (A)+(B145)+(B315),

(A)+(B146)+(B147), (A)+(B146)+(B148), (A)+(B146)+(B149), (A)+(B146)+(B150), (A)+(B146)+(B151), (A)+(B146)+(B152), (A)+(B146)+(B153), (A)+(B146)+(B154), (A)+(B146)+(B155), (A)+(B146)+(B156), (A)+(B146)+(B157), (A)+(B146)+(B158), (A)+(B146)+(B159), (A)+(B146)+(B160), (A)+(B146)+(B161), (A)+(B146)+(B162), (A)+(B146)+(B164), (A)+(B146)+(B164), (A)+(B146)+(B165), (A)+(B146)+(B166), (A)+(B146)+(B167), (A)+(B146)+(B168), (A)+(B146)+(B169), (A)+(B146)+(B170), (A)+(B146)+(B171), (A)+(B146)+(B172), (A)+(B146)+(B173), (A)+(B146)+(B174), (A)+(B146)+(B175), (A)+(B146)+(B176), (A)+(B146)+(B177), (A)+(B146)+(B178), (A)+(B146)+(B179), (A)+(B146)+(B180), (A)+(B146)+(B181), (A)+(B146)+(B182), (A)+(B146)+(B183), (A)+(B146)+(B184), (A)+(B146)+(B185), (A)+(B146)+(B186), (A)+(B146)+(B187), (A)+(B146)+(B188), (A)+(B146)+(B189), (A)+(B146)+(B190), (A)+(B146)+(B191), (A)+(B146)+(B192), (A)+(B146)+(B193), (A)+(B146)+(B194), (A)+(B146)+(B195), (A)+(B146)+(B196), (A)+(B146)+(B197), (A)+(B146)+(B198), (A)+(B146)+(B199), (A)+(B146)+(B200), (A)+(B146)+(B201), (A)+(B146)+(B202), (A)+(B146)+(B203), (A)+(B146)+(B204), (A)+(B146)+(B205), (A)+(B146)+(B206), (A)+(B146)+(B207), (A)+(B146)+(B208), (A)+(B146)+(B209), (A)+(B146)+(B210), (A)+(B146)+(B211), (A)+(B146)+(B212), (A)+(B146)+(B213), (A)+(B146)+(B214), (A)+(B146)+(B215), (A)+(B146)+(B216), (A)+(B146)+(B217), (A)+(B146)+(B218), (A)+(B146)+(B219), (A)+(B146)+(B220), (A)+(B146)+(B221), (A)+(B146)+(B222), (A)+(B146)+(B223), (A)+(B146)+(B224), (A)+(B146)+(B225), (A)+(B146)+(B226), (A)+(B146)+(B227), (A)+(B146)+(B228), (A)+(B146)+(B229), (A)+(B146)+(B230), (A)+(B146)+(B231), (A)+(B146)+(B232), (A)+(B146)+(B233), (A)+(B146)+(B234), (A)+(B146)+(B235), (A)+(B146)+(B236), (A)+(B146)+(B237), (A)+(B146)+(B238), (A)+(B146)+(B239), (A)+(B146)+(B240), (A)+(B146)+(B241), (A)+(B146)+(B242), (A)+(B146)+(B243), (A)+(B146)+(B244), (A)+(B146)+(B245), (A)+(B146)+(B246), (A)+(B146)+(B247), (A)+(B146)+(B248), (A)+(B146)+(B249), (A)+(B146)+(B250), (A)+(B146)+(B251), (A)+(B146)+(B252), (A)+(B146)+(B253), (A)+(B146)+(B254), (A)+(B146)+(B255), (A)+(B146)+(B256), (A)+(B146)+(B257), (A)+(B146)+(B258), (A)+(B146)+(B259), (A)+(B146)+(B260), (A)+(B146)+(B261), (A)+(B146)+(B262), (A)+(B146)+(B263), (A)+(B146)+(B264), (A)+(B146)+(B265), (A)+(B146)+(B266), (A)+(B146)+(B267), (A)+(B146)+(B268), (A)+(B146)+(B269), (A)+(B146)+(B270), (A)+(B146)+(B271), (A)+(B146)+(B272), (A)+(B146)+(B273), (A)+(B146)+(B274), (A)+(B146)+(B275), (A)+(B146)+(B276), (A)+(B146)+(B277), (A)+(B146)+(B278), (A)+(B146)+(B279), (A)+(B146)+(B280), (A)+(B146)+(B281), (A)+(B146)+(B282), (A)+(B146)+(B283), (A)+(B146)+(B284), (A)+(B146)+(B285), (A)+(B146)+(B286), (A)+(B146)+(B287), (A)+(B146)+(B288), (A)+(B146)+(B289), (A)+(B146)+(B290), (A)+(B146)+(B291), (A)+(B146)+(B292), (A)+(B146)+(B293), (A)+(B146)+(B294), (A)+(B146)+(B295), (A)+(B146)+(B296), (A)+(B146)+(B297), (A)+(B146)+(B298), (A)+(B146)+(B299), (A)+(B146)+(B300), (A)+(B146)+(B301), (A)+(B146)+(B302), (A)+(B146)+(B303), (A)+(B146)+(B304), (A)+(B146)+(B305), (A)+(B146)+(B306), (A)+(B146)+(B307), (A)+(B146)+(B308), (A)+(B146)+(B309), (A)+(B146)+(B310), (A)+(B146)+(B311), (A)+(B146)+(B312), (A)+(B146)+(B313), (A)+(B146)+(B314), (A)+(B146)+(B315),

(A)+(B147)+(B148), (A)+(B147)+(B149), (A)+(B147)+(B150), (A)+(B147)+(B151), (A)+(B147)+(B152), (A)+(B147)+(B153), (A)+(B147)+(B154), (A)+(B147)+(B155), (A)+(B147)+(B156), (A)+(B147)+(B157), (A)+(B147)+(B158), (A)+(B147)+(B159), (A)+(B147)+(B160), (A)+(B147)+(B161), (A)+(B147)+(B162), (A)+(B147)+(B164), (A)+(B147)+(B164), (A)+(B147)+(B165), (A)+(B147)+(B166), (A)+(B147)+(B167), (A)+(B147)+(B168), (A)+(B147)+(B169), (A)+(B147)+(B170), (A)+(B147)+(B171), (A)+(B147)+(B172), (A)+(B147)+(B173), (A)+(B147)+(B174), (A)+(B147)+(B175), (A)+(B147)+(B176), (A)+(B147)+(B177), (A)+(B147)+(B178), (A)+(B147)+(B179), (A)+(B147)+(B180), (A)+(B147)+(B181), (A)+(B147)+(B182), (A)+(B147)+(B183), (A)+(B147)+(B184), (A)+(B147)+(B185), (A)+(B147)+(B186), (A)+(B147)+(B187), (A)+(B147)+(B188), (A)+(B147)+(B189), (A)+(B147)+(B190), (A)+(B147)+(B191), (A)+(B147)+(B192), (A)+(B147)+(B193), (A)+(B147)+(B194), (A)+(B147)+(B195), (A)+(B147)+(B196), (A)+(B147)+(B197), (A)+(B147)+(B198), (A)+(B147)+(B199), (A)+(B147)+(B200), (A)+(B147)+(B201), (A)+(B147)+(B202), (A)+(B147)+(B203), (A)+(B147)+(B204), (A)+(B147)+(B205), (A)+(B147)+(B206), (A)+(B147)+(B207), (A)+(B147)+(B208), (A)+(B147)+(B209), (A)+(B147)+(B210), (A)+(B147)+(B211), (A)+(B147)+(B212), (A)+(B147)+(B213), (A)+(B147)+(B214), (A)+(B147)+(B215), (A)+(B147)+(B216), (A)+(B147)+(B217), (A)+(B147)+(B218), (A)+(B147)+(B219), (A)+(B147)+(B220), (A)+(B147)+(B221), (A)+(B147)+(B222), (A)+(B147)+(B223), (A)+(B147)+(B224), (A)+(B147)+(B225), (A)+(B147)+(B226), (A)+(B147)+(B227), (A)+(B147)+(B228), (A)+(B147)+(B229), (A)+(B147)+(B230), (A)+(B147)+(B231), (A)+(B147)+(B232), (A)+(B147)+(B233), (A)+(B147)+(B234), (A)+(B147)+(B235), (A)+(B147)+(B236), (A)+(B147)+(B237), (A)+(B147)+(B238), (A)+(B147)+(B239), (A)+(B147)+(B240), (A)+(B147)+(B241), (A)+(B147)+(B242), (A)+(B147)+(B243), (A)+(B147)+(B244), (A)+(B147)+(B245), (A)+(B147)+(B246), (A)+(B147)+(B247), (A)+(B147)+(B248), (A)+(B147)+(B249), (A)+(B147)+(B250), (A)+(B147)+(B251), (A)+(B147)+(B252), (A)+(B147)+(B253), (A)+(B147)+(B254), (A)+(B147)+(B255), (A)+(B147)+(B256), (A)+(B147)+(B257), (A)+(B147)+(B258), (A)+(B147)+(B259), (A)+(B147)+(B260), (A)+(B147)+(B261), (A)+(B147)+(B262), (A)+(B147)+(B263), (A)+(B147)+(B264), (A)+(B147)+(B265), (A)+(B147)+(B266), (A)+(B147)+(B267), (A)+(B147)+(B268), (A)+(B147)+(B269), (A)+(B147)+(B270), (A)+(B147)+(B271), (A)+(B147)+(B272), (A)+(B147)+(B273), (A)+(B147)+(B274), (A)+(B147)+(B275), (A)+(B147)+(B276), (A)+(B147)+(B277), (A)+(B147)+(B278), (A)+(B147)+(B279), (A)+(B147)+(B280), (A)+(B147)+(B281), (A)+(B147)+(B282), (A)+(B147)+(B283), (A)+(B147)+(B284), (A)+(B147)+(B285), (A)+(B147)+(B286), (A)+(B147)+(B287), (A)+(B147)+(B288), (A)+(B147)+(B289), (A)+(B147)+(B290), (A)+(B147)+(B291), (A)+(B147)+(B292), (A)+(B147)+(B293), (A)+(B147)+(B294), (A)+(B147)+(B295), (A)+(B147)+(B296), (A)+(B147)+(B297), (A)+(B147)+(B298), (A)+(B147)+(B299), (A)+(B147)+(B300), (A)+(B147)+(B301), (A)+(B147)+(B302), (A)+(B147)+(B303), (A)+(B147)+(B304), (A)+(B147)+(B305), (A)+(B147)+(B306), (A)+(B147)+(B307), (A)+(B147)+(B308), (A)+(B147)+(B309), (A)+(B147)+(B310), (A)+(B147)+(B311), (A)+(B147)+(B312), (A)+(B147)+(B313), (A)+(B147)+(B314), (A)+(B147)+(B315),

(A)+(B148)+(B149), (A)+(B148)+(B150), (A)+(B148)+(B151), (A)+(B148)+(B152), (A)+(B148)+(B153), (A)+(B148)+(B154), (A)+(B148)+(B155), (A)+(B148)+(B156), (A)+(B148)+(B157), (A)+(B148)+(B158), (A)+(B148)+(B159), (A)+(B148)+(B160), (A)+(B148)+(B161), (A)+(B148)+(B162), (A)+(B148)+(B164), (A)+(B148)+(B164), (A)+(B148)+(B165), (A)+(B148)+(B166), (A)+(B148)+(B167), (A)+(B148)+(B168), (A)+(B148)+(B169), (A)+(B148)+(B170), (A)+(B148)+(B171), (A)+(B148)+(B172), (A)+(B148)+(B173), (A)+(B148)+(B174), (A)+(B148)+(B175), (A)+(B148)+(B176), (A)+(B148)+(B177), (A)+(B148)+(B178), (A)+(B148)+(B179), (A)+(B148)+(B180), (A)+(B148)+(B181), (A)+(B148)+(B182), (A)+(B148)+(B183), (A)+(B148)+(B184), (A)+(B148)+(B185), (A)+(B148)+(B186), (A)+(B148)+(B187), (A)+(B148)+(B188), (A)+(B148)+(B189), (A)+(B148)+(B190), (A)+(B148)+(B191), (A)+(B148)+(B192), (A)+(B148)+(B193), (A)+(B148)+(B194), (A)+(B148)+(B195), (A)+(B148)+(B196), (A)+(B148)+(B197), (A)+(B148)+(B198), (A)+(B148)+(B199), (A)+(B148)+(B200), (A)+(B148)+(B201), (A)+(B148)+(B202), (A)+(B148)+(B203), (A)+(B148)+(B204), (A)+(B148)+(B205), (A)+(B148)+(B206), (A)+(B148)+(B207), (A)+(B148)+(B208), (A)+(B148)+(B209), (A)+(B148)+(B210), (A)+(B148)+(B211), (A)+(B148)+(B212), (A)+(B148)+(B213), (A)+(B148)+(B214), (A)+(B148)+(B215), (A)+(B148)+(B216), (A)+(B148)+(B217), (A)+(B148)+(B218), (A)+(B148)+(B219), (A)+(B148)+(B220), (A)+(B148)+(B221), (A)+(B148)+(B222), (A)+(B148)+(B223), (A)+(B148)+(B224), (A)+(B148)+(B225), (A)+(B148)+(B226), (A)+(B148)+(B227), (A)+(B148)+(B228), (A)+(B148)+(B229), (A)+(B148)+(B230), (A)+(B148)+(B231), (A)+(B148)+(B232), (A)+(B148)+(B233), (A)+(B148)+(B234), (A)+(B148)+(B235), (A)+(B148)+(B236), (A)+(B148)+(B237), (A)+(B148)+(B238), (A)+(B148)+(B239), (A)+(B148)+(B240), (A)+(B148)+(B241), (A)+(B148)+(B242), (A)+(B148)+(B243), (A)+(B148)+(B244), (A)+(B148)+(B245), (A)+(B148)+(B246), (A)+(B148)+(B247), (A)+(B148)+(B248), (A)+(B148)+(B249), (A)+(B148)+(B250), (A)+(B148)+(B251), (A)+(B148)+(B252), (A)+(B148)+(B253), (A)+(B148)+(B254), (A)+(B148)+(B255), (A)+(B148)+(B256), (A)+(B148)+(B257), (A)+(B148)+(B258), (A)+(B148)+(B259), (A)+(B148)+(B260), (A)+(B148)+(B261), (A)+(B148)+(B262), (A)+(B148)+(B263), (A)+(B148)+(B264), (A)+(B148)+(B265), (A)+(B148)+(B266), (A)+(B148)+(B267), (A)+(B148)+(B268), (A)+(B148)+(B269), (A)+(B148)+(B270), (A)+(B148)+(B271), (A)+(B148)+(B272), (A)+(B148)+(B273), (A)+(B148)+(B274), (A)+(B148)+(B275), (A)+(B148)+(B276), (A)+(B148)+(B277), (A)+(B148)+(B278), (A)+(B148)+(B279), (A)+(B148)+(B280), (A)+(B148)+(B281), (A)+(B148)+(B282), (A)+(B148)+(B283), (A)+(B148)+(B284), (A)+(B148)+(B285), (A)+(B148)+(B286), (A)+(B148)+(B287), (A)+(B148)+(B288), (A)+(B148)+(B289), (A)+(B148)+(B290), (A)+(B148)+(B291), (A)+(B148)+(B292), (A)+(B148)+(B293), (A)+(B148)+(B294), (A)+(B148)+(B295), (A)+(B148)+(B296), (A)+(B148)+(B297), (A)+(B148)+(B298), (A)+(B148)+(B299), (A)+(B148)+(B300), (A)+(B148)+(B301), (A)+(B148)+(B302), (A)+(B148)+(B303), (A)+(B148)+(B304), (A)+(B148)+(B305), (A)+(B148)+(B306), (A)+(B148)+(B307), (A)+(B148)+(B308), (A)+(B148)+(B309), (A)+(B148)+(B310), (A)+(B148)+(B311), (A)+(B148)+(B312), (A)+(B148)+(B313), (A)+(B148)+(B314), (A)+(B148)+(B315),

(A)+(B149)+(B150), (A)+(B149)+(B151), (A)+(B149)+(B152), (A)+(B149)+(B153), (A)+(B149)+(B154), (A)+(B149)+(B155), (A)+(B149)+(B156), (A)+(B149)+(B157), (A)+(B149)+(B158), (A)+(B149)+(B159), (A)+(B149)+(B160), (A)+(B149)+(B161), (A)+(B149)+(B162), (A)+(B149)+(B164), (A)+(B149)+(B164), (A)+(B149)+(B165), (A)+(B149)+(B166), (A)+(B149)+(B167), (A)+(B149)+(B168), (A)+(B149)+(B169), (A)+(B149)+(B170), (A)+(B149)+(B171), (A)+(B149)+(B172), (A)+(B149)+(B173), (A)+(B149)+(B174), (A)+(B149)+(B175), (A)+(B149)+(B176), (A)+(B149)+(B177), (A)+(B149)+(B178), (A)+(B149)+(B179), (A)+(B149)+(B180), (A)+(B149)+(B181), (A)+(B149)+(B182), (A)+(B149)+(B183), (A)+(B149)+(B184), (A)+(B149)+(B185), (A)+(B149)+(B186), (A)+(B149)+(B187), (A)+(B149)+(B188), (A)+(B149)+(B189), (A)+(B149)+(B190), (A)+(B149)+(B191), (A)+(B149)+(B192), (A)+(B149)+(B193), (A)+(B149)+(B194), (A)+(B149)+(B195), (A)+(B149)+(B196), (A)+(B149)+(B197), (A)+(B149)+(B198), (A)+(B149)+(B199), (A)+(B149)+(B200), (A)+(B149)+(B201), (A)+(B149)+(B202), (A)+(B149)+(B203), (A)+(B149)+(B204), (A)+(B149)+(B205), (A)+(B149)+(B206), (A)+(B149)+(B207), (A)+(B149)+(B208), (A)+(B149)+(B209), (A)+(B149)+(B210), (A)+(B149)+(B211), (A)+(B149)+(B212), (A)+(B149)+(B213), (A)+(B149)+(B214), (A)+(B149)+(B215), (A)+(B149)+(B216), (A)+(B149)+(B217), (A)+(B149)+(B218), (A)+(B149)+(B219), (A)+(B149)+(B220), (A)+(B149)+(B221), (A)+(B149)+(B222), (A)+(B149)+(B223), (A)+(B149)+(B224), (A)+(B149)+(B225), (A)+(B149)+(B226), (A)+(B149)+(B227), (A)+(B149)+(B228), (A)+(B149)+(B229), (A)+(B149)+(B230), (A)+(B149)+(B231), (A)+(B149)+(B232), (A)+(B149)+(B233), (A)+(B149)+(B234), (A)+(B149)+(B235), (A)+(B149)+(B236), (A)+(B149)+(B237), (A)+(B149)+(B238), (A)+(B149)+(B239), (A)+(B149)+(B240), (A)+(B149)+(B241), (A)+(B149)+(B242), (A)+(B149)+(B243), (A)+(B149)+(B244), (A)+(B149)+(B245), (A)+(B149)+(B246), (A)+(B149)+(B247), (A)+(B149)+(B248), (A)+(B149)+(B249), (A)+(B149)+(B250), (A)+(B149)+(B251), (A)+(B149)+(B252), (A)+(B149)+(B253), (A)+(B149)+(B254), (A)+(B149)+(B255), (A)+(B149)+(B256), (A)+(B149)+(B257), (A)+(B149)+(B258), (A)+(B149)+(B259), (A)+(B149)+(B260), (A)+(B149)+(B261), (A)+(B149)+(B262), (A)+(B149)+(B263), (A)+(B149)+(B264), (A)+(B149)+(B265), (A)+(B149)+(B266), (A)+(B149)+(B267), (A)+(B149)+(B268), (A)+(B149)+(B269), (A)+(B149)+(B270), (A)+(B149)+(B271), (A)+(B149)+(B272), (A)+(B149)+(B273), (A)+(B149)+(B274), (A)+(B149)+(B275), (A)+(B149)+(B276), (A)+(B149)+(B277), (A)+(B149)+(B278), (A)+(B149)+(B279), (A)+(B149)+(B280), (A)+(B149)+(B281), (A)+(B149)+(B282), (A)+(B149)+(B283), (A)+(B149)+(B284), (A)+(B149)+(B285), (A)+(B149)+(B286), (A)+(B149)+(B287), (A)+(B149)+(B288), (A)+(B149)+(B289), (A)+(B149)+(B290), (A)+(B149)+(B291), (A)+(B149)+(B292), (A)+(B149)+(B293), (A)+(B149)+(B294), (A)+(B149)+(B295), (A)+(B149)+(B296), (A)+(B149)+(B297), (A)+(B149)+(B298), (A)+(B149)+(B299), (A)+(B149)+(B300), (A)+(B149)+(B301), (A)+(B149)+(B302), (A)+(B149)+(B303), (A)+(B149)+(B304), (A)+(B149)+(B305), (A)+(B149)+(B306), (A)+(B149)+(B307), (A)+(B149)+(B308), (A)+(B149)+(B309), (A)+(B149)+(B310), (A)+(B149)+(B311), (A)+(B149)+(B312), (A)+(B149)+(B313), (A)+(B149)+(B314), (A)+(B149)+(B315),

(A)+(B150)+(B151), (A)+(B150)+(B152), (A)+(B150)+(B153), (A)+(B150)+(B154), (A)+(B150)+(B155), (A)+(B150)+(B156), (A)+(B150)+(B157), (A)+(B150)+(B158), (A)+(B150)+(B159), (A)+(B150)+(B160), (A)+(B150)+(B161), (A)+(B150)+(B162), (A)+(B150)+(B164), (A)+(B150)+(B164), (A)+(B150)+(B165), (A)+(B150)+(B166), (A)+(B150)+(B167), (A)+(B150)+(B168), (A)+(B150)+(B169), (A)+(B150)+(B170), (A)+(B150)+(B171), (A)+(B150)+(B172), (A)+(B150)+(B173), (A)+(B150)+(B174), (A)+(B150)+(B175), (A)+(B150)+(B176), (A)+(B150)+(B177), (A)+(B150)+(B178), (A)+(B150)+(B179), (A)+(B150)+(B180), (A)+(B150)+(B181), (A)+(B150)+(B182), (A)+(B150)+(B183), (A)+(B150)+(B184), (A)+(B150)+(B185), (A)+(B150)+(B186), (A)+(B150)+(B187), (A)+(B150)+(B188), (A)+(B150)+(B189), (A)+(B150)+(B190), (A)+(B150)+(B191), (A)+(B150)+(B192), (A)+(B150)+(B193), (A)+(B150)+(B194), (A)+(B150)+(B195), (A)+(B150)+(B196), (A)+(B150)+(B197), (A)+(B150)+(B198), (A)+(B150)+(B199), (A)+(B150)+(B200), (A)+(B150)+(B201), (A)+(B150)+(B202), (A)+(B150)+(B203), (A)+(B150)+(B204), (A)+(B150)+(B205), (A)+(B150)+(B206), (A)+(B150)+(B207), (A)+(B150)+(B208), (A)+(B150)+(B209), (A)+(B150)+(B210), (A)+(B150)+(B211), (A)+(B150)+(B212), (A)+(B150)+(B213), (A)+(B150)+(B214), (A)+(B150)+(B215), (A)+(B150)+(B216), (A)+(B150)+(B217), (A)+(B150)+(B218), (A)+(B150)+(B219), (A)+(B150)+(B220), (A)+(B150)+(B221), (A)+(B150)+(B222), (A)+(B150)+(B223), (A)+(B150)+(B224), (A)+(B150)+(B225), (A)+(B150)+(B226), (A)+(B150)+(B227), (A)+(B150)+(B228), (A)+(B150)+(B229), (A)+(B150)+(B230), (A)+(B150)+(B231), (A)+(B150)+(B232), (A)+(B150)+(B233), (A)+(B150)+(B234), (A)+(B150)+(B235), (A)+(B150)+(B236), (A)+(B150)+(B237), (A)+(B150)+(B238), (A)+(B150)+(B239), (A)+(B150)+(B240), (A)+(B150)+(B241), (A)+(B150)+(B242), (A)+(B150)+(B243), (A)+(B150)+(B244), (A)+(B150)+(B245), (A)+(B150)+(B246), (A)+(B150)+(B247), (A)+(B150)+(B248), (A)+(B150)+(B249), (A)+(B150)+(B250), (A)+(B150)+(B251), (A)+(B150)+(B252), (A)+(B150)+(B253), (A)+(B150)+(B254), (A)+(B150)+(B255), (A)+(B150)+(B256), (A)+(B150)+(B257), (A)+(B150)+(B258), (A)+(B150)+(B259), (A)+(B150)+(B260), (A)+(B150)+(B261), (A)+(B150)+(B262), (A)+(B150)+(B263), (A)+(B150)+(B264), (A)+(B150)+(B265), (A)+(B150)+(B266), (A)+(B150)+(B267), (A)+(B150)+(B268), (A)+(B150)+(B269), (A)+(B150)+(B270), (A)+(B150)+(B271), (A)+(B150)+(B272), (A)+(B150)+(B273), (A)+(B150)+(B274), (A)+(B150)+(B275), (A)+(B150)+(B276), (A)+(B150)+(B277), (A)+(B150)+(B278), (A)+(B150)+(B279), (A)+(B150)+(B280), (A)+(B150)+(B281), (A)+(B150)+(B282), (A)+(B150)+(B283), (A)+(B150)+(B284), (A)+(B150)+(B285), (A)+(B150)+(B286), (A)+(B150)+(B287), (A)+(B150)+(B288), (A)+(B150)+(B289), (A)+(B150)+(B290), (A)+(B150)+(B291), (A)+(B150)+(B292), (A)+(B150)+(B293), (A)+(B150)+(B294), (A)+(B150)+(B295), (A)+(B150)+(B296), (A)+(B150)+(B297), (A)+(B150)+(B298), (A)+(B150)+(B299), (A)+(B150)+(B300), (A)+(B150)+(B301), (A)+(B150)+(B302), (A)+(B150)+(B303), (A)+(B150)+(B304), (A)+(B150)+(B305), (A)+(B150)+(B306), (A)+(B150)+(B307), (A)+(B150)+(B308), (A)+(B150)+(B309), (A)+(B150)+(B310), (A)+(B150)+(B311), (A)+(B150)+(B312), (A)+(B150)+(B313), (A)+(B150)+(B314), (A)+(B150)+(B315),

(A)+(B151)+(B152), (A)+(B151)+(B153), (A)+(B151)+(B154), (A)+(B151)+(B155), (A)+(B151)+(B156), (A)+(B151)+(B157), (A)+(B151)+(B158), (A)+(B151)+(B159), (A)+(B151)+(B160), (A)+(B151)+(B161), (A)+(B151)+(B162), (A)+(B151)+(B164), (A)+(B151)+(B164), (A)+(B151)+(B165), (A)+(B151)+(B166), (A)+(B151)+(B167), (A)+(B151)+(B168), (A)+(B151)+(B169), (A)+(B151)+(B170), (A)+(B151)+(B171), (A)+(B151)+(B172), (A)+(B151)+(B173), (A)+(B151)+(B174), (A)+(B151)+(B175), (A)+(B151)+(B176), (A)+(B151)+(B177), (A)+(B151)+(B178), (A)+(B151)+(B179), (A)+(B151)+(B180), (A)+(B151)+(B181), (A)+(B151)+(B182), (A)+(B151)+(B183), (A)+(B151)+(B184), (A)+(B151)+(B185), (A)+(B151)+(B186), (A)+(B151)+(B187), (A)+(B151)+(B188), (A)+(B151)+(B189), (A)+(B151)+(B190), (A)+(B151)+(B191), (A)+(B151)+(B192), (A)+(B151)+(B193), (A)+(B151)+(B194), (A)+(B151)+(B195), (A)+(B151)+(B196), (A)+(B151)+(B197), (A)+(B151)+(B198), (A)+(B151)+(B199), (A)+(B151)+(B200), (A)+(B151)+(B201), (A)+(B151)+(B202), (A)+(B151)+(B203), (A)+(B151)+(B204), (A)+(B151)+(B205), (A)+(B151)+(B206), (A)+(B151)+(B207), (A)+(B151)+(B208), (A)+(B151)+(B209), (A)+(B151)+(B210), (A)+(B151)+(B211), (A)+(B151)+(B212), (A)+(B151)+(B213), (A)+(B151)+(B214), (A)+(B151)+(B215), (A)+(B151)+(B216), (A)+(B151)+(B217), (A)+(B151)+(B218), (A)+(B151)+(B219), (A)+(B151)+(B220), (A)+(B151)+(B221), (A)+(B151)+(B222), (A)+(B151)+(B223), (A)+(B151)+(B224), (A)+(B151)+(B225), (A)+(B151)+(B226), (A)+(B151)+(B227), (A)+(B151)+(B228), (A)+(B151)+(B229), (A)+(B151)+(B230), (A)+(B151)+(B231), (A)+(B151)+(B232), (A)+(B151)+(B233), (A)+(B151)+(B234), (A)+(B151)+(B235), (A)+(B151)+(B236), (A)+(B151)+(B237), (A)+(B151)+(B238), (A)+(B151)+(B239), (A)+(B151)+(B240), (A)+(B151)+(B241), (A)+(B151)+(B242), (A)+(B151)+(B243), (A)+(B151)+(B244), (A)+(B151)+(B245), (A)+(B151)+(B246), (A)+(B151)+(B247), (A)+(B151)+(B248), (A)+(B151)+(B249), (A)+(B151)+(B250), (A)+(B151)+(B251), (A)+(B151)+(B252), (A)+(B151)+(B253), (A)+(B151)+(B254), (A)+(B151)+(B255), (A)+(B151)+(B256), (A)+(B151)+(B257), (A)+(B151)+(B258), (A)+(B151)+(B259), (A)+(B151)+(B260), (A)+(B151)+(B261), (A)+(B151)+(B262), (A)+(B151)+(B263), (A)+(B151)+(B264), (A)+(B151)+(B265), (A)+(B151)+(B266), (A)+(B151)+(B267), (A)+(B151)+(B268), (A)+(B151)+(B269), (A)+(B151)+(B270), (A)+(B151)+(B271), (A)+(B151)+(B272), (A)+(B151)+(B273), (A)+(B151)+(B274), (A)+(B151)+(B275), (A)+(B151)+(B276), (A)+(B151)+(B277), (A)+(B151)+(B278), (A)+(B151)+(B279), (A)+(B151)+(B280), (A)+(B151)+(B281), (A)+(B151)+(B282), (A)+(B151)+(B283), (A)+(B151)+(B284), (A)+(B151)+(B285), (A)+(B151)+(B286), (A)+(B151)+(B287), (A)+(B151)+(B288), (A)+(B151)+(B289), (A)+(B151)+(B290), (A)+(B151)+(B291), (A)+(B151)+(B292), (A)+(B151)+(B293), (A)+(B151)+(B294), (A)+(B151)+(B295), (A)+(B151)+(B296), (A)+(B151)+(B297), (A)+(B151)+(B298), (A)+(B151)+(B299), (A)+(B151)+(B300), (A)+(B151)+(B301), (A)+(B151)+(B302), (A)+(B151)+(B303), (A)+(B151)+(B304), (A)+(B151)+(B305), (A)+(B151)+(B306), (A)+(B151)+(B307), (A)+(B151)+(B308), (A)+(B151)+(B309), (A)+(B151)+(B310), (A)+(B151)+(B311), (A)+(B151)+(B312), (A)+(B151)+(B313), (A)+(B151)+(B314), (A)+(B151)+(B315),

(A)+(B152)+(B153), (A)+(B152)+(B154), (A)+(B152)+(B155), (A)+(B152)+(B156), (A)+(B152)+(B157), (A)+(B152)+(B158), (A)+(B152)+(B159), (A)+(B152)+(B160), (A)+(B152)+(B161), (A)+(B152)+(B162), (A)+(B152)+(B164), (A)+(B152)+(B164), (A)+(B152)+(B165), (A)+(B152)+(B166), (A)+(B152)+(B167), (A)+(B152)+(B168), (A)+(B152)+(B169), (A)+(B152)+(B170), (A)+(B152)+(B171), (A)+(B152)+(B172), (A)+(B152)+(B173), (A)+(B152)+(B174), (A)+(B152)+(B175), (A)+(B152)+(B176), (A)+(B152)+(B177), (A)+(B152)+(B178), (A)+(B152)+(B179), (A)+(B152)+(B180), (A)+(B152)+(B181), (A)+(B152)+(B182), (A)+(B152)+(B183), (A)+(B152)+(B184), (A)+(B152)+(B185), (A)+(B152)+(B186), (A)+(B152)+(B187), (A)+(B152)+(B188), (A)+(B152)+(B189), (A)+(B152)+(B190), (A)+(B152)+(B191), (A)+(B152)+(B192), (A)+(B152)+(B193), (A)+(B152)+(B194), (A)+(B152)+(B195), (A)+(B152)+(B196), (A)+(B152)+(B197), (A)+(B152)+(B198), (A)+(B152)+(B199), (A)+(B152)+(B200), (A)+(B152)+(B201), (A)+(B152)+(B202), (A)+(B152)+(B203), (A)+(B152)+(B204), (A)+(B152)+(B205), (A)+(B152)+(B206), (A)+(B152)+(B207), (A)+(B152)+(B208), (A)+(B152)+(B209), (A)+(B152)+(B210), (A)+(B152)+(B211), (A)+(B152)+(B212), (A)+(B152)+(B213), (A)+(B152)+(B214), (A)+(B152)+(B215), (A)+(B152)+(B216), (A)+(B152)+(B217), (A)+(B152)+(B218), (A)+(B152)+(B219), (A)+(B152)+(B220), (A)+(B152)+(B221), (A)+(B152)+(B222), (A)+(B152)+(B223), (A)+(B152)+(B224), (A)+(B152)+(B225), (A)+(B152)+(B226), (A)+(B152)+(B227), (A)+(B152)+(B228), (A)+(B152)+(B229), (A)+(B152)+(B230), (A)+(B152)+(B231), (A)+(B152)+(B232), (A)+(B152)+(B233), (A)+(B152)+(B234), (A)+(B152)+(B235), (A)+(B152)+(B236), (A)+(B152)+(B237), (A)+(B152)+(B238), (A)+(B152)+(B239), (A)+(B152)+(B240), (A)+(B152)+(B241), (A)+(B152)+(B242), (A)+(B152)+(B243), (A)+(B152)+(B244), (A)+(B152)+(B245), (A)+(B152)+(B246), (A)+(B152)+(B247), (A)+(B152)+(B248), (A)+(B152)+(B249), (A)+(B152)+(B250), (A)+(B152)+(B251), (A)+(B152)+(B252), (A)+(B152)+(B253), (A)+(B152)+(B254), (A)+(B152)+(B255), (A)+(B152)+(B256), (A)+(B152)+(B257), (A)+(B152)+(B258), (A)+(B152)+(B259), (A)+(B152)+(B260), (A)+(B152)+(B261), (A)+(B152)+(B262), (A)+(B152)+(B263), (A)+(B152)+(B264), (A)+(B152)+(B265), (A)+(B152)+(B266), (A)+(B152)+(B267), (A)+(B152)+(B268), (A)+(B152)+(B269), (A)+(B152)+(B270), (A)+(B152)+(B271), (A)+(B152)+(B272), (A)+(B152)+(B273), (A)+(B152)+(B274), (A)+(B152)+(B275), (A)+(B152)+(B276), (A)+(B152)+(B277), (A)+(B152)+(B278), (A)+(B152)+(B279), (A)+(B152)+(B280), (A)+(B152)+(B281), (A)+(B152)+(B282), (A)+(B152)+(B283), (A)+(B152)+(B284), (A)+(B152)+(B285), (A)+(B152)+(B286), (A)+(B152)+(B287), (A)+(B152)+(B288), (A)+(B152)+(B289), (A)+(B152)+(B290), (A)+(B152)+(B291), (A)+(B152)+(B292), (A)+(B152)+(B293), (A)+(B152)+(B294), (A)+(B152)+(B295), (A)+(B152)+(B296), (A)+(B152)+(B297), (A)+(B152)+(B298), (A)+(B152)+(B299), (A)+(B152)+(B300), (A)+(B152)+(B301), (A)+(B152)+(B302), (A)+(B152)+(B303), (A)+(B152)+(B304), (A)+(B152)+(B305), (A)+(B152)+(B306), (A)+(B152)+(B307), (A)+(B152)+(B308), (A)+(B152)+(B309), (A)+(B152)+(B310), (A)+(B152)+(B311), (A)+(B152)+(B312), (A)+(B152)+(B313), (A)+(B152)+(B314), (A)+(B152)+(B315),

(A)+(B153)+(B154), (A)+(B153)+(B155), (A)+(B153)+(B156), (A)+(B153)+(B157), (A)+(B153)+(B158), (A)+(B153)+(B159), (A)+(B153)+(B160), (A)+(B153)+(B161), (A)+(B153)+(B162), (A)+(B153)+(B164), (A)+(B153)+(B164), (A)+(B153)+(B165), (A)+(B153)+(B166), (A)+(B153)+(B167), (A)+(B153)+(B168), (A)+(B153)+(B169), (A)+(B153)+(B170), (A)+(B153)+(B171), (A)+(B153)+(B172), (A)+(B153)+(B173), (A)+(B153)+(B174), (A)+(B153)+(B175), (A)+(B153)+(B176), (A)+(B153)+(B177), (A)+(B153)+(B178), (A)+(B153)+(B179), (A)+(B153)+(B180), (A)+(B153)+(B181), (A)+(B153)+(B182), (A)+(B153)+(B183), (A)+(B153)+(B184), (A)+(B153)+(B185), (A)+(B153)+(B186), (A)+(B153)+(B187), (A)+(B153)+(B188), (A)+(B153)+(B189), (A)+(B153)+(B190), (A)+(B153)+(B191), (A)+(B153)+(B192), (A)+(B153)+(B193), (A)+(B153)+(B194), (A)+(B153)+(B195), (A)+(B153)+(B196), (A)+(B153)+(B197), (A)+(B153)+(B198), (A)+(B153)+(B199), (A)+(B153)+(B200), (A)+(B153)+(B201), (A)+(B153)+(B202), (A)+(B153)+(B203), (A)+(B153)+(B204), (A)+(B153)+(B205), (A)+(B153)+(B206), (A)+(B153)+(B207), (A)+(B153)+(B208), (A)+(B153)+(B209), (A)+(B153)+(B210), (A)+(B153)+(B211), (A)+(B153)+(B212), (A)+(B153)+(B213), (A)+(B153)+(B214), (A)+(B153)+(B215), (A)+(B153)+(B216), (A)+(B153)+(B217), (A)+(B153)+(B218), (A)+(B153)+(B219), (A)+(B153)+(B220), (A)+(B153)+(B221), (A)+(B153)+(B222), (A)+(B153)+(B223), (A)+(B153)+(B224), (A)+(B153)+(B225), (A)+(B153)+(B226), (A)+(B153)+(B227), (A)+(B153)+(B228), (A)+(B153)+(B229), (A)+(B153)+(B230), (A)+(B153)+(B231), (A)+(B153)+(B232), (A)+(B153)+(B233), (A)+(B153)+(B234), (A)+(B153)+(B235), (A)+(B153)+(B236), (A)+(B153)+(B237), (A)+(B153)+(B238), (A)+(B153)+(B239), (A)+(B153)+(B240), (A)+(B153)+(B241), (A)+(B153)+(B242), (A)+(B153)+(B243), (A)+(B153)+(B244), (A)+(B153)+(B245), (A)+(B153)+(B246), (A)+(B153)+(B247), (A)+(B153)+(B248), (A)+(B153)+(B249), (A)+(B153)+(B250), (A)+(B153)+(B251), (A)+(B153)+(B252), (A)+(B153)+(B253), (A)+(B153)+(B254), (A)+(B153)+(B255), (A)+(B153)+(B256), (A)+(B153)+(B257), (A)+(B153)+(B258), (A)+(B153)+(B259), (A)+(B153)+(B260), (A)+(B153)+(B261), (A)+(B153)+(B262), (A)+(B153)+(B263), (A)+(B153)+(B264), (A)+(B153)+(B265), (A)+(B153)+(B266), (A)+(B153)+(B267), (A)+(B153)+(B268), (A)+(B153)+(B269), (A)+(B153)+(B270), (A)+(B153)+(B271), (A)+(B153)+(B272), (A)+(B153)+(B273), (A)+(B153)+(B274), (A)+(B153)+(B275), (A)+(B153)+(B276), (A)+(B153)+(B277), (A)+(B153)+(B278), (A)+(B153)+(B279), (A)+(B153)+(B280), (A)+(B153)+(B281), (A)+(B153)+(B282), (A)+(B153)+(B283), (A)+(B153)+(B284), (A)+(B153)+(B285), (A)+(B153)+(B286), (A)+(B153)+(B287), (A)+(B153)+(B288), (A)+(B153)+(B289), (A)+(B153)+(B290), (A)+(B153)+(B291), (A)+(B153)+(B292), (A)+(B153)+(B293), (A)+(B153)+(B294), (A)+(B153)+(B295), (A)+(B153)+(B296), (A)+(B153)+(B297), (A)+(B153)+(B298), (A)+(B153)+(B299), (A)+(B153)+(B300), (A)+(B153)+(B301), (A)+(B153)+(B302), (A)+(B153)+(B303), (A)+(B153)+(B304), (A)+(B153)+(B305), (A)+(B153)+(B306), (A)+(B153)+(B307), (A)+(B153)+(B308), (A)+(B153)+(B309), (A)+(B153)+(B310), (A)+(B153)+(B311), (A)+(B153)+(B312), (A)+(B153)+(B313), (A)+(B153)+(B314), (A)+(B153)+(B315),

(A)+(B154)+(B155), (A)+(B154)+(B156), (A)+(B154)+(B157), (A)+(B154)+(B158), (A)+(B154)+(B159), (A)+(B154)+(B160), (A)+(B154)+(B161), (A)+(B154)+(B162), (A)+(B154)+(B164), (A)+(B154)+(B164), (A)+(B154)+(B165), (A)+(B154)+(B166), (A)+(B154)+(B167), (A)+(B154)+(B168), (A)+(B154)+(B169), (A)+(B154)+(B170), (A)+(B154)+(B171), (A)+(B154)+(B172), (A)+(B154)+(B173), (A)+(B154)+(B174), (A)+(B154)+(B175), (A)+(B154)+(B176), (A)+(B154)+(B177), (A)+(B154)+(B178), (A)+(B154)+(B179), (A)+(B154)+(B180), (A)+(B154)+(B181), (A)+(B154)+(B182), (A)+(B154)+(B183), (A)+(B154)+(B184), (A)+(B154)+(B185), (A)+(B154)+(B186), (A)+(B154)+(B187), (A)+(B154)+(B188), (A)+(B154)+(B189), (A)+(B154)+(B190), (A)+(B154)+(B191), (A)+(B154)+(B192), (A)+(B154)+(B193), (A)+(B154)+(B194), (A)+(B154)+(B195), (A)+(B154)+(B196), (A)+(B154)+(B197), (A)+(B154)+(B198), (A)+(B154)+(B199), (A)+(B154)+(B200), (A)+(B154)+(B201), (A)+(B154)+(B202), (A)+(B154)+(B203), (A)+(B154)+(B204), (A)+(B154)+(B205), (A)+(B154)+(B206), (A)+(B154)+(B207), (A)+(B154)+(B208), (A)+(B154)+(B209), (A)+(B154)+(B210), (A)+(B154)+(B211), (A)+(B154)+(B212), (A)+(B154)+(B213), (A)+(B154)+(B214), (A)+(B154)+(B215), (A)+(B154)+(B216), (A)+(B154)+(B217), (A)+(B154)+(B218), (A)+(B154)+(B219), (A)+(B154)+(B220), (A)+(B154)+(B221), (A)+(B154)+(B222), (A)+(B154)+(B223), (A)+(B154)+(B224), (A)+(B154)+(B225), (A)+(B154)+(B226), (A)+(B154)+(B227), (A)+(B154)+(B228), (A)+(B154)+(B229), (A)+(B154)+(B230), (A)+(B154)+(B231), (A)+(B154)+(B232), (A)+(B154)+(B233), (A)+(B154)+(B234), (A)+(B154)+(B235), (A)+(B154)+(B236), (A)+(B154)+(B237), (A)+(B154)+(B238), (A)+(B154)+(B239), (A)+(B154)+(B240), (A)+(B154)+(B241), (A)+(B154)+(B242), (A)+(B154)+(B243), (A)+(B154)+(B244), (A)+(B154)+(B245), (A)+(B154)+(B246), (A)+(B154)+(B247), (A)+(B154)+(B248), (A)+(B154)+(B249), (A)+(B154)+(B250), (A)+(B154)+(B251), (A)+(B154)+(B252), (A)+(B154)+(B253), (A)+(B154)+(B254), (A)+(B154)+(B255), (A)+(B154)+(B256), (A)+(B154)+(B257), (A)+(B154)+(B258), (A)+(B154)+(B259), (A)+(B154)+(B260), (A)+(B154)+(B261), (A)+(B154)+(B262), (A)+(B154)+(B263), (A)+(B154)+(B264), (A)+(B154)+(B265), (A)+(B154)+(B266), (A)+(B154)+(B267), (A)+(B154)+(B268), (A)+(B154)+(B269), (A)+(B154)+(B270), (A)+(B154)+(B271), (A)+(B154)+(B272), (A)+(B154)+(B273), (A)+(B154)+(B274), (A)+(B154)+(B275), (A)+(B154)+(B276), (A)+(B154)+(B277), (A)+(B154)+(B278), (A)+(B154)+(B279), (A)+(B154)+(B280), (A)+(B154)+(B281), (A)+(B154)+(B282), (A)+(B154)+(B283), (A)+(B154)+(B284), (A)+(B154)+(B285), (A)+(B154)+(B286), (A)+(B154)+(B287), (A)+(B154)+(B288), (A)+(B154)+(B289), (A)+(B154)+(B290), (A)+(B154)+(B291), (A)+(B154)+(B292), (A)+(B154)+(B293), (A)+(B154)+(B294), (A)+(B154)+(B295), (A)+(B154)+(B296), (A)+(B154)+(B297), (A)+(B154)+(B298), (A)+(B154)+(B299), (A)+(B154)+(B300), (A)+(B154)+(B301), (A)+(B154)+(B302), (A)+(B154)+(B303), (A)+(B154)+(B304), (A)+(B154)+(B305), (A)+(B154)+(B306), (A)+(B154)+(B307), (A)+(B154)+(B308), (A)+(B154)+(B309), (A)+(B154)+(B310), (A)+(B154)+(B311), (A)+(B154)+(B312), (A)+(B154)+(B313), (A)+(B154)+(B314), (A)+(B154)+(B315),

(A)+(B155)+(B156), (A)+(B155)+(B157), (A)+(B155)+(B158), (A)+(B155)+(B159), (A)+(B155)+(B160), (A)+(B155)+(B161), (A)+(B155)+(B162), (A)+(B155)+(B164), (A)+(B155)+(B164), (A)+(B155)+(B165), (A)+(B155)+(B166), (A)+(B155)+(B167), (A)+(B155)+(B168), (A)+(B155)+(B169), (A)+(B155)+(B170), (A)+(B155)+(B171), (A)+(B155)+(B172), (A)+(B155)+(B173), (A)+(B155)+(B174), (A)+(B155)+(B175), (A)+(B155)+(B176), (A)+(B155)+(B177), (A)+(B155)+(B178), (A)+(B155)+(B179), (A)+(B155)+(B180), (A)+(B155)+(B181), (A)+(B155)+(B182), (A)+(B155)+(B183), (A)+(B155)+(B184), (A)+(B155)+(B185), (A)+(B155)+(B186), (A)+(B155)+(B187), (A)+(B155)+(B188), (A)+(B155)+(B189), (A)+(B155)+(B190), (A)+(B155)+(B191), (A)+(B155)+(B192), (A)+(B155)+(B193), (A)+(B155)+(B194), (A)+(B155)+(B195), (A)+(B155)+(B196), (A)+(B155)+(B197), (A)+(B155)+(B198), (A)+(B155)+(B199), (A)+(B155)+(B200), (A)+(B155)+(B201), (A)+(B155)+(B202), (A)+(B155)+(B203), (A)+(B155)+(B204), (A)+(B155)+(B205), (A)+(B155)+(B206), (A)+(B155)+(B207), (A)+(B155)+(B208), (A)+(B155)+(B209), (A)+(B155)+(B210), (A)+(B155)+(B211), (A)+(B155)+(B212), (A)+(B155)+(B213), (A)+(B155)+(B214), (A)+(B155)+(B215), (A)+(B155)+(B216), (A)+(B155)+(B217), (A)+(B155)+(B218), (A)+(B155)+(B219), (A)+(B155)+(B220), (A)+(B155)+(B221), (A)+(B155)+(B222), (A)+(B155)+(B223), (A)+(B155)+(B224), (A)+(B155)+(B225), (A)+(B155)+(B226), (A)+(B155)+(B227), (A)+(B155)+(B228), (A)+(B155)+(B229), (A)+(B155)+(B230), (A)+(B155)+(B231), (A)+(B155)+(B232), (A)+(B155)+(B233), (A)+(B155)+(B234), (A)+(B155)+(B235), (A)+(B155)+(B236), (A)+(B155)+(B237), (A)+(B155)+(B238), (A)+(B155)+(B239), (A)+(B155)+(B240), (A)+(B155)+(B241), (A)+(B155)+(B242), (A)+(B155)+(B243), (A)+(B155)+(B244), (A)+(B155)+(B245), (A)+(B155)+(B246), (A)+(B155)+(B247), (A)+(B155)+(B248), (A)+(B155)+(B249), (A)+(B155)+(B250), (A)+(B155)+(B251), (A)+(B155)+(B252), (A)+(B155)+(B253), (A)+(B155)+(B254), (A)+(B155)+(B255), (A)+(B155)+(B256), (A)+(B155)+(B257), (A)+(B155)+(B258), (A)+(B155)+(B259), (A)+(B155)+(B260), (A)+(B155)+(B261), (A)+(B155)+(B262), (A)+(B155)+(B263), (A)+(B155)+(B264), (A)+(B155)+(B265), (A)+(B155)+(B266), (A)+(B155)+(B267), (A)+(B155)+(B268), (A)+(B155)+(B269), (A)+(B155)+(B270), (A)+(B155)+(B271), (A)+(B155)+(B272), (A)+(B155)+(B273), (A)+(B155)+(B274), (A)+(B155)+(B275), (A)+(B155)+(B276), (A)+(B155)+(B277), (A)+(B155)+(B278), (A)+(B155)+(B279), (A)+(B155)+(B280), (A)+(B155)+(B281), (A)+(B155)+(B282), (A)+(B155)+(B283), (A)+(B155)+(B284), (A)+(B155)+(B285), (A)+(B155)+(B286), (A)+(B155)+(B287), (A)+(B155)+(B288), (A)+(B155)+(B289), (A)+(B155)+(B290), (A)+(B155)+(B291), (A)+(B155)+(B292), (A)+(B155)+(B293), (A)+(B155)+(B294), (A)+(B155)+(B295), (A)+(B155)+(B296), (A)+(B155)+(B297), (A)+(B155)+(B298), (A)+(B155)+(B299), (A)+(B155)+(B300), (A)+(B155)+(B301), (A)+(B155)+(B302), (A)+(B155)+(B303), (A)+(B155)+(B304), (A)+(B155)+(B305), (A)+(B155)+(B306), (A)+(B155)+(B307), (A)+(B155)+(B308), (A)+(B155)+(B309), (A)+(B155)+(B310), (A)+(B155)+(B311), (A)+(B155)+(B312), (A)+(B155)+(B313), (A)+(B155)+(B314), (A)+(B155)+(B315),

(A)+(B156)+(B157), (A)+(B156)+(B158), (A)+(B156)+(B159), (A)+(B156)+(B160), (A)+(B156)+(B161), (A)+(B156)+(B162), (A)+(B156)+(B164), (A)+(B156)+(B164), (A)+(B156)+(B165), (A)+(B156)+(B166), (A)+(B156)+(B167), (A)+(B156)+(B168), (A)+(B156)+(B169), (A)+(B156)+(B170), (A)+(B156)+(B171), (A)+(B156)+(B172), (A)+(B156)+(B173), (A)+(B156)+(B174), (A)+(B156)+(B175), (A)+(B156)+(B176), (A)+(B156)+(B177), (A)+(B156)+(B178), (A)+(B156)+(B179), (A)+(B156)+(B180), (A)+(B156)+(B181), (A)+(B156)+(B182), (A)+(B156)+(B183), (A)+(B156)+(B184), (A)+(B156)+(B185), (A)+(B156)+(B186), (A)+(B156)+(B187), (A)+(B156)+(B188), (A)+(B156)+(B189), (A)+(B156)+(B190), (A)+(B156)+(B191), (A)+(B156)+(B192), (A)+(B156)+(B193), (A)+(B156)+(B194), (A)+(B156)+(B195), (A)+(B156)+(B196), (A)+(B156)+(B197), (A)+(B156)+(B198), (A)+(B156)+(B199), (A)+(B156)+(B200), (A)+(B156)+(B201), (A)+(B156)+(B202), (A)+(B156)+(B203), (A)+(B156)+(B204), (A)+(B156)+(B205), (A)+(B156)+(B206), (A)+(B156)+(B207), (A)+(B156)+(B208), (A)+(B156)+(B209), (A)+(B156)+(B210), (A)+(B156)+(B211), (A)+(B156)+(B212), (A)+(B156)+(B213), (A)+(B156)+(B214), (A)+(B156)+(B215), (A)+(B156)+(B216), (A)+(B156)+(B217), (A)+(B156)+(B218), (A)+(B156)+(B219), (A)+(B156)+(B220), (A)+(B156)+(B221), (A)+(B156)+(B222), (A)+(B156)+(B223), (A)+(B156)+(B224), (A)+(B156)+(B225), (A)+(B156)+(B226), (A)+(B156)+(B227), (A)+(B156)+(B228), (A)+(B156)+(B229), (A)+(B156)+(B230), (A)+(B156)+(B231), (A)+(B156)+(B232), (A)+(B156)+(B233), (A)+(B156)+(B234), (A)+(B156)+(B235), (A)+(B156)+(B236), (A)+(B156)+(B237), (A)+(B156)+(B238), (A)+(B156)+(B239), (A)+(B156)+(B240), (A)+(B156)+(B241), (A)+(B156)+(B242), (A)+(B156)+(B243), (A)+(B156)+(B244), (A)+(B156)+(B245), (A)+(B156)+(B246), (A)+(B156)+(B247), (A)+(B156)+(B248), (A)+(B156)+(B249), (A)+(B156)+(B250), (A)+(B156)+(B251), (A)+(B156)+(B252), (A)+(B156)+(B253), (A)+(B156)+(B254), (A)+(B156)+(B255), (A)+(B156)+(B256), (A)+(B156)+(B257), (A)+(B156)+(B258), (A)+(B156)+(B259), (A)+(B156)+(B260), (A)+(B156)+(B261), (A)+(B156)+(B262), (A)+(B156)+(B263), (A)+(B156)+(B264), (A)+(B156)+(B265), (A)+(B156)+(B266), (A)+(B156)+(B267), (A)+(B156)+(B268), (A)+(B156)+(B269), (A)+(B156)+(B270), (A)+(B156)+(B271), (A)+(B156)+(B272), (A)+(B156)+(B273), (A)+(B156)+(B274), (A)+(B156)+(B275), (A)+(B156)+(B276), (A)+(B156)+(B277), (A)+(B156)+(B278), (A)+(B156)+(B279), (A)+(B156)+(B280), (A)+(B156)+(B281), (A)+(B156)+(B282), (A)+(B156)+(B283), (A)+(B156)+(B284), (A)+(B156)+(B285), (A)+(B156)+(B286), (A)+(B156)+(B287), (A)+(B156)+(B288), (A)+(B156)+(B289), (A)+(B156)+(B290), (A)+(B156)+(B291), (A)+(B156)+(B292), (A)+(B156)+(B293), (A)+(B156)+(B294), (A)+(B156)+(B295), (A)+(B156)+(B296), (A)+(B156)+(B297), (A)+(B156)+(B298), (A)+(B156)+(B299), (A)+(B156)+(B300), (A)+(B156)+(B301), (A)+(B156)+(B302), (A)+(B156)+(B303), (A)+(B156)+(B304), (A)+(B156)+(B305), (A)+(B156)+(B306), (A)+(B156)+(B307), (A)+(B156)+(B308), (A)+(B156)+(B309), (A)+(B156)+(B310), (A)+(B156)+(B311), (A)+(B156)+(B312), (A)+(B156)+(B313), (A)+(B156)+(B314), (A)+(B156)+(B315),

(A)+(B157)+(B158), (A)+(B157)+(B159), (A)+(B157)+(B160), (A)+(B157)+(B161), (A)+(B157)+(B162), (A)+(B157)+(B164), (A)+(B157)+(B164), (A)+(B157)+(B165), (A)+(B157)+(B166), (A)+(B157)+(B167), (A)+(B157)+(B168), (A)+(B157)+(B169), (A)+(B157)+(B170), (A)+(B157)+(B171), (A)+(B157)+(B172), (A)+(B157)+(B173), (A)+(B157)+(B174), (A)+(B157)+(B175), (A)+(B157)+(B176), (A)+(B157)+(B177), (A)+(B157)+(B178), (A)+(B157)+(B179), (A)+(B157)+(B180), (A)+(B157)+(B181), (A)+(B157)+(B182), (A)+(B157)+(B183), (A)+(B157)+(B184), (A)+(B157)+(B185), (A)+(B157)+(B186), (A)+(B157)+(B187), (A)+(B157)+(B188), (A)+(B157)+(B189), (A)+(B157)+(B190), (A)+(B157)+(B191), (A)+(B157)+(B192), (A)+(B157)+(B193), (A)+(B157)+(B194), (A)+(B157)+(B195), (A)+(B157)+(B196), (A)+(B157)+(B197), (A)+(B157)+(B198), (A)+(B157)+(B199), (A)+(B157)+(B200), (A)+(B157)+(B201), (A)+(B157)+(B202), (A)+(B157)+(B203), (A)+(B157)+(B204), (A)+(B157)+(B205), (A)+(B157)+(B206), (A)+(B157)+(B207), (A)+(B157)+(B208), (A)+(B157)+(B209), (A)+(B157)+(B210), (A)+(B157)+(B211), (A)+(B157)+(B212), (A)+(B157)+(B213), (A)+(B157)+(B214), (A)+(B157)+(B215), (A)+(B157)+(B216), (A)+(B157)+(B217), (A)+(B157)+(B218), (A)+(B157)+(B219), (A)+(B157)+(B220), (A)+(B157)+(B221), (A)+(B157)+(B222), (A)+(B157)+(B223), (A)+(B157)+(B224), (A)+(B157)+(B225), (A)+(B157)+(B226), (A)+(B157)+(B227), (A)+(B157)+(B228), (A)+(B157)+(B229), (A)+(B157)+(B230), (A)+(B157)+(B231), (A)+(B157)+(B232), (A)+(B157)+(B233), (A)+(B157)+(B234), (A)+(B157)+(B235), (A)+(B157)+(B236), (A)+(B157)+(B237), (A)+(B157)+(B238), (A)+(B157)+(B239), (A)+(B157)+(B240), (A)+(B157)+(B241), (A)+(B157)+(B242), (A)+(B157)+(B243), (A)+(B157)+(B244), (A)+(B157)+(B245), (A)+(B157)+(B246), (A)+(B157)+(B247), (A)+(B157)+(B248), (A)+(B157)+(B249), (A)+(B157)+(B250), (A)+(B157)+(B251), (A)+(B157)+(B252), (A)+(B157)+(B253), (A)+(B157)+(B254), (A)+(B157)+(B255), (A)+(B157)+(B256), (A)+(B157)+(B257), (A)+(B157)+(B258), (A)+(B157)+(B259), (A)+(B157)+(B260), (A)+(B157)+(B261), (A)+(B157)+(B262), (A)+(B157)+(B263), (A)+(B157)+(B264), (A)+(B157)+(B265), (A)+(B157)+(B266), (A)+(B157)+(B267), (A)+(B157)+(B268), (A)+(B157)+(B269), (A)+(B157)+(B270), (A)+(B157)+(B271), (A)+(B157)+(B272), (A)+(B157)+(B273), (A)+(B157)+(B274), (A)+(B157)+(B275), (A)+(B157)+(B276), (A)+(B157)+(B277), (A)+(B157)+(B278), (A)+(B157)+(B279), (A)+(B157)+(B280), (A)+(B157)+(B281), (A)+(B157)+(B282), (A)+(B157)+(B283), (A)+(B157)+(B284), (A)+(B157)+(B285), (A)+(B157)+(B286), (A)+(B157)+(B287), (A)+(B157)+(B288), (A)+(B157)+(B289), (A)+(B157)+(B290), (A)+(B157)+(B291), (A)+(B157)+(B292), (A)+(B157)+(B293), (A)+(B157)+(B294), (A)+(B157)+(B295), (A)+(B157)+(B296), (A)+(B157)+(B297), (A)+(B157)+(B298), (A)+(B157)+(B299), (A)+(B157)+(B300), (A)+(B157)+(B301), (A)+(B157)+(B302), (A)+(B157)+(B303), (A)+(B157)+(B304), (A)+(B157)+(B305), (A)+(B157)+(B306), (A)+(B157)+(B307), (A)+(B157)+(B308), (A)+(B157)+(B309), (A)+(B157)+(B310), (A)+(B157)+(B311), (A)+(B157)+(B312), (A)+(B157)+(B313), (A)+(B157)+(B314), (A)+(B157)+(B315),

(A)+(B158)+(B159), (A)+(B158)+(B160), (A)+(B158)+(B161), (A)+(B158)+(B162), (A)+(B158)+(B164), (A)+(B158)+(B164), (A)+(B158)+(B165), (A)+(B158)+(B166), (A)+(B158)+(B167), (A)+(B158)+(B168), (A)+(B158)+(B169), (A)+(B158)+(B170), (A)+(B158)+(B171), (A)+(B158)+(B172), (A)+(B158)+(B173), (A)+(B158)+(B174), (A)+(B158)+(B175), (A)+(B158)+(B176), (A)+(B158)+(B177), (A)+(B158)+(B178), (A)+(B158)+(B179), (A)+(B158)+(B180), (A)+(B158)+(B181), (A)+(B158)+(B182), (A)+(B158)+(B183), (A)+(B158)+(B184), (A)+(B158)+(B185), (A)+(B158)+(B186), (A)+(B158)+(B187), (A)+(B158)+(B188), (A)+(B158)+(B189), (A)+(B158)+(B190), (A)+(B158)+(B191), (A)+(B158)+(B192), (A)+(B158)+(B193), (A)+(B158)+(B194), (A)+(B158)+(B195), (A)+(B158)+(B196), (A)+(B158)+(B197), (A)+(B158)+(B198), (A)+(B158)+(B199), (A)+(B158)+(B200), (A)+(B158)+(B201), (A)+(B158)+(B202), (A)+(B158)+(B203), (A)+(B158)+(B204), (A)+(B158)+(B205), (A)+(B158)+(B206), (A)+(B158)+(B207), (A)+(B158)+(B208), (A)+(B158)+(B209), (A)+(B158)+(B210), (A)+(B158)+(B211), (A)+(B158)+(B212), (A)+(B158)+(B213), (A)+(B158)+(B214), (A)+(B158)+(B215), (A)+(B158)+(B216), (A)+(B158)+(B217), (A)+(B158)+(B218), (A)+(B158)+(B219), (A)+(B158)+(B220), (A)+(B158)+(B221), (A)+(B158)+(B222), (A)+(B158)+(B223), (A)+(B158)+(B224), (A)+(B158)+(B225), (A)+(B158)+(B226), (A)+(B158)+(B227), (A)+(B158)+(B228), (A)+(B158)+(B229), (A)+(B158)+(B230), (A)+(B158)+(B231), (A)+(B158)+(B232), (A)+(B158)+(B233), (A)+(B158)+(B234), (A)+(B158)+(B235), (A)+(B158)+(B236), (A)+(B158)+(B237), (A)+(B158)+(B238), (A)+(B158)+(B239), (A)+(B158)+(B240), (A)+(B158)+(B241), (A)+(B158)+(B242), (A)+(B158)+(B243), (A)+(B158)+(B244), (A)+(B158)+(B245), (A)+(B158)+(B246), (A)+(B158)+(B247), (A)+(B158)+(B248), (A)+(B158)+(B249), (A)+(B158)+(B250), (A)+(B158)+(B251), (A)+(B158)+(B252), (A)+(B158)+(B253), (A)+(B158)+(B254), (A)+(B158)+(B255), (A)+(B158)+(B256), (A)+(B158)+(B257), (A)+(B158)+(B258), (A)+(B158)+(B259), (A)+(B158)+(B260), (A)+(B158)+(B261), (A)+(B158)+(B262), (A)+(B158)+(B263), (A)+(B158)+(B264), (A)+(B158)+(B265), (A)+(B158)+(B266), (A)+(B158)+(B267), (A)+(B158)+(B268), (A)+(B158)+(B269), (A)+(B158)+(B270), (A)+(B158)+(B271), (A)+(B158)+(B272), (A)+(B158)+(B273), (A)+(B158)+(B274), (A)+(B158)+(B275), (A)+(B158)+(B276), (A)+(B158)+(B277), (A)+(B158)+(B278), (A)+(B158)+(B279), (A)+(B158)+(B280), (A)+(B158)+(B281), (A)+(B158)+(B282), (A)+(B158)+(B283), (A)+(B158)+(B284), (A)+(B158)+(B285), (A)+(B158)+(B286), (A)+(B158)+(B287), (A)+(B158)+(B288), (A)+(B158)+(B289), (A)+(B158)+(B290), (A)+(B158)+(B291), (A)+(B158)+(B292), (A)+(B158)+(B293), (A)+(B158)+(B294), (A)+(B158)+(B295), (A)+(B158)+(B296), (A)+(B158)+(B297), (A)+(B158)+(B298), (A)+(B158)+(B299), (A)+(B158)+(B300), (A)+(B158)+(B301), (A)+(B158)+(B302), (A)+(B158)+(B303), (A)+(B158)+(B304), (A)+(B158)+(B305), (A)+(B158)+(B306), (A)+(B158)+(B307), (A)+(B158)+(B308), (A)+(B158)+(B309), (A)+(B158)+(B310), (A)+(B158)+(B311), (A)+(B158)+(B312), (A)+(B158)+(B313), (A)+(B158)+(B314), (A)+(B158)+(B315),

(A)+(B159)+(B160), (A)+(B159)+(B161), (A)+(B159)+(B162), (A)+(B159)+(B164), (A)+(B159)+(B164), (A)+(B159)+(B165), (A)+(B159)+(B166), (A)+(B159)+(B167), (A)+(B159)+(B168), (A)+(B159)+(B169), (A)+(B159)+(B170), (A)+(B159)+(B171), (A)+(B159)+(B172), (A)+(B159)+(B173), (A)+(B159)+(B174), (A)+(B159)+(B175), (A)+(B159)+(B176), (A)+(B159)+(B177), (A)+(B159)+(B178), (A)+(B159)+(B179), (A)+(B159)+(B180), (A)+(B159)+(B181), (A)+(B159)+(B182), (A)+(B159)+(B183), (A)+(B159)+(B184), (A)+(B159)+(B185), (A)+(B159)+(B186), (A)+(B159)+(B187), (A)+(B159)+(B188), (A)+(B159)+(B189), (A)+(B159)+(B190), (A)+(B159)+(B191), (A)+(B159)+(B192), (A)+(B159)+(B193), (A)+(B159)+(B194), (A)+(B159)+(B195), (A)+(B159)+(B196), (A)+(B159)+(B197), (A)+(B159)+(B198), (A)+(B159)+(B199), (A)+(B159)+(B200), (A)+(B159)+(B201), (A)+(B159)+(B202), (A)+(B159)+(B203), (A)+(B159)+(B204), (A)+(B159)+(B205), (A)+(B159)+(B206), (A)+(B159)+(B207), (A)+(B159)+(B208), (A)+(B159)+(B209), (A)+(B159)+(B210), (A)+(B159)+(B211), (A)+(B159)+(B212), (A)+(B159)+(B213), (A)+(B159)+(B214), (A)+(B159)+(B215), (A)+(B159)+(B216), (A)+(B159)+(B217), (A)+(B159)+(B218), (A)+(B159)+(B219), (A)+(B159)+(B220), (A)+(B159)+(B221), (A)+(B159)+(B222), (A)+(B159)+(B223), (A)+(B159)+(B224), (A)+(B159)+(B225), (A)+(B159)+(B226), (A)+(B159)+(B227), (A)+(B159)+(B228), (A)+(B159)+(B229), (A)+(B159)+(B230), (A)+(B159)+(B231), (A)+(B159)+(B232), (A)+(B159)+(B233), (A)+(B159)+(B234), (A)+(B159)+(B235), (A)+(B159)+(B236), (A)+(B159)+(B237), (A)+(B159)+(B238), (A)+(B159)+(B239), (A)+(B159)+(B240), (A)+(B159)+(B241), (A)+(B159)+(B242), (A)+(B159)+(B243), (A)+(B159)+(B244), (A)+(B159)+(B245), (A)+(B159)+(B246), (A)+(B159)+(B247), (A)+(B159)+(B248), (A)+(B159)+(B249), (A)+(B159)+(B250), (A)+(B159)+(B251), (A)+(B159)+(B252), (A)+(B159)+(B253), (A)+(B159)+(B254), (A)+(B159)+(B255), (A)+(B159)+(B256), (A)+(B159)+(B257), (A)+(B159)+(B258), (A)+(B159)+(B259), (A)+(B159)+(B260), (A)+(B159)+(B261), (A)+(B159)+(B262), (A)+(B159)+(B263), (A)+(B159)+(B264), (A)+(B159)+(B265), (A)+(B159)+(B266), (A)+(B159)+(B267), (A)+(B159)+(B268), (A)+(B159)+(B269), (A)+(B159)+(B270), (A)+(B159)+(B271), (A)+(B159)+(B272), (A)+(B159)+(B273), (A)+(B159)+(B274), (A)+(B159)+(B275), (A)+(B159)+(B276), (A)+(B159)+(B277), (A)+(B159)+(B278), (A)+(B159)+(B279), (A)+(B159)+(B280), (A)+(B159)+(B281), (A)+(B159)+(B282), (A)+(B159)+(B283), (A)+(B159)+(B284), (A)+(B159)+(B285), (A)+(B159)+(B286), (A)+(B159)+(B287), (A)+(B159)+(B288), (A)+(B159)+(B289), (A)+(B159)+(B290), (A)+(B159)+(B291), (A)+(B159)+(B292), (A)+(B159)+(B293), (A)+(B159)+(B294), (A)+(B159)+(B295), (A)+(B159)+(B296), (A)+(B159)+(B297), (A)+(B159)+(B298), (A)+(B159)+(B299), (A)+(B159)+(B300), (A)+(B159)+(B301), (A)+(B159)+(B302), (A)+(B159)+(B303), (A)+(B159)+(B304), (A)+(B159)+(B305), (A)+(B159)+(B306), (A)+(B159)+(B307), (A)+(B159)+(B308), (A)+(B159)+(B309), (A)+(B159)+(B310), (A)+(B159)+(B311), (A)+(B159)+(B312), (A)+(B159)+(B313), (A)+(B159)+(B314), (A)+(B159)+(B315),

(A)+(B160)+(B161), (A)+(B160)+(B162), (A)+(B160)+(B164), (A)+(B160)+(B164), (A)+(B160)+(B165), (A)+(B160)+(B166), (A)+(B160)+(B167), (A)+(B160)+(B168), (A)+(B160)+(B169), (A)+(B160)+(B170), (A)+(B160)+(B171), (A)+(B160)+(B172), (A)+(B160)+(B173), (A)+(B160)+(B174), (A)+(B160)+(B175), (A)+(B160)+(B176), (A)+(B160)+(B177), (A)+(B160)+(B178), (A)+(B160)+(B179), (A)+(B160)+(B180), (A)+(B160)+(B181), (A)+(B160)+(B182), (A)+(B160)+(B183), (A)+(B160)+(B184), (A)+(B160)+(B185), (A)+(B160)+(B186), (A)+(B160)+(B187), (A)+(B160)+(B188), (A)+(B160)+(B189), (A)+(B160)+(B190), (A)+(B160)+(B191), (A)+(B160)+(B192), (A)+(B160)+(B193), (A)+(B160)+(B194), (A)+(B160)+(B195), (A)+(B160)+(B196), (A)+(B160)+(B197), (A)+(B160)+(B198), (A)+(B160)+(B199), (A)+(B160)+(B200), (A)+(B160)+(B201), (A)+(B160)+(B202), (A)+(B160)+(B203), (A)+(B160)+(B204), (A)+(B160)+(B205), (A)+(B160)+(B206), (A)+(B160)+(B207), (A)+(B160)+(B208), (A)+(B160)+(B209), (A)+(B160)+(B210), (A)+(B160)+(B211), (A)+(B160)+(B212), (A)+(B160)+(B213), (A)+(B160)+(B214), (A)+(B160)+(B215), (A)+(B160)+(B216), (A)+(B160)+(B217), (A)+(B160)+(B218), (A)+(B160)+(B219), (A)+(B160)+(B220), (A)+(B160)+(B221), (A)+(B160)+(B222), (A)+(B160)+(B223), (A)+(B160)+(B224), (A)+(B160)+(B225), (A)+(B160)+(B226), (A)+(B160)+(B227), (A)+(B160)+(B228), (A)+(B160)+(B229), (A)+(B160)+(B230), (A)+(B160)+(B231), (A)+(B160)+(B232), (A)+(B160)+(B233), (A)+(B160)+(B234), (A)+(B160)+(B235), (A)+(B160)+(B236), (A)+(B160)+(B237), (A)+(B160)+(B238), (A)+(B160)+(B239), (A)+(B160)+(B240), (A)+(B160)+(B241), (A)+(B160)+(B242), (A)+(B160)+(B243), (A)+(B160)+(B244), (A)+(B160)+(B245), (A)+(B160)+(B246), (A)+(B160)+(B247), (A)+(B160)+(B248), (A)+(B160)+(B249), (A)+(B160)+(B250), (A)+(B160)+(B251), (A)+(B160)+(B252), (A)+(B160)+(B253), (A)+(B160)+(B254), (A)+(B160)+(B255), (A)+(B160)+(B256), (A)+(B160)+(B257), (A)+(B160)+(B258), (A)+(B160)+(B259), (A)+(B160)+(B260), (A)+(B160)+(B261), (A)+(B160)+(B262), (A)+(B160)+(B263), (A)+(B160)+(B264), (A)+(B160)+(B265), (A)+(B160)+(B266), (A)+(B160)+(B267), (A)+(B160)+(B268), (A)+(B160)+(B269), (A)+(B160)+(B270), (A)+(B160)+(B271), (A)+(B160)+(B272), (A)+(B160)+(B273), (A)+(B160)+(B274), (A)+(B160)+(B275), (A)+(B160)+(B276), (A)+(B160)+(B277), (A)+(B160)+(B278), (A)+(B160)+(B279), (A)+(B160)+(B280), (A)+(B160)+(B281), (A)+(B160)+(B282), (A)+(B160)+(B283), (A)+(B160)+(B284), (A)+(B160)+(B285), (A)+(B160)+(B286), (A)+(B160)+(B287), (A)+(B160)+(B288), (A)+(B160)+(B289), (A)+(B160)+(B290), (A)+(B160)+(B291), (A)+(B160)+(B292), (A)+(B160)+(B293), (A)+(B160)+(B294), (A)+(B160)+(B295), (A)+(B160)+(B296), (A)+(B160)+(B297), (A)+(B160)+(B298), (A)+(B160)+(B299), (A)+(B160)+(B300), (A)+(B160)+(B301), (A)+(B160)+(B302), (A)+(B160)+(B303), (A)+(B160)+(B304), (A)+(B160)+(B305), (A)+(B160)+(B306), (A)+(B160)+(B307), (A)+(B160)+(B308), (A)+(B160)+(B309), (A)+(B160)+(B310), (A)+(B160)+(B311), (A)+(B160)+(B312), (A)+(B160)+(B313), (A)+(B160)+(B314), (A)+(B160)+(B315),

(A)+(B161)+(B162), (A)+(B161)+(B164), (A)+(B161)+(B164), (A)+(B161)+(B165), (A)+(B161)+(B166), (A)+(B161)+(B167), (A)+(B161)+(B168), (A)+(B161)+(B169), (A)+(B161)+(B170), (A)+(B161)+(B171), (A)+(B161)+(B172), (A)+(B161)+(B173), (A)+(B161)+(B174), (A)+(B161)+(B175), (A)+(B161)+(B176), (A)+(B161)+(B177), (A)+(B161)+(B178), (A)+(B161)+(B179), (A)+(B161)+(B180), (A)+(B161)+(B181), (A)+(B161)+(B182), (A)+(B161)+(B183), (A)+(B161)+(B184), (A)+(B161)+(B185), (A)+(B161)+(B186), (A)+(B161)+(B187), (A)+(B161)+(B188), (A)+(B161)+(B189), (A)+(B161)+(B190), (A)+(B161)+(B191), (A)+(B161)+(B192), (A)+(B161)+(B193), (A)+(B161)+(B194), (A)+(B161)+(B195), (A)+(B161)+(B196), (A)+(B161)+(B197), (A)+(B161)+(B198), (A)+(B161)+(B199), (A)+(B161)+(B200), (A)+(B161)+(B201), (A)+(B161)+(B202), (A)+(B161)+(B203), (A)+(B161)+(B204), (A)+(B161)+(B205), (A)+(B161)+(B206), (A)+(B161)+(B207), (A)+(B161)+(B208), (A)+(B161)+(B209), (A)+(B161)+(B210), (A)+(B161)+(B211), (A)+(B161)+(B212), (A)+(B161)+(B213), (A)+(B161)+(B214), (A)+(B161)+(B215), (A)+(B161)+(B216), (A)+(B161)+(B217), (A)+(B161)+(B218), (A)+(B161)+(B219), (A)+(B161)+(B220), (A)+(B161)+(B221), (A)+(B161)+(B222), (A)+(B161)+(B223), (A)+(B161)+(B224), (A)+(B161)+(B225), (A)+(B161)+(B226), (A)+(B161)+(B227), (A)+(B161)+(B228), (A)+(B161)+(B229), (A)+(B161)+(B230), (A)+(B161)+(B231), (A)+(B161)+(B232), (A)+(B161)+(B233), (A)+(B161)+(B234), (A)+(B161)+(B235), (A)+(B161)+(B236), (A)+(B161)+(B237), (A)+(B161)+(B238), (A)+(B161)+(B239), (A)+(B161)+(B240), (A)+(B161)+(B241), (A)+(B161)+(B242), (A)+(B161)+(B243), (A)+(B161)+(B244), (A)+(B161)+(B245), (A)+(B161)+(B246), (A)+(B161)+(B247), (A)+(B161)+(B248), (A)+(B161)+(B249), (A)+(B161)+(B250), (A)+(B161)+(B251), (A)+(B161)+(B252), (A)+(B161)+(B253), (A)+(B161)+(B254), (A)+(B161)+(B255), (A)+(B161)+(B256), (A)+(B161)+(B257), (A)+(B161)+(B258), (A)+(B161)+(B259), (A)+(B161)+(B260), (A)+(B161)+(B261), (A)+(B161)+(B262), (A)+(B161)+(B263), (A)+(B161)+(B264), (A)+(B161)+(B265), (A)+(B161)+(B266), (A)+(B161)+(B267), (A)+(B161)+(B268), (A)+(B161)+(B269), (A)+(B161)+(B270), (A)+(B161)+(B271), (A)+(B161)+(B272), (A)+(B161)+(B273), (A)+(B161)+(B274), (A)+(B161)+(B275), (A)+(B161)+(B276), (A)+(B161)+(B277), (A)+(B161)+(B278), (A)+(B161)+(B279), (A)+(B161)+(B280), (A)+(B161)+(B281), (A)+(B161)+(B282), (A)+(B161)+(B283), (A)+(B161)+(B284), (A)+(B161)+(B285), (A)+(B161)+(B286), (A)+(B161)+(B287), (A)+(B161)+(B288), (A)+(B161)+(B289), (A)+(B161)+(B290), (A)+(B161)+(B291), (A)+(B161)+(B292), (A)+(B161)+(B293), (A)+(B161)+(B294), (A)+(B161)+(B295), (A)+(B161)+(B296), (A)+(B161)+(B297), (A)+(B161)+(B298), (A)+(B161)+(B299), (A)+(B161)+(B300), (A)+(B161)+(B301), (A)+(B161)+(B302), (A)+(B161)+(B303), (A)+(B161)+(B304), (A)+(B161)+(B305), (A)+(B161)+(B306), (A)+(B161)+(B307), (A)+(B161)+(B308), (A)+(B161)+(B309), (A)+(B161)+(B310), (A)+(B161)+(B311), (A)+(B161)+(B312), (A)+(B161)+(B313), (A)+(B161)+(B314), (A)+(B161)+(B315),

(A)+(B162)+(B164), (A)+(B162)+(B164), (A)+(B162)+(B165), (A)+(B162)+(B166), (A)+(B162)+(B167), (A)+(B162)+(B168), (A)+(B162)+(B169), (A)+(B162)+(B170), (A)+(B162)+(B171), (A)+(B162)+(B172), (A)+(B162)+(B173), (A)+(B162)+(B174), (A)+(B162)+(B175), (A)+(B162)+(B176), (A)+(B162)+(B177), (A)+(B162)+(B178), (A)+(B162)+(B179), (A)+(B162)+(B180), (A)+(B162)+(B181), (A)+(B162)+(B182), (A)+(B162)+(B183), (A)+(B162)+(B184), (A)+(B162)+(B185), (A)+(B162)+(B186), (A)+(B162)+(B187), (A)+(B162)+(B188), (A)+(B162)+(B189), (A)+(B162)+(B190), (A)+(B162)+(B191), (A)+(B162)+(B192), (A)+(B162)+(B193), (A)+(B162)+(B194), (A)+(B162)+(B195), (A)+(B162)+(B196), (A)+(B162)+(B197), (A)+(B162)+(B198), (A)+(B162)+(B199), (A)+(B162)+(B200), (A)+(B162)+(B201), (A)+(B162)+(B202), (A)+(B162)+(B203), (A)+(B162)+(B204), (A)+(B162)+(B205), (A)+(B162)+(B206), (A)+(B162)+(B207), (A)+(B162)+(B208), (A)+(B162)+(B209), (A)+(B162)+(B210), (A)+(B162)+(B211), (A)+(B162)+(B212), (A)+(B162)+(B213), (A)+(B162)+(B214), (A)+(B162)+(B215), (A)+(B162)+(B216), (A)+(B162)+(B217), (A)+(B162)+(B218), (A)+(B162)+(B219), (A)+(B162)+(B220), (A)+(B162)+(B221), (A)+(B162)+(B222), (A)+(B162)+(B223), (A)+(B162)+(B224), (A)+(B162)+(B225), (A)+(B162)+(B226), (A)+(B162)+(B227), (A)+(B162)+(B228), (A)+(B162)+(B229), (A)+(B162)+(B230), (A)+(B162)+(B231), (A)+(B162)+(B232), (A)+(B162)+(B233), (A)+(B162)+(B234), (A)+(B162)+(B235), (A)+(B162)+(B236), (A)+(B162)+(B237), (A)+(B162)+(B238), (A)+(B162)+(B239), (A)+(B162)+(B240), (A)+(B162)+(B241), (A)+(B162)+(B242), (A)+(B162)+(B243), (A)+(B162)+(B244), (A)+(B162)+(B245), (A)+(B162)+(B246), (A)+(B162)+(B247), (A)+(B162)+(B248), (A)+(B162)+(B249), (A)+(B162)+(B250), (A)+(B162)+(B251), (A)+(B162)+(B252), (A)+(B162)+(B253), (A)+(B162)+(B254), (A)+(B162)+(B255), (A)+(B162)+(B256), (A)+(B162)+(B257), (A)+(B162)+(B258), (A)+(B162)+(B259), (A)+(B162)+(B260), (A)+(B162)+(B261), (A)+(B162)+(B262), (A)+(B162)+(B263), (A)+(B162)+(B264), (A)+(B162)+(B265), (A)+(B162)+(B266), (A)+(B162)+(B267), (A)+(B162)+(B268), (A)+(B162)+(B269), (A)+(B162)+(B270), (A)+(B162)+(B271), (A)+(B162)+(B272), (A)+(B162)+(B273), (A)+(B162)+(B274), (A)+(B162)+(B275), (A)+(B162)+(B276), (A)+(B162)+(B277), (A)+(B162)+(B278), (A)+(B162)+(B279), (A)+(B162)+(B280), (A)+(B162)+(B281), (A)+(B162)+(B282), (A)+(B162)+(B283), (A)+(B162)+(B284), (A)+(B162)+(B285), (A)+(B162)+(B286), (A)+(B162)+(B287), (A)+(B162)+(B288), (A)+(B162)+(B289), (A)+(B162)+(B290), (A)+(B162)+(B291), (A)+(B162)+(B292), (A)+(B162)+(B293), (A)+(B162)+(B294), (A)+(B162)+(B295), (A)+(B162)+(B296), (A)+(B162)+(B297), (A)+(B162)+(B298), (A)+(B162)+(B299), (A)+(B162)+(B300), (A)+(B162)+(B301), (A)+(B162)+(B302), (A)+(B162)+(B303), (A)+(B162)+(B304), (A)+(B162)+(B305), (A)+(B162)+(B306), (A)+(B162)+(B307), (A)+(B162)+(B308), (A)+(B162)+(B309), (A)+(B162)+(B310), (A)+(B162)+(B311), (A)+(B162)+(B312), (A)+(B162)+(B313), (A)+(B162)+(B314), (A)+(B162)+(B315),

(A)+(B163)+(B164), (A)+(B163)+(B165), (A)+(B163)+(B166), (A)+(B163)+(B167), (A)+(B163)+(B168), (A)+(B163)+(B169), (A)+(B163)+(B170), (A)+(B163)+(B171), (A)+(B163)+(B172), (A)+(B163)+(B173), (A)+(B163)+(B174), (A)+(B163)+(B175), (A)+(B163)+(B176), (A)+(B163)+(B177), (A)+(B163)+(B178), (A)+(B163)+(B179), (A)+(B163)+(B180), (A)+(B163)+(B181), (A)+(B163)+(B182), (A)+(B163)+(B183), (A)+(B163)+(B184), (A)+(B163)+(B185), (A)+(B163)+(B186), (A)+(B163)+(B187), (A)+(B163)+(B188), (A)+(B163)+(B189), (A)+(B163)+(B190), (A)+(B163)+(B191), (A)+(B163)+(B192), (A)+(B163)+(B193), (A)+(B163)+(B194), (A)+(B163)+(B195), (A)+(B163)+(B196), (A)+(B163)+(B197), (A)+(B163)+(B198), (A)+(B163)+(B199), (A)+(B163)+(B200), (A)+(B163)+(B201), (A)+(B163)+(B202), (A)+(B163)+(B203), (A)+(B163)+(B204), (A)+(B163)+(B205), (A)+(B163)+(B206), (A)+(B163)+(B207), (A)+(B163)+(B208), (A)+(B163)+(B209), (A)+(B163)+(B210), (A)+(B163)+(B211), (A)+(B163)+(B212), (A)+(B163)+(B213), (A)+(B163)+(B214), (A)+(B163)+(B215), (A)+(B163)+(B216), (A)+(B163)+(B217), (A)+(B163)+(B218), (A)+(B163)+(B219), (A)+(B163)+(B220), (A)+(B163)+(B221), (A)+(B163)+(B222), (A)+(B163)+(B223), (A)+(B163)+(B224), (A)+(B163)+(B225), (A)+(B163)+(B226), (A)+(B163)+(B227), (A)+(B163)+(B228), (A)+(B163)+(B229), (A)+(B163)+(B230), (A)+(B163)+(B231), (A)+(B163)+(B232), (A)+(B163)+(B233), (A)+(B163)+(B234), (A)+(B163)+(B235), (A)+(B163)+(B236), (A)+(B163)+(B237), (A)+(B163)+(B238), (A)+(B163)+(B239), (A)+(B163)+(B240), (A)+(B163)+(B241), (A)+(B163)+(B242), (A)+(B163)+(B243), (A)+(B163)+(B244), (A)+(B163)+(B245), (A)+(B163)+(B246), (A)+(B163)+(B247), (A)+(B163)+(B248), (A)+(B163)+(B249), (A)+(B163)+(B250), (A)+(B163)+(B251), (A)+(B163)+(B252), (A)+(B163)+(B253), (A)+(B163)+(B254), (A)+(B163)+(B255), (A)+(B163)+(B256), (A)+(B163)+(B257), (A)+(B163)+(B258), (A)+(B163)+(B259), (A)+(B163)+(B260), (A)+(B163)+(B261), (A)+(B163)+(B262), (A)+(B163)+(B263), (A)+(B163)+(B264), (A)+(B163)+(B265), (A)+(B163)+(B266), (A)+(B163)+(B267), (A)+(B163)+(B268), (A)+(B163)+(B269), (A)+(B163)+(B270), (A)+(B163)+(B271), (A)+(B163)+(B272), (A)+(B163)+(B273), (A)+(B163)+(B274), (A)+(B163)+(B275), (A)+(B163)+(B276), (A)+(B163)+(B277), (A)+(B163)+(B278), (A)+(B163)+(B279), (A)+(B163)+(B280), (A)+(B163)+(B281), (A)+(B163)+(B282), (A)+(B163)+(B283), (A)+(B163)+(B284), (A)+(B163)+(B285), (A)+(B163)+(B286), (A)+(B163)+(B287), (A)+(B163)+(B288), (A)+(B163)+(B289), (A)+(B163)+(B290), (A)+(B163)+(B291), (A)+(B163)+(B292), (A)+(B163)+(B293), (A)+(B163)+(B294), (A)+(B163)+(B295), (A)+(B163)+(B296), (A)+(B163)+(B297), (A)+(B163)+(B298), (A)+(B163)+(B299), (A)+(B163)+(B300), (A)+(B163)+(B301), (A)+(B163)+(B302), (A)+(B163)+(B303), (A)+(B163)+(B304), (A)+(B163)+(B305), (A)+(B163)+(B306), (A)+(B163)+(B307), (A)+(B163)+(B308), (A)+(B163)+(B309), (A)+(B163)+(B310), (A)+(B163)+(B311), (A)+(B163)+(B312), (A)+(B163)+(B313), (A)+(B163)+(B314), (A)+(B163)+(B315),

(A)+(B164)+(B165), (A)+(B164)+(B166), (A)+(B164)+(B167), (A)+(B164)+(B168), (A)+(B164)+(B169), (A)+(B164)+(B170), (A)+(B164)+(B171), (A)+(B164)+(B172), (A)+(B164)+(B173), (A)+(B164)+(B174), (A)+(B164)+(B175), (A)+(B164)+(B176), (A)+(B164)+(B177), (A)+(B164)+(B178), (A)+(B164)+(B179), (A)+(B164)+(B180), (A)+(B164)+(B181), (A)+(B164)+(B182), (A)+(B164)+(B183), (A)+(B164)+(B184), (A)+(B164)+(B185), (A)+(B164)+(B186), (A)+(B164)+(B187), (A)+(B164)+(B188), (A)+(B164)+(B189), (A)+(B164)+(B190), (A)+(B164)+(B191), (A)+(B164)+(B192), (A)+(B164)+(B193), (A)+(B164)+(B194), (A)+(B164)+(B195), (A)+(B164)+(B196), (A)+(B164)+(B197), (A)+(B164)+(B198), (A)+(B164)+(B199), (A)+(B164)+(B200), (A)+(B164)+(B201), (A)+(B164)+(B202), (A)+(B164)+(B203), (A)+(B164)+(B204), (A)+(B164)+(B205), (A)+(B164)+(B206), (A)+(B164)+(B207), (A)+(B164)+(B208), (A)+(B164)+(B209), (A)+(B164)+(B210), (A)+(B164)+(B211), (A)+(B164)+(B212), (A)+(B164)+(B213), (A)+(B164)+(B214), (A)+(B164)+(B215), (A)+(B164)+(B216), (A)+(B164)+(B217), (A)+(B164)+(B218), (A)+(B164)+(B219), (A)+(B164)+(B220), (A)+(B164)+(B221), (A)+(B164)+(B222), (A)+(B164)+(B223), (A)+(B164)+(B224), (A)+(B164)+(B225), (A)+(B164)+(B226), (A)+(B164)+(B227), (A)+(B164)+(B228), (A)+(B164)+(B229), (A)+(B164)+(B230), (A)+(B164)+(B231), (A)+(B164)+(B232), (A)+(B164)+(B233), (A)+(B164)+(B234), (A)+(B164)+(B235), (A)+(B164)+(B236), (A)+(B164)+(B237), (A)+(B164)+(B238), (A)+(B164)+(B239), (A)+(B164)+(B240), (A)+(B164)+(B241), (A)+(B164)+(B242), (A)+(B164)+(B243), (A)+(B164)+(B244), (A)+(B164)+(B245), (A)+(B164)+(B246), (A)+(B164)+(B247), (A)+(B164)+(B248), (A)+(B164)+(B249), (A)+(B164)+(B250), (A)+(B164)+(B251), (A)+(B164)+(B252), (A)+(B164)+(B253), (A)+(B164)+(B254), (A)+(B164)+(B255), (A)+(B164)+(B256), (A)+(B164)+(B257), (A)+(B164)+(B258), (A)+(B164)+(B259), (A)+(B164)+(B260), (A)+(B164)+(B261), (A)+(B164)+(B262), (A)+(B164)+(B263), (A)+(B164)+(B264), (A)+(B164)+(B265), (A)+(B164)+(B266), (A)+(B164)+(B267), (A)+(B164)+(B268), (A)+(B164)+(B269), (A)+(B164)+(B270), (A)+(B164)+(B271), (A)+(B164)+(B272), (A)+(B164)+(B273), (A)+(B164)+(B274), (A)+(B164)+(B275), (A)+(B164)+(B276), (A)+(B164)+(B277), (A)+(B164)+(B278), (A)+(B164)+(B279), (A)+(B164)+(B280), (A)+(B164)+(B281), (A)+(B164)+(B282), (A)+(B164)+(B283), (A)+(B164)+(B284), (A)+(B164)+(B285), (A)+(B164)+(B286), (A)+(B164)+(B287), (A)+(B164)+(B288), (A)+(B164)+(B289), (A)+(B164)+(B290), (A)+(B164)+(B291), (A)+(B164)+(B292), (A)+(B164)+(B293), (A)+(B164)+(B294), (A)+(B164)+(B295), (A)+(B164)+(B296), (A)+(B164)+(B297), (A)+(B164)+(B298), (A)+(B164)+(B299), (A)+(B164)+(B300), (A)+(B164)+(B301), (A)+(B164)+(B302), (A)+(B164)+(B303), (A)+(B164)+(B304), (A)+(B164)+(B305), (A)+(B164)+(B306), (A)+(B164)+(B307), (A)+(B164)+(B308), (A)+(B164)+(B309), (A)+(B164)+(B310), (A)+(B164)+(B311), (A)+(B164)+(B312), (A)+(B164)+(B313), (A)+(B164)+(B314), (A)+(B164)+(B315),

(A)+(B165)+(B166), (A)+(B165)+(B167), (A)+(B165)+(B168), (A)+(B165)+(B169), (A)+(B165)+(B170), (A)+(B165)+(B171), (A)+(B165)+(B172), (A)+(B165)+(B173), (A)+(B165)+(B174), (A)+(B165)+(B175), (A)+(B165)+(B176), (A)+(B165)+(B177), (A)+(B165)+(B178), (A)+(B165)+(B179), (A)+(B165)+(B180), (A)+(B165)+(B181), (A)+(B165)+(B182), (A)+(B165)+(B183), (A)+(B165)+(B184), (A)+(B165)+(B185), (A)+(B165)+(B186), (A)+(B165)+(B187), (A)+(B165)+(B188), (A)+(B165)+(B189), (A)+(B165)+(B190), (A)+(B165)+(B191), (A)+(B165)+(B192), (A)+(B165)+(B193), (A)+(B165)+(B194), (A)+(B165)+(B195), (A)+(B165)+(B196), (A)+(B165)+(B197), (A)+(B165)+(B198), (A)+(B165)+(B199), (A)+(B165)+(B200), (A)+(B165)+(B201), (A)+(B165)+(B202), (A)+(B165)+(B203), (A)+(B165)+(B204), (A)+(B165)+(B205), (A)+(B165)+(B206), (A)+(B165)+(B207), (A)+(B165)+(B208), (A)+(B165)+(B209), (A)+(B165)+(B210), (A)+(B165)+(B211), (A)+(B165)+(B212), (A)+(B165)+(B213), (A)+(B165)+(B214), (A)+(B165)+(B215), (A)+(B165)+(B216), (A)+(B165)+(B217), (A)+(B165)+(B218), (A)+(B165)+(B219), (A)+(B165)+(B220), (A)+(B165)+(B221), (A)+(B165)+(B222), (A)+(B165)+(B223), (A)+(B165)+(B224), (A)+(B165)+(B225), (A)+(B165)+(B226), (A)+(B165)+(B227), (A)+(B165)+(B228), (A)+(B165)+(B229), (A)+(B165)+(B230), (A)+(B165)+(B231), (A)+(B165)+(B232), (A)+(B165)+(B233), (A)+(B165)+(B234), (A)+(B165)+(B235), (A)+(B165)+(B236), (A)+(B165)+(B237), (A)+(B165)+(B238), (A)+(B165)+(B239), (A)+(B165)+(B240), (A)+(B165)+(B241), (A)+(B165)+(B242), (A)+(B165)+(B243), (A)+(B165)+(B244), (A)+(B165)+(B245), (A)+(B165)+(B246), (A)+(B165)+(B247), (A)+(B165)+(B248), (A)+(B165)+(B249), (A)+(B165)+(B250), (A)+(B165)+(B251), (A)+(B165)+(B252), (A)+(B165)+(B253), (A)+(B165)+(B254), (A)+(B165)+(B255), (A)+(B165)+(B256), (A)+(B165)+(B257), (A)+(B165)+(B258), (A)+(B165)+(B259), (A)+(B165)+(B260), (A)+(B165)+(B261), (A)+(B165)+(B262), (A)+(B165)+(B263), (A)+(B165)+(B264), (A)+(B165)+(B265), (A)+(B165)+(B266), (A)+(B165)+(B267), (A)+(B165)+(B268), (A)+(B165)+(B269), (A)+(B165)+(B270), (A)+(B165)+(B271), (A)+(B165)+(B272), (A)+(B165)+(B273), (A)+(B165)+(B274), (A)+(B165)+(B275), (A)+(B165)+(B276), (A)+(B165)+(B277), (A)+(B165)+(B278), (A)+(B165)+(B279), (A)+(B165)+(B280), (A)+(B165)+(B281), (A)+(B165)+(B282), (A)+(B165)+(B283), (A)+(B165)+(B284), (A)+(B165)+(B285), (A)+(B165)+(B286), (A)+(B165)+(B287), (A)+(B165)+(B288), (A)+(B165)+(B289), (A)+(B165)+(B290), (A)+(B165)+(B291), (A)+(B165)+(B292), (A)+(B165)+(B293), (A)+(B165)+(B294), (A)+(B165)+(B295), (A)+(B165)+(B296), (A)+(B165)+(B297), (A)+(B165)+(B298), (A)+(B165)+(B299), (A)+(B165)+(B300), (A)+(B165)+(B301), (A)+(B165)+(B302), (A)+(B165)+(B303), (A)+(B165)+(B304), (A)+(B165)+(B305), (A)+(B165)+(B306), (A)+(B165)+(B307), (A)+(B165)+(B308), (A)+(B165)+(B309), (A)+(B165)+(B310), (A)+(B165)+(B311), (A)+(B165)+(B312), (A)+(B165)+(B313), (A)+(B165)+(B314), (A)+(B165)+(B315),

(A)+(B166)+(B167), (A)+(B166)+(B168), (A)+(B166)+(B169), (A)+(B166)+(B170), (A)+(B166)+(B171), (A)+(B166)+(B172), (A)+(B166)+(B173), (A)+(B166)+(B174), (A)+(B166)+(B175), (A)+(B166)+(B176), (A)+(B166)+(B177), (A)+(B166)+(B178), (A)+(B166)+(B179), (A)+(B166)+(B180), (A)+(B166)+(B181), (A)+(B166)+(B182), (A)+(B166)+(B183), (A)+(B166)+(B184), (A)+(B166)+(B185), (A)+(B166)+(B186), (A)+(B166)+(B187), (A)+(B166)+(B188), (A)+(B166)+(B189), (A)+(B166)+(B190), (A)+(B166)+(B191), (A)+(B166)+(B192), (A)+(B166)+(B193), (A)+(B166)+(B194), (A)+(B166)+(B195), (A)+(B166)+(B196), (A)+(B166)+(B197), (A)+(B166)+(B198), (A)+(B166)+(B199), (A)+(B166)+(B200), (A)+(B166)+(B201), (A)+(B166)+(B202), (A)+(B166)+(B203), (A)+(B166)+(B204), (A)+(B166)+(B205), (A)+(B166)+(B206), (A)+(B166)+(B207), (A)+(B166)+(B208), (A)+(B166)+(B209), (A)+(B166)+(B210), (A)+(B166)+(B211), (A)+(B166)+(B212), (A)+(B166)+(B213), (A)+(B166)+(B214), (A)+(B166)+(B215), (A)+(B166)+(B216), (A)+(B166)+(B217), (A)+(B166)+(B218), (A)+(B166)+(B219), (A)+(B166)+(B220), (A)+(B166)+(B221), (A)+(B166)+(B222), (A)+(B166)+(B223), (A)+(B166)+(B224), (A)+(B166)+(B225), (A)+(B166)+(B226), (A)+(B166)+(B227), (A)+(B166)+(B228), (A)+(B166)+(B229), (A)+(B166)+(B230), (A)+(B166)+(B231), (A)+(B166)+(B232), (A)+(B166)+(B233), (A)+(B166)+(B234), (A)+(B166)+(B235), (A)+(B166)+(B236), (A)+(B166)+(B237), (A)+(B166)+(B238), (A)+(B166)+(B239), (A)+(B166)+(B240), (A)+(B166)+(B241), (A)+(B166)+(B242), (A)+(B166)+(B243), (A)+(B166)+(B244), (A)+(B166)+(B245), (A)+(B166)+(B246), (A)+(B166)+(B247), (A)+(B166)+(B248), (A)+(B166)+(B249), (A)+(B166)+(B250), (A)+(B166)+(B251), (A)+(B166)+(B252), (A)+(B166)+(B253), (A)+(B166)+(B254), (A)+(B166)+(B255), (A)+(B166)+(B256), (A)+(B166)+(B257), (A)+(B166)+(B258), (A)+(B166)+(B259), (A)+(B166)+(B260), (A)+(B166)+(B261), (A)+(B166)+(B262), (A)+(B166)+(B263), (A)+(B166)+(B264), (A)+(B166)+(B265), (A)+(B166)+(B266), (A)+(B166)+(B267), (A)+(B166)+(B268), (A)+(B166)+(B269), (A)+(B166)+(B270), (A)+(B166)+(B271), (A)+(B166)+(B272), (A)+(B166)+(B273), (A)+(B166)+(B274), (A)+(B166)+(B275), (A)+(B166)+(B276), (A)+(B166)+(B277), (A)+(B166)+(B278), (A)+(B166)+(B279), (A)+(B166)+(B280), (A)+(B166)+(B281), (A)+(B166)+(B282), (A)+(B166)+(B283), (A)+(B166)+(B284), (A)+(B166)+(B285), (A)+(B166)+(B286), (A)+(B166)+(B287), (A)+(B166)+(B288), (A)+(B166)+(B289), (A)+(B166)+(B290), (A)+(B166)+(B291), (A)+(B166)+(B292), (A)+(B166)+(B293), (A)+(B166)+(B294), (A)+(B166)+(B295), (A)+(B166)+(B296), (A)+(B166)+(B297), (A)+(B166)+(B298), (A)+(B166)+(B299), (A)+(B166)+(B300), (A)+(B166)+(B301), (A)+(B166)+(B302), (A)+(B166)+(B303), (A)+(B166)+(B304), (A)+(B166)+(B305), (A)+(B166)+(B306), (A)+(B166)+(B307), (A)+(B166)+(B308), (A)+(B166)+(B309), (A)+(B166)+(B310), (A)+(B166)+(B311), (A)+(B166)+(B312), (A)+(B166)+(B313), (A)+(B166)+(B314), (A)+(B166)+(B315),

(A)+(B167)+(B168), (A)+(B167)+(B169), (A)+(B167)+(B170), (A)+(B167)+(B171), (A)+(B167)+(B172), (A)+(B167)+(B173), (A)+(B167)+(B174), (A)+(B167)+(B175), (A)+(B167)+(B176), (A)+(B167)+(B177), (A)+(B167)+(B178), (A)+(B167)+(B179), (A)+(B167)+(B180), (A)+(B167)+(B181), (A)+(B167)+(B182), (A)+(B167)+(B183), (A)+(B167)+(B184), (A)+(B167)+(B185), (A)+(B167)+(B186), (A)+(B167)+(B187), (A)+(B167)+(B188), (A)+(B167)+(B189), (A)+(B167)+(B190), (A)+(B167)+(B191), (A)+(B167)+(B192), (A)+(B167)+(B193), (A)+(B167)+(B194), (A)+(B167)+(B195), (A)+(B167)+(B196), (A)+(B167)+(B197), (A)+(B167)+(B198), (A)+(B167)+(B199), (A)+(B167)+(B200), (A)+(B167)+(B201), (A)+(B167)+(B202), (A)+(B167)+(B203), (A)+(B167)+(B204), (A)+(B167)+(B205), (A)+(B167)+(B206), (A)+(B167)+(B207), (A)+(B167)+(B208), (A)+(B167)+(B209), (A)+(B167)+(B210), (A)+(B167)+(B211), (A)+(B167)+(B212), (A)+(B167)+(B213), (A)+(B167)+(B214), (A)+(B167)+(B215), (A)+(B167)+(B216), (A)+(B167)+(B217), (A)+(B167)+(B218), (A)+(B167)+(B219), (A)+(B167)+(B220), (A)+(B167)+(B221), (A)+(B167)+(B222), (A)+(B167)+(B223), (A)+(B167)+(B224), (A)+(B167)+(B225), (A)+(B167)+(B226), (A)+(B167)+(B227), (A)+(B167)+(B228), (A)+(B167)+(B229), (A)+(B167)+(B230), (A)+(B167)+(B231), (A)+(B167)+(B232), (A)+(B167)+(B233), (A)+(B167)+(B234), (A)+(B167)+(B235), (A)+(B167)+(B236), (A)+(B167)+(B237), (A)+(B167)+(B238), (A)+(B167)+(B239), (A)+(B167)+(B240), (A)+(B167)+(B241), (A)+(B167)+(B242), (A)+(B167)+(B243), (A)+(B167)+(B244), (A)+(B167)+(B245), (A)+(B167)+(B246), (A)+(B167)+(B247), (A)+(B167)+(B248), (A)+(B167)+(B249), (A)+(B167)+(B250), (A)+(B167)+(B251), (A)+(B167)+(B252), (A)+(B167)+(B253), (A)+(B167)+(B254), (A)+(B167)+(B255), (A)+(B167)+(B256), (A)+(B167)+(B257), (A)+(B167)+(B258), (A)+(B167)+(B259), (A)+(B167)+(B260), (A)+(B167)+(B261), (A)+(B167)+(B262), (A)+(B167)+(B263), (A)+(B167)+(B264), (A)+(B167)+(B265), (A)+(B167)+(B266), (A)+(B167)+(B267), (A)+(B167)+(B268), (A)+(B167)+(B269), (A)+(B167)+(B270), (A)+(B167)+(B271), (A)+(B167)+(B272), (A)+(B167)+(B273), (A)+(B167)+(B274), (A)+(B167)+(B275), (A)+(B167)+(B276), (A)+(B167)+(B277), (A)+(B167)+(B278), (A)+(B167)+(B279), (A)+(B167)+(B280), (A)+(B167)+(B281), (A)+(B167)+(B282), (A)+(B167)+(B283), (A)+(B167)+(B284), (A)+(B167)+(B285), (A)+(B167)+(B286), (A)+(B167)+(B287), (A)+(B167)+(B288), (A)+(B167)+(B289), (A)+(B167)+(B290), (A)+(B167)+(B291), (A)+(B167)+(B292), (A)+(B167)+(B293), (A)+(B167)+(B294), (A)+(B167)+(B295), (A)+(B167)+(B296), (A)+(B167)+(B297), (A)+(B167)+(B298), (A)+(B167)+(B299), (A)+(B167)+(B300), (A)+(B167)+(B301), (A)+(B167)+(B302), (A)+(B167)+(B303), (A)+(B167)+(B304), (A)+(B167)+(B305), (A)+(B167)+(B306), (A)+(B167)+(B307), (A)+(B167)+(B308), (A)+(B167)+(B309), (A)+(B167)+(B310), (A)+(B167)+(B311), (A)+(B167)+(B312), (A)+(B167)+(B313), (A)+(B167)+(B314), (A)+(B167)+(B315),

(A)+(B168)+(B169), (A)+(B168)+(B170), (A)+(B168)+(B171), (A)+(B168)+(B172), (A)+(B168)+(B173), (A)+(B168)+(B174), (A)+(B168)+(B175), (A)+(B168)+(B176), (A)+(B168)+(B177), (A)+(B168)+(B178), (A)+(B168)+(B179), (A)+(B168)+(B180), (A)+(B168)+(B181), (A)+(B168)+(B182), (A)+(B168)+(B183), (A)+(B168)+(B184), (A)+(B168)+(B185), (A)+(B168)+(B186), (A)+(B168)+(B187), (A)+(B168)+(B188), (A)+(B168)+(B189), (A)+(B168)+(B190), (A)+(B168)+(B191), (A)+(B168)+(B192), (A)+(B168)+(B193), (A)+(B168)+(B194), (A)+(B168)+(B195), (A)+(B168)+(B196), (A)+(B168)+(B197), (A)+(B168)+(B198), (A)+(B168)+(B199), (A)+(B168)+(B200), (A)+(B168)+(B201), (A)+(B168)+(B202), (A)+(B168)+(B203), (A)+(B168)+(B204), (A)+(B168)+(B205), (A)+(B168)+(B206), (A)+(B168)+(B207), (A)+(B168)+(B208), (A)+(B168)+(B209), (A)+(B168)+(B210), (A)+(B168)+(B211), (A)+(B168)+(B212), (A)+(B168)+(B213), (A)+(B168)+(B214), (A)+(B168)+(B215), (A)+(B168)+(B216), (A)+(B168)+(B217), (A)+(B168)+(B218), (A)+(B168)+(B219), (A)+(B168)+(B220), (A)+(B168)+(B221), (A)+(B168)+(B222), (A)+(B168)+(B223), (A)+(B168)+(B224), (A)+(B168)+(B225), (A)+(B168)+(B226), (A)+(B168)+(B227), (A)+(B168)+(B228), (A)+(B168)+(B229), (A)+(B168)+(B230), (A)+(B168)+(B231), (A)+(B168)+(B232), (A)+(B168)+(B233), (A)+(B168)+(B234), (A)+(B168)+(B235), (A)+(B168)+(B236), (A)+(B168)+(B237), (A)+(B168)+(B238), (A)+(B168)+(B239), (A)+(B168)+(B240), (A)+(B168)+(B241), (A)+(B168)+(B242), (A)+(B168)+(B243), (A)+(B168)+(B244), (A)+(B168)+(B245), (A)+(B168)+(B246), (A)+(B168)+(B247), (A)+(B168)+(B248), (A)+(B168)+(B249), (A)+(B168)+(B250), (A)+(B168)+(B251), (A)+(B168)+(B252), (A)+(B168)+(B253), (A)+(B168)+(B254), (A)+(B168)+(B255), (A)+(B168)+(B256), (A)+(B168)+(B257), (A)+(B168)+(B258), (A)+(B168)+(B259), (A)+(B168)+(B260), (A)+(B168)+(B261), (A)+(B168)+(B262), (A)+(B168)+(B263), (A)+(B168)+(B264), (A)+(B168)+(B265), (A)+(B168)+(B266), (A)+(B168)+(B267), (A)+(B168)+(B268), (A)+(B168)+(B269), (A)+(B168)+(B270), (A)+(B168)+(B271), (A)+(B168)+(B272), (A)+(B168)+(B273), (A)+(B168)+(B274), (A)+(B168)+(B275), (A)+(B168)+(B276), (A)+(B168)+(B277), (A)+(B168)+(B278), (A)+(B168)+(B279), (A)+(B168)+(B280), (A)+(B168)+(B281), (A)+(B168)+(B282), (A)+(B168)+(B283), (A)+(B168)+(B284), (A)+(B168)+(B285), (A)+(B168)+(B286), (A)+(B168)+(B287), (A)+(B168)+(B288), (A)+(B168)+(B289), (A)+(B168)+(B290), (A)+(B168)+(B291), (A)+(B168)+(B292), (A)+(B168)+(B293), (A)+(B168)+(B294), (A)+(B168)+(B295), (A)+(B168)+(B296), (A)+(B168)+(B297), (A)+(B168)+(B298), (A)+(B168)+(B299), (A)+(B168)+(B300), (A)+(B168)+(B301), (A)+(B168)+(B302), (A)+(B168)+(B303), (A)+(B168)+(B304), (A)+(B168)+(B305), (A)+(B168)+(B306), (A)+(B168)+(B307), (A)+(B168)+(B308), (A)+(B168)+(B309), (A)+(B168)+(B310), (A)+(B168)+(B311), (A)+(B168)+(B312), (A)+(B168)+(B313), (A)+(B168)+(B314), (A)+(B168)+(B315),

(A)+(B169)+(B170), (A)+(B169)+(B171), (A)+(B169)+(B172), (A)+(B169)+(B173), (A)+(B169)+(B174), (A)+(B169)+(B175), (A)+(B169)+(B176), (A)+(B169)+(B177), (A)+(B169)+(B178), (A)+(B169)+(B179), (A)+(B169)+(B180), (A)+(B169)+(B181), (A)+(B169)+(B182), (A)+(B169)+(B183), (A)+(B169)+(B184), (A)+(B169)+(B185), (A)+(B169)+(B186), (A)+(B169)+(B187), (A)+(B169)+(B188), (A)+(B169)+(B189), (A)+(B169)+(B190), (A)+(B169)+(B191), (A)+(B169)+(B192), (A)+(B169)+(B193), (A)+(B169)+(B194), (A)+(B169)+(B195), (A)+(B169)+(B196), (A)+(B169)+(B197), (A)+(B169)+(B198), (A)+(B169)+(B199), (A)+(B169)+(B200), (A)+(B169)+(B201), (A)+(B169)+(B202), (A)+(B169)+(B203), (A)+(B169)+(B204), (A)+(B169)+(B205), (A)+(B169)+(B206), (A)+(B169)+(B207), (A)+(B169)+(B208), (A)+(B169)+(B209), (A)+(B169)+(B210), (A)+(B169)+(B211), (A)+(B169)+(B212), (A)+(B169)+(B213), (A)+(B169)+(B214), (A)+(B169)+(B215), (A)+(B169)+(B216), (A)+(B169)+(B217), (A)+(B169)+(B218), (A)+(B169)+(B219), (A)+(B169)+(B220), (A)+(B169)+(B221), (A)+(B169)+(B222), (A)+(B169)+(B223), (A)+(B169)+(B224), (A)+(B169)+(B225), (A)+(B169)+(B226), (A)+(B169)+(B227), (A)+(B169)+(B228), (A)+(B169)+(B229), (A)+(B169)+(B230), (A)+(B169)+(B231), (A)+(B169)+(B232), (A)+(B169)+(B233), (A)+(B169)+(B234), (A)+(B169)+(B235), (A)+(B169)+(B236), (A)+(B169)+(B237), (A)+(B169)+(B238), (A)+(B169)+(B239), (A)+(B169)+(B240), (A)+(B169)+(B241), (A)+(B169)+(B242), (A)+(B169)+(B243), (A)+(B169)+(B244), (A)+(B169)+(B245), (A)+(B169)+(B246), (A)+(B169)+(B247), (A)+(B169)+(B248), (A)+(B169)+(B249), (A)+(B169)+(B250), (A)+(B169)+(B251), (A)+(B169)+(B252), (A)+(B169)+(B253), (A)+(B169)+(B254), (A)+(B169)+(B255), (A)+(B169)+(B256), (A)+(B169)+(B257), (A)+(B169)+(B258), (A)+(B169)+(B259), (A)+(B169)+(B260), (A)+(B169)+(B261), (A)+(B169)+(B262), (A)+(B169)+(B263), (A)+(B169)+(B264), (A)+(B169)+(B265), (A)+(B169)+(B266), (A)+(B169)+(B267), (A)+(B169)+(B268), (A)+(B169)+(B269), (A)+(B169)+(B270), (A)+(B169)+(B271), (A)+(B169)+(B272), (A)+(B169)+(B273), (A)+(B169)+(B274), (A)+(B169)+(B275), (A)+(B169)+(B276), (A)+(B169)+(B277), (A)+(B169)+(B278), (A)+(B169)+(B279), (A)+(B169)+(B280), (A)+(B169)+(B281), (A)+(B169)+(B282), (A)+(B169)+(B283), (A)+(B169)+(B284), (A)+(B169)+(B285), (A)+(B169)+(B286), (A)+(B169)+(B287), (A)+(B169)+(B288), (A)+(B169)+(B289), (A)+(B169)+(B290), (A)+(B169)+(B291), (A)+(B169)+(B292), (A)+(B169)+(B293), (A)+(B169)+(B294), (A)+(B169)+(B295), (A)+(B169)+(B296), (A)+(B169)+(B297), (A)+(B169)+(B298), (A)+(B169)+(B299), (A)+(B169)+(B300), (A)+(B169)+(B301), (A)+(B169)+(B302), (A)+(B169)+(B303), (A)+(B169)+(B304), (A)+(B169)+(B305), (A)+(B169)+(B306), (A)+(B169)+(B307), (A)+(B169)+(B308), (A)+(B169)+(B309), (A)+(B169)+(B310), (A)+(B169)+(B311), (A)+(B169)+(B312), (A)+(B169)+(B313), (A)+(B169)+(B314), (A)+(B169)+(B315),

(A)+(B170)+(B171), (A)+(B170)+(B172), (A)+(B170)+(B173), (A)+(B170)+(B174), (A)+(B170)+(B175), (A)+(B170)+(B176), (A)+(B170)+(B177), (A)+(B170)+(B178), (A)+(B170)+(B179), (A)+(B170)+(B180), (A)+(B170)+(B181), (A)+(B170)+(B182), (A)+(B170)+(B183), (A)+(B170)+(B184), (A)+(B170)+(B185), (A)+(B170)+(B186), (A)+(B170)+(B187), (A)+(B170)+(B188), (A)+(B170)+(B189), (A)+(B170)+(B190), (A)+(B170)+(B191), (A)+(B170)+(B192), (A)+(B170)+(B193), (A)+(B170)+(B194), (A)+(B170)+(B195), (A)+(B170)+(B196), (A)+(B170)+(B197), (A)+(B170)+(B198), (A)+(B170)+(B199), (A)+(B170)+(B200), (A)+(B170)+(B201), (A)+(B170)+(B202), (A)+(B170)+(B203), (A)+(B170)+(B204), (A)+(B170)+(B205), (A)+(B170)+(B206), (A)+(B170)+(B207), (A)+(B170)+(B208), (A)+(B170)+(B209), (A)+(B170)+(B210), (A)+(B170)+(B211), (A)+(B170)+(B212), (A)+(B170)+(B213), (A)+(B170)+(B214), (A)+(B170)+(B215), (A)+(B170)+(B216), (A)+(B170)+(B217), (A)+(B170)+(B218), (A)+(B170)+(B219), (A)+(B170)+(B220), (A)+(B170)+(B221), (A)+(B170)+(B222), (A)+(B170)+(B223), (A)+(B170)+(B224), (A)+(B170)+(B225), (A)+(B170)+(B226), (A)+(B170)+(B227), (A)+(B170)+(B228), (A)+(B170)+(B229), (A)+(B170)+(B230), (A)+(B170)+(B231), (A)+(B170)+(B232), (A)+(B170)+(B233), (A)+(B170)+(B234), (A)+(B170)+(B235), (A)+(B170)+(B236), (A)+(B170)+(B237), (A)+(B170)+(B238), (A)+(B170)+(B239), (A)+(B170)+(B240), (A)+(B170)+(B241), (A)+(B170)+(B242), (A)+(B170)+(B243), (A)+(B170)+(B244), (A)+(B170)+(B245), (A)+(B170)+(B246), (A)+(B170)+(B247), (A)+(B170)+(B248), (A)+(B170)+(B249), (A)+(B170)+(B250), (A)+(B170)+(B251), (A)+(B170)+(B252), (A)+(B170)+(B253), (A)+(B170)+(B254), (A)+(B170)+(B255), (A)+(B170)+(B256), (A)+(B170)+(B257), (A)+(B170)+(B258), (A)+(B170)+(B259), (A)+(B170)+(B260), (A)+(B170)+(B261), (A)+(B170)+(B262), (A)+(B170)+(B263), (A)+(B170)+(B264), (A)+(B170)+(B265), (A)+(B170)+(B266), (A)+(B170)+(B267), (A)+(B170)+(B268), (A)+(B170)+(B269), (A)+(B170)+(B270), (A)+(B170)+(B271), (A)+(B170)+(B272), (A)+(B170)+(B273), (A)+(B170)+(B274), (A)+(B170)+(B275), (A)+(B170)+(B276), (A)+(B170)+(B277), (A)+(B170)+(B278), (A)+(B170)+(B279), (A)+(B170)+(B280), (A)+(B170)+(B281), (A)+(B170)+(B282), (A)+(B170)+(B283), (A)+(B170)+(B284), (A)+(B170)+(B285), (A)+(B170)+(B286), (A)+(B170)+(B287), (A)+(B170)+(B288), (A)+(B170)+(B289), (A)+(B170)+(B290), (A)+(B170)+(B291), (A)+(B170)+(B292), (A)+(B170)+(B293), (A)+(B170)+(B294), (A)+(B170)+(B295), (A)+(B170)+(B296), (A)+(B170)+(B297), (A)+(B170)+(B298), (A)+(B170)+(B299), (A)+(B170)+(B300), (A)+(B170)+(B301), (A)+(B170)+(B302), (A)+(B170)+(B303), (A)+(B170)+(B304), (A)+(B170)+(B305), (A)+(B170)+(B306), (A)+(B170)+(B307), (A)+(B170)+(B308), (A)+(B170)+(B309), (A)+(B170)+(B310), (A)+(B170)+(B311), (A)+(B170)+(B312), (A)+(B170)+(B313), (A)+(B170)+(B314), (A)+(B170)+(B315),

(A)+(B171)+(B172), (A)+(B171)+(B173), (A)+(B171)+(B174), (A)+(B171)+(B175), (A)+(B171)+(B176), (A)+(B171)+(B177), (A)+(B171)+(B178), (A)+(B171)+(B179), (A)+(B171)+(B180), (A)+(B171)+(B181), (A)+(B171)+(B182), (A)+(B171)+(B183), (A)+(B171)+(B184), (A)+(B171)+(B185), (A)+(B171)+(B186), (A)+(B171)+(B187), (A)+(B171)+(B188), (A)+(B171)+(B189), (A)+(B171)+(B190), (A)+(B171)+(B191), (A)+(B171)+(B192), (A)+(B171)+(B193), (A)+(B171)+(B194), (A)+(B171)+(B195), (A)+(B171)+(B196), (A)+(B171)+(B197), (A)+(B171)+(B198), (A)+(B171)+(B199), (A)+(B171)+(B200), (A)+(B171)+(B201), (A)+(B171)+(B202), (A)+(B171)+(B203), (A)+(B171)+(B204), (A)+(B171)+(B205), (A)+(B171)+(B206), (A)+(B171)+(B207), (A)+(B171)+(B208), (A)+(B171)+(B209), (A)+(B171)+(B210), (A)+(B171)+(B211), (A)+(B171)+(B212), (A)+(B171)+(B213), (A)+(B171)+(B214), (A)+(B171)+(B215), (A)+(B171)+(B216), (A)+(B171)+(B217), (A)+(B171)+(B218), (A)+(B171)+(B219), (A)+(B171)+(B220), (A)+(B171)+(B221), (A)+(B171)+(B222), (A)+(B171)+(B223), (A)+(B171)+(B224), (A)+(B171)+(B225), (A)+(B171)+(B226), (A)+(B171)+(B227), (A)+(B171)+(B228), (A)+(B171)+(B229), (A)+(B171)+(B230), (A)+(B171)+(B231), (A)+(B171)+(B232), (A)+(B171)+(B233), (A)+(B171)+(B234), (A)+(B171)+(B235), (A)+(B171)+(B236), (A)+(B171)+(B237), (A)+(B171)+(B238), (A)+(B171)+(B239), (A)+(B171)+(B240), (A)+(B171)+(B241), (A)+(B171)+(B242), (A)+(B171)+(B243), (A)+(B171)+(B244), (A)+(B171)+(B245), (A)+(B171)+(B246), (A)+(B171)+(B247), (A)+(B171)+(B248), (A)+(B171)+(B249), (A)+(B171)+(B250), (A)+(B171)+(B251), (A)+(B171)+(B252), (A)+(B171)+(B253), (A)+(B171)+(B254), (A)+(B171)+(B255), (A)+(B171)+(B256), (A)+(B171)+(B257), (A)+(B171)+(B258), (A)+(B171)+(B259), (A)+(B171)+(B260), (A)+(B171)+(B261), (A)+(B171)+(B262), (A)+(B171)+(B263), (A)+(B171)+(B264), (A)+(B171)+(B265), (A)+(B171)+(B266), (A)+(B171)+(B267), (A)+(B171)+(B268), (A)+(B171)+(B269), (A)+(B171)+(B270), (A)+(B171)+(B271), (A)+(B171)+(B272), (A)+(B171)+(B273), (A)+(B171)+(B274), (A)+(B171)+(B275), (A)+(B171)+(B276), (A)+(B171)+(B277), (A)+(B171)+(B278), (A)+(B171)+(B279), (A)+(B171)+(B280), (A)+(B171)+(B281), (A)+(B171)+(B282), (A)+(B171)+(B283), (A)+(B171)+(B284), (A)+(B171)+(B285), (A)+(B171)+(B286), (A)+(B171)+(B287), (A)+(B171)+(B288), (A)+(B171)+(B289), (A)+(B171)+(B290), (A)+(B171)+(B291), (A)+(B171)+(B292), (A)+(B171)+(B293), (A)+(B171)+(B294), (A)+(B171)+(B295), (A)+(B171)+(B296), (A)+(B171)+(B297), (A)+(B171)+(B298), (A)+(B171)+(B299), (A)+(B171)+(B300), (A)+(B171)+(B301), (A)+(B171)+(B302), (A)+(B171)+(B303), (A)+(B171)+(B304), (A)+(B171)+(B305), (A)+(B171)+(B306), (A)+(B171)+(B307), (A)+(B171)+(B308), (A)+(B171)+(B309), (A)+(B171)+(B310), (A)+(B171)+(B311), (A)+(B171)+(B312), (A)+(B171)+(B313), (A)+(B171)+(B314), (A)+(B171)+(B315),

(A)+(B172)+(B173), (A)+(B172)+(B174), (A)+(B172)+(B175), (A)+(B172)+(B176), (A)+(B172)+(B177), (A)+(B172)+(B178), (A)+(B172)+(B179), (A)+(B172)+(B180), (A)+(B172)+(B181), (A)+(B172)+(B182), (A)+(B172)+(B183), (A)+(B172)+(B184), (A)+(B172)+(B185), (A)+(B172)+(B186), (A)+(B172)+(B187), (A)+(B172)+(B188), (A)+(B172)+(B189), (A)+(B172)+(B190), (A)+(B172)+(B191), (A)+(B172)+(B192), (A)+(B172)+(B193), (A)+(B172)+(B194), (A)+(B172)+(B195), (A)+(B172)+(B196), (A)+(B172)+(B197), (A)+(B172)+(B198), (A)+(B172)+(B199), (A)+(B172)+(B200), (A)+(B172)+(B201), (A)+(B172)+(B202), (A)+(B172)+(B203), (A)+(B172)+(B204), (A)+(B172)+(B205), (A)+(B172)+(B206), (A)+(B172)+(B207), (A)+(B172)+(B208), (A)+(B172)+(B209), (A)+(B172)+(B210), (A)+(B172)+(B211), (A)+(B172)+(B212), (A)+(B172)+(B213), (A)+(B172)+(B214), (A)+(B172)+(B215), (A)+(B172)+(B216), (A)+(B172)+(B217), (A)+(B172)+(B218), (A)+(B172)+(B219), (A)+(B172)+(B220), (A)+(B172)+(B221), (A)+(B172)+(B222), (A)+(B172)+(B223), (A)+(B172)+(B224), (A)+(B172)+(B225), (A)+(B172)+(B226), (A)+(B172)+(B227), (A)+(B172)+(B228), (A)+(B172)+(B229), (A)+(B172)+(B230), (A)+(B172)+(B231), (A)+(B172)+(B232), (A)+(B172)+(B233), (A)+(B172)+(B234), (A)+(B172)+(B235), (A)+(B172)+(B236), (A)+(B172)+(B237), (A)+(B172)+(B238), (A)+(B172)+(B239), (A)+(B172)+(B240), (A)+(B172)+(B241), (A)+(B172)+(B242), (A)+(B172)+(B243), (A)+(B172)+(B244), (A)+(B172)+(B245), (A)+(B172)+(B246), (A)+(B172)+(B247), (A)+(B172)+(B248), (A)+(B172)+(B249), (A)+(B172)+(B250), (A)+(B172)+(B251), (A)+(B172)+(B252), (A)+(B172)+(B253), (A)+(B172)+(B254), (A)+(B172)+(B255), (A)+(B172)+(B256), (A)+(B172)+(B257), (A)+(B172)+(B258), (A)+(B172)+(B259), (A)+(B172)+(B260), (A)+(B172)+(B261), (A)+(B172)+(B262), (A)+(B172)+(B263), (A)+(B172)+(B264), (A)+(B172)+(B265), (A)+(B172)+(B266), (A)+(B172)+(B267), (A)+(B172)+(B268), (A)+(B172)+(B269), (A)+(B172)+(B270), (A)+(B172)+(B271), (A)+(B172)+(B272), (A)+(B172)+(B273), (A)+(B172)+(B274), (A)+(B172)+(B275), (A)+(B172)+(B276), (A)+(B172)+(B277), (A)+(B172)+(B278), (A)+(B172)+(B279), (A)+(B172)+(B280), (A)+(B172)+(B281), (A)+(B172)+(B282), (A)+(B172)+(B283), (A)+(B172)+(B284), (A)+(B172)+(B285), (A)+(B172)+(B286), (A)+(B172)+(B287), (A)+(B172)+(B288), (A)+(B172)+(B289), (A)+(B172)+(B290), (A)+(B172)+(B291), (A)+(B172)+(B292), (A)+(B172)+(B293), (A)+(B172)+(B294), (A)+(B172)+(B295), (A)+(B172)+(B296), (A)+(B172)+(B297), (A)+(B172)+(B298), (A)+(B172)+(B299), (A)+(B172)+(B300), (A)+(B172)+(B301), (A)+(B172)+(B302), (A)+(B172)+(B303), (A)+(B172)+(B304), (A)+(B172)+(B305), (A)+(B172)+(B306), (A)+(B172)+(B307), (A)+(B172)+(B308), (A)+(B172)+(B309), (A)+(B172)+(B310), (A)+(B172)+(B311), (A)+(B172)+(B312), (A)+(B172)+(B313), (A)+(B172)+(B314), (A)+(B172)+(B315),

(A)+(B173)+(B174), (A)+(B173)+(B175), (A)+(B173)+(B176), (A)+(B173)+(B177), (A)+(B173)+(B178), (A)+(B173)+(B179), (A)+(B173)+(B180), (A)+(B173)+(B181), (A)+(B173)+(B182), (A)+(B173)+(B183), (A)+(B173)+(B184), (A)+(B173)+(B185), (A)+(B173)+(B186), (A)+(B173)+(B187), (A)+(B173)+(B188), (A)+(B173)+(B189), (A)+(B173)+(B190), (A)+(B173)+(B191), (A)+(B173)+(B192), (A)+(B173)+(B193), (A)+(B173)+(B194), (A)+(B173)+(B195), (A)+(B173)+(B196), (A)+(B173)+(B197), (A)+(B173)+(B198), (A)+(B173)+(B199), (A)+(B173)+(B200), (A)+(B173)+(B201), (A)+(B173)+(B202), (A)+(B173)+(B203), (A)+(B173)+(B204), (A)+(B173)+(B205), (A)+(B173)+(B206), (A)+(B173)+(B207), (A)+(B173)+(B208), (A)+(B173)+(B209), (A)+(B173)+(B210), (A)+(B173)+(B211), (A)+(B173)+(B212), (A)+(B173)+(B213), (A)+(B173)+(B214), (A)+(B173)+(B215), (A)+(B173)+(B216), (A)+(B173)+(B217), (A)+(B173)+(B218), (A)+(B173)+(B219), (A)+(B173)+(B220), (A)+(B173)+(B221), (A)+(B173)+(B222), (A)+(B173)+(B223), (A)+(B173)+(B224), (A)+(B173)+(B225), (A)+(B173)+(B226), (A)+(B173)+(B227), (A)+(B173)+(B228), (A)+(B173)+(B229), (A)+(B173)+(B230), (A)+(B173)+(B231), (A)+(B173)+(B232), (A)+(B173)+(B233), (A)+(B173)+(B234), (A)+(B173)+(B235), (A)+(B173)+(B236), (A)+(B173)+(B237), (A)+(B173)+(B238), (A)+(B173)+(B239), (A)+(B173)+(B240), (A)+(B173)+(B241), (A)+(B173)+(B242), (A)+(B173)+(B243), (A)+(B173)+(B244), (A)+(B173)+(B245), (A)+(B173)+(B246), (A)+(B173)+(B247), (A)+(B173)+(B248), (A)+(B173)+(B249), (A)+(B173)+(B250), (A)+(B173)+(B251), (A)+(B173)+(B252), (A)+(B173)+(B253), (A)+(B173)+(B254), (A)+(B173)+(B255), (A)+(B173)+(B256), (A)+(B173)+(B257), (A)+(B173)+(B258), (A)+(B173)+(B259), (A)+(B173)+(B260), (A)+(B173)+(B261), (A)+(B173)+(B262), (A)+(B173)+(B263), (A)+(B173)+(B264), (A)+(B173)+(B265), (A)+(B173)+(B266), (A)+(B173)+(B267), (A)+(B173)+(B268), (A)+(B173)+(B269), (A)+(B173)+(B270), (A)+(B173)+(B271), (A)+(B173)+(B272), (A)+(B173)+(B273), (A)+(B173)+(B274), (A)+(B173)+(B275), (A)+(B173)+(B276), (A)+(B173)+(B277), (A)+(B173)+(B278), (A)+(B173)+(B279), (A)+(B173)+(B280), (A)+(B173)+(B281), (A)+(B173)+(B282), (A)+(B173)+(B283), (A)+(B173)+(B284), (A)+(B173)+(B285), (A)+(B173)+(B286), (A)+(B173)+(B287), (A)+(B173)+(B288), (A)+(B173)+(B289), (A)+(B173)+(B290), (A)+(B173)+(B291), (A)+(B173)+(B292), (A)+(B173)+(B293), (A)+(B173)+(B294), (A)+(B173)+(B295), (A)+(B173)+(B296), (A)+(B173)+(B297), (A)+(B173)+(B298), (A)+(B173)+(B299), (A)+(B173)+(B300), (A)+(B173)+(B301), (A)+(B173)+(B302), (A)+(B173)+(B303), (A)+(B173)+(B304), (A)+(B173)+(B305), (A)+(B173)+(B306), (A)+(B173)+(B307), (A)+(B173)+(B308), (A)+(B173)+(B309), (A)+(B173)+(B310), (A)+(B173)+(B311), (A)+(B173)+(B312), (A)+(B173)+(B313), (A)+(B173)+(B314), (A)+(B173)+(B315),

(A)+(B174)+(B175), (A)+(B174)+(B176), (A)+(B174)+(B177), (A)+(B174)+(B178), (A)+(B174)+(B179), (A)+(B174)+(B180), (A)+(B174)+(B181), (A)+(B174)+(B182), (A)+(B174)+(B183), (A)+(B174)+(B184), (A)+(B174)+(B185), (A)+(B174)+(B186), (A)+(B174)+(B187), (A)+(B174)+(B188), (A)+(B174)+(B189), (A)+(B174)+(B190), (A)+(B174)+(B191), (A)+(B174)+(B192), (A)+(B174)+(B193), (A)+(B174)+(B194), (A)+(B174)+(B195), (A)+(B174)+(B196), (A)+(B174)+(B197), (A)+(B174)+(B198), (A)+(B174)+(B199), (A)+(B174)+(B200), (A)+(B174)+(B201), (A)+(B174)+(B202), (A)+(B174)+(B203), (A)+(B174)+(B204), (A)+(B174)+(B205), (A)+(B174)+(B206), (A)+(B174)+(B207), (A)+(B174)+(B208), (A)+(B174)+(B209), (A)+(B174)+(B210), (A)+(B174)+(B211), (A)+(B174)+(B212), (A)+(B174)+(B213), (A)+(B174)+(B214), (A)+(B174)+(B215), (A)+(B174)+(B216), (A)+(B174)+(B217), (A)+(B174)+(B218), (A)+(B174)+(B219), (A)+(B174)+(B220), (A)+(B174)+(B221), (A)+(B174)+(B222), (A)+(B174)+(B223), (A)+(B174)+(B224), (A)+(B174)+(B225), (A)+(B174)+(B226), (A)+(B174)+(B227), (A)+(B174)+(B228), (A)+(B174)+(B229), (A)+(B174)+(B230), (A)+(B174)+(B231), (A)+(B174)+(B232), (A)+(B174)+(B233), (A)+(B174)+(B234), (A)+(B174)+(B235), (A)+(B174)+(B236), (A)+(B174)+(B237), (A)+(B174)+(B238), (A)+(B174)+(B239), (A)+(B174)+(B240), (A)+(B174)+(B241), (A)+(B174)+(B242), (A)+(B174)+(B243), (A)+(B174)+(B244), (A)+(B174)+(B245), (A)+(B174)+(B246), (A)+(B174)+(B247), (A)+(B174)+(B248), (A)+(B174)+(B249), (A)+(B174)+(B250), (A)+(B174)+(B251), (A)+(B174)+(B252), (A)+(B174)+(B253), (A)+(B174)+(B254), (A)+(B174)+(B255), (A)+(B174)+(B256), (A)+(B174)+(B257), (A)+(B174)+(B258), (A)+(B174)+(B259), (A)+(B174)+(B260), (A)+(B174)+(B261), (A)+(B174)+(B262), (A)+(B174)+(B263), (A)+(B174)+(B264), (A)+(B174)+(B265), (A)+(B174)+(B266), (A)+(B174)+(B267), (A)+(B174)+(B268), (A)+(B174)+(B269), (A)+(B174)+(B270), (A)+(B174)+(B271), (A)+(B174)+(B272), (A)+(B174)+(B273), (A)+(B174)+(B274), (A)+(B174)+(B275), (A)+(B174)+(B276), (A)+(B174)+(B277), (A)+(B174)+(B278), (A)+(B174)+(B279), (A)+(B174)+(B280), (A)+(B174)+(B281), (A)+(B174)+(B282), (A)+(B174)+(B283), (A)+(B174)+(B284), (A)+(B174)+(B285), (A)+(B174)+(B286), (A)+(B174)+(B287), (A)+(B174)+(B288), (A)+(B174)+(B289), (A)+(B174)+(B290), (A)+(B174)+(B291), (A)+(B174)+(B292), (A)+(B174)+(B293), (A)+(B174)+(B294), (A)+(B174)+(B295), (A)+(B174)+(B296), (A)+(B174)+(B297), (A)+(B174)+(B298), (A)+(B174)+(B299), (A)+(B174)+(B300), (A)+(B174)+(B301), (A)+(B174)+(B302), (A)+(B174)+(B303), (A)+(B174)+(B304), (A)+(B174)+(B305), (A)+(B174)+(B306), (A)+(B174)+(B307), (A)+(B174)+(B308), (A)+(B174)+(B309), (A)+(B174)+(B310), (A)+(B174)+(B311), (A)+(B174)+(B312), (A)+(B174)+(B313), (A)+(B174)+(B314), (A)+(B174)+(B315),

(A)+(B175)+(B176), (A)+(B175)+(B177), (A)+(B175)+(B178), (A)+(B175)+(B179), (A)+(B175)+(B180), (A)+(B175)+(B181), (A)+(B175)+(B182), (A)+(B175)+(B183), (A)+(B175)+(B184), (A)+(B175)+(B185), (A)+(B175)+(B186), (A)+(B175)+(B187), (A)+(B175)+(B188), (A)+(B175)+(B189), (A)+(B175)+(B190), (A)+(B175)+(B191), (A)+(B175)+(B192), (A)+(B175)+(B193), (A)+(B175)+(B194), (A)+(B175)+(B195), (A)+(B175)+(B196), (A)+(B175)+(B197), (A)+(B175)+(B198), (A)+(B175)+(B199), (A)+(B175)+(B200), (A)+(B175)+(B201), (A)+(B175)+(B202), (A)+(B175)+(B203), (A)+(B175)+(B204), (A)+(B175)+(B205), (A)+(B175)+(B206), (A)+(B175)+(B207), (A)+(B175)+(B208), (A)+(B175)+(B209), (A)+(B175)+(B210), (A)+(B175)+(B211), (A)+(B175)+(B212), (A)+(B175)+(B213), (A)+(B175)+(B214), (A)+(B175)+(B215), (A)+(B175)+(B216), (A)+(B175)+(B217), (A)+(B175)+(B218), (A)+(B175)+(B219), (A)+(B175)+(B220), (A)+(B175)+(B221), (A)+(B175)+(B222), (A)+(B175)+(B223), (A)+(B175)+(B224), (A)+(B175)+(B225), (A)+(B175)+(B226), (A)+(B175)+(B227), (A)+(B175)+(B228), (A)+(B175)+(B229), (A)+(B175)+(B230), (A)+(B175)+(B231), (A)+(B175)+(B232), (A)+(B175)+(B233), (A)+(B175)+(B234), (A)+(B175)+(B235), (A)+(B175)+(B236), (A)+(B175)+(B237), (A)+(B175)+(B238), (A)+(B175)+(B239), (A)+(B175)+(B240), (A)+(B175)+(B241), (A)+(B175)+(B242), (A)+(B175)+(B243), (A)+(B175)+(B244), (A)+(B175)+(B245), (A)+(B175)+(B246), (A)+(B175)+(B247), (A)+(B175)+(B248), (A)+(B175)+(B249), (A)+(B175)+(B250), (A)+(B175)+(B251), (A)+(B175)+(B252), (A)+(B175)+(B253), (A)+(B175)+(B254), (A)+(B175)+(B255), (A)+(B175)+(B256), (A)+(B175)+(B257), (A)+(B175)+(B258), (A)+(B175)+(B259), (A)+(B175)+(B260), (A)+(B175)+(B261), (A)+(B175)+(B262), (A)+(B175)+(B263), (A)+(B175)+(B264), (A)+(B175)+(B265), (A)+(B175)+(B266), (A)+(B175)+(B267), (A)+(B175)+(B268), (A)+(B175)+(B269), (A)+(B175)+(B270), (A)+(B175)+(B271), (A)+(B175)+(B272), (A)+(B175)+(B273), (A)+(B175)+(B274), (A)+(B175)+(B275), (A)+(B175)+(B276), (A)+(B175)+(B277), (A)+(B175)+(B278), (A)+(B175)+(B279), (A)+(B175)+(B280), (A)+(B175)+(B281), (A)+(B175)+(B282), (A)+(B175)+(B283), (A)+(B175)+(B284), (A)+(B175)+(B285), (A)+(B175)+(B286), (A)+(B175)+(B287), (A)+(B175)+(B288), (A)+(B175)+(B289), (A)+(B175)+(B290), (A)+(B175)+(B291), (A)+(B175)+(B292), (A)+(B175)+(B293), (A)+(B175)+(B294), (A)+(B175)+(B295), (A)+(B175)+(B296), (A)+(B175)+(B297), (A)+(B175)+(B298), (A)+(B175)+(B299), (A)+(B175)+(B300), (A)+(B175)+(B301), (A)+(B175)+(B302), (A)+(B175)+(B303), (A)+(B175)+(B304), (A)+(B175)+(B305), (A)+(B175)+(B306), (A)+(B175)+(B307), (A)+(B175)+(B308), (A)+(B175)+(B309), (A)+(B175)+(B310), (A)+(B175)+(B311), (A)+(B175)+(B312), (A)+(B175)+(B313), (A)+(B175)+(B314), (A)+(B175)+(B315),

(A)+(B176)+(B177), (A)+(B176)+(B178), (A)+(B176)+(B179), (A)+(B176)+(B180), (A)+(B176)+(B181), (A)+(B176)+(B182), (A)+(B176)+(B183), (A)+(B176)+(B184), (A)+(B176)+(B185), (A)+(B176)+(B186), (A)+(B176)+(B187), (A)+(B176)+(B188), (A)+(B176)+(B189), (A)+(B176)+(B190), (A)+(B176)+(B191), (A)+(B176)+(B192), (A)+(B176)+(B193), (A)+(B176)+(B194), (A)+(B176)+(B195), (A)+(B176)+(B196), (A)+(B176)+(B197), (A)+(B176)+(B198), (A)+(B176)+(B199), (A)+(B176)+(B200), (A)+(B176)+(B201), (A)+(B176)+(B202), (A)+(B176)+(B203), (A)+(B176)+(B204), (A)+(B176)+(B205), (A)+(B176)+(B206), (A)+(B176)+(B207), (A)+(B176)+(B208), (A)+(B176)+(B209), (A)+(B176)+(B210), (A)+(B176)+(B211), (A)+(B176)+(B212), (A)+(B176)+(B213), (A)+(B176)+(B214), (A)+(B176)+(B215), (A)+(B176)+(B216), (A)+(B176)+(B217), (A)+(B176)+(B218), (A)+(B176)+(B219), (A)+(B176)+(B220), (A)+(B176)+(B221), (A)+(B176)+(B222), (A)+(B176)+(B223), (A)+(B176)+(B224), (A)+(B176)+(B225), (A)+(B176)+(B226), (A)+(B176)+(B227), (A)+(B176)+(B228), (A)+(B176)+(B229), (A)+(B176)+(B230), (A)+(B176)+(B231), (A)+(B176)+(B232), (A)+(B176)+(B233), (A)+(B176)+(B234), (A)+(B176)+(B235), (A)+(B176)+(B236), (A)+(B176)+(B237), (A)+(B176)+(B238), (A)+(B176)+(B239), (A)+(B176)+(B240), (A)+(B176)+(B241), (A)+(B176)+(B242), (A)+(B176)+(B243), (A)+(B176)+(B244), (A)+(B176)+(B245), (A)+(B176)+(B246), (A)+(B176)+(B247), (A)+(B176)+(B248), (A)+(B176)+(B249), (A)+(B176)+(B250), (A)+(B176)+(B251), (A)+(B176)+(B252), (A)+(B176)+(B253), (A)+(B176)+(B254), (A)+(B176)+(B255), (A)+(B176)+(B256), (A)+(B176)+(B257), (A)+(B176)+(B258), (A)+(B176)+(B259), (A)+(B176)+(B260), (A)+(B176)+(B261), (A)+(B176)+(B262), (A)+(B176)+(B263), (A)+(B176)+(B264), (A)+(B176)+(B265), (A)+(B176)+(B266), (A)+(B176)+(B267), (A)+(B176)+(B268), (A)+(B176)+(B269), (A)+(B176)+(B270), (A)+(B176)+(B271), (A)+(B176)+(B272), (A)+(B176)+(B273), (A)+(B176)+(B274), (A)+(B176)+(B275), (A)+(B176)+(B276), (A)+(B176)+(B277), (A)+(B176)+(B278), (A)+(B176)+(B279), (A)+(B176)+(B280), (A)+(B176)+(B281), (A)+(B176)+(B282), (A)+(B176)+(B283), (A)+(B176)+(B284), (A)+(B176)+(B285), (A)+(B176)+(B286), (A)+(B176)+(B287), (A)+(B176)+(B288), (A)+(B176)+(B289), (A)+(B176)+(B290), (A)+(B176)+(B291), (A)+(B176)+(B292), (A)+(B176)+(B293), (A)+(B176)+(B294), (A)+(B176)+(B295), (A)+(B176)+(B296), (A)+(B176)+(B297), (A)+(B176)+(B298), (A)+(B176)+(B299), (A)+(B176)+(B300), (A)+(B176)+(B301), (A)+(B176)+(B302), (A)+(B176)+(B303), (A)+(B176)+(B304), (A)+(B176)+(B305), (A)+(B176)+(B306), (A)+(B176)+(B307), (A)+(B176)+(B308), (A)+(B176)+(B309), (A)+(B176)+(B310), (A)+(B176)+(B311), (A)+(B176)+(B312), (A)+(B176)+(B313), (A)+(B176)+(B314), (A)+(B176)+(B315),

(A)+(B177)+(B178), (A)+(B177)+(B179), (A)+(B177)+(B180), (A)+(B177)+(B181), (A)+(B177)+(B182), (A)+(B177)+(B183), (A)+(B177)+(B184), (A)+(B177)+(B185), (A)+(B177)+(B186), (A)+(B177)+(B187), (A)+(B177)+(B188), (A)+(B177)+(B189), (A)+(B177)+(B190), (A)+(B177)+(B191), (A)+(B177)+(B192), (A)+(B177)+(B193), (A)+(B177)+(B194), (A)+(B177)+(B195), (A)+(B177)+(B196), (A)+(B177)+(B197), (A)+(B177)+(B198), (A)+(B177)+(B199), (A)+(B177)+(B200), (A)+(B177)+(B201), (A)+(B177)+(B202), (A)+(B177)+(B203), (A)+(B177)+(B204), (A)+(B177)+(B205), (A)+(B177)+(B206), (A)+(B177)+(B207), (A)+(B177)+(B208), (A)+(B177)+(B209), (A)+(B177)+(B210), (A)+(B177)+(B211), (A)+(B177)+(B212), (A)+(B177)+(B213), (A)+(B177)+(B214), (A)+(B177)+(B215), (A)+(B177)+(B216), (A)+(B177)+(B217), (A)+(B177)+(B218), (A)+(B177)+(B219), (A)+(B177)+(B220), (A)+(B177)+(B221), (A)+(B177)+(B222), (A)+(B177)+(B223), (A)+(B177)+(B224), (A)+(B177)+(B225), (A)+(B177)+(B226), (A)+(B177)+(B227), (A)+(B177)+(B228), (A)+(B177)+(B229), (A)+(B177)+(B230), (A)+(B177)+(B231), (A)+(B177)+(B232), (A)+(B177)+(B233), (A)+(B177)+(B234), (A)+(B177)+(B235), (A)+(B177)+(B236), (A)+(B177)+(B237), (A)+(B177)+(B238), (A)+(B177)+(B239), (A)+(B177)+(B240), (A)+(B177)+(B241), (A)+(B177)+(B242), (A)+(B177)+(B243), (A)+(B177)+(B244), (A)+(B177)+(B245), (A)+(B177)+(B246), (A)+(B177)+(B247), (A)+(B177)+(B248), (A)+(B177)+(B249), (A)+(B177)+(B250), (A)+(B177)+(B251), (A)+(B177)+(B252), (A)+(B177)+(B253), (A)+(B177)+(B254), (A)+(B177)+(B255), (A)+(B177)+(B256), (A)+(B177)+(B257), (A)+(B177)+(B258), (A)+(B177)+(B259), (A)+(B177)+(B260), (A)+(B177)+(B261), (A)+(B177)+(B262), (A)+(B177)+(B263), (A)+(B177)+(B264), (A)+(B177)+(B265), (A)+(B177)+(B266), (A)+(B177)+(B267), (A)+(B177)+(B268), (A)+(B177)+(B269), (A)+(B177)+(B270), (A)+(B177)+(B271), (A)+(B177)+(B272), (A)+(B177)+(B273), (A)+(B177)+(B274), (A)+(B177)+(B275), (A)+(B177)+(B276), (A)+(B177)+(B277), (A)+(B177)+(B278), (A)+(B177)+(B279), (A)+(B177)+(B280), (A)+(B177)+(B281), (A)+(B177)+(B282), (A)+(B177)+(B283), (A)+(B177)+(B284), (A)+(B177)+(B285), (A)+(B177)+(B286), (A)+(B177)+(B287), (A)+(B177)+(B288), (A)+(B177)+(B289), (A)+(B177)+(B290), (A)+(B177)+(B291), (A)+(B177)+(B292), (A)+(B177)+(B293), (A)+(B177)+(B294), (A)+(B177)+(B295), (A)+(B177)+(B296), (A)+(B177)+(B297), (A)+(B177)+(B298), (A)+(B177)+(B299), (A)+(B177)+(B300), (A)+(B177)+(B301), (A)+(B177)+(B302), (A)+(B177)+(B303), (A)+(B177)+(B304), (A)+(B177)+(B305), (A)+(B177)+(B306), (A)+(B177)+(B307), (A)+(B177)+(B308), (A)+(B177)+(B309), (A)+(B177)+(B310), (A)+(B177)+(B311), (A)+(B177)+(B312), (A)+(B177)+(B313), (A)+(B177)+(B314), (A)+(B177)+(B315),

(A)+(B178)+(B179), (A)+(B178)+(B180), (A)+(B178)+(B181), (A)+(B178)+(B182), (A)+(B178)+(B183), (A)+(B178)+(B184), (A)+(B178)+(B185), (A)+(B178)+(B186), (A)+(B178)+(B187), (A)+(B178)+(B188), (A)+(B178)+(B189), (A)+(B178)+(B190), (A)+(B178)+(B191), (A)+(B178)+(B192), (A)+(B178)+(B193), (A)+(B178)+(B194), (A)+(B178)+(B195), (A)+(B178)+(B196), (A)+(B178)+(B197), (A)+(B178)+(B198), (A)+(B178)+(B199), (A)+(B178)+(B200), (A)+(B178)+(B201), (A)+(B178)+(B202), (A)+(B178)+(B203), (A)+(B178)+(B204), (A)+(B178)+(B205), (A)+(B178)+(B206), (A)+(B178)+(B207), (A)+(B178)+(B208), (A)+(B178)+(B209), (A)+(B178)+(B210), (A)+(B178)+(B211), (A)+(B178)+(B212), (A)+(B178)+(B213), (A)+(B178)+(B214), (A)+(B178)+(B215), (A)+(B178)+(B216), (A)+(B178)+(B217), (A)+(B178)+(B218), (A)+(B178)+(B219), (A)+(B178)+(B220), (A)+(B178)+(B221), (A)+(B178)+(B222), (A)+(B178)+(B223), (A)+(B178)+(B224), (A)+(B178)+(B225), (A)+(B178)+(B226), (A)+(B178)+(B227), (A)+(B178)+(B228), (A)+(B178)+(B229), (A)+(B178)+(B230), (A)+(B178)+(B231), (A)+(B178)+(B232), (A)+(B178)+(B233), (A)+(B178)+(B234), (A)+(B178)+(B235), (A)+(B178)+(B236), (A)+(B178)+(B237), (A)+(B178)+(B238), (A)+(B178)+(B239), (A)+(B178)+(B240), (A)+(B178)+(B241), (A)+(B178)+(B242), (A)+(B178)+(B243), (A)+(B178)+(B244), (A)+(B178)+(B245), (A)+(B178)+(B246), (A)+(B178)+(B247), (A)+(B178)+(B248), (A)+(B178)+(B249), (A)+(B178)+(B250), (A)+(B178)+(B251), (A)+(B178)+(B252), (A)+(B178)+(B253), (A)+(B178)+(B254), (A)+(B178)+(B255), (A)+(B178)+(B256), (A)+(B178)+(B257), (A)+(B178)+(B258), (A)+(B178)+(B259), (A)+(B178)+(B260), (A)+(B178)+(B261), (A)+(B178)+(B262), (A)+(B178)+(B263), (A)+(B178)+(B264), (A)+(B178)+(B265), (A)+(B178)+(B266), (A)+(B178)+(B267), (A)+(B178)+(B268), (A)+(B178)+(B269), (A)+(B178)+(B270), (A)+(B178)+(B271), (A)+(B178)+(B272), (A)+(B178)+(B273), (A)+(B178)+(B274), (A)+(B178)+(B275), (A)+(B178)+(B276), (A)+(B178)+(B277), (A)+(B178)+(B278), (A)+(B178)+(B279), (A)+(B178)+(B280), (A)+(B178)+(B281), (A)+(B178)+(B282), (A)+(B178)+(B283), (A)+(B178)+(B284), (A)+(B178)+(B285), (A)+(B178)+(B286), (A)+(B178)+(B287), (A)+(B178)+(B288), (A)+(B178)+(B289), (A)+(B178)+(B290), (A)+(B178)+(B291), (A)+(B178)+(B292), (A)+(B178)+(B293), (A)+(B178)+(B294), (A)+(B178)+(B295), (A)+(B178)+(B296), (A)+(B178)+(B297), (A)+(B178)+(B298), (A)+(B178)+(B299), (A)+(B178)+(B300), (A)+(B178)+(B301), (A)+(B178)+(B302), (A)+(B178)+(B303), (A)+(B178)+(B304), (A)+(B178)+(B305), (A)+(B178)+(B306), (A)+(B178)+(B307), (A)+(B178)+(B308), (A)+(B178)+(B309), (A)+(B178)+(B310), (A)+(B178)+(B311), (A)+(B178)+(B312), (A)+(B178)+(B313), (A)+(B178)+(B314), (A)+(B178)+(B315),

(A)+(B179)+(B180), (A)+(B179)+(B181), (A)+(B179)+(B182), (A)+(B179)+(B183), (A)+(B179)+(B184), (A)+(B179)+(B185), (A)+(B179)+(B186), (A)+(B179)+(B187), (A)+(B179)+(B188), (A)+(B179)+(B189), (A)+(B179)+(B190), (A)+(B179)+(B191), (A)+(B179)+(B192), (A)+(B179)+(B193), (A)+(B179)+(B194), (A)+(B179)+(B195), (A)+(B179)+(B196), (A)+(B179)+(B197), (A)+(B179)+(B198), (A)+(B179)+(B199), (A)+(B179)+(B200), (A)+(B179)+(B201), (A)+(B179)+(B202), (A)+(B179)+(B203), (A)+(B179)+(B204), (A)+(B179)+(B205), (A)+(B179)+(B206), (A)+(B179)+(B207), (A)+(B179)+(B208), (A)+(B179)+(B209), (A)+(B179)+(B210), (A)+(B179)+(B211), (A)+(B179)+(B212), (A)+(B179)+(B213), (A)+(B179)+(B214), (A)+(B179)+(B215), (A)+(B179)+(B216), (A)+(B179)+(B217), (A)+(B179)+(B218), (A)+(B179)+(B219), (A)+(B179)+(B220), (A)+(B179)+(B221), (A)+(B179)+(B222), (A)+(B179)+(B223), (A)+(B179)+(B224), (A)+(B179)+(B225), (A)+(B179)+(B226), (A)+(B179)+(B227), (A)+(B179)+(B228), (A)+(B179)+(B229), (A)+(B179)+(B230), (A)+(B179)+(B231), (A)+(B179)+(B232), (A)+(B179)+(B233), (A)+(B179)+(B234), (A)+(B179)+(B235), (A)+(B179)+(B236), (A)+(B179)+(B237), (A)+(B179)+(B238), (A)+(B179)+(B239), (A)+(B179)+(B240), (A)+(B179)+(B241), (A)+(B179)+(B242), (A)+(B179)+(B243), (A)+(B179)+(B244), (A)+(B179)+(B245), (A)+(B179)+(B246), (A)+(B179)+(B247), (A)+(B179)+(B248), (A)+(B179)+(B249), (A)+(B179)+(B250), (A)+(B179)+(B251), (A)+(B179)+(B252), (A)+(B179)+(B253), (A)+(B179)+(B254), (A)+(B179)+(B255), (A)+(B179)+(B256), (A)+(B179)+(B257), (A)+(B179)+(B258), (A)+(B179)+(B259), (A)+(B179)+(B260), (A)+(B179)+(B261), (A)+(B179)+(B262), (A)+(B179)+(B263), (A)+(B179)+(B264), (A)+(B179)+(B265), (A)+(B179)+(B266), (A)+(B179)+(B267), (A)+(B179)+(B268), (A)+(B179)+(B269), (A)+(B179)+(B270), (A)+(B179)+(B271), (A)+(B179)+(B272), (A)+(B179)+(B273), (A)+(B179)+(B274), (A)+(B179)+(B275), (A)+(B179)+(B276), (A)+(B179)+(B277), (A)+(B179)+(B278), (A)+(B179)+(B279), (A)+(B179)+(B280), (A)+(B179)+(B281), (A)+(B179)+(B282), (A)+(B179)+(B283), (A)+(B179)+(B284), (A)+(B179)+(B285), (A)+(B179)+(B286), (A)+(B179)+(B287), (A)+(B179)+(B288), (A)+(B179)+(B289), (A)+(B179)+(B290), (A)+(B179)+(B291), (A)+(B179)+(B292), (A)+(B179)+(B293), (A)+(B179)+(B294), (A)+(B179)+(B295), (A)+(B179)+(B296), (A)+(B179)+(B297), (A)+(B179)+(B298), (A)+(B179)+(B299), (A)+(B179)+(B300), (A)+(B179)+(B301), (A)+(B179)+(B302), (A)+(B179)+(B303), (A)+(B179)+(B304), (A)+(B179)+(B305), (A)+(B179)+(B306), (A)+(B179)+(B307), (A)+(B179)+(B308), (A)+(B179)+(B309), (A)+(B179)+(B310), (A)+(B179)+(B311), (A)+(B179)+(B312), (A)+(B179)+(B313), (A)+(B179)+(B314), (A)+(B179)+(B315),

(A)+(B180)+(B181), (A)+(B180)+(B182), (A)+(B180)+(B183), (A)+(B180)+(B184), (A)+(B180)+(B185), (A)+(B180)+(B186), (A)+(B180)+(B187), (A)+(B180)+(B188), (A)+(B180)+(B189), (A)+(B180)+(B190), (A)+(B180)+(B191), (A)+(B180)+(B192), (A)+(B180)+(B193), (A)+(B180)+(B194), (A)+(B180)+(B195), (A)+(B180)+(B196), (A)+(B180)+(B197), (A)+(B180)+(B198), (A)+(B180)+(B199), (A)+(B180)+(B200), (A)+(B180)+(B201), (A)+(B180)+(B202), (A)+(B180)+(B203), (A)+(B180)+(B204), (A)+(B180)+(B205), (A)+(B180)+(B206), (A)+(B180)+(B207), (A)+(B180)+(B208), (A)+(B180)+(B209), (A)+(B180)+(B210), (A)+(B180)+(B211), (A)+(B180)+(B212), (A)+(B180)+(B213), (A)+(B180)+(B214), (A)+(B180)+(B215), (A)+(B180)+(B216), (A)+(B180)+(B217), (A)+(B180)+(B218), (A)+(B180)+(B219), (A)+(B180)+(B220), (A)+(B180)+(B221), (A)+(B180)+(B222), (A)+(B180)+(B223), (A)+(B180)+(B224), (A)+(B180)+(B225), (A)+(B180)+(B226), (A)+(B180)+(B227), (A)+(B180)+(B228), (A)+(B180)+(B229), (A)+(B180)+(B230), (A)+(B180)+(B231), (A)+(B180)+(B232), (A)+(B180)+(B233), (A)+(B180)+(B234), (A)+(B180)+(B235), (A)+(B180)+(B236), (A)+(B180)+(B237), (A)+(B180)+(B238), (A)+(B180)+(B239), (A)+(B180)+(B240), (A)+(B180)+(B241), (A)+(B180)+(B242), (A)+(B180)+(B243), (A)+(B180)+(B244), (A)+(B180)+(B245), (A)+(B180)+(B246), (A)+(B180)+(B247), (A)+(B180)+(B248), (A)+(B180)+(B249), (A)+(B180)+(B250), (A)+(B180)+(B251), (A)+(B180)+(B252), (A)+(B180)+(B253), (A)+(B180)+(B254), (A)+(B180)+(B255), (A)+(B180)+(B256), (A)+(B180)+(B257), (A)+(B180)+(B258), (A)+(B180)+(B259), (A)+(B180)+(B260), (A)+(B180)+(B261), (A)+(B180)+(B262), (A)+(B180)+(B263), (A)+(B180)+(B264), (A)+(B180)+(B265), (A)+(B180)+(B266), (A)+(B180)+(B267), (A)+(B180)+(B268), (A)+(B180)+(B269), (A)+(B180)+(B270), (A)+(B180)+(B271), (A)+(B180)+(B272), (A)+(B180)+(B273), (A)+(B180)+(B274), (A)+(B180)+(B275), (A)+(B180)+(B276), (A)+(B180)+(B277), (A)+(B180)+(B278), (A)+(B180)+(B279), (A)+(B180)+(B280), (A)+(B180)+(B281), (A)+(B180)+(B282), (A)+(B180)+(B283), (A)+(B180)+(B284), (A)+(B180)+(B285), (A)+(B180)+(B286), (A)+(B180)+(B287), (A)+(B180)+(B288), (A)+(B180)+(B289), (A)+(B180)+(B290), (A)+(B180)+(B291), (A)+(B180)+(B292), (A)+(B180)+(B293), (A)+(B180)+(B294), (A)+(B180)+(B295), (A)+(B180)+(B296), (A)+(B180)+(B297), (A)+(B180)+(B298), (A)+(B180)+(B299), (A)+(B180)+(B300), (A)+(B180)+(B301), (A)+(B180)+(B302), (A)+(B180)+(B303), (A)+(B180)+(B304), (A)+(B180)+(B305), (A)+(B180)+(B306), (A)+(B180)+(B307), (A)+(B180)+(B308), (A)+(B180)+(B309), (A)+(B180)+(B310), (A)+(B180)+(B311), (A)+(B180)+(B312), (A)+(B180)+(B313), (A)+(B180)+(B314), (A)+(B180)+(B315),

(A)+(B181)+(B182), (A)+(B181)+(B183), (A)+(B181)+(B184), (A)+(B181)+(B185), (A)+(B181)+(B186), (A)+(B181)+(B187), (A)+(B181)+(B188), (A)+(B181)+(B189), (A)+(B181)+(B190), (A)+(B181)+(B191), (A)+(B181)+(B192), (A)+(B181)+(B193), (A)+(B181)+(B194), (A)+(B181)+(B195), (A)+(B181)+(B196), (A)+(B181)+(B197), (A)+(B181)+(B198), (A)+(B181)+(B199), (A)+(B181)+(B200), (A)+(B181)+(B201), (A)+(B181)+(B202), (A)+(B181)+(B203), (A)+(B181)+(B204), (A)+(B181)+(B205), (A)+(B181)+(B206), (A)+(B181)+(B207), (A)+(B181)+(B208), (A)+(B181)+(B209), (A)+(B181)+(B210), (A)+(B181)+(B211), (A)+(B181)+(B212), (A)+(B181)+(B213), (A)+(B181)+(B214), (A)+(B181)+(B215), (A)+(B181)+(B216), (A)+(B181)+(B217), (A)+(B181)+(B218), (A)+(B181)+(B219), (A)+(B181)+(B220), (A)+(B181)+(B221), (A)+(B181)+(B222), (A)+(B181)+(B223), (A)+(B181)+(B224), (A)+(B181)+(B225), (A)+(B181)+(B226), (A)+(B181)+(B227), (A)+(B181)+(B228), (A)+(B181)+(B229), (A)+(B181)+(B230), (A)+(B181)+(B231), (A)+(B181)+(B232), (A)+(B181)+(B233), (A)+(B181)+(B234), (A)+(B181)+(B235), (A)+(B181)+(B236), (A)+(B181)+(B237), (A)+(B181)+(B238), (A)+(B181)+(B239), (A)+(B181)+(B240), (A)+(B181)+(B241), (A)+(B181)+(B242), (A)+(B181)+(B243), (A)+(B181)+(B244), (A)+(B181)+(B245), (A)+(B181)+(B246), (A)+(B181)+(B247), (A)+(B181)+(B248), (A)+(B181)+(B249), (A)+(B181)+(B250), (A)+(B181)+(B251), (A)+(B181)+(B252), (A)+(B181)+(B253), (A)+(B181)+(B254), (A)+(B181)+(B255), (A)+(B181)+(B256), (A)+(B181)+(B257), (A)+(B181)+(B258), (A)+(B181)+(B259), (A)+(B181)+(B260), (A)+(B181)+(B261), (A)+(B181)+(B262), (A)+(B181)+(B263), (A)+(B181)+(B264), (A)+(B181)+(B265), (A)+(B181)+(B266), (A)+(B181)+(B267), (A)+(B181)+(B268), (A)+(B181)+(B269), (A)+(B181)+(B270), (A)+(B181)+(B271), (A)+(B181)+(B272), (A)+(B181)+(B273), (A)+(B181)+(B274), (A)+(B181)+(B275), (A)+(B181)+(B276), (A)+(B181)+(B277), (A)+(B181)+(B278), (A)+(B181)+(B279), (A)+(B181)+(B280), (A)+(B181)+(B281), (A)+(B181)+(B282), (A)+(B181)+(B283), (A)+(B181)+(B284), (A)+(B181)+(B285), (A)+(B181)+(B286), (A)+(B181)+(B287), (A)+(B181)+(B288), (A)+(B181)+(B289), (A)+(B181)+(B290), (A)+(B181)+(B291), (A)+(B181)+(B292), (A)+(B181)+(B293), (A)+(B181)+(B294), (A)+(B181)+(B295), (A)+(B181)+(B296), (A)+(B181)+(B297), (A)+(B181)+(B298), (A)+(B181)+(B299), (A)+(B181)+(B300), (A)+(B181)+(B301), (A)+(B181)+(B302), (A)+(B181)+(B303), (A)+(B181)+(B304), (A)+(B181)+(B305), (A)+(B181)+(B306), (A)+(B181)+(B307), (A)+(B181)+(B308), (A)+(B181)+(B309), (A)+(B181)+(B310), (A)+(B181)+(B311), (A)+(B181)+(B312), (A)+(B181)+(B313), (A)+(B181)+(B314), (A)+(B181)+(B315),

(A)+(B182)+(B183), (A)+(B182)+(B184), (A)+(B182)+(B185), (A)+(B182)+(B186), (A)+(B182)+(B187), (A)+(B182)+(B188), (A)+(B182)+(B189), (A)+(B182)+(B190), (A)+(B182)+(B191), (A)+(B182)+(B192), (A)+(B182)+(B193), (A)+(B182)+(B194), (A)+(B182)+(B195), (A)+(B182)+(B196), (A)+(B182)+(B197), (A)+(B182)+(B198), (A)+(B182)+(B199), (A)+(B182)+(B200), (A)+(B182)+(B201), (A)+(B182)+(B202), (A)+(B182)+(B203), (A)+(B182)+(B204), (A)+(B182)+(B205), (A)+(B182)+(B206), (A)+(B182)+(B207), (A)+(B182)+(B208), (A)+(B182)+(B209), (A)+(B182)+(B210), (A)+(B182)+(B211), (A)+(B182)+(B212), (A)+(B182)+(B213), (A)+(B182)+(B214), (A)+(B182)+(B215), (A)+(B182)+(B216), (A)+(B182)+(B217), (A)+(B182)+(B218), (A)+(B182)+(B219), (A)+(B182)+(B220), (A)+(B182)+(B221), (A)+(B182)+(B222), (A)+(B182)+(B223), (A)+(B182)+(B224), (A)+(B182)+(B225), (A)+(B182)+(B226), (A)+(B182)+(B227), (A)+(B182)+(B228), (A)+(B182)+(B229), (A)+(B182)+(B230), (A)+(B182)+(B231), (A)+(B182)+(B232), (A)+(B182)+(B233), (A)+(B182)+(B234), (A)+(B182)+(B235), (A)+(B182)+(B236), (A)+(B182)+(B237), (A)+(B182)+(B238), (A)+(B182)+(B239), (A)+(B182)+(B240), (A)+(B182)+(B241), (A)+(B182)+(B242), (A)+(B182)+(B243), (A)+(B182)+(B244), (A)+(B182)+(B245), (A)+(B182)+(B246), (A)+(B182)+(B247), (A)+(B182)+(B248), (A)+(B182)+(B249), (A)+(B182)+(B250), (A)+(B182)+(B251), (A)+(B182)+(B252), (A)+(B182)+(B253), (A)+(B182)+(B254), (A)+(B182)+(B255), (A)+(B182)+(B256), (A)+(B182)+(B257), (A)+(B182)+(B258), (A)+(B182)+(B259), (A)+(B182)+(B260), (A)+(B182)+(B261), (A)+(B182)+(B262), (A)+(B182)+(B263), (A)+(B182)+(B264), (A)+(B182)+(B265), (A)+(B182)+(B266), (A)+(B182)+(B267), (A)+(B182)+(B268), (A)+(B182)+(B269), (A)+(B182)+(B270), (A)+(B182)+(B271), (A)+(B182)+(B272), (A)+(B182)+(B273), (A)+(B182)+(B274), (A)+(B182)+(B275), (A)+(B182)+(B276), (A)+(B182)+(B277), (A)+(B182)+(B278), (A)+(B182)+(B279), (A)+(B182)+(B280), (A)+(B182)+(B281), (A)+(B182)+(B282), (A)+(B182)+(B283), (A)+(B182)+(B284), (A)+(B182)+(B285), (A)+(B182)+(B286), (A)+(B182)+(B287), (A)+(B182)+(B288), (A)+(B182)+(B289), (A)+(B182)+(B290), (A)+(B182)+(B291), (A)+(B182)+(B292), (A)+(B182)+(B293), (A)+(B182)+(B294), (A)+(B182)+(B295), (A)+(B182)+(B296), (A)+(B182)+(B297), (A)+(B182)+(B298), (A)+(B182)+(B299), (A)+(B182)+(B300), (A)+(B182)+(B301), (A)+(B182)+(B302), (A)+(B182)+(B303), (A)+(B182)+(B304), (A)+(B182)+(B305), (A)+(B182)+(B306), (A)+(B182)+(B307), (A)+(B182)+(B308), (A)+(B182)+(B309), (A)+(B182)+(B310), (A)+(B182)+(B311), (A)+(B182)+(B312), (A)+(B182)+(B313), (A)+(B182)+(B314), (A)+(B182)+(B315),

(A)+(B183)+(B184), (A)+(B183)+(B185), (A)+(B183)+(B186), (A)+(B183)+(B187), (A)+(B183)+(B188), (A)+(B183)+(B189), (A)+(B183)+(B190), (A)+(B183)+(B191), (A)+(B183)+(B192), (A)+(B183)+(B193), (A)+(B183)+(B194), (A)+(B183)+(B195), (A)+(B183)+(B196), (A)+(B183)+(B197), (A)+(B183)+(B198), (A)+(B183)+(B199), (A)+(B183)+(B200), (A)+(B183)+(B201), (A)+(B183)+(B202), (A)+(B183)+(B203), (A)+(B183)+(B204), (A)+(B183)+(B205), (A)+(B183)+(B206), (A)+(B183)+(B207), (A)+(B183)+(B208), (A)+(B183)+(B209), (A)+(B183)+(B210), (A)+(B183)+(B211), (A)+(B183)+(B212), (A)+(B183)+(B213), (A)+(B183)+(B214), (A)+(B183)+(B215), (A)+(B183)+(B216), (A)+(B183)+(B217), (A)+(B183)+(B218), (A)+(B183)+(B219), (A)+(B183)+(B220), (A)+(B183)+(B221), (A)+(B183)+(B222), (A)+(B183)+(B223), (A)+(B183)+(B224), (A)+(B183)+(B225), (A)+(B183)+(B226), (A)+(B183)+(B227), (A)+(B183)+(B228), (A)+(B183)+(B229), (A)+(B183)+(B230), (A)+(B183)+(B231), (A)+(B183)+(B232), (A)+(B183)+(B233), (A)+(B183)+(B234), (A)+(B183)+(B235), (A)+(B183)+(B236), (A)+(B183)+(B237), (A)+(B183)+(B238), (A)+(B183)+(B239), (A)+(B183)+(B240), (A)+(B183)+(B241), (A)+(B183)+(B242), (A)+(B183)+(B243), (A)+(B183)+(B244), (A)+(B183)+(B245), (A)+(B183)+(B246), (A)+(B183)+(B247), (A)+(B183)+(B248), (A)+(B183)+(B249), (A)+(B183)+(B250), (A)+(B183)+(B251), (A)+(B183)+(B252), (A)+(B183)+(B253), (A)+(B183)+(B254), (A)+(B183)+(B255), (A)+(B183)+(B256), (A)+(B183)+(B257), (A)+(B183)+(B258), (A)+(B183)+(B259), (A)+(B183)+(B260), (A)+(B183)+(B261), (A)+(B183)+(B262), (A)+(B183)+(B263), (A)+(B183)+(B264), (A)+(B183)+(B265), (A)+(B183)+(B266), (A)+(B183)+(B267), (A)+(B183)+(B268), (A)+(B183)+(B269), (A)+(B183)+(B270), (A)+(B183)+(B271), (A)+(B183)+(B272), (A)+(B183)+(B273), (A)+(B183)+(B274), (A)+(B183)+(B275), (A)+(B183)+(B276), (A)+(B183)+(B277), (A)+(B183)+(B278), (A)+(B183)+(B279), (A)+(B183)+(B280), (A)+(B183)+(B281), (A)+(B183)+(B282), (A)+(B183)+(B283), (A)+(B183)+(B284), (A)+(B183)+(B285), (A)+(B183)+(B286), (A)+(B183)+(B287), (A)+(B183)+(B288), (A)+(B183)+(B289), (A)+(B183)+(B290), (A)+(B183)+(B291), (A)+(B183)+(B292), (A)+(B183)+(B293), (A)+(B183)+(B294), (A)+(B183)+(B295), (A)+(B183)+(B296), (A)+(B183)+(B297), (A)+(B183)+(B298), (A)+(B183)+(B299), (A)+(B183)+(B300), (A)+(B183)+(B301), (A)+(B183)+(B302), (A)+(B183)+(B303), (A)+(B183)+(B304), (A)+(B183)+(B305), (A)+(B183)+(B306), (A)+(B183)+(B307), (A)+(B183)+(B308), (A)+(B183)+(B309), (A)+(B183)+(B310), (A)+(B183)+(B311), (A)+(B183)+(B312), (A)+(B183)+(B313), (A)+(B183)+(B314), (A)+(B183)+(B315),

(A)+(B184)+(B185), (A)+(B184)+(B186), (A)+(B184)+(B187), (A)+(B184)+(B188), (A)+(B184)+(B189), (A)+(B184)+(B190), (A)+(B184)+(B191), (A)+(B184)+(B192), (A)+(B184)+(B193), (A)+(B184)+(B194), (A)+(B184)+(B195), (A)+(B184)+(B196), (A)+(B184)+(B197), (A)+(B184)+(B198), (A)+(B184)+(B199), (A)+(B184)+(B200), (A)+(B184)+(B201), (A)+(B184)+(B202), (A)+(B184)+(B203), (A)+(B184)+(B204), (A)+(B184)+(B205), (A)+(B184)+(B206), (A)+(B184)+(B207), (A)+(B184)+(B208), (A)+(B184)+(B209), (A)+(B184)+(B210), (A)+(B184)+(B211), (A)+(B184)+(B212), (A)+(B184)+(B213), (A)+(B184)+(B214), (A)+(B184)+(B215), (A)+(B184)+(B216), (A)+(B184)+(B217), (A)+(B184)+(B218), (A)+(B184)+(B219), (A)+(B184)+(B220), (A)+(B184)+(B221), (A)+(B184)+(B222), (A)+(B184)+(B223), (A)+(B184)+(B224), (A)+(B184)+(B225), (A)+(B184)+(B226), (A)+(B184)+(B227), (A)+(B184)+(B228), (A)+(B184)+(B229), (A)+(B184)+(B230), (A)+(B184)+(B231), (A)+(B184)+(B232), (A)+(B184)+(B233), (A)+(B184)+(B234), (A)+(B184)+(B235), (A)+(B184)+(B236), (A)+(B184)+(B237), (A)+(B184)+(B238), (A)+(B184)+(B239), (A)+(B184)+(B240), (A)+(B184)+(B241), (A)+(B184)+(B242), (A)+(B184)+(B243), (A)+(B184)+(B244), (A)+(B184)+(B245), (A)+(B184)+(B246), (A)+(B184)+(B247), (A)+(B184)+(B248), (A)+(B184)+(B249), (A)+(B184)+(B250), (A)+(B184)+(B251), (A)+(B184)+(B252), (A)+(B184)+(B253), (A)+(B184)+(B254), (A)+(B184)+(B255), (A)+(B184)+(B256), (A)+(B184)+(B257), (A)+(B184)+(B258), (A)+(B184)+(B259), (A)+(B184)+(B260), (A)+(B184)+(B261), (A)+(B184)+(B262), (A)+(B184)+(B263), (A)+(B184)+(B264), (A)+(B184)+(B265), (A)+(B184)+(B266), (A)+(B184)+(B267), (A)+(B184)+(B268), (A)+(B184)+(B269), (A)+(B184)+(B270), (A)+(B184)+(B271), (A)+(B184)+(B272), (A)+(B184)+(B273), (A)+(B184)+(B274), (A)+(B184)+(B275), (A)+(B184)+(B276), (A)+(B184)+(B277), (A)+(B184)+(B278), (A)+(B184)+(B279), (A)+(B184)+(B280), (A)+(B184)+(B281), (A)+(B184)+(B282), (A)+(B184)+(B283), (A)+(B184)+(B284), (A)+(B184)+(B285), (A)+(B184)+(B286), (A)+(B184)+(B287), (A)+(B184)+(B288), (A)+(B184)+(B289), (A)+(B184)+(B290), (A)+(B184)+(B291), (A)+(B184)+(B292), (A)+(B184)+(B293), (A)+(B184)+(B294), (A)+(B184)+(B295), (A)+(B184)+(B296), (A)+(B184)+(B297), (A)+(B184)+(B298), (A)+(B184)+(B299), (A)+(B184)+(B300), (A)+(B184)+(B301), (A)+(B184)+(B302), (A)+(B184)+(B303), (A)+(B184)+(B304), (A)+(B184)+(B305), (A)+(B184)+(B306), (A)+(B184)+(B307), (A)+(B184)+(B308), (A)+(B184)+(B309), (A)+(B184)+(B310), (A)+(B184)+(B311), (A)+(B184)+(B312), (A)+(B184)+(B313), (A)+(B184)+(B314), (A)+(B184)+(B315),

(A)+(B185)+(B186), (A)+(B185)+(B187), (A)+(B185)+(B188), (A)+(B185)+(B189), (A)+(B185)+(B190), (A)+(B185)+(B191), (A)+(B185)+(B192), (A)+(B185)+(B193), (A)+(B185)+(B194), (A)+(B185)+(B195), (A)+(B185)+(B196), (A)+(B185)+(B197), (A)+(B185)+(B198), (A)+(B185)+(B199), (A)+(B185)+(B200), (A)+(B185)+(B201), (A)+(B185)+(B202), (A)+(B185)+(B203), (A)+(B185)+(B204), (A)+(B185)+(B205), (A)+(B185)+(B206), (A)+(B185)+(B207), (A)+(B185)+(B208), (A)+(B185)+(B209), (A)+(B185)+(B210), (A)+(B185)+(B211), (A)+(B185)+(B212), (A)+(B185)+(B213), (A)+(B185)+(B214), (A)+(B185)+(B215), (A)+(B185)+(B216), (A)+(B185)+(B217), (A)+(B185)+(B218), (A)+(B185)+(B219), (A)+(B185)+(B220), (A)+(B185)+(B221), (A)+(B185)+(B222), (A)+(B185)+(B223), (A)+(B185)+(B224), (A)+(B185)+(B225), (A)+(B185)+(B226), (A)+(B185)+(B227), (A)+(B185)+(B228), (A)+(B185)+(B229), (A)+(B185)+(B230), (A)+(B185)+(B231), (A)+(B185)+(B232), (A)+(B185)+(B233), (A)+(B185)+(B234), (A)+(B185)+(B235), (A)+(B185)+(B236), (A)+(B185)+(B237), (A)+(B185)+(B238), (A)+(B185)+(B239), (A)+(B185)+(B240), (A)+(B185)+(B241), (A)+(B185)+(B242), (A)+(B185)+(B243), (A)+(B185)+(B244), (A)+(B185)+(B245), (A)+(B185)+(B246), (A)+(B185)+(B247), (A)+(B185)+(B248), (A)+(B185)+(B249), (A)+(B185)+(B250), (A)+(B185)+(B251), (A)+(B185)+(B252), (A)+(B185)+(B253), (A)+(B185)+(B254), (A)+(B185)+(B255), (A)+(B185)+(B256), (A)+(B185)+(B257), (A)+(B185)+(B258), (A)+(B185)+(B259), (A)+(B185)+(B260), (A)+(B185)+(B261), (A)+(B185)+(B262), (A)+(B185)+(B263), (A)+(B185)+(B264), (A)+(B185)+(B265), (A)+(B185)+(B266), (A)+(B185)+(B267), (A)+(B185)+(B268), (A)+(B185)+(B269), (A)+(B185)+(B270), (A)+(B185)+(B271), (A)+(B185)+(B272), (A)+(B185)+(B273), (A)+(B185)+(B274), (A)+(B185)+(B275), (A)+(B185)+(B276), (A)+(B185)+(B277), (A)+(B185)+(B278), (A)+(B185)+(B279), (A)+(B185)+(B280), (A)+(B185)+(B281), (A)+(B185)+(B282), (A)+(B185)+(B283), (A)+(B185)+(B284), (A)+(B185)+(B285), (A)+(B185)+(B286), (A)+(B185)+(B287), (A)+(B185)+(B288), (A)+(B185)+(B289), (A)+(B185)+(B290), (A)+(B185)+(B291), (A)+(B185)+(B292), (A)+(B185)+(B293), (A)+(B185)+(B294), (A)+(B185)+(B295), (A)+(B185)+(B296), (A)+(B185)+(B297), (A)+(B185)+(B298), (A)+(B185)+(B299), (A)+(B185)+(B300), (A)+(B185)+(B301), (A)+(B185)+(B302), (A)+(B185)+(B303), (A)+(B185)+(B304), (A)+(B185)+(B305), (A)+(B185)+(B306), (A)+(B185)+(B307), (A)+(B185)+(B308), (A)+(B185)+(B309), (A)+(B185)+(B310), (A)+(B185)+(B311), (A)+(B185)+(B312), (A)+(B185)+(B313), (A)+(B185)+(B314), (A)+(B185)+(B315),

(A)+(B186)+(B187), (A)+(B186)+(B188), (A)+(B186)+(B189), (A)+(B186)+(B190), (A)+(B186)+(B191), (A)+(B186)+(B192), (A)+(B186)+(B193), (A)+(B186)+(B194), (A)+(B186)+(B195), (A)+(B186)+(B196), (A)+(B186)+(B197), (A)+(B186)+(B198), (A)+(B186)+(B199), (A)+(B186)+(B200), (A)+(B186)+(B201), (A)+(B186)+(B202), (A)+(B186)+(B203), (A)+(B186)+(B204), (A)+(B186)+(B205), (A)+(B186)+(B206), (A)+(B186)+(B207), (A)+(B186)+(B208), (A)+(B186)+(B209), (A)+(B186)+(B210), (A)+(B186)+(B211), (A)+(B186)+(B212), (A)+(B186)+(B213), (A)+(B186)+(B214), (A)+(B186)+(B215), (A)+(B186)+(B216), (A)+(B186)+(B217), (A)+(B186)+(B218), (A)+(B186)+(B219), (A)+(B186)+(B220), (A)+(B186)+(B221), (A)+(B186)+(B222), (A)+(B186)+(B223), (A)+(B186)+(B224), (A)+(B186)+(B225), (A)+(B186)+(B226), (A)+(B186)+(B227), (A)+(B186)+(B228), (A)+(B186)+(B229), (A)+(B186)+(B230), (A)+(B186)+(B231), (A)+(B186)+(B232), (A)+(B186)+(B233), (A)+(B186)+(B234), (A)+(B186)+(B235), (A)+(B186)+(B236), (A)+(B186)+(B237), (A)+(B186)+(B238), (A)+(B186)+(B239), (A)+(B186)+(B240), (A)+(B186)+(B241), (A)+(B186)+(B242), (A)+(B186)+(B243), (A)+(B186)+(B244), (A)+(B186)+(B245), (A)+(B186)+(B246), (A)+(B186)+(B247), (A)+(B186)+(B248), (A)+(B186)+(B249), (A)+(B186)+(B250), (A)+(B186)+(B251), (A)+(B186)+(B252), (A)+(B186)+(B253), (A)+(B186)+(B254), (A)+(B186)+(B255), (A)+(B186)+(B256), (A)+(B186)+(B257), (A)+(B186)+(B258), (A)+(B186)+(B259), (A)+(B186)+(B260), (A)+(B186)+(B261), (A)+(B186)+(B262), (A)+(B186)+(B263), (A)+(B186)+(B264), (A)+(B186)+(B265), (A)+(B186)+(B266), (A)+(B186)+(B267), (A)+(B186)+(B268), (A)+(B186)+(B269), (A)+(B186)+(B270), (A)+(B186)+(B271), (A)+(B186)+(B272), (A)+(B186)+(B273), (A)+(B186)+(B274), (A)+(B186)+(B275), (A)+(B186)+(B276), (A)+(B186)+(B277), (A)+(B186)+(B278), (A)+(B186)+(B279), (A)+(B186)+(B280), (A)+(B186)+(B281), (A)+(B186)+(B282), (A)+(B186)+(B283), (A)+(B186)+(B284), (A)+(B186)+(B285), (A)+(B186)+(B286), (A)+(B186)+(B287), (A)+(B186)+(B288), (A)+(B186)+(B289), (A)+(B186)+(B290), (A)+(B186)+(B291), (A)+(B186)+(B292), (A)+(B186)+(B293), (A)+(B186)+(B294), (A)+(B186)+(B295), (A)+(B186)+(B296), (A)+(B186)+(B297), (A)+(B186)+(B298), (A)+(B186)+(B299), (A)+(B186)+(B300), (A)+(B186)+(B301), (A)+(B186)+(B302), (A)+(B186)+(B303), (A)+(B186)+(B304), (A)+(B186)+(B305), (A)+(B186)+(B306), (A)+(B186)+(B307), (A)+(B186)+(B308), (A)+(B186)+(B309), (A)+(B186)+(B310), (A)+(B186)+(B311), (A)+(B186)+(B312), (A)+(B186)+(B313), (A)+(B186)+(B314), (A)+(B186)+(B315),

(A)+(B187)+(B188), (A)+(B187)+(B189), (A)+(B187)+(B190), (A)+(B187)+(B191), (A)+(B187)+(B192), (A)+(B187)+(B193), (A)+(B187)+(B194), (A)+(B187)+(B195), (A)+(B187)+(B196), (A)+(B187)+(B197), (A)+(B187)+(B198), (A)+(B187)+(B199), (A)+(B187)+(B200), (A)+(B187)+(B201), (A)+(B187)+(B202), (A)+(B187)+(B203), (A)+(B187)+(B204), (A)+(B187)+(B205), (A)+(B187)+(B206), (A)+(B187)+(B207), (A)+(B187)+(B208), (A)+(B187)+(B209), (A)+(B187)+(B210), (A)+(B187)+(B211), (A)+(B187)+(B212), (A)+(B187)+(B213), (A)+(B187)+(B214), (A)+(B187)+(B215), (A)+(B187)+(B216), (A)+(B187)+(B217), (A)+(B187)+(B218), (A)+(B187)+(B219), (A)+(B187)+(B220), (A)+(B187)+(B221), (A)+(B187)+(B222), (A)+(B187)+(B223), (A)+(B187)+(B224), (A)+(B187)+(B225), (A)+(B187)+(B226), (A)+(B187)+(B227), (A)+(B187)+(B228), (A)+(B187)+(B229), (A)+(B187)+(B230), (A)+(B187)+(B231), (A)+(B187)+(B232), (A)+(B187)+(B233), (A)+(B187)+(B234), (A)+(B187)+(B235), (A)+(B187)+(B236), (A)+(B187)+(B237), (A)+(B187)+(B238), (A)+(B187)+(B239), (A)+(B187)+(B240), (A)+(B187)+(B241), (A)+(B187)+(B242), (A)+(B187)+(B243), (A)+(B187)+(B244), (A)+(B187)+(B245), (A)+(B187)+(B246), (A)+(B187)+(B247), (A)+(B187)+(B248), (A)+(B187)+(B249), (A)+(B187)+(B250), (A)+(B187)+(B251), (A)+(B187)+(B252), (A)+(B187)+(B253), (A)+(B187)+(B254), (A)+(B187)+(B255), (A)+(B187)+(B256), (A)+(B187)+(B257), (A)+(B187)+(B258), (A)+(B187)+(B259), (A)+(B187)+(B260), (A)+(B187)+(B261), (A)+(B187)+(B262), (A)+(B187)+(B263), (A)+(B187)+(B264), (A)+(B187)+(B265), (A)+(B187)+(B266), (A)+(B187)+(B267), (A)+(B187)+(B268), (A)+(B187)+(B269), (A)+(B187)+(B270), (A)+(B187)+(B271), (A)+(B187)+(B272), (A)+(B187)+(B273), (A)+(B187)+(B274), (A)+(B187)+(B275), (A)+(B187)+(B276), (A)+(B187)+(B277), (A)+(B187)+(B278), (A)+(B187)+(B279), (A)+(B187)+(B280), (A)+(B187)+(B281), (A)+(B187)+(B282), (A)+(B187)+(B283), (A)+(B187)+(B284), (A)+(B187)+(B285), (A)+(B187)+(B286), (A)+(B187)+(B287), (A)+(B187)+(B288), (A)+(B187)+(B289), (A)+(B187)+(B290), (A)+(B187)+(B291), (A)+(B187)+(B292), (A)+(B187)+(B293), (A)+(B187)+(B294), (A)+(B187)+(B295), (A)+(B187)+(B296), (A)+(B187)+(B297), (A)+(B187)+(B298), (A)+(B187)+(B299), (A)+(B187)+(B300), (A)+(B187)+(B301), (A)+(B187)+(B302), (A)+(B187)+(B303), (A)+(B187)+(B304), (A)+(B187)+(B305), (A)+(B187)+(B306), (A)+(B187)+(B307), (A)+(B187)+(B308), (A)+(B187)+(B309), (A)+(B187)+(B310), (A)+(B187)+(B311), (A)+(B187)+(B312), (A)+(B187)+(B313), (A)+(B187)+(B314), (A)+(B187)+(B315),

(A)+(B188)+(B189), (A)+(B188)+(B190), (A)+(B188)+(B191), (A)+(B188)+(B192), (A)+(B188)+(B193), (A)+(B188)+(B194), (A)+(B188)+(B195), (A)+(B188)+(B196), (A)+(B188)+(B197), (A)+(B188)+(B198), (A)+(B188)+(B199), (A)+(B188)+(B200), (A)+(B188)+(B201), (A)+(B188)+(B202), (A)+(B188)+(B203), (A)+(B188)+(B204), (A)+(B188)+(B205), (A)+(B188)+(B206), (A)+(B188)+(B207), (A)+(B188)+(B208), (A)+(B188)+(B209), (A)+(B188)+(B210), (A)+(B188)+(B211), (A)+(B188)+(B212), (A)+(B188)+(B213), (A)+(B188)+(B214), (A)+(B188)+(B215), (A)+(B188)+(B216), (A)+(B188)+(B217), (A)+(B188)+(B218), (A)+(B188)+(B219), (A)+(B188)+(B220), (A)+(B188)+(B221), (A)+(B188)+(B222), (A)+(B188)+(B223), (A)+(B188)+(B224), (A)+(B188)+(B225), (A)+(B188)+(B226), (A)+(B188)+(B227), (A)+(B188)+(B228), (A)+(B188)+(B229), (A)+(B188)+(B230), (A)+(B188)+(B231), (A)+(B188)+(B232), (A)+(B188)+(B233), (A)+(B188)+(B234), (A)+(B188)+(B235), (A)+(B188)+(B236), (A)+(B188)+(B237), (A)+(B188)+(B238), (A)+(B188)+(B239), (A)+(B188)+(B240), (A)+(B188)+(B241), (A)+(B188)+(B242), (A)+(B188)+(B243), (A)+(B188)+(B244), (A)+(B188)+(B245), (A)+(B188)+(B246), (A)+(B188)+(B247), (A)+(B188)+(B248), (A)+(B188)+(B249), (A)+(B188)+(B250), (A)+(B188)+(B251), (A)+(B188)+(B252), (A)+(B188)+(B253), (A)+(B188)+(B254), (A)+(B188)+(B255), (A)+(B188)+(B256), (A)+(B188)+(B257), (A)+(B188)+(B258), (A)+(B188)+(B259), (A)+(B188)+(B260), (A)+(B188)+(B261), (A)+(B188)+(B262), (A)+(B188)+(B263), (A)+(B188)+(B264), (A)+(B188)+(B265), (A)+(B188)+(B266), (A)+(B188)+(B267), (A)+(B188)+(B268), (A)+(B188)+(B269), (A)+(B188)+(B270), (A)+(B188)+(B271), (A)+(B188)+(B272), (A)+(B188)+(B273), (A)+(B188)+(B274), (A)+(B188)+(B275), (A)+(B188)+(B276), (A)+(B188)+(B277), (A)+(B188)+(B278), (A)+(B188)+(B279), (A)+(B188)+(B280), (A)+(B188)+(B281), (A)+(B188)+(B282), (A)+(B188)+(B283), (A)+(B188)+(B284), (A)+(B188)+(B285), (A)+(B188)+(B286), (A)+(B188)+(B287), (A)+(B188)+(B288), (A)+(B188)+(B289), (A)+(B188)+(B290), (A)+(B188)+(B291), (A)+(B188)+(B292), (A)+(B188)+(B293), (A)+(B188)+(B294), (A)+(B188)+(B295), (A)+(B188)+(B296), (A)+(B188)+(B297), (A)+(B188)+(B298), (A)+(B188)+(B299), (A)+(B188)+(B300), (A)+(B188)+(B301), (A)+(B188)+(B302), (A)+(B188)+(B303), (A)+(B188)+(B304), (A)+(B188)+(B305), (A)+(B188)+(B306), (A)+(B188)+(B307), (A)+(B188)+(B308), (A)+(B188)+(B309), (A)+(B188)+(B310), (A)+(B188)+(B311), (A)+(B188)+(B312), (A)+(B188)+(B313), (A)+(B188)+(B314), (A)+(B188)+(B315),

(A)+(B189)+(B190), (A)+(B189)+(B191), (A)+(B189)+(B192), (A)+(B189)+(B193), (A)+(B189)+(B194), (A)+(B189)+(B195), (A)+(B189)+(B196), (A)+(B189)+(B197), (A)+(B189)+(B198), (A)+(B189)+(B199), (A)+(B189)+(B200), (A)+(B189)+(B201), (A)+(B189)+(B202), (A)+(B189)+(B203), (A)+(B189)+(B204), (A)+(B189)+(B205), (A)+(B189)+(B206), (A)+(B189)+(B207), (A)+(B189)+(B208), (A)+(B189)+(B209), (A)+(B189)+(B210), (A)+(B189)+(B211), (A)+(B189)+(B212), (A)+(B189)+(B213), (A)+(B189)+(B214), (A)+(B189)+(B215), (A)+(B189)+(B216), (A)+(B189)+(B217), (A)+(B189)+(B218), (A)+(B189)+(B219), (A)+(B189)+(B220), (A)+(B189)+(B221), (A)+(B189)+(B222), (A)+(B189)+(B223), (A)+(B189)+(B224), (A)+(B189)+(B225), (A)+(B189)+(B226), (A)+(B189)+(B227), (A)+(B189)+(B228), (A)+(B189)+(B229), (A)+(B189)+(B230), (A)+(B189)+(B231), (A)+(B189)+(B232), (A)+(B189)+(B233), (A)+(B189)+(B234), (A)+(B189)+(B235), (A)+(B189)+(B236), (A)+(B189)+(B237), (A)+(B189)+(B238), (A)+(B189)+(B239), (A)+(B189)+(B240), (A)+(B189)+(B241), (A)+(B189)+(B242), (A)+(B189)+(B243), (A)+(B189)+(B244), (A)+(B189)+(B245), (A)+(B189)+(B246), (A)+(B189)+(B247), (A)+(B189)+(B248), (A)+(B189)+(B249), (A)+(B189)+(B250), (A)+(B189)+(B251), (A)+(B189)+(B252), (A)+(B189)+(B253), (A)+(B189)+(B254), (A)+(B189)+(B255), (A)+(B189)+(B256), (A)+(B189)+(B257), (A)+(B189)+(B258), (A)+(B189)+(B259), (A)+(B189)+(B260), (A)+(B189)+(B261), (A)+(B189)+(B262), (A)+(B189)+(B263), (A)+(B189)+(B264), (A)+(B189)+(B265), (A)+(B189)+(B266), (A)+(B189)+(B267), (A)+(B189)+(B268), (A)+(B189)+(B269), (A)+(B189)+(B270), (A)+(B189)+(B271), (A)+(B189)+(B272), (A)+(B189)+(B273), (A)+(B189)+(B274), (A)+(B189)+(B275), (A)+(B189)+(B276), (A)+(B189)+(B277), (A)+(B189)+(B278), (A)+(B189)+(B279), (A)+(B189)+(B280), (A)+(B189)+(B281), (A)+(B189)+(B282), (A)+(B189)+(B283), (A)+(B189)+(B284), (A)+(B189)+(B285), (A)+(B189)+(B286), (A)+(B189)+(B287), (A)+(B189)+(B288), (A)+(B189)+(B289), (A)+(B189)+(B290), (A)+(B189)+(B291), (A)+(B189)+(B292), (A)+(B189)+(B293), (A)+(B189)+(B294), (A)+(B189)+(B295), (A)+(B189)+(B296), (A)+(B189)+(B297), (A)+(B189)+(B298), (A)+(B189)+(B299), (A)+(B189)+(B300), (A)+(B189)+(B301), (A)+(B189)+(B302), (A)+(B189)+(B303), (A)+(B189)+(B304), (A)+(B189)+(B305), (A)+(B189)+(B306), (A)+(B189)+(B307), (A)+(B189)+(B308), (A)+(B189)+(B309), (A)+(B189)+(B310), (A)+(B189)+(B311), (A)+(B189)+(B312), (A)+(B189)+(B313), (A)+(B189)+(B314), (A)+(B189)+(B315),

(A)+(B190)+(B191), (A)+(B190)+(B192), (A)+(B190)+(B193), (A)+(B190)+(B194), (A)+(B190)+(B195), (A)+(B190)+(B196), (A)+(B190)+(B197), (A)+(B190)+(B198), (A)+(B190)+(B199), (A)+(B190)+(B200), (A)+(B190)+(B201), (A)+(B190)+(B202), (A)+(B190)+(B203), (A)+(B190)+(B204), (A)+(B190)+(B205), (A)+(B190)+(B206), (A)+(B190)+(B207), (A)+(B190)+(B208), (A)+(B190)+(B209), (A)+(B190)+(B210), (A)+(B190)+(B211), (A)+(B190)+(B212), (A)+(B190)+(B213), (A)+(B190)+(B214), (A)+(B190)+(B215), (A)+(B190)+(B216), (A)+(B190)+(B217), (A)+(B190)+(B218), (A)+(B190)+(B219), (A)+(B190)+(B220), (A)+(B190)+(B221), (A)+(B190)+(B222), (A)+(B190)+(B223), (A)+(B190)+(B224), (A)+(B190)+(B225), (A)+(B190)+(B226), (A)+(B190)+(B227), (A)+(B190)+(B228), (A)+(B190)+(B229), (A)+(B190)+(B230), (A)+(B190)+(B231), (A)+(B190)+(B232), (A)+(B190)+(B233), (A)+(B190)+(B234), (A)+(B190)+(B235), (A)+(B190)+(B236), (A)+(B190)+(B237), (A)+(B190)+(B238), (A)+(B190)+(B239), (A)+(B190)+(B240), (A)+(B190)+(B241), (A)+(B190)+(B242), (A)+(B190)+(B243), (A)+(B190)+(B244), (A)+(B190)+(B245), (A)+(B190)+(B246), (A)+(B190)+(B247), (A)+(B190)+(B248), (A)+(B190)+(B249), (A)+(B190)+(B250), (A)+(B190)+(B251), (A)+(B190)+(B252), (A)+(B190)+(B253), (A)+(B190)+(B254), (A)+(B190)+(B255), (A)+(B190)+(B256), (A)+(B190)+(B257), (A)+(B190)+(B258), (A)+(B190)+(B259), (A)+(B190)+(B260), (A)+(B190)+(B261), (A)+(B190)+(B262), (A)+(B190)+(B263), (A)+(B190)+(B264), (A)+(B190)+(B265), (A)+(B190)+(B266), (A)+(B190)+(B267), (A)+(B190)+(B268), (A)+(B190)+(B269), (A)+(B190)+(B270), (A)+(B190)+(B271), (A)+(B190)+(B272), (A)+(B190)+(B273), (A)+(B190)+(B274), (A)+(B190)+(B275), (A)+(B190)+(B276), (A)+(B190)+(B277), (A)+(B190)+(B278), (A)+(B190)+(B279), (A)+(B190)+(B280), (A)+(B190)+(B281), (A)+(B190)+(B282), (A)+(B190)+(B283), (A)+(B190)+(B284), (A)+(B190)+(B285), (A)+(B190)+(B286), (A)+(B190)+(B287), (A)+(B190)+(B288), (A)+(B190)+(B289), (A)+(B190)+(B290), (A)+(B190)+(B291), (A)+(B190)+(B292), (A)+(B190)+(B293), (A)+(B190)+(B294), (A)+(B190)+(B295), (A)+(B190)+(B296), (A)+(B190)+(B297), (A)+(B190)+(B298), (A)+(B190)+(B299), (A)+(B190)+(B300), (A)+(B190)+(B301), (A)+(B190)+(B302), (A)+(B190)+(B303), (A)+(B190)+(B304), (A)+(B190)+(B305), (A)+(B190)+(B306), (A)+(B190)+(B307), (A)+(B190)+(B308), (A)+(B190)+(B309), (A)+(B190)+(B310), (A)+(B190)+(B311), (A)+(B190)+(B312), (A)+(B190)+(B313), (A)+(B190)+(B314), (A)+(B190)+(B315),

(A)+(B191)+(B192), (A)+(B191)+(B193), (A)+(B191)+(B194), (A)+(B191)+(B195), (A)+(B191)+(B196), (A)+(B191)+(B197), (A)+(B191)+(B198), (A)+(B191)+(B199), (A)+(B191)+(B200), (A)+(B191)+(B201), (A)+(B191)+(B202), (A)+(B191)+(B203), (A)+(B191)+(B204), (A)+(B191)+(B205), (A)+(B191)+(B206), (A)+(B191)+(B207), (A)+(B191)+(B208), (A)+(B191)+(B209), (A)+(B191)+(B210), (A)+(B191)+(B211), (A)+(B191)+(B212), (A)+(B191)+(B213), (A)+(B191)+(B214), (A)+(B191)+(B215), (A)+(B191)+(B216), (A)+(B191)+(B217), (A)+(B191)+(B218), (A)+(B191)+(B219), (A)+(B191)+(B220), (A)+(B191)+(B221), (A)+(B191)+(B222), (A)+(B191)+(B223), (A)+(B191)+(B224), (A)+(B191)+(B225), (A)+(B191)+(B226), (A)+(B191)+(B227), (A)+(B191)+(B228), (A)+(B191)+(B229), (A)+(B191)+(B230), (A)+(B191)+(B231), (A)+(B191)+(B232), (A)+(B191)+(B233), (A)+(B191)+(B234), (A)+(B191)+(B235), (A)+(B191)+(B236), (A)+(B191)+(B237), (A)+(B191)+(B238), (A)+(B191)+(B239), (A)+(B191)+(B240), (A)+(B191)+(B241), (A)+(B191)+(B242), (A)+(B191)+(B243), (A)+(B191)+(B244), (A)+(B191)+(B245), (A)+(B191)+(B246), (A)+(B191)+(B247), (A)+(B191)+(B248), (A)+(B191)+(B249), (A)+(B191)+(B250), (A)+(B191)+(B251), (A)+(B191)+(B252), (A)+(B191)+(B253), (A)+(B191)+(B254), (A)+(B191)+(B255), (A)+(B191)+(B256), (A)+(B191)+(B257), (A)+(B191)+(B258), (A)+(B191)+(B259), (A)+(B191)+(B260), (A)+(B191)+(B261), (A)+(B191)+(B262), (A)+(B191)+(B263), (A)+(B191)+(B264), (A)+(B191)+(B265), (A)+(B191)+(B266), (A)+(B191)+(B267), (A)+(B191)+(B268), (A)+(B191)+(B269), (A)+(B191)+(B270), (A)+(B191)+(B271), (A)+(B191)+(B272), (A)+(B191)+(B273), (A)+(B191)+(B274), (A)+(B191)+(B275), (A)+(B191)+(B276), (A)+(B191)+(B277), (A)+(B191)+(B278), (A)+(B191)+(B279), (A)+(B191)+(B280), (A)+(B191)+(B281), (A)+(B191)+(B282), (A)+(B191)+(B283), (A)+(B191)+(B284), (A)+(B191)+(B285), (A)+(B191)+(B286), (A)+(B191)+(B287), (A)+(B191)+(B288), (A)+(B191)+(B289), (A)+(B191)+(B290), (A)+(B191)+(B291), (A)+(B191)+(B292), (A)+(B191)+(B293), (A)+(B191)+(B294), (A)+(B191)+(B295), (A)+(B191)+(B296), (A)+(B191)+(B297), (A)+(B191)+(B298), (A)+(B191)+(B299), (A)+(B191)+(B300), (A)+(B191)+(B301), (A)+(B191)+(B302), (A)+(B191)+(B303), (A)+(B191)+(B304), (A)+(B191)+(B305), (A)+(B191)+(B306), (A)+(B191)+(B307), (A)+(B191)+(B308), (A)+(B191)+(B309), (A)+(B191)+(B310), (A)+(B191)+(B311), (A)+(B191)+(B312), (A)+(B191)+(B313), (A)+(B191)+(B314), (A)+(B191)+(B315),

(A)+(B192)+(B193), (A)+(B192)+(B194), (A)+(B192)+(B195), (A)+(B192)+(B196), (A)+(B192)+(B197), (A)+(B192)+(B198), (A)+(B192)+(B199), (A)+(B192)+(B200), (A)+(B192)+(B201), (A)+(B192)+(B202), (A)+(B192)+(B203), (A)+(B192)+(B204), (A)+(B192)+(B205), (A)+(B192)+(B206), (A)+(B192)+(B207), (A)+(B192)+(B208), (A)+(B192)+(B209), (A)+(B192)+(B210), (A)+(B192)+(B211), (A)+(B192)+(B212), (A)+(B192)+(B213), (A)+(B192)+(B214), (A)+(B192)+(B215), (A)+(B192)+(B216), (A)+(B192)+(B217), (A)+(B192)+(B218), (A)+(B192)+(B219), (A)+(B192)+(B220), (A)+(B192)+(B221), (A)+(B192)+(B222), (A)+(B192)+(B223), (A)+(B192)+(B224), (A)+(B192)+(B225), (A)+(B192)+(B226), (A)+(B192)+(B227), (A)+(B192)+(B228), (A)+(B192)+(B229), (A)+(B192)+(B230), (A)+(B192)+(B231), (A)+(B192)+(B232), (A)+(B192)+(B233), (A)+(B192)+(B234), (A)+(B192)+(B235), (A)+(B192)+(B236), (A)+(B192)+(B237), (A)+(B192)+(B238), (A)+(B192)+(B239), (A)+(B192)+(B240), (A)+(B192)+(B241), (A)+(B192)+(B242), (A)+(B192)+(B243), (A)+(B192)+(B244), (A)+(B192)+(B245), (A)+(B192)+(B246), (A)+(B192)+(B247), (A)+(B192)+(B248), (A)+(B192)+(B249), (A)+(B192)+(B250), (A)+(B192)+(B251), (A)+(B192)+(B252), (A)+(B192)+(B253), (A)+(B192)+(B254), (A)+(B192)+(B255), (A)+(B192)+(B256), (A)+(B192)+(B257), (A)+(B192)+(B258), (A)+(B192)+(B259), (A)+(B192)+(B260), (A)+(B192)+(B261), (A)+(B192)+(B262), (A)+(B192)+(B263), (A)+(B192)+(B264), (A)+(B192)+(B265), (A)+(B192)+(B266), (A)+(B192)+(B267), (A)+(B192)+(B268), (A)+(B192)+(B269), (A)+(B192)+(B270), (A)+(B192)+(B271), (A)+(B192)+(B272), (A)+(B192)+(B273), (A)+(B192)+(B274), (A)+(B192)+(B275), (A)+(B192)+(B276), (A)+(B192)+(B277), (A)+(B192)+(B278), (A)+(B192)+(B279), (A)+(B192)+(B280), (A)+(B192)+(B281), (A)+(B192)+(B282), (A)+(B192)+(B283), (A)+(B192)+(B284), (A)+(B192)+(B285), (A)+(B192)+(B286), (A)+(B192)+(B287), (A)+(B192)+(B288), (A)+(B192)+(B289), (A)+(B192)+(B290), (A)+(B192)+(B291), (A)+(B192)+(B292), (A)+(B192)+(B293), (A)+(B192)+(B294), (A)+(B192)+(B295), (A)+(B192)+(B296), (A)+(B192)+(B297), (A)+(B192)+(B298), (A)+(B192)+(B299), (A)+(B192)+(B300), (A)+(B192)+(B301), (A)+(B192)+(B302), (A)+(B192)+(B303), (A)+(B192)+(B304), (A)+(B192)+(B305), (A)+(B192)+(B306), (A)+(B192)+(B307), (A)+(B192)+(B308), (A)+(B192)+(B309), (A)+(B192)+(B310), (A)+(B192)+(B311), (A)+(B192)+(B312), (A)+(B192)+(B313), (A)+(B192)+(B314), (A)+(B192)+(B315),

(A)+(B193)+(B194), (A)+(B193)+(B195), (A)+(B193)+(B196), (A)+(B193)+(B197), (A)+(B193)+(B198), (A)+(B193)+(B199), (A)+(B193)+(B200), (A)+(B193)+(B201), (A)+(B193)+(B202), (A)+(B193)+(B203), (A)+(B193)+(B204), (A)+(B193)+(B205), (A)+(B193)+(B206), (A)+(B193)+(B207), (A)+(B193)+(B208), (A)+(B193)+(B209), (A)+(B193)+(B210), (A)+(B193)+(B211), (A)+(B193)+(B212), (A)+(B193)+(B213), (A)+(B193)+(B214), (A)+(B193)+(B215), (A)+(B193)+(B216), (A)+(B193)+(B217), (A)+(B193)+(B218), (A)+(B193)+(B219), (A)+(B193)+(B220), (A)+(B193)+(B221), (A)+(B193)+(B222), (A)+(B193)+(B223), (A)+(B193)+(B224), (A)+(B193)+(B225), (A)+(B193)+(B226), (A)+(B193)+(B227), (A)+(B193)+(B228), (A)+(B193)+(B229), (A)+(B193)+(B230), (A)+(B193)+(B231), (A)+(B193)+(B232), (A)+(B193)+(B233), (A)+(B193)+(B234), (A)+(B193)+(B235), (A)+(B193)+(B236), (A)+(B193)+(B237), (A)+(B193)+(B238), (A)+(B193)+(B239), (A)+(B193)+(B240), (A)+(B193)+(B241), (A)+(B193)+(B242), (A)+(B193)+(B243), (A)+(B193)+(B244), (A)+(B193)+(B245), (A)+(B193)+(B246), (A)+(B193)+(B247), (A)+(B193)+(B248), (A)+(B193)+(B249), (A)+(B193)+(B250), (A)+(B193)+(B251), (A)+(B193)+(B252), (A)+(B193)+(B253), (A)+(B193)+(B254), (A)+(B193)+(B255), (A)+(B193)+(B256), (A)+(B193)+(B257), (A)+(B193)+(B258), (A)+(B193)+(B259), (A)+(B193)+(B260), (A)+(B193)+(B261), (A)+(B193)+(B262), (A)+(B193)+(B263), (A)+(B193)+(B264), (A)+(B193)+(B265), (A)+(B193)+(B266), (A)+(B193)+(B267), (A)+(B193)+(B268), (A)+(B193)+(B269), (A)+(B193)+(B270), (A)+(B193)+(B271), (A)+(B193)+(B272), (A)+(B193)+(B273), (A)+(B193)+(B274), (A)+(B193)+(B275), (A)+(B193)+(B276), (A)+(B193)+(B277), (A)+(B193)+(B278), (A)+(B193)+(B279), (A)+(B193)+(B280), (A)+(B193)+(B281), (A)+(B193)+(B282), (A)+(B193)+(B283), (A)+(B193)+(B284), (A)+(B193)+(B285), (A)+(B193)+(B286), (A)+(B193)+(B287), (A)+(B193)+(B288), (A)+(B193)+(B289), (A)+(B193)+(B290), (A)+(B193)+(B291), (A)+(B193)+(B292), (A)+(B193)+(B293), (A)+(B193)+(B294), (A)+(B193)+(B295), (A)+(B193)+(B296), (A)+(B193)+(B297), (A)+(B193)+(B298), (A)+(B193)+(B299), (A)+(B193)+(B300), (A)+(B193)+(B301), (A)+(B193)+(B302), (A)+(B193)+(B303), (A)+(B193)+(B304), (A)+(B193)+(B305), (A)+(B193)+(B306), (A)+(B193)+(B307), (A)+(B193)+(B308), (A)+(B193)+(B309), (A)+(B193)+(B310), (A)+(B193)+(B311), (A)+(B193)+(B312), (A)+(B193)+(B313), (A)+(B193)+(B314), (A)+(B193)+(B315),

(A)+(B194)+(B195), (A)+(B194)+(B196), (A)+(B194)+(B197), (A)+(B194)+(B198), (A)+(B194)+(B199), (A)+(B194)+(B200), (A)+(B194)+(B201), (A)+(B194)+(B202), (A)+(B194)+(B203), (A)+(B194)+(B204), (A)+(B194)+(B205), (A)+(B194)+(B206), (A)+(B194)+(B207), (A)+(B194)+(B208), (A)+(B194)+(B209), (A)+(B194)+(B210), (A)+(B194)+(B211), (A)+(B194)+(B212), (A)+(B194)+(B213), (A)+(B194)+(B214), (A)+(B194)+(B215), (A)+(B194)+(B216), (A)+(B194)+(B217), (A)+(B194)+(B218), (A)+(B194)+(B219), (A)+(B194)+(B220), (A)+(B194)+(B221), (A)+(B194)+(B222), (A)+(B194)+(B223), (A)+(B194)+(B224), (A)+(B194)+(B225), (A)+(B194)+(B226), (A)+(B194)+(B227), (A)+(B194)+(B228), (A)+(B194)+(B229), (A)+(B194)+(B230), (A)+(B194)+(B231), (A)+(B194)+(B232), (A)+(B194)+(B233), (A)+(B194)+(B234), (A)+(B194)+(B235), (A)+(B194)+(B236), (A)+(B194)+(B237), (A)+(B194)+(B238), (A)+(B194)+(B239), (A)+(B194)+(B240), (A)+(B194)+(B241), (A)+(B194)+(B242), (A)+(B194)+(B243), (A)+(B194)+(B244), (A)+(B194)+(B245), (A)+(B194)+(B246), (A)+(B194)+(B247), (A)+(B194)+(B248), (A)+(B194)+(B249), (A)+(B194)+(B250), (A)+(B194)+(B251), (A)+(B194)+(B252), (A)+(B194)+(B253), (A)+(B194)+(B254), (A)+(B194)+(B255), (A)+(B194)+(B256), (A)+(B194)+(B257), (A)+(B194)+(B258), (A)+(B194)+(B259), (A)+(B194)+(B260), (A)+(B194)+(B261), (A)+(B194)+(B262), (A)+(B194)+(B263), (A)+(B194)+(B264), (A)+(B194)+(B265), (A)+(B194)+(B266), (A)+(B194)+(B267), (A)+(B194)+(B268), (A)+(B194)+(B269), (A)+(B194)+(B270), (A)+(B194)+(B271), (A)+(B194)+(B272), (A)+(B194)+(B273), (A)+(B194)+(B274), (A)+(B194)+(B275), (A)+(B194)+(B276), (A)+(B194)+(B277), (A)+(B194)+(B278), (A)+(B194)+(B279), (A)+(B194)+(B280), (A)+(B194)+(B281), (A)+(B194)+(B282), (A)+(B194)+(B283), (A)+(B194)+(B284), (A)+(B194)+(B285), (A)+(B194)+(B286), (A)+(B194)+(B287), (A)+(B194)+(B288), (A)+(B194)+(B289), (A)+(B194)+(B290), (A)+(B194)+(B291), (A)+(B194)+(B292), (A)+(B194)+(B293), (A)+(B194)+(B294), (A)+(B194)+(B295), (A)+(B194)+(B296), (A)+(B194)+(B297), (A)+(B194)+(B298), (A)+(B194)+(B299), (A)+(B194)+(B300), (A)+(B194)+(B301), (A)+(B194)+(B302), (A)+(B194)+(B303), (A)+(B194)+(B304), (A)+(B194)+(B305), (A)+(B194)+(B306), (A)+(B194)+(B307), (A)+(B194)+(B308), (A)+(B194)+(B309), (A)+(B194)+(B310), (A)+(B194)+(B311), (A)+(B194)+(B312), (A)+(B194)+(B313), (A)+(B194)+(B314), (A)+(B194)+(B315),

(A)+(B195)+(B196), (A)+(B195)+(B197), (A)+(B195)+(B198), (A)+(B195)+(B199), (A)+(B195)+(B200), (A)+(B195)+(B201), (A)+(B195)+(B202), (A)+(B195)+(B203), (A)+(B195)+(B204), (A)+(B195)+(B205), (A)+(B195)+(B206), (A)+(B195)+(B207), (A)+(B195)+(B208), (A)+(B195)+(B209), (A)+(B195)+(B210), (A)+(B195)+(B211), (A)+(B195)+(B212), (A)+(B195)+(B213), (A)+(B195)+(B214), (A)+(B195)+(B215), (A)+(B195)+(B216), (A)+(B195)+(B217), (A)+(B195)+(B218), (A)+(B195)+(B219), (A)+(B195)+(B220), (A)+(B195)+(B221), (A)+(B195)+(B222), (A)+(B195)+(B223), (A)+(B195)+(B224), (A)+(B195)+(B225), (A)+(B195)+(B226), (A)+(B195)+(B227), (A)+(B195)+(B228), (A)+(B195)+(B229), (A)+(B195)+(B230), (A)+(B195)+(B231), (A)+(B195)+(B232), (A)+(B195)+(B233), (A)+(B195)+(B234), (A)+(B195)+(B235), (A)+(B195)+(B236), (A)+(B195)+(B237), (A)+(B195)+(B238), (A)+(B195)+(B239), (A)+(B195)+(B240), (A)+(B195)+(B241), (A)+(B195)+(B242), (A)+(B195)+(B243), (A)+(B195)+(B244), (A)+(B195)+(B245), (A)+(B195)+(B246), (A)+(B195)+(B247), (A)+(B195)+(B248), (A)+(B195)+(B249), (A)+(B195)+(B250), (A)+(B195)+(B251), (A)+(B195)+(B252), (A)+(B195)+(B253), (A)+(B195)+(B254), (A)+(B195)+(B255), (A)+(B195)+(B256), (A)+(B195)+(B257), (A)+(B195)+(B258), (A)+(B195)+(B259), (A)+(B195)+(B260), (A)+(B195)+(B261), (A)+(B195)+(B262), (A)+(B195)+(B263), (A)+(B195)+(B264), (A)+(B195)+(B265), (A)+(B195)+(B266), (A)+(B195)+(B267), (A)+(B195)+(B268), (A)+(B195)+(B269), (A)+(B195)+(B270), (A)+(B195)+(B271), (A)+(B195)+(B272), (A)+(B195)+(B273), (A)+(B195)+(B274), (A)+(B195)+(B275), (A)+(B195)+(B276), (A)+(B195)+(B277), (A)+(B195)+(B278), (A)+(B195)+(B279), (A)+(B195)+(B280), (A)+(B195)+(B281), (A)+(B195)+(B282), (A)+(B195)+(B283), (A)+(B195)+(B284), (A)+(B195)+(B285), (A)+(B195)+(B286), (A)+(B195)+(B287), (A)+(B195)+(B288), (A)+(B195)+(B289), (A)+(B195)+(B290), (A)+(B195)+(B291), (A)+(B195)+(B292), (A)+(B195)+(B293), (A)+(B195)+(B294), (A)+(B195)+(B295), (A)+(B195)+(B296), (A)+(B195)+(B297), (A)+(B195)+(B298), (A)+(B195)+(B299), (A)+(B195)+(B300), (A)+(B195)+(B301), (A)+(B195)+(B302), (A)+(B195)+(B303), (A)+(B195)+(B304), (A)+(B195)+(B305), (A)+(B195)+(B306), (A)+(B195)+(B307), (A)+(B195)+(B308), (A)+(B195)+(B309), (A)+(B195)+(B310), (A)+(B195)+(B311), (A)+(B195)+(B312), (A)+(B195)+(B313), (A)+(B195)+(B314), (A)+(B195)+(B315),

(A)+(B196)+(B197), (A)+(B196)+(B198), (A)+(B196)+(B199), (A)+(B196)+(B200), (A)+(B196)+(B201), (A)+(B196)+(B202), (A)+(B196)+(B203), (A)+(B196)+(B204), (A)+(B196)+(B205), (A)+(B196)+(B206), (A)+(B196)+(B207), (A)+(B196)+(B208), (A)+(B196)+(B209), (A)+(B196)+(B210), (A)+(B196)+(B211), (A)+(B196)+(B212), (A)+(B196)+(B213), (A)+(B196)+(B214), (A)+(B196)+(B215), (A)+(B196)+(B216), (A)+(B196)+(B217), (A)+(B196)+(B218), (A)+(B196)+(B219), (A)+(B196)+(B220), (A)+(B196)+(B221), (A)+(B196)+(B222), (A)+(B196)+(B223), (A)+(B196)+(B224), (A)+(B196)+(B225), (A)+(B196)+(B226), (A)+(B196)+(B227), (A)+(B196)+(B228), (A)+(B196)+(B229), (A)+(B196)+(B230), (A)+(B196)+(B231), (A)+(B196)+(B232), (A)+(B196)+(B233), (A)+(B196)+(B234), (A)+(B196)+(B235), (A)+(B196)+(B236), (A)+(B196)+(B237), (A)+(B196)+(B238), (A)+(B196)+(B239), (A)+(B196)+(B240), (A)+(B196)+(B241), (A)+(B196)+(B242), (A)+(B196)+(B243), (A)+(B196)+(B244), (A)+(B196)+(B245), (A)+(B196)+(B246), (A)+(B196)+(B247), (A)+(B196)+(B248), (A)+(B196)+(B249), (A)+(B196)+(B250), (A)+(B196)+(B251), (A)+(B196)+(B252), (A)+(B196)+(B253), (A)+(B196)+(B254), (A)+(B196)+(B255), (A)+(B196)+(B256), (A)+(B196)+(B257), (A)+(B196)+(B258), (A)+(B196)+(B259), (A)+(B196)+(B260), (A)+(B196)+(B261), (A)+(B196)+(B262), (A)+(B196)+(B263), (A)+(B196)+(B264), (A)+(B196)+(B265), (A)+(B196)+(B266), (A)+(B196)+(B267), (A)+(B196)+(B268), (A)+(B196)+(B269), (A)+(B196)+(B270), (A)+(B196)+(B271), (A)+(B196)+(B272), (A)+(B196)+(B273), (A)+(B196)+(B274), (A)+(B196)+(B275), (A)+(B196)+(B276), (A)+(B196)+(B277), (A)+(B196)+(B278), (A)+(B196)+(B279), (A)+(B196)+(B280), (A)+(B196)+(B281), (A)+(B196)+(B282), (A)+(B196)+(B283), (A)+(B196)+(B284), (A)+(B196)+(B285), (A)+(B196)+(B286), (A)+(B196)+(B287), (A)+(B196)+(B288), (A)+(B196)+(B289), (A)+(B196)+(B290), (A)+(B196)+(B291), (A)+(B196)+(B292), (A)+(B196)+(B293), (A)+(B196)+(B294), (A)+(B196)+(B295), (A)+(B196)+(B296), (A)+(B196)+(B297), (A)+(B196)+(B298), (A)+(B196)+(B299), (A)+(B196)+(B300), (A)+(B196)+(B301), (A)+(B196)+(B302), (A)+(B196)+(B303), (A)+(B196)+(B304), (A)+(B196)+(B305), (A)+(B196)+(B306), (A)+(B196)+(B307), (A)+(B196)+(B308), (A)+(B196)+(B309), (A)+(B196)+(B310), (A)+(B196)+(B311), (A)+(B196)+(B312), (A)+(B196)+(B313), (A)+(B196)+(B314), (A)+(B196)+(B315),

(A)+(B197)+(B198), (A)+(B197)+(B199), (A)+(B197)+(B200), (A)+(B197)+(B201), (A)+(B197)+(B202), (A)+(B197)+(B203), (A)+(B197)+(B204), (A)+(B197)+(B205), (A)+(B197)+(B206), (A)+(B197)+(B207), (A)+(B197)+(B208), (A)+(B197)+(B209), (A)+(B197)+(B210), (A)+(B197)+(B211), (A)+(B197)+(B212), (A)+(B197)+(B213), (A)+(B197)+(B214), (A)+(B197)+(B215), (A)+(B197)+(B216), (A)+(B197)+(B217), (A)+(B197)+(B218), (A)+(B197)+(B219), (A)+(B197)+(B220), (A)+(B197)+(B221), (A)+(B197)+(B222), (A)+(B197)+(B223), (A)+(B197)+(B224), (A)+(B197)+(B225), (A)+(B197)+(B226), (A)+(B197)+(B227), (A)+(B197)+(B228), (A)+(B197)+(B229), (A)+(B197)+(B230), (A)+(B197)+(B231), (A)+(B197)+(B232), (A)+(B197)+(B233), (A)+(B197)+(B234), (A)+(B197)+(B235), (A)+(B197)+(B236), (A)+(B197)+(B237), (A)+(B197)+(B238), (A)+(B197)+(B239), (A)+(B197)+(B240), (A)+(B197)+(B241), (A)+(B197)+(B242), (A)+(B197)+(B243), (A)+(B197)+(B244), (A)+(B197)+(B245), (A)+(B197)+(B246), (A)+(B197)+(B247), (A)+(B197)+(B248), (A)+(B197)+(B249), (A)+(B197)+(B250), (A)+(B197)+(B251), (A)+(B197)+(B252), (A)+(B197)+(B253), (A)+(B197)+(B254), (A)+(B197)+(B255), (A)+(B197)+(B256), (A)+(B197)+(B257), (A)+(B197)+(B258), (A)+(B197)+(B259), (A)+(B197)+(B260), (A)+(B197)+(B261), (A)+(B197)+(B262), (A)+(B197)+(B263), (A)+(B197)+(B264), (A)+(B197)+(B265), (A)+(B197)+(B266), (A)+(B197)+(B267), (A)+(B197)+(B268), (A)+(B197)+(B269), (A)+(B197)+(B270), (A)+(B197)+(B271), (A)+(B197)+(B272), (A)+(B197)+(B273), (A)+(B197)+(B274), (A)+(B197)+(B275), (A)+(B197)+(B276), (A)+(B197)+(B277), (A)+(B197)+(B278), (A)+(B197)+(B279), (A)+(B197)+(B280), (A)+(B197)+(B281), (A)+(B197)+(B282), (A)+(B197)+(B283), (A)+(B197)+(B284), (A)+(B197)+(B285), (A)+(B197)+(B286), (A)+(B197)+(B287), (A)+(B197)+(B288), (A)+(B197)+(B289), (A)+(B197)+(B290), (A)+(B197)+(B291), (A)+(B197)+(B292), (A)+(B197)+(B293), (A)+(B197)+(B294), (A)+(B197)+(B295), (A)+(B197)+(B296), (A)+(B197)+(B297), (A)+(B197)+(B298), (A)+(B197)+(B299), (A)+(B197)+(B300), (A)+(B197)+(B301), (A)+(B197)+(B302), (A)+(B197)+(B303), (A)+(B197)+(B304), (A)+(B197)+(B305), (A)+(B197)+(B306), (A)+(B197)+(B307), (A)+(B197)+(B308), (A)+(B197)+(B309), (A)+(B197)+(B310), (A)+(B197)+(B311), (A)+(B197)+(B312), (A)+(B197)+(B313), (A)+(B197)+(B314), (A)+(B197)+(B315),

(A)+(B198)+(B199), (A)+(B198)+(B200), (A)+(B198)+(B201), (A)+(B198)+(B202), (A)+(B198)+(B203), (A)+(B198)+(B204), (A)+(B198)+(B205), (A)+(B198)+(B206), (A)+(B198)+(B207), (A)+(B198)+(B208), (A)+(B198)+(B209), (A)+(B198)+(B210), (A)+(B198)+(B211), (A)+(B198)+(B212), (A)+(B198)+(B213), (A)+(B198)+(B214), (A)+(B198)+(B215), (A)+(B198)+(B216), (A)+(B198)+(B217), (A)+(B198)+(B218), (A)+(B198)+(B219), (A)+(B198)+(B220), (A)+(B198)+(B221), (A)+(B198)+(B222), (A)+(B198)+(B223), (A)+(B198)+(B224), (A)+(B198)+(B225), (A)+(B198)+(B226), (A)+(B198)+(B227), (A)+(B198)+(B228), (A)+(B198)+(B229), (A)+(B198)+(B230), (A)+(B198)+(B231), (A)+(B198)+(B232), (A)+(B198)+(B233), (A)+(B198)+(B234), (A)+(B198)+(B235), (A)+(B198)+(B236), (A)+(B198)+(B237), (A)+(B198)+(B238), (A)+(B198)+(B239), (A)+(B198)+(B240), (A)+(B198)+(B241), (A)+(B198)+(B242), (A)+(B198)+(B243), (A)+(B198)+(B244), (A)+(B198)+(B245), (A)+(B198)+(B246), (A)+(B198)+(B247), (A)+(B198)+(B248), (A)+(B198)+(B249), (A)+(B198)+(B250), (A)+(B198)+(B251), (A)+(B198)+(B252), (A)+(B198)+(B253), (A)+(B198)+(B254), (A)+(B198)+(B255), (A)+(B198)+(B256), (A)+(B198)+(B257), (A)+(B198)+(B258), (A)+(B198)+(B259), (A)+(B198)+(B260), (A)+(B198)+(B261), (A)+(B198)+(B262), (A)+(B198)+(B263), (A)+(B198)+(B264), (A)+(B198)+(B265), (A)+(B198)+(B266), (A)+(B198)+(B267), (A)+(B198)+(B268), (A)+(B198)+(B269), (A)+(B198)+(B270), (A)+(B198)+(B271), (A)+(B198)+(B272), (A)+(B198)+(B273), (A)+(B198)+(B274), (A)+(B198)+(B275), (A)+(B198)+(B276), (A)+(B198)+(B277), (A)+(B198)+(B278), (A)+(B198)+(B279), (A)+(B198)+(B280), (A)+(B198)+(B281), (A)+(B198)+(B282), (A)+(B198)+(B283), (A)+(B198)+(B284), (A)+(B198)+(B285), (A)+(B198)+(B286), (A)+(B198)+(B287), (A)+(B198)+(B288), (A)+(B198)+(B289), (A)+(B198)+(B290), (A)+(B198)+(B291), (A)+(B198)+(B292), (A)+(B198)+(B293), (A)+(B198)+(B294), (A)+(B198)+(B295), (A)+(B198)+(B296), (A)+(B198)+(B297), (A)+(B198)+(B298), (A)+(B198)+(B299), (A)+(B198)+(B300), (A)+(B198)+(B301), (A)+(B198)+(B302), (A)+(B198)+(B303), (A)+(B198)+(B304), (A)+(B198)+(B305), (A)+(B198)+(B306), (A)+(B198)+(B307), (A)+(B198)+(B308), (A)+(B198)+(B309), (A)+(B198)+(B310), (A)+(B198)+(B311), (A)+(B198)+(B312), (A)+(B198)+(B313), (A)+(B198)+(B314), (A)+(B198)+(B315),

(A)+(B199)+(B200), (A)+(B199)+(B201), (A)+(B199)+(B202), (A)+(B199)+(B203), (A)+(B199)+(B204), (A)+(B199)+(B205), (A)+(B199)+(B206), (A)+(B199)+(B207), (A)+(B199)+(B208), (A)+(B199)+(B209), (A)+(B199)+(B210), (A)+(B199)+(B211), (A)+(B199)+(B212), (A)+(B199)+(B213), (A)+(B199)+(B214), (A)+(B199)+(B215), (A)+(B199)+(B216), (A)+(B199)+(B217), (A)+(B199)+(B218), (A)+(B199)+(B219), (A)+(B199)+(B220), (A)+(B199)+(B221), (A)+(B199)+(B222), (A)+(B199)+(B223), (A)+(B199)+(B224), (A)+(B199)+(B225), (A)+(B199)+(B226), (A)+(B199)+(B227), (A)+(B199)+(B228), (A)+(B199)+(B229), (A)+(B199)+(B230), (A)+(B199)+(B231), (A)+(B199)+(B232), (A)+(B199)+(B233), (A)+(B199)+(B234), (A)+(B199)+(B235), (A)+(B199)+(B236), (A)+(B199)+(B237), (A)+(B199)+(B238), (A)+(B199)+(B239), (A)+(B199)+(B240), (A)+(B199)+(B241), (A)+(B199)+(B242), (A)+(B199)+(B243), (A)+(B199)+(B244), (A)+(B199)+(B245), (A)+(B199)+(B246), (A)+(B199)+(B247), (A)+(B199)+(B248), (A)+(B199)+(B249), (A)+(B199)+(B250), (A)+(B199)+(B251), (A)+(B199)+(B252), (A)+(B199)+(B253), (A)+(B199)+(B254), (A)+(B199)+(B255), (A)+(B199)+(B256), (A)+(B199)+(B257), (A)+(B199)+(B258), (A)+(B199)+(B259), (A)+(B199)+(B260), (A)+(B199)+(B261), (A)+(B199)+(B262), (A)+(B199)+(B263), (A)+(B199)+(B264), (A)+(B199)+(B265), (A)+(B199)+(B266), (A)+(B199)+(B267), (A)+(B199)+(B268), (A)+(B199)+(B269), (A)+(B199)+(B270), (A)+(B199)+(B271), (A)+(B199)+(B272), (A)+(B199)+(B273), (A)+(B199)+(B274), (A)+(B199)+(B275), (A)+(B199)+(B276), (A)+(B199)+(B277), (A)+(B199)+(B278), (A)+(B199)+(B279), (A)+(B199)+(B280), (A)+(B199)+(B281), (A)+(B199)+(B282), (A)+(B199)+(B283), (A)+(B199)+(B284), (A)+(B199)+(B285), (A)+(B199)+(B286), (A)+(B199)+(B287), (A)+(B199)+(B288), (A)+(B199)+(B289), (A)+(B199)+(B290), (A)+(B199)+(B291), (A)+(B199)+(B292), (A)+(B199)+(B293), (A)+(B199)+(B294), (A)+(B199)+(B295), (A)+(B199)+(B296), (A)+(B199)+(B297), (A)+(B199)+(B298), (A)+(B199)+(B299), (A)+(B199)+(B300), (A)+(B199)+(B301), (A)+(B199)+(B302), (A)+(B199)+(B303), (A)+(B199)+(B304), (A)+(B199)+(B305), (A)+(B199)+(B306), (A)+(B199)+(B307), (A)+(B199)+(B308), (A)+(B199)+(B309), (A)+(B199)+(B310), (A)+(B199)+(B311), (A)+(B199)+(B312), (A)+(B199)+(B313), (A)+(B199)+(B314), (A)+(B199)+(B315),

(A)+(B200)+(B201), (A)+(B200)+(B202), (A)+(B200)+(B203), (A)+(B200)+(B204), (A)+(B200)+(B205), (A)+(B200)+(B206), (A)+(B200)+(B207), (A)+(B200)+(B208), (A)+(B200)+(B209), (A)+(B200)+(B210), (A)+(B200)+(B211), (A)+(B200)+(B212), (A)+(B200)+(B213), (A)+(B200)+(B214), (A)+(B200)+(B215), (A)+(B200)+(B216), (A)+(B200)+(B217), (A)+(B200)+(B218), (A)+(B200)+(B219), (A)+(B200)+(B220), (A)+(B200)+(B221), (A)+(B200)+(B222), (A)+(B200)+(B223), (A)+(B200)+(B224), (A)+(B200)+(B225), (A)+(B200)+(B226), (A)+(B200)+(B227), (A)+(B200)+(B228), (A)+(B200)+(B229), (A)+(B200)+(B230), (A)+(B200)+(B231), (A)+(B200)+(B232), (A)+(B200)+(B233), (A)+(B200)+(B234), (A)+(B200)+(B235), (A)+(B200)+(B236), (A)+(B200)+(B237), (A)+(B200)+(B238), (A)+(B200)+(B239), (A)+(B200)+(B240), (A)+(B200)+(B241), (A)+(B200)+(B242), (A)+(B200)+(B243), (A)+(B200)+(B244), (A)+(B200)+(B245), (A)+(B200)+(B246), (A)+(B200)+(B247), (A)+(B200)+(B248), (A)+(B200)+(B249), (A)+(B200)+(B250), (A)+(B200)+(B251), (A)+(B200)+(B252), (A)+(B200)+(B253), (A)+(B200)+(B254), (A)+(B200)+(B255), (A)+(B200)+(B256), (A)+(B200)+(B257), (A)+(B200)+(B258), (A)+(B200)+(B259), (A)+(B200)+(B260), (A)+(B200)+(B261), (A)+(B200)+(B262), (A)+(B200)+(B263), (A)+(B200)+(B264), (A)+(B200)+(B265), (A)+(B200)+(B266), (A)+(B200)+(B267), (A)+(B200)+(B268), (A)+(B200)+(B269), (A)+(B200)+(B270), (A)+(B200)+(B271), (A)+(B200)+(B272), (A)+(B200)+(B273), (A)+(B200)+(B274), (A)+(B200)+(B275), (A)+(B200)+(B276), (A)+(B200)+(B277), (A)+(B200)+(B278), (A)+(B200)+(B279), (A)+(B200)+(B280), (A)+(B200)+(B281), (A)+(B200)+(B282), (A)+(B200)+(B283), (A)+(B200)+(B284), (A)+(B200)+(B285), (A)+(B200)+(B286), (A)+(B200)+(B287), (A)+(B200)+(B288), (A)+(B200)+(B289), (A)+(B200)+(B290), (A)+(B200)+(B291), (A)+(B200)+(B292), (A)+(B200)+(B293), (A)+(B200)+(B294), (A)+(B200)+(B295), (A)+(B200)+(B296), (A)+(B200)+(B297), (A)+(B200)+(B298), (A)+(B200)+(B299), (A)+(B200)+(B300), (A)+(B200)+(B301), (A)+(B200)+(B302), (A)+(B200)+(B303), (A)+(B200)+(B304), (A)+(B200)+(B305), (A)+(B200)+(B306), (A)+(B200)+(B307), (A)+(B200)+(B308), (A)+(B200)+(B309), (A)+(B200)+(B310), (A)+(B200)+(B311), (A)+(B200)+(B312), (A)+(B200)+(B313), (A)+(B200)+(B314), (A)+(B200)+(B315),

(A)+(B201)+(B202), (A)+(B201)+(B203), (A)+(B201)+(B204), (A)+(B201)+(B205), (A)+(B201)+(B206), (A)+(B201)+(B207), (A)+(B201)+(B208), (A)+(B201)+(B209), (A)+(B201)+(B210), (A)+(B201)+(B211), (A)+(B201)+(B212), (A)+(B201)+(B213), (A)+(B201)+(B214), (A)+(B201)+(B215), (A)+(B201)+(B216), (A)+(B201)+(B217), (A)+(B201)+(B218), (A)+(B201)+(B219), (A)+(B201)+(B220), (A)+(B201)+(B221), (A)+(B201)+(B222), (A)+(B201)+(B223), (A)+(B201)+(B224), (A)+(B201)+(B225), (A)+(B201)+(B226), (A)+(B201)+(B227), (A)+(B201)+(B228), (A)+(B201)+(B229), (A)+(B201)+(B230), (A)+(B201)+(B231), (A)+(B201)+(B232), (A)+(B201)+(B233), (A)+(B201)+(B234), (A)+(B201)+(B235), (A)+(B201)+(B236), (A)+(B201)+(B237), (A)+(B201)+(B238), (A)+(B201)+(B239), (A)+(B201)+(B240), (A)+(B201)+(B241), (A)+(B201)+(B242), (A)+(B201)+(B243), (A)+(B201)+(B244), (A)+(B201)+(B245), (A)+(B201)+(B246), (A)+(B201)+(B247), (A)+(B201)+(B248), (A)+(B201)+(B249), (A)+(B201)+(B250), (A)+(B201)+(B251), (A)+(B201)+(B252), (A)+(B201)+(B253), (A)+(B201)+(B254), (A)+(B201)+(B255), (A)+(B201)+(B256), (A)+(B201)+(B257), (A)+(B201)+(B258), (A)+(B201)+(B259), (A)+(B201)+(B260), (A)+(B201)+(B261), (A)+(B201)+(B262), (A)+(B201)+(B263), (A)+(B201)+(B264), (A)+(B201)+(B265), (A)+(B201)+(B266), (A)+(B201)+(B267), (A)+(B201)+(B268), (A)+(B201)+(B269), (A)+(B201)+(B270), (A)+(B201)+(B271), (A)+(B201)+(B272), (A)+(B201)+(B273), (A)+(B201)+(B274), (A)+(B201)+(B275), (A)+(B201)+(B276), (A)+(B201)+(B277), (A)+(B201)+(B278), (A)+(B201)+(B279), (A)+(B201)+(B280), (A)+(B201)+(B281), (A)+(B201)+(B282), (A)+(B201)+(B283), (A)+(B201)+(B284), (A)+(B201)+(B285), (A)+(B201)+(B286), (A)+(B201)+(B287), (A)+(B201)+(B288), (A)+(B201)+(B289), (A)+(B201)+(B290), (A)+(B201)+(B291), (A)+(B201)+(B292), (A)+(B201)+(B293), (A)+(B201)+(B294), (A)+(B201)+(B295), (A)+(B201)+(B296), (A)+(B201)+(B297), (A)+(B201)+(B298), (A)+(B201)+(B299), (A)+(B201)+(B300), (A)+(B201)+(B301), (A)+(B201)+(B302), (A)+(B201)+(B303), (A)+(B201)+(B304), (A)+(B201)+(B305), (A)+(B201)+(B306), (A)+(B201)+(B307), (A)+(B201)+(B308), (A)+(B201)+(B309), (A)+(B201)+(B310), (A)+(B201)+(B311), (A)+(B201)+(B312), (A)+(B201)+(B313), (A)+(B201)+(B314), (A)+(B201)+(B315),

(A)+(B202)+(B203), (A)+(B202)+(B204), (A)+(B202)+(B205), (A)+(B202)+(B206), (A)+(B202)+(B207), (A)+(B202)+(B208), (A)+(B202)+(B209), (A)+(B202)+(B210), (A)+(B202)+(B211), (A)+(B202)+(B212), (A)+(B202)+(B213), (A)+(B202)+(B214), (A)+(B202)+(B215), (A)+(B202)+(B216), (A)+(B202)+(B217), (A)+(B202)+(B218), (A)+(B202)+(B219), (A)+(B202)+(B220), (A)+(B202)+(B221), (A)+(B202)+(B222), (A)+(B202)+(B223), (A)+(B202)+(B224), (A)+(B202)+(B225), (A)+(B202)+(B226), (A)+(B202)+(B227), (A)+(B202)+(B228), (A)+(B202)+(B229), (A)+(B202)+(B230), (A)+(B202)+(B231), (A)+(B202)+(B232), (A)+(B202)+(B233), (A)+(B202)+(B234), (A)+(B202)+(B235), (A)+(B202)+(B236), (A)+(B202)+(B237), (A)+(B202)+(B238), (A)+(B202)+(B239), (A)+(B202)+(B240), (A)+(B202)+(B241), (A)+(B202)+(B242), (A)+(B202)+(B243), (A)+(B202)+(B244), (A)+(B202)+(B245), (A)+(B202)+(B246), (A)+(B202)+(B247), (A)+(B202)+(B248), (A)+(B202)+(B249), (A)+(B202)+(B250), (A)+(B202)+(B251), (A)+(B202)+(B252), (A)+(B202)+(B253), (A)+(B202)+(B254), (A)+(B202)+(B255), (A)+(B202)+(B256), (A)+(B202)+(B257), (A)+(B202)+(B258), (A)+(B202)+(B259), (A)+(B202)+(B260), (A)+(B202)+(B261), (A)+(B202)+(B262), (A)+(B202)+(B263), (A)+(B202)+(B264), (A)+(B202)+(B265), (A)+(B202)+(B266), (A)+(B202)+(B267), (A)+(B202)+(B268), (A)+(B202)+(B269), (A)+(B202)+(B270), (A)+(B202)+(B271), (A)+(B202)+(B272), (A)+(B202)+(B273), (A)+(B202)+(B274), (A)+(B202)+(B275), (A)+(B202)+(B276), (A)+(B202)+(B277), (A)+(B202)+(B278), (A)+(B202)+(B279), (A)+(B202)+(B280), (A)+(B202)+(B281), (A)+(B202)+(B282), (A)+(B202)+(B283), (A)+(B202)+(B284), (A)+(B202)+(B285), (A)+(B202)+(B286), (A)+(B202)+(B287), (A)+(B202)+(B288), (A)+(B202)+(B289), (A)+(B202)+(B290), (A)+(B202)+(B291), (A)+(B202)+(B292), (A)+(B202)+(B293), (A)+(B202)+(B294), (A)+(B202)+(B295), (A)+(B202)+(B296), (A)+(B202)+(B297), (A)+(B202)+(B298), (A)+(B202)+(B299), (A)+(B202)+(B300), (A)+(B202)+(B301), (A)+(B202)+(B302), (A)+(B202)+(B303), (A)+(B202)+(B304), (A)+(B202)+(B305), (A)+(B202)+(B306), (A)+(B202)+(B307), (A)+(B202)+(B308), (A)+(B202)+(B309), (A)+(B202)+(B310), (A)+(B202)+(B311), (A)+(B202)+(B312), (A)+(B202)+(B313), (A)+(B202)+(B314), (A)+(B202)+(B315),

(A)+(B203)+(B204), (A)+(B203)+(B205), (A)+(B203)+(B206), (A)+(B203)+(B207), (A)+(B203)+(B208), (A)+(B203)+(B209), (A)+(B203)+(B210), (A)+(B203)+(B211), (A)+(B203)+(B212), (A)+(B203)+(B213), (A)+(B203)+(B214), (A)+(B203)+(B215), (A)+(B203)+(B216), (A)+(B203)+(B217), (A)+(B203)+(B218), (A)+(B203)+(B219), (A)+(B203)+(B220), (A)+(B203)+(B221), (A)+(B203)+(B222), (A)+(B203)+(B223), (A)+(B203)+(B224), (A)+(B203)+(B225), (A)+(B203)+(B226), (A)+(B203)+(B227), (A)+(B203)+(B228), (A)+(B203)+(B229), (A)+(B203)+(B230), (A)+(B203)+(B231), (A)+(B203)+(B232), (A)+(B203)+(B233), (A)+(B203)+(B234), (A)+(B203)+(B235), (A)+(B203)+(B236), (A)+(B203)+(B237), (A)+(B203)+(B238), (A)+(B203)+(B239), (A)+(B203)+(B240), (A)+(B203)+(B241), (A)+(B203)+(B242), (A)+(B203)+(B243), (A)+(B203)+(B244), (A)+(B203)+(B245), (A)+(B203)+(B246), (A)+(B203)+(B247), (A)+(B203)+(B248), (A)+(B203)+(B249), (A)+(B203)+(B250), (A)+(B203)+(B251), (A)+(B203)+(B252), (A)+(B203)+(B253), (A)+(B203)+(B254), (A)+(B203)+(B255), (A)+(B203)+(B256), (A)+(B203)+(B257), (A)+(B203)+(B258), (A)+(B203)+(B259), (A)+(B203)+(B260), (A)+(B203)+(B261), (A)+(B203)+(B262), (A)+(B203)+(B263), (A)+(B203)+(B264), (A)+(B203)+(B265), (A)+(B203)+(B266), (A)+(B203)+(B267), (A)+(B203)+(B268), (A)+(B203)+(B269), (A)+(B203)+(B270), (A)+(B203)+(B271), (A)+(B203)+(B272), (A)+(B203)+(B273), (A)+(B203)+(B274), (A)+(B203)+(B275), (A)+(B203)+(B276), (A)+(B203)+(B277), (A)+(B203)+(B278), (A)+(B203)+(B279), (A)+(B203)+(B280), (A)+(B203)+(B281), (A)+(B203)+(B282), (A)+(B203)+(B283), (A)+(B203)+(B284), (A)+(B203)+(B285), (A)+(B203)+(B286), (A)+(B203)+(B287), (A)+(B203)+(B288), (A)+(B203)+(B289), (A)+(B203)+(B290), (A)+(B203)+(B291), (A)+(B203)+(B292), (A)+(B203)+(B293), (A)+(B203)+(B294), (A)+(B203)+(B295), (A)+(B203)+(B296), (A)+(B203)+(B297), (A)+(B203)+(B298), (A)+(B203)+(B299), (A)+(B203)+(B300), (A)+(B203)+(B301), (A)+(B203)+(B302), (A)+(B203)+(B303), (A)+(B203)+(B304), (A)+(B203)+(B305), (A)+(B203)+(B306), (A)+(B203)+(B307), (A)+(B203)+(B308), (A)+(B203)+(B309), (A)+(B203)+(B310), (A)+(B203)+(B311), (A)+(B203)+(B312), (A)+(B203)+(B313), (A)+(B203)+(B314), (A)+(B203)+(B315),

(A)+(B204)+(B205), (A)+(B204)+(B206), (A)+(B204)+(B207), (A)+(B204)+(B208), (A)+(B204)+(B209), (A)+(B204)+(B210), (A)+(B204)+(B211), (A)+(B204)+(B212), (A)+(B204)+(B213), (A)+(B204)+(B214), (A)+(B204)+(B215), (A)+(B204)+(B216), (A)+(B204)+(B217), (A)+(B204)+(B218), (A)+(B204)+(B219), (A)+(B204)+(B220), (A)+(B204)+(B221), (A)+(B204)+(B222), (A)+(B204)+(B223), (A)+(B204)+(B224), (A)+(B204)+(B225), (A)+(B204)+(B226), (A)+(B204)+(B227), (A)+(B204)+(B228), (A)+(B204)+(B229), (A)+(B204)+(B230), (A)+(B204)+(B231), (A)+(B204)+(B232), (A)+(B204)+(B233), (A)+(B204)+(B234), (A)+(B204)+(B235), (A)+(B204)+(B236), (A)+(B204)+(B237), (A)+(B204)+(B238), (A)+(B204)+(B239), (A)+(B204)+(B240), (A)+(B204)+(B241), (A)+(B204)+(B242), (A)+(B204)+(B243), (A)+(B204)+(B244), (A)+(B204)+(B245), (A)+(B204)+(B246), (A)+(B204)+(B247), (A)+(B204)+(B248), (A)+(B204)+(B249), (A)+(B204)+(B250), (A)+(B204)+(B251), (A)+(B204)+(B252), (A)+(B204)+(B253), (A)+(B204)+(B254), (A)+(B204)+(B255), (A)+(B204)+(B256), (A)+(B204)+(B257), (A)+(B204)+(B258), (A)+(B204)+(B259), (A)+(B204)+(B260), (A)+(B204)+(B261), (A)+(B204)+(B262), (A)+(B204)+(B263), (A)+(B204)+(B264), (A)+(B204)+(B265), (A)+(B204)+(B266), (A)+(B204)+(B267), (A)+(B204)+(B268), (A)+(B204)+(B269), (A)+(B204)+(B270), (A)+(B204)+(B271), (A)+(B204)+(B272), (A)+(B204)+(B273), (A)+(B204)+(B274), (A)+(B204)+(B275), (A)+(B204)+(B276), (A)+(B204)+(B277), (A)+(B204)+(B278), (A)+(B204)+(B279), (A)+(B204)+(B280), (A)+(B204)+(B281), (A)+(B204)+(B282), (A)+(B204)+(B283), (A)+(B204)+(B284), (A)+(B204)+(B285), (A)+(B204)+(B286), (A)+(B204)+(B287), (A)+(B204)+(B288), (A)+(B204)+(B289), (A)+(B204)+(B290), (A)+(B204)+(B291), (A)+(B204)+(B292), (A)+(B204)+(B293), (A)+(B204)+(B294), (A)+(B204)+(B295), (A)+(B204)+(B296), (A)+(B204)+(B297), (A)+(B204)+(B298), (A)+(B204)+(B299), (A)+(B204)+(B300), (A)+(B204)+(B301), (A)+(B204)+(B302), (A)+(B204)+(B303), (A)+(B204)+(B304), (A)+(B204)+(B305), (A)+(B204)+(B306), (A)+(B204)+(B307), (A)+(B204)+(B308), (A)+(B204)+(B309), (A)+(B204)+(B310), (A)+(B204)+(B311), (A)+(B204)+(B312), (A)+(B204)+(B313), (A)+(B204)+(B314), (A)+(B204)+(B315),

(A)+(B205)+(B206), (A)+(B205)+(B207), (A)+(B205)+(B208), (A)+(B205)+(B209), (A)+(B205)+(B210), (A)+(B205)+(B211), (A)+(B205)+(B212), (A)+(B205)+(B213), (A)+(B205)+(B214), (A)+(B205)+(B215), (A)+(B205)+(B216), (A)+(B205)+(B217), (A)+(B205)+(B218), (A)+(B205)+(B219), (A)+(B205)+(B220), (A)+(B205)+(B221), (A)+(B205)+(B222), (A)+(B205)+(B223), (A)+(B205)+(B224), (A)+(B205)+(B225), (A)+(B205)+(B226), (A)+(B205)+(B227), (A)+(B205)+(B228), (A)+(B205)+(B229), (A)+(B205)+(B230), (A)+(B205)+(B231), (A)+(B205)+(B232), (A)+(B205)+(B233), (A)+(B205)+(B234), (A)+(B205)+(B235), (A)+(B205)+(B236), (A)+(B205)+(B237), (A)+(B205)+(B238), (A)+(B205)+(B239), (A)+(B205)+(B240), (A)+(B205)+(B241), (A)+(B205)+(B242), (A)+(B205)+(B243), (A)+(B205)+(B244), (A)+(B205)+(B245), (A)+(B205)+(B246), (A)+(B205)+(B247), (A)+(B205)+(B248), (A)+(B205)+(B249), (A)+(B205)+(B250), (A)+(B205)+(B251), (A)+(B205)+(B252), (A)+(B205)+(B253), (A)+(B205)+(B254), (A)+(B205)+(B255), (A)+(B205)+(B256), (A)+(B205)+(B257), (A)+(B205)+(B258), (A)+(B205)+(B259), (A)+(B205)+(B260), (A)+(B205)+(B261), (A)+(B205)+(B262), (A)+(B205)+(B263), (A)+(B205)+(B264), (A)+(B205)+(B265), (A)+(B205)+(B266), (A)+(B205)+(B267), (A)+(B205)+(B268), (A)+(B205)+(B269), (A)+(B205)+(B270), (A)+(B205)+(B271), (A)+(B205)+(B272), (A)+(B205)+(B273), (A)+(B205)+(B274), (A)+(B205)+(B275), (A)+(B205)+(B276), (A)+(B205)+(B277), (A)+(B205)+(B278), (A)+(B205)+(B279), (A)+(B205)+(B280), (A)+(B205)+(B281), (A)+(B205)+(B282), (A)+(B205)+(B283), (A)+(B205)+(B284), (A)+(B205)+(B285), (A)+(B205)+(B286), (A)+(B205)+(B287), (A)+(B205)+(B288), (A)+(B205)+(B289), (A)+(B205)+(B290), (A)+(B205)+(B291), (A)+(B205)+(B292), (A)+(B205)+(B293), (A)+(B205)+(B294), (A)+(B205)+(B295), (A)+(B205)+(B296), (A)+(B205)+(B297), (A)+(B205)+(B298), (A)+(B205)+(B299), (A)+(B205)+(B300), (A)+(B205)+(B301), (A)+(B205)+(B302), (A)+(B205)+(B303), (A)+(B205)+(B304), (A)+(B205)+(B305), (A)+(B205)+(B306), (A)+(B205)+(B307), (A)+(B205)+(B308), (A)+(B205)+(B309), (A)+(B205)+(B310), (A)+(B205)+(B311), (A)+(B205)+(B312), (A)+(B205)+(B313), (A)+(B205)+(B314), (A)+(B205)+(B315),

(A)+(B206)+(B207), (A)+(B206)+(B208), (A)+(B206)+(B209), (A)+(B206)+(B210), (A)+(B206)+(B211), (A)+(B206)+(B212), (A)+(B206)+(B213), (A)+(B206)+(B214), (A)+(B206)+(B215), (A)+(B206)+(B216), (A)+(B206)+(B217), (A)+(B206)+(B218), (A)+(B206)+(B219), (A)+(B206)+(B220), (A)+(B206)+(B221), (A)+(B206)+(B222), (A)+(B206)+(B223), (A)+(B206)+(B224), (A)+(B206)+(B225), (A)+(B206)+(B226), (A)+(B206)+(B227), (A)+(B206)+(B228), (A)+(B206)+(B229), (A)+(B206)+(B230), (A)+(B206)+(B231), (A)+(B206)+(B232), (A)+(B206)+(B233), (A)+(B206)+(B234), (A)+(B206)+(B235), (A)+(B206)+(B236), (A)+(B206)+(B237), (A)+(B206)+(B238), (A)+(B206)+(B239), (A)+(B206)+(B240), (A)+(B206)+(B241), (A)+(B206)+(B242), (A)+(B206)+(B243), (A)+(B206)+(B244), (A)+(B206)+(B245), (A)+(B206)+(B246), (A)+(B206)+(B247), (A)+(B206)+(B248), (A)+(B206)+(B249), (A)+(B206)+(B250), (A)+(B206)+(B251), (A)+(B206)+(B252), (A)+(B206)+(B253), (A)+(B206)+(B254), (A)+(B206)+(B255), (A)+(B206)+(B256), (A)+(B206)+(B257), (A)+(B206)+(B258), (A)+(B206)+(B259), (A)+(B206)+(B260), (A)+(B206)+(B261), (A)+(B206)+(B262), (A)+(B206)+(B263), (A)+(B206)+(B264), (A)+(B206)+(B265), (A)+(B206)+(B266), (A)+(B206)+(B267), (A)+(B206)+(B268), (A)+(B206)+(B269), (A)+(B206)+(B270), (A)+(B206)+(B271), (A)+(B206)+(B272), (A)+(B206)+(B273), (A)+(B206)+(B274), (A)+(B206)+(B275), (A)+(B206)+(B276), (A)+(B206)+(B277), (A)+(B206)+(B278), (A)+(B206)+(B279), (A)+(B206)+(B280), (A)+(B206)+(B281), (A)+(B206)+(B282), (A)+(B206)+(B283), (A)+(B206)+(B284), (A)+(B206)+(B285), (A)+(B206)+(B286), (A)+(B206)+(B287), (A)+(B206)+(B288), (A)+(B206)+(B289), (A)+(B206)+(B290), (A)+(B206)+(B291), (A)+(B206)+(B292), (A)+(B206)+(B293), (A)+(B206)+(B294), (A)+(B206)+(B295), (A)+(B206)+(B296), (A)+(B206)+(B297), (A)+(B206)+(B298), (A)+(B206)+(B299), (A)+(B206)+(B300), (A)+(B206)+(B301), (A)+(B206)+(B302), (A)+(B206)+(B303), (A)+(B206)+(B304), (A)+(B206)+(B305), (A)+(B206)+(B306), (A)+(B206)+(B307), (A)+(B206)+(B308), (A)+(B206)+(B309), (A)+(B206)+(B310), (A)+(B206)+(B311), (A)+(B206)+(B312), (A)+(B206)+(B313), (A)+(B206)+(B314), (A)+(B206)+(B315),

(A)+(B207)+(B208), (A)+(B207)+(B209), (A)+(B207)+(B210), (A)+(B207)+(B211), (A)+(B207)+(B212), (A)+(B207)+(B213), (A)+(B207)+(B214), (A)+(B207)+(B215), (A)+(B207)+(B216), (A)+(B207)+(B217), (A)+(B207)+(B218), (A)+(B207)+(B219), (A)+(B207)+(B220), (A)+(B207)+(B221), (A)+(B207)+(B222), (A)+(B207)+(B223), (A)+(B207)+(B224), (A)+(B207)+(B225), (A)+(B207)+(B226), (A)+(B207)+(B227), (A)+(B207)+(B228), (A)+(B207)+(B229), (A)+(B207)+(B230), (A)+(B207)+(B231), (A)+(B207)+(B232), (A)+(B207)+(B233), (A)+(B207)+(B234), (A)+(B207)+(B235), (A)+(B207)+(B236), (A)+(B207)+(B237), (A)+(B207)+(B238), (A)+(B207)+(B239), (A)+(B207)+(B240), (A)+(B207)+(B241), (A)+(B207)+(B242), (A)+(B207)+(B243), (A)+(B207)+(B244), (A)+(B207)+(B245), (A)+(B207)+(B246), (A)+(B207)+(B247), (A)+(B207)+(B248), (A)+(B207)+(B249), (A)+(B207)+(B250), (A)+(B207)+(B251), (A)+(B207)+(B252), (A)+(B207)+(B253), (A)+(B207)+(B254), (A)+(B207)+(B255), (A)+(B207)+(B256), (A)+(B207)+(B257), (A)+(B207)+(B258), (A)+(B207)+(B259), (A)+(B207)+(B260), (A)+(B207)+(B261), (A)+(B207)+(B262), (A)+(B207)+(B263), (A)+(B207)+(B264), (A)+(B207)+(B265), (A)+(B207)+(B266), (A)+(B207)+(B267), (A)+(B207)+(B268), (A)+(B207)+(B269), (A)+(B207)+(B270), (A)+(B207)+(B271), (A)+(B207)+(B272), (A)+(B207)+(B273), (A)+(B207)+(B274), (A)+(B207)+(B275), (A)+(B207)+(B276), (A)+(B207)+(B277), (A)+(B207)+(B278), (A)+(B207)+(B279), (A)+(B207)+(B280), (A)+(B207)+(B281), (A)+(B207)+(B282), (A)+(B207)+(B283), (A)+(B207)+(B284), (A)+(B207)+(B285), (A)+(B207)+(B286), (A)+(B207)+(B287), (A)+(B207)+(B288), (A)+(B207)+(B289), (A)+(B207)+(B290), (A)+(B207)+(B291), (A)+(B207)+(B292), (A)+(B207)+(B293), (A)+(B207)+(B294), (A)+(B207)+(B295), (A)+(B207)+(B296), (A)+(B207)+(B297), (A)+(B207)+(B298), (A)+(B207)+(B299), (A)+(B207)+(B300), (A)+(B207)+(B301), (A)+(B207)+(B302), (A)+(B207)+(B303), (A)+(B207)+(B304), (A)+(B207)+(B305), (A)+(B207)+(B306), (A)+(B207)+(B307), (A)+(B207)+(B308), (A)+(B207)+(B309), (A)+(B207)+(B310), (A)+(B207)+(B311), (A)+(B207)+(B312), (A)+(B207)+(B313), (A)+(B207)+(B314), (A)+(B207)+(B315),

(A)+(B208)+(B209), (A)+(B208)+(B210), (A)+(B208)+(B211), (A)+(B208)+(B212), (A)+(B208)+(B213), (A)+(B208)+(B214), (A)+(B208)+(B215), (A)+(B208)+(B216), (A)+(B208)+(B217), (A)+(B208)+(B218), (A)+(B208)+(B219), (A)+(B208)+(B220), (A)+(B208)+(B221), (A)+(B208)+(B222), (A)+(B208)+(B223), (A)+(B208)+(B224), (A)+(B208)+(B225), (A)+(B208)+(B226), (A)+(B208)+(B227), (A)+(B208)+(B228), (A)+(B208)+(B229), (A)+(B208)+(B230), (A)+(B208)+(B231), (A)+(B208)+(B232), (A)+(B208)+(B233), (A)+(B208)+(B234), (A)+(B208)+(B235), (A)+(B208)+(B236), (A)+(B208)+(B237), (A)+(B208)+(B238), (A)+(B208)+(B239), (A)+(B208)+(B240), (A)+(B208)+(B241), (A)+(B208)+(B242), (A)+(B208)+(B243), (A)+(B208)+(B244), (A)+(B208)+(B245), (A)+(B208)+(B246), (A)+(B208)+(B247), (A)+(B208)+(B248), (A)+(B208)+(B249), (A)+(B208)+(B250), (A)+(B208)+(B251), (A)+(B208)+(B252), (A)+(B208)+(B253), (A)+(B208)+(B254), (A)+(B208)+(B255), (A)+(B208)+(B256), (A)+(B208)+(B257), (A)+(B208)+(B258), (A)+(B208)+(B259), (A)+(B208)+(B260), (A)+(B208)+(B261), (A)+(B208)+(B262), (A)+(B208)+(B263), (A)+(B208)+(B264), (A)+(B208)+(B265), (A)+(B208)+(B266), (A)+(B208)+(B267), (A)+(B208)+(B268), (A)+(B208)+(B269), (A)+(B208)+(B270), (A)+(B208)+(B271), (A)+(B208)+(B272), (A)+(B208)+(B273), (A)+(B208)+(B274), (A)+(B208)+(B275), (A)+(B208)+(B276), (A)+(B208)+(B277), (A)+(B208)+(B278), (A)+(B208)+(B279), (A)+(B208)+(B280), (A)+(B208)+(B281), (A)+(B208)+(B282), (A)+(B208)+(B283), (A)+(B208)+(B284), (A)+(B208)+(B285), (A)+(B208)+(B286), (A)+(B208)+(B287), (A)+(B208)+(B288), (A)+(B208)+(B289), (A)+(B208)+(B290), (A)+(B208)+(B291), (A)+(B208)+(B292), (A)+(B208)+(B293), (A)+(B208)+(B294), (A)+(B208)+(B295), (A)+(B208)+(B296), (A)+(B208)+(B297), (A)+(B208)+(B298), (A)+(B208)+(B299), (A)+(B208)+(B300), (A)+(B208)+(B301), (A)+(B208)+(B302), (A)+(B208)+(B303), (A)+(B208)+(B304), (A)+(B208)+(B305), (A)+(B208)+(B306), (A)+(B208)+(B307), (A)+(B208)+(B308), (A)+(B208)+(B309), (A)+(B208)+(B310), (A)+(B208)+(B311), (A)+(B208)+(B312), (A)+(B208)+(B313), (A)+(B208)+(B314), (A)+(B208)+(B315),

(A)+(B209)+(B210), (A)+(B209)+(B211), (A)+(B209)+(B212), (A)+(B209)+(B213), (A)+(B209)+(B214), (A)+(B209)+(B215), (A)+(B209)+(B216), (A)+(B209)+(B217), (A)+(B209)+(B218), (A)+(B209)+(B219), (A)+(B209)+(B220), (A)+(B209)+(B221), (A)+(B209)+(B222), (A)+(B209)+(B223), (A)+(B209)+(B224), (A)+(B209)+(B225), (A)+(B209)+(B226), (A)+(B209)+(B227), (A)+(B209)+(B228), (A)+(B209)+(B229), (A)+(B209)+(B230), (A)+(B209)+(B231), (A)+(B209)+(B232), (A)+(B209)+(B233), (A)+(B209)+(B234), (A)+(B209)+(B235), (A)+(B209)+(B236), (A)+(B209)+(B237), (A)+(B209)+(B238), (A)+(B209)+(B239), (A)+(B209)+(B240), (A)+(B209)+(B241), (A)+(B209)+(B242), (A)+(B209)+(B243), (A)+(B209)+(B244), (A)+(B209)+(B245), (A)+(B209)+(B246), (A)+(B209)+(B247), (A)+(B209)+(B248), (A)+(B209)+(B249), (A)+(B209)+(B250), (A)+(B209)+(B251), (A)+(B209)+(B252), (A)+(B209)+(B253), (A)+(B209)+(B254), (A)+(B209)+(B255), (A)+(B209)+(B256), (A)+(B209)+(B257), (A)+(B209)+(B258), (A)+(B209)+(B259), (A)+(B209)+(B260), (A)+(B209)+(B261), (A)+(B209)+(B262), (A)+(B209)+(B263), (A)+(B209)+(B264), (A)+(B209)+(B265), (A)+(B209)+(B266), (A)+(B209)+(B267), (A)+(B209)+(B268), (A)+(B209)+(B269), (A)+(B209)+(B270), (A)+(B209)+(B271), (A)+(B209)+(B272), (A)+(B209)+(B273), (A)+(B209)+(B274), (A)+(B209)+(B275), (A)+(B209)+(B276), (A)+(B209)+(B277), (A)+(B209)+(B278), (A)+(B209)+(B279), (A)+(B209)+(B280), (A)+(B209)+(B281), (A)+(B209)+(B282), (A)+(B209)+(B283), (A)+(B209)+(B284), (A)+(B209)+(B285), (A)+(B209)+(B286), (A)+(B209)+(B287), (A)+(B209)+(B288), (A)+(B209)+(B289), (A)+(B209)+(B290), (A)+(B209)+(B291), (A)+(B209)+(B292), (A)+(B209)+(B293), (A)+(B209)+(B294), (A)+(B209)+(B295), (A)+(B209)+(B296), (A)+(B209)+(B297), (A)+(B209)+(B298), (A)+(B209)+(B299), (A)+(B209)+(B300), (A)+(B209)+(B301), (A)+(B209)+(B302), (A)+(B209)+(B303), (A)+(B209)+(B304), (A)+(B209)+(B305), (A)+(B209)+(B306), (A)+(B209)+(B307), (A)+(B209)+(B308), (A)+(B209)+(B309), (A)+(B209)+(B310), (A)+(B209)+(B311), (A)+(B209)+(B312), (A)+(B209)+(B313), (A)+(B209)+(B314), (A)+(B209)+(B315),

(A)+(B210)+(B211), (A)+(B210)+(B212), (A)+(B210)+(B213), (A)+(B210)+(B214), (A)+(B210)+(B215), (A)+(B210)+(B216), (A)+(B210)+(B217), (A)+(B210)+(B218), (A)+(B210)+(B219), (A)+(B210)+(B220), (A)+(B210)+(B221), (A)+(B210)+(B222), (A)+(B210)+(B223), (A)+(B210)+(B224), (A)+(B210)+(B225), (A)+(B210)+(B226), (A)+(B210)+(B227), (A)+(B210)+(B228), (A)+(B210)+(B229), (A)+(B210)+(B230), (A)+(B210)+(B231), (A)+(B210)+(B232), (A)+(B210)+(B233), (A)+(B210)+(B234), (A)+(B210)+(B235), (A)+(B210)+(B236), (A)+(B210)+(B237), (A)+(B210)+(B238), (A)+(B210)+(B239), (A)+(B210)+(B240), (A)+(B210)+(B241), (A)+(B210)+(B242), (A)+(B210)+(B243), (A)+(B210)+(B244), (A)+(B210)+(B245), (A)+(B210)+(B246), (A)+(B210)+(B247), (A)+(B210)+(B248), (A)+(B210)+(B249), (A)+(B210)+(B250), (A)+(B210)+(B251), (A)+(B210)+(B252), (A)+(B210)+(B253), (A)+(B210)+(B254), (A)+(B210)+(B255), (A)+(B210)+(B256), (A)+(B210)+(B257), (A)+(B210)+(B258), (A)+(B210)+(B259), (A)+(B210)+(B260), (A)+(B210)+(B261), (A)+(B210)+(B262), (A)+(B210)+(B263), (A)+(B210)+(B264), (A)+(B210)+(B265), (A)+(B210)+(B266), (A)+(B210)+(B267), (A)+(B210)+(B268), (A)+(B210)+(B269), (A)+(B210)+(B270), (A)+(B210)+(B271), (A)+(B210)+(B272), (A)+(B210)+(B273), (A)+(B210)+(B274), (A)+(B210)+(B275), (A)+(B210)+(B276), (A)+(B210)+(B277), (A)+(B210)+(B278), (A)+(B210)+(B279), (A)+(B210)+(B280), (A)+(B210)+(B281), (A)+(B210)+(B282), (A)+(B210)+(B283), (A)+(B210)+(B284), (A)+(B210)+(B285), (A)+(B210)+(B286), (A)+(B210)+(B287), (A)+(B210)+(B288), (A)+(B210)+(B289), (A)+(B210)+(B290), (A)+(B210)+(B291), (A)+(B210)+(B292), (A)+(B210)+(B293), (A)+(B210)+(B294), (A)+(B210)+(B295), (A)+(B210)+(B296), (A)+(B210)+(B297), (A)+(B210)+(B298), (A)+(B210)+(B299), (A)+(B210)+(B300), (A)+(B210)+(B301), (A)+(B210)+(B302), (A)+(B210)+(B303), (A)+(B210)+(B304), (A)+(B210)+(B305), (A)+(B210)+(B306), (A)+(B210)+(B307), (A)+(B210)+(B308), (A)+(B210)+(B309), (A)+(B210)+(B310), (A)+(B210)+(B311), (A)+(B210)+(B312), (A)+(B210)+(B313), (A)+(B210)+(B314), (A)+(B210)+(B315),

(A)+(B211)+(B212), (A)+(B211)+(B213), (A)+(B211)+(B214), (A)+(B211)+(B215), (A)+(B211)+(B216), (A)+(B211)+(B217), (A)+(B211)+(B218), (A)+(B211)+(B219), (A)+(B211)+(B220), (A)+(B211)+(B221), (A)+(B211)+(B222), (A)+(B211)+(B223), (A)+(B211)+(B224), (A)+(B211)+(B225), (A)+(B211)+(B226), (A)+(B211)+(B227), (A)+(B211)+(B228), (A)+(B211)+(B229), (A)+(B211)+(B230), (A)+(B211)+(B231), (A)+(B211)+(B232), (A)+(B211)+(B233), (A)+(B211)+(B234), (A)+(B211)+(B235), (A)+(B211)+(B236), (A)+(B211)+(B237), (A)+(B211)+(B238), (A)+(B211)+(B239), (A)+(B211)+(B240), (A)+(B211)+(B241), (A)+(B211)+(B242), (A)+(B211)+(B243), (A)+(B211)+(B244), (A)+(B211)+(B245), (A)+(B211)+(B246), (A)+(B211)+(B247), (A)+(B211)+(B248), (A)+(B211)+(B249), (A)+(B211)+(B250), (A)+(B211)+(B251), (A)+(B211)+(B252), (A)+(B211)+(B253), (A)+(B211)+(B254), (A)+(B211)+(B255), (A)+(B211)+(B256), (A)+(B211)+(B257), (A)+(B211)+(B258), (A)+(B211)+(B259), (A)+(B211)+(B260), (A)+(B211)+(B261), (A)+(B211)+(B262), (A)+(B211)+(B263), (A)+(B211)+(B264), (A)+(B211)+(B265), (A)+(B211)+(B266), (A)+(B211)+(B267), (A)+(B211)+(B268), (A)+(B211)+(B269), (A)+(B211)+(B270), (A)+(B211)+(B271), (A)+(B211)+(B272), (A)+(B211)+(B273), (A)+(B211)+(B274), (A)+(B211)+(B275), (A)+(B211)+(B276), (A)+(B211)+(B277), (A)+(B211)+(B278), (A)+(B211)+(B279), (A)+(B211)+(B280), (A)+(B211)+(B281), (A)+(B211)+(B282), (A)+(B211)+(B283), (A)+(B211)+(B284), (A)+(B211)+(B285), (A)+(B211)+(B286), (A)+(B211)+(B287), (A)+(B211)+(B288), (A)+(B211)+(B289), (A)+(B211)+(B290), (A)+(B211)+(B291), (A)+(B211)+(B292), (A)+(B211)+(B293), (A)+(B211)+(B294), (A)+(B211)+(B295), (A)+(B211)+(B296), (A)+(B211)+(B297), (A)+(B211)+(B298), (A)+(B211)+(B299), (A)+(B211)+(B300), (A)+(B211)+(B301), (A)+(B211)+(B302), (A)+(B211)+(B303), (A)+(B211)+(B304), (A)+(B211)+(B305), (A)+(B211)+(B306), (A)+(B211)+(B307), (A)+(B211)+(B308), (A)+(B211)+(B309), (A)+(B211)+(B310), (A)+(B211)+(B311), (A)+(B211)+(B312), (A)+(B211)+(B313), (A)+(B211)+(B314), (A)+(B211)+(B315),

(A)+(B212)+(B213), (A)+(B212)+(B214), (A)+(B212)+(B215), (A)+(B212)+(B216), (A)+(B212)+(B217), (A)+(B212)+(B218), (A)+(B212)+(B219), (A)+(B212)+(B220), (A)+(B212)+(B221), (A)+(B212)+(B222), (A)+(B212)+(B223), (A)+(B212)+(B224), (A)+(B212)+(B225), (A)+(B212)+(B226), (A)+(B212)+(B227), (A)+(B212)+(B228), (A)+(B212)+(B229), (A)+(B212)+(B230), (A)+(B212)+(B231), (A)+(B212)+(B232), (A)+(B212)+(B233), (A)+(B212)+(B234), (A)+(B212)+(B235), (A)+(B212)+(B236), (A)+(B212)+(B237), (A)+(B212)+(B238), (A)+(B212)+(B239), (A)+(B212)+(B240), (A)+(B212)+(B241), (A)+(B212)+(B242), (A)+(B212)+(B243), (A)+(B212)+(B244), (A)+(B212)+(B245), (A)+(B212)+(B246), (A)+(B212)+(B247), (A)+(B212)+(B248), (A)+(B212)+(B249), (A)+(B212)+(B250), (A)+(B212)+(B251), (A)+(B212)+(B252), (A)+(B212)+(B253), (A)+(B212)+(B254), (A)+(B212)+(B255), (A)+(B212)+(B256), (A)+(B212)+(B257), (A)+(B212)+(B258), (A)+(B212)+(B259), (A)+(B212)+(B260), (A)+(B212)+(B261), (A)+(B212)+(B262), (A)+(B212)+(B263), (A)+(B212)+(B264), (A)+(B212)+(B265), (A)+(B212)+(B266), (A)+(B212)+(B267), (A)+(B212)+(B268), (A)+(B212)+(B269), (A)+(B212)+(B270), (A)+(B212)+(B271), (A)+(B212)+(B272), (A)+(B212)+(B273), (A)+(B212)+(B274), (A)+(B212)+(B275), (A)+(B212)+(B276), (A)+(B212)+(B277), (A)+(B212)+(B278), (A)+(B212)+(B279), (A)+(B212)+(B280), (A)+(B212)+(B281), (A)+(B212)+(B282), (A)+(B212)+(B283), (A)+(B212)+(B284), (A)+(B212)+(B285), (A)+(B212)+(B286), (A)+(B212)+(B287), (A)+(B212)+(B288), (A)+(B212)+(B289), (A)+(B212)+(B290), (A)+(B212)+(B291), (A)+(B212)+(B292), (A)+(B212)+(B293), (A)+(B212)+(B294), (A)+(B212)+(B295), (A)+(B212)+(B296), (A)+(B212)+(B297), (A)+(B212)+(B298), (A)+(B212)+(B299), (A)+(B212)+(B300), (A)+(B212)+(B301), (A)+(B212)+(B302), (A)+(B212)+(B303), (A)+(B212)+(B304), (A)+(B212)+(B305), (A)+(B212)+(B306), (A)+(B212)+(B307), (A)+(B212)+(B308), (A)+(B212)+(B309), (A)+(B212)+(B310), (A)+(B212)+(B311), (A)+(B212)+(B312), (A)+(B212)+(B313), (A)+(B212)+(B314), (A)+(B212)+(B315),

(A)+(B213)+(B214), (A)+(B213)+(B215), (A)+(B213)+(B216), (A)+(B213)+(B217), (A)+(B213)+(B218), (A)+(B213)+(B219), (A)+(B213)+(B220), (A)+(B213)+(B221), (A)+(B213)+(B222), (A)+(B213)+(B223), (A)+(B213)+(B224), (A)+(B213)+(B225), (A)+(B213)+(B226), (A)+(B213)+(B227), (A)+(B213)+(B228), (A)+(B213)+(B229), (A)+(B213)+(B230), (A)+(B213)+(B231), (A)+(B213)+(B232), (A)+(B213)+(B233), (A)+(B213)+(B234), (A)+(B213)+(B235), (A)+(B213)+(B236), (A)+(B213)+(B237), (A)+(B213)+(B238), (A)+(B213)+(B239), (A)+(B213)+(B240), (A)+(B213)+(B241), (A)+(B213)+(B242), (A)+(B213)+(B243), (A)+(B213)+(B244), (A)+(B213)+(B245), (A)+(B213)+(B246), (A)+(B213)+(B247), (A)+(B213)+(B248), (A)+(B213)+(B249), (A)+(B213)+(B250), (A)+(B213)+(B251), (A)+(B213)+(B252), (A)+(B213)+(B253), (A)+(B213)+(B254), (A)+(B213)+(B255), (A)+(B213)+(B256), (A)+(B213)+(B257), (A)+(B213)+(B258), (A)+(B213)+(B259), (A)+(B213)+(B260), (A)+(B213)+(B261), (A)+(B213)+(B262), (A)+(B213)+(B263), (A)+(B213)+(B264), (A)+(B213)+(B265), (A)+(B213)+(B266), (A)+(B213)+(B267), (A)+(B213)+(B268), (A)+(B213)+(B269), (A)+(B213)+(B270), (A)+(B213)+(B271), (A)+(B213)+(B272), (A)+(B213)+(B273), (A)+(B213)+(B274), (A)+(B213)+(B275), (A)+(B213)+(B276), (A)+(B213)+(B277), (A)+(B213)+(B278), (A)+(B213)+(B279), (A)+(B213)+(B280), (A)+(B213)+(B281), (A)+(B213)+(B282), (A)+(B213)+(B283), (A)+(B213)+(B284), (A)+(B213)+(B285), (A)+(B213)+(B286), (A)+(B213)+(B287), (A)+(B213)+(B288), (A)+(B213)+(B289), (A)+(B213)+(B290), (A)+(B213)+(B291), (A)+(B213)+(B292), (A)+(B213)+(B293), (A)+(B213)+(B294), (A)+(B213)+(B295), (A)+(B213)+(B296), (A)+(B213)+(B297), (A)+(B213)+(B298), (A)+(B213)+(B299), (A)+(B213)+(B300), (A)+(B213)+(B301), (A)+(B213)+(B302), (A)+(B213)+(B303), (A)+(B213)+(B304), (A)+(B213)+(B305), (A)+(B213)+(B306), (A)+(B213)+(B307), (A)+(B213)+(B308), (A)+(B213)+(B309), (A)+(B213)+(B310), (A)+(B213)+(B311), (A)+(B213)+(B312), (A)+(B213)+(B313), (A)+(B213)+(B314), (A)+(B213)+(B315),

(A)+(B214)+(B215), (A)+(B214)+(B216), (A)+(B214)+(B217), (A)+(B214)+(B218), (A)+(B214)+(B219), (A)+(B214)+(B220), (A)+(B214)+(B221), (A)+(B214)+(B222), (A)+(B214)+(B223), (A)+(B214)+(B224), (A)+(B214)+(B225), (A)+(B214)+(B226), (A)+(B214)+(B227), (A)+(B214)+(B228), (A)+(B214)+(B229), (A)+(B214)+(B230), (A)+(B214)+(B231), (A)+(B214)+(B232), (A)+(B214)+(B233), (A)+(B214)+(B234), (A)+(B214)+(B235), (A)+(B214)+(B236), (A)+(B214)+(B237), (A)+(B214)+(B238), (A)+(B214)+(B239), (A)+(B214)+(B240), (A)+(B214)+(B241), (A)+(B214)+(B242), (A)+(B214)+(B243), (A)+(B214)+(B244), (A)+(B214)+(B245), (A)+(B214)+(B246), (A)+(B214)+(B247), (A)+(B214)+(B248), (A)+(B214)+(B249), (A)+(B214)+(B250), (A)+(B214)+(B251), (A)+(B214)+(B252), (A)+(B214)+(B253), (A)+(B214)+(B254), (A)+(B214)+(B255), (A)+(B214)+(B256), (A)+(B214)+(B257), (A)+(B214)+(B258), (A)+(B214)+(B259), (A)+(B214)+(B260), (A)+(B214)+(B261), (A)+(B214)+(B262), (A)+(B214)+(B263), (A)+(B214)+(B264), (A)+(B214)+(B265), (A)+(B214)+(B266), (A)+(B214)+(B267), (A)+(B214)+(B268), (A)+(B214)+(B269), (A)+(B214)+(B270), (A)+(B214)+(B271), (A)+(B214)+(B272), (A)+(B214)+(B273), (A)+(B214)+(B274), (A)+(B214)+(B275), (A)+(B214)+(B276), (A)+(B214)+(B277), (A)+(B214)+(B278), (A)+(B214)+(B279), (A)+(B214)+(B280), (A)+(B214)+(B281), (A)+(B214)+(B282), (A)+(B214)+(B283), (A)+(B214)+(B284), (A)+(B214)+(B285), (A)+(B214)+(B286), (A)+(B214)+(B287), (A)+(B214)+(B288), (A)+(B214)+(B289), (A)+(B214)+(B290), (A)+(B214)+(B291), (A)+(B214)+(B292), (A)+(B214)+(B293), (A)+(B214)+(B294), (A)+(B214)+(B295), (A)+(B214)+(B296), (A)+(B214)+(B297), (A)+(B214)+(B298), (A)+(B214)+(B299), (A)+(B214)+(B300), (A)+(B214)+(B301), (A)+(B214)+(B302), (A)+(B214)+(B303), (A)+(B214)+(B304), (A)+(B214)+(B305), (A)+(B214)+(B306), (A)+(B214)+(B307), (A)+(B214)+(B308), (A)+(B214)+(B309), (A)+(B214)+(B310), (A)+(B214)+(B311), (A)+(B214)+(B312), (A)+(B214)+(B313), (A)+(B214)+(B314), (A)+(B214)+(B315),

(A)+(B215)+(B216), (A)+(B215)+(B217), (A)+(B215)+(B218), (A)+(B215)+(B219), (A)+(B215)+(B220), (A)+(B215)+(B221), (A)+(B215)+(B222), (A)+(B215)+(B223), (A)+(B215)+(B224), (A)+(B215)+(B225), (A)+(B215)+(B226), (A)+(B215)+(B227), (A)+(B215)+(B228), (A)+(B215)+(B229), (A)+(B215)+(B230), (A)+(B215)+(B231), (A)+(B215)+(B232), (A)+(B215)+(B233), (A)+(B215)+(B234), (A)+(B215)+(B235), (A)+(B215)+(B236), (A)+(B215)+(B237), (A)+(B215)+(B238), (A)+(B215)+(B239), (A)+(B215)+(B240), (A)+(B215)+(B241), (A)+(B215)+(B242), (A)+(B215)+(B243), (A)+(B215)+(B244), (A)+(B215)+(B245), (A)+(B215)+(B246), (A)+(B215)+(B247), (A)+(B215)+(B248), (A)+(B215)+(B249), (A)+(B215)+(B250), (A)+(B215)+(B251), (A)+(B215)+(B252), (A)+(B215)+(B253), (A)+(B215)+(B254), (A)+(B215)+(B255), (A)+(B215)+(B256), (A)+(B215)+(B257), (A)+(B215)+(B258), (A)+(B215)+(B259), (A)+(B215)+(B260), (A)+(B215)+(B261), (A)+(B215)+(B262), (A)+(B215)+(B263), (A)+(B215)+(B264), (A)+(B215)+(B265), (A)+(B215)+(B266), (A)+(B215)+(B267), (A)+(B215)+(B268), (A)+(B215)+(B269), (A)+(B215)+(B270), (A)+(B215)+(B271), (A)+(B215)+(B272), (A)+(B215)+(B273), (A)+(B215)+(B274), (A)+(B215)+(B275), (A)+(B215)+(B276), (A)+(B215)+(B277), (A)+(B215)+(B278), (A)+(B215)+(B279), (A)+(B215)+(B280), (A)+(B215)+(B281), (A)+(B215)+(B282), (A)+(B215)+(B283), (A)+(B215)+(B284), (A)+(B215)+(B285), (A)+(B215)+(B286), (A)+(B215)+(B287), (A)+(B215)+(B288), (A)+(B215)+(B289), (A)+(B215)+(B290), (A)+(B215)+(B291), (A)+(B215)+(B292), (A)+(B215)+(B293), (A)+(B215)+(B294), (A)+(B215)+(B295), (A)+(B215)+(B296), (A)+(B215)+(B297), (A)+(B215)+(B298), (A)+(B215)+(B299), (A)+(B215)+(B300), (A)+(B215)+(B301), (A)+(B215)+(B302), (A)+(B215)+(B303), (A)+(B215)+(B304), (A)+(B215)+(B305), (A)+(B215)+(B306), (A)+(B215)+(B307), (A)+(B215)+(B308), (A)+(B215)+(B309), (A)+(B215)+(B310), (A)+(B215)+(B311), (A)+(B215)+(B312), (A)+(B215)+(B313), (A)+(B215)+(B314), (A)+(B215)+(B315),

(A)+(B216)+(B217), (A)+(B216)+(B218), (A)+(B216)+(B219), (A)+(B216)+(B220), (A)+(B216)+(B221), (A)+(B216)+(B222), (A)+(B216)+(B223), (A)+(B216)+(B224), (A)+(B216)+(B225), (A)+(B216)+(B226), (A)+(B216)+(B227), (A)+(B216)+(B228), (A)+(B216)+(B229), (A)+(B216)+(B230), (A)+(B216)+(B231), (A)+(B216)+(B232), (A)+(B216)+(B233), (A)+(B216)+(B234), (A)+(B216)+(B235), (A)+(B216)+(B236), (A)+(B216)+(B237), (A)+(B216)+(B238), (A)+(B216)+(B239), (A)+(B216)+(B240), (A)+(B216)+(B241), (A)+(B216)+(B242), (A)+(B216)+(B243), (A)+(B216)+(B244), (A)+(B216)+(B245), (A)+(B216)+(B246), (A)+(B216)+(B247), (A)+(B216)+(B248), (A)+(B216)+(B249), (A)+(B216)+(B250), (A)+(B216)+(B251), (A)+(B216)+(B252), (A)+(B216)+(B253), (A)+(B216)+(B254), (A)+(B216)+(B255), (A)+(B216)+(B256), (A)+(B216)+(B257), (A)+(B216)+(B258), (A)+(B216)+(B259), (A)+(B216)+(B260), (A)+(B216)+(B261), (A)+(B216)+(B262), (A)+(B216)+(B263), (A)+(B216)+(B264), (A)+(B216)+(B265), (A)+(B216)+(B266), (A)+(B216)+(B267), (A)+(B216)+(B268), (A)+(B216)+(B269), (A)+(B216)+(B270), (A)+(B216)+(B271), (A)+(B216)+(B272), (A)+(B216)+(B273), (A)+(B216)+(B274), (A)+(B216)+(B275), (A)+(B216)+(B276), (A)+(B216)+(B277), (A)+(B216)+(B278), (A)+(B216)+(B279), (A)+(B216)+(B280), (A)+(B216)+(B281), (A)+(B216)+(B282), (A)+(B216)+(B283), (A)+(B216)+(B284), (A)+(B216)+(B285), (A)+(B216)+(B286), (A)+(B216)+(B287), (A)+(B216)+(B288), (A)+(B216)+(B289), (A)+(B216)+(B290), (A)+(B216)+(B291), (A)+(B216)+(B292), (A)+(B216)+(B293), (A)+(B216)+(B294), (A)+(B216)+(B295), (A)+(B216)+(B296), (A)+(B216)+(B297), (A)+(B216)+(B298), (A)+(B216)+(B299), (A)+(B216)+(B300), (A)+(B216)+(B301), (A)+(B216)+(B302), (A)+(B216)+(B303), (A)+(B216)+(B304), (A)+(B216)+(B305), (A)+(B216)+(B306), (A)+(B216)+(B307), (A)+(B216)+(B308), (A)+(B216)+(B309), (A)+(B216)+(B310), (A)+(B216)+(B311), (A)+(B216)+(B312), (A)+(B216)+(B313), (A)+(B216)+(B314), (A)+(B216)+(B315),

(A)+(B217)+(B218), (A)+(B217)+(B219), (A)+(B217)+(B220), (A)+(B217)+(B221), (A)+(B217)+(B222), (A)+(B217)+(B223), (A)+(B217)+(B224), (A)+(B217)+(B225), (A)+(B217)+(B226), (A)+(B217)+(B227), (A)+(B217)+(B228), (A)+(B217)+(B229), (A)+(B217)+(B230), (A)+(B217)+(B231), (A)+(B217)+(B232), (A)+(B217)+(B233), (A)+(B217)+(B234), (A)+(B217)+(B235), (A)+(B217)+(B236), (A)+(B217)+(B237), (A)+(B217)+(B238), (A)+(B217)+(B239), (A)+(B217)+(B240), (A)+(B217)+(B241), (A)+(B217)+(B242), (A)+(B217)+(B243), (A)+(B217)+(B244), (A)+(B217)+(B245), (A)+(B217)+(B246), (A)+(B217)+(B247), (A)+(B217)+(B248), (A)+(B217)+(B249), (A)+(B217)+(B250), (A)+(B217)+(B251), (A)+(B217)+(B252), (A)+(B217)+(B253), (A)+(B217)+(B254), (A)+(B217)+(B255), (A)+(B217)+(B256), (A)+(B217)+(B257), (A)+(B217)+(B258), (A)+(B217)+(B259), (A)+(B217)+(B260), (A)+(B217)+(B261), (A)+(B217)+(B262), (A)+(B217)+(B263), (A)+(B217)+(B264), (A)+(B217)+(B265), (A)+(B217)+(B266), (A)+(B217)+(B267), (A)+(B217)+(B268), (A)+(B217)+(B269), (A)+(B217)+(B270), (A)+(B217)+(B271), (A)+(B217)+(B272), (A)+(B217)+(B273), (A)+(B217)+(B274), (A)+(B217)+(B275), (A)+(B217)+(B276), (A)+(B217)+(B277), (A)+(B217)+(B278), (A)+(B217)+(B279), (A)+(B217)+(B280), (A)+(B217)+(B281), (A)+(B217)+(B282), (A)+(B217)+(B283), (A)+(B217)+(B284), (A)+(B217)+(B285), (A)+(B217)+(B286), (A)+(B217)+(B287), (A)+(B217)+(B288), (A)+(B217)+(B289), (A)+(B217)+(B290), (A)+(B217)+(B291), (A)+(B217)+(B292), (A)+(B217)+(B293), (A)+(B217)+(B294), (A)+(B217)+(B295), (A)+(B217)+(B296), (A)+(B217)+(B297), (A)+(B217)+(B298), (A)+(B217)+(B299), (A)+(B217)+(B300), (A)+(B217)+(B301), (A)+(B217)+(B302), (A)+(B217)+(B303), (A)+(B217)+(B304), (A)+(B217)+(B305), (A)+(B217)+(B306), (A)+(B217)+(B307), (A)+(B217)+(B308), (A)+(B217)+(B309), (A)+(B217)+(B310), (A)+(B217)+(B311), (A)+(B217)+(B312), (A)+(B217)+(B313), (A)+(B217)+(B314), (A)+(B217)+(B315),

(A)+(B218)+(B219), (A)+(B218)+(B220), (A)+(B218)+(B221), (A)+(B218)+(B222), (A)+(B218)+(B223), (A)+(B218)+(B224), (A)+(B218)+(B225), (A)+(B218)+(B226), (A)+(B218)+(B227), (A)+(B218)+(B228), (A)+(B218)+(B229), (A)+(B218)+(B230), (A)+(B218)+(B231), (A)+(B218)+(B232), (A)+(B218)+(B233), (A)+(B218)+(B234), (A)+(B218)+(B235), (A)+(B218)+(B236), (A)+(B218)+(B237), (A)+(B218)+(B238), (A)+(B218)+(B239), (A)+(B218)+(B240), (A)+(B218)+(B241), (A)+(B218)+(B242), (A)+(B218)+(B243), (A)+(B218)+(B244), (A)+(B218)+(B245), (A)+(B218)+(B246), (A)+(B218)+(B247), (A)+(B218)+(B248), (A)+(B218)+(B249), (A)+(B218)+(B250), (A)+(B218)+(B251), (A)+(B218)+(B252), (A)+(B218)+(B253), (A)+(B218)+(B254), (A)+(B218)+(B255), (A)+(B218)+(B256), (A)+(B218)+(B257), (A)+(B218)+(B258), (A)+(B218)+(B259), (A)+(B218)+(B260), (A)+(B218)+(B261), (A)+(B218)+(B262), (A)+(B218)+(B263), (A)+(B218)+(B264), (A)+(B218)+(B265), (A)+(B218)+(B266), (A)+(B218)+(B267), (A)+(B218)+(B268), (A)+(B218)+(B269), (A)+(B218)+(B270), (A)+(B218)+(B271), (A)+(B218)+(B272), (A)+(B218)+(B273), (A)+(B218)+(B274), (A)+(B218)+(B275), (A)+(B218)+(B276), (A)+(B218)+(B277), (A)+(B218)+(B278), (A)+(B218)+(B279), (A)+(B218)+(B280), (A)+(B218)+(B281), (A)+(B218)+(B282), (A)+(B218)+(B283), (A)+(B218)+(B284), (A)+(B218)+(B285), (A)+(B218)+(B286), (A)+(B218)+(B287), (A)+(B218)+(B288), (A)+(B218)+(B289), (A)+(B218)+(B290), (A)+(B218)+(B291), (A)+(B218)+(B292), (A)+(B218)+(B293), (A)+(B218)+(B294), (A)+(B218)+(B295), (A)+(B218)+(B296), (A)+(B218)+(B297), (A)+(B218)+(B298), (A)+(B218)+(B299), (A)+(B218)+(B300), (A)+(B218)+(B301), (A)+(B218)+(B302), (A)+(B218)+(B303), (A)+(B218)+(B304), (A)+(B218)+(B305), (A)+(B218)+(B306), (A)+(B218)+(B307), (A)+(B218)+(B308), (A)+(B218)+(B309), (A)+(B218)+(B310), (A)+(B218)+(B311), (A)+(B218)+(B312), (A)+(B218)+(B313), (A)+(B218)+(B314), (A)+(B218)+(B315),

(A)+(B219)+(B220), (A)+(B219)+(B221), (A)+(B219)+(B222), (A)+(B219)+(B223), (A)+(B219)+(B224), (A)+(B219)+(B225), (A)+(B219)+(B226), (A)+(B219)+(B227), (A)+(B219)+(B228), (A)+(B219)+(B229), (A)+(B219)+(B230), (A)+(B219)+(B231), (A)+(B219)+(B232), (A)+(B219)+(B233), (A)+(B219)+(B234), (A)+(B219)+(B235), (A)+(B219)+(B236), (A)+(B219)+(B237), (A)+(B219)+(B238), (A)+(B219)+(B239), (A)+(B219)+(B240), (A)+(B219)+(B241), (A)+(B219)+(B242), (A)+(B219)+(B243), (A)+(B219)+(B244), (A)+(B219)+(B245), (A)+(B219)+(B246), (A)+(B219)+(B247), (A)+(B219)+(B248), (A)+(B219)+(B249), (A)+(B219)+(B250), (A)+(B219)+(B251), (A)+(B219)+(B252), (A)+(B219)+(B253), (A)+(B219)+(B254), (A)+(B219)+(B255), (A)+(B219)+(B256), (A)+(B219)+(B257), (A)+(B219)+(B258), (A)+(B219)+(B259), (A)+(B219)+(B260), (A)+(B219)+(B261), (A)+(B219)+(B262), (A)+(B219)+(B263), (A)+(B219)+(B264), (A)+(B219)+(B265), (A)+(B219)+(B266), (A)+(B219)+(B267), (A)+(B219)+(B268), (A)+(B219)+(B269), (A)+(B219)+(B270), (A)+(B219)+(B271), (A)+(B219)+(B272), (A)+(B219)+(B273), (A)+(B219)+(B274), (A)+(B219)+(B275), (A)+(B219)+(B276), (A)+(B219)+(B277), (A)+(B219)+(B278), (A)+(B219)+(B279), (A)+(B219)+(B280), (A)+(B219)+(B281), (A)+(B219)+(B282), (A)+(B219)+(B283), (A)+(B219)+(B284), (A)+(B219)+(B285), (A)+(B219)+(B286), (A)+(B219)+(B287), (A)+(B219)+(B288), (A)+(B219)+(B289), (A)+(B219)+(B290), (A)+(B219)+(B291), (A)+(B219)+(B292), (A)+(B219)+(B293), (A)+(B219)+(B294), (A)+(B219)+(B295), (A)+(B219)+(B296), (A)+(B219)+(B297), (A)+(B219)+(B298), (A)+(B219)+(B299), (A)+(B219)+(B300), (A)+(B219)+(B301), (A)+(B219)+(B302), (A)+(B219)+(B303), (A)+(B219)+(B304), (A)+(B219)+(B305), (A)+(B219)+(B306), (A)+(B219)+(B307), (A)+(B219)+(B308), (A)+(B219)+(B309), (A)+(B219)+(B310), (A)+(B219)+(B311), (A)+(B219)+(B312), (A)+(B219)+(B313), (A)+(B219)+(B314), (A)+(B219)+(B315),

(A)+(B220)+(B221), (A)+(B220)+(B222), (A)+(B220)+(B223), (A)+(B220)+(B224), (A)+(B220)+(B225), (A)+(B220)+(B226), (A)+(B220)+(B227), (A)+(B220)+(B228), (A)+(B220)+(B229), (A)+(B220)+(B230), (A)+(B220)+(B231), (A)+(B220)+(B232), (A)+(B220)+(B233), (A)+(B220)+(B234), (A)+(B220)+(B235), (A)+(B220)+(B236), (A)+(B220)+(B237), (A)+(B220)+(B238), (A)+(B220)+(B239), (A)+(B220)+(B240), (A)+(B220)+(B241), (A)+(B220)+(B242), (A)+(B220)+(B243), (A)+(B220)+(B244), (A)+(B220)+(B245), (A)+(B220)+(B246), (A)+(B220)+(B247), (A)+(B220)+(B248), (A)+(B220)+(B249), (A)+(B220)+(B250), (A)+(B220)+(B251), (A)+(B220)+(B252), (A)+(B220)+(B253), (A)+(B220)+(B254), (A)+(B220)+(B255), (A)+(B220)+(B256), (A)+(B220)+(B257), (A)+(B220)+(B258), (A)+(B220)+(B259), (A)+(B220)+(B260), (A)+(B220)+(B261), (A)+(B220)+(B262), (A)+(B220)+(B263), (A)+(B220)+(B264), (A)+(B220)+(B265), (A)+(B220)+(B266), (A)+(B220)+(B267), (A)+(B220)+(B268), (A)+(B220)+(B269), (A)+(B220)+(B270), (A)+(B220)+(B271), (A)+(B220)+(B272), (A)+(B220)+(B273), (A)+(B220)+(B274), (A)+(B220)+(B275), (A)+(B220)+(B276), (A)+(B220)+(B277), (A)+(B220)+(B278), (A)+(B220)+(B279), (A)+(B220)+(B280), (A)+(B220)+(B281), (A)+(B220)+(B282), (A)+(B220)+(B283), (A)+(B220)+(B284), (A)+(B220)+(B285), (A)+(B220)+(B286), (A)+(B220)+(B287), (A)+(B220)+(B288), (A)+(B220)+(B289), (A)+(B220)+(B290), (A)+(B220)+(B291), (A)+(B220)+(B292), (A)+(B220)+(B293), (A)+(B220)+(B294), (A)+(B220)+(B295), (A)+(B220)+(B296), (A)+(B220)+(B297), (A)+(B220)+(B298), (A)+(B220)+(B299), (A)+(B220)+(B300), (A)+(B220)+(B301), (A)+(B220)+(B302), (A)+(B220)+(B303), (A)+(B220)+(B304), (A)+(B220)+(B305), (A)+(B220)+(B306), (A)+(B220)+(B307), (A)+(B220)+(B308), (A)+(B220)+(B309), (A)+(B220)+(B310), (A)+(B220)+(B311), (A)+(B220)+(B312), (A)+(B220)+(B313), (A)+(B220)+(B314), (A)+(B220)+(B315),

(A)+(B221)+(B222), (A)+(B221)+(B223), (A)+(B221)+(B224), (A)+(B221)+(B225), (A)+(B221)+(B226), (A)+(B221)+(B227), (A)+(B221)+(B228), (A)+(B221)+(B229), (A)+(B221)+(B230), (A)+(B221)+(B231), (A)+(B221)+(B232), (A)+(B221)+(B233), (A)+(B221)+(B234), (A)+(B221)+(B235), (A)+(B221)+(B236), (A)+(B221)+(B237), (A)+(B221)+(B238), (A)+(B221)+(B239), (A)+(B221)+(B240), (A)+(B221)+(B241), (A)+(B221)+(B242), (A)+(B221)+(B243), (A)+(B221)+(B244), (A)+(B221)+(B245), (A)+(B221)+(B246), (A)+(B221)+(B247), (A)+(B221)+(B248), (A)+(B221)+(B249), (A)+(B221)+(B250), (A)+(B221)+(B251), (A)+(B221)+(B252), (A)+(B221)+(B253), (A)+(B221)+(B254), (A)+(B221)+(B255), (A)+(B221)+(B256), (A)+(B221)+(B257), (A)+(B221)+(B258), (A)+(B221)+(B259), (A)+(B221)+(B260), (A)+(B221)+(B261), (A)+(B221)+(B262), (A)+(B221)+(B263), (A)+(B221)+(B264), (A)+(B221)+(B265), (A)+(B221)+(B266), (A)+(B221)+(B267), (A)+(B221)+(B268), (A)+(B221)+(B269), (A)+(B221)+(B270), (A)+(B221)+(B271), (A)+(B221)+(B272), (A)+(B221)+(B273), (A)+(B221)+(B274), (A)+(B221)+(B275), (A)+(B221)+(B276), (A)+(B221)+(B277), (A)+(B221)+(B278), (A)+(B221)+(B279), (A)+(B221)+(B280), (A)+(B221)+(B281), (A)+(B221)+(B282), (A)+(B221)+(B283), (A)+(B221)+(B284), (A)+(B221)+(B285), (A)+(B221)+(B286), (A)+(B221)+(B287), (A)+(B221)+(B288), (A)+(B221)+(B289), (A)+(B221)+(B290), (A)+(B221)+(B291), (A)+(B221)+(B292), (A)+(B221)+(B293), (A)+(B221)+(B294), (A)+(B221)+(B295), (A)+(B221)+(B296), (A)+(B221)+(B297), (A)+(B221)+(B298), (A)+(B221)+(B299), (A)+(B221)+(B300), (A)+(B221)+(B301), (A)+(B221)+(B302), (A)+(B221)+(B303), (A)+(B221)+(B304), (A)+(B221)+(B305), (A)+(B221)+(B306), (A)+(B221)+(B307), (A)+(B221)+(B308), (A)+(B221)+(B309), (A)+(B221)+(B310), (A)+(B221)+(B311), (A)+(B221)+(B312), (A)+(B221)+(B313), (A)+(B221)+(B314), (A)+(B221)+(B315),

(A)+(B222)+(B223), (A)+(B222)+(B224), (A)+(B222)+(B225), (A)+(B222)+(B226), (A)+(B222)+(B227), (A)+(B222)+(B228), (A)+(B222)+(B229), (A)+(B222)+(B230), (A)+(B222)+(B231), (A)+(B222)+(B232), (A)+(B222)+(B233), (A)+(B222)+(B234), (A)+(B222)+(B235), (A)+(B222)+(B236), (A)+(B222)+(B237), (A)+(B222)+(B238), (A)+(B222)+(B239), (A)+(B222)+(B240), (A)+(B222)+(B241), (A)+(B222)+(B242), (A)+(B222)+(B243), (A)+(B222)+(B244), (A)+(B222)+(B245), (A)+(B222)+(B246), (A)+(B222)+(B247), (A)+(B222)+(B248), (A)+(B222)+(B249), (A)+(B222)+(B250), (A)+(B222)+(B251), (A)+(B222)+(B252), (A)+(B222)+(B253), (A)+(B222)+(B254), (A)+(B222)+(B255), (A)+(B222)+(B256), (A)+(B222)+(B257), (A)+(B222)+(B258), (A)+(B222)+(B259), (A)+(B222)+(B260), (A)+(B222)+(B261), (A)+(B222)+(B262), (A)+(B222)+(B263), (A)+(B222)+(B264), (A)+(B222)+(B265), (A)+(B222)+(B266), (A)+(B222)+(B267), (A)+(B222)+(B268), (A)+(B222)+(B269), (A)+(B222)+(B270), (A)+(B222)+(B271), (A)+(B222)+(B272), (A)+(B222)+(B273), (A)+(B222)+(B274), (A)+(B222)+(B275), (A)+(B222)+(B276), (A)+(B222)+(B277), (A)+(B222)+(B278), (A)+(B222)+(B279), (A)+(B222)+(B280), (A)+(B222)+(B281), (A)+(B222)+(B282), (A)+(B222)+(B283), (A)+(B222)+(B284), (A)+(B222)+(B285), (A)+(B222)+(B286), (A)+(B222)+(B287), (A)+(B222)+(B288), (A)+(B222)+(B289), (A)+(B222)+(B290), (A)+(B222)+(B291), (A)+(B222)+(B292), (A)+(B222)+(B293), (A)+(B222)+(B294), (A)+(B222)+(B295), (A)+(B222)+(B296), (A)+(B222)+(B297), (A)+(B222)+(B298), (A)+(B222)+(B299), (A)+(B222)+(B300), (A)+(B222)+(B301), (A)+(B222)+(B302), (A)+(B222)+(B303), (A)+(B222)+(B304), (A)+(B222)+(B305), (A)+(B222)+(B306), (A)+(B222)+(B307), (A)+(B222)+(B308), (A)+(B222)+(B309), (A)+(B222)+(B310), (A)+(B222)+(B311), (A)+(B222)+(B312), (A)+(B222)+(B313), (A)+(B222)+(B314), (A)+(B222)+(B315),

(A)+(B223)+(B224), (A)+(B223)+(B225), (A)+(B223)+(B226), (A)+(B223)+(B227), (A)+(B223)+(B228), (A)+(B223)+(B229), (A)+(B223)+(B230), (A)+(B223)+(B231), (A)+(B223)+(B232), (A)+(B223)+(B233), (A)+(B223)+(B234), (A)+(B223)+(B235), (A)+(B223)+(B236), (A)+(B223)+(B237), (A)+(B223)+(B238), (A)+(B223)+(B239), (A)+(B223)+(B240), (A)+(B223)+(B241), (A)+(B223)+(B242), (A)+(B223)+(B243), (A)+(B223)+(B244), (A)+(B223)+(B245), (A)+(B223)+(B246), (A)+(B223)+(B247), (A)+(B223)+(B248), (A)+(B223)+(B249), (A)+(B223)+(B250), (A)+(B223)+(B251), (A)+(B223)+(B252), (A)+(B223)+(B253), (A)+(B223)+(B254), (A)+(B223)+(B255), (A)+(B223)+(B256), (A)+(B223)+(B257), (A)+(B223)+(B258), (A)+(B223)+(B259), (A)+(B223)+(B260), (A)+(B223)+(B261), (A)+(B223)+(B262), (A)+(B223)+(B263), (A)+(B223)+(B264), (A)+(B223)+(B265), (A)+(B223)+(B266), (A)+(B223)+(B267), (A)+(B223)+(B268), (A)+(B223)+(B269), (A)+(B223)+(B270), (A)+(B223)+(B271), (A)+(B223)+(B272), (A)+(B223)+(B273), (A)+(B223)+(B274), (A)+(B223)+(B275), (A)+(B223)+(B276), (A)+(B223)+(B277), (A)+(B223)+(B278), (A)+(B223)+(B279), (A)+(B223)+(B280), (A)+(B223)+(B281), (A)+(B223)+(B282), (A)+(B223)+(B283), (A)+(B223)+(B284), (A)+(B223)+(B285), (A)+(B223)+(B286), (A)+(B223)+(B287), (A)+(B223)+(B288), (A)+(B223)+(B289), (A)+(B223)+(B290), (A)+(B223)+(B291), (A)+(B223)+(B292), (A)+(B223)+(B293), (A)+(B223)+(B294), (A)+(B223)+(B295), (A)+(B223)+(B296), (A)+(B223)+(B297), (A)+(B223)+(B298), (A)+(B223)+(B299), (A)+(B223)+(B300), (A)+(B223)+(B301), (A)+(B223)+(B302), (A)+(B223)+(B303), (A)+(B223)+(B304), (A)+(B223)+(B305), (A)+(B223)+(B306), (A)+(B223)+(B307), (A)+(B223)+(B308), (A)+(B223)+(B309), (A)+(B223)+(B310), (A)+(B223)+(B311), (A)+(B223)+(B312), (A)+(B223)+(B313), (A)+(B223)+(B314), (A)+(B223)+(B315),

(A)+(B224)+(B225), (A)+(B224)+(B226), (A)+(B224)+(B227), (A)+(B224)+(B228), (A)+(B224)+(B229), (A)+(B224)+(B230), (A)+(B224)+(B231), (A)+(B224)+(B232), (A)+(B224)+(B233), (A)+(B224)+(B234), (A)+(B224)+(B235), (A)+(B224)+(B236), (A)+(B224)+(B237), (A)+(B224)+(B238), (A)+(B224)+(B239), (A)+(B224)+(B240), (A)+(B224)+(B241), (A)+(B224)+(B242), (A)+(B224)+(B243), (A)+(B224)+(B244), (A)+(B224)+(B245), (A)+(B224)+(B246), (A)+(B224)+(B247), (A)+(B224)+(B248), (A)+(B224)+(B249), (A)+(B224)+(B250), (A)+(B224)+(B251), (A)+(B224)+(B252), (A)+(B224)+(B253), (A)+(B224)+(B254), (A)+(B224)+(B255), (A)+(B224)+(B256), (A)+(B224)+(B257), (A)+(B224)+(B258), (A)+(B224)+(B259), (A)+(B224)+(B260), (A)+(B224)+(B261), (A)+(B224)+(B262), (A)+(B224)+(B263), (A)+(B224)+(B264), (A)+(B224)+(B265), (A)+(B224)+(B266), (A)+(B224)+(B267), (A)+(B224)+(B268), (A)+(B224)+(B269), (A)+(B224)+(B270), (A)+(B224)+(B271), (A)+(B224)+(B272), (A)+(B224)+(B273), (A)+(B224)+(B274), (A)+(B224)+(B275), (A)+(B224)+(B276), (A)+(B224)+(B277), (A)+(B224)+(B278), (A)+(B224)+(B279), (A)+(B224)+(B280), (A)+(B224)+(B281), (A)+(B224)+(B282), (A)+(B224)+(B283), (A)+(B224)+(B284), (A)+(B224)+(B285), (A)+(B224)+(B286), (A)+(B224)+(B287), (A)+(B224)+(B288), (A)+(B224)+(B289), (A)+(B224)+(B290), (A)+(B224)+(B291), (A)+(B224)+(B292), (A)+(B224)+(B293), (A)+(B224)+(B294), (A)+(B224)+(B295), (A)+(B224)+(B296), (A)+(B224)+(B297), (A)+(B224)+(B298), (A)+(B224)+(B299), (A)+(B224)+(B300), (A)+(B224)+(B301), (A)+(B224)+(B302), (A)+(B224)+(B303), (A)+(B224)+(B304), (A)+(B224)+(B305), (A)+(B224)+(B306), (A)+(B224)+(B307), (A)+(B224)+(B308), (A)+(B224)+(B309), (A)+(B224)+(B310), (A)+(B224)+(B311), (A)+(B224)+(B312), (A)+(B224)+(B313), (A)+(B224)+(B314), (A)+(B224)+(B315),

(A)+(B225)+(B226), (A)+(B225)+(B227), (A)+(B225)+(B228), (A)+(B225)+(B229), (A)+(B225)+(B230), (A)+(B225)+(B231), (A)+(B225)+(B232), (A)+(B225)+(B233), (A)+(B225)+(B234), (A)+(B225)+(B235), (A)+(B225)+(B236), (A)+(B225)+(B237), (A)+(B225)+(B238), (A)+(B225)+(B239), (A)+(B225)+(B240), (A)+(B225)+(B241), (A)+(B225)+(B242), (A)+(B225)+(B243), (A)+(B225)+(B244), (A)+(B225)+(B245), (A)+(B225)+(B246), (A)+(B225)+(B247), (A)+(B225)+(B248), (A)+(B225)+(B249), (A)+(B225)+(B250), (A)+(B225)+(B251), (A)+(B225)+(B252), (A)+(B225)+(B253), (A)+(B225)+(B254), (A)+(B225)+(B255), (A)+(B225)+(B256), (A)+(B225)+(B257), (A)+(B225)+(B258), (A)+(B225)+(B259), (A)+(B225)+(B260), (A)+(B225)+(B261), (A)+(B225)+(B262), (A)+(B225)+(B263), (A)+(B225)+(B264), (A)+(B225)+(B265), (A)+(B225)+(B266), (A)+(B225)+(B267), (A)+(B225)+(B268), (A)+(B225)+(B269), (A)+(B225)+(B270), (A)+(B225)+(B271), (A)+(B225)+(B272), (A)+(B225)+(B273), (A)+(B225)+(B274), (A)+(B225)+(B275), (A)+(B225)+(B276), (A)+(B225)+(B277), (A)+(B225)+(B278), (A)+(B225)+(B279), (A)+(B225)+(B280), (A)+(B225)+(B281), (A)+(B225)+(B282), (A)+(B225)+(B283), (A)+(B225)+(B284), (A)+(B225)+(B285), (A)+(B225)+(B286), (A)+(B225)+(B287), (A)+(B225)+(B288), (A)+(B225)+(B289), (A)+(B225)+(B290), (A)+(B225)+(B291), (A)+(B225)+(B292), (A)+(B225)+(B293), (A)+(B225)+(B294), (A)+(B225)+(B295), (A)+(B225)+(B296), (A)+(B225)+(B297), (A)+(B225)+(B298), (A)+(B225)+(B299), (A)+(B225)+(B300), (A)+(B225)+(B301), (A)+(B225)+(B302), (A)+(B225)+(B303), (A)+(B225)+(B304), (A)+(B225)+(B305), (A)+(B225)+(B306), (A)+(B225)+(B307), (A)+(B225)+(B308), (A)+(B225)+(B309), (A)+(B225)+(B310), (A)+(B225)+(B311), (A)+(B225)+(B312), (A)+(B225)+(B313), (A)+(B225)+(B314), (A)+(B225)+(B315),

(A)+(B226)+(B227), (A)+(B226)+(B228), (A)+(B226)+(B229), (A)+(B226)+(B230), (A)+(B226)+(B231), (A)+(B226)+(B232), (A)+(B226)+(B233), (A)+(B226)+(B234), (A)+(B226)+(B235), (A)+(B226)+(B236), (A)+(B226)+(B237), (A)+(B226)+(B238), (A)+(B226)+(B239), (A)+(B226)+(B240), (A)+(B226)+(B241), (A)+(B226)+(B242), (A)+(B226)+(B243), (A)+(B226)+(B244), (A)+(B226)+(B245), (A)+(B226)+(B246), (A)+(B226)+(B247), (A)+(B226)+(B248), (A)+(B226)+(B249), (A)+(B226)+(B250), (A)+(B226)+(B251), (A)+(B226)+(B252), (A)+(B226)+(B253), (A)+(B226)+(B254), (A)+(B226)+(B255), (A)+(B226)+(B256), (A)+(B226)+(B257), (A)+(B226)+(B258), (A)+(B226)+(B259), (A)+(B226)+(B260), (A)+(B226)+(B261), (A)+(B226)+(B262), (A)+(B226)+(B263), (A)+(B226)+(B264), (A)+(B226)+(B265), (A)+(B226)+(B266), (A)+(B226)+(B267), (A)+(B226)+(B268), (A)+(B226)+(B269), (A)+(B226)+(B270), (A)+(B226)+(B271), (A)+(B226)+(B272), (A)+(B226)+(B273), (A)+(B226)+(B274), (A)+(B226)+(B275), (A)+(B226)+(B276), (A)+(B226)+(B277), (A)+(B226)+(B278), (A)+(B226)+(B279), (A)+(B226)+(B280), (A)+(B226)+(B281), (A)+(B226)+(B282), (A)+(B226)+(B283), (A)+(B226)+(B284), (A)+(B226)+(B285), (A)+(B226)+(B286), (A)+(B226)+(B287), (A)+(B226)+(B288), (A)+(B226)+(B289), (A)+(B226)+(B290), (A)+(B226)+(B291), (A)+(B226)+(B292), (A)+(B226)+(B293), (A)+(B226)+(B294), (A)+(B226)+(B295), (A)+(B226)+(B296), (A)+(B226)+(B297), (A)+(B226)+(B298), (A)+(B226)+(B299), (A)+(B226)+(B300), (A)+(B226)+(B301), (A)+(B226)+(B302), (A)+(B226)+(B303), (A)+(B226)+(B304), (A)+(B226)+(B305), (A)+(B226)+(B306), (A)+(B226)+(B307), (A)+(B226)+(B308), (A)+(B226)+(B309), (A)+(B226)+(B310), (A)+(B226)+(B311), (A)+(B226)+(B312), (A)+(B226)+(B313), (A)+(B226)+(B314), (A)+(B226)+(B315),

(A)+(B227)+(B228), (A)+(B227)+(B229), (A)+(B227)+(B230), (A)+(B227)+(B231), (A)+(B227)+(B232), (A)+(B227)+(B233), (A)+(B227)+(B234), (A)+(B227)+(B235), (A)+(B227)+(B236), (A)+(B227)+(B237), (A)+(B227)+(B238), (A)+(B227)+(B239), (A)+(B227)+(B240), (A)+(B227)+(B241), (A)+(B227)+(B242), (A)+(B227)+(B243), (A)+(B227)+(B244), (A)+(B227)+(B245), (A)+(B227)+(B246), (A)+(B227)+(B247), (A)+(B227)+(B248), (A)+(B227)+(B249), (A)+(B227)+(B250), (A)+(B227)+(B251), (A)+(B227)+(B252), (A)+(B227)+(B253), (A)+(B227)+(B254), (A)+(B227)+(B255), (A)+(B227)+(B256), (A)+(B227)+(B257), (A)+(B227)+(B258), (A)+(B227)+(B259), (A)+(B227)+(B260), (A)+(B227)+(B261), (A)+(B227)+(B262), (A)+(B227)+(B263), (A)+(B227)+(B264), (A)+(B227)+(B265), (A)+(B227)+(B266), (A)+(B227)+(B267), (A)+(B227)+(B268), (A)+(B227)+(B269), (A)+(B227)+(B270), (A)+(B227)+(B271), (A)+(B227)+(B272), (A)+(B227)+(B273), (A)+(B227)+(B274), (A)+(B227)+(B275), (A)+(B227)+(B276), (A)+(B227)+(B277), (A)+(B227)+(B278), (A)+(B227)+(B279), (A)+(B227)+(B280), (A)+(B227)+(B281), (A)+(B227)+(B282), (A)+(B227)+(B283), (A)+(B227)+(B284), (A)+(B227)+(B285), (A)+(B227)+(B286), (A)+(B227)+(B287), (A)+(B227)+(B288), (A)+(B227)+(B289), (A)+(B227)+(B290), (A)+(B227)+(B291), (A)+(B227)+(B292), (A)+(B227)+(B293), (A)+(B227)+(B294), (A)+(B227)+(B295), (A)+(B227)+(B296), (A)+(B227)+(B297), (A)+(B227)+(B298), (A)+(B227)+(B299), (A)+(B227)+(B300), (A)+(B227)+(B301), (A)+(B227)+(B302), (A)+(B227)+(B303), (A)+(B227)+(B304), (A)+(B227)+(B305), (A)+(B227)+(B306), (A)+(B227)+(B307), (A)+(B227)+(B308), (A)+(B227)+(B309), (A)+(B227)+(B310), (A)+(B227)+(B311), (A)+(B227)+(B312), (A)+(B227)+(B313), (A)+(B227)+(B314), (A)+(B227)+(B315),

(A)+(B228)+(B229), (A)+(B228)+(B230), (A)+(B228)+(B231), (A)+(B228)+(B232), (A)+(B228)+(B233), (A)+(B228)+(B234), (A)+(B228)+(B235), (A)+(B228)+(B236), (A)+(B228)+(B237), (A)+(B228)+(B238), (A)+(B228)+(B239), (A)+(B228)+(B240), (A)+(B228)+(B241), (A)+(B228)+(B242), (A)+(B228)+(B243), (A)+(B228)+(B244), (A)+(B228)+(B245), (A)+(B228)+(B246), (A)+(B228)+(B247), (A)+(B228)+(B248), (A)+(B228)+(B249), (A)+(B228)+(B250), (A)+(B228)+(B251), (A)+(B228)+(B252), (A)+(B228)+(B253), (A)+(B228)+(B254), (A)+(B228)+(B255), (A)+(B228)+(B256), (A)+(B228)+(B257), (A)+(B228)+(B258), (A)+(B228)+(B259), (A)+(B228)+(B260), (A)+(B228)+(B261), (A)+(B228)+(B262), (A)+(B228)+(B263), (A)+(B228)+(B264), (A)+(B228)+(B265), (A)+(B228)+(B266), (A)+(B228)+(B267), (A)+(B228)+(B268), (A)+(B228)+(B269), (A)+(B228)+(B270), (A)+(B228)+(B271), (A)+(B228)+(B272), (A)+(B228)+(B273), (A)+(B228)+(B274), (A)+(B228)+(B275), (A)+(B228)+(B276), (A)+(B228)+(B277), (A)+(B228)+(B278), (A)+(B228)+(B279), (A)+(B228)+(B280), (A)+(B228)+(B281), (A)+(B228)+(B282), (A)+(B228)+(B283), (A)+(B228)+(B284), (A)+(B228)+(B285), (A)+(B228)+(B286), (A)+(B228)+(B287), (A)+(B228)+(B288), (A)+(B228)+(B289), (A)+(B228)+(B290), (A)+(B228)+(B291), (A)+(B228)+(B292), (A)+(B228)+(B293), (A)+(B228)+(B294), (A)+(B228)+(B295), (A)+(B228)+(B296), (A)+(B228)+(B297), (A)+(B228)+(B298), (A)+(B228)+(B299), (A)+(B228)+(B300), (A)+(B228)+(B301), (A)+(B228)+(B302), (A)+(B228)+(B303), (A)+(B228)+(B304), (A)+(B228)+(B305), (A)+(B228)+(B306), (A)+(B228)+(B307), (A)+(B228)+(B308), (A)+(B228)+(B309), (A)+(B228)+(B310), (A)+(B228)+(B311), (A)+(B228)+(B312), (A)+(B228)+(B313), (A)+(B228)+(B314), (A)+(B228)+(B315),

(A)+(B229)+(B230), (A)+(B229)+(B231), (A)+(B229)+(B232), (A)+(B229)+(B233), (A)+(B229)+(B234), (A)+(B229)+(B235), (A)+(B229)+(B236), (A)+(B229)+(B237), (A)+(B229)+(B238), (A)+(B229)+(B239), (A)+(B229)+(B240), (A)+(B229)+(B241), (A)+(B229)+(B242), (A)+(B229)+(B243), (A)+(B229)+(B244), (A)+(B229)+(B245), (A)+(B229)+(B246), (A)+(B229)+(B247), (A)+(B229)+(B248), (A)+(B229)+(B249), (A)+(B229)+(B250), (A)+(B229)+(B251), (A)+(B229)+(B252), (A)+(B229)+(B253), (A)+(B229)+(B254), (A)+(B229)+(B255), (A)+(B229)+(B256), (A)+(B229)+(B257), (A)+(B229)+(B258), (A)+(B229)+(B259), (A)+(B229)+(B260), (A)+(B229)+(B261), (A)+(B229)+(B262), (A)+(B229)+(B263), (A)+(B229)+(B264), (A)+(B229)+(B265), (A)+(B229)+(B266), (A)+(B229)+(B267), (A)+(B229)+(B268), (A)+(B229)+(B269), (A)+(B229)+(B270), (A)+(B229)+(B271), (A)+(B229)+(B272), (A)+(B229)+(B273), (A)+(B229)+(B274), (A)+(B229)+(B275), (A)+(B229)+(B276), (A)+(B229)+(B277), (A)+(B229)+(B278), (A)+(B229)+(B279), (A)+(B229)+(B280), (A)+(B229)+(B281), (A)+(B229)+(B282), (A)+(B229)+(B283), (A)+(B229)+(B284), (A)+(B229)+(B285), (A)+(B229)+(B286), (A)+(B229)+(B287), (A)+(B229)+(B288), (A)+(B229)+(B289), (A)+(B229)+(B290), (A)+(B229)+(B291), (A)+(B229)+(B292), (A)+(B229)+(B293), (A)+(B229)+(B294), (A)+(B229)+(B295), (A)+(B229)+(B296), (A)+(B229)+(B297), (A)+(B229)+(B298), (A)+(B229)+(B299), (A)+(B229)+(B300), (A)+(B229)+(B301), (A)+(B229)+(B302), (A)+(B229)+(B303), (A)+(B229)+(B304), (A)+(B229)+(B305), (A)+(B229)+(B306), (A)+(B229)+(B307), (A)+(B229)+(B308), (A)+(B229)+(B309), (A)+(B229)+(B310), (A)+(B229)+(B311), (A)+(B229)+(B312), (A)+(B229)+(B313), (A)+(B229)+(B314), (A)+(B229)+(B315),

(A)+(B230)+(B231), (A)+(B230)+(B232), (A)+(B230)+(B233), (A)+(B230)+(B234), (A)+(B230)+(B235), (A)+(B230)+(B236), (A)+(B230)+(B237), (A)+(B230)+(B238), (A)+(B230)+(B239), (A)+(B230)+(B240), (A)+(B230)+(B241), (A)+(B230)+(B242), (A)+(B230)+(B243), (A)+(B230)+(B244), (A)+(B230)+(B245), (A)+(B230)+(B246), (A)+(B230)+(B247), (A)+(B230)+(B248), (A)+(B230)+(B249), (A)+(B230)+(B250), (A)+(B230)+(B251), (A)+(B230)+(B252), (A)+(B230)+(B253), (A)+(B230)+(B254), (A)+(B230)+(B255), (A)+(B230)+(B256), (A)+(B230)+(B257), (A)+(B230)+(B258), (A)+(B230)+(B259), (A)+(B230)+(B260), (A)+(B230)+(B261), (A)+(B230)+(B262), (A)+(B230)+(B263), (A)+(B230)+(B264), (A)+(B230)+(B265), (A)+(B230)+(B266), (A)+(B230)+(B267), (A)+(B230)+(B268), (A)+(B230)+(B269), (A)+(B230)+(B270), (A)+(B230)+(B271), (A)+(B230)+(B272), (A)+(B230)+(B273), (A)+(B230)+(B274), (A)+(B230)+(B275), (A)+(B230)+(B276), (A)+(B230)+(B277), (A)+(B230)+(B278), (A)+(B230)+(B279), (A)+(B230)+(B280), (A)+(B230)+(B281), (A)+(B230)+(B282), (A)+(B230)+(B283), (A)+(B230)+(B284), (A)+(B230)+(B285), (A)+(B230)+(B286), (A)+(B230)+(B287), (A)+(B230)+(B288), (A)+(B230)+(B289), (A)+(B230)+(B290), (A)+(B230)+(B291), (A)+(B230)+(B292), (A)+(B230)+(B293), (A)+(B230)+(B294), (A)+(B230)+(B295), (A)+(B230)+(B296), (A)+(B230)+(B297), (A)+(B230)+(B298), (A)+(B230)+(B299), (A)+(B230)+(B300), (A)+(B230)+(B301), (A)+(B230)+(B302), (A)+(B230)+(B303), (A)+(B230)+(B304), (A)+(B230)+(B305), (A)+(B230)+(B306), (A)+(B230)+(B307), (A)+(B230)+(B308), (A)+(B230)+(B309), (A)+(B230)+(B310), (A)+(B230)+(B311), (A)+(B230)+(B312), (A)+(B230)+(B313), (A)+(B230)+(B314), (A)+(B230)+(B315),

(A)+(B231)+(B232), (A)+(B231)+(B233), (A)+(B231)+(B234), (A)+(B231)+(B235), (A)+(B231)+(B236), (A)+(B231)+(B237), (A)+(B231)+(B238), (A)+(B231)+(B239), (A)+(B231)+(B240), (A)+(B231)+(B241), (A)+(B231)+(B242), (A)+(B231)+(B243), (A)+(B231)+(B244), (A)+(B231)+(B245), (A)+(B231)+(B246), (A)+(B231)+(B247), (A)+(B231)+(B248), (A)+(B231)+(B249), (A)+(B231)+(B250), (A)+(B231)+(B251), (A)+(B231)+(B252), (A)+(B231)+(B253), (A)+(B231)+(B254), (A)+(B231)+(B255), (A)+(B231)+(B256), (A)+(B231)+(B257), (A)+(B231)+(B258), (A)+(B231)+(B259), (A)+(B231)+(B260), (A)+(B231)+(B261), (A)+(B231)+(B262), (A)+(B231)+(B263), (A)+(B231)+(B264), (A)+(B231)+(B265), (A)+(B231)+(B266), (A)+(B231)+(B267), (A)+(B231)+(B268), (A)+(B231)+(B269), (A)+(B231)+(B270), (A)+(B231)+(B271), (A)+(B231)+(B272), (A)+(B231)+(B273), (A)+(B231)+(B274), (A)+(B231)+(B275), (A)+(B231)+(B276), (A)+(B231)+(B277), (A)+(B231)+(B278), (A)+(B231)+(B279), (A)+(B231)+(B280), (A)+(B231)+(B281), (A)+(B231)+(B282), (A)+(B231)+(B283), (A)+(B231)+(B284), (A)+(B231)+(B285), (A)+(B231)+(B286), (A)+(B231)+(B287), (A)+(B231)+(B288), (A)+(B231)+(B289), (A)+(B231)+(B290), (A)+(B231)+(B291), (A)+(B231)+(B292), (A)+(B231)+(B293), (A)+(B231)+(B294), (A)+(B231)+(B295), (A)+(B231)+(B296), (A)+(B231)+(B297), (A)+(B231)+(B298), (A)+(B231)+(B299), (A)+(B231)+(B300), (A)+(B231)+(B301), (A)+(B231)+(B302), (A)+(B231)+(B303), (A)+(B231)+(B304), (A)+(B231)+(B305), (A)+(B231)+(B306), (A)+(B231)+(B307), (A)+(B231)+(B308), (A)+(B231)+(B309), (A)+(B231)+(B310), (A)+(B231)+(B311), (A)+(B231)+(B312), (A)+(B231)+(B313), (A)+(B231)+(B314), (A)+(B231)+(B315),

(A)+(B232)+(B233), (A)+(B232)+(B234), (A)+(B232)+(B235), (A)+(B232)+(B236), (A)+(B232)+(B237), (A)+(B232)+(B238), (A)+(B232)+(B239), (A)+(B232)+(B240), (A)+(B232)+(B241), (A)+(B232)+(B242), (A)+(B232)+(B243), (A)+(B232)+(B244), (A)+(B232)+(B245), (A)+(B232)+(B246), (A)+(B232)+(B247), (A)+(B232)+(B248), (A)+(B232)+(B249), (A)+(B232)+(B250), (A)+(B232)+(B251), (A)+(B232)+(B252), (A)+(B232)+(B253), (A)+(B232)+(B254), (A)+(B232)+(B255), (A)+(B232)+(B256), (A)+(B232)+(B257), (A)+(B232)+(B258), (A)+(B232)+(B259), (A)+(B232)+(B260), (A)+(B232)+(B261), (A)+(B232)+(B262), (A)+(B232)+(B263), (A)+(B232)+(B264), (A)+(B232)+(B265), (A)+(B232)+(B266), (A)+(B232)+(B267), (A)+(B232)+(B268), (A)+(B232)+(B269), (A)+(B232)+(B270), (A)+(B232)+(B271), (A)+(B232)+(B272), (A)+(B232)+(B273), (A)+(B232)+(B274), (A)+(B232)+(B275), (A)+(B232)+(B276), (A)+(B232)+(B277), (A)+(B232)+(B278), (A)+(B232)+(B279), (A)+(B232)+(B280), (A)+(B232)+(B281), (A)+(B232)+(B282), (A)+(B232)+(B283), (A)+(B232)+(B284), (A)+(B232)+(B285), (A)+(B232)+(B286), (A)+(B232)+(B287), (A)+(B232)+(B288), (A)+(B232)+(B289), (A)+(B232)+(B290), (A)+(B232)+(B291), (A)+(B232)+(B292), (A)+(B232)+(B293), (A)+(B232)+(B294), (A)+(B232)+(B295), (A)+(B232)+(B296), (A)+(B232)+(B297), (A)+(B232)+(B298), (A)+(B232)+(B299), (A)+(B232)+(B300), (A)+(B232)+(B301), (A)+(B232)+(B302), (A)+(B232)+(B303), (A)+(B232)+(B304), (A)+(B232)+(B305), (A)+(B232)+(B306), (A)+(B232)+(B307), (A)+(B232)+(B308), (A)+(B232)+(B309), (A)+(B232)+(B310), (A)+(B232)+(B311), (A)+(B232)+(B312), (A)+(B232)+(B313), (A)+(B232)+(B314), (A)+(B232)+(B315),

(A)+(B233)+(B234), (A)+(B233)+(B235), (A)+(B233)+(B236), (A)+(B233)+(B237), (A)+(B233)+(B238), (A)+(B233)+(B239), (A)+(B233)+(B240), (A)+(B233)+(B241), (A)+(B233)+(B242), (A)+(B233)+(B243), (A)+(B233)+(B244), (A)+(B233)+(B245), (A)+(B233)+(B246), (A)+(B233)+(B247), (A)+(B233)+(B248), (A)+(B233)+(B249), (A)+(B233)+(B250), (A)+(B233)+(B251), (A)+(B233)+(B252), (A)+(B233)+(B253), (A)+(B233)+(B254), (A)+(B233)+(B255), (A)+(B233)+(B256), (A)+(B233)+(B257), (A)+(B233)+(B258), (A)+(B233)+(B259), (A)+(B233)+(B260), (A)+(B233)+(B261), (A)+(B233)+(B262), (A)+(B233)+(B263), (A)+(B233)+(B264), (A)+(B233)+(B265), (A)+(B233)+(B266), (A)+(B233)+(B267), (A)+(B233)+(B268), (A)+(B233)+(B269), (A)+(B233)+(B270), (A)+(B233)+(B271), (A)+(B233)+(B272), (A)+(B233)+(B273), (A)+(B233)+(B274), (A)+(B233)+(B275), (A)+(B233)+(B276), (A)+(B233)+(B277), (A)+(B233)+(B278), (A)+(B233)+(B279), (A)+(B233)+(B280), (A)+(B233)+(B281), (A)+(B233)+(B282), (A)+(B233)+(B283), (A)+(B233)+(B284), (A)+(B233)+(B285), (A)+(B233)+(B286), (A)+(B233)+(B287), (A)+(B233)+(B288), (A)+(B233)+(B289), (A)+(B233)+(B290), (A)+(B233)+(B291), (A)+(B233)+(B292), (A)+(B233)+(B293), (A)+(B233)+(B294), (A)+(B233)+(B295), (A)+(B233)+(B296), (A)+(B233)+(B297), (A)+(B233)+(B298), (A)+(B233)+(B299), (A)+(B233)+(B300), (A)+(B233)+(B301), (A)+(B233)+(B302), (A)+(B233)+(B303), (A)+(B233)+(B304), (A)+(B233)+(B305), (A)+(B233)+(B306), (A)+(B233)+(B307), (A)+(B233)+(B308), (A)+(B233)+(B309), (A)+(B233)+(B310), (A)+(B233)+(B311), (A)+(B233)+(B312), (A)+(B233)+(B313), (A)+(B233)+(B314), (A)+(B233)+(B315),

(A)+(B234)+(B235), (A)+(B234)+(B236), (A)+(B234)+(B237), (A)+(B234)+(B238), (A)+(B234)+(B239), (A)+(B234)+(B240), (A)+(B234)+(B241), (A)+(B234)+(B242), (A)+(B234)+(B243), (A)+(B234)+(B244), (A)+(B234)+(B245), (A)+(B234)+(B246), (A)+(B234)+(B247), (A)+(B234)+(B248), (A)+(B234)+(B249), (A)+(B234)+(B250), (A)+(B234)+(B251), (A)+(B234)+(B252), (A)+(B234)+(B253), (A)+(B234)+(B254), (A)+(B234)+(B255), (A)+(B234)+(B256), (A)+(B234)+(B257), (A)+(B234)+(B258), (A)+(B234)+(B259), (A)+(B234)+(B260), (A)+(B234)+(B261), (A)+(B234)+(B262), (A)+(B234)+(B263), (A)+(B234)+(B264), (A)+(B234)+(B265), (A)+(B234)+(B266), (A)+(B234)+(B267), (A)+(B234)+(B268), (A)+(B234)+(B269), (A)+(B234)+(B270), (A)+(B234)+(B271), (A)+(B234)+(B272), (A)+(B234)+(B273), (A)+(B234)+(B274), (A)+(B234)+(B275), (A)+(B234)+(B276), (A)+(B234)+(B277), (A)+(B234)+(B278), (A)+(B234)+(B279), (A)+(B234)+(B280), (A)+(B234)+(B281), (A)+(B234)+(B282), (A)+(B234)+(B283), (A)+(B234)+(B284), (A)+(B234)+(B285), (A)+(B234)+(B286), (A)+(B234)+(B287), (A)+(B234)+(B288), (A)+(B234)+(B289), (A)+(B234)+(B290), (A)+(B234)+(B291), (A)+(B234)+(B292), (A)+(B234)+(B293), (A)+(B234)+(B294), (A)+(B234)+(B295), (A)+(B234)+(B296), (A)+(B234)+(B297), (A)+(B234)+(B298), (A)+(B234)+(B299), (A)+(B234)+(B300), (A)+(B234)+(B301), (A)+(B234)+(B302), (A)+(B234)+(B303), (A)+(B234)+(B304), (A)+(B234)+(B305), (A)+(B234)+(B306), (A)+(B234)+(B307), (A)+(B234)+(B308), (A)+(B234)+(B309), (A)+(B234)+(B310), (A)+(B234)+(B311), (A)+(B234)+(B312), (A)+(B234)+(B313), (A)+(B234)+(B314), (A)+(B234)+(B315),

(A)+(B235)+(B236), (A)+(B235)+(B237), (A)+(B235)+(B238), (A)+(B235)+(B239), (A)+(B235)+(B240), (A)+(B235)+(B241), (A)+(B235)+(B242), (A)+(B235)+(B243), (A)+(B235)+(B244), (A)+(B235)+(B245), (A)+(B235)+(B246), (A)+(B235)+(B247), (A)+(B235)+(B248), (A)+(B235)+(B249), (A)+(B235)+(B250), (A)+(B235)+(B251), (A)+(B235)+(B252), (A)+(B235)+(B253), (A)+(B235)+(B254), (A)+(B235)+(B255), (A)+(B235)+(B256), (A)+(B235)+(B257), (A)+(B235)+(B258), (A)+(B235)+(B259), (A)+(B235)+(B260), (A)+(B235)+(B261), (A)+(B235)+(B262), (A)+(B235)+(B263), (A)+(B235)+(B264), (A)+(B235)+(B265), (A)+(B235)+(B266), (A)+(B235)+(B267), (A)+(B235)+(B268), (A)+(B235)+(B269), (A)+(B235)+(B270), (A)+(B235)+(B271), (A)+(B235)+(B272), (A)+(B235)+(B273), (A)+(B235)+(B274), (A)+(B235)+(B275), (A)+(B235)+(B276), (A)+(B235)+(B277), (A)+(B235)+(B278), (A)+(B235)+(B279), (A)+(B235)+(B280), (A)+(B235)+(B281), (A)+(B235)+(B282), (A)+(B235)+(B283), (A)+(B235)+(B284), (A)+(B235)+(B285), (A)+(B235)+(B286), (A)+(B235)+(B287), (A)+(B235)+(B288), (A)+(B235)+(B289), (A)+(B235)+(B290), (A)+(B235)+(B291), (A)+(B235)+(B292), (A)+(B235)+(B293), (A)+(B235)+(B294), (A)+(B235)+(B295), (A)+(B235)+(B296), (A)+(B235)+(B297), (A)+(B235)+(B298), (A)+(B235)+(B299), (A)+(B235)+(B300), (A)+(B235)+(B301), (A)+(B235)+(B302), (A)+(B235)+(B303), (A)+(B235)+(B304), (A)+(B235)+(B305), (A)+(B235)+(B306), (A)+(B235)+(B307), (A)+(B235)+(B308), (A)+(B235)+(B309), (A)+(B235)+(B310), (A)+(B235)+(B311), (A)+(B235)+(B312), (A)+(B235)+(B313), (A)+(B235)+(B314), (A)+(B235)+(B315),

(A)+(B236)+(B237), (A)+(B236)+(B238), (A)+(B236)+(B239), (A)+(B236)+(B240), (A)+(B236)+(B241), (A)+(B236)+(B242), (A)+(B236)+(B243), (A)+(B236)+(B244), (A)+(B236)+(B245), (A)+(B236)+(B246), (A)+(B236)+(B247), (A)+(B236)+(B248), (A)+(B236)+(B249), (A)+(B236)+(B250), (A)+(B236)+(B251), (A)+(B236)+(B252), (A)+(B236)+(B253), (A)+(B236)+(B254), (A)+(B236)+(B255), (A)+(B236)+(B256), (A)+(B236)+(B257), (A)+(B236)+(B258), (A)+(B236)+(B259), (A)+(B236)+(B260), (A)+(B236)+(B261), (A)+(B236)+(B262), (A)+(B236)+(B263), (A)+(B236)+(B264), (A)+(B236)+(B265), (A)+(B236)+(B266), (A)+(B236)+(B267), (A)+(B236)+(B268), (A)+(B236)+(B269), (A)+(B236)+(B270), (A)+(B236)+(B271), (A)+(B236)+(B272), (A)+(B236)+(B273), (A)+(B236)+(B274), (A)+(B236)+(B275), (A)+(B236)+(B276), (A)+(B236)+(B277), (A)+(B236)+(B278), (A)+(B236)+(B279), (A)+(B236)+(B280), (A)+(B236)+(B281), (A)+(B236)+(B282), (A)+(B236)+(B283), (A)+(B236)+(B284), (A)+(B236)+(B285), (A)+(B236)+(B286), (A)+(B236)+(B287), (A)+(B236)+(B288), (A)+(B236)+(B289), (A)+(B236)+(B290), (A)+(B236)+(B291), (A)+(B236)+(B292), (A)+(B236)+(B293), (A)+(B236)+(B294), (A)+(B236)+(B295), (A)+(B236)+(B296), (A)+(B236)+(B297), (A)+(B236)+(B298), (A)+(B236)+(B299), (A)+(B236)+(B300), (A)+(B236)+(B301), (A)+(B236)+(B302), (A)+(B236)+(B303), (A)+(B236)+(B304), (A)+(B236)+(B305), (A)+(B236)+(B306), (A)+(B236)+(B307), (A)+(B236)+(B308), (A)+(B236)+(B309), (A)+(B236)+(B310), (A)+(B236)+(B311), (A)+(B236)+(B312), (A)+(B236)+(B313), (A)+(B236)+(B314), (A)+(B236)+(B315),

(A)+(B237)+(B238), (A)+(B237)+(B239), (A)+(B237)+(B240), (A)+(B237)+(B241), (A)+(B237)+(B242), (A)+(B237)+(B243), (A)+(B237)+(B244), (A)+(B237)+(B245), (A)+(B237)+(B246), (A)+(B237)+(B247), (A)+(B237)+(B248), (A)+(B237)+(B249), (A)+(B237)+(B250), (A)+(B237)+(B251), (A)+(B237)+(B252), (A)+(B237)+(B253), (A)+(B237)+(B254), (A)+(B237)+(B255), (A)+(B237)+(B256), (A)+(B237)+(B257), (A)+(B237)+(B258), (A)+(B237)+(B259), (A)+(B237)+(B260), (A)+(B237)+(B261), (A)+(B237)+(B262), (A)+(B237)+(B263), (A)+(B237)+(B264), (A)+(B237)+(B265), (A)+(B237)+(B266), (A)+(B237)+(B267), (A)+(B237)+(B268), (A)+(B237)+(B269), (A)+(B237)+(B270), (A)+(B237)+(B271), (A)+(B237)+(B272), (A)+(B237)+(B273), (A)+(B237)+(B274), (A)+(B237)+(B275), (A)+(B237)+(B276), (A)+(B237)+(B277), (A)+(B237)+(B278), (A)+(B237)+(B279), (A)+(B237)+(B280), (A)+(B237)+(B281), (A)+(B237)+(B282), (A)+(B237)+(B283), (A)+(B237)+(B284), (A)+(B237)+(B285), (A)+(B237)+(B286), (A)+(B237)+(B287), (A)+(B237)+(B288), (A)+(B237)+(B289), (A)+(B237)+(B290), (A)+(B237)+(B291), (A)+(B237)+(B292), (A)+(B237)+(B293), (A)+(B237)+(B294), (A)+(B237)+(B295), (A)+(B237)+(B296), (A)+(B237)+(B297), (A)+(B237)+(B298), (A)+(B237)+(B299), (A)+(B237)+(B300), (A)+(B237)+(B301), (A)+(B237)+(B302), (A)+(B237)+(B303), (A)+(B237)+(B304), (A)+(B237)+(B305), (A)+(B237)+(B306), (A)+(B237)+(B307), (A)+(B237)+(B308), (A)+(B237)+(B309), (A)+(B237)+(B310), (A)+(B237)+(B311), (A)+(B237)+(B312), (A)+(B237)+(B313), (A)+(B237)+(B314), (A)+(B237)+(B315),

(A)+(B238)+(B239), (A)+(B238)+(B240), (A)+(B238)+(B241), (A)+(B238)+(B242), (A)+(B238)+(B243), (A)+(B238)+(B244), (A)+(B238)+(B245), (A)+(B238)+(B246), (A)+(B238)+(B247), (A)+(B238)+(B248), (A)+(B238)+(B249), (A)+(B238)+(B250), (A)+(B238)+(B251), (A)+(B238)+(B252), (A)+(B238)+(B253), (A)+(B238)+(B254), (A)+(B238)+(B255), (A)+(B238)+(B256), (A)+(B238)+(B257), (A)+(B238)+(B258), (A)+(B238)+(B259), (A)+(B238)+(B260), (A)+(B238)+(B261), (A)+(B238)+(B262), (A)+(B238)+(B263), (A)+(B238)+(B264), (A)+(B238)+(B265), (A)+(B238)+(B266), (A)+(B238)+(B267), (A)+(B238)+(B268), (A)+(B238)+(B269), (A)+(B238)+(B270), (A)+(B238)+(B271), (A)+(B238)+(B272), (A)+(B238)+(B273), (A)+(B238)+(B274), (A)+(B238)+(B275), (A)+(B238)+(B276), (A)+(B238)+(B277), (A)+(B238)+(B278), (A)+(B238)+(B279), (A)+(B238)+(B280), (A)+(B238)+(B281), (A)+(B238)+(B282), (A)+(B238)+(B283), (A)+(B238)+(B284), (A)+(B238)+(B285), (A)+(B238)+(B286), (A)+(B238)+(B287), (A)+(B238)+(B288), (A)+(B238)+(B289), (A)+(B238)+(B290), (A)+(B238)+(B291), (A)+(B238)+(B292), (A)+(B238)+(B293), (A)+(B238)+(B294), (A)+(B238)+(B295), (A)+(B238)+(B296), (A)+(B238)+(B297), (A)+(B238)+(B298), (A)+(B238)+(B299), (A)+(B238)+(B300), (A)+(B238)+(B301), (A)+(B238)+(B302), (A)+(B238)+(B303), (A)+(B238)+(B304), (A)+(B238)+(B305), (A)+(B238)+(B306), (A)+(B238)+(B307), (A)+(B238)+(B308), (A)+(B238)+(B309), (A)+(B238)+(B310), (A)+(B238)+(B311), (A)+(B238)+(B312), (A)+(B238)+(B313), (A)+(B238)+(B314), (A)+(B238)+(B315),

(A)+(B239)+(B240), (A)+(B239)+(B241), (A)+(B239)+(B242), (A)+(B239)+(B243), (A)+(B239)+(B244), (A)+(B239)+(B245), (A)+(B239)+(B246), (A)+(B239)+(B247), (A)+(B239)+(B248), (A)+(B239)+(B249), (A)+(B239)+(B250), (A)+(B239)+(B251), (A)+(B239)+(B252), (A)+(B239)+(B253), (A)+(B239)+(B254), (A)+(B239)+(B255), (A)+(B239)+(B256), (A)+(B239)+(B257), (A)+(B239)+(B258), (A)+(B239)+(B259), (A)+(B239)+(B260), (A)+(B239)+(B261), (A)+(B239)+(B262), (A)+(B239)+(B263), (A)+(B239)+(B264), (A)+(B239)+(B265), (A)+(B239)+(B266), (A)+(B239)+(B267), (A)+(B239)+(B268), (A)+(B239)+(B269), (A)+(B239)+(B270), (A)+(B239)+(B271), (A)+(B239)+(B272), (A)+(B239)+(B273), (A)+(B239)+(B274), (A)+(B239)+(B275), (A)+(B239)+(B276), (A)+(B239)+(B277), (A)+(B239)+(B278), (A)+(B239)+(B279), (A)+(B239)+(B280), (A)+(B239)+(B281), (A)+(B239)+(B282), (A)+(B239)+(B283), (A)+(B239)+(B284), (A)+(B239)+(B285), (A)+(B239)+(B286), (A)+(B239)+(B287), (A)+(B239)+(B288), (A)+(B239)+(B289), (A)+(B239)+(B290), (A)+(B239)+(B291), (A)+(B239)+(B292), (A)+(B239)+(B293), (A)+(B239)+(B294), (A)+(B239)+(B295), (A)+(B239)+(B296), (A)+(B239)+(B297), (A)+(B239)+(B298), (A)+(B239)+(B299), (A)+(B239)+(B300), (A)+(B239)+(B301), (A)+(B239)+(B302), (A)+(B239)+(B303), (A)+(B239)+(B304), (A)+(B239)+(B305), (A)+(B239)+(B306), (A)+(B239)+(B307), (A)+(B239)+(B308), (A)+(B239)+(B309), (A)+(B239)+(B310), (A)+(B239)+(B311), (A)+(B239)+(B312), (A)+(B239)+(B313), (A)+(B239)+(B314), (A)+(B239)+(B315),

(A)+(B240)+(B241), (A)+(B240)+(B242), (A)+(B240)+(B243), (A)+(B240)+(B244), (A)+(B240)+(B245), (A)+(B240)+(B246), (A)+(B240)+(B247), (A)+(B240)+(B248), (A)+(B240)+(B249), (A)+(B240)+(B250), (A)+(B240)+(B251), (A)+(B240)+(B252), (A)+(B240)+(B253), (A)+(B240)+(B254), (A)+(B240)+(B255), (A)+(B240)+(B256), (A)+(B240)+(B257), (A)+(B240)+(B258), (A)+(B240)+(B259), (A)+(B240)+(B260), (A)+(B240)+(B261), (A)+(B240)+(B262), (A)+(B240)+(B263), (A)+(B240)+(B264), (A)+(B240)+(B265), (A)+(B240)+(B266), (A)+(B240)+(B267), (A)+(B240)+(B268), (A)+(B240)+(B269), (A)+(B240)+(B270), (A)+(B240)+(B271), (A)+(B240)+(B272), (A)+(B240)+(B273), (A)+(B240)+(B274), (A)+(B240)+(B275), (A)+(B240)+(B276), (A)+(B240)+(B277), (A)+(B240)+(B278), (A)+(B240)+(B279), (A)+(B240)+(B280), (A)+(B240)+(B281), (A)+(B240)+(B282), (A)+(B240)+(B283), (A)+(B240)+(B284), (A)+(B240)+(B285), (A)+(B240)+(B286), (A)+(B240)+(B287), (A)+(B240)+(B288), (A)+(B240)+(B289), (A)+(B240)+(B290), (A)+(B240)+(B291), (A)+(B240)+(B292), (A)+(B240)+(B293), (A)+(B240)+(B294), (A)+(B240)+(B295), (A)+(B240)+(B296), (A)+(B240)+(B297), (A)+(B240)+(B298), (A)+(B240)+(B299), (A)+(B240)+(B300), (A)+(B240)+(B301), (A)+(B240)+(B302), (A)+(B240)+(B303), (A)+(B240)+(B304), (A)+(B240)+(B305), (A)+(B240)+(B306), (A)+(B240)+(B307), (A)+(B240)+(B308), (A)+(B240)+(B309), (A)+(B240)+(B310), (A)+(B240)+(B311), (A)+(B240)+(B312), (A)+(B240)+(B313), (A)+(B240)+(B314), (A)+(B240)+(B315),

(A)+(B241)+(B242), (A)+(B241)+(B243), (A)+(B241)+(B244), (A)+(B241)+(B245), (A)+(B241)+(B246), (A)+(B241)+(B247), (A)+(B241)+(B248), (A)+(B241)+(B249), (A)+(B241)+(B250), (A)+(B241)+(B251), (A)+(B241)+(B252), (A)+(B241)+(B253), (A)+(B241)+(B254), (A)+(B241)+(B255), (A)+(B241)+(B256), (A)+(B241)+(B257), (A)+(B241)+(B258), (A)+(B241)+(B259), (A)+(B241)+(B260), (A)+(B241)+(B261), (A)+(B241)+(B262), (A)+(B241)+(B263), (A)+(B241)+(B264), (A)+(B241)+(B265), (A)+(B241)+(B266), (A)+(B241)+(B267), (A)+(B241)+(B268), (A)+(B241)+(B269), (A)+(B241)+(B270), (A)+(B241)+(B271), (A)+(B241)+(B272), (A)+(B241)+(B273), (A)+(B241)+(B274), (A)+(B241)+(B275), (A)+(B241)+(B276), (A)+(B241)+(B277), (A)+(B241)+(B278), (A)+(B241)+(B279), (A)+(B241)+(B280), (A)+(B241)+(B281), (A)+(B241)+(B282), (A)+(B241)+(B283), (A)+(B241)+(B284), (A)+(B241)+(B285), (A)+(B241)+(B286), (A)+(B241)+(B287), (A)+(B241)+(B288), (A)+(B241)+(B289), (A)+(B241)+(B290), (A)+(B241)+(B291), (A)+(B241)+(B292), (A)+(B241)+(B293), (A)+(B241)+(B294), (A)+(B241)+(B295), (A)+(B241)+(B296), (A)+(B241)+(B297), (A)+(B241)+(B298), (A)+(B241)+(B299), (A)+(B241)+(B300), (A)+(B241)+(B301), (A)+(B241)+(B302), (A)+(B241)+(B303), (A)+(B241)+(B304), (A)+(B241)+(B305), (A)+(B241)+(B306), (A)+(B241)+(B307), (A)+(B241)+(B308), (A)+(B241)+(B309), (A)+(B241)+(B310), (A)+(B241)+(B311), (A)+(B241)+(B312), (A)+(B241)+(B313), (A)+(B241)+(B314), (A)+(B241)+(B315),

(A)+(B242)+(B243), (A)+(B242)+(B244), (A)+(B242)+(B245), (A)+(B242)+(B246), (A)+(B242)+(B247), (A)+(B242)+(B248), (A)+(B242)+(B249), (A)+(B242)+(B250), (A)+(B242)+(B251), (A)+(B242)+(B252), (A)+(B242)+(B253), (A)+(B242)+(B254), (A)+(B242)+(B255), (A)+(B242)+(B256), (A)+(B242)+(B257), (A)+(B242)+(B258), (A)+(B242)+(B259), (A)+(B242)+(B260), (A)+(B242)+(B261), (A)+(B242)+(B262), (A)+(B242)+(B263), (A)+(B242)+(B264), (A)+(B242)+(B265), (A)+(B242)+(B266), (A)+(B242)+(B267), (A)+(B242)+(B268), (A)+(B242)+(B269), (A)+(B242)+(B270), (A)+(B242)+(B271), (A)+(B242)+(B272), (A)+(B242)+(B273), (A)+(B242)+(B274), (A)+(B242)+(B275), (A)+(B242)+(B276), (A)+(B242)+(B277), (A)+(B242)+(B278), (A)+(B242)+(B279), (A)+(B242)+(B280), (A)+(B242)+(B281), (A)+(B242)+(B282), (A)+(B242)+(B283), (A)+(B242)+(B284), (A)+(B242)+(B285), (A)+(B242)+(B286), (A)+(B242)+(B287), (A)+(B242)+(B288), (A)+(B242)+(B289), (A)+(B242)+(B290), (A)+(B242)+(B291), (A)+(B242)+(B292), (A)+(B242)+(B293), (A)+(B242)+(B294), (A)+(B242)+(B295), (A)+(B242)+(B296), (A)+(B242)+(B297), (A)+(B242)+(B298), (A)+(B242)+(B299), (A)+(B242)+(B300), (A)+(B242)+(B301), (A)+(B242)+(B302), (A)+(B242)+(B303), (A)+(B242)+(B304), (A)+(B242)+(B305), (A)+(B242)+(B306), (A)+(B242)+(B307), (A)+(B242)+(B308), (A)+(B242)+(B309), (A)+(B242)+(B310), (A)+(B242)+(B311), (A)+(B242)+(B312), (A)+(B242)+(B313), (A)+(B242)+(B314), (A)+(B242)+(B315),

(A)+(B243)+(B244), (A)+(B243)+(B245), (A)+(B243)+(B246), (A)+(B243)+(B247), (A)+(B243)+(B248), (A)+(B243)+(B249), (A)+(B243)+(B250), (A)+(B243)+(B251), (A)+(B243)+(B252), (A)+(B243)+(B253), (A)+(B243)+(B254), (A)+(B243)+(B255), (A)+(B243)+(B256), (A)+(B243)+(B257), (A)+(B243)+(B258), (A)+(B243)+(B259), (A)+(B243)+(B260), (A)+(B243)+(B261), (A)+(B243)+(B262), (A)+(B243)+(B263), (A)+(B243)+(B264), (A)+(B243)+(B265), (A)+(B243)+(B266), (A)+(B243)+(B267), (A)+(B243)+(B268), (A)+(B243)+(B269), (A)+(B243)+(B270), (A)+(B243)+(B271), (A)+(B243)+(B272), (A)+(B243)+(B273), (A)+(B243)+(B274), (A)+(B243)+(B275), (A)+(B243)+(B276), (A)+(B243)+(B277), (A)+(B243)+(B278), (A)+(B243)+(B279), (A)+(B243)+(B280), (A)+(B243)+(B281), (A)+(B243)+(B282), (A)+(B243)+(B283), (A)+(B243)+(B284), (A)+(B243)+(B285), (A)+(B243)+(B286), (A)+(B243)+(B287), (A)+(B243)+(B288), (A)+(B243)+(B289), (A)+(B243)+(B290), (A)+(B243)+(B291), (A)+(B243)+(B292), (A)+(B243)+(B293), (A)+(B243)+(B294), (A)+(B243)+(B295), (A)+(B243)+(B296), (A)+(B243)+(B297), (A)+(B243)+(B298), (A)+(B243)+(B299), (A)+(B243)+(B300), (A)+(B243)+(B301), (A)+(B243)+(B302), (A)+(B243)+(B303), (A)+(B243)+(B304), (A)+(B243)+(B305), (A)+(B243)+(B306), (A)+(B243)+(B307), (A)+(B243)+(B308), (A)+(B243)+(B309), (A)+(B243)+(B310), (A)+(B243)+(B311), (A)+(B243)+(B312), (A)+(B243)+(B313), (A)+(B243)+(B314), (A)+(B243)+(B315),

(A)+(B244)+(B245), (A)+(B244)+(B246), (A)+(B244)+(B247), (A)+(B244)+(B248), (A)+(B244)+(B249), (A)+(B244)+(B250), (A)+(B244)+(B251), (A)+(B244)+(B252), (A)+(B244)+(B253), (A)+(B244)+(B254), (A)+(B244)+(B255), (A)+(B244)+(B256), (A)+(B244)+(B257), (A)+(B244)+(B258), (A)+(B244)+(B259), (A)+(B244)+(B260), (A)+(B244)+(B261), (A)+(B244)+(B262), (A)+(B244)+(B263), (A)+(B244)+(B264), (A)+(B244)+(B265), (A)+(B244)+(B266), (A)+(B244)+(B267), (A)+(B244)+(B268), (A)+(B244)+(B269), (A)+(B244)+(B270), (A)+(B244)+(B271), (A)+(B244)+(B272), (A)+(B244)+(B273), (A)+(B244)+(B274), (A)+(B244)+(B275), (A)+(B244)+(B276), (A)+(B244)+(B277), (A)+(B244)+(B278), (A)+(B244)+(B279), (A)+(B244)+(B280), (A)+(B244)+(B281), (A)+(B244)+(B282), (A)+(B244)+(B283), (A)+(B244)+(B284), (A)+(B244)+(B285), (A)+(B244)+(B286), (A)+(B244)+(B287), (A)+(B244)+(B288), (A)+(B244)+(B289), (A)+(B244)+(B290), (A)+(B244)+(B291), (A)+(B244)+(B292), (A)+(B244)+(B293), (A)+(B244)+(B294), (A)+(B244)+(B295), (A)+(B244)+(B296), (A)+(B244)+(B297), (A)+(B244)+(B298), (A)+(B244)+(B299), (A)+(B244)+(B300), (A)+(B244)+(B301), (A)+(B244)+(B302), (A)+(B244)+(B303), (A)+(B244)+(B304), (A)+(B244)+(B305), (A)+(B244)+(B306), (A)+(B244)+(B307), (A)+(B244)+(B308), (A)+(B244)+(B309), (A)+(B244)+(B310), (A)+(B244)+(B311), (A)+(B244)+(B312), (A)+(B244)+(B313), (A)+(B244)+(B314), (A)+(B244)+(B315),

(A)+(B245)+(B246), (A)+(B245)+(B247), (A)+(B245)+(B248), (A)+(B245)+(B249), (A)+(B245)+(B250), (A)+(B245)+(B251), (A)+(B245)+(B252), (A)+(B245)+(B253), (A)+(B245)+(B254), (A)+(B245)+(B255), (A)+(B245)+(B256), (A)+(B245)+(B257), (A)+(B245)+(B258), (A)+(B245)+(B259), (A)+(B245)+(B260), (A)+(B245)+(B261), (A)+(B245)+(B262), (A)+(B245)+(B263), (A)+(B245)+(B264), (A)+(B245)+(B265), (A)+(B245)+(B266), (A)+(B245)+(B267), (A)+(B245)+(B268), (A)+(B245)+(B269), (A)+(B245)+(B270), (A)+(B245)+(B271), (A)+(B245)+(B272), (A)+(B245)+(B273), (A)+(B245)+(B274), (A)+(B245)+(B275), (A)+(B245)+(B276), (A)+(B245)+(B277), (A)+(B245)+(B278), (A)+(B245)+(B279), (A)+(B245)+(B280), (A)+(B245)+(B281), (A)+(B245)+(B282), (A)+(B245)+(B283), (A)+(B245)+(B284), (A)+(B245)+(B285), (A)+(B245)+(B286), (A)+(B245)+(B287), (A)+(B245)+(B288), (A)+(B245)+(B289), (A)+(B245)+(B290), (A)+(B245)+(B291), (A)+(B245)+(B292), (A)+(B245)+(B293), (A)+(B245)+(B294), (A)+(B245)+(B295), (A)+(B245)+(B296), (A)+(B245)+(B297), (A)+(B245)+(B298), (A)+(B245)+(B299), (A)+(B245)+(B300), (A)+(B245)+(B301), (A)+(B245)+(B302), (A)+(B245)+(B303), (A)+(B245)+(B304), (A)+(B245)+(B305), (A)+(B245)+(B306), (A)+(B245)+(B307), (A)+(B245)+(B308), (A)+(B245)+(B309), (A)+(B245)+(B310), (A)+(B245)+(B311), (A)+(B245)+(B312), (A)+(B245)+(B313), (A)+(B245)+(B314), (A)+(B245)+(B315),

(A)+(B246)+(B247), (A)+(B246)+(B248), (A)+(B246)+(B249), (A)+(B246)+(B250), (A)+(B246)+(B251), (A)+(B246)+(B252), (A)+(B246)+(B253), (A)+(B246)+(B254), (A)+(B246)+(B255), (A)+(B246)+(B256), (A)+(B246)+(B257), (A)+(B246)+(B258), (A)+(B246)+(B259), (A)+(B246)+(B260), (A)+(B246)+(B261), (A)+(B246)+(B262), (A)+(B246)+(B263), (A)+(B246)+(B264), (A)+(B246)+(B265), (A)+(B246)+(B266), (A)+(B246)+(B267), (A)+(B246)+(B268), (A)+(B246)+(B269), (A)+(B246)+(B270), (A)+(B246)+(B271), (A)+(B246)+(B272), (A)+(B246)+(B273), (A)+(B246)+(B274), (A)+(B246)+(B275), (A)+(B246)+(B276), (A)+(B246)+(B277), (A)+(B246)+(B278), (A)+(B246)+(B279), (A)+(B246)+(B280), (A)+(B246)+(B281), (A)+(B246)+(B282), (A)+(B246)+(B283), (A)+(B246)+(B284), (A)+(B246)+(B285), (A)+(B246)+(B286), (A)+(B246)+(B287), (A)+(B246)+(B288), (A)+(B246)+(B289), (A)+(B246)+(B290), (A)+(B246)+(B291), (A)+(B246)+(B292), (A)+(B246)+(B293), (A)+(B246)+(B294), (A)+(B246)+(B295), (A)+(B246)+(B296), (A)+(B246)+(B297), (A)+(B246)+(B298), (A)+(B246)+(B299), (A)+(B246)+(B300), (A)+(B246)+(B301), (A)+(B246)+(B302), (A)+(B246)+(B303), (A)+(B246)+(B304), (A)+(B246)+(B305), (A)+(B246)+(B306), (A)+(B246)+(B307), (A)+(B246)+(B308), (A)+(B246)+(B309), (A)+(B246)+(B310), (A)+(B246)+(B311), (A)+(B246)+(B312), (A)+(B246)+(B313), (A)+(B246)+(B314), (A)+(B246)+(B315),

(A)+(B247)+(B248), (A)+(B247)+(B249), (A)+(B247)+(B250), (A)+(B247)+(B251), (A)+(B247)+(B252), (A)+(B247)+(B253), (A)+(B247)+(B254), (A)+(B247)+(B255), (A)+(B247)+(B256), (A)+(B247)+(B257), (A)+(B247)+(B258), (A)+(B247)+(B259), (A)+(B247)+(B260), (A)+(B247)+(B261), (A)+(B247)+(B262), (A)+(B247)+(B263), (A)+(B247)+(B264), (A)+(B247)+(B265), (A)+(B247)+(B266), (A)+(B247)+(B267), (A)+(B247)+(B268), (A)+(B247)+(B269), (A)+(B247)+(B270), (A)+(B247)+(B271), (A)+(B247)+(B272), (A)+(B247)+(B273), (A)+(B247)+(B274), (A)+(B247)+(B275), (A)+(B247)+(B276), (A)+(B247)+(B277), (A)+(B247)+(B278), (A)+(B247)+(B279), (A)+(B247)+(B280), (A)+(B247)+(B281), (A)+(B247)+(B282), (A)+(B247)+(B283), (A)+(B247)+(B284), (A)+(B247)+(B285), (A)+(B247)+(B286), (A)+(B247)+(B287), (A)+(B247)+(B288), (A)+(B247)+(B289), (A)+(B247)+(B290), (A)+(B247)+(B291), (A)+(B247)+(B292), (A)+(B247)+(B293), (A)+(B247)+(B294), (A)+(B247)+(B295), (A)+(B247)+(B296), (A)+(B247)+(B297), (A)+(B247)+(B298), (A)+(B247)+(B299), (A)+(B247)+(B300), (A)+(B247)+(B301), (A)+(B247)+(B302), (A)+(B247)+(B303), (A)+(B247)+(B304), (A)+(B247)+(B305), (A)+(B247)+(B306), (A)+(B247)+(B307), (A)+(B247)+(B308), (A)+(B247)+(B309), (A)+(B247)+(B310), (A)+(B247)+(B311), (A)+(B247)+(B312), (A)+(B247)+(B313), (A)+(B247)+(B314), (A)+(B247)+(B315),

(A)+(B248)+(B249), (A)+(B248)+(B250), (A)+(B248)+(B251), (A)+(B248)+(B252), (A)+(B248)+(B253), (A)+(B248)+(B254), (A)+(B248)+(B255), (A)+(B248)+(B256), (A)+(B248)+(B257), (A)+(B248)+(B258), (A)+(B248)+(B259), (A)+(B248)+(B260), (A)+(B248)+(B261), (A)+(B248)+(B262), (A)+(B248)+(B263), (A)+(B248)+(B264), (A)+(B248)+(B265), (A)+(B248)+(B266), (A)+(B248)+(B267), (A)+(B248)+(B268), (A)+(B248)+(B269), (A)+(B248)+(B270), (A)+(B248)+(B271), (A)+(B248)+(B272), (A)+(B248)+(B273), (A)+(B248)+(B274), (A)+(B248)+(B275), (A)+(B248)+(B276), (A)+(B248)+(B277), (A)+(B248)+(B278), (A)+(B248)+(B279), (A)+(B248)+(B280), (A)+(B248)+(B281), (A)+(B248)+(B282), (A)+(B248)+(B283), (A)+(B248)+(B284), (A)+(B248)+(B285), (A)+(B248)+(B286), (A)+(B248)+(B287), (A)+(B248)+(B288), (A)+(B248)+(B289), (A)+(B248)+(B290), (A)+(B248)+(B291), (A)+(B248)+(B292), (A)+(B248)+(B293), (A)+(B248)+(B294), (A)+(B248)+(B295), (A)+(B248)+(B296), (A)+(B248)+(B297), (A)+(B248)+(B298), (A)+(B248)+(B299), (A)+(B248)+(B300), (A)+(B248)+(B301), (A)+(B248)+(B302), (A)+(B248)+(B303), (A)+(B248)+(B304), (A)+(B248)+(B305), (A)+(B248)+(B306), (A)+(B248)+(B307), (A)+(B248)+(B308), (A)+(B248)+(B309), (A)+(B248)+(B310), (A)+(B248)+(B311), (A)+(B248)+(B312), (A)+(B248)+(B313), (A)+(B248)+(B314), (A)+(B248)+(B315),

(A)+(B249)+(B250), (A)+(B249)+(B251), (A)+(B249)+(B252), (A)+(B249)+(B253), (A)+(B249)+(B254), (A)+(B249)+(B255), (A)+(B249)+(B256), (A)+(B249)+(B257), (A)+(B249)+(B258), (A)+(B249)+(B259), (A)+(B249)+(B260), (A)+(B249)+(B261), (A)+(B249)+(B262), (A)+(B249)+(B263), (A)+(B249)+(B264), (A)+(B249)+(B265), (A)+(B249)+(B266), (A)+(B249)+(B267), (A)+(B249)+(B268), (A)+(B249)+(B269), (A)+(B249)+(B270), (A)+(B249)+(B271), (A)+(B249)+(B272), (A)+(B249)+(B273), (A)+(B249)+(B274), (A)+(B249)+(B275), (A)+(B249)+(B276), (A)+(B249)+(B277), (A)+(B249)+(B278), (A)+(B249)+(B279), (A)+(B249)+(B280), (A)+(B249)+(B281), (A)+(B249)+(B282), (A)+(B249)+(B283), (A)+(B249)+(B284), (A)+(B249)+(B285), (A)+(B249)+(B286), (A)+(B249)+(B287), (A)+(B249)+(B288), (A)+(B249)+(B289), (A)+(B249)+(B290), (A)+(B249)+(B291), (A)+(B249)+(B292), (A)+(B249)+(B293), (A)+(B249)+(B294), (A)+(B249)+(B295), (A)+(B249)+(B296), (A)+(B249)+(B297), (A)+(B249)+(B298), (A)+(B249)+(B299), (A)+(B249)+(B300), (A)+(B249)+(B301), (A)+(B249)+(B302), (A)+(B249)+(B303), (A)+(B249)+(B304), (A)+(B249)+(B305), (A)+(B249)+(B306), (A)+(B249)+(B307), (A)+(B249)+(B308), (A)+(B249)+(B309), (A)+(B249)+(B310), (A)+(B249)+(B311), (A)+(B249)+(B312), (A)+(B249)+(B313), (A)+(B249)+(B314), (A)+(B249)+(B315),

(A)+(B250)+(B251), (A)+(B250)+(B252), (A)+(B250)+(B253), (A)+(B250)+(B254), (A)+(B250)+(B255), (A)+(B250)+(B256), (A)+(B250)+(B257), (A)+(B250)+(B258), (A)+(B250)+(B259), (A)+(B250)+(B260), (A)+(B250)+(B261), (A)+(B250)+(B262), (A)+(B250)+(B263), (A)+(B250)+(B264), (A)+(B250)+(B265), (A)+(B250)+(B266), (A)+(B250)+(B267), (A)+(B250)+(B268), (A)+(B250)+(B269), (A)+(B250)+(B270), (A)+(B250)+(B271), (A)+(B250)+(B272), (A)+(B250)+(B273), (A)+(B250)+(B274), (A)+(B250)+(B275), (A)+(B250)+(B276), (A)+(B250)+(B277), (A)+(B250)+(B278), (A)+(B250)+(B279), (A)+(B250)+(B280), (A)+(B250)+(B281), (A)+(B250)+(B282), (A)+(B250)+(B283), (A)+(B250)+(B284), (A)+(B250)+(B285), (A)+(B250)+(B286), (A)+(B250)+(B287), (A)+(B250)+(B288), (A)+(B250)+(B289), (A)+(B250)+(B290), (A)+(B250)+(B291), (A)+(B250)+(B292), (A)+(B250)+(B293), (A)+(B250)+(B294), (A)+(B250)+(B295), (A)+(B250)+(B296), (A)+(B250)+(B297), (A)+(B250)+(B298), (A)+(B250)+(B299), (A)+(B250)+(B300), (A)+(B250)+(B301), (A)+(B250)+(B302), (A)+(B250)+(B303), (A)+(B250)+(B304), (A)+(B250)+(B305), (A)+(B250)+(B306), (A)+(B250)+(B307), (A)+(B250)+(B308), (A)+(B250)+(B309), (A)+(B250)+(B310), (A)+(B250)+(B311), (A)+(B250)+(B312), (A)+(B250)+(B313), (A)+(B250)+(B314), (A)+(B250)+(B315),

(A)+(B251)+(B252), (A)+(B251)+(B253), (A)+(B251)+(B254), (A)+(B251)+(B255), (A)+(B251)+(B256), (A)+(B251)+(B257), (A)+(B251)+(B258), (A)+(B251)+(B259), (A)+(B251)+(B260), (A)+(B251)+(B261), (A)+(B251)+(B262), (A)+(B251)+(B263), (A)+(B251)+(B264), (A)+(B251)+(B265), (A)+(B251)+(B266), (A)+(B251)+(B267), (A)+(B251)+(B268), (A)+(B251)+(B269), (A)+(B251)+(B270), (A)+(B251)+(B271), (A)+(B251)+(B272), (A)+(B251)+(B273), (A)+(B251)+(B274), (A)+(B251)+(B275), (A)+(B251)+(B276), (A)+(B251)+(B277), (A)+(B251)+(B278), (A)+(B251)+(B279), (A)+(B251)+(B280), (A)+(B251)+(B281), (A)+(B251)+(B282), (A)+(B251)+(B283), (A)+(B251)+(B284), (A)+(B251)+(B285), (A)+(B251)+(B286), (A)+(B251)+(B287), (A)+(B251)+(B288), (A)+(B251)+(B289), (A)+(B251)+(B290), (A)+(B251)+(B291), (A)+(B251)+(B292), (A)+(B251)+(B293), (A)+(B251)+(B294), (A)+(B251)+(B295), (A)+(B251)+(B296), (A)+(B251)+(B297), (A)+(B251)+(B298), (A)+(B251)+(B299), (A)+(B251)+(B300), (A)+(B251)+(B301), (A)+(B251)+(B302), (A)+(B251)+(B303), (A)+(B251)+(B304), (A)+(B251)+(B305), (A)+(B251)+(B306), (A)+(B251)+(B307), (A)+(B251)+(B308), (A)+(B251)+(B309), (A)+(B251)+(B310), (A)+(B251)+(B311), (A)+(B251)+(B312), (A)+(B251)+(B313), (A)+(B251)+(B314), (A)+(B251)+(B315),

(A)+(B252)+(B253), (A)+(B252)+(B254), (A)+(B252)+(B255), (A)+(B252)+(B256), (A)+(B252)+(B257), (A)+(B252)+(B258), (A)+(B252)+(B259), (A)+(B252)+(B260), (A)+(B252)+(B261), (A)+(B252)+(B262), (A)+(B252)+(B263), (A)+(B252)+(B264), (A)+(B252)+(B265), (A)+(B252)+(B266), (A)+(B252)+(B267), (A)+(B252)+(B268), (A)+(B252)+(B269), (A)+(B252)+(B270), (A)+(B252)+(B271), (A)+(B252)+(B272), (A)+(B252)+(B273), (A)+(B252)+(B274), (A)+(B252)+(B275), (A)+(B252)+(B276), (A)+(B252)+(B277), (A)+(B252)+(B278), (A)+(B252)+(B279), (A)+(B252)+(B280), (A)+(B252)+(B281), (A)+(B252)+(B282), (A)+(B252)+(B283), (A)+(B252)+(B284), (A)+(B252)+(B285), (A)+(B252)+(B286), (A)+(B252)+(B287), (A)+(B252)+(B288), (A)+(B252)+(B289), (A)+(B252)+(B290), (A)+(B252)+(B291), (A)+(B252)+(B292), (A)+(B252)+(B293), (A)+(B252)+(B294), (A)+(B252)+(B295), (A)+(B252)+(B296), (A)+(B252)+(B297), (A)+(B252)+(B298), (A)+(B252)+(B299), (A)+(B252)+(B300), (A)+(B252)+(B301), (A)+(B252)+(B302), (A)+(B252)+(B303), (A)+(B252)+(B304), (A)+(B252)+(B305), (A)+(B252)+(B306), (A)+(B252)+(B307), (A)+(B252)+(B308), (A)+(B252)+(B309), (A)+(B252)+(B310), (A)+(B252)+(B311), (A)+(B252)+(B312), (A)+(B252)+(B313), (A)+(B252)+(B314), (A)+(B252)+(B315),

(A)+(B253)+(B254), (A)+(B253)+(B255), (A)+(B253)+(B256), (A)+(B253)+(B257), (A)+(B253)+(B258), (A)+(B253)+(B259), (A)+(B253)+(B260), (A)+(B253)+(B261), (A)+(B253)+(B262), (A)+(B253)+(B263), (A)+(B253)+(B264), (A)+(B253)+(B265), (A)+(B253)+(B266), (A)+(B253)+(B267), (A)+(B253)+(B268), (A)+(B253)+(B269), (A)+(B253)+(B270), (A)+(B253)+(B271), (A)+(B253)+(B272), (A)+(B253)+(B273), (A)+(B253)+(B274), (A)+(B253)+(B275), (A)+(B253)+(B276), (A)+(B253)+(B277), (A)+(B253)+(B278), (A)+(B253)+(B279), (A)+(B253)+(B280), (A)+(B253)+(B281), (A)+(B253)+(B282), (A)+(B253)+(B283), (A)+(B253)+(B284), (A)+(B253)+(B285), (A)+(B253)+(B286), (A)+(B253)+(B287), (A)+(B253)+(B288), (A)+(B253)+(B289), (A)+(B253)+(B290), (A)+(B253)+(B291), (A)+(B253)+(B292), (A)+(B253)+(B293), (A)+(B253)+(B294), (A)+(B253)+(B295), (A)+(B253)+(B296), (A)+(B253)+(B297), (A)+(B253)+(B298), (A)+(B253)+(B299), (A)+(B253)+(B300), (A)+(B253)+(B301), (A)+(B253)+(B302), (A)+(B253)+(B303), (A)+(B253)+(B304), (A)+(B253)+(B305), (A)+(B253)+(B306), (A)+(B253)+(B307), (A)+(B253)+(B308), (A)+(B253)+(B309), (A)+(B253)+(B310), (A)+(B253)+(B311), (A)+(B253)+(B312), (A)+(B253)+(B313), (A)+(B253)+(B314), (A)+(B253)+(B315),

(A)+(B254)+(B255), (A)+(B254)+(B256), (A)+(B254)+(B257), (A)+(B254)+(B258), (A)+(B254)+(B259), (A)+(B254)+(B260), (A)+(B254)+(B261), (A)+(B254)+(B262), (A)+(B254)+(B263), (A)+(B254)+(B264), (A)+(B254)+(B265), (A)+(B254)+(B266), (A)+(B254)+(B267), (A)+(B254)+(B268), (A)+(B254)+(B269), (A)+(B254)+(B270), (A)+(B254)+(B271), (A)+(B254)+(B272), (A)+(B254)+(B273), (A)+(B254)+(B274), (A)+(B254)+(B275), (A)+(B254)+(B276), (A)+(B254)+(B277), (A)+(B254)+(B278), (A)+(B254)+(B279), (A)+(B254)+(B280), (A)+(B254)+(B281), (A)+(B254)+(B282), (A)+(B254)+(B283), (A)+(B254)+(B284), (A)+(B254)+(B285), (A)+(B254)+(B286), (A)+(B254)+(B287), (A)+(B254)+(B288), (A)+(B254)+(B289), (A)+(B254)+(B290), (A)+(B254)+(B291), (A)+(B254)+(B292), (A)+(B254)+(B293), (A)+(B254)+(B294), (A)+(B254)+(B295), (A)+(B254)+(B296), (A)+(B254)+(B297), (A)+(B254)+(B298), (A)+(B254)+(B299), (A)+(B254)+(B300), (A)+(B254)+(B301), (A)+(B254)+(B302), (A)+(B254)+(B303), (A)+(B254)+(B304), (A)+(B254)+(B305), (A)+(B254)+(B306), (A)+(B254)+(B307), (A)+(B254)+(B308), (A)+(B254)+(B309), (A)+(B254)+(B310), (A)+(B254)+(B311), (A)+(B254)+(B312), (A)+(B254)+(B313), (A)+(B254)+(B314), (A)+(B254)+(B315),

(A)+(B255)+(B256), (A)+(B255)+(B257), (A)+(B255)+(B258), (A)+(B255)+(B259), (A)+(B255)+(B260), (A)+(B255)+(B261), (A)+(B255)+(B262), (A)+(B255)+(B263), (A)+(B255)+(B264), (A)+(B255)+(B265), (A)+(B255)+(B266), (A)+(B255)+(B267), (A)+(B255)+(B268), (A)+(B255)+(B269), (A)+(B255)+(B270), (A)+(B255)+(B271), (A)+(B255)+(B272), (A)+(B255)+(B273), (A)+(B255)+(B274), (A)+(B255)+(B275), (A)+(B255)+(B276), (A)+(B255)+(B277), (A)+(B255)+(B278), (A)+(B255)+(B279), (A)+(B255)+(B280), (A)+(B255)+(B281), (A)+(B255)+(B282), (A)+(B255)+(B283), (A)+(B255)+(B284), (A)+(B255)+(B285), (A)+(B255)+(B286), (A)+(B255)+(B287), (A)+(B255)+(B288), (A)+(B255)+(B289), (A)+(B255)+(B290), (A)+(B255)+(B291), (A)+(B255)+(B292), (A)+(B255)+(B293), (A)+(B255)+(B294), (A)+(B255)+(B295), (A)+(B255)+(B296), (A)+(B255)+(B297), (A)+(B255)+(B298), (A)+(B255)+(B299), (A)+(B255)+(B300), (A)+(B255)+(B301), (A)+(B255)+(B302), (A)+(B255)+(B303), (A)+(B255)+(B304), (A)+(B255)+(B305), (A)+(B255)+(B306), (A)+(B255)+(B307), (A)+(B255)+(B308), (A)+(B255)+(B309), (A)+(B255)+(B310), (A)+(B255)+(B311), (A)+(B255)+(B312), (A)+(B255)+(B313), (A)+(B255)+(B314), (A)+(B255)+(B315),

(A)+(B256)+(B257), (A)+(B256)+(B258), (A)+(B256)+(B259), (A)+(B256)+(B260), (A)+(B256)+(B261), (A)+(B256)+(B262), (A)+(B256)+(B263), (A)+(B256)+(B264), (A)+(B256)+(B265), (A)+(B256)+(B266), (A)+(B256)+(B267), (A)+(B256)+(B268), (A)+(B256)+(B269), (A)+(B256)+(B270), (A)+(B256)+(B271), (A)+(B256)+(B272), (A)+(B256)+(B273), (A)+(B256)+(B274), (A)+(B256)+(B275), (A)+(B256)+(B276), (A)+(B256)+(B277), (A)+(B256)+(B278), (A)+(B256)+(B279), (A)+(B256)+(B280), (A)+(B256)+(B281), (A)+(B256)+(B282), (A)+(B256)+(B283), (A)+(B256)+(B284), (A)+(B256)+(B285), (A)+(B256)+(B286), (A)+(B256)+(B287), (A)+(B256)+(B288), (A)+(B256)+(B289), (A)+(B256)+(B290), (A)+(B256)+(B291), (A)+(B256)+(B292), (A)+(B256)+(B293), (A)+(B256)+(B294), (A)+(B256)+(B295), (A)+(B256)+(B296), (A)+(B256)+(B297), (A)+(B256)+(B298), (A)+(B256)+(B299), (A)+(B256)+(B300), (A)+(B256)+(B301), (A)+(B256)+(B302), (A)+(B256)+(B303), (A)+(B256)+(B304), (A)+(B256)+(B305), (A)+(B256)+(B306), (A)+(B256)+(B307), (A)+(B256)+(B308), (A)+(B256)+(B309), (A)+(B256)+(B310), (A)+(B256)+(B311), (A)+(B256)+(B312), (A)+(B256)+(B313), (A)+(B256)+(B314), (A)+(B256)+(B315),

(A)+(B257)+(B258), (A)+(B257)+(B259), (A)+(B257)+(B260), (A)+(B257)+(B261), (A)+(B257)+(B262), (A)+(B257)+(B263), (A)+(B257)+(B264), (A)+(B257)+(B265), (A)+(B257)+(B266), (A)+(B257)+(B267), (A)+(B257)+(B268), (A)+(B257)+(B269), (A)+(B257)+(B270), (A)+(B257)+(B271), (A)+(B257)+(B272), (A)+(B257)+(B273), (A)+(B257)+(B274), (A)+(B257)+(B275), (A)+(B257)+(B276), (A)+(B257)+(B277), (A)+(B257)+(B278), (A)+(B257)+(B279), (A)+(B257)+(B280), (A)+(B257)+(B281), (A)+(B257)+(B282), (A)+(B257)+(B283), (A)+(B257)+(B284), (A)+(B257)+(B285), (A)+(B257)+(B286), (A)+(B257)+(B287), (A)+(B257)+(B288), (A)+(B257)+(B289), (A)+(B257)+(B290), (A)+(B257)+(B291), (A)+(B257)+(B292), (A)+(B257)+(B293), (A)+(B257)+(B294), (A)+(B257)+(B295), (A)+(B257)+(B296), (A)+(B257)+(B297), (A)+(B257)+(B298), (A)+(B257)+(B299), (A)+(B257)+(B300), (A)+(B257)+(B301), (A)+(B257)+(B302), (A)+(B257)+(B303), (A)+(B257)+(B304), (A)+(B257)+(B305), (A)+(B257)+(B306), (A)+(B257)+(B307), (A)+(B257)+(B308), (A)+(B257)+(B309), (A)+(B257)+(B310), (A)+(B257)+(B311), (A)+(B257)+(B312), (A)+(B257)+(B313), (A)+(B257)+(B314), (A)+(B257)+(B315),

(A)+(B258)+(B259), (A)+(B258)+(B260), (A)+(B258)+(B261), (A)+(B258)+(B262), (A)+(B258)+(B263), (A)+(B258)+(B264), (A)+(B258)+(B265), (A)+(B258)+(B266), (A)+(B258)+(B267), (A)+(B258)+(B268), (A)+(B258)+(B269), (A)+(B258)+(B270), (A)+(B258)+(B271), (A)+(B258)+(B272), (A)+(B258)+(B273), (A)+(B258)+(B274), (A)+(B258)+(B275), (A)+(B258)+(B276), (A)+(B258)+(B277), (A)+(B258)+(B278), (A)+(B258)+(B279), (A)+(B258)+(B280), (A)+(B258)+(B281), (A)+(B258)+(B282), (A)+(B258)+(B283), (A)+(B258)+(B284), (A)+(B258)+(B285), (A)+(B258)+(B286), (A)+(B258)+(B287), (A)+(B258)+(B288), (A)+(B258)+(B289), (A)+(B258)+(B290), (A)+(B258)+(B291), (A)+(B258)+(B292), (A)+(B258)+(B293), (A)+(B258)+(B294), (A)+(B258)+(B295), (A)+(B258)+(B296), (A)+(B258)+(B297), (A)+(B258)+(B298), (A)+(B258)+(B299), (A)+(B258)+(B300), (A)+(B258)+(B301), (A)+(B258)+(B302), (A)+(B258)+(B303), (A)+(B258)+(B304), (A)+(B258)+(B305), (A)+(B258)+(B306), (A)+(B258)+(B307), (A)+(B258)+(B308), (A)+(B258)+(B309), (A)+(B258)+(B310), (A)+(B258)+(B311), (A)+(B258)+(B312), (A)+(B258)+(B313), (A)+(B258)+(B314), (A)+(B258)+(B315),

(A)+(B259)+(B260), (A)+(B259)+(B261), (A)+(B259)+(B262), (A)+(B259)+(B263), (A)+(B259)+(B264), (A)+(B259)+(B265), (A)+(B259)+(B266), (A)+(B259)+(B267), (A)+(B259)+(B268), (A)+(B259)+(B269), (A)+(B259)+(B270), (A)+(B259)+(B271), (A)+(B259)+(B272), (A)+(B259)+(B273), (A)+(B259)+(B274), (A)+(B259)+(B275), (A)+(B259)+(B276), (A)+(B259)+(B277), (A)+(B259)+(B278), (A)+(B259)+(B279), (A)+(B259)+(B280), (A)+(B259)+(B281), (A)+(B259)+(B282), (A)+(B259)+(B283), (A)+(B259)+(B284), (A)+(B259)+(B285), (A)+(B259)+(B286), (A)+(B259)+(B287), (A)+(B259)+(B288), (A)+(B259)+(B289), (A)+(B259)+(B290), (A)+(B259)+(B291), (A)+(B259)+(B292), (A)+(B259)+(B293), (A)+(B259)+(B294), (A)+(B259)+(B295), (A)+(B259)+(B296), (A)+(B259)+(B297), (A)+(B259)+(B298), (A)+(B259)+(B299), (A)+(B259)+(B300), (A)+(B259)+(B301), (A)+(B259)+(B302), (A)+(B259)+(B303), (A)+(B259)+(B304), (A)+(B259)+(B305), (A)+(B259)+(B306), (A)+(B259)+(B307), (A)+(B259)+(B308), (A)+(B259)+(B309), (A)+(B259)+(B310), (A)+(B259)+(B311), (A)+(B259)+(B312), (A)+(B259)+(B313), (A)+(B259)+(B314), (A)+(B259)+(B315),

(A)+(B260)+(B261), (A)+(B260)+(B262), (A)+(B260)+(B263), (A)+(B260)+(B264), (A)+(B260)+(B265), (A)+(B260)+(B266), (A)+(B260)+(B267), (A)+(B260)+(B268), (A)+(B260)+(B269), (A)+(B260)+(B270), (A)+(B260)+(B271), (A)+(B260)+(B272), (A)+(B260)+(B273), (A)+(B260)+(B274), (A)+(B260)+(B275), (A)+(B260)+(B276), (A)+(B260)+(B277), (A)+(B260)+(B278), (A)+(B260)+(B279), (A)+(B260)+(B280), (A)+(B260)+(B281), (A)+(B260)+(B282), (A)+(B260)+(B283), (A)+(B260)+(B284), (A)+(B260)+(B285), (A)+(B260)+(B286), (A)+(B260)+(B287), (A)+(B260)+(B288), (A)+(B260)+(B289), (A)+(B260)+(B290), (A)+(B260)+(B291), (A)+(B260)+(B292), (A)+(B260)+(B293), (A)+(B260)+(B294), (A)+(B260)+(B295), (A)+(B260)+(B296), (A)+(B260)+(B297), (A)+(B260)+(B298), (A)+(B260)+(B299), (A)+(B260)+(B300), (A)+(B260)+(B301), (A)+(B260)+(B302), (A)+(B260)+(B303), (A)+(B260)+(B304), (A)+(B260)+(B305), (A)+(B260)+(B306), (A)+(B260)+(B307), (A)+(B260)+(B308), (A)+(B260)+(B309), (A)+(B260)+(B310), (A)+(B260)+(B311), (A)+(B260)+(B312), (A)+(B260)+(B313), (A)+(B260)+(B314), (A)+(B260)+(B315),

(A)+(B261)+(B262), (A)+(B261)+(B263), (A)+(B261)+(B264), (A)+(B261)+(B265), (A)+(B261)+(B266), (A)+(B261)+(B267), (A)+(B261)+(B268), (A)+(B261)+(B269), (A)+(B261)+(B270), (A)+(B261)+(B271), (A)+(B261)+(B272), (A)+(B261)+(B273), (A)+(B261)+(B274), (A)+(B261)+(B275), (A)+(B261)+(B276), (A)+(B261)+(B277), (A)+(B261)+(B278), (A)+(B261)+(B279), (A)+(B261)+(B280), (A)+(B261)+(B281), (A)+(B261)+(B282), (A)+(B261)+(B283), (A)+(B261)+(B284), (A)+(B261)+(B285), (A)+(B261)+(B286), (A)+(B261)+(B287), (A)+(B261)+(B288), (A)+(B261)+(B289), (A)+(B261)+(B290), (A)+(B261)+(B291), (A)+(B261)+(B292), (A)+(B261)+(B293), (A)+(B261)+(B294), (A)+(B261)+(B295), (A)+(B261)+(B296), (A)+(B261)+(B297), (A)+(B261)+(B298), (A)+(B261)+(B299), (A)+(B261)+(B300), (A)+(B261)+(B301), (A)+(B261)+(B302), (A)+(B261)+(B303), (A)+(B261)+(B304), (A)+(B261)+(B305), (A)+(B261)+(B306), (A)+(B261)+(B307), (A)+(B261)+(B308), (A)+(B261)+(B309), (A)+(B261)+(B310), (A)+(B261)+(B311), (A)+(B261)+(B312), (A)+(B261)+(B313), (A)+(B261)+(B314), (A)+(B261)+(B315),

(A)+(B262)+(B263), (A)+(B262)+(B264), (A)+(B262)+(B265), (A)+(B262)+(B266), (A)+(B262)+(B267), (A)+(B262)+(B268), (A)+(B262)+(B269), (A)+(B262)+(B270), (A)+(B262)+(B271), (A)+(B262)+(B272), (A)+(B262)+(B273), (A)+(B262)+(B274), (A)+(B262)+(B275), (A)+(B262)+(B276), (A)+(B262)+(B277), (A)+(B262)+(B278), (A)+(B262)+(B279), (A)+(B262)+(B280), (A)+(B262)+(B281), (A)+(B262)+(B282), (A)+(B262)+(B283), (A)+(B262)+(B284), (A)+(B262)+(B285), (A)+(B262)+(B286), (A)+(B262)+(B287), (A)+(B262)+(B288), (A)+(B262)+(B289), (A)+(B262)+(B290), (A)+(B262)+(B291), (A)+(B262)+(B292), (A)+(B262)+(B293), (A)+(B262)+(B294), (A)+(B262)+(B295), (A)+(B262)+(B296), (A)+(B262)+(B297), (A)+(B262)+(B298), (A)+(B262)+(B299), (A)+(B262)+(B300), (A)+(B262)+(B301), (A)+(B262)+(B302), (A)+(B262)+(B303), (A)+(B262)+(B304), (A)+(B262)+(B305), (A)+(B262)+(B306), (A)+(B262)+(B307), (A)+(B262)+(B308), (A)+(B262)+(B309), (A)+(B262)+(B310), (A)+(B262)+(B311), (A)+(B262)+(B312), (A)+(B262)+(B313), (A)+(B262)+(B314), (A)+(B262)+(B315),

(A)+(B263)+(B264), (A)+(B263)+(B265), (A)+(B263)+(B266), (A)+(B263)+(B267), (A)+(B263)+(B268), (A)+(B263)+(B269), (A)+(B263)+(B270), (A)+(B263)+(B271), (A)+(B263)+(B272), (A)+(B263)+(B273), (A)+(B263)+(B274), (A)+(B263)+(B275), (A)+(B263)+(B276), (A)+(B263)+(B277), (A)+(B263)+(B278), (A)+(B263)+(B279), (A)+(B263)+(B280), (A)+(B263)+(B281), (A)+(B263)+(B282), (A)+(B263)+(B283), (A)+(B263)+(B284), (A)+(B263)+(B285), (A)+(B263)+(B286), (A)+(B263)+(B287), (A)+(B263)+(B288), (A)+(B263)+(B289), (A)+(B263)+(B290), (A)+(B263)+(B291), (A)+(B263)+(B292), (A)+(B263)+(B293), (A)+(B263)+(B294), (A)+(B263)+(B295), (A)+(B263)+(B296), (A)+(B263)+(B297), (A)+(B263)+(B298), (A)+(B263)+(B299), (A)+(B263)+(B300), (A)+(B263)+(B301), (A)+(B263)+(B302), (A)+(B263)+(B303), (A)+(B263)+(B304), (A)+(B263)+(B305), (A)+(B263)+(B306), (A)+(B263)+(B307), (A)+(B263)+(B308), (A)+(B263)+(B309), (A)+(B263)+(B310), (A)+(B263)+(B311), (A)+(B263)+(B312), (A)+(B263)+(B313), (A)+(B263)+(B314), (A)+(B263)+(B315),

(A)+(B264)+(B265), (A)+(B264)+(B266), (A)+(B264)+(B267), (A)+(B264)+(B268), (A)+(B264)+(B269), (A)+(B264)+(B270), (A)+(B264)+(B271), (A)+(B264)+(B272), (A)+(B264)+(B273), (A)+(B264)+(B274), (A)+(B264)+(B275), (A)+(B264)+(B276), (A)+(B264)+(B277), (A)+(B264)+(B278), (A)+(B264)+(B279), (A)+(B264)+(B280), (A)+(B264)+(B281), (A)+(B264)+(B282), (A)+(B264)+(B283), (A)+(B264)+(B284), (A)+(B264)+(B285), (A)+(B264)+(B286), (A)+(B264)+(B287), (A)+(B264)+(B288), (A)+(B264)+(B289), (A)+(B264)+(B290), (A)+(B264)+(B291), (A)+(B264)+(B292), (A)+(B264)+(B293), (A)+(B264)+(B294), (A)+(B264)+(B295), (A)+(B264)+(B296), (A)+(B264)+(B297), (A)+(B264)+(B298), (A)+(B264)+(B299), (A)+(B264)+(B300), (A)+(B264)+(B301), (A)+(B264)+(B302), (A)+(B264)+(B303), (A)+(B264)+(B304), (A)+(B264)+(B305), (A)+(B264)+(B306), (A)+(B264)+(B307), (A)+(B264)+(B308), (A)+(B264)+(B309), (A)+(B264)+(B310), (A)+(B264)+(B311), (A)+(B264)+(B312), (A)+(B264)+(B313), (A)+(B264)+(B314), (A)+(B264)+(B315),

(A)+(B265)+(B266), (A)+(B265)+(B267), (A)+(B265)+(B268), (A)+(B265)+(B269), (A)+(B265)+(B270), (A)+(B265)+(B271), (A)+(B265)+(B272), (A)+(B265)+(B273), (A)+(B265)+(B274), (A)+(B265)+(B275), (A)+(B265)+(B276), (A)+(B265)+(B277), (A)+(B265)+(B278), (A)+(B265)+(B279), (A)+(B265)+(B280), (A)+(B265)+(B281), (A)+(B265)+(B282), (A)+(B265)+(B283), (A)+(B265)+(B284), (A)+(B265)+(B285), (A)+(B265)+(B286), (A)+(B265)+(B287), (A)+(B265)+(B288), (A)+(B265)+(B289), (A)+(B265)+(B290), (A)+(B265)+(B291), (A)+(B265)+(B292), (A)+(B265)+(B293), (A)+(B265)+(B294), (A)+(B265)+(B295), (A)+(B265)+(B296), (A)+(B265)+(B297), (A)+(B265)+(B298), (A)+(B265)+(B299), (A)+(B265)+(B300), (A)+(B265)+(B301), (A)+(B265)+(B302), (A)+(B265)+(B303), (A)+(B265)+(B304), (A)+(B265)+(B305), (A)+(B265)+(B306), (A)+(B265)+(B307), (A)+(B265)+(B308), (A)+(B265)+(B309), (A)+(B265)+(B310), (A)+(B265)+(B311), (A)+(B265)+(B312), (A)+(B265)+(B313), (A)+(B265)+(B314), (A)+(B265)+(B315),

(A)+(B266)+(B267), (A)+(B266)+(B268), (A)+(B266)+(B269), (A)+(B266)+(B270), (A)+(B266)+(B271), (A)+(B266)+(B272), (A)+(B266)+(B273), (A)+(B266)+(B274), (A)+(B266)+(B275), (A)+(B266)+(B276), (A)+(B266)+(B277), (A)+(B266)+(B278), (A)+(B266)+(B279), (A)+(B266)+(B280), (A)+(B266)+(B281), (A)+(B266)+(B282), (A)+(B266)+(B283), (A)+(B266)+(B284), (A)+(B266)+(B285), (A)+(B266)+(B286), (A)+(B266)+(B287), (A)+(B266)+(B288), (A)+(B266)+(B289), (A)+(B266)+(B290), (A)+(B266)+(B291), (A)+(B266)+(B292), (A)+(B266)+(B293), (A)+(B266)+(B294), (A)+(B266)+(B295), (A)+(B266)+(B296), (A)+(B266)+(B297), (A)+(B266)+(B298), (A)+(B266)+(B299), (A)+(B266)+(B300), (A)+(B266)+(B301), (A)+(B266)+(B302), (A)+(B266)+(B303), (A)+(B266)+(B304), (A)+(B266)+(B305), (A)+(B266)+(B306), (A)+(B266)+(B307), (A)+(B266)+(B308), (A)+(B266)+(B309), (A)+(B266)+(B310), (A)+(B266)+(B311), (A)+(B266)+(B312), (A)+(B266)+(B313), (A)+(B266)+(B314), (A)+(B266)+(B315),

(A)+(B267)+(B268), (A)+(B267)+(B269), (A)+(B267)+(B270), (A)+(B267)+(B271), (A)+(B267)+(B272), (A)+(B267)+(B273), (A)+(B267)+(B274), (A)+(B267)+(B275), (A)+(B267)+(B276), (A)+(B267)+(B277), (A)+(B267)+(B278), (A)+(B267)+(B279), (A)+(B267)+(B280), (A)+(B267)+(B281), (A)+(B267)+(B282), (A)+(B267)+(B283), (A)+(B267)+(B284), (A)+(B267)+(B285), (A)+(B267)+(B286), (A)+(B267)+(B287), (A)+(B267)+(B288), (A)+(B267)+(B289), (A)+(B267)+(B290), (A)+(B267)+(B291), (A)+(B267)+(B292), (A)+(B267)+(B293), (A)+(B267)+(B294), (A)+(B267)+(B295), (A)+(B267)+(B296), (A)+(B267)+(B297), (A)+(B267)+(B298), (A)+(B267)+(B299), (A)+(B267)+(B300), (A)+(B267)+(B301), (A)+(B267)+(B302), (A)+(B267)+(B303), (A)+(B267)+(B304), (A)+(B267)+(B305), (A)+(B267)+(B306), (A)+(B267)+(B307), (A)+(B267)+(B308), (A)+(B267)+(B309), (A)+(B267)+(B310), (A)+(B267)+(B311), (A)+(B267)+(B312), (A)+(B267)+(B313), (A)+(B267)+(B314), (A)+(B267)+(B315),

(A)+(B268)+(B269), (A)+(B268)+(B270), (A)+(B268)+(B271), (A)+(B268)+(B272), (A)+(B268)+(B273), (A)+(B268)+(B274), (A)+(B268)+(B275), (A)+(B268)+(B276), (A)+(B268)+(B277), (A)+(B268)+(B278), (A)+(B268)+(B279), (A)+(B268)+(B280), (A)+(B268)+(B281), (A)+(B268)+(B282), (A)+(B268)+(B283), (A)+(B268)+(B284), (A)+(B268)+(B285), (A)+(B268)+(B286), (A)+(B268)+(B287), (A)+(B268)+(B288), (A)+(B268)+(B289), (A)+(B268)+(B290), (A)+(B268)+(B291), (A)+(B268)+(B292), (A)+(B268)+(B293), (A)+(B268)+(B294), (A)+(B268)+(B295), (A)+(B268)+(B296), (A)+(B268)+(B297), (A)+(B268)+(B298), (A)+(B268)+(B299), (A)+(B268)+(B300), (A)+(B268)+(B301), (A)+(B268)+(B302), (A)+(B268)+(B303), (A)+(B268)+(B304), (A)+(B268)+(B305), (A)+(B268)+(B306), (A)+(B268)+(B307), (A)+(B268)+(B308), (A)+(B268)+(B309), (A)+(B268)+(B310), (A)+(B268)+(B311), (A)+(B268)+(B312), (A)+(B268)+(B313), (A)+(B268)+(B314), (A)+(B268)+(B315),

(A)+(B269)+(B270), (A)+(B269)+(B271), (A)+(B269)+(B272), (A)+(B269)+(B273), (A)+(B269)+(B274), (A)+(B269)+(B275), (A)+(B269)+(B276), (A)+(B269)+(B277), (A)+(B269)+(B278), (A)+(B269)+(B279), (A)+(B269)+(B280), (A)+(B269)+(B281), (A)+(B269)+(B282), (A)+(B269)+(B283), (A)+(B269)+(B284), (A)+(B269)+(B285), (A)+(B269)+(B286), (A)+(B269)+(B287), (A)+(B269)+(B288), (A)+(B269)+(B289), (A)+(B269)+(B290), (A)+(B269)+(B291), (A)+(B269)+(B292), (A)+(B269)+(B293), (A)+(B269)+(B294), (A)+(B269)+(B295), (A)+(B269)+(B296), (A)+(B269)+(B297), (A)+(B269)+(B298), (A)+(B269)+(B299), (A)+(B269)+(B300), (A)+(B269)+(B301), (A)+(B269)+(B302), (A)+(B269)+(B303), (A)+(B269)+(B304), (A)+(B269)+(B305), (A)+(B269)+(B306), (A)+(B269)+(B307), (A)+(B269)+(B308), (A)+(B269)+(B309), (A)+(B269)+(B310), (A)+(B269)+(B311), (A)+(B269)+(B312), (A)+(B269)+(B313), (A)+(B269)+(B314), (A)+(B269)+(B315),

(A)+(B270)+(B271), (A)+(B270)+(B272), (A)+(B270)+(B273), (A)+(B270)+(B274), (A)+(B270)+(B275), (A)+(B270)+(B276), (A)+(B270)+(B277), (A)+(B270)+(B278), (A)+(B270)+(B279), (A)+(B270)+(B280), (A)+(B270)+(B281), (A)+(B270)+(B282), (A)+(B270)+(B283), (A)+(B270)+(B284), (A)+(B270)+(B285), (A)+(B270)+(B286), (A)+(B270)+(B287), (A)+(B270)+(B288), (A)+(B270)+(B289), (A)+(B270)+(B290), (A)+(B270)+(B291), (A)+(B270)+(B292), (A)+(B270)+(B293), (A)+(B270)+(B294), (A)+(B270)+(B295), (A)+(B270)+(B296), (A)+(B270)+(B297), (A)+(B270)+(B298), (A)+(B270)+(B299), (A)+(B270)+(B300), (A)+(B270)+(B301), (A)+(B270)+(B302), (A)+(B270)+(B303), (A)+(B270)+(B304), (A)+(B270)+(B305), (A)+(B270)+(B306), (A)+(B270)+(B307), (A)+(B270)+(B308), (A)+(B270)+(B309), (A)+(B270)+(B310), (A)+(B270)+(B311), (A)+(B270)+(B312), (A)+(B270)+(B313), (A)+(B270)+(B314), (A)+(B270)+(B315),

(A)+(B271)+(B272), (A)+(B271)+(B273), (A)+(B271)+(B274), (A)+(B271)+(B275), (A)+(B271)+(B276), (A)+(B271)+(B277), (A)+(B271)+(B278), (A)+(B271)+(B279), (A)+(B271)+(B280), (A)+(B271)+(B281), (A)+(B271)+(B282), (A)+(B271)+(B283), (A)+(B271)+(B284), (A)+(B271)+(B285), (A)+(B271)+(B286), (A)+(B271)+(B287), (A)+(B271)+(B288), (A)+(B271)+(B289), (A)+(B271)+(B290), (A)+(B271)+(B291), (A)+(B271)+(B292), (A)+(B271)+(B293), (A)+(B271)+(B294), (A)+(B271)+(B295), (A)+(B271)+(B296), (A)+(B271)+(B297), (A)+(B271)+(B298), (A)+(B271)+(B299), (A)+(B271)+(B300), (A)+(B271)+(B301), (A)+(B271)+(B302), (A)+(B271)+(B303), (A)+(B271)+(B304), (A)+(B271)+(B305), (A)+(B271)+(B306), (A)+(B271)+(B307), (A)+(B271)+(B308), (A)+(B271)+(B309), (A)+(B271)+(B310), (A)+(B271)+(B311), (A)+(B271)+(B312), (A)+(B271)+(B313), (A)+(B271)+(B314), (A)+(B271)+(B315),

(A)+(B272)+(B273), (A)+(B272)+(B274), (A)+(B272)+(B275), (A)+(B272)+(B276), (A)+(B272)+(B277), (A)+(B272)+(B278), (A)+(B272)+(B279), (A)+(B272)+(B280), (A)+(B272)+(B281), (A)+(B272)+(B282), (A)+(B272)+(B283), (A)+(B272)+(B284), (A)+(B272)+(B285), (A)+(B272)+(B286), (A)+(B272)+(B287), (A)+(B272)+(B288), (A)+(B272)+(B289), (A)+(B272)+(B290), (A)+(B272)+(B291), (A)+(B272)+(B292), (A)+(B272)+(B293), (A)+(B272)+(B294), (A)+(B272)+(B295), (A)+(B272)+(B296), (A)+(B272)+(B297), (A)+(B272)+(B298), (A)+(B272)+(B299), (A)+(B272)+(B300), (A)+(B272)+(B301), (A)+(B272)+(B302), (A)+(B272)+(B303), (A)+(B272)+(B304), (A)+(B272)+(B305), (A)+(B272)+(B306), (A)+(B272)+(B307), (A)+(B272)+(B308), (A)+(B272)+(B309), (A)+(B272)+(B310), (A)+(B272)+(B311), (A)+(B272)+(B312), (A)+(B272)+(B313), (A)+(B272)+(B314), (A)+(B272)+(B315),

(A)+(B273)+(B274), (A)+(B273)+(B275), (A)+(B273)+(B276), (A)+(B273)+(B277), (A)+(B273)+(B278), (A)+(B273)+(B279), (A)+(B273)+(B280), (A)+(B273)+(B281), (A)+(B273)+(B282), (A)+(B273)+(B283), (A)+(B273)+(B284), (A)+(B273)+(B285), (A)+(B273)+(B286), (A)+(B273)+(B287), (A)+(B273)+(B288), (A)+(B273)+(B289), (A)+(B273)+(B290), (A)+(B273)+(B291), (A)+(B273)+(B292), (A)+(B273)+(B293), (A)+(B273)+(B294), (A)+(B273)+(B295), (A)+(B273)+(B296), (A)+(B273)+(B297), (A)+(B273)+(B298), (A)+(B273)+(B299), (A)+(B273)+(B300), (A)+(B273)+(B301), (A)+(B273)+(B302), (A)+(B273)+(B303), (A)+(B273)+(B304), (A)+(B273)+(B305), (A)+(B273)+(B306), (A)+(B273)+(B307), (A)+(B273)+(B308), (A)+(B273)+(B309), (A)+(B273)+(B310), (A)+(B273)+(B311), (A)+(B273)+(B312), (A)+(B273)+(B313), (A)+(B273)+(B314), (A)+(B273)+(B315),

(A)+(B274)+(B275), (A)+(B274)+(B276), (A)+(B274)+(B277), (A)+(B274)+(B278), (A)+(B274)+(B279), (A)+(B274)+(B280), (A)+(B274)+(B281), (A)+(B274)+(B282), (A)+(B274)+(B283), (A)+(B274)+(B284), (A)+(B274)+(B285), (A)+(B274)+(B286), (A)+(B274)+(B287), (A)+(B274)+(B288), (A)+(B274)+(B289), (A)+(B274)+(B290), (A)+(B274)+(B291), (A)+(B274)+(B292), (A)+(B274)+(B293), (A)+(B274)+(B294), (A)+(B274)+(B295), (A)+(B274)+(B296), (A)+(B274)+(B297), (A)+(B274)+(B298), (A)+(B274)+(B299), (A)+(B274)+(B300), (A)+(B274)+(B301), (A)+(B274)+(B302), (A)+(B274)+(B303), (A)+(B274)+(B304), (A)+(B274)+(B305), (A)+(B274)+(B306), (A)+(B274)+(B307), (A)+(B274)+(B308), (A)+(B274)+(B309), (A)+(B274)+(B310), (A)+(B274)+(B311), (A)+(B274)+(B312), (A)+(B274)+(B313), (A)+(B274)+(B314), (A)+(B274)+(B315),

(A)+(B275)+(B276), (A)+(B275)+(B277), (A)+(B275)+(B278), (A)+(B275)+(B279), (A)+(B275)+(B280), (A)+(B275)+(B281), (A)+(B275)+(B282), (A)+(B275)+(B283), (A)+(B275)+(B284), (A)+(B275)+(B285), (A)+(B275)+(B286), (A)+(B275)+(B287), (A)+(B275)+(B288), (A)+(B275)+(B289), (A)+(B275)+(B290), (A)+(B275)+(B291), (A)+(B275)+(B292), (A)+(B275)+(B293), (A)+(B275)+(B294), (A)+(B275)+(B295), (A)+(B275)+(B296), (A)+(B275)+(B297), (A)+(B275)+(B298), (A)+(B275)+(B299), (A)+(B275)+(B300), (A)+(B275)+(B301), (A)+(B275)+(B302), (A)+(B275)+(B303), (A)+(B275)+(B304), (A)+(B275)+(B305), (A)+(B275)+(B306), (A)+(B275)+(B307), (A)+(B275)+(B308), (A)+(B275)+(B309), (A)+(B275)+(B310), (A)+(B275)+(B311), (A)+(B275)+(B312), (A)+(B275)+(B313), (A)+(B275)+(B314), (A)+(B275)+(B315),

(A)+(B276)+(B277), (A)+(B276)+(B278), (A)+(B276)+(B279), (A)+(B276)+(B280), (A)+(B276)+(B281), (A)+(B276)+(B282), (A)+(B276)+(B283), (A)+(B276)+(B284), (A)+(B276)+(B285), (A)+(B276)+(B286), (A)+(B276)+(B287), (A)+(B276)+(B288), (A)+(B276)+(B289), (A)+(B276)+(B290), (A)+(B276)+(B291), (A)+(B276)+(B292), (A)+(B276)+(B293), (A)+(B276)+(B294), (A)+(B276)+(B295), (A)+(B276)+(B296), (A)+(B276)+(B297), (A)+(B276)+(B298), (A)+(B276)+(B299), (A)+(B276)+(B300), (A)+(B276)+(B301), (A)+(B276)+(B302), (A)+(B276)+(B303), (A)+(B276)+(B304), (A)+(B276)+(B305), (A)+(B276)+(B306), (A)+(B276)+(B307), (A)+(B276)+(B308), (A)+(B276)+(B309), (A)+(B276)+(B310), (A)+(B276)+(B311), (A)+(B276)+(B312), (A)+(B276)+(B313), (A)+(B276)+(B314), (A)+(B276)+(B315),

(A)+(B277)+(B278), (A)+(B277)+(B279), (A)+(B277)+(B280), (A)+(B277)+(B281), (A)+(B277)+(B282), (A)+(B277)+(B283), (A)+(B277)+(B284), (A)+(B277)+(B285), (A)+(B277)+(B286), (A)+(B277)+(B287), (A)+(B277)+(B288), (A)+(B277)+(B289), (A)+(B277)+(B290), (A)+(B277)+(B291), (A)+(B277)+(B292), (A)+(B277)+(B293), (A)+(B277)+(B294), (A)+(B277)+(B295), (A)+(B277)+(B296), (A)+(B277)+(B297), (A)+(B277)+(B298), (A)+(B277)+(B299), (A)+(B277)+(B300), (A)+(B277)+(B301), (A)+(B277)+(B302), (A)+(B277)+(B303), (A)+(B277)+(B304), (A)+(B277)+(B305), (A)+(B277)+(B306), (A)+(B277)+(B307), (A)+(B277)+(B308), (A)+(B277)+(B309), (A)+(B277)+(B310), (A)+(B277)+(B311), (A)+(B277)+(B312), (A)+(B277)+(B313), (A)+(B277)+(B314), (A)+(B277)+(B315),

(A)+(B278)+(B279), (A)+(B278)+(B280), (A)+(B278)+(B281), (A)+(B278)+(B282), (A)+(B278)+(B283), (A)+(B278)+(B284), (A)+(B278)+(B285), (A)+(B278)+(B286), (A)+(B278)+(B287), (A)+(B278)+(B288), (A)+(B278)+(B289), (A)+(B278)+(B290), (A)+(B278)+(B291), (A)+(B278)+(B292), (A)+(B278)+(B293), (A)+(B278)+(B294), (A)+(B278)+(B295), (A)+(B278)+(B296), (A)+(B278)+(B297), (A)+(B278)+(B298), (A)+(B278)+(B299), (A)+(B278)+(B300), (A)+(B278)+(B301), (A)+(B278)+(B302), (A)+(B278)+(B303), (A)+(B278)+(B304), (A)+(B278)+(B305), (A)+(B278)+(B306), (A)+(B278)+(B307), (A)+(B278)+(B308), (A)+(B278)+(B309), (A)+(B278)+(B310), (A)+(B278)+(B311), (A)+(B278)+(B312), (A)+(B278)+(B313), (A)+(B278)+(B314), (A)+(B278)+(B315),

(A)+(B279)+(B280), (A)+(B279)+(B281), (A)+(B279)+(B282), (A)+(B279)+(B283), (A)+(B279)+(B284), (A)+(B279)+(B285), (A)+(B279)+(B286), (A)+(B279)+(B287), (A)+(B279)+(B288), (A)+(B279)+(B289), (A)+(B279)+(B290), (A)+(B279)+(B291), (A)+(B279)+(B292), (A)+(B279)+(B293), (A)+(B279)+(B294), (A)+(B279)+(B295), (A)+(B279)+(B296), (A)+(B279)+(B297), (A)+(B279)+(B298), (A)+(B279)+(B299), (A)+(B279)+(B300), (A)+(B279)+(B301), (A)+(B279)+(B302), (A)+(B279)+(B303), (A)+(B279)+(B304), (A)+(B279)+(B305), (A)+(B279)+(B306), (A)+(B279)+(B307), (A)+(B279)+(B308), (A)+(B279)+(B309), (A)+(B279)+(B310), (A)+(B279)+(B311), (A)+(B279)+(B312), (A)+(B279)+(B313), (A)+(B279)+(B314), (A)+(B279)+(B315),

(A)+(B280)+(B281), (A)+(B280)+(B282), (A)+(B280)+(B283), (A)+(B280)+(B284), (A)+(B280)+(B285), (A)+(B280)+(B286), (A)+(B280)+(B287), (A)+(B280)+(B288), (A)+(B280)+(B289), (A)+(B280)+(B290), (A)+(B280)+(B291), (A)+(B280)+(B292), (A)+(B280)+(B293), (A)+(B280)+(B294), (A)+(B280)+(B295), (A)+(B280)+(B296), (A)+(B280)+(B297), (A)+(B280)+(B298), (A)+(B280)+(B299), (A)+(B280)+(B300), (A)+(B280)+(B301), (A)+(B280)+(B302), (A)+(B280)+(B303), (A)+(B280)+(B304), (A)+(B280)+(B305), (A)+(B280)+(B306), (A)+(B280)+(B307), (A)+(B280)+(B308), (A)+(B280)+(B309), (A)+(B280)+(B310), (A)+(B280)+(B311), (A)+(B280)+(B312), (A)+(B280)+(B313), (A)+(B280)+(B314), (A)+(B280)+(B315),

(A)+(B281)+(B282), (A)+(B281)+(B283), (A)+(B281)+(B284), (A)+(B281)+(B285), (A)+(B281)+(B286), (A)+(B281)+(B287), (A)+(B281)+(B288), (A)+(B281)+(B289), (A)+(B281)+(B290), (A)+(B281)+(B291), (A)+(B281)+(B292), (A)+(B281)+(B293), (A)+(B281)+(B294), (A)+(B281)+(B295), (A)+(B281)+(B296), (A)+(B281)+(B297), (A)+(B281)+(B298), (A)+(B281)+(B299), (A)+(B281)+(B300), (A)+(B281)+(B301), (A)+(B281)+(B302), (A)+(B281)+(B303), (A)+(B281)+(B304), (A)+(B281)+(B305), (A)+(B281)+(B306), (A)+(B281)+(B307), (A)+(B281)+(B308), (A)+(B281)+(B309), (A)+(B281)+(B310), (A)+(B281)+(B311), (A)+(B281)+(B312), (A)+(B281)+(B313), (A)+(B281)+(B314), (A)+(B281)+(B315),

(A)+(B282)+(B283), (A)+(B282)+(B284), (A)+(B282)+(B285), (A)+(B282)+(B286), (A)+(B282)+(B287), (A)+(B282)+(B288), (A)+(B282)+(B289), (A)+(B282)+(B290), (A)+(B282)+(B291), (A)+(B282)+(B292), (A)+(B282)+(B293), (A)+(B282)+(B294), (A)+(B282)+(B295), (A)+(B282)+(B296), (A)+(B282)+(B297), (A)+(B282)+(B298), (A)+(B282)+(B299), (A)+(B282)+(B300), (A)+(B282)+(B301), (A)+(B282)+(B302), (A)+(B282)+(B303), (A)+(B282)+(B304), (A)+(B282)+(B305), (A)+(B282)+(B306), (A)+(B282)+(B307), (A)+(B282)+(B308), (A)+(B282)+(B309), (A)+(B282)+(B310), (A)+(B282)+(B311), (A)+(B282)+(B312), (A)+(B282)+(B313), (A)+(B282)+(B314), (A)+(B282)+(B315),

(A)+(B283)+(B284), (A)+(B283)+(B285), (A)+(B283)+(B286), (A)+(B283)+(B287), (A)+(B283)+(B288), (A)+(B283)+(B289), (A)+(B283)+(B290), (A)+(B283)+(B291), (A)+(B283)+(B292), (A)+(B283)+(B293), (A)+(B283)+(B294), (A)+(B283)+(B295), (A)+(B283)+(B296), (A)+(B283)+(B297), (A)+(B283)+(B298), (A)+(B283)+(B299), (A)+(B283)+(B300), (A)+(B283)+(B301), (A)+(B283)+(B302), (A)+(B283)+(B303), (A)+(B283)+(B304), (A)+(B283)+(B305), (A)+(B283)+(B306), (A)+(B283)+(B307), (A)+(B283)+(B308), (A)+(B283)+(B309), (A)+(B283)+(B310), (A)+(B283)+(B311), (A)+(B283)+(B312), (A)+(B283)+(B313), (A)+(B283)+(B314), (A)+(B283)+(B315),

(A)+(B284)+(B285), (A)+(B284)+(B286), (A)+(B284)+(B287), (A)+(B284)+(B288), (A)+(B284)+(B289), (A)+(B284)+(B290), (A)+(B284)+(B291), (A)+(B284)+(B292), (A)+(B284)+(B293), (A)+(B284)+(B294), (A)+(B284)+(B295), (A)+(B284)+(B296), (A)+(B284)+(B297), (A)+(B284)+(B298), (A)+(B284)+(B299), (A)+(B284)+(B300), (A)+(B284)+(B301), (A)+(B284)+(B302), (A)+(B284)+(B303), (A)+(B284)+(B304), (A)+(B284)+(B305), (A)+(B284)+(B306), (A)+(B284)+(B307), (A)+(B284)+(B308), (A)+(B284)+(B309), (A)+(B284)+(B310), (A)+(B284)+(B311), (A)+(B284)+(B312), (A)+(B284)+(B313), (A)+(B284)+(B314), (A)+(B284)+(B315),

(A)+(B285)+(B286), (A)+(B285)+(B287), (A)+(B285)+(B288), (A)+(B285)+(B289), (A)+(B285)+(B290), (A)+(B285)+(B291), (A)+(B285)+(B292), (A)+(B285)+(B293), (A)+(B285)+(B294), (A)+(B285)+(B295), (A)+(B285)+(B296), (A)+(B285)+(B297), (A)+(B285)+(B298), (A)+(B285)+(B299), (A)+(B285)+(B300), (A)+(B285)+(B301), (A)+(B285)+(B302), (A)+(B285)+(B303), (A)+(B285)+(B304), (A)+(B285)+(B305), (A)+(B285)+(B306), (A)+(B285)+(B307), (A)+(B285)+(B308), (A)+(B285)+(B309), (A)+(B285)+(B310), (A)+(B285)+(B311), (A)+(B285)+(B312), (A)+(B285)+(B313), (A)+(B285)+(B314), (A)+(B285)+(B315),

(A)+(B286)+(B287), (A)+(B286)+(B288), (A)+(B286)+(B289), (A)+(B286)+(B290), (A)+(B286)+(B291), (A)+(B286)+(B292), (A)+(B286)+(B293), (A)+(B286)+(B294), (A)+(B286)+(B295), (A)+(B286)+(B296), (A)+(B286)+(B297), (A)+(B286)+(B298), (A)+(B286)+(B299), (A)+(B286)+(B300), (A)+(B286)+(B301), (A)+(B286)+(B302), (A)+(B286)+(B303), (A)+(B286)+(B304), (A)+(B286)+(B305), (A)+(B286)+(B306), (A)+(B286)+(B307), (A)+(B286)+(B308), (A)+(B286)+(B309), (A)+(B286)+(B310), (A)+(B286)+(B311), (A)+(B286)+(B312), (A)+(B286)+(B313), (A)+(B286)+(B314), (A)+(B286)+(B315),

(A)+(B287)+(B288), (A)+(B287)+(B289), (A)+(B287)+(B290), (A)+(B287)+(B291), (A)+(B287)+(B292), (A)+(B287)+(B293), (A)+(B287)+(B294), (A)+(B287)+(B295), (A)+(B287)+(B296), (A)+(B287)+(B297), (A)+(B287)+(B298), (A)+(B287)+(B299), (A)+(B287)+(B300), (A)+(B287)+(B301), (A)+(B287)+(B302), (A)+(B287)+(B303), (A)+(B287)+(B304), (A)+(B287)+(B305), (A)+(B287)+(B306), (A)+(B287)+(B307), (A)+(B287)+(B308), (A)+(B287)+(B309), (A)+(B287)+(B310), (A)+(B287)+(B311), (A)+(B287)+(B312), (A)+(B287)+(B313), (A)+(B287)+(B314), (A)+(B287)+(B315),

(A)+(B288)+(B289), (A)+(B288)+(B290), (A)+(B288)+(B291), (A)+(B288)+(B292), (A)+(B288)+(B293), (A)+(B288)+(B294), (A)+(B288)+(B295), (A)+(B288)+(B296), (A)+(B288)+(B297), (A)+(B288)+(B298), (A)+(B288)+(B299), (A)+(B288)+(B300), (A)+(B288)+(B301), (A)+(B288)+(B302), (A)+(B288)+(B303), (A)+(B288)+(B304), (A)+(B288)+(B305), (A)+(B288)+(B306), (A)+(B288)+(B307), (A)+(B288)+(B308), (A)+(B288)+(B309), (A)+(B288)+(B310), (A)+(B288)+(B311), (A)+(B288)+(B312), (A)+(B288)+(B313), (A)+(B288)+(B314), (A)+(B288)+(B315),

(A)+(B289)+(B290), (A)+(B289)+(B291), (A)+(B289)+(B292), (A)+(B289)+(B293), (A)+(B289)+(B294), (A)+(B289)+(B295), (A)+(B289)+(B296), (A)+(B289)+(B297), (A)+(B289)+(B298), (A)+(B289)+(B299), (A)+(B289)+(B300), (A)+(B289)+(B301), (A)+(B289)+(B302), (A)+(B289)+(B303), (A)+(B289)+(B304), (A)+(B289)+(B305), (A)+(B289)+(B306), (A)+(B289)+(B307), (A)+(B289)+(B308), (A)+(B289)+(B309), (A)+(B289)+(B310), (A)+(B289)+(B311), (A)+(B289)+(B312), (A)+(B289)+(B313), (A)+(B289)+(B314), (A)+(B289)+(B315), (A)+(B290)+(B291), (A)+(B290)+(B292), (A)+(B290)+(B293), (A)+(B290)+(B294), (A)+(B290)+(B295), (A)+(B290)+(B296), (A)+(B290)+(B297), (A)+(B290)+(B298), (A)+(B290)+(B299), (A)+(B290)+(B300), (A)+(B290)+(B301), (A)+(B290)+(B302), (A)+(B290)+(B303), (A)+(B290)+(B304), (A)+(B290)+(B305), (A)+(B290)+(B306), (A)+(B290)+(B307), (A)+(B290)+(B308), (A)+(B290)+(B309), (A)+(B290)+(B310), (A)+(B290)+(B311), (A)+(B290)+(B312), (A)+(B290)+(B313), (A)+(B290)+(B314), (A)+(B290)+(B315),

(A)+(B291)+(B292), (A)+(B291)+(B293), (A)+(B291)+(B294), (A)+(B291)+(B295), (A)+(B291)+(B296), (A)+(B291)+(B297), (A)+(B291)+(B298), (A)+(B291)+(B299), (A)+(B291)+(B300), (A)+(B291)+(B301), (A)+(B291)+(B302), (A)+(B291)+(B303), (A)+(B291)+(B304), (A)+(B291)+(B305), (A)+(B291)+(B306), (A)+(B291)+(B307), (A)+(B291)+(B308), (A)+(B291)+(B309), (A)+(B291)+(B310), (A)+(B291)+(B311), (A)+(B291)+(B312), (A)+(B291)+(B313), (A)+(B291)+(B314), (A)+(B291)+(B315),

(A)+(B292)+(B293), (A)+(B292)+(B294), (A)+(B292)+(B295), (A)+(B292)+(B296), (A)+(B292)+(B297), (A)+(B292)+(B298), (A)+(B292)+(B299), (A)+(B292)+(B300), (A)+(B292)+(B301), (A)+(B292)+(B302), (A)+(B292)+(B303), (A)+(B292)+(B304), (A)+(B292)+(B305), (A)+(B292)+(B306), (A)+(B292)+(B307), (A)+(B292)+(B308), (A)+(B292)+(B309), (A)+(B292)+(B310), (A)+(B292)+(B311), (A)+(B292)+(B312), (A)+(B292)+(B313), (A)+(B292)+(B314), (A)+(B292)+(B315),

(A)+(B293)+(B294), (A)+(B293)+(B295), (A)+(B293)+(B296), (A)+(B293)+(B297), (A)+(B293)+(B298), (A)+(B293)+(B299), (A)+(B293)+(B300), (A)+(B293)+(B301), (A)+(B293)+(B302), (A)+(B293)+(B303), (A)+(B293)+(B304), (A)+(B293)+(B305), (A)+(B293)+(B306), (A)+(B293)+(B307), (A)+(B293)+(B308), (A)+(B293)+(B309), (A)+(B293)+(B310), (A)+(B293)+(B311), (A)+(B293)+(B312), (A)+(B293)+(B313), (A)+(B293)+(B314), (A)+(B293)+(B315),

(A)+(B294)+(B295), (A)+(B294)+(B296), (A)+(B294)+(B297), (A)+(B294)+(B298), (A)+(B294)+(B299), (A)+(B294)+(B300), (A)+(B294)+(B301), (A)+(B294)+(B302), (A)+(B294)+(B303), (A)+(B294)+(B304), (A)+(B294)+(B305), (A)+(B294)+(B306), (A)+(B294)+(B307), (A)+(B294)+(B308), (A)+(B294)+(B309), (A)+(B294)+(B310), (A)+(B294)+(B311), (A)+(B294)+(B312), (A)+(B294)+(B313), (A)+(B294)+(B314), (A)+(B294)+(B315),

(A)+(B295)+(B296), (A)+(B295)+(B297), (A)+(B295)+(B298), (A)+(B295)+(B299), (A)+(B295)+(B300), (A)+(B295)+(B301), (A)+(B295)+(B302), (A)+(B295)+(B303), (A)+(B295)+(B304), (A)+(B295)+(B305), (A)+(B295)+(B306), (A)+(B295)+(B307), (A)+(B295)+(B308), (A)+(B295)+(B309), (A)+(B295)+(B310), (A)+(B295)+(B311), (A)+(B295)+(B312), (A)+(B295)+(B313), (A)+(B295)+(B314), (A)+(B295)+(B315),

(A)+(B296)+(B297), (A)+(B296)+(B298), (A)+(B296)+(B299), (A)+(B296)+(B300), (A)+(B296)+(B301), (A)+(B296)+(B302), (A)+(B296)+(B303), (A)+(B296)+(B304), (A)+(B296)+(B305), (A)+(B296)+(B306), (A)+(B296)+(B307), (A)+(B296)+(B308), (A)+(B296)+(B309), (A)+(B296)+(B310), (A)+(B296)+(B311), (A)+(B296)+(B312), (A)+(B296)+(B313), (A)+(B296)+(B314), (A)+(B296)+(B315),

(A)+(B297)+(B298), (A)+(B297)+(B299), (A)+(B297)+(B300), (A)+(B297)+(B301), (A)+(B297)+(B302), (A)+(B297)+(B303), (A)+(B297)+(B304), (A)+(B297)+(B305), (A)+(B297)+(B306), (A)+(B297)+(B307), (A)+(B297)+(B308), (A)+(B297)+(B309), (A)+(B297)+(B310), (A)+(B297)+(B311), (A)+(B297)+(B312), (A)+(B297)+(B313), (A)+(B297)+(B314), (A)+(B297)+(B315),

(A)+(B298)+(B299), (A)+(B298)+(B300), (A)+(B298)+(B301), (A)+(B298)+(B302), (A)+(B298)+(B303), (A)+(B298)+(B304), (A)+(B298)+(B305), (A)+(B298)+(B306), (A)+(B298)+(B307), (A)+(B298)+(B308), (A)+(B298)+(B309), (A)+(B298)+(B310), (A)+(B298)+(B311), (A)+(B298)+(B312), (A)+(B298)+(B313), (A)+(B298)+(B314), (A)+(B298)+(B315),

(A)+(B299)+(B300), (A)+(B299)+(B301), (A)+(B299)+(B302), (A)+(B299)+(B303), (A)+(B299)+(B304), (A)+(B299)+(B305), (A)+(B299)+(B306), (A)+(B299)+(B307), (A)+(B299)+(B308), (A)+(B299)+(B309), (A)+(B299)+(B310), (A)+(B299)+(B311), (A)+(B299)+(B312), (A)+(B299)+(B313), (A)+(B299)+(B314), (A)+(B299)+(B315),

(A)+(B300)+(B301), (A)+(B300)+(B302), (A)+(B300)+(B303), (A)+(B300)+(B304), (A)+(B300)+(B305), (A)+(B300)+(B306), (A)+(B300)+(B307), (A)+(B300)+(B308), (A)+(B300)+(B309), (A)+(B300)+(B310), (A)+(B300)+(B311), (A)+(B300)+(B312), (A)+(B300)+(B313), (A)+(B300)+(B314), (A)+(B300)+(B315),

(A)+(B301)+(B302), (A)+(B301)+(B303), (A)+(B301)+(B304), (A)+(B301)+(B305), (A)+(B301)+(B306), (A)+(B301)+(B307), (A)+(B301)+(B308), (A)+(B301)+(B309), (A)+(B301)+(B310), (A)+(B301)+(B311), (A)+(B301)+(B312), (A)+(B301)+(B313), (A)+(B301)+(B314), (A)+(B301)+(B315),

(A)+(B302)+(B303), (A)+(B302)+(B304), (A)+(B302)+(B305), (A)+(B302)+(B306), (A)+(B302)+(B307), (A)+(B302)+(B308), (A)+(B302)+(B309), (A)+(B302)+(B310), (A)+(B302)+(B311), (A)+(B302)+(B312), (A)+(B302)+(B313), (A)+(B302)+(B314), (A)+(B302)+(B315),

(A)+(B303)+(B304), (A)+(B303)+(B305), (A)+(B303)+(B306), (A)+(B303)+(B307), (A)+(B303)+(B308), (A)+(B303)+(B309), (A)+(B303)+(B310), (A)+(B303)+(B311), (A)+(B303)+(B312), (A)+(B303)+(B313), (A)+(B303)+(B314), (A)+(B303)+(B315),

(A)+(B304)+(B305), (A)+(B304)+(B306), (A)+(B304)+(B307), (A)+(B304)+(B308), (A)+(B304)+(B309), (A)+(B304)+(B310), (A)+(B304)+(B311), (A)+(B304)+(B312), (A)+(B304)+(B313), (A)+(B304)+(B314), (A)+(B304)+(B315),

(A)+(B305)+(B306), (A)+(B305)+(B307), (A)+(B305)+(B308), (A)+(B305)+(B309), (A)+(B305)+(B310), (A)+(B305)+(B311), (A)+(B305)+(B312), (A)+(B305)+(B313), (A)+(B305)+(B314), (A)+(B305)+(B315),

(A)+(B306)+(B307), (A)+(B306)+(B308), (A)+(B306)+(B309), (A)+(B306)+(B310), (A)+(B306)+(B311), (A)+(B306)+(B312), (A)+(B306)+(B313), (A)+(B306)+(B314), (A)+(B306)+(B315),

(A)+(B307)+(B308), (A)+(B307)+(B309), (A)+(B307)+(B310), (A)+(B307)+(B311), (A)+(B307)+(B312), (A)+(B307)+(B313), (A)+(B307)+(B314), (A)+(B307)+(B315),

(A)+(B308)+(B309), (A)+(B308)+(B310), (A)+(B308)+(B311), (A)+(B308)+(B312), (A)+(B308)+(B313), (A)+(B308)+(B314), (A)+(B308)+(B315),

(A)+(B309)+(B310), (A)+(B309)+(B311), (A)+(B309)+(B312), (A)+(B309)+(B313), (A)+(B309)+(B314), (A)+(B309)+(B315),

(A)+(B310)+(B311), (A)+(B310)+(B312), (A)+(B310)+(B313), (A)+(B310)+(B314), (A)+(B310)+(B315),

(A)+(B311)+(B312), (A)+(B311)+(B313), (A)+(B311)+(B314), (A)+(B311)+(B315),

(A)+(B312)+(B313), (A)+(B312)+(B314), (A)+(B312)+(B315),

(A)+(B313)+(B314), (A)+(B313)+(B315), and

(A)+(B314)+(B315).

Preferred are herbicidal compositions comprising the components

(A)+(B35)+(B1), (A)+(B35)+(B2), (A)+(B35)+(B3), (A)+(B35)+(B4), (A)+(B35)+(B5), (A)+(B35)+(B6), (A)+(B35)+(B7), (A)+(B35)+(B8), (A)+(B35)+(B9), (A)+(B35)+(B10), (A)+(B35)+(B11), (A)+(B35)+(B12), (A)+(B35)+(B13), (A)+(B35)+(B14), (A)+(B35)+(B15), (A)+(B35)+(B16), (A)+(B35)+(B17), (A)+(B35)+(B18), (A)+(B35)+(B19), (A)+(B35)+(B20), (A)+(B35)+(B22), (A)+(B35)+(B75), (A)+(B35)+(B111), (A)+(B35)+(B176),

(A)+(B50)+(B1), (A)+(B50)+(B2), (A)+(B50)+(B3), (A)+(B50)+(B4), (A)+(B50)+(B5), (A)+(B50)+(B6), (A)+(B50)+(B7), (A)+(B50)+(B8), (A)+(B50)+(B9), (A)+(B50)+(B10), (A)+(B50)+(B11), (A)+(B50)+(B12), (A)+(B50)+(B13), (A)+(B50)+(B14), (A)+(B50)+(B15), (A)+(B50)+(B16), (A)+(B50)+(B17), (A)+(B50)+(B18), (A)+(B50)+(B19), (A)+(B50)+(B20), (A)+(B50)+(B22), (A)+(B50)+(B75), (A)+(B50)+(B111), (A)+(B50)+(B176),

(A)+(B51)+(B1), (A)+(B51)+(B2), (A)+(B51)+(B3), (A)+(B51)+(B4), (A)+(B51)+(B5), (A)+(B51)+(B6), (A)+(B51)+(B7), (A)+(B51)+(B8), (A)+(B51)+(B9), (A)+(B51)+(B10), (A)+(B51)+(B11), (A)+(B51)+(B12), (A)+(B51)+(B13), (A)+(B51)+(B14), (A)+(B51)+(B15), (A)+(B51)+(B16), (A)+(B51)+(B17), (A)+(B51)+(B18), (A)+(B51)+(B19), (A)+(B51)+(B20), (A)+(B51)+(B22), (A)+(B51)+(B75), (A)+(B51)+(B111), (A)+(B51)+(B176),

(A)+(B221)+(B1), (A)+(B221)+(B2), (A)+(B221)+(B3), (A)+(B221)+(B4), (A)+(B221)+(B5), (A)+(B221)+(B6), (A)+(B221)+(B7), (A)+(B221)+(B8), (A)+(B221)+(B9), (A)+(B221)+(B10), (A)+(B221)+(B11), (A)+(B221)+(B12), (A)+(B221)+(B13), (A)+(B221)+(B14), (A)+(B221)+(B15), (A)+(B221)+(B16), (A)+(B221)+(B17), (A)+(B221)+(B18), (A)+(B221)+(B19), (A)+(B221)+(B20), (A)+(B221)+(B22), (A)+(B221)+(B75), (A)+(B221)+(B111), (A)+(B221)+(B176),

(A)+(B282)+(B1), (A)+(B282)+(B2), (A)+(B282)+(B3), (A)+(B282)+(B4), (A)+(B282)+(B5), (A)+(B282)+(B6), (A)+(B282)+(B7), (A)+(B282)+(B8), (A)+(B282)+(B9), (A)+(B282)+(B10), (A)+(B282)+(B11), (A)+(B282)+(B12), (A)+(B282)+(B13), (A)+(B282)+(B14), (A)+(B282)+(B15), (A)+(B282)+(B16), (A)+(B282)+(B17), (A)+(B282)+(B18), (A)+(B282)+(B19), (A)+(B282)+(B20), (A)+(B282)+(B22), (A)+(B282)+(B75), (A)+(B282)+(B111), (A)+(B282)+(B176),

(A)+(B297)+(B1), (A)+(B297)+(B2), (A)+(B297)+(B3), (A)+(B297)+(B4), (A)+(B297)+(B5), (A)+(B297)+(B6), (A)+(B297)+(B7), (A)+(B297)+(B8), (A)+(B297)+(B9), (A)+(B297)+(B10), (A)+(B297)+(B11), (A)+(B297)+(B12), (A)+(B297)+(B13), (A)+(B297)+(B14), (A)+(B297)+(B15), (A)+(B297)+(B16), (A)+(B297)+(B17), (A)+(B297)+(B18), (A)+(B297)+(B19), (A)+(B297)+(B20), (A)+(B297)+(B22), (A)+(B297)+(B75), (A)+(B297)+(B111), (A)+(B297)+(B176).

Particularly preferred are herbicidal compositions comprising the components

(A)+(B1)+(B22), (A)+(B1)+(B75), (A)+(B1)+(B111), (A)+(B1)+(B221),

(A)+(B22)+(B75), (A)+(B22)+(B111), (A)+(B22)+(B221),

(A)+(B75)+(B111), (A)+(B75)+(B221),

(A)+(B111)+(B221).

Very particularly preferred are herbicidal compositions comprising the components

(A)+(B1)+(B221), (A)+(B22)+(B221), (A)+(B75)+(B221), (A)+(B111)+(B221).

In the herbicidal compositions according to the invention, application rates in the range from 10 to 200 g, preferably 15 to 200 g, of active substance per hectare (ai/ha) of component A and in each case 5 to 5000 g, preferably 10 to 2000 g, of components B (in each the sum of the two components B) are generally required. The different levels of the application rates of the components B are based primarily on the different mechanisms of action of these components B, which is known in principle to the person skilled in the art. In general and based on his expert knowledge, the person skilled in the art may also find these in relevant sources such as the abovementioned Pesticide Manual and also in product information from the manufacturers of the commercial herbicides on which the components B are based.

The herbicidal compositions according to the invention have excellent herbicidal efficacy against a broad spectrum of economically important mono- and dicotyledonous annual harmful plants. The herbicidal compositions according to the invention also have good control over perennial harmful plants which are difficult to control and produce shoots from rhizomes, root stocks or other perennial organs.

The present invention therefore also provides a method for controlling unwanted plants or for regulating the growth of plants, preferably in plant crops, in which one or more compound(s) of the invention is/are applied to the plants (for example harmful plants such as monocotyledonous or dicotyledonous weeds or unwanted crop plants), the seed (for example grains, seeds or vegetative propagules such as tubers or shoot parts with buds) or the area on which the plants grow (for example the area under cultivation). The herbicidal compositions according to the invention can be deployed, for example, prior to sowing (if appropriate also by incorporation into the soil), prior to emergence or after emergence. Specific examples of some representatives of the monocotyledonous and dicotyledonous weed flora which can be controlled by the herbicidal compositions according to the invention are as follows, though there is no intention to restrict the enumeration to particular species.

Monocotyledonous harmful plants of the genera: Aegilops, Agropyron, Agrostis, Alopecurus, Apera, Avena, Brachiaria, Bromus, Cenchrus, Commelina, Cynodon, Cyperus, Dactyloctenium, Digitaria, Echinochloa, Eleocharis, Eleusine, Eragrostis, Eriochloa, Festuca, Fimbristylis, Heteranthera, Imperata, Ischaemum, Leptochloa, Lolium, Monochoria, Panicum, Paspalum, Phalaris, Phleum, Poa, Rottboellia, Sagittaria, Scirpus, Setaria and Sorghum.

Dicotyledonous weeds of the genera: Abutilon, Amaranthus, Ambrosia, Anoda, Anthemis, Aphanes, Artemisia, Atriplex, Bellis, Bidens, Capsella, Carduus, Cassia, Centaurea, Chenopodium, Cirsium, Convolvulus, Datura, Desmodium, Emex, Erysimum, Euphorbia, Galeopsis, Galinsoga, Galium, Hibiscus, Ipomoea, Kochia, Lamium, Lepidium, Lindernia, Matricaria, Mentha, Mercurialis, Mullugo, Myosotis, Papaver, Pharbitis, Plantago, Polygonum, Portulaca, Ranunculus, Raphanus, Rorippa, Rotala, Rumex, Salsola, Senecio, Sesbania, Sida, Sinapis, Solanum, Sonchus, Sphenoclea, Stellaria, Taraxacum, Thlaspi, Trifolium, Urtica, Veronica, Viola and Xanthium.

If the herbicidal compositions according to the invention are applied to the soil surface before germination, either the emergence of the weed seedlings is prevented completely or the weeds grow until they have reached the cotyledon stage, but then they stop growing and ultimately die completely after three to four weeks have passed.

If the herbicidal compositions according to the invention are applied post-emergence to the green parts of the plants, growth stops after the treatment, and the harmful plants remain at the growth stage at the time of application, or they die completely after a certain time, such that competition by the weeds, which is harmful to the crop plants, is thus eliminated very early and in a lasting manner.

Although the herbicidal compositions according to the invention have outstanding herbicidal activity against monocotyledonous and dicotyledonous weeds, crop plants of economically important crops, for example dicotyledonous crops of the genera Arachis, Beta, Brassica, Cucumis, Cucurbita, Helianthus, Daucus, Glycine, Gossypium, Ipomoea, Lactuca, Linum, Lycopersicon, Miscanthus, Nicotiana, Phaseolus, Pisum, Solanum, Vicia, or monocotyledonous crops of the genera Allium, Ananas, Asparagus, Avena, Hordeum, Oryza, Panicum, Saccharum, Secale, Sorghum, Triticale, Triticum, Zea, in particular Zea and Triticum, will be damaged to a negligible extent only, if at all, depending on the structure of the particular compound of the invention and its application rate. For these reasons, the present herbicidal compositions are highly suitable for selective control of unwanted plant growth in plant crops such as agriculturally useful plants or ornamental plants.

In addition, the herbicidal compositions according to the invention, depending on their particular chemical structure and the application rate deployed, have outstanding growth-regulating properties in crop plants. They intervene in the plants' own metabolism with regulatory effect, and can thus be used for the controlled influencing of plant constituents and to facilitate harvesting, for example by triggering desiccation and stunted growth. In addition, they are also suitable for general control and inhibition of unwanted vegetative growth without killing the plants. Inhibition of vegetative growth plays a major role for many mono- and dicotyledonous crops since, for example, this can reduce or completely prevent lodging.

By virtue of their herbicidal and plant growth regulatory properties, the herbicidal compositions according to the invention can also be used to control harmful plants in crops of genetically modified plants or plants modified by conventional mutagenesis. In general, the transgenic plants are characterized by particular advantageous properties, for example by resistances to certain pesticides, in particular certain herbicides, resistances to plant diseases or pathogens of plant diseases, such as certain insects or microorganisms such as fungi, bacteria or viruses. Other specific characteristics relate, for example, to the harvested material with regard to quantity, quality, storability, composition and specific constituents. For instance, there are known transgenic plants with an elevated starch content or altered starch quality, or those with a different fatty acid composition in the harvested material.

It is preferable with a view to transgenic crops to use the herbicidal compositions according to the invention in economically important transgenic crops of useful plants and ornamentals, for example of cereals such as wheat, barley, rye, oats, millet, rice and corn or else crops of sugar beet, cotton, soybean, oilseed rape, potato, manioc, tomato, peas and other vegetables.

Preferably, the herbicidal compositions can be used as herbicides in crops of useful plants which are resistant, or have been made resistant by genetic engineering, to the phytotoxic effects of the herbicides.

Conventional ways of producing novel plants which have modified properties in comparison to existing plants consist, for example, in traditional cultivation methods and the generation of mutants. Alternatively, novel plants with modified properties can be generated with the aid of recombinant methods (see, for example, EP-A-0221044, EP-A-0131624). For example, there have been descriptions in several cases of:
genetic modifications of crop plants for the purpose of modifying the starch synthesized in the plants (for example WO 92/11376, WO 92/14827, WO 91/19806),
transgenic crop plants which are resistant to particular herbicides of the glufosinate type (cf., for example, EP-A-0242236, EP-A-242246) or glyphosate type (WO 92/00377) or of the sulphonylurea type (EP-A-0257993, U.S. Pat. No. 5,013,659),
transgenic crop plants, for example cotton, which is capable of producing Bacillus thuringiensis toxins (Bt toxins), which make the plants resistant to certain pests (EP-A-0142924, EP-A-0193259),
transgenic crop plants having a modified fatty acid composition (WO 91/13972),
genetically modified crop plants with novel constituents or secondary metabolites, for example novel phytoalexins, which bring about an increased disease resistance (EPA 309862, EPA0464461),
genetically modified plants having reduced photorespiration, which have higher yields and higher stress tolerance (EPA 0305398),
transgenic crop plants which produce pharmaceutically or diagnostically important proteins (“molecular pharming”),
transgenic crop plants which feature higher yields or better quality,
transgenic crop plants which feature a combination, for example, of the abovementioned novel properties (“gene stacking”).

Numerous molecular biology techniques which can be used to produce novel transgenic plants with modified properties are known in principle; see, for example, I. Potrykus and G. Spangenberg (eds.) Gene Transfer to Plants, Springer Lab Manual (1995), Springer Verlag Berlin, Heidelberg, or Christou, “Trends in Plant Science” 1 (1996) 423-431).

For such recombinant manipulations, nucleic acid molecules which allow mutagenesis or sequence alteration by recombination of DNA sequences can be introduced into plasmids. With the aid of standard methods, it is possible, for example, to undertake base exchanges, remove parts of sequences or add natural or synthetic sequences. To join the DNA fragments with one another, adapters or linkers can be placed onto the fragments, see e.g. Sambrook et al., 1989, Molecular Cloning, A Laboratory Manual, 2nd edition Cold Spring Harbor Laboratory Press, Cold Spring Harbor, N.Y., or Winnacker “Gene and Klone [Genes and clones]”, VCH Weinheim 2nd edition 1996.

For example, the generation of plant cells with a reduced activity of a gene product can be achieved by expressing at least one corresponding antisense RNA, a sense RNA for achieving a cosuppression effect, or by expressing at least one suitably constructed ribozyme which specifically cleaves transcripts of the abovementioned gene product. To this end, it is firstly possible to use DNA molecules which encompass the entire coding sequence of a gene product inclusive of any flanking sequences which may be present, and also DNA molecules which only encompass portions of the coding sequence, in which case it is necessary for these portions to be long enough to have an antisense effect in the cells. It is also possible to use DNA sequences which have a high degree of homology to the coding sequences of a gene product, but are not completely identical to them.

When expressing nucleic acid molecules in plants, the protein synthesized may be localized in any desired compartment of the plant cell. However, to achieve localization in a particular compartment, it is possible, for example, to join the coding region to DNA sequences which ensure localization in a particular compartment. Such sequences are known to those skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106). The nucleic acid molecules can also be expressed in the organelles of the plant cells.

The transgenic plant cells can be regenerated by known techniques to give rise to entire plants. In principle, the transgenic plants may be plants of any desired plant species, i.e. not only monocotyledonous but also dicotyledonous plants.

Thus, transgenic plants can be obtained whose properties are altered by overexpression, suppression or inhibition of homologous (=natural) genes or gene sequences or expression of heterologous (=foreign) genes or gene sequences.

Preferably the herbicidal compositions according to the invention can be used in transgenic crops which are resistant to growth regulators such as, for example, dicamba, or to herbicides which inhibit essential plant enzymes, for example acetolactate synthases (ALS), EPSP synthases, glutamine synthases (GS) or hydroxyphenylpyruvate dioxygenases (HPPD), or to herbicides from the group of the sulphonylureas, the glyphosates, glufosinates or benzoylisoxazoles and analogous active compounds.

When the herbicidal compositions according to the invention are employed in transgenic crops, not only do the effects toward harmful plants observed in other crops occur, but frequently also effects which are specific to application in the particular transgenic crop, for example an altered or specifically widened spectrum of weeds which can be controlled, altered application rates which can be used for the application, preferably good combinability with the herbicides to which the transgenic crop is resistant, and influencing of growth and yield of the transgenic crop plants.

The invention therefore also provides for the use of the herbicidal compositions according to the invention as herbicides for control of harmful plants in transgenic crop plants.

The herbicidal compositions according to the invention can be applied in the form of wettable powders, emulsifiable concentrates, sprayable solutions, dusting products or granules in the customary formulations. The invention therefore also provides herbicidal and plant-growth-regulating compositions which comprise the herbicidal compositions according to the invention.

The herbicidal compositions according to the invention can be formulated in various ways, according to the biological and/or physicochemical parameters required. Possible formulations include, for example: wettable powders (WP), water-soluble powders (SP), water-soluble concentrates, emulsifiable concentrates (EC), emulsions (EW), such as oil-in-water and water-in-oil emulsions, sprayable solutions, suspension concentrates (SC), dispersions based on oil or water, oil-miscible solutions, capsule suspensions (CS), dusting products (DP), dressings, granules for scattering and soil application, granules (GR) in the form of microgranules, spray granules, absorption and adsorption granules, water-dispersible granules (WG), water-soluble granules (SG), ULV formulations, microcapsules and waxes. These individual formulation types are known in principle and are described, for example, in: Winnacker-Küchler, “Chemische Technologie” [Chemical Technology], Volume 7, C. Hanser Verlag Munich, 4th. Ed. 1986, Wade van Valkenburg, “Pesticide Formulations”, Marcel Dekker, N.Y., 1973, K. Martens, “Spray Drying” Handbook, 3rd Ed. 1979, G. Goodwin Ltd. London.

The formulation auxiliaries required, such as inert materials, surfactants, solvents and further additives, are likewise known and are described, for example, in: Watkins, “Handbook of Insecticide Dust Diluents and Carriers”, 2nd ed., Darland Books, Caldwell N.J.; H. v. Olphen, “Introduction to Clay Colloid Chemistry”, 2nd ed., J. Wiley & Sons, N.Y.; C. Marsden, “Solvents Guide”, 2nd ed., Interscience, N.Y. 1963; McCutcheon's “Detergents and Emulsifiers Annual”, MC Publ. Corp., Ridgewood N.J., Sisley and Wood, “Encyclopedia of Surface Active Agents”, Chem. Publ. Co. Inc., N.Y. 1964; Schönfeldt, “Grenzflächenaktive Äthylenoxidaddukte” [Interface-active Ethylene Oxide Adducts], Wiss. Verlagsgesellschaft, Stuttgart 1976; Winnacker-Küchler, “Chemische Technologie” [Chemical Engineering], volume 7, C. Hanser Verlag Munich, 4th Ed. 1986.

Wettable powders are preparations which can be dispersed uniformly in water and, in addition to the herbicidal compositions according to the invention and a diluent or inert substance, also comprise surfactants of the ionic and/or nonionic type (wetting agents, dispersants), for example polyethoxylated alkylphenols, polyethoxylated fatty alcohols, polyethoxylated fatty amines, fatty alcohol polyglycol ether sulphates, alkanesulphonates, alkylbenzenesulphonates, sodium lignosulphonate, sodium 2,2′-dinaphthylmethane-6,6′-disulphonate, sodium dibutylnaphthalenesulphonate or else sodium oleoylmethyltaurate. To produce the wettable powders, the herbicidal compositions according to the invention are finely ground, for example in customary apparatuses such as hammer mills, blower mills and air-jet mills, and simultaneously or subsequently mixed with the formulation auxiliaries.

Emulsifiable concentrates are produced by dissolving the herbicidal compositions according to the invention in an organic solvent, for example butanol, cyclohexanone, dimethylformamide, xylene, or else relatively high-boiling aromatics or hydrocarbons or mixtures of the organic solvents, with addition of one or more ionic and/or nonionic surfactants (emulsifiers). Examples of emulsifiers which may be used are: calcium alkylarylsulphonates such as calcium dodecylbenzenesulphonate, or nonionic emulsifiers such as fatty acid polyglycol esters, alkylaryl polyglycol ethers, fatty alcohol polyglycol ethers, propylene oxide-ethylene oxide condensation products, alkyl polyethers, sorbitan esters, for example sorbitan fatty acid esters, or polyoxyethylene sorbitan esters, for example polyoxyethylene sorbitan fatty acid esters.

Dustable powders are obtained by grinding the herbicidal compositions according to the invention with finely distributed solid substances, for example talc, natural clays such as kaolin, bentonite and pyrophyllite, or diatomaceous earth.

Suspension concentrates may be water- or oil-based. They may be prepared, for example, by wet-grinding by means of commercial bead mills and optional addition of surfactants as have, for example, already been listed above for the other formulation types.

Emulsions, for example oil-in-water emulsions (EW), can be produced, for example, by means of stirrers, colloid mills and/or static mixers using aqueous organic solvents and optionally surfactants as already listed above, for example, for the other formulation types.

Granules can be prepared either by spraying the herbicidal compositions according to the invention onto adsorptive granular inert material or by applying active ingredient concentrates to the surface of carriers, such as sand, kaolinites or granular inert material, by means of adhesives, for example polyvinyl alcohol, sodium polyacrylate or else mineral oils. Suitable active ingredients can also be granulated in the manner customary for the production of fertilizer granules—if desired as a mixture with fertilizers.

Water-dispersible granules are produced generally by the customary processes such as spray-drying, fluidized bed granulation, pan granulation, mixing with high-speed mixers and extrusion without solid inert material.

For the production of pan, fluidized-bed, extruder and spray granules, see e.g. processes in “Spray Drying Handbook” 3rd Ed. 1979, G. Goodwin Ltd., London, J. E. Browning, “Agglomeration”, Chemical and Engineering 1967, pages 147 ff.; “Perry's Chemical Engineer's Handbook”, 5th ed., McGraw-Hill, New York 1973, pp. 8-57.

For further details regarding the formulation of crop protection compositions, see, for example, G. C. Klingman, “Weed Control as a Science”, John Wiley and Sons, Inc., New York, 1961, pages 81-96 and J. D. Freyer, S. A. Evans, “Weed Control Handbook”, 5th Ed., Blackwell Scientific Publications, Oxford, 1968, pages 101-103.

On the basis of these formulations, it is also possible to produce combinations with other pesticidally active substances, for example insecticides, acaricides, herbicides, fungicides, and also with safeners, fertilizers and/or growth regulators, for example in the form of a finished formulation or as a tankmix. Suitable safeners are, for example, mefenpyr-diethyl, cyprosulfamide, isoxadifen-ethyl, cloquintocet-mexyl and dichlormid. A suitable fertilizer is particular ammonium sulphate.

The agrochemical formulations (herbicidal compositions according to the invention) generally comprise 0.1 to 99% by weight, in particular 0.1 to 95% by weight, of components A and B. In wettable powders, the concentration of components A and B is, for example, about 10 to 90% by weight, the remainder ad 100% by weight consisting of customary formulation ingredients. In emulsifiable concentrates, the concentration of components A and B may be about 1 to 90% and preferably 5 to 80% by weight. Formulations in the form of dusts comprise 1 to 30% by weight of components A and B, preferably usually 5 to 20% by weight, sprayable solutions comprise about 0.05 to 80%, preferably 2 to 50% by weight, of components A and B. In the case of water-dispersible granules, the content of components A and B depends partially on whether the active compound is present in liquid or solid form and on which granulation auxiliaries, fillers, etc., are used. In the water-dispersible granules, the content of components A and B is, for example, between 1% and 95% by weight, preferably between 10% and 80% by weight.

The herbicidal compositions according to the invention generally comprise components A and B in a ratio of from 1:500 to 40:1, preferably from 1:133.3 to 20:1 (in each case based on the sum of the two components B).

In addition, the formulations mentioned optionally comprise the respective customary tackifiers, wetting agents, dispersants, emulsifiers, penetrants, preservatives, antifreeze agents and solvents, fillers, carriers and dyes, defoamers, evaporation inhibitors and agents which influence the pH and the viscosity.

For application, the formulations in commercial form are, if appropriate, diluted in a customary manner, for example in the case of wettable powders, emulsifiable concentrates, dispersions and water-dispersible granules with water. Dust-type preparations, granules for soil application or granules for scattering and sprayable solutions are not normally diluted further with other inert substances prior to application.

### B. Biological Examples: Herbicidal Post-Emergence Action

Seeds of mono- and dicotyledonous weed plants were sown outdoors and, after emergence, treated with the herbicidally active compounds or the herbicidal compositions according to the invention. The herbicidal activity was evaluated visually 11 days after the treatment in comparison with untreated control plants, where “0%” means no herbicidal activity and “100%” means full herbicidal activity. Here, it was found that the herbicidal compositions according to the invention have higher herbicidal activity than the herbicidal compositions comprising component A and in each case only one component B. This higher herbicidal activity, which in particular also entails a synergistic effect, would not have been expected by the person skilled in the art owing to the activity of the herbicidal compositions comprising component A and one component B. In particular, the herbicidal compositions according to the invention comprising
component A and metribuzine and diflufenican,
component A and metribuzine and 2,4-D, and
component A and metribuzine and aclonifen
   have a particular synergistic activity, as can be seen from the data in the tables that follow.

The figures denote:

| A | component A (2-chloro-3-(methylsulphanyl)-N- | | |
|---|---|---|---|
| | (1-methyl-1H-tetrazol-5-yl)-4-(trifluoromethyl)benzamid) | | |
| AMBEL | Ambrosia elatior | AVEFA | Avena fatua |
| KCHSC | Kochia scoparia | PANRU | Panicum ramosum |
| SETVI | Setaria viridis | | |

TABLE 1
herbicidal activity found

| Herbicide or herbicidal | Dosage | Herbicidal efficacy against | | | | |
|---|---|---|---|---|---|---|
| composition | [g/ha] | AVEFA | PANRU | SETVI | KCHSC | AMBEL |
| Component A | 10 | 10% | 10% | 10% | 15% | 5% |
| metribuzin | 240 | 0% | 0% | 0% | 0% | 0% |
| clomazone | 600 | 0% | 0% | 0% | 0% | 0% |
| diflufenican | 150 | 0% | 0% | 0% | 0% | 0% |
| 2,4-D | 350 | 0% | 0% | 0% | 0% | 0% |
| aclonifen | 1000 | 0% | 0% | 0% | 0% | 0% |
| A + metribuzin | 10 + 240 | 29% | 28% | 28% | 32% | 32% |
| A + clomazone | 10 + 600 | 20% | 20% | 15% | 20% | 10% |
| A + diflufenican | 10 + 150 | 20% | 20% | 15% | 20% | 10% |
| A + 2,4-D | 10 + 350 | 20% | 20% | 15% | 22% | 10% |
| A + aclonifen | 10 + 1000 | 20% | 20% | 15% | 20% | 10% |
| A + metribuzin + clomazone | 10 + 240 + 600 | 35% | 35% | 35% | 40% | 35% |
| A + metribuzin + diflufenican | 10 + 240 + 150 | 35% | 30% | 35% | 42% | 38% |
| A + metribuzin + 2,4-D | 10 + 240 + 350 | 35% | 32% | 35% | 42% | 45% |
| A + metribuzin + aclonifen | 10 + 240 + 1000 | 35% | 35% | 38% | 40% | 40% |

These data show that, unexpectedly, the herbicidal compositions according to the invention have higher activity than would have been expected from the activities of the individual components or the 2-component mixtures listed in Table 2.

TABLE 2
expected herbicidal activity (according to Colby) and, stated in brackets, the difference (Δ)
to the value determined

| Herbicide or herbicidal | Herbicidal efficacy against | | | | |
|---|---|---|---|---|---|
| composition | AVEFA | PANRU | SETVI | KCHSC | AMBEL |
| A + metribuzin | 10% (Δ = 19) | 10% (Δ = 18) | 10% (Δ = 18) | 15% (Δ = 17) | 5% (Δ = 27) |
| A + clomazone | 10% (Δ = 10) | 10% (Δ = 0) | 10% (Δ = 5) | 15% (Δ = 5) | 5% (Δ = 5) |
| A + diflufenican | 10% (Δ = 10) | 10% (Δ = 10) | 10% (Δ = 5) | 15% (Δ = 5) | 5% (Δ = 5) |
| A + 2,4-D | 10% (Δ = 10) | 10% (Δ = 10) | 10% (Δ =) | 15% (Δ = 7% | 5% (Δ = 5) |
| A + aclonifen | 10% (Δ = 10) | 10% (Δ = 10) | 10% (Δ = 5) | 15% (Δ = 5) | 5% (Δ = 5) |
| A + metribuzin + clomazone | 10% (Δ = 25) | 10% (Δ = 25) | 10% (Δ = 25) | 15% (Δ = 25) | 5% (Δ = 30) |
| A + metribuzin + diflufenican | 10% (Δ = 25) | 10% (Δ = 20) | 10% (Δ = 25) | 15% (Δ = 27) | 5% (Δ = 3) |
| A + metribuzin + 2,4-D | 10% (Δ = 25) | 10% (Δ = 22) | 10% (Δ = 25) | 15% (Δ = 27) | 5% (Δ = 40) |
| A + metribuzin + aclonifen | 10% (Δ = 25) | 10% (Δ = 25) | 10% (Δ = 28) | 15% (Δ = 25) | 5% (Δ = 35) |

1. Herbicidal composition comprising
A) 2-chloro-3-(methylsulphanyl)-N-(1-methyl-1H-tetrazol-5-yl)-4-(trifluoromethyl)benzamide
Or/or a salt thereof
(component A),
and
B) two herbicidally active compounds selected from the group consisting of
2,4-D, 2,4-DB, 2,4-DB-butyl, 2,4-DB-dimethylammonium, 2,4-DB-isoctyl, 2,4-DB-potassium, 2,4-D-butotyl, 2,4-D-butyl, 2,4-D-dimethylammonium, 2,4-D-diolamine, 2,4-D-ethyl, 2,4-D-ethylhexyl, 2,4-D-isobutyl, 2,4-D-isoctyl, 2,4-D-isopropyl, 2,4-D-isopropylammonium, 2,4-DP, 2,4-D-sodium, 2,4-D-triisopropanol-ammonium, 2,4-D-trolamine, acetachlor, aclonifen, alloxydim, alloxydim-sodium, ametryne, amicarbazone, amidosulfuron, aminocyclopyrachlor, aminocyclopyrachlor methyl ester, aminocyclopyrachlor potassium salt, aminopyralid, aminopyralid-triisopropanolammonium, amiprofos-methyl, amitrole, atrazine, azimsulfuron, benazolin-ethyl, benazolin potassium salt, benfluralin, bensulfuron, bensulfuron-methyl, bentazone, bentazone-sodium, benzobicyclon, benzofenap, bialaphos-monosodium, bialaphos-sodium, bicyclopyrone, bispyrac-sodium, bromacil, bromacil-lithium, bromofenoxim, bromoxynil, bromoxynil-butyrate, bromoxynil-heptanoate, bromoxynil-octanoate, bromoxynil-potassium, butamifos, butralin, butroxydim, carbetamide, chloramben, chloridazon, chlorimuron-ethyl, chlorobromuron, chlorotoluron, chloroxuron, chlorpropham, chlorsulfuron, chlorthal-dimethyl, cinosulfuron, clethodim, clodinafop, clodinafop-propargyl, clomazone, clomeprop, clopyralid, clopyralid-olamine, clopyralid-potassium, clopyralid-triethylammonium, clopyralid-triisopropanolammonium, cloransulam-methyl, cyclosulfamuron, cycloxydim, cyhalofop-buthyl, cynazine, desmedipham, desmetryne, dicamba, dicamba-butotyl, dicamba-diglycolamine salt, dicamba-diolamine, dicamba-isopropylammonium, dicamba-potassium, dicamba-sodium, dicamba-trolamine, dichlorprop, dichlorprop-butotyl, dichlorprop-dimethylammonium, dichlorprop-isoctyl, dichlorprop-P, dichlorprop-P-dimethylammonium, dichlorprop-P-ethylhexyl, dichlorprop-potassium, dichlorprop-P-potassium, dichlorprop-P-sodium, diclofop, diclofop-methyl, diclofop-P-methyl, diclosulam, diflufenican, dimefuron, dimethametryn, dimethenamid, dinitramine, dithiopyr, diuron, ethalfluralin, ethametsulfuron-methyl, ethidimuron, ethoxysulfuron, fenoxaprop-p, fenoxaprop-p-ethyl, fenuron, flamprop-m, flamprop-m-isopropyl, flamprop-m-methyl, flazasulfuron, florasulam, fluazifop-butyl, fluazifop-p-butyl, flucarbazone-sodium, flucetosulfuron, flufenacet, flumetsulam, fluometuron, flupyrsulfuron-methyl-acid, flupyrsulfuron-methyl-sodium, fluridone, flurochloridone, fluroxypyr, fluroxypyr-2-butoxy-1-methylethyl, fluroxypyr-meptyl, flurtamone, foramsulfuron, glufosinate, glufosinate-ammonium, glufosinate-P, glufosinate-sodium, glyphosate, glyphosate-ammonium, glyphosate-diammonium, glyphosate-dimethylammonium, glyphosate-isopropylammonium, glyphosate-potassium, glyphosate-sesquisodium, halosulfuron, halosulfuron-methyl, haloxyfop-etotyl, haloxyfop-methyl, haloxyfop-p, haloxyfop-p-methyl, hexazinone, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-ammonium, imazosulfuron, indaziflam, iodosulfuron-methyl-sodium, ioxynil, ioxynil-octanoate 179ioxynil-potassium, ioxynil-sodium, isoproturon, isouron, isoxachlortole, isoxaflutole, lenacil, linuron, MCPA, MCPA-2-ethylexyl, MCPA-butotyl, MCPA-dimethylammonium, MCPA-isopropylammonium, MCPA-potassium, MCPA-sodium, MCPA-thioethyl, MCPB, MCPB-, MCPB-ethyl, MCPB-potassium, MCPB-sodium, mecoprop, mecoprop-butotyl, mecoprop-P, mecoprop-P-2-ethylhexyl, mecoprop-P-butotyl, mecoprop-P-dimethylammonium, mecoprop-potassium, mecoprop-P-potassium, mecoprop-sodium, mesosulfuron-methyl, mesotrione, metamifop, metamitron, metazachlor, metazosulfuron, methabenzthiazuron, metobromuron, metolachlor, metosulam, metoxuron, metribuzin, metsulfuron, metsulfuron-methyl, monolinuron, neburon, nicosulfuron, norflurazon, orthosulfamuron, oryzalin, oxasulfuron, pendimethalin, penoxsulam, pentanochlor, pethoxamide, phenmedipham, picloram, picloram-dimethylammonium, picloram-isoctyl, picloram-potassium, picloram-triethylammonium, picloram-triisopropanolammonium, picloram-triisopropylammonium, picloram-trolamin, picolinafen, pinoxaden, popaquizafop, primisulfuron, primisulfuron-methyl, profoxydim, prometon, prometryne, propanil, propazine, propham, propoxycarbazone-sodium, propyrisulfuron, propyzamide, prosulfuron, pyrasulfotole, pyrazolynate, pyrazosulfuron, pyrazosulfuron-ethyl, pyrazoxyfen, pyribenzoxim, pyridafol, pyridate, pyriftalid, pyriminobac-methyl, pyrimisulfan, pyrithiobac-sodium, pyroxasulfone, pyroxsulam, quinclorac, quinmerac, quizalofop-ethyl, quizalofop-p-ethyl, quizalofop-p-methyl, quizalofop-p-terfuryl, rimsulfuron, sethoxydim, siduron, simazine, simetryne, s-metolachlor, sulcotrione, sulfometuron-methyl, sulfosate, sulfosulfuron, TBA, tebutam, tebuthiuron, tefuryltrione, tembotrione, tepraloxydim, terbacil, terbumeton, terbuthylazine, terbutryne, thiazopyr, thiencarbazone-methyl, thifensulfuron, thifensulfuron-methyl, topramezone, tralkoxydim, triasulfuron, tribenuron, tribenuron-methyl, trichlopyr, trichlopyr-butotyl, trichlopyr-triethylammonium, trietazine, trifloxysulfuron-sodium, trifluralin, triflusulfuron-methyl and tritosulfuron.

2. Herbicidal composition according to claim 1, comprising, as component B), two herbicidally active compounds selected from the group consisting of 2,4-D, 2,4-DB, 2,4-DB-butyl, 2,4-DB-dimethylammonium, 2,4-DB-isoctyl, 2,4-DB-potassium, 2,4-D-butotyl, 2,4-D-butyl, 2,4-D-dimethylammonium, 2,4-D-diolamine, 2,4-D-ethyl, 2,4-D-ethylhexyl, 2,4-D-isobutyl, 2,4-D-isoctyl, 2,4-D-isopropyl, 2,4-D-isopropylammonium, 2,4-DP, 2,4-D-sodium, 2,4-D-triisopropanol-ammonium, 2,4-D-trolamine, aclonifen, atrazine, bromacil, bromacil-lithium, clomazone, diflufenican, indaziflam, metribuzin, simazine and terbuthylazine.

3. Herbicidal composition according to claim 1, comprising, as component B), two herbicidally active compounds selected from the group consisting of 2,4-D, aclonifen, clomazone, diflufenican and metribuzin.

4. Herbicidal composition according to claim 3, comprising, as first component B), metribuzin, and, as second component B), a herbicidally active compound selected from the group consisting of 2,4-D, aclonifen, clomazone and diflufenican.

5. Herbicidal composition according to claim 1, comprising at least one further insecticidally active substance from the group consisting of insecticides, acaricides, herbicides, fungicides, safeners, fertilizers and/or growth regulators.

6. Herbicidal composition according to claim 5, comprising mefenpyr-diethyl, cyprosulfamide, isoxadifen-ethyl, cloquintocet-mexyl or dichlormid as safener.

7. Herbicidal composition according to claim 5, comprising ammonium sulphate as fertilizer.

8. Herbicidal composition according to claim 1, comprising the components A and B in a ratio of from 1:500 to 40:1, in each case based on the sum of the two components B.

9. Herbicidal composition according to claim 8, comprising the components A and B in a ratio of from 1:133.3 to 20:1, in each case based on the sum of the two components B.

10. Herbicidal composition according to claim 1, further comprising one or more formulation auxiliaries customary in crop protection.

11. Method for controlling unwanted vegetation, comprising applying the herbicidal composition according to claim 1 to the plants, plant parts, plant seeds or an area in which plants grow.

12. Method according to claim 11 for the selective control of harmful plants in crops of useful plants.

13. Method according to claim 12 in which the plant crops are genetically modified or have been obtained by mutation selection.

14. A product comprising the herbicidal composition defined in claim 1 for controlling harmful plants.
